(19) United States
(12) Patent Application Publication
(10) Pub. No.: US 2026/0154435 A1
(43) Pub. Date: Jun. 4, 2026

(54) EMBEDDED SYSTEMS

(71) Applicant: Strong Force TX Portfolio 2018, LLC, Fort Lauderdale, FL (US)

(72) Inventors: Charles H. Cella, Pembroke, MA (US); Andrew Cardno, San Diego, CA (US); Andrew S. Locke, Farmington, MI (US); Brent D. Bliven, Austin, TX (US); Anthony Cascio, Lutz, FL (US); Eric P. Vetter, Apex, NC (US); David J. Stein, Fairfax, VA (US); Teymour S. El-Tahry, Detroit, MI (US); Nicholas Rogosin, Studio City, CA (US); Taylor D. Charon, Troy, MI (US); Jenna L. Parenti, Broomfield, CO (US); Andrew Bunin, Lakewood Ranch, FL (US); Henry Mohr, Philadelphia, PA (US); Kendra S. Heger, Birmingham, MI (US); Leon Fortin, JR., Providence, RI (US); Richard Spitz, Franklin, TN (US); Brad Kell, Seattle, WA (US); Hristo Malchev, Alta Loma, CA (US); Joshua B. Dobrowitsky, Birmingham, MI (US)

(21) Appl. No.: 19/317,750

(22) Filed: Sep. 3, 2025

Related U.S. Application Data
(63) Continuation of application No. PCT/US24/18783, filed on Mar. 7, 2024.
(60) Provisional application No. 63/450,638, filed on Mar. 7, 2023.
(60) Provisional application No. 63/461,802, filed on Apr. 25, 2023.
(60) Provisional application No. 63/535,741, filed on Aug. 31, 2023.
(60) Provisional application No. 63/610,890, filed on Dec. 15, 2023.
(60) Provisional application No. 63/621,548, filed on Jan. 16, 2024.
(60) Provisional application No. 63/625,605, filed on Jan. 26, 2024.

(51) Int. Cl. G06F 21/62; G06F 16/904; G06F 16/906

(52) U.S. Cl. CPC G06F 21/6218; G06F 16/904; G06F 16/906; G06F 2221/2141

(57) ABSTRACT

A system may include a data classification module configured to classify data into classified data based on predefined sensitivity levels and regulatory compliance requirements. A system may include an access control module configured to manage permissions for different user roles within an enterprise, granting access to the classified data in accordance with the sensitivity levels and regulatory compliance requirements. A system may include a data formatting module configured to format classified data into formatted data with customized presentations for various enterprise departments. A system may include an integration module configured to interface with at least one of an Enterprise Resource Planning (ERP) system or a Customer Relationship Management (CRM) system to retrieve and classify the data. A system may include a user interface module configured to present the formatted data within the host application, providing a seamless user experience for accessing the embedded marketplace.

### CROSS-REFERENCE TO RELATED APPLICATIONS

This application is a continuation of International Application No. PCT/US2024/018783, filed 7 Mar. 2024 which claims the benefit of priority to the following U.S. Provisional Patent Application Ser. No. 63/450,638, filed 7 Mar. 2023; Ser. No. 63/461,802, filed 25 Apr. 2023; Ser. No. 63/535,741, filed 31 Aug. 2023; Ser. No. 63/610,890 filed 15 Dec. 2023; Ser. No. 63/621,548, filed 16 Jan. 2024; and Ser. No. 63/625,605 filed 26 Jan. 2024.

Each patent application referenced above is hereby incorporated by reference as if fully set forth herein in its entirety.

### FIELD

The present disclosure relates to embedded marketplaces, and more particularly relates to transaction systems that include embedded marketplaces.

### BACKGROUND

Brought about by exponentially increasing connectivity and intelligence of devices of all types, the world is experiencing orders-of-magnitude increases in scale and granularity of data, as well as the emergence of entirely new types of data, all available to enable or enhance digital transactions in markets of all types. This expansion brings new challenges to parse, analyze, and derive intelligence from the fractally expanding data layers, as well as regulatory and business requirements to understand and act upon the transactions, transactors, and all corporate, individual, or AI intermediaries that operate on or interact with data.

Some transactions relate to marketplaces. Conventional marketplaces often require specific interaction with a particular location. The location may be a geographic location for physical marketplaces or may be a designated IP address or designated application for a specific product or vendor.

Marketplaces provide a range of critical functions for their stakeholders, including the ability to find counterparties who are willing to engage in transactions involving a wide range of asset classes. Among other things, exchange transactions allow parties to unlock liquidity, execute financial strategies (such as with arbitrage), manage risk (such as with options and futures contracts), aggregate capital, convert value from one asset class to another, participate in gains from trade, influence behavior, and obtain insight (such as from data streams about transactions). Successful marketplaces like the New York Stock Exchange (NYSE) and the Chicago Mercantile Exchange (CME) are fundamental components of the global economy, and new exchanges emerge regularly for new categories. Exchanges rely increasingly on information technology infrastructure capabilities for a wide range of core capabilities for trading, presentation, execution, reporting, analytics, reconciliation and other functions, including distributed storage, caching, high speed networking, algorithmic trading, big data, data integration, modeling and analytics, robotic process automation, distributed ledger technologies (DLTs), smart contracts, real-time data collection, search, asset digitization and others. There exists a need in the art to provide intelligent orchestration of markets for a broad and expanding range of asset classes and involving an increasingly diverse set of stakeholders.

### SUMMARY

In embodiments, the techniques described herein relate to a computer-implemented system for providing an embedded marketplace within a host application, the system including: a data classification module configured to classify data into classified data based on predefined sensitivity levels and regulatory compliance requirements; an access control module configured to manage permissions for different user roles within an enterprise, granting access to the classified data in accordance with the sensitivity levels and regulatory compliance requirements; a data formatting module configured to format classified data into formatted data with customized presentations for various enterprise departments; an integration module configured to interface with at least one of an Enterprise Resource Planning (ERP) system and a Customer Relationship Management (CRM) system to retrieve and classify the data; and a user interface module configured to present the formatted data within the host application, providing a seamless user experience for accessing the embedded marketplace.

In embodiments, a host application for embedding the marketplace is an Enterprise Resource Planning (ERP) system, and the data classification module is further configured to classify financial, supply chain, and human resources data for selective presentation to authorized users. In embodiments, a host application for embedding the marketplace is a Customer Relationship Management (CRM) system, and the data formatting module is further configured to generate visual sales funnels and marketing campaign analytics for the sales and marketing departments. In embodiments, a host application for embedding the marketplace is a Product Lifecycle Management (PLM) system, and the integration module is further configured to provide research and development data, including product specifications and testing results, formatted as technical documents. In embodiments, a host application for embedding the marketplace is a governance, risk, and compliance (GRC) platform, and the access control module is further configured to enforce compliance with legal and regulatory standards by restricting access to sensitive compliance-related data. In embodiments, a host application for embedding the marketplace is an IT service management tool, and the user interface module is further configured to display IT asset management data, system performance metrics, and security incident reports in a format tailored for IT department use. In embodiments, a host application for embedding the marketplace is a corporate intranet portal, and the data formatting module is further configured to provide executive dashboards, departmental reports, and company-wide announcements in a centralized location. In embodiments, a host application for embedding the marketplace is a cloud-based collaboration platform, and the integration module is further configured to facilitate data sharing and project management across geographically dispersed teams within the enterprise.

In embodiments, the techniques described herein relate to a computer-implemented system for managing an embedded marketplace within an enterprise, the system including: a data classification module configured to classify enterprise data into classified data based on predefined sensitivity levels and regulatory compliance requirements; an access control module configured to manage permissions for different user roles within the enterprise, granting access to the classified data in accordance with the sensitivity levels and regulatory compliance requirements; a data formatting module configured to format the classified data into formatted data with customized presentations for a set of enterprise departments; an integration module configured to interface with enterprise systems to retrieve and classify the enterprise data, wherein the enterprise systems include at least one of an Enterprise Resource Planning (ERP) system or a Customer Relationship Management (CRM) system; and a user interface module configured to present the formatted data within the host application for accessing the embedded marketplace.

In embodiments, a data classification module utilizes role-based access controls (RBAC) to assign data access permissions. In embodiments, a data classification module tags data with metadata indicating its sensitivity level. In embodiments, an access control module includes a feature for regular audits and real-time monitoring of data access. In embodiments, a data formatting module provides management summaries with high-level graphics, dashboards, and synopses for executive teams. In embodiments, a data formatting module provides detailed reports, raw data sets, and analytical tools for in-depth data analysis by employees. In embodiments, a user interface module allows for customizable views of data according to departmental needs. In embodiments, an integration module includes a data service catalog featuring data processing, analytics, and visualization tools. In embodiments, an integration module is configured to pull relevant data from CRM, SCM, and PLM systems and format it for different departments. In embodiments, a user interface module offers training modules and support services to assist employees in data utilization. In embodiments, an integration module provides a unified platform for centralized data governance across the enterprise. In embodiments, an access control module supports attribute-based access control (ABAC) and RBAC. In embodiments, an integration module automates compliance with regulations by embedding rules directly into data access mechanisms. In embodiments, a user interface module provides advanced search functions to improve data discovery. In embodiments, a user interface module offers personalized data and service recommendations based on user roles and past usage. In embodiments, an integration module is configured to adjust permissions dynamically based on context, wherein the context includes at least one of current projects or collaborations. In embodiments, an integration module supports a scalable architecture to accommodate growing volumes and varieties of data. In embodiments, a user interface module provides an intuitive interface that reduces the learning curve for users. In embodiments, an integration module includes usage tracking and analytics to provide insights into data value and usage patterns. In embodiments, an integration module maintains comprehensive audit trails for security audits and compliance checks. In embodiments, an integration module facilitates subscription-based access to data services for predictable budgeting and cost control.

In embodiments, the techniques described herein relate to a computer-implemented method for embedding a system within a host platform for process automation and artificial intelligence, the method including: identifying, by a processing system, a set of functionalities provided by the host platform; determining, by the processing system, a set of marketplace services relevant to the identified functionalities of the host platform; integrating, by the processing system, an interface of the marketplace services into the host platform, wherein the interface is configured to present the marketplace services contextually based on user interaction with the host platform; configuring, by the processing system, the marketplace services to utilize data from the host platform for personalizing the marketplace services offered to the user; and facilitating, by the processing system, transactions within the embedded marketplace without requiring the user to navigate away from the host platform.

In embodiments, a host platform includes an Enterprise Resource Planning (ERP) system, and the marketplace services are selected based on procurement needs identified by the ERP system. In embodiments, a host platform includes a Customer Relationship Management (CRM) system, and the marketplace services are tailored to offer products or services based on customer profiles and interactions stored within the CRM system. In embodiments, a host platform includes a social media platform, and the marketplace services are configured to offer products or services related to content viewed by the user on the social media platform. In embodiments, a host platform includes an Internet of Things (IoT) device, and the marketplace services are configured to offer maintenance, repair, or related products based on sensor data collected by the IoT device. In embodiments, a host platform includes a digital wallet application, and the marketplace services are configured to offer financial products or services based on the user's financial transactions and preferences. In embodiments, a host platform includes a content creation platform, and the marketplace services are configured to offer digital assets, tools, or services relevant to the content being created by the user. In embodiments, a host platform includes a gaming platform, and the marketplace services are configured to offer in-game items, virtual goods, or physical merchandise related to the game being played by the user. In embodiments, a marketplace services include artificial intelligence algorithms to predict user needs and proactively present relevant marketplace services within the host platform. In embodiments, a marketplace services are configured to utilize process automation for handling transactions within the embedded marketplace, wherein the transactions include payment processing, order fulfillment, and post-transaction customer service.

In embodiments, the techniques described herein relate to a method, further including: collecting, by the processing system, feedback from the user regarding the marketplace services; and adjusting, by the processing system using an artificial intelligence algorithm, the marketplace services based on the collected feedback to improve relevance and user satisfaction within the embedded marketplace.

In embodiments, the techniques described herein relate to a computer-implemented method for managing procurement within an enterprise, the method including: intercepting web browser traffic initiated by enterprise employees; analyzing the intercepted traffic to identify procurement-related actions; accessing a regulatory database to determine compliance with applicable laws and enterprise policies; evaluating procurement requests based on budgetary constraints and employee authorization levels; and controlling the execution of procurement transactions by permitting, modifying, or blocking based on compliance and authorization evaluations.

In embodiments, the techniques described herein relate to a system for automated procurement management in an enterprise environment, including: a network traffic analysis module configured to monitor and evaluate web-based procurement activities; a compliance assessment engine integrated with a regulatory database for real-time compliance verification; an approval management module to facilitate and track the approval process for procurement requests; and a transaction execution module that enforces compliance and approval outcomes by managing the finalization of procurement transactions.

In embodiments, the techniques described herein relate to a computer-implemented system for integrating a marketplace into a digital twin, the system including: a processing system configured to generate a digital twin representing a physical asset, wherein the digital twin includes real-time data reflecting the status, condition, and performance of the physical asset; a marketplace module embedded within the digital twin, configured to facilitate transactions related to the physical asset, wherein the marketplace module includes listing, purchasing, and transaction processing functionalities; a data analysis module configured to utilize the real-time data from the digital twin to identify needs or opportunities for transactions within the marketplace module; and a communication interface configured to present transaction opportunities to users and enable user interaction with the marketplace module through the digital twin.

In embodiments, a marketplace module is further configured to offer predictive maintenance services for the physical asset based on the analysis wherein the marketplace module is further configured to provide recommendations for spare parts and consumables that are compatible with the physical asset. In embodiments, a marketplace module includes a smart contract functionality configured to automate the execution of transactions based on predefined rules derived from the real-time data. In embodiments, a marketplace module is further configured to offer insurance services, wherein the terms of the insurance services are dynamically adjusted based on the real-time data from the digital twin. In embodiments, a marketplace module is further configured to facilitate the resale or leasing of the physical asset by connecting potential buyers or lessees with the digital twin. In embodiments, a marketplace module is further configured to integrate with third-party service providers, enabling the offering of extended services related to the physical asset. In embodiments, a marketplace module is further configured to utilize machine learning algorithms to personalize the transaction opportunities presented to the user based on user behavior and preferences.

In embodiments, a marketplace module is further configured to support a virtual reality interface, allowing users to interact with the digital twin and marketplace in an immersive environment. In embodiments, a marketplace module is further configured to provide a platform for user-generated content, wherein users can list custom modifications or enhancements related to the physical asset. In embodiments, a marketplace module is further configured to aggregate data from multiple digital twins representing a fleet, wherein the marketplace module is further configured to enable energy trading services for digital twins representing energy-consuming or energy-generating assets, based on real-time energy usage and production data. In embodiments, a marketplace module is further configured to offer subscription-based services related to the physical asset, wherein the subscription terms are modifiable in response to changes in the real-time data. In embodiments, a marketplace module is further configured to provide a feedback mechanism for users to rate and review transactions, which influences the presentation of future transaction opportunities within the marketplace. In embodiments, a marketplace module is further configured to support regulatory compliance monitoring, wherein transactions are automatically adjusted to adhere to applicable laws and regulations based on the real-time data.

In embodiments, the techniques described herein relate to a system for providing an integrated transaction platform, the system including: an embedded marketplace module configured to aggregate offerings from multiple vendors within a user interface of a host application; a data aggregation system configured to collect and process data from various sources to personalize the aggregated offerings based on user preferences and behavior; a transaction execution module configured to facilitate the purchase, sale, and exchange of goods and services within the embedded marketplace; a blockchain interface configured to interact with one or more distributed ledgers for recording transactions executed within the embedded marketplace; and a smart contract module configured to generate and enforce agreements related to transactions within the embedded marketplace based on predefined rules and conditions.

In embodiments, an embedded marketplace module is further configured to present a unified view of aggregated offerings across multiple external marketplaces. In embodiments, a data aggregation system utilizes machine learning algorithms to refine personalization based on real-time user interactions with the embedded marketplace. In embodiments, a transaction execution module is further configured to process payments using at least one of fiat currency or cryptocurrency. In embodiments, a blockchain interface is further configured to support multiple blockchain protocols to ensure compatibility with various distributed ledger technologies. In embodiments, a smart contract module is further configured to automatically adjust contract terms based on changes in regulatory requirements. In embodiments, the techniques described herein relate to a system, further including a robotic process automation (RPA) module configured to automate procurement processes based on inventory levels and predictive demand analysis. In embodiments, an RPA module is further configured to interface with vendor management systems to streamline supply chain operations. In embodiments, an embedded marketplace module is further configured to integrate with digital twin representations of physical assets for enhanced visualization of offerings. In embodiments, a transaction execution module includes a recommendation engine to suggest ancillary services related to the primary offerings. In embodiments, a blockchain interface is configured for tokenizing assets to facilitate asset trading within the embedded marketplace. In embodiments, a smart contract module includes a dispute resolution mechanism that automatically triggers based on transaction anomalies. In embodiments, a data aggregation system is further configured to aggregate at least one of social media data and IoT device data to enhance offering personalization. In embodiments, an embedded marketplace module is further configured to provide location-based services and to offer goods and services relevant to a geographic location of the user. In embodiments, a transaction execution module is further configured to support subscription-based transactions for recurring purchases within the embedded marketplace. In embodiments, a blockchain interface is further configured to provide audit trails for transactions to ensure transparency and compliance. In embodiments, a smart contract module is further configured to integrate with external contract management systems for cross-platform contract synchronization. In embodiments, an RPA module is further configured to automate compliance checks against enterprise policies during the procurement process. In embodiments, an embedded marketplace module is further configured to embed marketplaces within virtual reality environments for immersive shopping experiences. In embodiments, a transaction execution module is further configured to enable peer-to-peer transactions without intermediary involvement, leveraging the blockchain interface and smart contract module.

In embodiments, the techniques described herein relate to a computer-implemented system for managing transactions within an enterprise ecosystem, the system including: a processor; a memory storing instructions that, when executed by the processor, cause the system to: integrate an embedded marketplace with an enterprise access layer (EAL) that interfaces with a plurality of enterprise resources; automate procurement and sales processes by interfacing the embedded marketplace with a workflow systems of the enterprise; utilize a data services system to manage listings, transactions, and user profiles within the embedded marketplace; implement an intelligence system to provide predictive analytics for market trends and demand forecasting within the embedded marketplace; enforce security and compliance through a permissions system that controls access to functions of the embedded marketplace; manage digital transactions via a wallets system that interfaces with the embedded marketplace; and generate reports on marketplace activity through a reporting system that is communicatively coupled with the embedded marketplace.

In embodiments, instructions further cause the system to collect real-time data and analyze the real-time data to provide personalized recommendations for goods or services to users based on their historical transaction data. In embodiments, instructions further cause the system to implement a smart contract orchestration engine to automate transactional workflows within the enterprise ecosystem. In embodiments, instructions further cause the system to operate in conjunction with technologies deployed in private networks of the enterprise, the private networks including at least one of on-premises and cloud resources and platforms. In embodiments, instructions further cause the system to tokenize digital assets to digitally represent transactions within the enterprise ecosystem. In embodiments, instructions further cause the system to facilitate transactions with external entities by providing a set of network resources for bilateral or multilateral transactions involving the enterprise. In embodiments, instructions further cause the system to simplify transactions for an enterprise by allowing the enterprise to interface with multiple markets, marketplaces, exchanges, and platforms through a common point of access. In embodiments, instructions further cause the system to employ a blockchain to manage and secure transactions within the enterprise ecosystem. In embodiments, instructions further cause the system to include a generative content system that utilizes a large language model (LLM) trained on enterprise-specific data to propose new workflows for enterprise processes.

In embodiments, the techniques described herein relate to a computer-implemented system for facilitating transactions within an embedded marketplace enterprise ecosystem, including: a processor; a memory storing instructions that, when executed by the processor, cause the system to: integrate an embedded marketplace with an enterprise's digital infrastructure; automate transactional processes by interfacing the embedded marketplace with a workflow system of the enterprise; manage listings, transactions, and user profiles within the embedded marketplace using a data services system; provide analytics and insights for strategic decision-making within the embedded marketplace through an intelligence system; enforce security and compliance protocols via a permissions system that controls access to the embedded marketplace; and facilitate digital transactions through a wallets system that interfaces with the embedded marketplace.

In embodiments, an embedded marketplace utilizes a large language model (LLM) trained on enterprise-specific data to assist in generating and optimizing transactional workflows. In embodiments, an embedded marketplace employs robotic process automation (RPA) to streamline procurement and sales processes by automating repetitive tasks and data handling. In embodiments, an embedded marketplace includes a digital twin of the enterprise ecosystem to simulate and analyze marketplace dynamics and enterprise resource planning scenarios. In embodiments, an embedded marketplace integrates with a blockchain network to manage and secure transactions, ensuring data integrity and traceability. In embodiments, an embedded marketplace is configured to use artificial intelligence (AI) for dynamic pricing strategies based on real-time market data and predictive analytics. In embodiments, an embedded marketplace incorporates a smart contract orchestration engine to automate agreement execution and compliance with contractual terms. In embodiments, an embedded marketplace is capable of interfacing with Internet of Things (IoT) devices to facilitate transactions based on sensor data and automated triggers. In embodiments, an embedded marketplace utilizes machine learning algorithms to personalize product recommendations based on user behavior and preferences. In embodiments, an embedded marketplace is further configured to support subscription services, allowing for recurring transactions and customer retention strategies. In embodiments, an embedded marketplace includes a virtual assistant powered by natural language processing (NLP) to aid users in navigating the marketplace and completing transactions. In embodiments, an embedded marketplace is designed to integrate with virtual and augmented reality (VR/AR) platforms to provide immersive product demonstrations and virtual showrooms. In embodiments, an embedded marketplace is configured to tokenize digital assets, representing ownership and transactions of digital and physical goods within the enterprise ecosystem. In embodiments, an embedded marketplace is further configured to facilitate cross-border transactions by incorporating multi-currency and language support. In embodiments, an embedded marketplace employs a customer relationship management (CRM) system to track interactions and transactions with customers, enhancing customer service and engagement. In embodiments, an embedded marketplace is further configured to integrate with supply chain management systems to optimize inventory levels and logistics. In embodiments, an embedded marketplace includes an API gateway to allow third-party applications and services to interact with the marketplace ecosystem. In embodiments, an embedded marketplace is further configured to employ a fraud detection system that uses anomaly detection techniques to identify and prevent fraudulent transactions. In embodiments, an embedded marketplace is configured to support a peer-to-peer (P2P) network for direct transactions between users without intermediary involvement. In embodiments, an embedded marketplace includes a feedback and rating system that employs sentiment analysis to gauge customer satisfaction and improve service offerings.

These and other features, and characteristics of the present technology, as well as the methods of operation and functions of the related elements of structure and the combination of parts and economies of the manufacturer, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise. A more complete understanding of the disclosure will be appreciated from the description and accompanying drawings and the claims, which follow.

### BRIEF DESCRIPTION OF THE FIGURES

The disclosure and the following detailed description of certain embodiments thereof may be understood by reference to the following figures:

FIG. 1 is a schematic diagram of components of a platform for enabling intelligent transactions in accordance with embodiments of the present disclosure.

FIGS. 2A and 2B are schematic diagrams of additional components of a platform for enabling intelligent transactions in accordance with embodiments of the present disclosure.

### Intelligence Services System FIGS.

FIG. 3 is a schematic view of an example of an intelligence services system according to some embodiments.

FIG. 4 is a schematic view of an example of a neural network according to some embodiments.

FIG. 5 is a schematic view of an example of a convolutional neural network according to some embodiments.

FIG. 6 is a schematic view of an example of a neural network according to some embodiments.

FIG. 7 is a diagram of an approach based on reinforcement learning according to some embodiments.

FIG. 8 depicts a block diagram of exemplary features, capabilities, and interfaces of a robust generative artificial intelligence platform.

### Enterprise Access Layer FIGS.

FIG. 9 is a schematic view of an example of an enterprise ecosystem including an enterprise access layer.

FIG. 10 is a functional block diagram of an example implementation of an enterprise access layer.

FIG. 11 is a schematic view of examples of how the enterprise access layer of FIG. 10 may be integrated with portions of an enterprise ecosystem.

FIG. 12 is a schematic view of an example market orchestration system that includes an enterprise access layer.

FIG. 13 is a functional block diagram of an example implementation of an intelligence system.

FIG. 14 is a functional block diagram of an example implementation of a data pool system.

FIG. 15 is a functional block diagram of an example implementation of a scoring system.

FIG. 16 is a simplified diagram of a determination of attention by a machine learning model in accordance with some embodiments.

FIG. 17 is a simplified diagram of a transformer model in accordance with some embodiments.

FIG. 18 is a simplified diagram of financial infrastructure systems in accordance with some embodiments.

### Process Automation and Artificial Intelligence FIGS.

FIG. 19 provides an exemplary block diagram illustration of a transaction environment (e.g., a marketplace or a set of marketplaces), in accordance with example embodiments of the disclosure.

FIG. 20 provides an exemplary block diagram illustration of a system implementing a processing system for automation of transactions in the marketplace, in accordance with example embodiments of the disclosure.

FIG. 21 provides an exemplary block diagram illustration of the processing system of FIG. 20 showing various modules therein, in accordance with example embodiments of the disclosure.

FIG. 22 provides an exemplary flowchart for automation of transactions in the marketplace, in accordance with example embodiments of the disclosure.

FIG. 23 provides an exemplary block diagram illustration of a system implementing a processing system for managing transactions in the marketplace, in accordance with example embodiments of the disclosure.

FIG. 24 provides an exemplary block diagram illustration of the processing system of FIG. 23 showing various modules therein, in accordance with example embodiments of the disclosure.

FIG. 25 provides an exemplary flowchart for automation of transactions in the marketplace, in accordance with example embodiments of the disclosure.

FIG. 26 provides an exemplary block diagram illustration of a system implementing a processing system for automating processing of transactions in the marketplace, in accordance with example embodiments of the disclosure.

FIG. 27 provides an exemplary block diagram illustration of the processing system of FIG. 26 showing various modules therein, in accordance with example embodiments of the disclosure.

FIG. 28 provides an exemplary flowchart for automating processing of transactions in the marketplace, in accordance with example embodiments of the disclosure.

FIG. 29 provides an exemplary block diagram illustration of a system for automated orchestration of the marketplace, in accordance with example embodiments of the disclosure.

FIG. 30 provides an exemplary flowchart for automated orchestration of the marketplace, in accordance with example embodiments of the disclosure.

FIG. 31 provides an exemplary block diagram illustration of a system for augmenting of services in the marketplace, in accordance with example embodiments of the disclosure.

FIG. 32 provides an exemplary flowchart for augmenting of services in the marketplace, in accordance with example embodiments of the disclosure.

FIG. 33 is a schematic diagram of an embedded marketplace system in accordance with embodiments of the present disclosure.

FIG. 34 is a schematic diagram of an embedded marketplace platform for use with an embedded marketplace system in accordance with embodiments of the present disclosure.

### DETAILED DESCRIPTION

### Transaction Platform

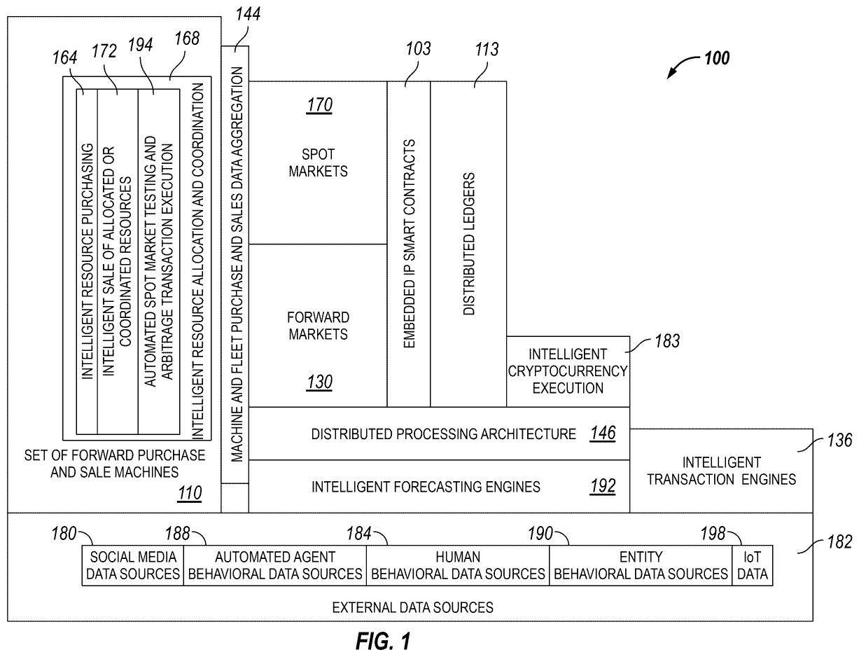

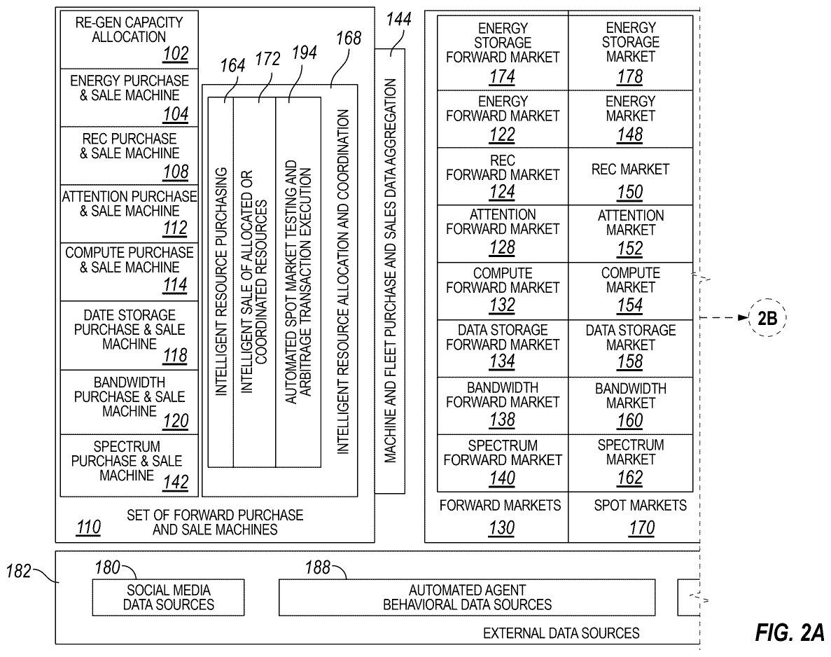

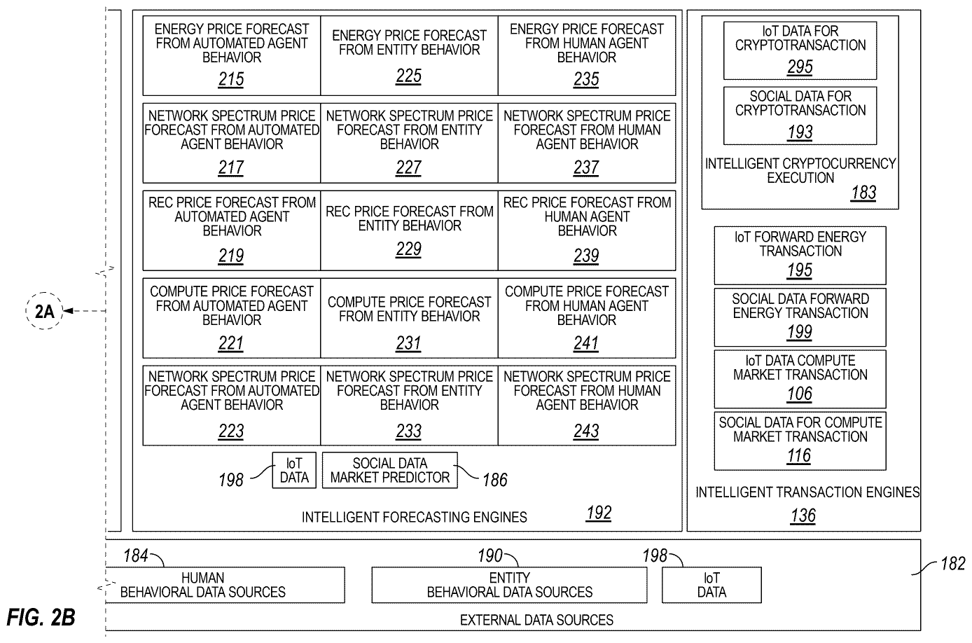

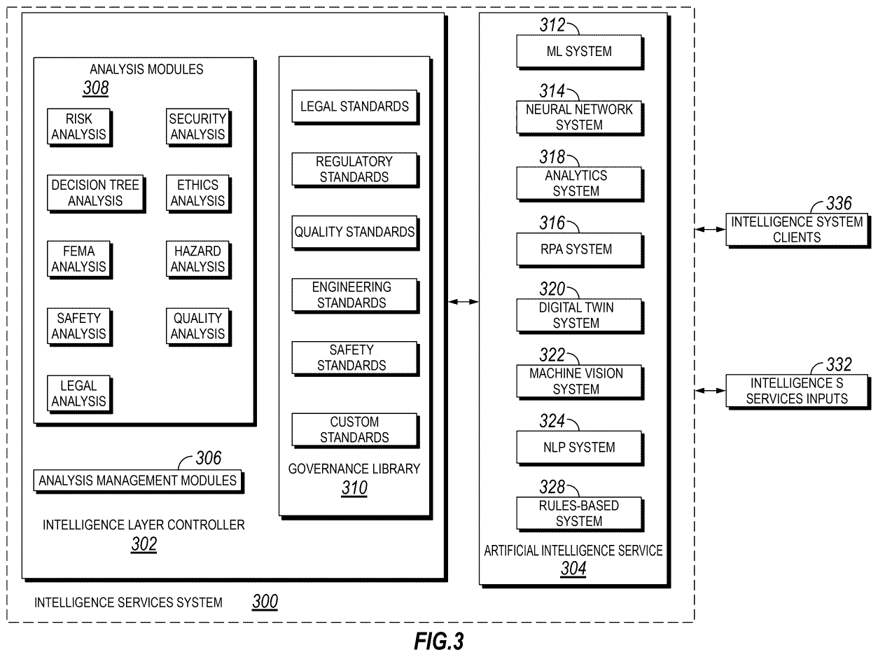

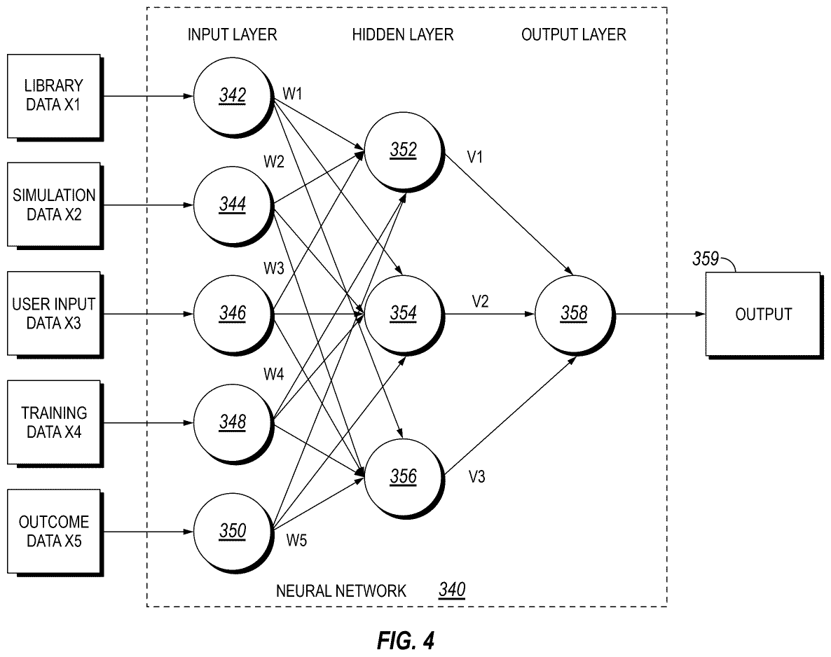

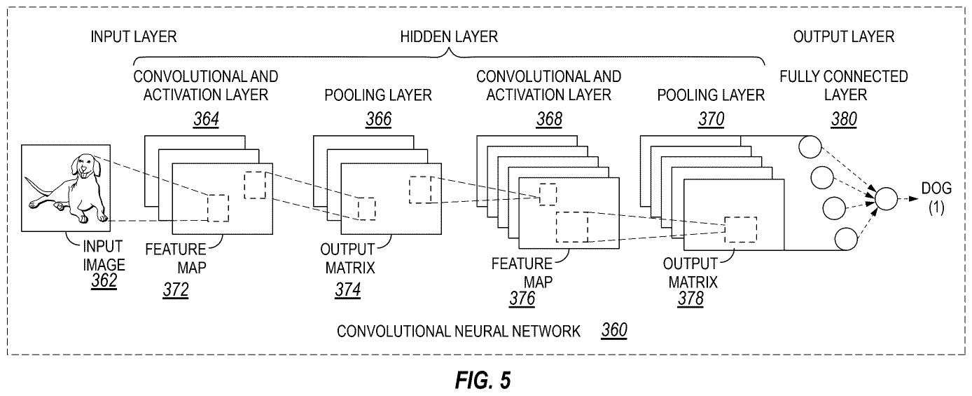

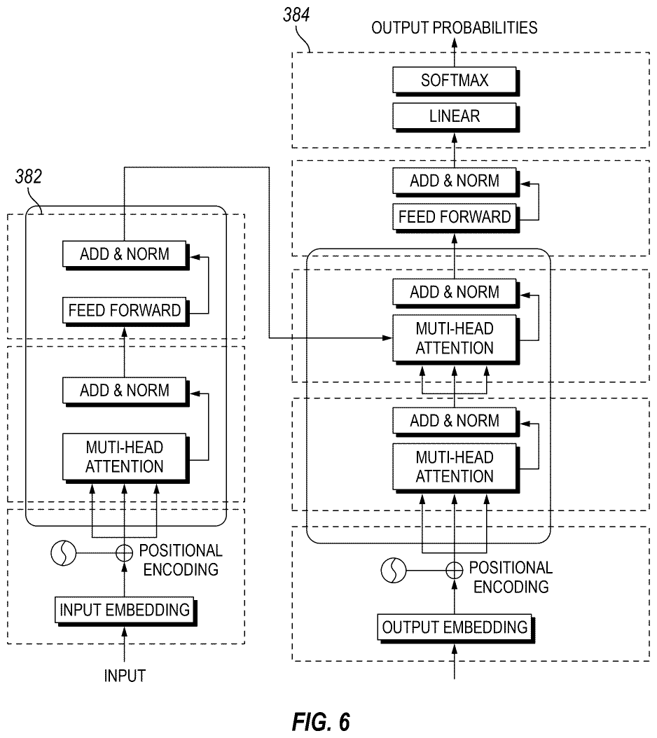

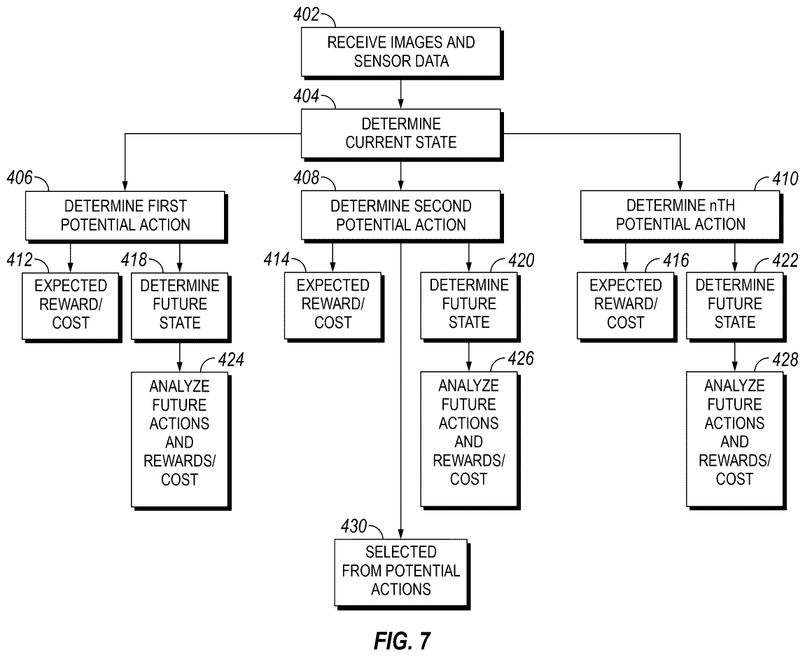

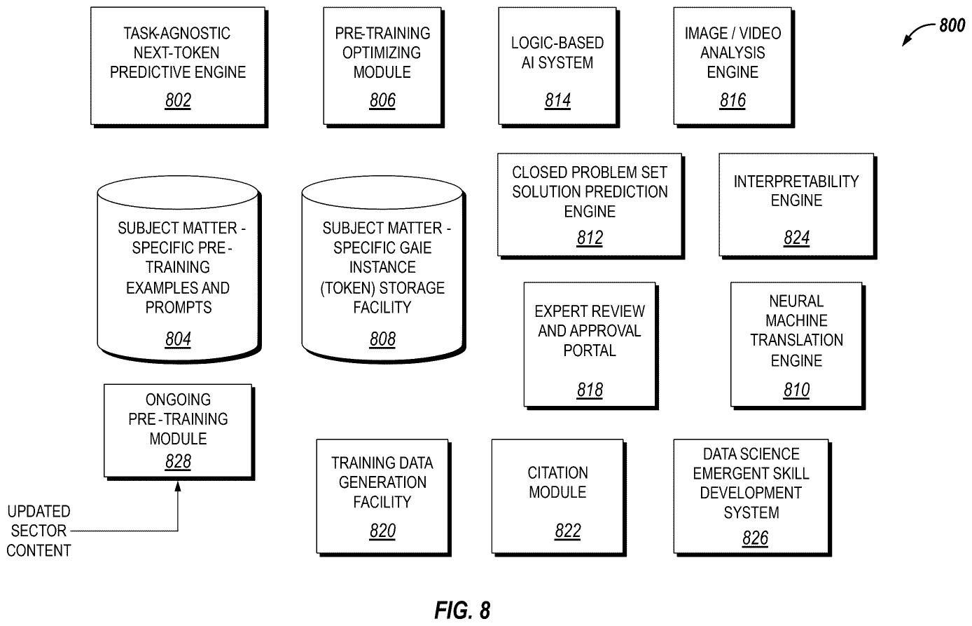

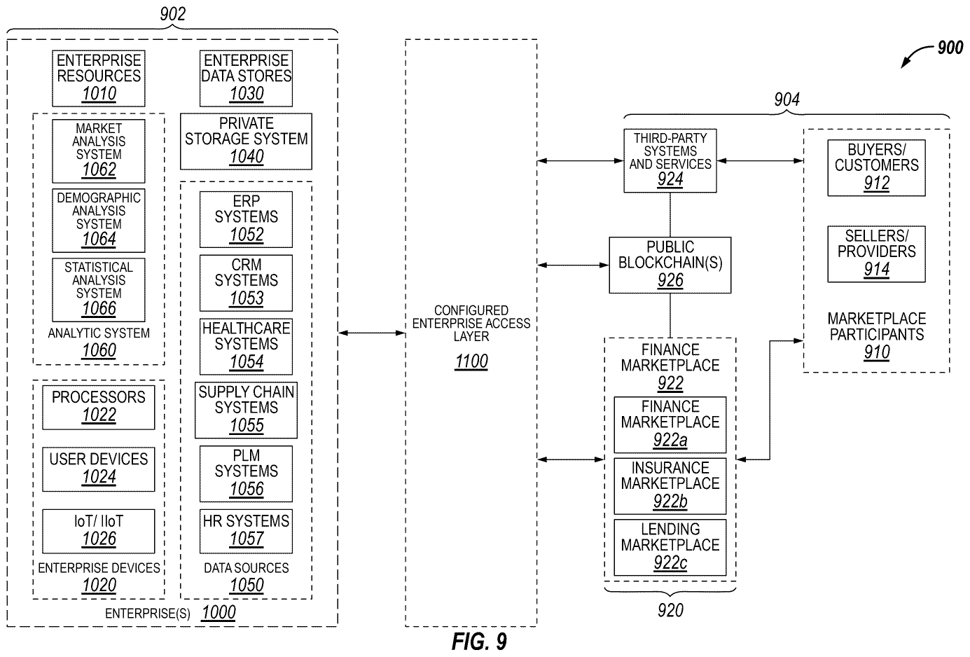

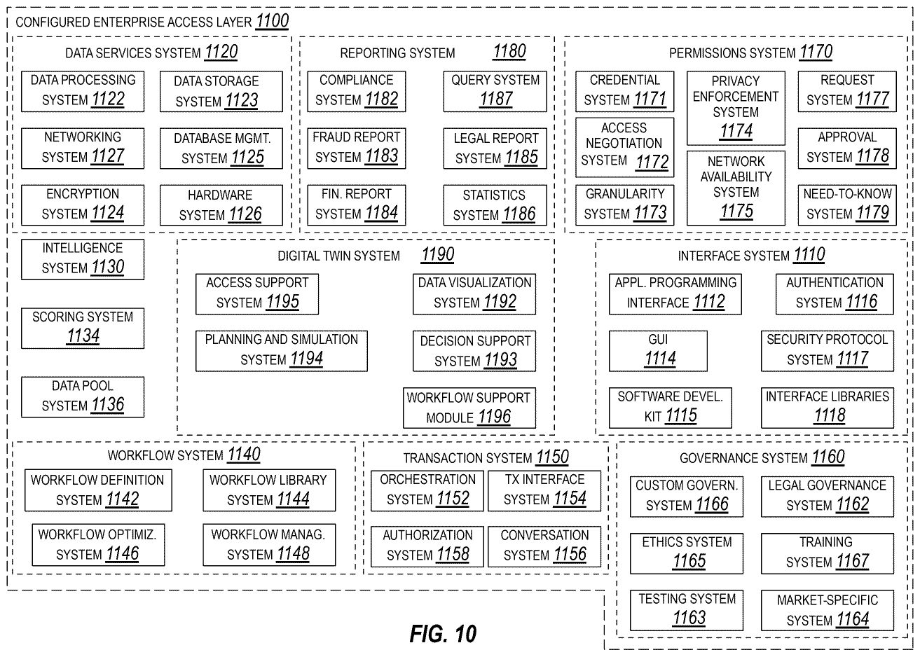

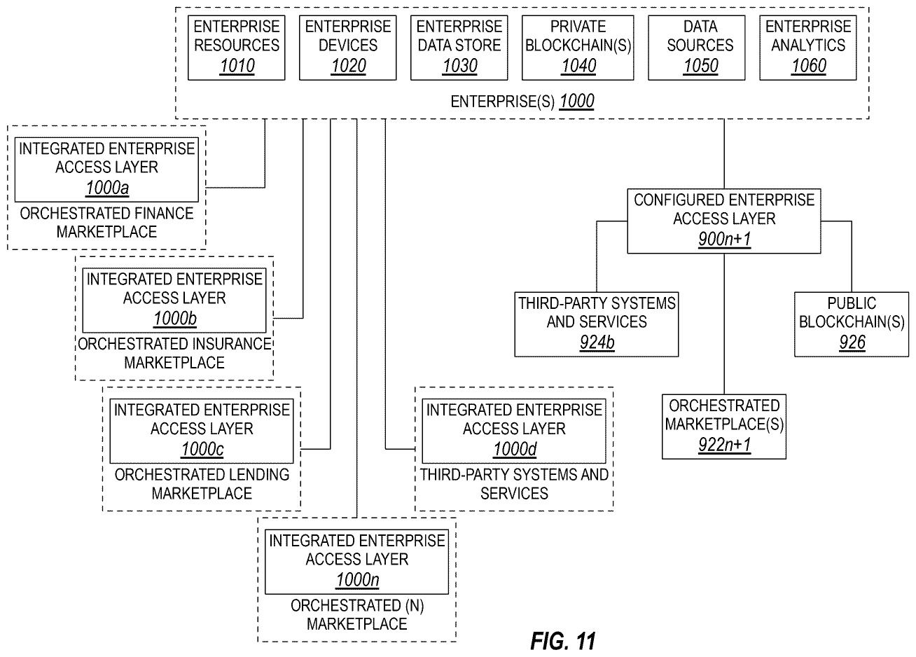

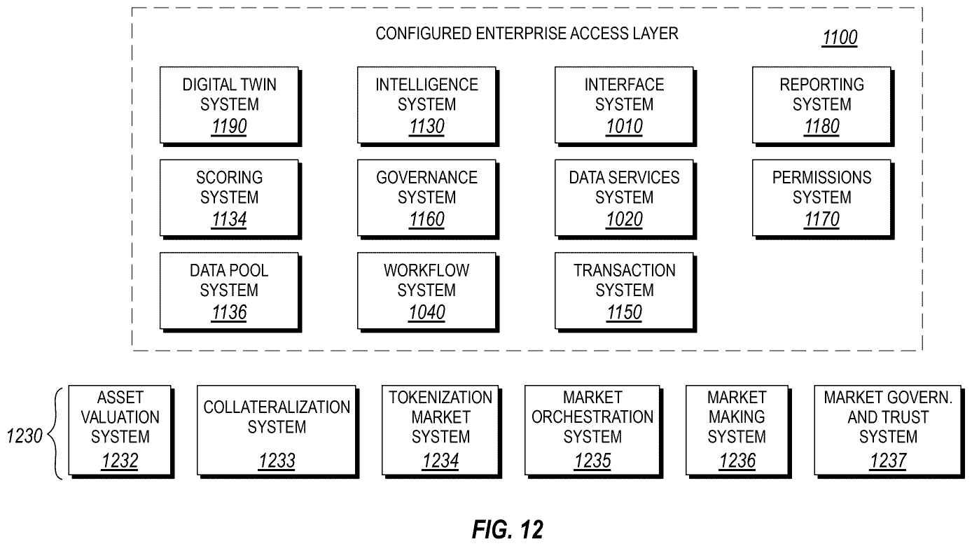

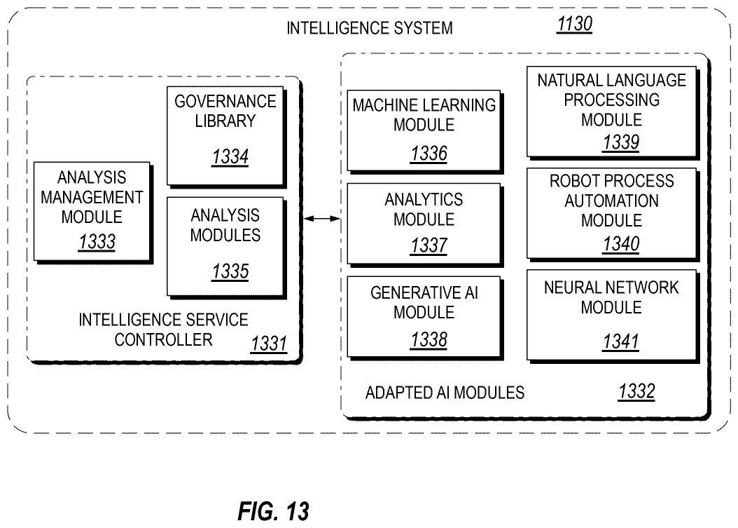

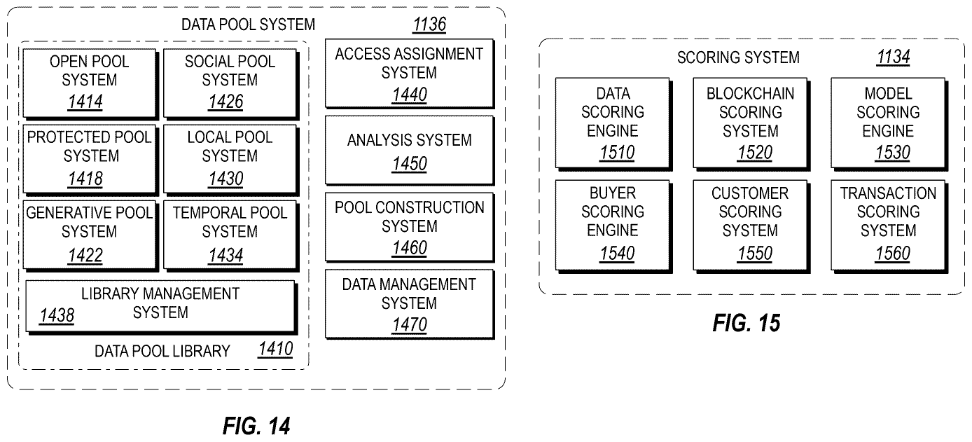

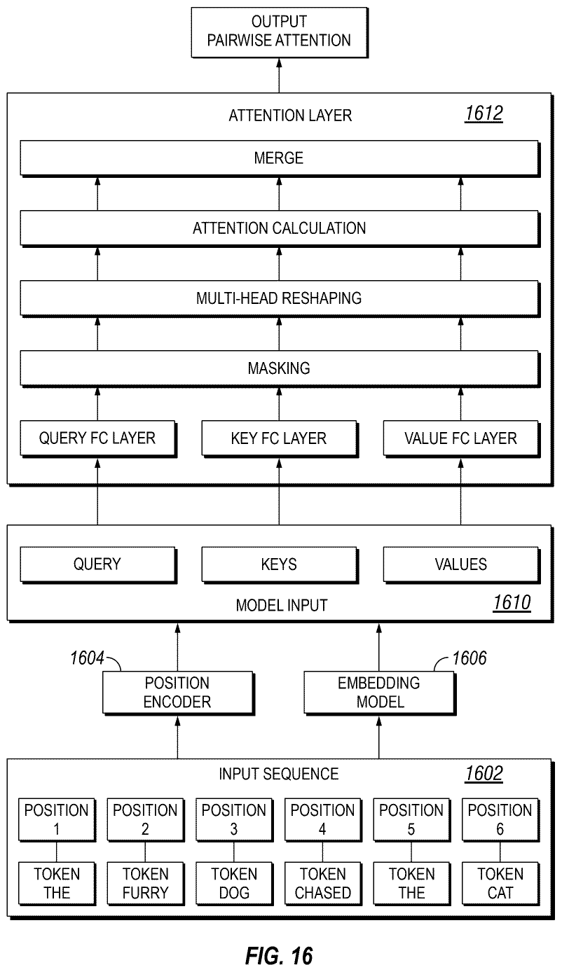

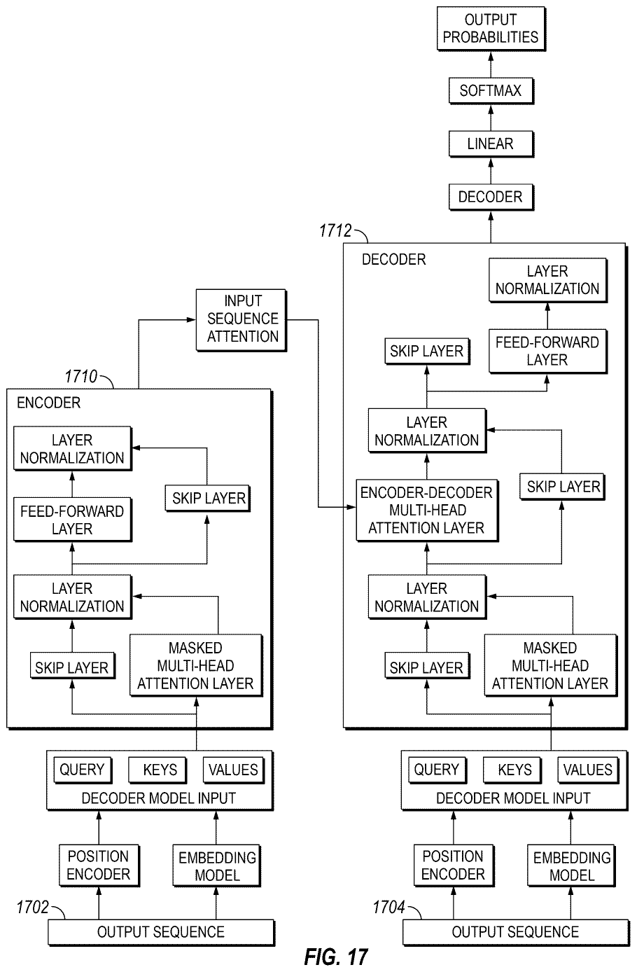

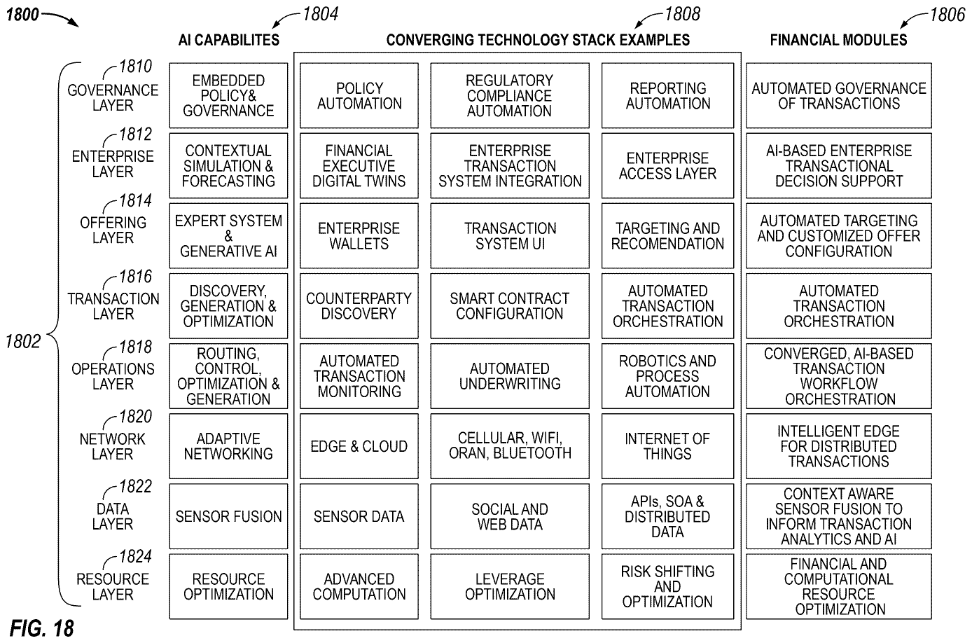

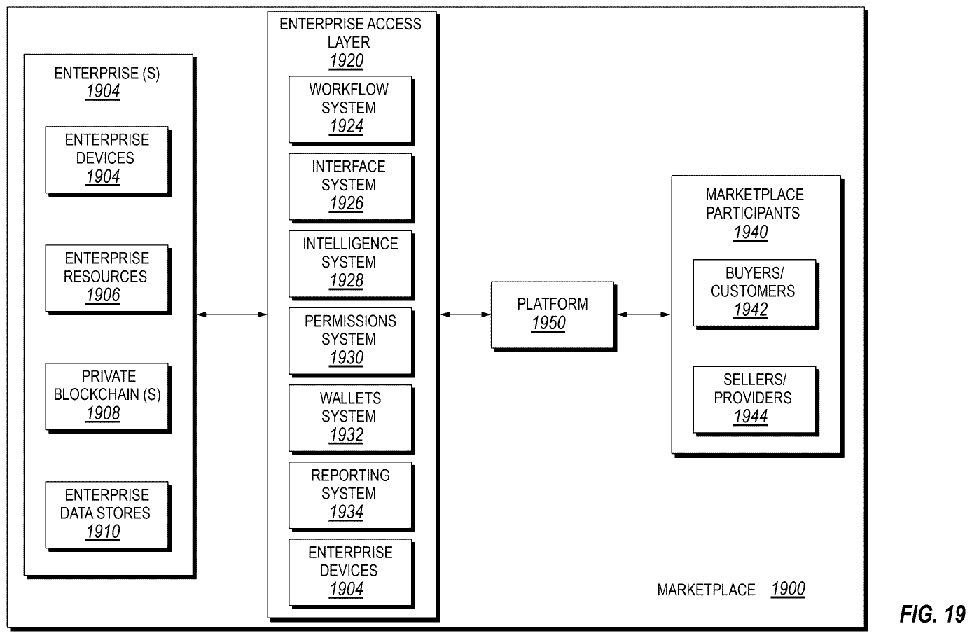

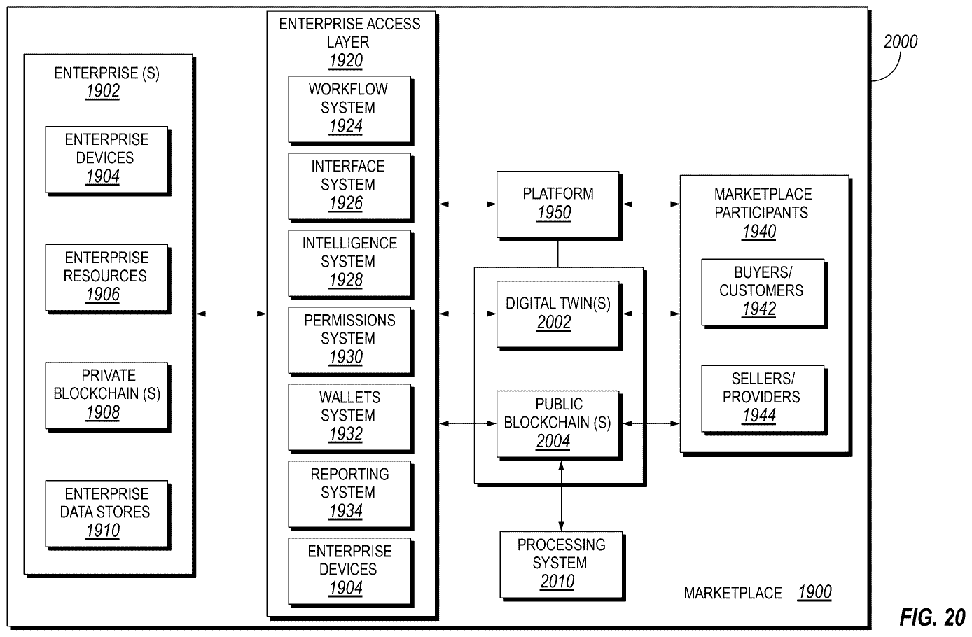

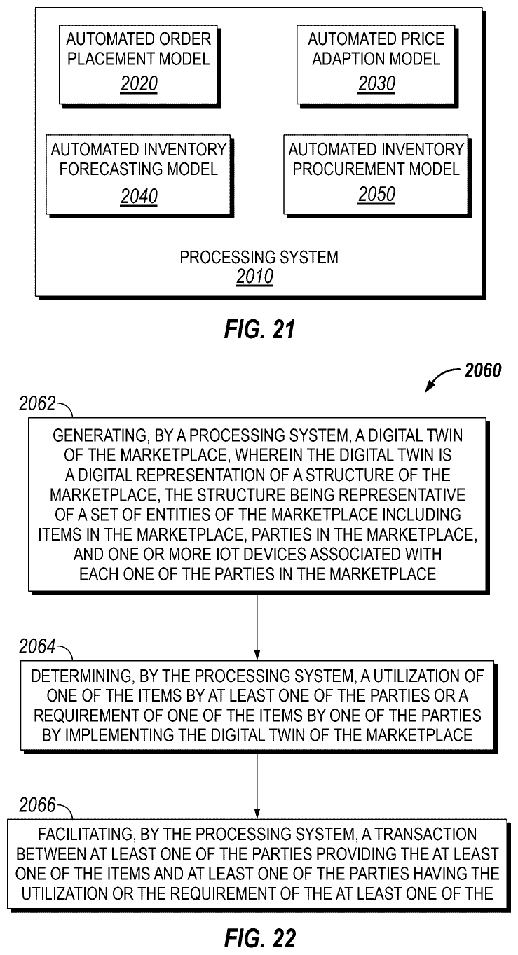

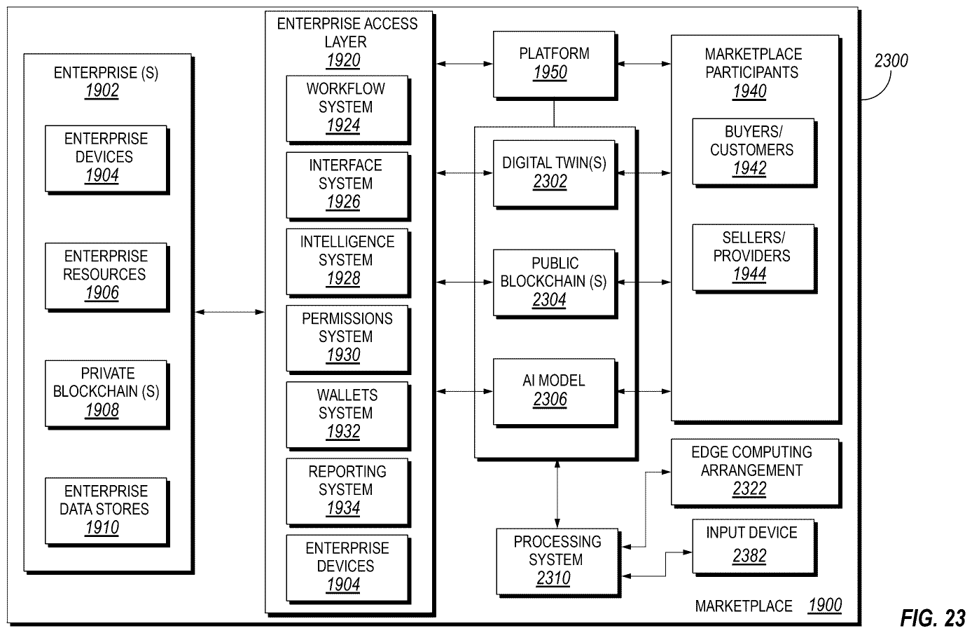

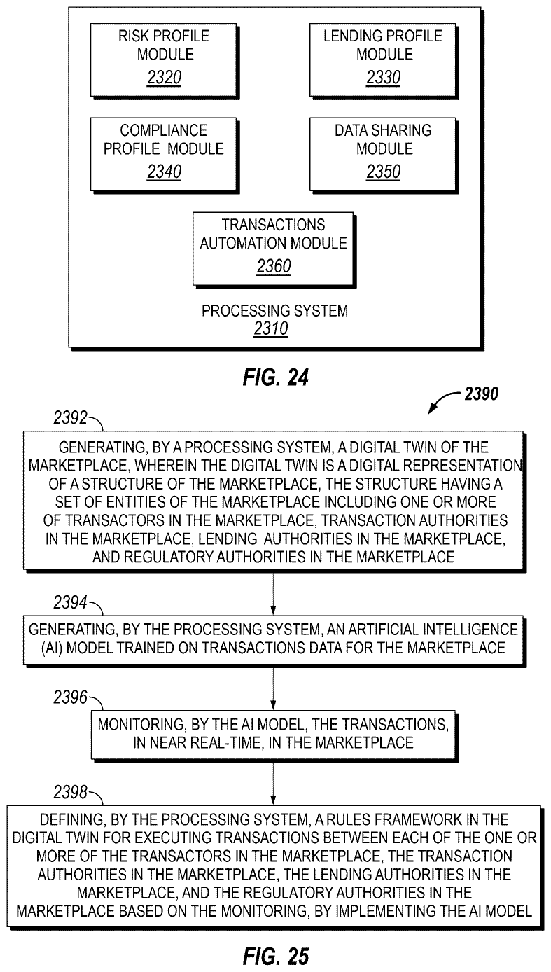

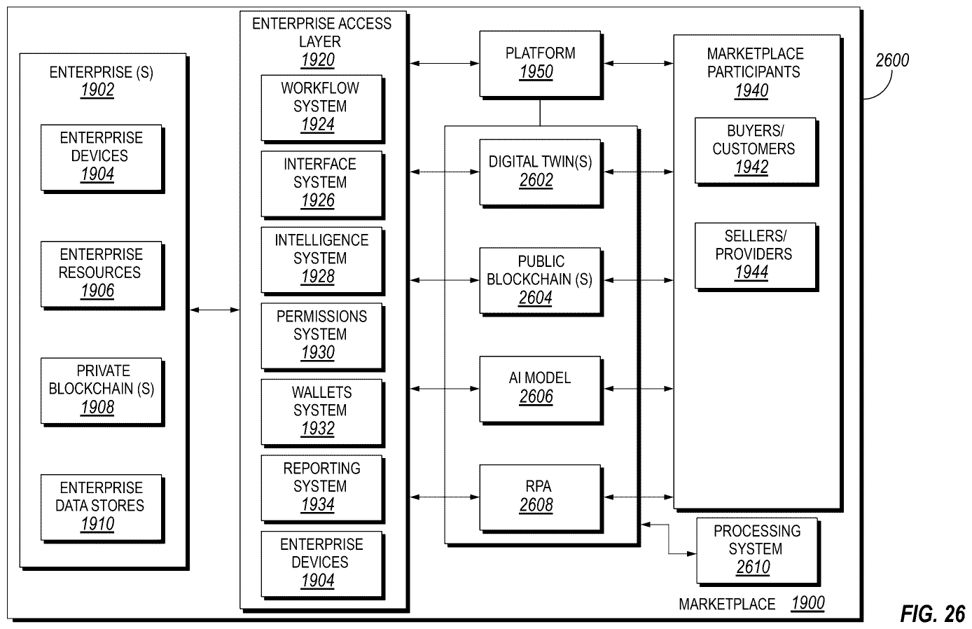

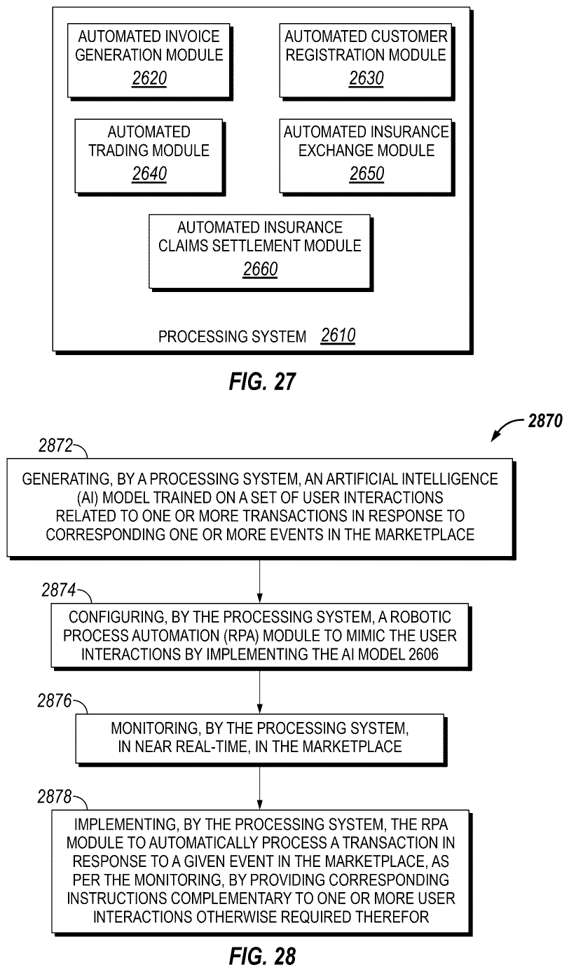

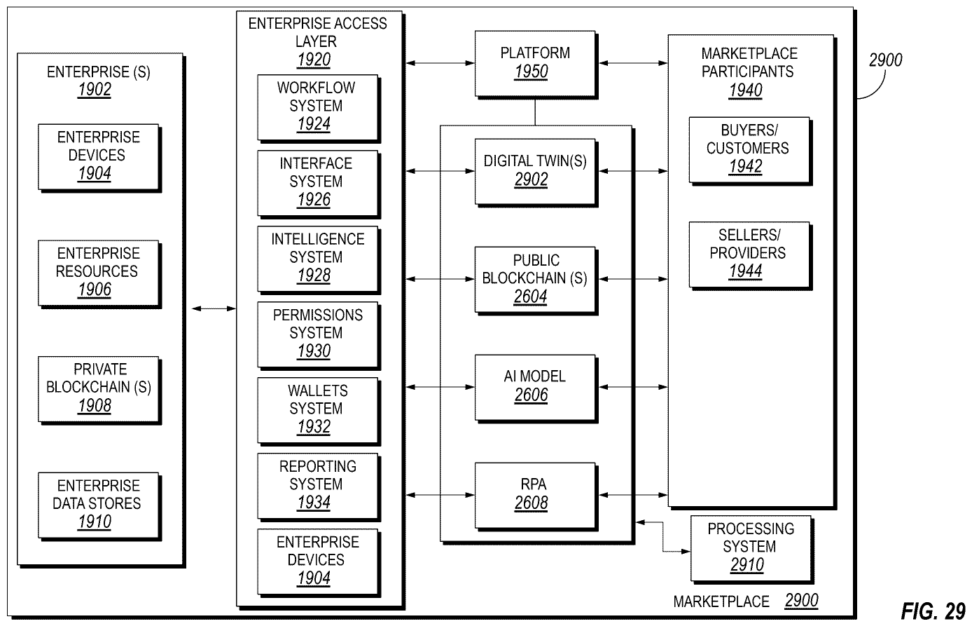

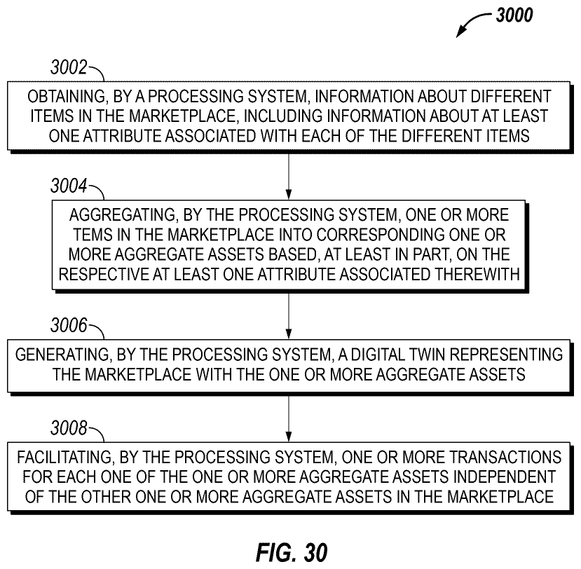

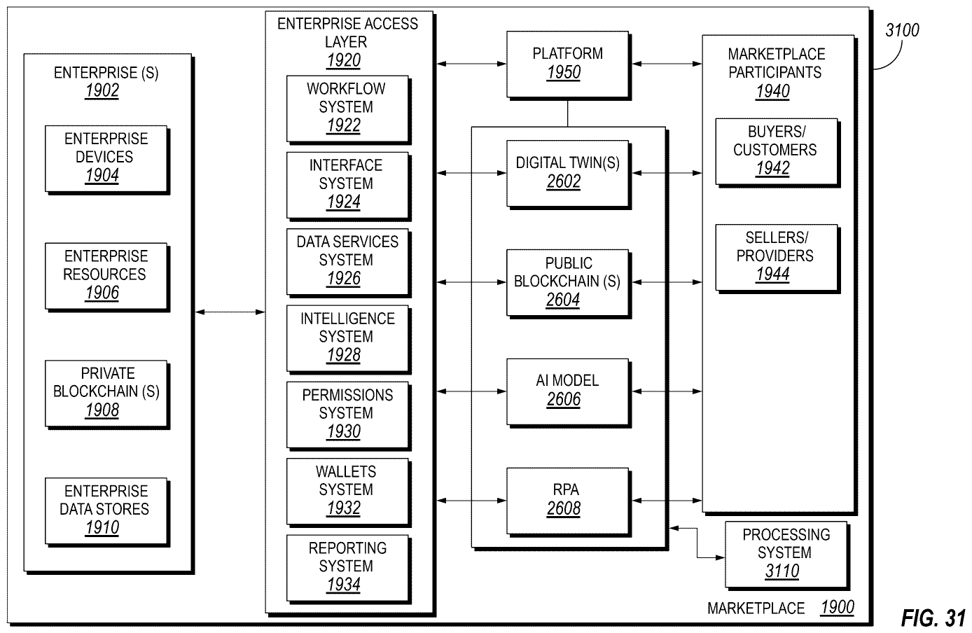

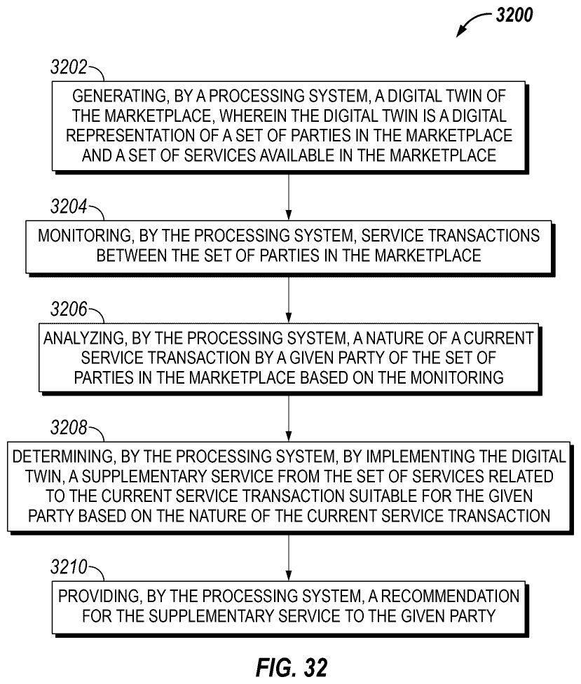

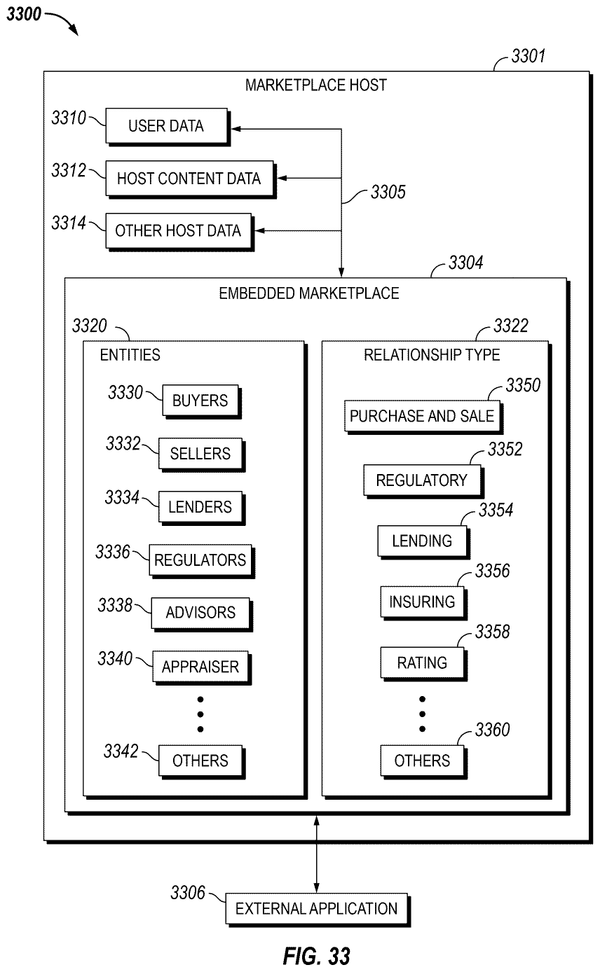

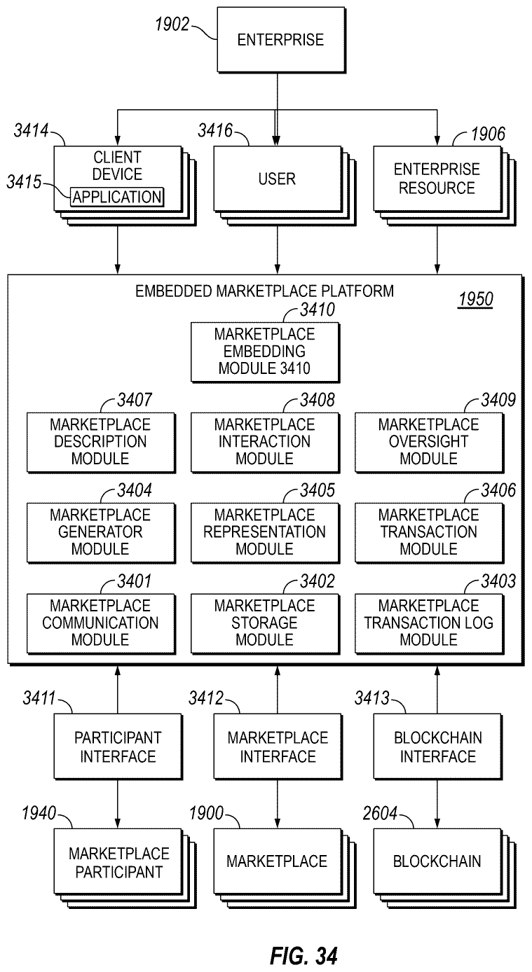

Referring to FIGS. 1, 2A and 2B, a set of systems, methods, components, modules, machines, articles, blocks, circuits, services, programs, applications, hardware, software and other elements are provided, collectively referred to herein interchangeably as the system or the platform 100, The platform 100 enables a wide range of improvements of and for various machines, systems, and other components that enable transactions involving the exchange of value (such as using currency, cryptocurrency, tokens, rewards or the like, as well as a wide range of in-kind and other resources) in various markets, including current or spot markets 170, forward markets 130 and the like, for various goods, services, and resources. As used herein, “currency” should be understood to encompass fiat currency issued or regulated by governments, cryptocurrencies, tokens of value, tickets, loyalty points, rewards points, coupons, and other elements that represent or may be exchanged for value. Resources, such as ones that may be exchanged for value in a marketplace, should be understood to encompass goods, services, natural resources, energy resources, computing resources, energy storage resources, data storage resources, network bandwidth resources, processing resources and the like, including resources for which value is exchanged and resources that enable a transaction to occur (such as necessary computing and processing resources, storage resources, network resources, and energy resources that enable a transaction). The platform 100 may include a set of forward purchase and sale machines 110, each of which may be configured as an expert system or automated intelligent agent for interaction with one or more of the set of spot markets 170 and forward markets 130. Enabling the set of forward purchase and sale machines 110 are an intelligent resource purchasing system 164 having a set of intelligent agents for purchasing resources in spot and forward markets; an intelligent resource allocation and coordination system 168 for the intelligent sale of allocated or coordinated resources, such as compute resources, energy resources, and other resources involved in or enabling a transaction; an intelligent sale engine 172 for intelligent coordination of a sale of allocated resources in spot and futures markets; and an automated spot market testing and arbitrage transaction execution engine 194 for performing spot testing of spot and forward markets, such as with micro-transactions and, where conditions indicate favorable arbitrage conditions, automatically executing transactions in resources that take advantage of the favorable conditions. Each of the engines may use model-based or rule-based expert systems, such as based on rules or heuristics, as well as deep learning systems by which rules or heuristics may be learned over trials involving a large set of inputs. The engines may use any of the expert systems and artificial intelligence capabilities described throughout this disclosure. Interactions within the platform 100, including of all platform components, and of interactions among them and with various markets, may be tracked and collected, such as by a data aggregation system 144, such as for aggregating data on purchases and sales in various marketplaces by the set of machines described herein. Aggregated data may include tracking and outcome data that may be fed to artificial intelligence and machine learning systems, such as to train or supervise the same. The various engines may operate on a range of data sources, including aggregated data from marketplace transactions, tracking data regarding the behavior of each of the engines, and a set of external data sources 182, which may include social media data sources 180 (such as social networking sites like Facebook™ and Twitter™), Internet of Things (IoT) data sources (including from sensors, cameras, data collectors, and instrumented machines and systems), such as IoT sources that provide information about machines and systems that enable transactions and machines and systems that are involved in production and consumption of resources. External data sources 182 may include behavioral data sources, such as automated agent behavioral data sources 188 (such as tracking and reporting on behavior of automated agents that are used for conversation and dialog management, agents used for control functions for machines and systems, agents used for purchasing and sales, agents used for data collection, agents used for advertising, and others), human behavioral data sources (such as data sources tracking online behavior, mobility behavior, energy consumption behavior, energy production behavior, network utilization behavior, compute and processing behavior, resource consumption behavior, resource production behavior, purchasing behavior, attention behavior, social behavior, and others), and entity behavioral data sources 190 (such as behavior of business organizations and other entities, such as purchasing behavior, consumption behavior, production behavior, market activity, merger and acquisition behavior, transaction behavior, location behavior, and others). The IoT, social and behavioral data from and about sensors, machines, humans, entities, and automated agents may collectively be used to populate expert systems, machine learning systems, and other intelligent systems and engines described throughout this disclosure, such as being provided as inputs to deep learning systems and being provided as feedback or outcomes for purposes of training, supervision, and iterative improvement of systems for prediction, forecasting, classification, automation and control. The data may be organized as a stream of events. The data may be stored in a distributed ledger or other distributed system. The data may be stored in a knowledge graph where nodes represent entities and links represent relationships. The external data sources may be queried via various database query functions. The external data sources 182 may be accessed via APIs, brokers, connectors, protocols like REST and SOAP, and other data ingestion and extraction techniques. Data may be enriched with metadata and may be subject to transformation and loading into suitable forms for consumption by the engines, such as by cleansing, normalization, de-duplication, and the like.

The platform 100 may include a set of intelligent forecasting engines 192 for forecasting events, activities, variables, and parameters of spot markets 170, forward markets 130, resources that are traded in such markets, resources that enable such markets, behaviors (such as any of those tracked in the external data sources 182), transactions, and the like. The intelligent forecasting engines 192 may operate on data from the data aggregation systems 144 about elements of the platform 100 and on data from the external data sources 182. The platform may include a set of intelligent transaction engines 136 for automatically executing transactions in spot markets 170 and forward markets 130. This may include executing intelligent cryptocurrency transactions with an intelligent cryptocurrency execution engine 183 associated with IoT data for crypto transaction 295 and social data for crypto transaction 193. The platform 100 may make use of asset of improved distributed ledgers 113 and improved smart contracts 103, including ones that embed and operate on proprietary information, instruction sets and the like that enable complex transactions to occur among individuals with reduced (or without) reliance on intermediaries. These and other components are described in more detail throughout this disclosure.

Referring to the block diagrams of FIGS. 2A and 2B, further details and additional components of the platform 100 and interactions among them are depicted. The set of forward purchase and sale machines 110 may include a regeneration capacity allocation engine 102 (such as for allocating energy generation or regeneration capacity, such as within a hybrid vehicle or system that includes energy generation or regeneration capacity, a renewable energy system that has energy storage, or other energy storage system, where energy is allocated for one or more of sale on a forward market 130, sale in a spot market 170, use in completing a transaction (e.g., mining for cryptocurrency), or other purposes. For example, the regeneration capacity allocation engine 102 may explore available options for use of stored energy, such as sale in current and forward energy markets that accept energy from producers, keeping the energy in storage for future use, or using the energy for work (which may include processing work, such as processing activities of the platform like data collection or processing, or processing work for executing transactions, including mining activities for cryptocurrencies). In embodiments, energy storage capacity may be transacted on an energy storage forward market 174 or an energy storage market 178.

The set of forward purchase and sale machines 110 may include an energy purchase and sale machine 104 for purchasing or selling energy, such as in an energy spot market 148 or an energy forward market 122. The energy purchase and sale machine 104 may use an expert system, neural network or other intelligence to determine timing of purchases, such as based on current and anticipated state information with respect to pricing and availability of energy and based on current and anticipated state information with respect to needs for energy, including needs for energy to perform computing tasks, cryptocurrency mining, data collection actions, and other work, such as work done by automated agents and systems and work required for humans or entities based on their behavior. For example, the energy purchase machine may recognize, by machine learning, that a business is likely to require a block of energy in order to perform an increased level of manufacturing based on an increase in orders or market demand and may purchase the energy at a favorable price on a futures market, based on a combination of energy market data and entity behavioral data. Continuing the example, market demand may be understood by machine learning, such as by processing human behavioral data sources 184, such as social media posts, e-commerce data and the like that indicate increasing demand. The energy purchase and sale machine 104 may sell energy in the energy spot market 148 or the energy forward market 122. Sale may also be conducted by an expert system operating on the various data sources described herein, including with training on outcomes and human supervision.

The set of forward purchase and sale machines 110 may include a renewable energy credit (REC) purchase and sale machine 108, which may purchase renewable energy credits, pollution credits, and other environmental or regulatory credits in a spot market 150 or forward market 124 for such credits. Purchasing may be configured and managed by an expert system operating on any of the external data sources 182 or on data aggregated by the set of data aggregation systems 144 for the platform. Renewable energy credits and other credits may be purchased by an automated system using an expert system, including machine learning or other artificial intelligence, such as where credits are purchased with favorable timing based on an understanding of supply and demand that is determined by processing inputs from the data sources. The expert system may be trained on a data set of outcomes from purchases under historical input conditions. The expert system may be trained on a data set of human purchase decisions and/or may be supervised by one or more human operators. The renewable energy credit (REC) purchase and sale machine 108 may also sell renewable energy credits, pollution credits, and other environmental or regulatory credits in a spot market 150 or forward market 124 for such credits. Sale may also be conducted by an expert system operating on the various data sources described herein, including with training on outcomes and human supervision.

The set of forward purchase and sale machines 110 may include an attention purchase and sale machine 112, which may purchase one or more attention-related resources, such as advertising space, search listing, keyword listing, banner advertisements, participation in a panel or survey activity, participation in a trial or pilot, or the like in a spot market for attention 152 or a forward market for attention 128. Attention resources may include the attention of automated agents, such as bots, crawlers, dialog managers, and the like that are used for searching, shopping, and purchasing. Purchasing of attention resources may be configured and managed by an expert system operating on any of the external data sources 182 or on data aggregated by the set of data aggregation systems 144 for the platform. Attention resources may be purchased by an automated system using an expert system, including machine learning or other artificial intelligence, such as where resources are purchased with favorable timing, such as based on an understanding of supply and demand, that is determined by processing inputs from the various data sources. For example, the attention purchase and sale machine 112 may purchase advertising space in a forward market for advertising based on learning from a wide range of inputs about market conditions, behavior data, and data regarding activities of agent and systems within the platform 100. The expert system may be trained on a data set of outcomes from purchases under historical input conditions. The expert system may be trained on a data set of human purchase decisions and/or may be supervised by one or more human operators. The attention purchase and sale machine 112 may also sell one or more attention-related resources, such as advertising space, search listing, keyword listing, banner advertisements, participation in a panel or survey activity, participation in a trial or pilot, or the like in a spot market for attention 152 or a forward market for attention 128, which may include offering or selling access to, or attention or, one or more automated agents of the platform 100. Sale may also be conducted by an expert system operating on the various data sources described herein, including with training on outcomes and human supervision.

The set of forward purchase and sale machines 110 may include a compute purchase and sale machine 114, which may purchase one or more computation-related resources, such as processing resources, database resources, computation resources, server resources, disk resources, input/output resources, temporary storage resources, memory resources, virtual machine resources, container resources, and others in a spot market for compute 154 or a forward market for compute 132. Purchasing of compute resources may be configured and managed by an expert system operating on any of the external data sources 182 or on data aggregated by the set of data aggregation systems 144 for the platform. Compute resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for computing. The expert system may be trained on a data set of outcomes from purchases under historical input conditions. The expert system may be trained on a data set of human purchase decisions and/or may be supervised by one or more human operators. The compute purchase and sale machine 114 may also sell one or more computation-related resources that are connected to, part of, or managed by the platform 100, such as processing resources, database resources, computation resources, server resources, disk resources, input/output resources, temporary storage resources, memory resources, virtual machine resources, container resources, and others in a spot market for compute 154 or a forward market for compute 132. Sale may also be conducted by an expert system operating on the various data sources described herein, including with training on outcomes and human supervision.

The set of forward purchase and sale machines 110 may include a data storage purchase and sale machine 118, which may purchase one or more data-related resources, such as database resources, disk resources, server resources, memory resources, RAM resources, network attached storage resources, storage attached network (SAN) resources, tape resources, time-based data access resources, virtual machine resources, container resources, and others in a spot market for storage resources 158 or a forward market for data storage 134. Purchasing of data storage resources may be configured and managed by an expert system operating on any of the external data sources 182 or on data aggregated by the set of data aggregation systems 144 for the platform. Data storage resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for storage. The expert system may be trained on a data set of outcomes from purchases under historical input conditions. The expert system may be trained on a data set of human purchase decisions and/or may be supervised by one or more human operators. The data storage purchase and sale machine 118 may also sell one or more data storage-related resources that are connected to, part of, or managed by the platform 100 in a spot market for storage resources 158 or a forward market for data storage 134. Sale may also be conducted by an expert system operating on the various data sources described herein, including with training on outcomes and human supervision.

The set of forward purchase and sale machines 110 may include a bandwidth purchase and sale machine 120, which may purchase one or more bandwidth-related resources, such as cellular bandwidth, Wi-Fi bandwidth, radio bandwidth, access point bandwidth, beacon bandwidth, local area network bandwidth, wide area network bandwidth, enterprise network bandwidth, server bandwidth, storage input/output bandwidth, advertising network bandwidth, market bandwidth, or other bandwidth, in a spot market for bandwidth resources 160 or a forward market for bandwidth 138. Purchasing of bandwidth resources may be configured and managed by an expert system operating on any of the external data sources 182 or on data aggregated by the set of data aggregation systems 144 for the platform. Bandwidth resources may be purchased by an automated system using an expert system, including machine learning or other artificial intelligence, such as where resources are purchased with favorable timing, such as based on an understanding of supply and demand, that is determined by processing inputs from the various data sources. For example, the bandwidth purchase and sale machine 120 may purchase or reserve bandwidth on a network resource for a future networking activity managed by the platform based on learning from a wide range of inputs about market conditions, behavior data, and data regarding activities of agent and systems within the platform 100, such as to obtain such resources at favorable prices during surge periods of demand for bandwidth. The expert system may be trained on a data set of outcomes from purchases under historical input conditions. The expert system may be trained on a data set of human purchase decisions and/or may be supervised by one or more human operators. The bandwidth purchase and sale machine 120 may also sell one or more bandwidth-related resources that are connected to, part of, or managed by the platform 100 in a spot market for bandwidth resources 160 or a forward market for bandwidth 138. Sale may also be conducted by an expert system operating on the various data sources described herein, including with training on outcomes and human supervision.

The set of forward purchase and sale machines 110 may include a spectrum purchase and sale machine 142, which may purchase one or more spectrum-related resources, such as cellular spectrum, 3G spectrum, 4G spectrum, LTE spectrum, 5G spectrum, cognitive radio spectrum, peer-to-peer network spectrum, emergency responder spectrum and the like in a spot market for spectrum resources 162 or a forward market for spectrum/bandwidth 140. Purchasing of spectrum resources may be configured and managed by an expert system operating on any of the external data sources 182 or on data aggregated by the set of data aggregation systems 144 for the platform. Spectrum resources may be purchased by an automated system using an expert system, including machine learning or other artificial intelligence, such as where resources are purchased with favorable timing, such as based on an understanding of supply and demand, that is determined by processing inputs from the various data sources. For example, the spectrum purchase and sale machine 142 may purchase or reserve spectrum on a network resource for a future networking activity managed by the platform based on learning from a wide range of inputs about market conditions, behavior data, and data regarding activities of agent and systems within the platform 100, such as to obtain such resources at favorable prices during surge periods of demand for spectrum. The expert system may be trained on a data set of outcomes from purchases under historical input conditions. The expert system may be trained on a data set of human purchase decisions and/or may be supervised by one or more human operators. The spectrum purchase and sale machine 142 may also sell one or more spectrum-related resources that are connected to, part of, or managed by the platform 100 in a spot market for spectrum resources 162 or a forward market for spectrum/bandwidth 140. Sale may also be conducted by an expert system operating on the various data sources described herein, including with training on outcomes and human supervision.

In embodiments, the intelligent resource allocation and coordination system 168, including the intelligent resource purchasing system 164, the intelligent sale engine 172 and the automated spot market testing and arbitrage transaction execution engine 194, may provide coordinated and automated allocation of resources and coordinated execution of transactions across the various forward markets 130 and spot markets 170 by coordinating the various purchase and sale machines, such as by an expert system, such as a machine learning system (which may model-based or a deep learning system, and which may be trained on outcomes and/or supervised by humans). For example, the intelligent resource allocation and coordination system 168 may coordinate purchasing of resources for a set of assets and coordinated sale of resources available from a set of assets, such as a fleet of vehicles, a data center of processing and data storage resources, an information technology network (on premises, cloud, or hybrids), a fleet of energy production systems (renewable or non-renewable), a smart home or building (including appliances, machines, infrastructure components and systems, and the like thereof that consume or produce resources), and the like. The platform 100 may optimize allocation of resource purchasing, sale and utilization based on data aggregated in the platform, such as by tracking activities of various engines and agents, as well as by taking inputs from external data sources 182. In embodiments, outcomes may be provided as feedback for training the intelligent resource allocation and coordination system 168, such as outcomes based on yield, profitability, optimization of resources, optimization of business objectives, satisfaction of goals, satisfaction of users or operators, or the like. For example, as the energy for computational tasks becomes a significant fraction of an enterprise's energy usage, the platform 100 may learn to optimize how a set of machines that have energy storage capacity allocate that capacity among computing tasks (such as for cryptocurrency mining, application of neural networks, computation on data and the like), other useful tasks (that may yield profits or other benefits), storage for future use, or sale to the provider of an energy grid. The platform 100 may be used by fleet operators, enterprises, governments, municipalities, military units, first responder units, manufacturers, energy producers, cloud platform providers, and other enterprises and operators that own or operate resources that consume or provide energy, computation, data storage, bandwidth, or spectrum. The platform 100 may also be used in connection with markets for attention, such as to use available capacity of resources to support attention-based exchanges of value, such as in advertising markets, micro-transaction markets, and others.

Referring still to FIGS. 2A and 2B, the platform 100 may include a set of intelligent forecasting engines 192 that forecast one or more attributes, parameters, variables, or other factors, such as for use as inputs by the set of forward purchase and sale machines, the intelligent transaction engines 136 (such as for intelligent cryptocurrency execution) or for other purposes. Each of the set of intelligent forecasting engines 192 may use data that is tracked, aggregated, processed, or handled within the platform 100, such as by the data aggregation system 144, as well as input data from external data sources 182, such as social media data sources 180, automated agent behavioral data sources 188, human behavioral data sources 184, entity behavioral data sources 190 and IoT data sources 198. These collective inputs may be used to forecast attributes, such as using a model (e.g., Bayesian, regression, or other statistical model), a rule, or an expert system, such as a machine learning system that has one or more classifiers, pattern recognizers, and predictors, such as any of the expert systems described throughout this disclosure. In embodiments, the set of intelligent forecasting engines 192 may include one or more specialized engines that forecast market attributes, such as capacity, demand, supply, and prices, using particular data sources for particular markets. These may include an energy price forecasting engine 215 that bases its forecast on behavior of an automated agent, a network spectrum price forecasting engine 217 that bases its forecast on behavior of an automated agent, a REC price forecasting engine 219 that bases its forecast on behavior of an automated agent, a compute price forecasting engine 221 that bases its forecast on behavior of an automated agent, a network spectrum price forecasting engine 223 that bases its forecast on behavior of an automated agent. In each case, observations regarding the behavior of automated agents, such as ones used for conversation, for dialog management, for managing electronic commerce, for managing advertising and others may be provided as inputs for forecasting to the engines. The intelligent forecasting engines 192 may also include a range of engines that provide forecasts at least in part based on entity behavior, such as behavior of business and other organizations, such as marketing behavior, sales behavior, product offering behavior, advertising behavior, purchasing behavior, transactional behavior, merger and acquisition behavior, and other entity behavior. These may include an energy price forecasting engine 225 using entity behavior, a network spectrum price forecasting engine 227 using entity behavior, a REC price forecasting engine 229 using entity behavior, a compute price forecasting engine 231 using entity behavior, and a network spectrum price forecasting engine 233 using entity behavior.

The intelligent forecasting engines 192 may also include a range of engines that provide forecasts at least in part based on human behavior, such as behavior of consumers and users, such as purchasing behavior, shopping behavior, sales behavior, product interaction behavior, energy utilization behavior, mobility behavior, activity level behavior, activity type behavior, transactional behavior, and other human behavior. These may include an energy price forecasting engine 235 using human behavior, a network spectrum price forecasting engine 237 using human behavior, a REC price forecasting engine 239 using human behavior, a compute price forecasting engine 241 using human behavior, and a network spectrum price forecasting engine 243 using human behavior.

Referring still to FIGS. 2A and 2B, the platform 100 may include a set of intelligent transaction engines 136 that automate execution of transactions in forward markets 130 and/or spot markets 170 based on determination that favorable conditions exist, such as by the intelligent resource allocation and coordination system 168 and/or with use of forecasts form the intelligent forecasting engines 192. The intelligent transaction engines 136 may be configured to automatically execute transactions, using available market interfaces, such as APIs, connectors, ports, network interfaces, and the like, in each of the markets noted above. In embodiments, the intelligent transaction engines may execute transactions based on event streams that come from external data sources, such as IoT data sources 198 and social media data sources 180. The engines may include, for example, an IoT forward energy transaction engine 195 and/or an IoT compute market transaction engine 106, either or both of which may use data from the Internet of Things to determine timing and other attributes for market transaction in a market for one or more of the resources described herein, such as an energy market transaction, a compute resource transaction or other resource transaction. IoT data may include instrumentation and controls data for one or more machines (optionally coordinated as a fleet) that use or produce energy or that use or have compute resources, weather data that influences energy prices or consumption (such as wind data influencing production of wind energy), sensor data from energy production environments, sensor data from points of use for energy or compute resources (such as vehicle traffic data, network traffic data, IT network utilization data, Internet utilization and traffic data, camera data from work sites, smart building data, smart home data, and the like), and other data collected by or transferred within the Internet of Things, including data stored in IoT platforms and of cloud services providers like Amazon, IBM, and others. The intelligent transaction engines 136 may include engines that use social data to determine timing of other attributes for a market transaction in one or more of the resources described herein, such as a social data forward energy transaction engine 199 and/or a social data compute market transaction engine 116. Social data may include data from social networking sites (e.g., Facebook™, YouTube™, Twitter™, Snapchat™, Instagram™, and others), data from websites, data from e-commerce sites, and data from other sites that contain information that may be relevant to determining or forecasting behavior of users or entities, such as data indicating interest or attention to particular topics, goods or services, data indicating activity types and levels such as may be observed by machine processing of image data showing individuals engaged in activities, including travel, work activities, leisure activities, and the like. Social data may be supplied to machine learning, such as for learning user behavior or entity behavior at a social data market predictor 186, and/or as an input to an expert system, a model, or the like, such as one for determining, based on the social data, the parameters for a transaction. For example, an event or set of events in a social data stream may indicate the likelihood of a surge of interest in an online resource, a product, or a service, and compute resources, bandwidth, storage, or like may be purchased in advance (avoiding surge pricing) to accommodate the increased interest reflected by the social data stream.

### Neural Net Systems

Embodiments of the present disclosure, including ones involving expert systems, self-organization, machine learning, artificial intelligence, and the like, may benefit from the use of a neural net, such as a neural net trained for pattern recognition, for classification of one or more parameters, characteristics, or phenomena, for support of autonomous control, and other purposes. References to a neural net throughout this disclosure should be understood to encompass a wide range of different types of neural networks, machine learning systems, artificial intelligence systems, and the like, such as feed forward neural networks, radial basis function neural networks, self-organizing neural networks (e.g., Kohonen self-organizing neural networks), recurrent neural networks, modular neural networks, artificial neural networks, physical neural networks, multi-layered neural networks, convolutional neural networks, hybrids of neural networks with other expert systems (e.g., hybrid fuzzy logic-neural network systems), Autoencoder neural networks, probabilistic neural networks, time delay neural networks, convolutional neural networks, regulatory feedback neural networks, radial basis function neural networks, recurrent neural networks, Hopfield neural networks, Boltzmann machine neural networks, self-organizing map (SOM) neural networks, learning vector quantization (LVQ) neural networks, fully recurrent neural networks, simple recurrent neural networks, echo state neural networks, long short-term memory neural networks, bi-directional neural networks, hierarchical neural networks, stochastic neural networks, genetic scale RNN neural networks, committee of machines neural networks, associative neural networks, physical neural networks, instantaneously trained neural networks, spiking neural networks, neocognitron neural networks, dynamic neural networks, cascading neural networks, neuro-fuzzy neural networks, compositional pattern-producing neural networks, memory neural networks, hierarchical temporal memory neural networks, deep feed forward neural networks, gated recurrent unit (GCU) neural networks, auto encoder neural networks, variational auto encoder neural networks, de-noising auto encoder neural networks, sparse auto-encoder neural networks, Markov chain neural networks, restricted Boltzmann machine neural networks, deep belief neural networks, deep convolutional neural networks, de-convolutional neural networks, deep convolutional inverse graphics neural networks, generative adversarial neural networks, liquid state machine neural networks, extreme learning machine neural networks, echo state neural networks, deep residual neural networks, support vector machine neural networks, neural Turing machine neural networks, and/or holographic associative memory neural networks, or hybrids or combinations of the foregoing, or combinations with other expert systems, such as rule-based systems, model-based systems (including ones based on physical models, statistical models, flow-based models, biological models, biomimetic models, and the like).

In embodiments, exemplary neural networks have cells that are assigned functions and requirements. In embodiments, the various neural net examples may include back fed data/sensor cells, data/sensor cells, noisy input cells, and hidden cells. The neural net components also include probabilistic hidden cells, spiking hidden cells, output cells, match input/output cells, recurrent cells, memory cells, different memory cells, kernels, and convolution or pool cells.

In embodiments, an exemplary perceptron neural network may connect to, integrate with, or interface with the platform 100. The platform may also be associated with further neural net systems such as a feed forward neural network, a radial basis neural network, a deep feed forward neural network, a recurrent neural network, a long/short term neural network, and a gated recurrent neural network. The platform may also be associated with further neural net systems such as an auto encoder neural network, a variational neural network, a denoising neural network, a sparse neural network, a Markov chain neural network, and a Hopfield network neural network. The platform may further be associated with additional neural net systems such as a Boltzmann machine neural network, a restricted BM neural network, a deep belief neural network, a deep convolutional neural network, a deconvolutional neural network, and a deep convolutional inverse graphics neural network. The platform may also be associated with further neural net systems such as a generative adversarial neural network, a liquid state machine neural network, an extreme learning machine neural network, an echo state neural network, a deep residual neural network, a Kohonen neural network, a support vector machine neural network, and a neural Turing machine neural network.

The foregoing neural networks may have a variety of nodes or neurons, which may perform a variety of functions on inputs, such as inputs received from sensors or other data sources, including other nodes. Functions may involve weights, features, feature vectors, and the like. Neurons may include perceptrons, neurons that mimic biological functions (such as of the human senses of touch, vision, taste, hearing, and smell), and the like. Continuous neurons, such as with sigmoidal activation, may be used in the context of various forms of neural net, such as where back propagation is involved.

In many embodiments, an expert system or neural network may be trained, such as by a human operator or supervisor, or based on a data set, model, or the like. Training may include presenting the neural network with one or more training data sets that represent values, such as sensor data, event data, parameter data, and other types of data (including the many types described throughout this disclosure), as well as one or more indicators of an outcome, such as an outcome of a process, an outcome of a calculation, an outcome of an event, an outcome of an activity, or the like. Training may include training in optimization, such as training a neural network to optimize one or more systems based on one or more optimization approaches, such as Bayesian approaches, parametric Bayes classifier approaches, k-nearest-neighbor classifier approaches, iterative approaches, interpolation approaches, Pareto optimization approaches, algorithmic approaches, and the like. Feedback may be provided in a process of variation and selection, such as with a genetic algorithm that evolves one or more solutions based on feedback through a series of rounds.

In embodiments, a plurality of neural networks may be deployed in a cloud platform that receives data streams and other inputs collected (such as by mobile data collectors) in one or more transactional environments and transmitted to the cloud platform over one or more networks, including using network coding to provide efficient transmission. In the cloud platform, optionally using massively parallel computational capability, a plurality of different neural networks of various types (including modular forms, structure-adaptive forms, hybrids, and the like) may be used to undertake prediction, classification, control functions, and provide other outputs as described in connection with expert systems disclosed throughout this disclosure. The different neural networks may be structured to compete with each other (optionally including use evolutionary algorithms, genetic algorithms, or the like), such that an appropriate type of neural network, with appropriate input sets, weights, node types and functions, and the like, may be selected, such as by an expert system, for a specific task involved in a given context, workflow, environment process, system, or the like.

In embodiments, methods and systems described herein that involve an expert system or self-organization capability may use a feed forward neural network, which moves information in one direction, such as from a data input, like a data source related to at least one resource or parameter related to a transactional environment, such as any of the data sources mentioned throughout this disclosure, through a series of neurons or nodes, to an output. Data may move from the input nodes to the output nodes, optionally passing through one or more hidden nodes, without loops. In embodiments, feed forward neural networks may be constructed with various types of units, such as binary McCulloch-Pitts neurons, the simplest of which is a perceptron.

In embodiments, methods and systems described herein that involve an expert system or self-organization capability may use a capsule neural network, such as for prediction, classification, or control functions with respect to a transactional environment, such as relating to one or more of the machines and automated systems described throughout this disclosure.

In embodiments, methods and systems described herein that involve an expert system or self-organization capability may use a radial basis function (RBF) neural network, which may be preferred in some situations involving interpolation in a multi-dimensional space (such as where interpolation is helpful in optimizing a multi-dimensional function, such as for optimizing a data marketplace as described here, optimizing the efficiency or output of a power generation system, a factory system, or the like, or other situation involving multiple dimensions. In embodiments, each neuron in the RBF neural network stores an example from a training set as a “prototype.” Linearity involved in the functioning of this neural network offers RBF the advantage of not typically suffering from problems with local minima or maxima.

In embodiments, methods and systems described herein that involve an expert system or self-organization capability may use a radial basis function (RBF) neural network, such as one that employs a distance criterion with respect to a center (e.g., a Gaussian function). A radial basis function may be applied as a replacement for a hidden layer, such as a sigmoidal hidden layer transfer, in a multi-layer perceptron. An RBF network may have two layers, such as where an input is mapped onto each RBF in a hidden layer. In embodiments, an output layer may comprise a linear combination of hidden layer values representing, for example, a mean predicted output. The output layer value may provide an output that is the same as or similar to that of a regression model in statistics. In classification problems, the output layer may be a sigmoid function of a linear combination of hidden layer values, representing a posterior probability. Performance in both cases is often improved by shrinkage techniques, such as ridge regression in classical statistics. This corresponds to a prior belief in small parameter values (and therefore smooth output functions) in a Bayesian framework. RBF networks may avoid local minima, because the only parameters that are adjusted in the learning process are the linear mapping from hidden layer to output layer. Linearity ensures that the error surface is quadratic and therefore has a single minimum. In regression problems, this may be found in one matrix operation. In classification problems, the fixed non-linearity introduced by the sigmoid output function may be handled using an iteratively re-weighted least squares function or the like. RBF networks may use kernel methods such as support vector machines (SVM) and Gaussian processes (where the RBF is the kernel function). A non-linear kernel function may be used to project the input data into a space where the learning problem may be solved using a linear model.

In embodiments, an RBF neural network may include an input layer, a hidden layer, and a summation layer. In the input layer, one neuron appears in the input layer for each predictor variable. In the case of categorical variables, N−1 neurons are used, where N is the number of categories. The input neurons may, in embodiments, standardize the value ranges by subtracting the median and dividing by the interquartile range. The input neurons may then feed the values to each of the neurons in the hidden layer. In the hidden layer, a variable number of neurons may be used (determined by the training process). Each neuron may consist of a radial basis function that is centered on a point with as many dimensions as a number of predictor variables. The spread (e.g., radius) of the RBF function may be different for each dimension. The centers and spreads may be determined by training. When presented with the vector of input values from the input layer, a hidden neuron may compute a Euclidean distance of the test case from the neuron's center point and then apply the RBF kernel function to this distance, such as using the spread values. The resulting value may then be passed to the summation layer. In the summation layer, the value coming out of a neuron in the hidden layer may be multiplied by a weight associated with the neuron and may add to the weighted values of other neurons. This sum becomes the output. For classification problems, one output is produced (with a separate set of weights and summation units) for each target category. The value output for a category is the probability that the case being evaluated has that category. In training of an RBF, various parameters may be determined, such as the number of neurons in a hidden layer, the coordinates of the center of each hidden-layer function, the spread of each function in each dimension, and the weights applied to outputs as they pass to the summation layer. Training may be used by clustering algorithms (such as k-means clustering), by evolutionary approaches, and the like.

In embodiments, a recurrent neural network may have a time-varying, real-valued (more than just zero or one) activation (output). Each connection may have a modifiable real-valued weight. Some of the nodes are called labeled nodes, some output nodes, and others hidden nodes. For supervised learning in discrete time settings, training sequences of real-valued input vectors may become sequences of activations of the input nodes, one input vector at a time. At each time step, each non-input unit may compute its current activation as a nonlinear function of the weighted sum of the activations of all units from which it receives connections. The system may explicitly activate (independent of incoming signals) some output units at certain time steps.

In embodiments, methods and systems described herein that involve an expert system or self-organization capability may use a self-organizing neural network, such as a Kohonen self-organizing neural network, such as for visualization of views of data, such as low-dimensional views of high-dimensional data. The self-organizing neural network may apply competitive learning to a set of input data, such as from one or more sensors or other data inputs from or associated with a transactional environment, including any machine or component that relates to the transactional environment. In embodiments, the self-organizing neural network may be used to identify structures in data, such as unlabeled data, such as in data sensed from a range of data sources about or sensors in or about in a transactional environment, where sources of the data are unknown (such as where events may be coming from any of a range of unknown sources). The self-organizing neural network may organize structures or patterns in the data, such that they may be recognized, analyzed, and labeled, such as identifying market behavior structures as corresponding to other events and signals.

In embodiments, methods and systems described herein that involve an expert system or self-organization capability may use a recurrent neural network, which may allow for a bi-directional flow of data, such as where connected units (e.g., neurons or nodes) form a directed cycle. Such a network may be used to model or exhibit dynamic temporal behavior, such as involved in dynamic systems, such as a wide variety of the automation systems, machines and devices described throughout this disclosure, such as an automated agent interacting with a marketplace for purposes of collecting data, testing spot market transactions, execution transactions, and the like, where dynamic system behavior involves complex interactions that a user may desire to understand, predict, control and/or optimize. For example, the recurrent neural network may be used to anticipate the state of a market, such as one involving a dynamic process or action, such as a change in state of a resource that is traded in or that enables a marketplace of transactional environment. In embodiments, the recurrent neural network may use internal memory to process a sequence of inputs, such as from other nodes and/or from sensors and other data inputs from or about the transactional environment, of the various types described herein. In embodiments, the recurrent neural network may also be used for pattern recognition, such as for recognizing a machine, component, agent, or other item based on a behavioral signature, a profile, a set of feature vectors (such as in an audio file or image), or the like. In a non-limiting example, a recurrent neural network may recognize a shift in an operational mode of a marketplace or machine by learning to classify the shift from a training data set consisting of a stream of data from one or more data sources of sensors applied to or about one or more resources.

In embodiments, methods and systems described herein that involve an expert system or self-organization capability may use a modular neural network, which may comprise a series of independent neural networks (such as ones of various types described herein) that are moderated by an intermediary. Each of the independent neural networks in the modular neural network may work with separate inputs, accomplishing subtasks that make up the task the modular network as whole is intended to perform. For example, a modular neural network may comprise a recurrent neural network for pattern recognition, such as to recognize what type of machine or system is being sensed by one or more sensors that are provided as input channels to the modular network and an RBF neural network for optimizing the behavior of the machine or system once understood. The intermediary may accept inputs of each of the individual neural networks, process them, and create output for the modular neural network, such an appropriate control parameter, a prediction of state, or the like.

Combinations among any of the pairs, triplets, or larger combinations, of the various neural network types described herein, are encompassed by the present disclosure. This may include combinations where an expert system uses one neural network for recognizing a pattern (e.g., a pattern indicating a problem or fault condition) and a different neural network for self-organizing an activity or workflow based on the recognized pattern (such as providing an output governing autonomous control of a system in response to the recognized condition or pattern). This may also include combinations where an expert system uses one neural network for classifying an item (e.g., identifying a machine, a component, or an operational mode) and a different neural network for predicting a state of the item (e.g., a fault state, an operational state, an anticipated state, a maintenance state, or the like). Modular neural networks may also include situations where an expert system uses one neural network for determining a state or context (such as a state of a machine, a process, a workflow, a marketplace, a storage system, a network, a data collector, or the like) and a different neural network for self-organizing a process involving the state or context (e.g., a data storage process, a network coding process, a network selection process, a data marketplace process, a power generation process, a manufacturing process, a refining process, a digging process, a boring process, or other process described herein).

In embodiments, methods and systems described herein that involve an expert system or self-organization capability may use a physical neural network where one or more hardware elements is used to perform or simulate neural behavior. In embodiments, one or more hardware neurons may be configured to stream voltage values, current values, or the like that represent sensor data, such as to calculate information from analog sensor inputs representing energy consumption, energy production, or the like, such as by one or more machines providing energy or consuming energy for one or more transactions. One or more hardware nodes may be configured to stream output data resulting from the activity of the neural net. Hardware nodes, which may comprise one or more chips, microprocessors, integrated circuits, programmable logic controllers, application-specific integrated circuits, field-programmable gate arrays, or the like, may be provided to optimize the machine that is producing or consuming energy, or to optimize another parameter of some part of a neural net of any of the types described herein. Hardware nodes may include hardware for acceleration of calculations (such as dedicated processors for performing basic or more sophisticated calculations on input data to provide outputs, dedicated processors for filtering or compressing data, dedicated processors for de-compressing data, dedicated processors for compression of specific file or data types (e.g., for handling image data, video streams, acoustic signals, thermal images, heat maps, or the like), and the like. A physical neural network may be embodied in a data collector, including one that may be reconfigured by switching or routing inputs in varying configurations, such as to provide different neural net configurations within the data collector for handling different types of inputs (with the switching and configuration optionally under control of an expert system, which may include a software-based neural net located on the data collector or remotely). A physical, or at least partially physical, neural network may include physical hardware nodes located in a storage system, such as for storing data within a machine, a data storage system, a distributed ledger, a mobile device, a server, a cloud resource, or in a transactional environment, such as for accelerating input/output functions to one or more storage elements that supply data to or take data from the neural net. A physical, or at least partially physical, neural network may include physical hardware nodes located in a network, such as for transmitting data within, to or from an industrial environment, such as for accelerating input/output functions to one or more network nodes in the net, accelerating relay functions, or the like. In embodiments, of a physical neural network, an electrically adjustable resistance material may be used for emulating the function of a neural synapse. In embodiments, the physical hardware emulates the neurons, and software emulates the neural network between the neurons. In embodiments, neural networks complement conventional algorithmic computers. They are versatile and may be trained to perform appropriate functions without the need for any instructions, such as classification functions, optimization functions, pattern recognition functions, control functions, selection functions, evolution functions, and others.

In embodiments, methods and systems described herein that involve an expert system or self-organization capability may use a multilayered feed forward neural network, such as for complex pattern classification of one or more items, phenomena, modes, states, or the like. In embodiments, a multilayered feed forward neural network may be trained by an optimization technique, such as a genetic algorithm, such as to explore a large and complex space of options to find an optimum, or near-optimum, global solution. For example, one or more genetic algorithms may be used to train a multilayered feed forward neural network to classify complex phenomena, such as to recognize complex operational modes of machines, such as modes involving complex interactions among machines (including interference effects, resonance effects, and the like), modes involving non-linear phenomena, modes involving critical faults, such as where multiple, simultaneous faults occur, making root cause analysis difficult, and others. In embodiments, a multilayered feed forward neural network may be used to classify results from monitoring of a marketplace, such as monitoring systems, such as automated agents, that operate within the marketplace, as well as monitoring resources that enable the marketplace, such as computing, networking, energy, data storage, energy storage, and other resources.

In embodiments, methods and systems described herein that involve an expert system or self-organization capability may use a feed-forward, back-propagation multi-layer perceptron (MLP) neural network, such as for handling one or more remote sensing applications, such as for taking inputs from sensors distributed throughout various transactional environments. In embodiments, the MLP neural network may be used for classification of transactional environments and resource environments, such as spot markets, forward markets, energy markets, renewable energy credit (REC) markets, networking markets, advertising markets, spectrum markets, ticketing markets, rewards markets, compute markets, and others mentioned throughout this disclosure, as well as physical resources and environments that produce them, such as energy resources (including renewable energy environments, mining environments, exploration environments, drilling environments, and the like, including classification of geological structures (including underground features and above ground features), classification of materials (including fluids, minerals, metals, and the like), and other problems. This may include fuzzy classification.

In embodiments, methods and systems described herein that involve an expert system or self-organization capability may use a structure-adaptive neural network, where the structure of a neural network is adapted, such as based on a rule, a sensed condition, a contextual parameter, or the like. For example, if a neural network does not converge on a solution, such as classifying an item or arriving at a prediction, when acting on a set of inputs after some amount of training, the neural network may be modified, such as from a feed forward neural network to a recurrent neural network, such as by switching data paths between some subset of nodes from unidirectional to bi-directional data paths. The structure adaptation may occur under control of an expert system, such as to trigger adaptation upon occurrence of a trigger, rule, or event, such as recognizing occurrence of a threshold (such as an absence of a convergence to a solution within a given amount of time) or recognizing a phenomenon as requiring different or additional structure (such as recognizing that a system is varying dynamically or in a non-linear fashion). In one non-limiting example, an expert system may switch from a simple neural network structure like a feed forward neural network to a more complex neural network structure like a recurrent neural network, a convolutional neural network, or the like upon receiving an indication that a continuously variable transmission is being used to drive a generator, turbine, or the like in a system being analyzed.

In embodiments, methods and systems described herein that involve an expert system or self-organization capability may use an autoencoder, autoassociator or Diabolo neural network, which may be similar to a multilayer perceptron (MLP) neural network, such as where there may be an input layer, an output layer and one or more hidden layers connecting them. However, the output layer in the auto-encoder may have the same number of units as the input layer, where the purpose of the MLP neural network is to reconstruct its own inputs (rather than just emitting a target value). Therefore, the auto encoders may operate as an unsupervised learning model. An auto encoder may be used, for example, for unsupervised learning of efficient codings, such as for dimensionality reduction, for learning generative models of data, and the like. In embodiments, an auto-encoding neural network may be used to self-learn an efficient network coding for transmission of analog sensor data from a machine over one or more networks or of digital data from one or more data sources. In embodiments, an auto-encoding neural network may be used to self-learn an efficient storage approach for storage of streams of data.

In embodiments, methods and systems described herein that involve an expert system or self-organization capability may use a probabilistic neural network (PNN), which, in embodiments, may comprise a multi-layer (e.g., four-layer) feed forward neural network, where layers may include input layers, hidden layers, pattern/summation layers and an output layer. In an embodiment of a PNN algorithm, a parent probability distribution function (PDF) of each class may be approximated, such as by a Parzen window and/or a non-parametric function. Then, using the PDF of each class, the class probability of a new input is estimated, and Bayes' rule may be employed, such as to allocate it to the class with the highest posterior probability. A PNN may embody a Bayesian network and may use a statistical algorithm or analytic technique, such as Kernel Fisher discriminant analysis technique. The PNN may be used for classification and pattern recognition in any of a wide range of embodiments disclosed herein. In one non-limiting example, a probabilistic neural network may be used to predict a fault condition of an engine based on collection of data inputs from sensors and instruments for the engine.

In embodiments, methods and systems described herein that involve an expert system or self-organization capability may use a time delay neural network (TDNN), which may comprise a feed forward architecture for sequential data that recognizes features independent of sequence position. In embodiments, to account for time shifts in data, delays are added to one or more inputs, or between one or more nodes, so that multiple data points (from distinct points in time) are analyzed together. A time delay neural network may form part of a larger pattern recognition system, such as using a perceptron network. In embodiments, a TDNN may be trained with supervised learning, such as where connection weights are trained with back propagation or under feedback. In embodiments, a TDNN may be used to process sensor data from distinct streams, such as a stream of velocity data, a stream of acceleration data, a stream of temperature data, a stream of pressure data, and the like, where time delays are used to align the data streams in time, such as to help understand patterns that involve understanding of the various streams (e.g., changes in price patterns in spot or forward markets).

In embodiments, methods and systems described herein that involve an expert system or self-organization capability may use a convolutional neural network (referred to in some cases as a CNN, a ConvNet, a shift invariant neural network, or a space invariant neural network), wherein the units are connected in a pattern similar to the visual cortex of the human brain. Neurons may respond to stimuli in a restricted region of space, referred to as a receptive field. Receptive fields may partially overlap, such that they collectively cover the entire (e.g., visual) field. Node responses may be calculated mathematically, such as by a convolution operation, such as using multilayer perceptrons that use minimal preprocessing. A convolutional neural network may be used for recognition within images and video streams, such as for recognizing a type of machine in a large environment using a camera system disposed on a mobile data collector, such as on a drone or mobile robot. In embodiments, a convolutional neural network may be used to provide a recommendation based on data inputs, including sensor inputs and other contextual information, such as recommending a route for a mobile data collector. In embodiments, a convolutional neural network may be used for processing inputs, such as for natural language processing of instructions provided by one or more parties involved in a workflow in an environment. In embodiments, a convolutional neural network may be deployed with a large number of neurons (e.g., 100,000, 500,000 or more), with multiple (e.g., 4, 5, 6 or more) layers, and with many (e.g., millions) of parameters. A convolutional neural net may use one or more convolutional nets.

In embodiments, methods and systems described herein that involve an expert system or self-organization capability may use a regulatory feedback network, such as for recognizing emergent phenomena (such as new types of behavior not previously understood in a transactional environment).

In embodiments, methods and systems described herein that involve an expert system or self-organization capability may use a self-organizing map (SOM), involving unsupervised learning. A set of neurons may learn to map points in an input space to coordinates in an output space. The input space may have different dimensions and topology from the output space, and the SOM may preserve these while mapping phenomena into groups.

In embodiments, methods and systems described herein that involve an expert system or self-organization capability may use a learning vector quantization neural net (LVQ). Prototypical representatives of the classes may parameterize, together with an appropriate distance measure, in a distance-based classification scheme.

In embodiments, methods and systems described herein that involve an expert system or self-organization capability may use an echo state network (ESN), which may comprise a recurrent neural network with a sparsely connected, random hidden layer. The weights of output neurons may be changed (e.g., the weights may be trained based on feedback). In embodiments, an ESN may be used to handle time series patterns, such as, in an example, recognizing a pattern of events associated with a market, such as the pattern of price changes in response to stimuli.

In embodiments, methods and systems described herein that involve an expert system or self-organization capability may use a Bi-directional, recurrent neural network (BRNN), such as using a finite sequence of values (e.g., voltage values from a sensor) to predict or label each element of the sequence based on both the past and the future context of the element. This may be done by adding the outputs of two RNNs, such as one processing the sequence from left to right, the other one from right to left. The combined outputs are the predictions of target signals, such as ones provided by a teacher or supervisor. A bi-directional RNN may be combined with a long short-term memory RNN.

In embodiments, methods and systems described herein that involve an expert system or self-organization capability may use a hierarchical RNN that connects elements in various ways to decompose hierarchical behavior, such as into useful subprograms. In embodiments, a hierarchical RNN may be used to manage one or more hierarchical templates for data collection in a transactional environment.

In embodiments, methods and systems described herein that involve an expert system or self-organization capability may use a stochastic neural network, which may introduce random variations into the network. Such random variations may be viewed as a form of statistical sampling, such as Monte Carlo sampling.

In embodiments, methods and systems described herein that involve an expert system or self-organization capability may use a genetic scale recurrent neural network. In such embodiments, an RNN (often an LSTM) is used where a series is decomposed into a number of scales where every scale informs the primary length between two consecutive points. A first order scale consists of a normal RNN, a second order consists of all points separated by two indices and so on. The Nth order RNN connects the first and last node. The outputs from all the various scales may be treated as a committee of members, and the associated scores may be used genetically for the next iteration.

In embodiments, methods and systems described herein that involve an expert system or self-organization capability may use a committee of machines (CoM), comprising a collection of different neural networks that together “vote” on a given example. Because neural networks may suffer from local minima, starting with the same architecture and training, but using randomly different initial weights often gives different results. A CoM tends to stabilize the result.

In embodiments, methods and systems described herein that involve an expert system or self-organization capability may use an associative neural network (ASNN), such as involving an extension of a committee of machines that combines multiple feed forward neural networks and a k-nearest neighbor technique. It may use the correlation between ensemble responses as a measure of distance amid the analyzed cases for the kNN. This corrects the bias of the neural network ensemble. An associative neural network may have a memory that may coincide with a training set. If new data become available, the network instantly improves its predictive ability and provides data approximation (self-learns) without retraining. Another important feature of ASNN is the possibility to interpret neural network results by analysis of correlations between data cases in the space of models.

In embodiments, methods and systems described herein that involve an expert system or self-organization capability may use an instantaneously trained neural network (ITNN), where the weights of the hidden and the output layers are mapped directly from training vector data.

In embodiments, methods and systems described herein that involve an expert system or self-organization capability may use a spiking neural network, which may explicitly consider the timing of inputs. The network input and output may be represented as a series of spikes (such as a delta function or more complex shapes). SNNs may process information in the time domain (e.g., signals that vary over time, such as signals involving dynamic behavior of markets or transactional environments). They are often implemented as recurrent networks.

In embodiments, methods and systems described herein that involve an expert system or self-organization capability may use a dynamic neural network that addresses nonlinear multivariate behavior and includes learning of time-dependent behavior, such as transient phenomena and delay effects. Transients may include behavior of shifting market variables, such as prices, available quantities, available counterparties, and the like.

In embodiments, cascade correlation may be used as an architecture and supervised learning algorithm, supplementing adjustment of the weights in a network of fixed topology. Cascade-correlation may begin with a minimal network, then automatically trains, and adds new hidden units one by one, creating a multi-layer structure. Once a new hidden unit has been added to the network, its input-side weights may be frozen. This unit then becomes a permanent feature-detector in the network, available for producing outputs or for creating other, more complex feature detectors. The cascade-correlation architecture may learn quickly, determine its own size and topology, and retain the structures it has built even if the training set changes and requires no back-propagation.

In embodiments, methods and systems described herein that involve an expert system or self-organization capability may use a neuro-fuzzy network, such as involving a fuzzy inference system in the body of an artificial neural network. Depending on the type, several layers may simulate the processes involved in a fuzzy inference, such as fuzzification, inference, aggregation and defuzzification. Embedding a fuzzy system in a general structure of a neural net as the benefit of using available training methods to find the parameters of a fuzzy system.

In embodiments, methods and systems described herein that involve an expert system or self-organization capability may use a compositional pattern-producing network (CPPN), such as a variation of an associative neural network (ANN) that differs the set of activation functions and how they are applied. While typical ANNs often contain only sigmoid functions (and sometimes Gaussian functions), CPPNs may include both types of functions and many others. Furthermore, CPPNs may be applied across the entire space of possible inputs, so that they may represent a complete image. Since they are compositions of functions, CPPNs in effect encode images at infinite resolution and may be sampled for a particular display at whatever resolution is optimal.

This type of network may add new patterns without re-training. In embodiments, methods and systems described herein that involve an expert system or self-organization capability may use a one-shot associative memory network, such as by creating a specific memory structure, which assigns each new pattern to an orthogonal plane using adjacently connected hierarchical arrays.

In embodiments, methods and systems described herein that involve an expert system or self-organization capability may use a hierarchical temporal memory (HTM) neural network, such as involving the structural and algorithmic properties of the neocortex. HTM may use a biomimetic model based on memory-prediction theory. HTM may be used to discover and infer the high-level causes of observed input patterns and sequences.

### Machine Learning System

In embodiments, the machine learning system may train models, such as predictive models (e.g., various types of neural networks, regression based models, and other machine-learned models). In embodiments, training can be supervised, semi-supervised, or unsupervised. In embodiments, training can be done using training data, which may be collected or generated for training purposes.

A facility output model (or prediction model) may be a model that receive facility attributes and outputs one or more predictions regarding the production or other output of a facility. Examples of predictions may be the amount of energy a facility will produce, the amount of processing the facility will undertake, the amount of data a network will be able to transfer, the amount of data that can be stored, the price of a component, service or the like (such as supplied to or provided by a facility), a profit generated by accomplishing a given tasks, the cost entailed in performing an action, and the like. In each case, the machine learning system optionally trains a model based on training data. In embodiments, the machine learning system may receive vectors containing facility attributes (e.g., facility type, facility capability, objectives sought, constraints or rules that apply to utilization of resources or the facility, or the like), person attributes (e.g., role, components managed, and the like), and outcomes (e.g., energy produced, computing tasks completed, and financial results, among many others). Each vector corresponds to a respective outcome and the attributes of the respective facility and respective actions that led to the outcome. The machine learning system takes in the vectors and generates predictive model based thereon. In embodiments, the machine learning system may store the predictive models in the model datastore.

In embodiments, training can also be done based on feedback received by the system, which is also referred to as “reinforcement learning.” In embodiments, the machine learning system may receive a set of circumstances that led to a prediction (e.g., attributes of facility, attributes of a model, and the like) and an outcome related to the facility and may update the model according to the feedback.

In embodiments, training may be provided from a training data set that is created by observing actions of a set of humans, such as facility managers managing facilities that have various capabilities and that are involved in various contexts and situations. This may include use of robotic process automation to learn on a training data set of interactions of humans with interfaces, such as graphical user interfaces, of one or more computer programs, such as dashboards, control systems, and other systems that are used to manage an energy and compute management facility.

### Artificial Intelligence (AI) Systems

In embodiments, the AI system leverages the predictive models to make predictions regarding facilities. Examples of predictions include ones related to inputs to a facility (e.g., available energy, cost of energy, cost of compute resources, networking capacity and the like, as well as various market information, such as pricing information for end use markets), ones related to components or systems of a facility (including performance predictions, maintenance predictions, uptime/downtime predictions, capacity predictions and the like), ones related to functions or workflows of the facility (such as ones that involved conditions or states that may result in following one or more distinct possible paths within a workflow, a process, or the like), ones related to outputs of the facility, and others. In embodiments, the AI system receives a facility identifier. In response to the facility identifier, the AI system may retrieve attributes corresponding to the facility. In some embodiments, the AI system may obtain the facility attributes from a graph. Additionally or alternatively, the AI system may obtain the facility attributes from a facility record corresponding to the facility identifier, and the person attributes from a person record corresponding to the person identifier.

Examples of additional attributes that can be used to make predictions about a facility or a related process of system include: related facility information; owner goals (including financial goals); client goals; and many more additional or alternative attributes. In embodiments, the AI system may output scores for each possible prediction, where each prediction corresponds to a possible outcome. For example, in using a prediction model used to determine a likelihood that a hydroelectric source for a facility will produce 5 MW of power, the prediction model can output a score for a “will produce” outcome and a score for a “will not produce” outcome. The AI system may then select the outcome with the highest score as the prediction. Alternatively, the AI system may output the respective scores to a requesting system.

### Intelligence Services System

FIG. 3 illustrates an example intelligence system 300 (also referred to as “intelligence services,” an “intelligence services system,” or an “intelligence system”) according to some embodiments of the present disclosure. In embodiments, the intelligence system 300 provides a framework for providing intelligence services to one or more intelligence service clients 336. In some embodiments, the intelligence system 300 framework may be adapted to be at least partially replicated in respective intelligence clients 336 (e.g., an enterprise access layer, a wallet system, a market orchestration system, a digital lending system, an asset-backed tokenization system, and/or the like). In these embodiments, an individual client 336 may include some or all of the capabilities of the intelligence system 300, whereby the intelligence system 300 is adapted for the specific functions performed by the subsystems of the intelligence client. Additionally or alternatively, in some embodiments, the intelligence system 300 may be implemented as a set of microservices, such that different intelligence clients 336 may leverage the intelligence system 300 via one or more APIs exposed to the intelligence clients. In these embodiments, the intelligence system 300 may be configured to perform various types of intelligence services that may be adapted for different intelligence clients 336. In either of these configurations, an intelligence service client 336 may provide an intelligence request to the intelligence system 300, whereby the request is to perform a specific intelligence task (e.g., a decision, a recommendation, a report, an instruction, a classification, a prediction, a training action, an NLP request, or the like). In response, the intelligence system 300 executes the requested intelligence task and returns a response to the intelligence service client 336. Additionally or alternatively, in some embodiments, the intelligence system 300 may be implemented using one or more specialized chips that are configured to provide AI assisted microservices such as image processing, diagnostics, location and orientation, chemical analysis, data processing, and so forth. Examples of AI-enabled chips are discussed elsewhere in the disclosure.

In embodiments, an intelligence system 300 may include an intelligence service controller 302 and artificial intelligence (AI) modules 304. In embodiments, an artificial intelligence system 300 receives an intelligence request from an intelligence service client 336 and any required data to process the request from the intelligence service client 336. In response to the request and the specific data, one or more implicated artificial intelligence modules 304 perform the intelligence task and output an “intelligence response”. Examples of intelligence modules 304 responses may include a decision (e.g., a control instruction, a proposed action, machine-generated text, and/or the like), a prediction (e.g., a predicted meaning of a text snippet, a predicted outcome associated with a proposed action, a predicted fault condition, and/or the like), a classification (e.g., a classification of an object in an image, a classification of a spoken utterance, a classified fault condition based on sensor data, and/or the like), and/or other suitable outputs of an artificial intelligence system.

### Artificial Intelligence Modules

In embodiments, artificial intelligence modules 304 may include an ML module 312, a rules-based module 328, an analytics module 318, an RPA module 316, a digital twin module 320, a machine vision module 322, an NLP module 324, and/or a neural network module 314. It is appreciated that the foregoing are non-limiting examples of artificial intelligence modules, and that some of the modules may be included or leveraged by other artificial intelligence modules. For example, the NLP module 324 and the machine vision module 322 may leverage different neural networks that are part of the neural network module 314 in performance of their respective functions.

It is further noted that in some scenarios, artificial intelligence modules 304 themselves may also be intelligence clients 336. For example, a rules-based module 328 for intelligence may request an intelligence task from an ML module 312 or a neural network module 314, such as requesting a classification of an object appearing in a video and/or a motion of the object. In this example, the rules-based module 328 for intelligence may be an intelligence service client 336 that uses the classification to determine whether to take a specified action. In another example, a machine vision module 322 may request a digital twin of a specified environment from a digital twin module 320, such that the ML module 312 may request specific data from the digital twin as features to train a machine-learned model that is trained for a specific environment.

In embodiments, an intelligence task may require specific types of data to respond to the request. For example, a machine vision task requires one or more images (and potentially other data) to classify objects appearing in an image or set of images, to determine features within the set of images (such as locations of items, presence of faces, symbols or instructions, expressions, parameters of motion, changes in status, and many others), and the like. In another example, an NLP task requires audio of speech and/or text data (and potentially other data) to determine a meaning or other element of the speech and/or text. In yet another example, an AI-based control task (e.g., a decision on movement of a robot) may require environment data (e.g., maps, coordinates of known obstacles, images, and/or the like) and/or a motion plan to make a decision as to how to control the motion of a robot. In a platform-level example, an analytics-based reporting task may require data from a number of different databases to generate a report. Thus, in embodiments, tasks that can be performed by an intelligence system 300 may require, or benefit from, specific intelligence service inputs 332. In some embodiments, an intelligence system 300 may be configured to receive and/or request specific data from the intelligence service inputs 332 to perform a respective intelligence task. Additionally or alternatively, the requesting intelligence service client 336 may provide the specific data in the request. For instance, the intelligence system 300 may expose one or more APIs to the intelligence clients 336, whereby a requesting client 336 provides the specific data in the request via the API. Examples of intelligence service inputs may include, but are not limited to, sensors that provide sensor data, video streams, audio streams, databases, data feeds, human input, and/or other suitable data.

In embodiments, intelligence modules 304 includes and provides access to an ML module 312 that may be integrated into or be accessed by one or more intelligence clients 336. In embodiments, the ML module 312 may provide machine-based learning capabilities, features, functions, and algorithms for use by an intelligence service client 336 such as training ML models, leveraging ML models, reinforcing ML models, performing various clustering techniques, feature extraction, and/or the like. In an example, a machine learning module 312 may provide machine learning computing, data storage, and feedback infrastructure to a simulation system (e.g., as described above). The machine learning module 312 may also operate cooperatively with other modules, such as the rules-based module 328, the machine vision module 322, the RPA module 316, and/or the like.

The machine learning module 312 may define one or more machine learning models for performing analytics, simulation, decision making, and predictive analytics related to data processing, data analysis, simulation creation, and simulation analysis of one or more components or subsystems of an intelligence service client 336. In embodiments, the machine learning models are algorithms and/or statistical models that perform specific tasks without using explicit instructions, relying instead on patterns and inference. The machine learning models build one or more mathematical models based on training data to make predictions and/or decisions without being explicitly programmed to perform the specific tasks. In example implementations, machine learning models may perform classification, prediction, regression, clustering, anomaly detection, recommendation generation, and/or other tasks.

In embodiments, the machine learning models may perform various types of classification based on the input data. Classification is a predictive modeling problem where a class label is predicted for a given example of input data. For example, machine learning models can perform binary classification, multi-class or multi-label classification. In embodiments, the machine-learning model may output “confidence scores” that are indicative of a respective confidence associated with classification of the input into the respective class. In embodiments, the confidence scores can be compared to one or more thresholds to render a discrete categorical prediction. In embodiments, only a certain number of classes (e.g., one) with the relatively largest confidence scores can be selected to render a discrete categorical prediction.

In embodiments, machine learning models may output a probabilistic classification. For example, machine learning models may predict, given a sample input, a probability distribution over a set of classes. Thus, rather than outputting only the most likely class to which the sample input should belong, machine learning models can output, for each class, a probability that the sample input belongs to such class. In embodiments, the probability distribution over all possible classes can sum to one. In embodiments, a Softmax function, or other type of function or layer can be used to turn a set of real values respectively associated with the possible classes to a set of real values in the range (0, 1) that sum to one. In embodiments, the probabilities provided by the probability distribution can be compared to one or more thresholds to render a discrete categorical prediction. In embodiments, only a certain number of classes (e.g., one) with the relatively largest predicted probability can be selected to render a discrete categorical prediction.

In embodiments, machine learning models can perform regression to provide output data in the form of a continuous numeric value. As examples, machine learning models can perform linear regression, polynomial regression, or nonlinear regression. As described, in embodiments, a Softmax function or other function or layer can be used to squash a set of real values respectively associated with a two or more possible classes to a set of real values in the range (0, 1) that sum to one. For example, machine learning models can perform linear regression, polynomial regression, or nonlinear regression. As examples, machine learning models can perform simple regression or multiple regression. As described above, in some implementations, a Softmax function or other function or layer can be used to squash a set of real values respectively associated with a two or more possible classes to a set of real values in the range (0, 1) that sum to one.

In embodiments, machine learning models may perform various types of clustering. For example, machine learning models may identify one or more previously-defined clusters to which the input data most likely corresponds. In some implementations in which machine learning models performs clustering, machine learning models can be trained using unsupervised learning techniques.

In embodiments, machine learning models may perform anomaly detection or outlier detection. For example, machine learning models can identify input data that does not conform to an expected pattern or other characteristic (e.g., as previously observed from previous input data). As examples, the anomaly detection can be used for fraud detection or system failure detection.

In some implementations, machine learning models can provide output data in the form of one or more recommendations. For example, machine learning models can be included in a recommendation system or engine. As an example, given input data that describes previous outcomes for certain entities (e.g., a score, ranking, or rating indicative of an amount of success or enjoyment), machine learning models can output a suggestion or recommendation of one or more additional entities that, based on the previous outcomes, are expected to have a desired outcome

As described above, machine learning models can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, machine learning models can be or include one or more classifier models such as, for example, linear classification models; quadratic classification models; etc. Machine learning models may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning models can be or include one or more decision tree-based models such as, for example, classification and/or regression trees; chi-squared automatic interaction detection decision trees; decision stumps; conditional decision trees; etc.

Machine learning models may be or include one or more kernel machines. In some implementations, machine learning models can be or include one or more support vector machines. Machine learning models may be or include one or more instance-based learning models such as, for example, learning vector quantization models; self-organizing map models; locally weighted learning models; etc. In some implementations, machine learning models can be or include one or more nearest neighbor models such as, for example, k-nearest neighbor classifications models; k-nearest neighbors regression models; etc. Machine learning models can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

Machine learning models may include one or more clustering models such as, for example, k-means clustering models; k-medians clustering models; expectation maximization models; hierarchical clustering models; etc.

In some implementations, machine learning models can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine learning models can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In embodiments, artificial intelligence modules 304 may include and/or provide access to a neural network module 314. In embodiments, the neural network module 314 is configured to train, deploy, and/or leverage artificial neural networks (or “neural networks”) on behalf of an intelligence service client 336. It is noted that in the description, the term machine learning model may include neural networks, and as such, the neural network module 314 may be part of the machine learning module 312. In embodiments, the neural network module 314 may be configured to train neural networks that may be used by the intelligence clients 336. Non-limiting examples of different types of neural networks may include any of the neural network types described throughout this disclosure and the documents incorporated herein by reference, including without limitation convolutional neural networks (CNN), deep convolutional neural networks (DCN), feed forward neural networks (including deep feed forward neural networks), recurrent neural networks (RNN) (including without limitation gated RNNs), long/short term memory (LTSM) neural networks, and the like, as well as hybrids or combinations of the above, such as deployed in series, in parallel, in acyclic (e.g., directed graph-based) flows, and/or in more complex flows that may include intermediate decision nodes, recursive loops, and the like, where a given type of neural network takes inputs from a data source or other neural network and provides outputs that are included within the input sets of another neural network until a flow is completed and a final output is provided. In embodiments, the neural network module 314 may be leveraged by other artificial intelligence modules 304, such as the machine vision module 322, the NLP module 324, the rules-based module 328, the digital twin module 320, and so on. Example applications of the neural network module 314 are described throughout the disclosure.

A neural network includes a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

In embodiments, the neural networks can be or include one or more feed forward neural networks. In feed forward networks, the connections between nodes do not form a cycle. For example, each connection can connect a node from an earlier layer to a node from a later layer.

In embodiments, the neural networks can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc. In some example embodiments, recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, neural networks can be or include one or more non-recurrent sequence-to-sequence models based on self-attention, such as Transformer networks. Details of an exemplary transformer network can be found at http://papers.nips.cc/paper/7181-attention-is-all-you-need.pdf.

In embodiments, the neural networks can be or include one or more convolutional neural networks. In some instances, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

In embodiments, the neural networks can be or include one or more generative networks such as, for example, generative adversarial networks. Generative networks can be used to generate new data such as new images or other content.

In embodiments, the neural networks may be or include autoencoders. In some instances, the aim of an autoencoder is to learn a representation (e.g., a lower-dimensional encoding) for a set of data, typically for the purpose of dimensionality reduction. For example, in some instances, an autoencoder can seek to encode the input data and then provide output data that reconstructs the input data from the encoding. Recently, the autoencoder concept has become more widely used for learning generative models of data. In some instances, the autoencoder can include additional losses beyond reconstructing the input data.

In embodiments, the neural networks may be or include one or more other forms of artificial neural networks such as, for example, deep Boltzmann machines; deep belief networks; stacked autoencoders; etc. Any of the neural networks described herein can be combined (e.g., stacked) to form more complex networks.

FIG. 4 illustrates an example neural network with multiple layers. Neural network 340 may include an input layer, a hidden layer, and an output layer with each layer comprising a plurality of nodes or neurons that respond to different combinations of inputs from the previous layers. The connections between the neurons have numeric weights that determine how much relative effect an input has on the output value of the node in question. Input layer may include a plurality of input nodes 342, 344, 346, 348 and 350 that may provide information from the outside world or input data (e.g., sensor data, image data, text data, audio data, etc.) to the neural network 340. The input data may be from different sources and may include library data x1, simulation data x2, user input data x3, training data x4 and outcome data x5. The input nodes 342, 344, 346, 348 and 350 may pass on the information to the next layer, and no computation may be performed by the input nodes. Hidden layers may include a plurality of nodes, such as nodes 352, 354, and 356. The nodes 352, 354, and 356 in the hidden layer may process the information from the input layer based on the weights of the connections between the input layer and the hidden layer and transfer information to the output layer. Output layers may include an output node 358 which processes information based on the weights of the connections between the hidden layer and the output layer and is responsible for computing and transferring information as an output 359 from the network to the outside world, such as recognizing certain objects or activities, or predicting a condition or an action.

In embodiments, a neural network 340 may include two or more hidden layers and may be referred to as a deep neural network. The layers are constructed so that the first layer detects a set of primitive patterns in the input (e.g., image) data, the second layer detects patterns of patterns and the third layer detects patterns of those patterns. In some embodiments, a node in the neural network 340 may have connections to all nodes in the immediately preceding layer and the immediate next layer. Thus, the layers may be referred to as fully-connected layers. In some embodiments, a node in the neural network 340 may have connections to only some of the nodes in the immediately preceding layer and the immediate next layer. Thus, the layers may be referred to as sparsely-connected layers. Each neuron in the neural network consists of a weighted linear combination of its inputs and the computation on each neural network layer may be described as a multiplication of an input matrix and a weight matrix. A bias matrix is then added to the resulting product matrix to account for the threshold of each neuron in the next level. Further, an activation function is applied to each resultant value, and the resulting values are placed in the matrix for the next layer. Thus, the output from a node i in the neural network may be represented as:

$$yi = f ( \sum xiwi + bi )$$

where f is the activation function, Σxiwi is the weighted sum of input matrix and bi is the bias matrix.

The activation function determines the activity level or excitation level generated in the node as a result of an input signal of a particular size. The purpose of the activation function is to introduce non-linearity into the output of a neural network node because most real-world functions are non-linear and it is desirable that the neurons can learn these non-linear representations. Several activation functions may be used in an artificial neural network. One example activation function is the sigmoid function σ(x), which is a continuous S-shaped monotonically increasing function that asymptotically approaches fixed values as the input approaches plus or minus infinity. The sigmoid function σ(x) takes a real-valued input and transforms it into a value between 0 and 1:

$$σ ( x ) = 1 / ( 1 + exp ( - x ) ) .$$

Another example activation function is the tanh function, which takes a real-valued input and transforms it into a value within the range of [−1, 1]:

$$tanh ( x ) = 2 σ ( 2 x ) - 1$$

A third example activation function is the rectified linear unit (ReLU) function. The ReLU function takes a real-valued input and thresholds it above zero (i.e., replacing negative values with zero):

$$f ( x ) = max ( 0 , x ) .$$

It will be apparent that the above activation functions are provided as examples and in various embodiments, neural network 340 may utilize a variety of activation functions including (but not limited to) identity, binary step, logistic, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, softexponential, sinusoid, sinc, gaussian, softmax, maxout, and/or a combination of activation functions.

In the example shown in FIG. 4, nodes 342, 344, 346, 348 and 350 in the input layer may take external inputs x1, x2, x3, x4 and x5 which may be numerical values depending upon the input dataset. It will be understood that even though only five inputs are shown in FIG. 4, in various implementations, a node may include tens, hundreds, thousands, or more inputs. As discussed above, no computation is performed on the input layer and thus the outputs from nodes 342, 344, 346, 348 and 350 of input layer are x1, x2, x3, x4 and x5 respectively, which are fed into hidden layer. The output of node 352 in the hidden layer may depend on the outputs from the input layer (x1, x2, x3, x4 and x5) and weights associated with connections (w1, w2, w3, w4 and w5). Thus, the output from node 352 may be computed as:

$${Y}_{352} = f ( x 1 w 1 + x 2 w 2 + x 3 w 3 + x 4 w 4 + x 5 w 5 + {b}_{352} ) .$$

The outputs from the nodes 354 and 356 in the hidden layer may also be computed in a similar manner and then be fed to the node 358 in the output layer. Node 358 in the output layer may perform similar computations (using weights v1, v2 and v3 associated with the connections) as the nodes 352, 354 and 356 in the hidden layers:

$${Y}_{358} = f ( {y}_{352} v 1 + {y}_{354} v 2 + {y}_{356} v 3 + {b}_{358} ) ;$$

where Y₃₄₀ is the output of the neural network 340.

As mentioned, the connections between nodes in the neural network have associated weights, which determine how much relative effect an input value has on the output value of the node in question. Before the network is trained, random values are selected for each of the weights. The weights are adjusted during the training process and this adjustment of weights to determine the best set of weights that maximize the accuracy of the neural network is referred to as training. For every input in a training dataset, the output of the artificial neural network may be observed and compared with the expected output, and the error between the expected output and the observed output may be propagated back to the previous layer. The weights may be adjusted accordingly based on the error. This process is repeated until the output error is below a predetermined threshold.

In embodiments, backpropagation (e.g., backward propagation of errors) is utilized with an optimization method such as gradient descent to adjust weights and update the neural network characteristics. Backpropagation may be a supervised training scheme that learns from labeled training data and errors at the nodes by changing parameters of the neural network to reduce the errors. For example, a result of forward propagation (e.g., output activation value(s)) determined using training input data is compared against a corresponding known reference output data to calculate a loss function gradient. The gradient may be then utilized in an optimization method to determine new updated weights in an attempt to minimize a loss function. For example, to measure error, the mean square error is determined using the equation:

$$E = {( target - output )}^{2} \qquad ( eq . 1 )$$

To determine the gradient for a weight “w,” a partial derivative of the error with respect to the weight may be determined, where:

$$gradient = \partial E / \partial w \qquad ( eq . 2 )$$

The calculation of the partial derivative of the errors with respect to the weights may flow backwards through the node levels of the neural network. Then a portion (e.g., ratio, percentage, etc.) of the gradient is subtracted from the weight to determine the updated weight. The portion may be specified as a learning rate “a.”

Thus an example equation of determining the updated weight is given by the formula:

$${w}_{new} = {w}_{old} - α \partial E / \partial w \qquad ( eq . 3 )$$

The learning rate must be selected such that it is not too small (e.g., a rate that is too small may lead to a slow convergence to the desired weights) and not too large (e.g., a rate that is too large may cause the weights to not converge to the desired weights).

After the weight adjustment, the network should perform better than before for the same input because the weights have now been adjusted to minimize the errors.

As mentioned, neural networks may include convolutional neural networks (CNN). A CNN is a specialized neural network for processing data having a known, grid-like topology, such as image data. Accordingly, CNNs are commonly used for classification, object recognition and computer vision applications, but they also may be used for other types of pattern recognition such as speech and language processing.

A convolutional neural network learns highly non-linear mappings by interconnecting layers of artificial neurons arranged in many different layers with activation functions that make the layers dependent. It includes one or more convolutional layers, interspersed with one or more sub-sampling layers and non-linear layers, which are typically followed by one or more fully connected layers.

Referring to FIG. 5, a CNN 360 includes an input layer with an input image 362 to be classified by the CNN 360, a hidden layer which in turn includes one or more convolutional layers, interspersed with one or more activation or non-linear layers (e.g., ReLU) and pooling or sub-sampling layers and an output layer-typically including one or more fully connected layers. Input image 362 may be represented by a matrix of pixels and may have multiple channels. For example, a colored image may have a red, a green, and blue channels each representing red, green, and blue (RGB) components of the input image. Each channel may be represented by a 2-D matrix of pixels having pixel values in the range of 0 to 255. A gray-scale image on the other hand may have only one channel. The following section describes processing of a single image channel using CNN 360. It will be understood that multiple channels may be processed in a similar manner.

As shown, input image 362 may be processed by the hidden layer, which includes sets of convolutional and activation layers 364 and 368, each followed by pooling layers 366 and 370.

The convolutional layers of the convolutional neural network serve as feature extractors capable of learning and decomposing the input image into hierarchical features. The convolution layers may perform convolution operations on the input image where a filter (also referred as a kernel or feature detector) may slide over the input image at a certain step size (referred to as the stride). For every position (or step), element-wise multiplications between the filter matrix and the overlapped matrix in the input image may be calculated and summed to get a final value that represents a single element of an output matrix constituting a feature map. The feature map refers to image data that represents various features of the input image data and may have smaller dimensions as compared to the input image. The activation or non-linear layers use different non-linear trigger functions to signal distinct identification of likely features on each hidden layer. Non-linear layers use a variety of specific functions to implement the non-linear triggering, including the rectified linear units (ReLUs), hyperbolic tangent, absolute of hyperbolic tangent and sigmoid functions. In one implementation, a ReLU activation implements the function y=max (x, 0) and keeps the input and output sizes of a layer the same. The advantage of using ReLU is that the convolutional neural network is trained many times faster. ReLU is a non-continuous, non-saturating activation function that is linear with respect to the input if the input values are larger than zero and zero otherwise.

As shown in FIG. 5, the first convolution and activation layer 364 may perform convolutions on input image 362 using multiple filters followed by non-linearity operation (e.g., ReLU) to generate multiple output matrices (or feature maps) 372. The number of filters used may be referred to as the depth of the convolution layer. Thus, the first convolution and activation layer 364 in the example of FIG. 5 has a depth of three and generates three feature maps using three filters. Feature maps 372 may then be passed to the first pooling layer that may sub-sample or down-sample the feature maps using a pooling function to generate output matrix 374. The pooling function replaces the feature map with a summary statistic to reduce the spatial dimensions of the extracted feature map thereby reducing the number of parameters and computations in the network. Thus, the pooling layer reduces the dimensionality of the feature maps while retaining the most important information. The pooling function can also be used to introduce translation invariance into the neural network, such that small translations to the input do not change the pooled outputs. Different pooling functions may be used in the pooling layer, including max pooling, average pooling, and l2-norm pooling.

Output matrix 374 may then be processed by a second convolution and activation layer 368 to perform convolutions and non-linear activation operations (e.g., ReLU) as described above to generate feature maps 376. In the example shown in FIG. 5, second convolution and activation layer 368 may have a depth of five. Feature maps 376 may then be passed to a pooling layer 370, where feature maps 376 may be subsampled or down-sampled to generate an output matrix 378.

Output matrix 378 generated by pooling layer 370 is then processed by one or more fully connected layer 380 that forms a part of the output layer of CNN 360. The fully connected layer 380 has a full connection with all the feature maps of the output matrix 378 of the pooling layer 370. In embodiments, the fully connected layer 380 may take the output matrix 378 generated by the pooling layer 370 as the input in vector form, and perform high-level determination to output a feature vector containing information of the structures in the input image. In embodiments, the fully-connected layer 380 may classify the object in input image 362 into one of several categories using a Softmax function. The Softmax function may be used as the activation function in the output layer and takes a vector of real-valued scores and maps it to a vector of values between zero and one that sum to one. In embodiments, other classifiers, such as a support vector machine (SVM) classifier, may be used.

In embodiments, one or more normalization layers may be added to the CNN 360 to normalize the output of the convolution filters. The normalization layer may provide whitening or lateral inhibition, avoid vanishing or exploding gradients, stabilize training, and enable learning with higher rates and faster convergence. In embodiments, the normalization layers are added after the convolution layer but before the activation layer.

CNN 360 may thus be seen as multiple sets of convolution, activation, pooling, normalization and fully connected layers stacked together to learn, enhance and extract implicit features and patterns in the input image 362. A layer as used herein, can refer to one or more components that operate with similar function by mathematical or other functional means to process received inputs to generate/derive outputs for a next layer with one or more other components for further processing within CNN 360.

The initial layers of CNN 360 e.g., convolution layers, may extract low level features such as edges and/or gradients from the input image 362. Subsequent layers may extract or detect progressively more complex features and patterns such as presence of curvatures and textures in image data and so on. The output of each layer may serve as an input of a succeeding layer in CNN 360 to learn hierarchical feature representations from data in the input image 362. This allows convolutional neural networks to efficiently learn increasingly complex and abstract visual concepts.

Although only two convolution layers are shown in the example, the present disclosure is not limited to the example architecture, and CNN 360 architecture may comprise any number of layers in total, and any number of layers for convolution, activation and pooling. For example, there have been many variations and improvements over the basic CNN model described above. Some examples include Alexnet, GoogLeNet, VGGNet (that stacks many layers containing narrow convolutional layers followed by max pooling layers), Residual network or ResNet (that uses residual blocks and skip connections to learn residual mapping), DenseNet (that connects each layer of CNN to every other layer in a feed-forward fashion), Squeeze and excitation networks (that incorporate global context into features) and AmobeaNet (that uses evolutionary algorithms to search and find optimal architecture for image recognition).

### Training of Convolutional Neural Network

The training process of a convolutional neural network, such as CNN 360, may be similar to the training process discussed in FIG. 4 with respect to neural network 340.

In embodiments, all parameters and weights (including the weights in the filters and weights for the fully-connected layer are initially assigned (e.g., randomly assigned). Then, during training, a training image or images, in which the objects have been detected and classified, are provided as the input to the CNN 360, which performs the forward propagation steps. In other words, CNN 360 applies convolution, non-linear activation, and pooling layers to each training image to determine the classification vectors (i.e., detect and classify each training image). These classification vectors are compared with the predetermined classification vectors. The error (e.g., the squared sum of differences, log loss, softmax log loss) between the classification vectors of the CNN and the predetermined classification vectors is determined. This error is then employed to update the weights and parameters of the CNN in a backpropagation process which may use gradient descent and may include one or more iterations. The training process is repeated for each training image in the training set.

The training process and inference process described above may be performed on hardware, software, or a combination of hardware and software. However, training a convolutional neural network like CNN 360 or using the trained CNN for inference generally requires significant amounts of computation power to perform, for example, the matrix multiplications or convolutions. Thus, specialized hardware circuits, such as graphic processing units (GPUs), tensor processing units (TPUs), neural network processing units (NPUs), FPGAs, ASICS, or other highly parallel processing circuits may be used for training and/or inference. Training and inference may be performed on a cloud, on a data center, or on a device.

### Region Based CNNs (RCNNs) and Object Detection

In embodiments, an object detection model extends the functionality of CNN based image classification neural network models by not only classifying objects but also determining their locations in an image in terms of bounding boxes. Region-based CNN (R-CNN) methods are used to extract regions of interest (ROI), where each ROI is a rectangle that may represent the boundary of an object in image. Conceptually, R-CNN operates in two phases. In a first phase, region proposal methods generate all potential bounding box candidates in the image. In a second phase, for every proposal, a CNN classifier is applied to distinguish between objects. Alternatively, a fast R-CNN architecture can be used, which integrates the feature extractor and classifier into a unified network. Another faster R-CNN can be used, which incorporates a Region Proposal Network (RPN) and fast R-CNN into an end-to-end trainable framework. Mask R-CNN adds instance segmentation, while mesh R-CNN adds the ability to generate a 3D mesh from a 2D image.

Referring back to FIG. 3, in embodiments, the artificial intelligence modules 304 may provide access to and/or integrate a robotic process automation (RPA) module 316. The RPA module 316 may facilitate, among other things, computer automation of producing and validating workflows. The RPA module 316 provides automation of tasks performed by humans, such as receiving and reviewing written information, entering data into user interfaces, converting or otherwise processing data such as files or records, recording observations, generating documents such as reports, and communicating with other users by mechanisms such as email. In some cases, the tasks involve a workflow that includes a number of interrelated steps, contextual information that relates to the task, and interactions with other applications and humans. The RPA module 316 can be configured to receive or learn one or more such workflows on behalf of the human and in a manner similar to the actions and logic of the human, and can thereafter perform such workflows in response to various triggers such as events. Examples of RPA modules 316 may encompass those in this disclosure and in the documents incorporated by reference herein and may involve automation of any of the wide range of value chain network activities or entities described therein.

In embodiments, an RPA module 316 is configured to receive or learn a robotic process automation workflow in a variety of ways. As a first example, in embodiments, the RPA module 316 can include a graphical user interface (GUI) that enables a user to specify the details of the robotic process automation workflow. The GUI can include components that represent different types of actions, such as an action of receiving input from a user or application, an action of converting or otherwise processing data, and an action of providing input to an application. The GUI can receive, from the user, a selection of components representing actions that correspond to the steps of the workflow when performed by a human. The GUI can also receive, from the user, an interconnection of the selected components, such as a logical order in which the corresponding actions are to be performed, or a dependency of one component upon another component (e.g., a first component can output data that is received as input by another component). The GUI can include one or more templates, such as one or more sequences of actions that are performed together to complete a common workflow. The GUI can receive, from the user, a selection of a template, optionally including one or more details that adapt the selected template to a particular workflow performed by the human. Based on the input received from the user, the RPA module 316 can generate a robotic process automation workflow that can be executed to perform the workflow. The RPA module 316 can store the generated workflow for future use. For example, the RPA module 316 can execute the compiled code or interpret the generated script to perform the workflow in a similar manner as performed by the human.

As a second example, in embodiments, an RPA module 316 is configured to receive or learn a workflow based on a set of rules. For example, the RPA module 316 can include a GUI that enables a user to specify the details of the robotic process automation workflow as a set of conditions and responsive actions. The GUI includes a set of components that respond to conditions to be monitored, such as a status of a resource or an occurrence of an event. The GUI for designing the workflows can include a set of components that represent actions to be taken in response to an occurrence of one of the conditions. The GUI can receive, from the user, a selection of components representing one or more of the conditions of a workflow, and a selection of one or more components representing the actions to be taken in response to the conditions. In some embodiments, the GUI can include one or more templates, such as one or more conditions associated with one or more actions that correspond to a common workflow. The GUI can receive, from the user, a selection of one of the templates, including one or more details that adapt the selected template to a particular workflow performed by the human. Based on the input received from the user, the RPA module 316 can generate a robotic process automation workflow that automates a set of tasks in response to one or more detected events. The RPA module 316 can store the generated workflow for future use. For example, the RPA module 316 can monitor the selected conditions and perform the selected actions in response to an occurrence of the selected actions, in a similar manner as performed by the human.

As a third example, in embodiments, an RPA module 316 is configured to learn a workflow by recording a set of actions performed by a human to complete the workflow. For example, the RPA module 316 can receive, from the user, an indication of a start of the workflow involving a device, such as a selection of a Start Recording button. The RPA module 316 can receive user input from the user, such as input to one or more human interaction devices (HIDs) such as a keyboard, a mouse, a touchscreen, a camera, or a microphone. Alternatively or additionally, the RPA module 316 can receive user input as a series of human interaction events reported by a device, such as an input layer of an operating system that receives and aggregates user input from one or more human input devices. Alternatively or additionally, the RPA module 316 can receive user input as a series of events reported by one or more applications, such as a web browser that reports a set of user input events. The RPA module 316 can record the user input as a sequence of inputs. The RPA module 316 can associate the recorded user input with contextual information, such as an identification of the application to which the user input was directed. The RPA module 316 can associate the recorded user input with other events, such as preceding events of an application that receives the user input (e.g., an indication by a web browser that a web page has been rendered and is available to receive user input) and/or responsive events of the application in response to receiving the user input (e.g., an action performed by a web page in response to receiving user input). The RPA module 316 can associate the recorded user input with other events occurring within the device, such as an action performed by another application or an operating system of the device in response to the user input. The RPA module 316 can receive, from the user, an indication of an end of the workflow, such as a selection of a Stop Recording button. The RPA module 316 can generate a workflow that includes a record of the observed user input, optionally in association with other data. The RPA module 316 can store the generated workflow for future use. For example, the RPA module 316 can replay the sequence of recorded user input to perform the workflow in a similar manner as performed by the human.

As a fourth example, in embodiments, an RPA module 316 is configured to learn a workflow by watching an interaction between a human and a device. For example, a human can perform a number of workflows using the device over a period of time, such as a business day. The RPA module 316 can monitor the user input of the human and can identify, in the user input, one or more patterns of actions that are repeatedly performed by the human. The RPA module 316 can determine that a pattern of actions corresponds to a workflow performed by the human. In some embodiments, the RPA module 316 can identify variations among various instances of the actions when performed by the human during the workflow, such as different types of data entry that occur in different instances of the actions. The RPA module 316 can associate an action in the workflow with one or more parameters, wherein the parameters correspond to the different variations among the various instances of the action when performed by the human. In various embodiments, the RPA module 316 can determine a basis of each of the variations of the action that are associated with different variations of the action in the workflow. For example, the RPA module 316 can determine that when the workflow is performed by the human on behalf of a first user, the action is to be performed with a first data entry value, such as data entry including the name of the first user. When the workflow is performed by the human on behalf of a second user, the action is to be performed with a second data entry value, such as data entry including the name of the second user. The data entry can be represented in the workflow as a data entry parameter (e.g., a name of a user on whose behalf the workflow is performed), optionally with specific values that correspond to a context of the workflow (e.g., the names of the users on whose behalf the workflow can be performed). The RPA module 316 can generate a workflow that includes a sequence of commands that correspond to the pattern of actions performed by the user during the workflow, and, optionally, the parameters and/or parameter values of various actions of the workflow. The RPA module 316 can store the generated workflow for future use. For example, the RPA module 316 can replay the sequence of commands to replicate the pattern of actions that correspond to the workflow when performed in a similar manner as by the human.

In embodiments, the RPA module 316 can be implemented in a variety of architectures. As a first example, the RPA module 316 can be implemented on the same device as a human uses to perform a workflow, and/or that a user uses to specify the details of a workflow. The RPA module 316 can store one or more generated workflows on the device, and can perform the workflow on the same device. As a second example, the RPA module 316 can be implemented on a first device to replicate a workflow performed by a human on a second device. The RPA module 316 can monitor the interaction of the human with the second device while performing a task, generate and store a workflow on the first device, and execute the workflow on the first device to perform the task on the first device in a similar manner as performed by the user on the second device. As a third example, the RPA module 316 can be implemented on a first device to generate a workflow that corresponds to a task performed by the human on the first device, and can transmit the workflow to a second device. The workflow can cause the second device to perform the task on the second device in a similar manner as performed by the user on the first device. As a fourth example, the RPA module 316 can be implemented on a second device to receive a workflow that corresponds to a task performed by the human on a first device. The RPA module 316 workflow can execute the workflow on the second device to perform the task on the second device in a similar manner as performed by the user on the first device. In some embodiments, the RPA module 316 can be distributed over a set of two or more devices, such as a first portion of the RPA module 316 that executes on a first device to generate a workflow based on an interaction between a human and the first device, and a second portion of the RPA module 316 that executes on a second device to perform the workflow on the second device. In some embodiments, at least a portion of the RPA module 316 can be replicated over a plurality of devices, such as two or more devices that each perform (e.g., concurrently and/or consecutively) a workflow that was generated based on an interaction between a human and a first device. In some embodiments, different RPA modules 316 executing on each of a plurality of devices can interact to execute one or more workflows (e.g., a first RPA module 316 that executes on a first device to perform a first portion of a workflow, and a second RPA module 316 that executes on a second device to perform a second portion of the same workflow). Each RPA module 316 can operate in a particular role while performing at least a portion of a workflow, such as a first RPA module 316 that executes on a cloud edge device to receive an input of a workflow, a second RPA module 316 that executes on a cloud server to process the input of the workflow, and a third RPA module 316 that executes on another cloud edge device to present an output of the workflow.

In embodiments, an RPA module 316 can perform a workflow in response to a variety of triggers. The RPA module 316 can perform a workflow in response to a request of a user, such as a request to execute code or run a particular script in order to perform a learned workflow. The RPA module 316 can perform a workflow in response to a detection of a pattern of activity by a human (e.g., a second workflow that is to be performed by the RPA module 316 in response to a completion of a first workflow by a human). The RPA module 316 can perform at least a portion of a workflow in lieu of a human performing at least a portion of the workflow. For example, the RPA module 316 can detect a start of a workflow by a human, and can suggest to the human that the RPA module 316 perform the rest of the workflow. Upon receiving an acceptance of the suggestion, the RPA module 316 can perform the entire workflow in lieu of the human, and/or one or more remaining steps of the workflow following the initial steps performed by the human. The RPA module 316 can perform a workflow in response to an occurrence of a type of data (e.g., the device receiving a file that includes particular data type, such as a particular type of document or a particular type of image). The RPA module 316 can perform a workflow in response to receiving a message through a communication channel such as email, telephone, text message, gesture input received by a camera or haptic input device, or voice input received by a microphone. The RPA module 316 can perform a workflow in response to receiving a request from an operating system or an application executing on the device (e.g., a request from a spreadsheet application in response to a user entering a certain type of data). The RPA module 316 can perform a workflow in response to a detected event. For example, when a device recognizes a presence of a particular human (e.g., when a camera of a device recognizes a face of the human), the RPA module 316 can perform a workflow that involves displaying a report for the human. The RPA module 316 can perform a workflow at a scheduled interval, such as once per hour or once per day. The RPA module 316 can perform a workflow in response to a request received from another workflow executed on the same device or another device (e.g., a second workflow that is to be performed upon completion of a first workflow).

In embodiments, an RPA module 316 can perform a workflow based on a variety of inputs. The RPA module 316 can perform a workflow based on one or more details of a trigger of the workflow. For example, if the workflow is being performed in response to a request of a user to perform the workflow, the RPA module 316 can perform the workflow based on one or more details of the request. For example, if the workflow was triggered by a request of a user to process a particular document, the RPA module 316 can perform the workflow based on one or more details of the document. If the workflow is being performed in response to a message or telephone call, the RPA module 316 can perform the workflow based on an identity of the sender of the message or the identity of the caller. If the workflow is being performed as a daily instance based on a schedule, the RPA module 316 can perform the workflow based on the day of the week on which the workflow is being performed. If a workflow is being performed in response to a detection of a condition, the RPA module 316 can perform the workflow based on one or more details of the condition. For example, if the condition is a storage capacity of a device that exceeds a storage capacity threshold, the RPA module 316 can perform the workflow based on a severity of the storage capacity condition (e.g., a remaining storage capacity of the device). The RPA module 316 can perform a workflow based on a data source, such as one or more files of a file system, one or more rows or records of a database, or one or more messages received by a network interface. If the RPA module 316 is performing a workflow in response to one or more events, the RPA module 316 can perform the workflow based on one or more details of the event. For example, if the RPA module 316 is performing a second workflow in response to a completion of a first workflow on the same device or another device, the RPA module 316 can perform the workflow based on a date or time of the completion of the first workflow, a result of the first workflow, and/or an output of the first workflow. The RPA module 316 can perform a workflow based on one or more contextual details. For example, the RPA module 316 can perform a workflow based on a detected number and identities of humans who are present in the proximity of a device. The RPA module 316 can perform a workflow based on data associated with an application executing on the device. For example, if the RPA module 316 performs the workflow based on a loading of a web page, the RPA module 316 can perform the workflow based on data scraped from the contents of the web page. The RPA module 316 can perform the workflow based on observation of human actions that involve interactions with hardware elements, with software interfaces, and with other elements. Observations may include field observations as humans perform real tasks, as well as observations of simulations or other activities in which a human performs an action with the explicit intent to provide a training data set or input for the RPA module 316, such as where a human tags or labels a training data set with features that assist the RPA module 316 in learning to recognize or classify features or objects, among many other examples.

In embodiments, an RPA module 316 can interact with one or more applications while performing the workflow. For example, the RPA module 316 can extract data from a variable or an object of an application, such as text content of a textbox in a web form or the contents of cells in a spreadsheet. The RPA module 316 can extract data stored within an application (e.g., by inspecting a memory space of the application). The RPA module 316 can analyze data generated as output by the application (e.g., one or more files generated by the application, one or more rows or records of a spreadsheet generated by the application, or one or more network communication messages received and/or transmitted by the application over a network). The RPA module 316 can invoke an application programming interface (API) of the application to request data from the application, and can receive and analyze data provided by the application in response to the invocation of the API. The RPA module 316 can examine one or more properties of the device on which the application is executing (e.g., a portion of a display of the devices that includes a graphical user interface of the application) to extract data from the application. Alternatively or additionally, the RPA module 316 can provide data to an application and/or modify a behavior of an application while performing the workflow. For example, the RPA module 316 can generate user input that is directed to an application (e.g., simulating a human interaction device (HID), such as a keyboard, to generate keystrokes that are delivered to the application as user input). The RPA module 316 can directly transmit and/or modify data of the application (e.g., altering HTML data stored in a rendered web page to modifying the contents of the textbox, or directly modifying data in the memory space of an application). The RPA module 316 can request the operating system to interact with and/or modify the behavior of an application (e.g., requesting that the device start, activate, suspend, resume, close, or terminate an application). The RPA module 316 can invoke an API of the application to provide data to the application (e.g., invoking an API of a spreadsheet to request the entry of data into a particular cell). The RPA module 316 can invoke code associated with an application to provide data and/or modify the behavior of the application (e.g., executing code that is encoded in an application-specific programming language and embedded in a document used by an application or invoking a stored procedure of a database associated with the application). The RPA module 316 can cause or allow an interaction with an application to be visible to a human (e.g., the RPA module 316 can provide user input that simulates a user visually activating a spreadsheet application and visually typing data into various cells of the spreadsheet application). The RPA module 316 can hide an interaction with an application from a human (e.g., visually hiding a window of an application while entering data into one or more textboxes of the window of the application).

In embodiments, an RPA module 316 can utilize a variety of logical processes while performing a workflow. The RPA module 316 can retrieve, interpret, analyze, convert, validate, aggregate, partition, render, store, and/or otherwise process data that was received and/or is associated with the workflow. The RPA module 316 can transmit the data to another workflow, application, or device for processing or storage, and/or can query or receive the data from another workflow, application, or device. The RPA module 316 can apply an optical character recognition (OCR) process to an image (e.g., a picture of a form or a document) to determine and extract text content from the image. The RPA module 316 can apply a computer vision process to an image (e.g., a photograph captured by a camera) to determine and extract image data from the image, such as detecting, recognizing, classifying, and/or localizing one or more objects. The RPA module 316 can apply a speech recognition process to a sound input (e.g., a voice input from a telephone call or a microphone) to determine and extract voice content from the image, such as one or more voice commands. The RPA module 316 can apply a gesture recognition process to an input device (e.g., a camera, proximity sensor, or inertial measurement unit that detects movement of a hand) to determine one or more gestures performed by a human. The RPA module 316 can apply a pattern recognition process to data to detect one or more patterns in the data (e.g., analyzing sensor data from a machine to detect one or more occurrences of an event associated with the machine, such as a movement of a moving part of the machine).

In embodiments, the RPA module 316 performs a workflow in cooperation with a human or another workflow. For example, a workflow can include one or more human portions to be performed by a human and one or more automated portions to be performed by the RPA module 316. The RPA module 316 can first perform an automated portion and deliver a result of the automated portion to the human so that the human can perform a human portion based on the result. The RPA module 316 can receive a result of a human portion of the workflow and can perform an automated portion of the workflow on the result of the human portion of the workflow. The RPA module 316 can perform the automated portion of the workflow concurrently with a human performing a human portion of the workflow, and can then combine a result of the automated portion of the workflow with a result of the human portion of the workflow. The RPA module 316 can perform a first automated portion of the workflow, present a result of the first automated portion to a human for review and validation, and can perform a second automated portion of the workflow based on the review and validation of the result of the first automated portion based on a result of the review and validation by the human.

In embodiments, an RPA module 316 may learn to perform certain tasks based on the learned patterns and processes. The RPA module 316 can use one or more artificial intelligence modules 304 to perform one or more steps of a workflow. For example, an RPA module 316 can perform a data classification step on input data by applying a classification neural network to the input data. An RPA module 316 can perform a pattern recognition step on input data by applying a pattern recognition neural network to the input data. An RPA module 316 can perform a computer vision processing step and/or an optical character recognition step of a workflow by applying one or CNNs 360 to an image. An RPA module 316 can perform a sequential analysis step involving time series data by applying one or more recurrent neural networks (RNNs) to the time series data. An RPA module 316 can perform one or more natural language processing steps on a natural-language expression (e.g., a natural-language document or a natural-language voice input) by applying one or more transformer-based neural networks to the natural-language expression.

In various embodiments, the RPA module 316 uses one or more artificial intelligence modules 304 that are untrained. For example, the one or more artificial intelligence modules 304 can include a k-nearest-neighbor model that determines a classification of a received input based on a proximity of the received input to a collection of other inputs with known classifications. The k-nearest-neighbor model then classifies the received input according to a majority of the known classifications of the determined k inputs that are closest to the received input.

In various embodiments, the RPA module 316 uses one or more artificial intelligence modules 304 that are trained in an unsupervised manner. For example, the workflow can include an anomaly detection step, such as determining a portion of a form that includes handwritten text. An anomaly detection algorithm can partition the form into a collection of symbols, and can compare the symbols to distinguish between symbols that occur with a high frequency (e.g., machine-printed characters in a font) from symbols that occur with a low frequency (e.g., hand-printed characters that are unique or at least highly variable). The anomaly detection algorithm can therefore partition the form into regions that include machine-printed characters and regions that include hand-printed characters. The RPA module 316 can then process each region of the document with either an OCR module that is configured to recognize machine-printed characters in a font or an OCR module that is configured to recognize hand-printed characters.

In various embodiments, the RPA module 316 uses one or more artificial intelligence modules 304 that are specifically designed and/or trained for the workflow. For example, the workflow can be associated with a training data set, and the RPA module 316 can train one or more machine learning models to perform the processing of the workflow based on the training data set. In various embodiments, the RPA module 316 uses one or more pretrained artificial intelligence modules 304 to perform the processing of the workflow. For example, the RPA module 316 can receive a partially pretrained natural language processing (NLP) machine learning model that is generally trained to recognize sentence structure and word meaning. The RPA module 316 can adapt the partially pretrained NLP machine learning model based on natural-language expressions that are more specifically associated with the workflow. The adaptation can involve applying transfer learning to an artificial intelligence module 304 (e.g., more specifically training one or more classification layers in a classification portion of the NLP machine learning model while holding other portions of the NLP machine learning model constant). The adaptation can involve retraining an artificial intelligence module 304 (e.g., retraining an entirety of an NLP machine learning model based on natural-language expressions that are associated with a workflow). The adaptation can involve generating an ensemble of artificial intelligence modules 304 to perform the workflow (e.g., two or more artificial intelligence modules 304, each of which performs classification of data in a different way, wherein an output classification of the workflow is based on a consensus of the two or more artificial intelligence modules 304). The artificial intelligence modules 304 can include a random forest, in which each of one or more decision trees analyses an input data according to different criteria, and an output of the random forest is based on a consensus of the decision trees. The artificial intelligence modules 304 can include a stacking ensemble, in which each of two or more machine learning models processes data to generate an output, and another machine learning model determines which output, among the outputs of the two or more machine learning models, is to be used as the output of processing the data.

In embodiments, the RPA module 316 generates one or more outputs or results of a workflow. The RPA module 316 can generate, as output, data that can be stored by the device (e.g., as a file in a file system or as a row or record in a database). The RPA module 316 can generate, as output, data that is included in another data set (e.g., text entered into fields of a form, numbers entered into cells of a spreadsheet, or text entered into textboxes of a web page). The RPA module 316 can generate, as output, data that is transmitted to another device (e.g., a submission of form data of a web page to a webserver). The RPA module 316 can generate, as output, data that is communicated to one or more users (e.g., a visual notification of a result displayed for a user of the device, or a message that is transmitted to a user by a communication channel such as email, text message, or voice output). The RPA module 316 can generate, as output, data that modifies a behavior of an application (e.g., a command to start, activate, suspend, resume, close, or terminate an application). The RPA module 316 can generate, as output, data that modifies a behavior of the device or another device (e.g., a command that controls a machine, such as a printer, a camera, a device, or an industrial manufacturing device). The RPA module 316 can generate, as output, data that reflects an initial, current, or final status of the workflow (e.g., a dashboard that shows a progress of the workflow to completion, or a result of the workflow in combination with the results of other workflows). The RPA module 316 can generate, as output, one or more events (e.g., notifications to a human, an application, an operating system of the device, or another device as to the progression, completion, and/or results of the workflow). The events can be received and further processed by the RPA module 316 or another RPA module executing on the same device or another device. For example, upon completion of a first workflow, the RPA module 316 can initiate a second workflow based on a result and/or output of the first workflow. The RPA module 316 can generate, as output, documentation of one or more results of the workflow. For example, the RPA module 316 can update a log to document the results and/or output of the workflow, including one or more errors, exceptions, validation failures that occurred during the workflow.

In embodiments, the RPA module 316 modifies a workflow based on a performance of the workflow. For example, the RPA module 316 can request review, by a user, of one or more results of the workflow, including one or more errors, exceptions, validation failures that occurred during the workflow. The RPA module 316 can deactivate one or more steps or modules of the workflow that resulted in an error, exception, or validation failure. The RPA module 316 can automatically adjust the workflow to perform future instances of the workflow based on the completed instance of the workflow. For example, the RPA module 316 can update the workflow to improve an efficiency of the workflow, to add or remove functions to the workflow, to adjust functions of the workflow to perform differently, to log one or more instances and/or parameters of the workflow, and/or to eliminate or reduce one or more logical faults in the workflow. The RPA module 316 can update one or more artificial intelligence modules 304 associated with the workflow. For example, the RPA module 316 can generate or add one or more machine learning models to the workflow to improve processing of the workflow. The RPA module 316 can remove one or more machine learning models to improve efficiency of the workflow. The RPA module 316 can redesign and/or retrain one or more machine learning models based on a result of the workflow. The RPA module 316 can add one or more machine learning models to an existing ensemble of machine learning models.

### Analytics Module

In embodiments, the artificial intelligence modules 304 may include and/or provide access to an analytics module 318. In embodiments, an analytics module 318 is configured to perform various analytical processes on data output from value chain entities or other data sources. In example embodiments, analytics produced by the analytics module 318 may facilitate quantification of system performance as compared to a set of goals and/or metrics. The goals and/or metrics may be preconfigured, determined dynamically from operating results, and the like. Examples of analytics processes that can be performed by an analytics module 318 are discussed below and in the document incorporated herein by reference. In some example implementations, analytics processes may include tracking goals and/or specific metrics that involve coordination of value chain activities and demand intelligence, such as involving forecasting demand for a set of relevant items by location and time (among many others).

### Digital Twin Module

In embodiments, artificial intelligence modules 304 may include and/or provide access to a digital twin module 320. The digital twin module 320 may encompass any of a wide range of features and capabilities described herein In embodiments, a digital twin module 320 may be configured to provide, among other things, execution environments for and different types of digital twins, such as twins of physical environments, twins of robot operating units, logistics twins, executive digital twins, organizational digital twins, role-based digital twins, and the like. In embodiments, the digital twin module 320 may be configured in accordance with digital twin systems and/or modules described elsewhere throughout the disclosure. In example embodiments, a digital twin module 320 may be configured to generate digital twins that are requested by intelligence clients 336. Further, the digital twin module 320 may be configured with interfaces, such as APIs and the like for receiving information from external data sources. For instance, the digital twin module 320 may receive real-time data from sensor systems of a machinery, vehicle, robot, or other device, and/or sensor systems of the physical environment in which a device operates. In embodiments, the digital twin module 320 may receive digital twin data from other suitable data sources, such as third-party services (e.g., weather services, traffic data services, logistics systems and databases, and the like. In embodiments, the digital twin module 320 may include digital twin data representing features, states, or the like of value chain network entities, such as supply chain infrastructure entities, transportation or logistic entities, containers, goods, or the like, as well as demand entities, such as customers, merchants, stores, points-of-sale, points-of-use, and the like. The digital twin module 320 may be integrated with or into, link to, or otherwise interact with an interface (e.g., a control tower or dashboard), for coordination of supply and demand, including coordination of automation within supply chain activities and demand management activities.

In embodiments, a digital twin module 320 may provide access to and manage a library of digital twins. Artificial intelligence modules 304 may access the library to perform functions, such as a simulation of actions in a given environment in response to certain stimuli.

### Machine Vision Module

In embodiments, artificial intelligence modules 304 may include and/or provide access to a machine vision module 322. In embodiments, a machine vision module 322 is configured to process images (e.g., captured by a camera) to detect and classify objects in the image. In embodiments, the machine vision module 322 receives one or more images (which may be frames of a video feed or single still shot images) and identifies “blobs” in an image (e.g., using edge detection techniques or the like). The machine vision module 322 may then classify the blobs. In some embodiments, the machine vision module 322 leverages one or more machine-learned image classification models and/or neural networks (e.g., convolutional neural networks) to classify the blobs in the image. In some embodiments, the machine vision module 322 may perform feature extraction on the images and/or the respective blobs in the image prior to classification. In some embodiments, the machine vision module 322 may leverage classification made in a previous image to affirm or update classification(s) from the previous image. For example, if an object that was detected in a previous frame was classified with a lower confidence score (e.g., the object was partially occluded or out of focus), the machine vision module 322 may affirm or update the classification if the machine vision module 322 is able to determine a classification of the object with a higher degree of confidence. In embodiments, the machine vision module 322 is configured to detect occlusions, such as objects that may be occluded by another object. In embodiments, the machine vision module 322 receives additional input to assist in image classification tasks, such as from a radar, a sonar, a digital twin of an environment (which may show locations of known objects), and/or the like. In some embodiments, a machine vision module 322 may include or interface with a liquid lens. In these embodiments, the liquid lens may facilitate improved machine vision (e.g., when focusing at multiple distances is necessitated by the environment and job of a robot) and/or other machine vision tasks that are enabled by a liquid lens.

### Natural Language Processing Module

In embodiments, the artificial intelligence modules 304 may include and/or provide access to a natural language processing (NLP) module 324. In embodiments, an NLP module 324 performs natural language tasks on behalf of an intelligence service client 336. Examples of natural language processing techniques may include, but are not limited to, speech recognition, speech segmentation, speaker diarization, text-to-speech, lemmatization, morphological segmentation, parts-of-speech tagging, stemming, syntactic analysis, lexical analysis, and the like. In embodiments, the NLP module 324 may enable voice commands that are received from a human. In embodiments, the NLP module 324 receives an audio stream (e.g., from a microphone) and may perform voice-to-text conversion on the audio stream to obtain a transcription of the audio stream. The NLP module 324 may process text (e.g., a transcription of the audio stream) to determine a meaning of the text using various NLP techniques (e.g., NLP models, neural networks, and/or the like). In embodiments, the NLP module 324 may determine an action or command that was spoken in the audio stream based on the results of the NLP. In embodiments, the NLP module 324 may output the results of the NLP to an intelligence service client 336.

In embodiments, the NLP module 324 provides an intelligence service client 336 with the ability to parse one or more conversational voice instructions provided by a human user to perform one or more tasks as well as communicate with the human user. The NLP module 324 may perform speech recognition to recognize the voice instructions, natural language understanding to parse and derive meaning from the instructions, and natural language generation to generate a voice response for the user upon processing of the user instructions. In some embodiments, the NLP module 324 enables an intelligence service client 336 to understand the instructions and, upon successful completion of the task by the intelligence service client 336, provide a response to the user. In embodiments, the NLP module 324 may formulate and ask questions to a user if the context of the user request is not completely clear. In embodiments, the NLP module 324 may utilize inputs received from one or more sensors including vision sensors, location-based data (e.g., GPS data) to determine context information associated with processed speech or text data.

In embodiments, the NLP module 324 uses neural networks when performing NLP tasks, such as recurrent neural networks, long short term memory (LSTMs), gated recurrent unit (GRUs), transformer neural networks, convolutional neural networks and/or the like.

FIG. 6 illustrates an example neural network for implementing NLP module 324. In the illustrated example, the example neural network is a transformer neural network. In the example, the transformer neural network includes three input stages and five output stages to transform an input sequence into an output sequence. The example transformer includes an encoder 382 and a decoder 384. The encoder 382 processes input, and the decoder 384 generates output probabilities, for example. The encoder 382 includes three stages, and the decoder 384 includes five stages. Encoder 382 stage 1 represents an input as a sequence of positional encodings added to embedded inputs. Encoder 382 stages 2 and 3 include N layers (e.g., N=6, etc.) in which each layer includes a position-wise feedforward neural network (FNN) and an attention-based sublayer. Each attention-based sublayer of encoder 382 stage 2 includes four linear projections and multi-head attention logic to be added and normalized to be provided to the position-wise FNN of encoder 382 stage 3. Encoder 382 stages 2 and 3 employ a residual connection followed by a normalization layer at their output.

The example decoder 384 processes an output embedding as its input with the output embedding shifted right by one position to help ensure that a prediction for position i is dependent on positions previous to/less than i. In stage 2 of the decoder 384, masked multi-head attention is modified to prevent positions from attending to subsequent positions. Stages 3-4 of the decoder 384 include N layers (e.g., N=6, etc.) in which each layer includes a position-wise FNN and two attention-based sublayers. Each attention-based sublayer of decoder 384 stage 3 includes four linear projections and multi-head attention logic to be added and normalized to be provided to the position-wise FNN of decoder 384 stage 4. Decoder 384 stages 2-4 employ a residual connection followed by a normalization layer at their output. Decoder 384 stage 5 provides a linear transformation followed by a softmax function to normalize a resulting vector of K numbers into a probability distribution including K probabilities proportional to exponentials of the K input numbers.

Additional examples of neural networks may be found elsewhere in the disclosure.

### Rules-Based Module

Referring back to FIG. 3, in embodiments, artificial intelligence modules 304 may also include and/or provide access to a rules-based module 328 that may be integrated into or be accessed by an intelligence service client 336. In some embodiments, a rules-based module 328 may be configured with programmatic logic that defines a set of rules and other conditions that trigger certain actions that may be performed in connection with an intelligence client. In embodiments, the rules-based module 328 may be configured with programmatic logic that receives input and determines whether one or more rules are met based on the input. If a condition is met, the rules-based module 328 determines an action to perform, which may be output to a requesting intelligence service client 336. The data received by the rules-based engine may be received from an intelligence service input 332 source and/or may be requested from another module in artificial intelligence modules 304, such as the machine vision module 322, the neural network module 314, the ML module 312, and/or the like. For example, a rules-based module 328 may receive classifications of objects in a field of view of a mobile system (e.g., robot, autonomous vehicle, or the like) from a machine vision system and/or sensor data from a lidar sensor of the mobile system and, in response, may determine whether the mobile system should continue in its path, change its course, or stop. In embodiments, the rules-based module 328 may be configured to make other suitable rules-based decisions on behalf of a respective client 336, examples of which are discussed throughout the disclosure. In some embodiments, the rules-based engine may apply governance standards and/or analysis modules, which are described in greater detail below.

### Intelligence Services Controller and Analysis Management Module

In embodiments, artificial intelligence modules 304 interface with an intelligence service controller 302, which is configured to determine a type of request issued by an intelligence service client 336 and, in response, may determine a set of governance standards and/or analyses that are to be applied by the artificial intelligence modules 304 when responding to the request. In embodiments, the intelligence service controller 302 may include an analysis management module 306, a set of analysis modules 308, and a governance library 310.

In embodiments, an intelligence service controller 302 is configured to determine a type of request issued by an intelligence service client 336 and, in response, may determine a set of governance standards and/or analyses that are to be applied by the artificial intelligence modules 304 when responding to the request. In embodiments, the intelligence service controller 302 may include an analysis management module 306, a set of analysis modules 308, and a governance library 310. In embodiments, the analysis management module 306 receives an artificial intelligence module 304 request and determines the governance standards and/or analyses implicated by the request. In embodiments, the analysis management module 306 may determine the governance standards that apply to the request based on the type of decision that was requested and/or whether certain analyses are to be performed with respect to the requested decision. For example, a request for a control decision that results in an intelligence service client 336 performing an action may implicate a certain set of governance standards that apply, such as safety standards, legal standards, quality standards, or the like, and/or may implicate one or more analyses regarding the control decision, such as a risk analysis, a safety analysis, an engineering analysis, or the like.

In some embodiments, the analysis management module 306 may determine the governance standards that apply to a decision request based on one or more conditions. Non-limiting examples of such conditions may include the type of decision that is requested, a geolocation in which a decision is being made, an environment that the decision will affect, current or predicted environment conditions of the environment and/or the like. In embodiments, the governance standards may be defined as a set of standards libraries stored in a governance library 310. In embodiments, standards libraries may define conditions, thresholds, rules, recommendations, or other suitable parameters by which a decision may be analyzed. Examples of standards libraries may include, legal standards library, a regulatory standards library, a quality standards library, an engineering standards library, a safety standards library, a financial standards library, and/or other suitable types of standards libraries. In embodiments, the governance library 310 may include an index that indexes certain standards defined in the respective standards library based on different conditions. Examples of conditions may be a jurisdiction or geographic areas to which certain standards apply, environmental conditions to which certain standards apply, device types to which certain standards apply, materials or products to which certain standards apply, and/or the like.

In some embodiments, the analysis management module 306 may determine the appropriate set of standards that must be applied with respect to a particular decision and may provide the appropriate set of standards to the artificial intelligence modules 304, such that the artificial intelligence modules 304 leverages the implicated governance standards when determining a decision. In these embodiments, the artificial intelligence modules 304 may be configured to apply the standards in the decision-making process, such that a decision output by the artificial intelligence modules 304 is consistent with the implicated governance standards. It is appreciated that the standards libraries in the governance library may be defined by the platform provider, customers, and/or third parties. The standards may be government standards, industry standards, customer standards, or other suitable sources. In embodiments, each set of standards may include a set of conditions that implicate the respective set of standards, such that the conditions may be used to determine which standards to apply given a situation.

In some embodiments, the analysis management module 306 may determine one or more analyses that are to be performed with respect to a particular decision and may provide corresponding analysis modules 308 that perform those analyses to the artificial intelligence modules 304, such that the artificial intelligence modules 304 leverage the corresponding analysis modules 308 to analyze a decision before outputting the decision to the requesting client. In embodiments, the analysis modules 308 may include modules that are configured to perform specific analyses with respect to certain types of decisions, whereby the respective modules are executed by a processing system that hosts the instance of the intelligence system 300. Non-limiting examples of analysis modules 308 may include risk analysis module(s), security analysis module(s), decision tree analysis module(s), ethics analysis module(s), failure mode and effects (FMEA) analysis module(s), hazard analysis module(s), quality analysis module(s), safety analysis module(s), regulatory analysis module(s), legal analysis module(s), and/or other suitable analysis modules.

In some embodiments, the analysis management module 306 is configured to determine which types of analyses to perform based on the type of decision that was requested by an intelligence service client 336. In some of these embodiments, the analysis management module 306 may include an index or other suitable mechanism that identifies a set of analysis modules 308 based on a requested decision type. In these embodiments, the analysis management module 306 may receive the decision type and may determine a set of analysis modules 308 that are to be executed based on the decision type. Additionally or alternatively, one or more governance standards may define when a particular analysis is to be performed. For example, the engineering standards may define what scenarios necessitate a FMEA analysis. In this example, the engineering standards may have been implicated by a request for a particular type of decision and the engineering standards may define scenarios when an FMEA analysis is to be performed. In this example, artificial intelligence modules 304 may execute a safety analysis module and/or a risk analysis module and may determine an alternative decision if the action would violate a legal standard or a safety standard. In response to analyzing a proposed decision, artificial intelligence modules 304 may selectively output the proposed condition based on the results of the executed analyses. If a decision is allowed, artificial intelligence modules 304 may output the decision to the requesting intelligence service client 336. If the proposed configuration is flagged by one or more of the analyses, artificial intelligence modules 304 may determine an alternative decision and execute the analyses with respect to the alternate proposed decision until a conforming decision is obtained.

It is noted here that in some embodiments, one or more analysis modules 308 may themselves be defined in a standard, and one or more relevant standards used together may comprise a particular analysis. For example, the applicable safety standard may call for a risk analysis that can use or more allowable methods. In this example, an ISO standard for overall process and documentation, and an ASTM standard for a narrowly defined procedure may be employed to complete the risk analysis required by the safety governance standard.

As mentioned, the foregoing framework of an intelligence system 300 may be applied in and/or leveraged by various entities of a value chain. For example, in some embodiments, a platform-level intelligence system may be configured with the entire capabilities of the intelligence system 300, and certain configurations of the intelligence system 300 may be provisioned for respective value chain entities. Furthermore, in some embodiments, an intelligence service client 336 may be configured to escalate an intelligence system task to a higher-level value chain entity (e.g., edge-level or the platform-level) when the intelligence service client 336 cannot perform the task autonomously. It is noted that in some embodiments, an intelligence service controller 302 may direct intelligence tasks to a lower-level component. Furthermore, in some implementations, an intelligence system 300 may be configured to output default actions when a decision cannot be reached by the intelligence system 300 and/or a higher or lower-level intelligence system. In some of these implementations, the default decisions may be defined in a rule and/or in a standards library.

### Reinforcement Learning to Determine Optimal Policy

Reinforcement learning (RL), is a machine learning technique where an agent iteratively learns optimal policy through interactions with the environment. In RL, the agent must discover correct actions by trial-and-error so as to maximize some notion of long-term reward. Specifically, in a system employing RL, there exist two entities: (1) an environment and (2) an agent. The agent is a computer program component that is connected to its environment such that it can sense the state of the environment as well as execute actions on the environment. On each step of interaction, the agent senses the current state of the environment, s, and chooses an action to take, a. The action changes the state of the environment, and the value of this state transition is communicated to the agent by a reward signal, r, where the magnitude of r indicates the desirability of an action. Over time, the agent builds a policy, π, which specifies the action the agent will take for each state of the environment.

Formally, in reinforcement learning, there exists a discrete set of environment states, S; a discrete set of agent actions, A; and a set of scalar reinforcement signals, R. After learning, the system creates a policy, π, that defines the value of taking action aεA in state sεS. The policy defines Qπ(s, a) as the expected return value for starting from s, taking action a, and following policy π.

The reinforcement learning agent is trained in a policy through iterative exposure to various states, having the agent select an action as per the policy and providing a reward based on a function designed to reward desirable behavior. Based on the reward feedback, the system may “learn” the policy and becomes trained in producing desirable actions. For example, for navigation policy, RL agent may evaluate its state repeatedly (e.g., location, distance from a target object), select an action (e.g., provide input to the motors for movement towards the target object), evaluate the action using a reward signal, which provides an indication of the of the success of the action. (e.g., a reward of +10 if movement reduces the distance between a mobile system and a target object and −10 if the movement increases the distance). Similarly, the RL agent may be trained in grasping policy by iteratively obtaining images of a target object to be grasped, attempt to grasp the object, evaluate the attempt, and then execute the subsequent iteration using the evaluation of the attempt of the preceding iteration(s) to assist in determining the next attempt.

There may be several approaches for training the RL agent in a policy. Imitation learning is a key approach in which the agent learns from state/action pairs where the actions are those that would be chosen by an expert (e.g., a human) in response to an observed state. Imitation learning not just solves sample-inefficiency or computational feasibility problems, but also makes the training process safer. The RL agent may derive multiple examples of the state/action pairs by observing a human (e.g., navigating towards and grasping a target object), and uses them as a basis for training the policy. Behavior cloning (BC), that focuses on learning the expert's policy using supervised learning is an example of imitation learning approach.

Value based learning approach aims to find a policy comprising a sequence of actions that maximizes the expectation value of future reward (or minimizes the expected cost). The RL agent may learn the value/cost function and then derives a policy with respect to the same. Two different expectation values are often referred to: the state value V(s) and the action value Q (s,a) respectively. The state value function V(s) represents the value associated with the agent at each state whereas the action value function Q(s,a) represents the value associated with the agent at state s and performing action a. The value-based learning approach works by approximating optimal value (V* or Q*) and then deriving an optimal policy. For example, the optimal value function Q*(s, a) may be identified by finding the sequence of actions which maximize the state-action value function Q (s, a). The optimal policy for each state can be derived by identifying the highest valued action that can be taken from each state.

$$π * ( s ) = argmax Q * ( s , a )$$

To iteratively calculate the value function as actions within the sequence are executed and the mobile system transitions from one state to another, the Bellman Optimality equation may be applied. The optimal value function Q*(s,a) obeys Bellman Optimality equation and can be expressed as:

$$Q * ( {s}_{t} , {a}_{t} ) = E [ {r}_{t + 1} + γ max Q * ( {s}_{t + 1} , {a}_{t + 1} ) ] \qquad ( eq . 4 )$$

Policy based learning approach directly optimizes the policy function π using a suitable optimization technique (e.g., stochastic gradient descent) to fine tune a vector of parameters without calculating a value function. The policy-based learning approach is typically effective in high-dimensional or continuous action spaces.

FIG. 7 illustrates an approach based on reinforcement learning and including evaluation of various states, actions and rewards in determining optimal policy for executing one or more tasks by a mobile system.

At 402, a reinforcement learning agent (e.g., of the intelligence services system 300) receives sensor information including a plurality of images captured by the mobile system in the environment. The analysis of one or more of these images may enable the agent to determine a first state associated with the mobile system at 404. The data representing the first state may include information about the environment, such as images, sounds, temperature or time and information about the mobile system, including its position, speed, internal state (e.g., battery life, clock setting) etc.

At 406, 408, and 410, various potential actions responsive to the state may be determined. Some examples of potential actions include providing control instructions to actuators, motors, wheels, wings flaps, or other components that controls the agent's speed, acceleration, orientation, or position; changing the agent's internal settings, such as putting certain components into a sleep mode to conserve battery life; changing the direction if the agent is in danger of colliding with an obstacle object; acquiring or transmitting data; attempting to grasp a target object and the like.

At 412, 414 and 416, expected rewards may be determined for each of the potential actions based on a reward function. For each of the determined potential actions, an expected reward may be determined based on a reward function. The reward may be predicated on a desired outcome, such as avoiding an obstacle, conserving power, or acquiring data. If the action yields the desired outcome (e.g., avoiding the obstacle), the reward is high; otherwise, the reward may be low.

The agent may also look to the future to analyze whether there may be opportunities for realizing higher rewards in the future. At 418, 420, and 422, the agent may determine future states resulting from potential actions respectively at 406, 408, and 410.

For each of the future states predicted at 418, 420, and 422, one or more future actions may be determined and evaluated. At 424, 426, and 428, for example, values or other indicators of expected rewards associated with one or more of the future actions may be developed. The expected rewards associated with the one or more future actions may be evaluated by comparing values of reward functions associated with each future action.

At 430, an action may be selected based on a comparison of expected current and future rewards.

In embodiments, the reinforcement learning agent may be pre-trained through simulations in a digital twin system. In embodiments, the reinforcement agent may be pre-trained using behavior cloning. In embodiments, the reinforcement agent may be trained using a deep reinforcement learning algorithm selected from Deep Q-Network (DQN), double deep Q-Network (DDQN), Deep Deterministic Policy Gradient (DDPG), soft actor critic (SAC), advantage actor critic (A2C), asynchronous advantage actor critic (A3C), proximal policy optimization (PPO), trust region policy optimization (TRPO).

In embodiments, the reinforcement learning agent may look to balance exploitation (of current knowledge) with exploration (of uncharted territory) while traversing the action space. For example, the agent may follow an ε-greedy policy by randomly selecting exploration occasionally with probability ε while taking the optimal action most of the time with probability 1−ε, where ε is a parameter satisfying 0<ε<1.

### Generative AI Systems

In example embodiments, a generative artificial intelligence engine (GAIE) may be combined with a machine learning system in a transaction environment. Input to the GAIE may include images, video, audio, text, programmatic code, data, and the like. Outputs from a GAIE may include structured and organized prose, images, video, audio content, software/programming source code, formatted data (e.g., arrays), algorithms, definitions, context-specific structures (e.g., smart contacts, transaction platform configuration data sets, and the like), machine language-based data (e.g., API-formatted content), and the like. For GAIE instances in which the models are designed to process text data, the GAIE may interface to other programmatic systems (such as traditional machine learning engines) to process other forms of data into text data. In example embodiments, the other programmatic systems, including systems executing machine learning algorithms, may produce textual based (optionally at volume) that may be consumed by GAIE. For example, consider such another system building a series of one thousand text-based observations on the other-formatted data; this may be a useful input for a GAIE model to learn and process (e.g., summarize) into text-formatted output information. In example embodiments, an interface between the GAIE and its combined machine learning system may be extended to include a dialogue between the systems, where the GAIE includes and/or accesses a capability to ask the machine learning system specific questions to facilitate the refining of its knowledge. For example, the dialogue capability may include a request of the machine learning system to provide an assessment of current market trading positions. In another example, the dialogue capability may encode numeric outputs from the machine learning engine into text (e.g., words, such as high, medium, low) that may be input for interpretation by the GAIE.

In example embodiments, the data processed by a GAIE may include one or more types of content. For example, a GAIE may receive, as input, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Input to the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be received as various forms of data. For example, a natural-language expression received as input by a GAIE could be encoded as one or more of: encoded text, an image of a writing, a sound recording of human speech, a video of an individual exhibiting sign language, an encoding according to a machine learning model embedding, or the like, or any combination thereof. In example embodiments, an input received and processed by the GAIE can include an internal state of the GAIE, such as a partial result of a partial processing of an input, or a set of weights and/or biases of the GAIE as a result of prior processing (e.g., an internal state of a recurrent neural network (RNN)).

In some embodiments, the data and/or content received and processed by a GAIE originates from one or more individuals, such as a person speaking a natural-language expression. In some embodiments, the data and/or content received and processed by a GAIE originates from one or more natural sources, such as patterns formed by nature. In some embodiments, the data and/or content received and processed by a GAIE originates from one or more other devices, such as another machine learning model executing on another device, or from another component of the same device executing the GAIE, such as output of another machine learning model executing on the same device executing the GAIE, or a sensor in an Internet-of-Things (IoT) and/or cloud architecture. In some embodiments, the data and/or content received and processed by a GAIE is artificially synthesized, such as synthetic data generated by an algorithm to augment a training data set. In some embodiments, the data and/or content received and processed by a GAIE is generated by the same GAIE, such as an internal state of the GAIE in response to previous and/or concurrent processing, or a previous output of the GAIE in the manner of a recurrent neural network (RNN).

In some embodiments, at least some or part of the data and/or content received and processed by a GAIE is also used to train the GAIE. For example, a variational GAIE could be trained on an input and a corresponding acceptable output, and could later receive the same input in order to output one or more variations of the acceptable output. In some embodiments, at least some or part of the data and/or content received and processed by a GAIE is different than data and/or content that was used to train the GAIE. In some such embodiments, the data and/or content received and processed by the GAIE is different than but similar to the data and/or content that was used to train the GAIE, such as new inputs that are exhibit a similar statistical distribution of features as the training data. In some such embodiments, the data and/or content received and processed by the GAIE is different than and dissimilar to the data and/or content that was used to train the GAIE, such as new inputs that exhibit a significantly different statistical distribution of features than the training data. In scenarios that involve dissimilar inputs, one or more first outputs of the GAIE in response to a new input may be compared to one or more second outputs of the GAIE in response to inputs of the training data set to determine whether the first outputs and the second outputs are consistent. The GAIE may request and/or receive additional training based on the new inputs and corresponding acceptable outputs. In scenarios that involve dissimilar inputs, the GAIE may present an alert and/or description that indicates how the new inputs and/or corresponding outputs differ from previously received inputs and/or corresponding outputs.

In example embodiments, the output of a GAIE may include one or more types of content. For example, a GAIE may generate, as output, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Output of the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be generated by the GAIE as various forms of data. For example, a natural-language expression generated as output by the GAIE could be encoded as one or more of: encoded text, an image of a writing, a sound recording of human speech, a video of an individual exhibiting sign language, an encoding according to a machine learning model embedding, or the like, or any combination thereof. In example embodiments, an output of the GAIE can include an internal state of the GAIE, such as a partial result of a partial processing of an input, or a set of weights and/or biases of the GAIE as a result of prior processing (e.g., an internal state of a recurrent neural network (RNN)).

In example embodiments, a language-based dialogue-enabled GAIE may be configured to produce (e.g., write) new machine learning models that may process various types of data to provide new and extended text input for processing by the GAIE. In example embodiments, humans may observe and interact with this ongoing dialogue between the two systems. In example embodiments, the dialogue is initiated by an expression of a conversation partner (e.g., a human or another device), and the GAIE generates one or more expressions that are responsive to the expression of the conversation partner. In example embodiments, the GAIE generates an expression to initiate the dialogue, and further responds to one or more expressions of the conversation partner in response to the initiating expression. In example embodiments, the ongoing dialogue occurs in a turn-taking manner, wherein each of the conversational partner and the GAIE generating an expression based on a previous expression of the other of the conversation partner and the GAIE. In example embodiments, the ongoing dialogue occurs extemporaneously, with each of the conversation partner and the GAIE generating expressions irrespective of a timing and/or sequential ordering of previous and/or concurrent expressions of the conversation partner and/or the GAIE

In example embodiments, the dialogue occurs between a GAIE and a plurality of conversation partners, such as two or more humans, two or more other GAIEs, or a combination of one or more humans and one or more other GAIEs. In some such example embodiments, the GAIE and each of the other conversation partners take turns generating expressions in response to prior expressions from the GAIE and the other conversation partners. In some such embodiments, one or more sub-conversations occur among one or more subsets of the GAIE and the plurality of conversation partners. Such sub-conversations may occur concurrently (e.g., the GAIE concurrently engages in a first conversation with a first conversation partner and a second conversation with a second conversation partner) and/or consecutively (e.g., the GAIE concurrently engages in a first conversation with a first conversation partner, followed by a second conversation with a second conversation partner). Such sub-conversations may involve the same or similar topics or expressions (e.g., the GAIE may present the same or similar conversation-initiating expression to each of a plurality of conversation partners, and may concurrently engage each of the plurality of conversation partners in a separate conversation on the same or similar topic). Such sub-conversations may involve different topics or expressions (e.g., the GAIE may present different conversation-initiating expressions to each of a plurality of conversation partners, and may concurrently engage each of the plurality of conversation partners in a separate conversation on different topics). In example embodiments, a first conversation among a first subset of the GAIE and conversation partners may be related to a second conversation among a second subset of the GAIE and conversation partners (e.g., the second subset may engage in a second conversation based on content of the first conversation among a first subgroup).

In example embodiments, one or more of the GAIE and the conversation partner may embody one or more roles. For example, the GAIE may generate expressions based on a role of a conversation starter, a conversation responder, a teacher, a student, a supervisor, a peer, a subordinate, a team member, an independent observer, a researcher, a particular character in a story, an advisor, a caregiver, a therapist, an ally or enabler of a conversation partner, or a competitor or opponent of a conversation partner (e.g., a “devil's advocate” that presents opposing and/or alternative viewpoints to a belief or argument of a conversation partner). In example embodiments, at least one of the one or more conversation partner embodies one or more aforementioned roles or other rules. In example embodiments, a role of a GAIE is relative to a role of a conversation partner (e.g., the GAIE may embody a superior, peer, or subordinate role with respect to a role of a conversation partner). In example embodiments, a role of a GAIE in a first conversation among a first subset of the GAIE and a plurality of conversation partners may be the same as or similar to a role of a GAIE in a second conversation among a first subset of the GAIE and the plurality of conversation partners. In example embodiments, a role of a GAIE in a first conversation among a first subset of the GAIE and a plurality of conversation partners may differ from a role of a GAIE in a second conversation among a first subset of the GAIE and the plurality of conversation partners (e.g., the GAIE may embody a role of a teacher in a first conversation and a role of a student in a second conversation). In example embodiments, a role of a GAIE in a conversation may change over time (e.g., the GAIE may first embody a role of a student in a conversation, and may later change to a role of a teacher in the same conversation). In example embodiments, a GAIE may embody two or more roles in a conversation (e.g., the GAIE may exhibit two personalities in a conversation that respectively represent one of two characters in a story). In example embodiments, a GAIE generates expressions between two or more roles in a conversation (e.g., the GAIE may generate a dialogue between each of two characters in a story). In example embodiments, a GAIE may engage in each of multiple conversations in a same or similar modality (e.g., engaging in multiple text-based conversations concurrently). In example embodiments, a GAIE may engage in each of multiple conversations in different modalities (e.g., engaging in a first conversation via text and a second conversation via voice).

In example embodiments, a GAIE participating in a conversation is associated with an avatar (e.g., a name, color, image, two- or three-dimensional model, voice, or the like). Expressions generated by the GAIE may be presented as if originating from the GAIE (e.g., in the voice associated with the GAIE, or in a speech bubble that is displayed near a visual position of a GAIE in a virtual or augmented-reality environment). In example embodiments, an avatar of a GAIE may be based on a role of the GAIE (e.g., a GAIE embodying a role of a teacher may be associated with an avatar depicting a teacher). In example embodiments, an avatar of a GAIE may be included in a real-world actor, such as a robot in a real-world environment such as a stage performance.

In example embodiments, a GAIE may include generative pretrained transformer elements that may be configured as a language model designed to understand various types of input and produce chat commands for a chat-type interface system. These commands may include software development tasks, API calls, and the like. In example embodiments, such a language model may include input functions that support receiving images, including video, to build textual output, functions, and additional questions that may be injected into the dialogue between the two systems in the dialogue embodiment described above. In example embodiments, this multimodal support may allow for contextual analysis of images and other media formats. In an example, users/customers may upload images or other media into a GAIE enabled platform. Based on aspects of a corresponding input prompt, a multi-modal GAIE may be configured for use in a valuation workflow to identify both macro and micro attributes and their correlated effects on valuation from a plurality of perspectives. In this example, photographs/images of an old car may be input along with a valuation-related prompt. In response, the GAIE may identify one or more typical values based on detected attributes of the car, such as the make/model, etc. The GAIE may further take into account finer details in the image to suggest potential value-altering metrics. In one example, a finer detail in the image such as damaged body panels may reduce the car value below a typical value. In another example, a finer detail in the image that shows a marking consistent with a limited production run may increase the valuation.

In example embodiments, a subject matter GAIE may be adapted to facilitate transaction forensics. As more transactions are carried out by AI, the need for humans to understand how and why specific transactions were initiated and carried out is likely to increase. For example, a transaction may be generated in response to a user request, such as “please send me a new circuit board for my broken refrigerator.” When the requested circuit board arrives configured with, for example, hostile government tracking devices, it may be beneficial for the AI system to reveal how the AI system conducted the transaction that procured the circuit board. It may also be beneficial for the AI system to participate in establishing AI system control actions and/or steps that may be taken to prevent future occurrences of unacceptable procurement.

For transactions that involve collateral and/or insurance coverage, a GAIE may be configured to assist in valuation of the collateral, defining and/or meeting insurance needs and the like.

A transaction subject matter pretrained GAIE may respond to a token acquisition-related prompt from an investor with a stated set of goals, a set of candidate opportunities for acquiring new tokens, a set of comparative advantages relative to other tokens, and a potential nexus between the strengths of a token and the goals of an investor. In example embodiments, a system having a portfolio analysis engine may discover an investment opportunity based on an investment goal of a user and may be combined with a conversation engine that generates a summary of the investment opportunity for presentation to the user, the summary including a reason that the investment opportunity promotes the investment goal of the user. In various embodiments, the summary may be based on one or more properties of the user, such as a user's financial condition, a user's demographic traits, a sophistication level of the user's understanding of the transaction, portfolio, market, and/or economy, and/or the user's history of previous transactions associated with the portfolio, market, and/or economy.

An adapted GAIE may facilitate the generation of synthetic data for and/or about transactions, such as from a disposable training model that may be scrapped after training. Synthetic data from the original source, now embedded in the trained GAIE, may be regenerated without personally identifying information and the like to overcome privacy concerns and facilitate data sharing and/or pooling among transaction entities (e.g., banks and third parties). In example embodiments, an area of focus for application of a GAIE may include operation with a transaction engine using GAIE-generated synthetic data derived from a training set of historical transaction data to transact between two or more entities. In example embodiments, data that is used to train the GAIE may be stored for future use. For example, training data may be subsequently examined to determine a reason for an output and/or behavior of the GAIE. For example, when a GAIE exhibits a bias or deficiency, the training data may be examined to determine a property in the training data that results in the bias or deficiency of the GAIE, and additional training data could be provided to continue training or to retrain the GAIE, wherein the additional training data supplements the property of the training data that results in the bias or deficiency of the GAIE.

In example embodiments, a transaction subject matter fine-tuned GAIE may provide rich improvements in capabilities, such as transaction subject matter related search, digital wallet search, and the like. In example embodiments, a generative AI conversational agent may be configured to search a set of digital wallets.

In example embodiments, a GAIE may be pre-trained to perform financial system management functions, such as “Smart Treasury Management,” in an Enterprise Access Layer (EAL) system. As an example, an EAL-pretrained GAIE may describe, project and/or determine likely yield generation across different accounts, independent of interactions impacting the yield being on and off-chain. A smart treasury management pre-trained GAIE may set parameters of risk taking and/or goals and partner learning systems through pretraining on transaction (e.g., treasury) data pools. In example embodiments, such a pre-trained GAIE may not be limited to treasury management; it may be applicable to operating on any asset that looks to generate yield with a set of parameters across systems. In example embodiments, such a GAIE may include and/or interface with a presentation layer capability (e.g., of data story engine and the like) to provide a user with asset management information in a concise manner across accounts. In example embodiments, such a GAIE may produce content, such as a data story, based on simulated information on different event-based outcomes aggregated across a multitude of accounts.

In example embodiments, an EAL-pretrained GAIE may be trained to create, configure, or manage enterprise data pools for use all throughout a transaction system of (or on behalf of) the enterprise. Other capabilities of an EAL-pretrained GAIE may include workflow development, transaction workflow configuration, workflow and task use, reuse and/or creation, fraud analysis, employee training at a range of levels up to an including an expert training level, transaction complexity reduction, and the like.

In example embodiments, such a GAIE may facilitate workflow orchestration for a process that uses a conversational, generative AI agent and another AI-supported process in an orchestrated sequence. In example embodiments, a GAIE may generate, perform, maintain, and/or supervise one or more workflows in a robotic process automation (RPA) environment. For example, a GAIE may be trained to monitor expressions and/or actions of an individual during interaction with other individuals, and may generate similar expressions and/or perform similar actions during similar interactions between the GAIE and other individuals. In some such scenarios, the GAIE passively observes the individual during the interactions with other individuals and self-trains to behave similarly to the individual in similar interactions with other individuals. In some such scenarios, the individual actively trains and/or teaches the GAIE to generate expressions and/or actions (e.g., by creating and/or performing example or pedagogical interactions the GAIE), and based on the training and/or teaching, the GAIE behaves similarly during subsequent interactions between the GAIE and other individuals. In example embodiments, the GAIE is trained and/or taught by an individual to perform a behavior while interacting with individuals, and subsequently performs the behavior while interacting with the same individual who provided the training and/or teaching.

In example embodiments, an enterprise access layer may have an intelligent agent that learns workflows performed by a set of users in a semi-supervised manner based on interactions of the users, wherein the intelligent agent performs at least one step in a learned workflow. In example embodiments, the intelligent agent automatically solicits feedback from one or more of the users to complete the workflow step and reinforce the training of the intelligent agent.

Application areas of an EAL-pretrained GAIE platform may include: data pools, intelligence system management, workflow development, expert training, fraud analysis, request refinement, governance; examples of these areas follow.

For a data pools application area, an EAL-pretrained GAIE may configure, curate, construct, and manage access to static or travelling data pools that facilitate use-case, customer, agent, or other EAL workflow needs. For an intelligence system management application area, the GAIE may enhance the intelligence system with a supervisory generative AI capability that decides how and when to apply various AI tools and modules. For a workflow development application area, a pretrained GAIE may identify, refine, and/or create various transaction (e.g., data or financial) workflows that may be modularized, re-used, and further refined based on data. For an expert training application area, a GAIE may interact with experts, approvers, etc. to build domain-specific capabilities that may be used to enhance workflows, governance, fraud detection, and the like. For a fraud analysis application area, the GAIE may interact with fraud experts, criminal records, people previously convicted of fraud, and the like to enhance detection capability. For a request refinement application area, the GAIE may refine any request or transaction to reduce computing and data transmission resources. For a governance application area, a pre-trained GAIE may facilitate determining when, where, and what in relation to governance requirements.

In example embodiments, a GAIE may be pre-trained for know-your-customer/know-your-transactor utilization. In example embodiments, such a pre-trained GAIE may generate a summary of customer profiles based on contextual analysis of information sourced, for example, from social media. Such a pre-trained GAIE may facilitate iterating between conversation and user behavior tracking/observation to determine how conversational parameters influence user behavior (group/cohort level). Also, it may facilitate iterating between conversation and user behavior tracking/observation to determine how conversational parameters influence user behavior, such as at an individual level.

From a perspective of smart contracts within and/or associated with transaction environments, a pre-trained GAIE may facilitate building out the terms of a smart contract based on interactive dialogue with a customer. Such a pre-trained GAIE may also generate, and optionally negotiate, intellectual property licensing terms. In example embodiments, a system for generating a smart contract may include a GAIE-based system configured to ingest and interpret contract-related terms (e.g., dictated by an individual) and to generate a corresponding smart contract configuration data structure, wrapper, and the like. A system that may flag non-standard smart contract terms/conditions may include a generative AI conversational agent configured to process contract terms and to flag non-standard aspects of smart contract terms and/or conditions. In example embodiments, a system based on a pretrained GAIE may develop sets of work scope definitions for smart contracts and/or connect work scope definitions to proprietary standards and data.

In an example, a pre-trained GAIE may include intelligent recursive use of AI assistants based on the outcome of an initial query (e.g., prompt) that may require use of proprietary or purchased standards and data access. Such AI assistants may embody one or more of a variety of roles, for example, a personal data assistant (PDA), a teacher, a student, a supervisor, a peer, a subordinate, a team member, a coach, an independent observer, a researcher, a particular character in a story, an advisor, a caregiver, a therapist, an ally or enabler of a conversation partner, or a competitor or opponent of a conversation partner. In this example, a GAIE may receive a prompt that requests the GAIE to provide a scope of work for a smart contract that includes chemical compatibility testing for a family of plastics used in flow batteries. The initial query may be adapted and/or regenerated (e.g., from the pre-trained GAIE and the like) as a prompt to identify appropriate plastic chemical compatibility testing standards that require access rights. In response to gaining access rights, the GAIE may develop a revised scope of work based on the regenerated query and write a smart contract to execute testing based on the revised scope of work.

In example embodiments, a pretrained GAIE system may have a smart contract analysis engine that determines one or more features of a smart contract that is under consideration by a user. The GAIE may further have a conversation engine that explains the features of the smart contract to the user, including summarizing contents of smart contracts.

In example embodiments, a GAIE may be pre-trained to perform prompt generation based on a data story or a plurality of sources across systems. Example generated prompts may include instructing and/or requesting the pre-trained GAIE to tell a story about a journey of a product, a business relationship, an event, a service provider, a smart container fleet, a robotic fleet, and the like.

In example embodiments, the GAIE may receive a plot or outcome of the story, and may generate content that is content with the plot or that produces the outcome. In example embodiments, the GAIE may generate a plot or outcome of the story, and may also generate content that is consistent with the GAIE-generated plot or outcome of the story. In example embodiments, the GAIE may receive a world or environment of a story, and may generate content that occurs within the given world or environment. In example embodiments, the GAIE may generate a world or environment of a story, and may also generate content that occurs within the GAIE-generated world or environment. In example embodiments, the GAIE may receive a character or event to be included in a story, and may generate content that includes the given character or event in the story. In example embodiments, the GAIE may generate a character or event to be included in a story, and may also generate content that includes the GAIE-generated character or event in the story. In example embodiments, the GAIE may generate a world, environment, character, event, or the like “from scratch” (e.g., based on randomized inputs). In example embodiments, the GAIE may generate a world, environment, character, event, or the like based on a given world, environment, character, event, or the like (e.g., a story that is based on a real-world public figure or event).

In example embodiments, the GAIE may receive a first story and may generate a second story that is related to the first story. For example, the GAIE may generate a second story that is an alternative retelling of the first story (e.g., a second story that includes a retelling of the first story from a perspective of a different character than a narrating character of the first story). The GAIE may generate a second story that occurs in a same or similar world or environment as the first story, or a different world or environment that is related to a world or environment of the first story. The GAIE may generate a second story that features a character or event of the first story, or a different character or event that is related to a character or event of the first story.

In example embodiments, the GAIE may generate a story from the perspective of a narrator or independent observer of the story (e.g., a third-person story). In example embodiments, the GAIE may generate a story from the perspective of a character or point of view within the story (e.g., a first-person story), including a character generated and/or embodied by the GAIE. In example embodiments, the GAIE may generate a story from the perspective of a listener or audience member to whom the story is presented (e.g., a second-person story). In example embodiments, the GAIE may generate a story from multiple perspectives, such as a first part of a story generated from a perspective of a first character, a second part of the story generated from a perspective of a second character, and a third part of a story generated from a perspective of a narrator. In example embodiments, the GAIE may generate a story involving a sequence of two or more events (e.g., a story that involves two or more events observed by a character). In example embodiments, the GAIE may generate a story involving an event that is portrayed from multiple perspectives (e.g., a story that describes an event from a perspective of a first character, and that also describes the same event from a perspective of a second character).

In example embodiments, a GAIE may generate a static story that remains the same upon retelling. In example embodiments, the GAIE may generate a dynamic story that changes upon retelling (e.g., adding more detail to a story upon each retelling). In example embodiments, a GAIE may change a story based on an input of a user (e.g., based on a choice of outcomes selected by one or more receivers of the story). In example embodiments, a GAIE may generate a story based on one or more inputs received from one or more receivers of the story (e.g., based on a prompt of a user, such as a request to create a story that includes a certain event specified by the user). In example embodiments, a GAIE may receive feedback from a receiver about a story (e.g., an expression of pleasure, displeasure, approval, disapproval, delight, dissatisfaction, confusion, or the like regarding a character, event, or property of the story), and the GAIE may update the story based on the feedback (e.g., adding, removing, or clarifying an event in the story, or switching a perspective of an event from a first character in the story to a second character in the story).

In example embodiments, a GAIE may be trained by loading data (such as structured and un-structured data that may be dominated by numerical or non-text values) to the GAIE. Examples of such training data may include one or more database schemas. Techniques for curation and integration of purpose-specific data, including curation of models as inputs to a GAIE may include curating domain-specific data, data and model discovery.

Candidate areas of innovation enabled by and/or associated with GAIE advances may include user behavior models (optionally with feedback and personalization), group clustering and similarity, personality typing, governance of inputs and process, explaining the basis of GAIE knowledge and proof points, genetic programming with feedback functions, intelligent agents, voice assistants and other user experiences, transactional agents (counterparty discovery and negotiation), agents that deal with other agents, opportunity miners, automated discovery of opportunities for agent generation and application, user interfaces that adapt to the user and context, hybrid content generation, collaboration units of humans and generative AI, purpose-specific data integration, a selected set of data sources, curation of data as models as input to generative AI, and the like.

In embodiments of a GAIE-enabled system, such as one for robotic process automation, the GAIE system may summarize a set of actions being subjected to robotic automation and describe context for the actions, such as, “I found these properties as fitting your criteria because of the following features. Which ones are most attractive?” In this way, a process automation system enabled with GAIE may solicit feedback for faster feedback-based training.

In example embodiments, emerging capabilities of GAIE technology may greatly improve upon earlier versions in terms of, for example, integration of domain-specific knowledge (e.g., math) with a chat interface. Further emerging capabilities may include being better informed about and for processing prompts of complex topics. Yet further, knowledge organization is becoming much improved as GAIE systems evolve. In example embodiments, updated GAIEs may correctly answer a prompt asking about today's date, whereas prior versions may answer that today's date (e.g., the current date) may be the date on which the GAIE was last trained.

In example embodiments, a context pretrained (e.g., subject matter focused) GAIE may provide better personalization than a base GAIE instance. In general, while a base GAIE, if explicitly informed of details of the user may attempt to personalize its responses, a subject matter focused or other pre-trained GAIE may be configured with and/or with access to structured information about users (e.g., determined based on user identification and/or prompt-based clues, and the like) to provide inherent, latent context for a dialogue that includes user personalized responses.

In example embodiments, a GAIE is configured to support interpretability and/or explainability of its outputs. In example embodiments, a GAIE provides, along with an output, a description of a basis of the output, such as an explanation of the reason for generating this particular output in response to an input. In example embodiments, a GAIE provides, along with an output, a description of an internal state of the GAIE that resulted in the output, such as a set of variational parameters of a variational encoder that were processed in combination with an input to produce an output, and/or an internal state of the GAIE due to a previous processing of the GAIE that resulted in the output (e.g., similar to a recurrent neural network (RNN)). In example embodiments, a GAIE provides, along with an output, an indication of one or more subsets of features of an input that are particularly associated with the output (e.g., in a GAIE that outputs a caption or summary of an image, the GAIE can also identify the particular portions or elements of the image that are associated with the caption or portions of the summary).

In example embodiments, an advanced GAIE, such as one pretrained for subject matter specific operation, may be trained for improved epistemology, to help determine evidence of the content that it represents as facts in responses that it provides. One example of improved epistemology may include citing sources of knowledge pertinent to facts in a response as a step toward proof of facts of a response-essentially a way of the GAIE “showing its work,” or at least where its work originates. In example embodiments, a GAIE generates output based on information received from one or more external sources (e.g., one or more messages in a message set, or one or more websites on the Internet), and the GAIE indicates one or more portions of the information that are associated with the output (e.g., one or more websites on the Internet that provided information that is included in the output of the GAIE).

An advanced GAIE as described and envisioned herein may maintain contextual awareness across chat (user-prompt/GAIE-response) interactions. Maintaining contextual awareness may help avoid the GAIE beginning each chat session from scratch, with no context as to prior chats with the same user. Maintaining contextual awareness may also enable picking up and resuming a conversation from earlier interactions between the GAIE and a user. Yet further maintaining contextual awareness and awareness of passage of time between interaction sessions may facilitate adapting responses to prompts in a later resumed chat session based on trained knowledge of the intervening passage of time and/or changing circumstances. In an example, a GAIE may determine that a deadline described in an earlier chat has expired, a consequential intervening event has occurred (your home-town team lost the big game), and the like. Further, contextual awareness across time-separate chat sessions may be highly valuable when being employed for projects that may have real-world physical constraints on time (e.g., smart contract negotiation may involve human evaluation, discussion, and decision making that may take time based, for example on other priorities seeking involvement of the human). This may determine the difference between treating each conversation as individual/compartmentalized/isolated, and treating ongoing, time-separated conversations as resumable, optionally as if (almost) no time had passed. In example embodiments, a GAIE may be configured with a contextualization module that maintains some notion of conversation sessions and interconnections that may be referred (e.g., a conversation from yesterday) for details and continuity. This contextualization may further enable avoiding repeating responses, making it more efficient to reference a previous conversation. Yet further, a contextualization module may provide context to the GAIE of other conversations between the user and the system, between other users and the system, and the like.

In such a contextually maintained instance, a context-enabled GAIE may provide a response regarding forecasted weather that references an earlier period of time. In an example, a context-enabled GAIE may provide a weather-related response such as, “On Monday, we discussed the weather, you asked if you would need an umbrella on Wednesday, and I answered ‘probably not’ based on the forecast at that time. I need to inform you that the updated weather forecast indicates that rain may be more likely on Wednesday, so you probably may need an umbrella.”

Other capabilities of emerging GAIE systems may include adapting a GAIE to the generation and operation of digital avatars. In example embodiments, digital avatars may be programmed with their own visual representations. To accomplish greater similarity between an avatar and its owner based on visual and audio interpretation of users, a GAIE training and/or pre-training data set may require information about body language and nonverbal cues, such as gaze, posture, speech pitch and volume, and the like.

Emerging GAIE systems may include determining and adapting responses with variations and nuances based on, for example, user activities. A user's physical disposition may influence content production by a GAIE (e.g., presenting different cues) based on if the user is sitting, walking, driving, exercising, and the like. Further, a GAIE system may adapt responses to prompts based on variations and nuances of real-life interactions versus voice interfaces versus virtual reality. Other aspects that may impact GAIE responding to prompts may include variations and nuances of different cultures, demographics, and the like. Yet further, in example embodiments, methods and systems for advanced GAIE training and operation may include recognition of higher-level communication features of users (humor, sarcasm, dishonesty, double entendre, etc.) and user emotional state, for example.

In example embodiments, methods and systems for enhancing GAIE platforms, such as those described herein, may include configuring a GAIE to participate in multi-user dialogue, where strict turn-taking interaction with one person might be difficult in a group setting, where the context of who may be speaking to whom matters for each expression. The more fluid multi-user conversational structure vs. turn-taking structure may indicate advances to a GAIE may include developing understanding of: social interactions and cues, such as to whom each expression may be directed; group dynamics (e.g., who may be the group leader?) and interpersonal relationships; the notion of threaded discussions with branches; concurrent discussions between various sub-groups of a group; when to chime in with input so as to avoid interrupting other users; some notion about conversational balance, to avoid dominating the conversation; tact; users' sensitivity about personal information, and when it may and cannot be shared in a group setting based on context, relationships with other users, and the like.

Independent of whether interactions are one-on-one or multi-user, it is envisioned that a GAIE may be adapted to evolve beyond a turn-taking paradigm. In an example, a GAIE may currently create media (images, music, video, and the like) based on a user prompt (that itself may be one or more types of media), and may refine the created media based on user interactions, such as changing the content in certain ways or extending the boundaries of an image with more content that may be consistent with the existing content (e.g., outpainting). A more sophisticated version of generative AI may flexibly and continuously adapt its generated content to contextual user input and interactions. In an example, generating media may be adapted by the GAIE in response user integration with the generated media content, such as in response to allowing a user to virtually walk around inside the content to interact with and/or react to content items. Such a media-adapting GAIE may generate new content or update the content based on the user input/content virtual interactions. Yet further to facilitate a user to virtually interact immersively with generated content details about the user may be considered part of the criteria for newly generating and/or updating the media.

In example embodiments, a media-output enabled GAIE without user immersive interaction and feedback may generate media (e.g., a first image) based on a prompt in which a user specifies a theme for a story. The user may then specify a series of scenes that follow, and the GAIE generates an image for each scene, leading to a story board series for the story.

When a media-out enabled GAIE is teamed with user immersive capabilities, the user may control, for example, an avatar that may walk around within the scene and interact with generated media objects. Based, for example, on an order and manner with which the user traverses the scene and interacts with the objects, the generative algorithm may generate new content (e.g., the user looks at a particular painting on the wall of a gallery and then opens the curtains of a window). Outside the window may be an entire world that may be consistent with the particular painting that the user viewed. If the user chooses to move the avatar into that world, the painting on the wall updates to reflect the user's interactions.

In another example of immersive user-generated media content engagement, a user may request a science fiction story. In addition to generating a story based on tropes that are generally relevant to science fiction, the GAIE may include tropes that are likely familiar to the user, such as based on the user's age, culture, other interests, etc. (such as science fiction versions of characters that are well-known in the oeuvre of myth and literature to which the user belongs). In some cases, the algorithm may even include individuals in the created story that are analogous to celebrities or public figures in the user's culture or generation, or even the user's own friends and acquaintances.

In example embodiments, a GAIE may be pretrained for market orchestration including configuring a new marketplace, discovery of counterparties, ecosystem-based transactions, aggregation of demand and/or supply, negotiation of contract terms, configuring a smart contract, brokering deals, generating simulations for an exchange digital twin, personalizing financial/trading advice, and the like.

In an example of a GAIE adapted for market orchestration responses, a generative AI interactive agent may enable the configuration of a new marketplace. In another example of a GAIE adapted for market orchestration responses, a generative AI interactive agent may be configured for the discovery of counterparties, assets, and/or marketplaces.

In an example of a GAIE adapted for market orchestration responses, a generative AI interactive agent may be configured to present ecosystem-based transactions. In an example of a GAIE adapted for market orchestration responses, a generative AI interactive agent may be configured to aggregate demand and/or supply. In an example of a GAIE adapted for market orchestration responses, a GAIE may be configured to negotiate contract terms. In an example of a GAIE adapted for market orchestration responses, a GAIE may enable the configuration of a smart contract. In an example of a GAIE adapted for market orchestration responses, a generative AI interactive agent and the like may be configured to broker deals. In an example of a GAIE adapted for market orchestration responses, a generative AI interactive agent may be configured to generate simulations for an exchange digital twin. In an example of a GAIE adapted for market orchestration responses, a generative AI interactive agent may be configured to generate personalized financial and/or trading advice.

In an example of a GAIE adapted for a gaming environment, a generative AI interactive agent that may be configured to generate a gaming environment and/or experience (e.g., such as by using a gaming engine). In an example a GAIE adapted for a gaming environment may be configured to generate a personalized gaming environment and/or experience. In an example, a GAIE adapted for a gaming environment may generate NPC text/conversation so that a gaming environment having a non-player character text generator may use AI/machine learning to interactively pass relevant game objective advancing data to a human player of the game. In example embodiments, a GAIE adapted for a gaming environment may include an interactive agent that navigates a customer journey using a gaming engine and contextual, generative interactive AI based on comparison of a dialogue with a script for the customer journey. In embodiments, a GAIE may be integrated with a gaming engine.

In example embodiments, a superintelligence system may be based on a pre-trained GAIE that facilitates automated discovery of relevant domain-specific knowledge and examples. The superintelligence system may further leverage pre-trained advanced GAIE to leverage domain-specific examples to generate content. Yet further the superintelligence system may include a genetic programming capability to create novel variation. In example embodiments, a superintelligence system may further include feedback systems (e.g., collaborative filtering and automated outcome tracking) to prune variation to favorable outcomes (financial, personalization, group targeting, and the like).

In example embodiments, a GAIE may be pre-trained for use by and/or in cooperative operation with a digital twin engine, such as an instance of an executive digital twin and the like. In an exemplary deployment, a GAIE may interact with a digital twin to provide a narrative about a topic of the digital twin to give to a viewer. In this example, the digital twin may interact with the GAIE (e.g., through an API and the like) to generate a narrative summary for a CEO and a detailed narrative for a CFO.

Executive digital twins may be configured for a particular role or user. Therefore, a GAIE system with a digital twin interface may improve executive digital twin capabilities by curating the data for and populating content for consumption by executive digital twins for different roles. In an example a GAIE may receive information about the executive digital twin as well as about the intended human being represented by the executive digital twin (e.g., the role of the user). The GAIE may determine a degree of narrative detail for each executive digital twin. This may be based on generic executive digital twin/user role criteria and/or refined through interaction with a particular user for the executive digital twin. In example embodiments, a CEO with a tech focus may receive more “in-depth” narrative relating to tech or R&D, whereas a CEO with a financial background may end up receiving narratives that are more focused on financial analysis but less granular on tech-related features.

In example embodiments, a GAIE system that interacts with a digital twin engine (e.g., an executive digital twin instance and/or engine) may determine of the potential universe of content on which it is trained, what may be relevant and what may be noise or unrelated for the specific narrative topic, the target human consumer, and the like. Based on this relevance determination, the GAIE system may generate the output data based on the relevant data and the determined degree of detail.

Further, the GAIE system may also select real time data sources to connect to a target/requesting executive digital twin. The GAIE may further configure consumption pipelines for those sources on the spot (e.g., data source identification, data requests for identified data sources, API configuration, and the like). Therefore, in this example the GAIE system would be identifying data sources and connecting them to an executive digital twin instance/engine.

An example use case may include an executive digital twin that has access to full financial data from a previous time-frame (e.g., a previous year/quarter/month, and the like). The executive digital twin may enable access by the GAIE to all of this data. The GAIE may determine a degree of detail of the data for the intended viewer (e.g., target consumer of a narrative regarding a topic captured in the full financial data).

In the case of a target consumer/view having a role of CEO, the GAIE may determine that the narrative for the CEO will include key insights but not full details. The GAIE may then generate a narrative of the top insights for a target time-frame (e.g., a current quarter) from at least the received data.

A pre-trained GAIE may be used to generate, manage, and/or manipulate digital twins, such as by describing attributes of a digital twin, describing interactions with other digital twins or environments, describing simulations, using digital twin simulation data to generate content, enabling context-adaptive executive digital twins, facilitating development of narratives about ongoing, real time operations, tuned to the preferred conversation style of a user represented by a digital twin, and the like. In example embodiments, a context-adaptive executive digital twin integrated with a generative conversational AI system may be configured to generate a set of narratives about operations of an enterprise based on an input data set of real-time sensor data from the operations of the enterprise. The digital twin (or human user) may prompt the GAIE and/or conversational AI system to compare financials with real-time sensor data.

A GAIE may be adapted (e.g., pre-trained) to facilitate enhancement of AI training data associated with a digital twin application. In example embodiments, a method may include using an AI conversational agent to create synthetic training data.

Further in association with digital twin technology, a GAIE may be adapted for summarizing highly granular data for consumption by an executive digital twin. In this regard, an executive digital twin system may include an intelligent agent that receives a set of customization features from a user (e.g., an executive represented by the digital twin) that include a role of the user within an organization. The intelligent agent may also determine a respective granularity level of a report based on the customization features. In example embodiments, the set of customization features include granularity designations for different types of reports. Yet further, the intelligent agent determines the granularity level of a report based on the role of the user within an organization. Further, the subject matter of the report may be generated based on the role of the user within the organization.

In example embodiments, a speech-based user interface for customizing a level of specificity for generating executive digital twin reports may be operatively coupled to a customized GAIE that processes the speech into a set of report instructions (and optionally report content) based on aspects of the user(s). An example of a speech-based request that may be processed as described may include, “I'd like an executive-summary level report on predictive maintenance” or “I'd like a detailed report on competitor analysis.” The speech-based user interface may respond to such a request by directing a corresponding executive digital twin system to feed a specificity level for parameters to a generative AI engine (e.g., GAIE) as additional input along with the data. In this example, IoT data from manufacturing facilities may be used in predictive maintenance. A response to a prompt regarding preventive maintenance may be customized with a level of specificity based on target report consumer role(s), such as for an operations-based role. A level of specificity may include what are the costs, when is the maintenance needed by, what may be the predicted downtime, how to offset and/or time the maintenance activity, and the like. For a financial-based role, specificity levels may be adapted to address what may be the disruption going to do for the bottom line in the short term; how does this impact our supply; what may the disruption do to our market-share; will it impact our stock price, and the like.

When a digital twin may be used to model an individual, a fine-tuned GAIE may be used to coordinate the digital twin with the human for improved fidelity (e.g., when the human behaves or reacts differently than the digital twin predicts, a GAIE may initiate a dialogue with the user to determine why, and the results may be used to update the digital twin model for the individual). Instead of having a human expert occasionally participate in automated digital twin model training (e.g., to correct errors or provide new examples, and the like), a corresponding GAIE may be occasionally querying the user to solicit more information to update the digital twin model of the individual. As an example, a system may include a digital twin that models an individual, and may further include a conversation engine that facilitates determining an update of the digital twin based on a conversation with the individual that is associated with a difference between an action of the individual and a corresponding action prediction by the digital twin.

In example embodiments, a GAIE system may be configured for use in an automated manufacturing environment. In one example, a user may prepare a descriptive prompt of a desired product to have it 3D printed. The GAIE system may generate a 3D printing set of instructions, such as a configuration of an automated 3D printing machine and a rendering indicative of a result of the 3D printing machine following the instructions. In another example, a user may include a photo/video of product as a prompt along with a request for instructions to 3D print an improved version, such as “I want this bike but I want different tires and I want it to be red.”

Another exemplary use of a pre-trained GAIE may include using user behavioral data to generate guiding recommendations for energy conservation, usage shifting, and the like. In particular, a recommendation system for energy conservation, usage shifting, or optimization may include an integrated generative, conversational AI system that adapts generated output based on user behavior from a user behavior data set.

In example embodiments, an adapted GAIE may facilitate management of energy resources. An energy resource management system may be enhanced to provide advanced intelligence (e.g., superintelligence) to plan, manage, and/or govern DERs and energy generation, storage, consumption, and transmission facilities. Elements of a superintelligent energy management system may include automated discovery of relevant domain-specific knowledge and examples, generative AI to leverage domain-specific examples to generate content, genetic programming to create novel variation, feedback systems (e.g., collaborative filtering and automated outcome tracking) to prune variation to favorable outcomes (financial, personalization, group targeting, etc., etc.), and the like. In an example, a superintelligent AI-enabled management system may be configured to manage a plurality of systems of an energy edge platform via automated discovery, generative AI, genetic programming, and feedback systems.

In example embodiments, a GAIE may be adapted (e.g., trained, pre-trained, and the like) for the field of patents to generate patent claims responsive to being provided a patent disclosure. An enabled GAIE may receive patent claims as a prompt and may generate a supportive patent disclosure therefrom. In example embodiments, an enabled GAIE may be trained to understand a patent structure and a claim structure for a plurality of jurisdictions.

In example embodiments, a GAIE may be pretrained (e.g., finetuned) with a private instance of an enterprise's intellectual property data (e.g., products, business goals, competitive considerations, core inventive ideas, and the like). In example embodiments, a private instance of enterprise data for patent generation may be configured (e.g., as prompt-response pairs) for finetuning the GAIE instance.

Beyond patent disclosure and figure preparation, a GAIE may be fine-tuned to generate figures, disclosure from figures, claims from figures, office action responses, evidence of use (EOU) for patent monetizing, preparing a matrix of patent claims across a portfolio, high level landscape search strings, enhancement of search strings, and the like. Finetuning may include preparation of prompt-response sets for a range of IP-related actions, such as patent claim assertion, infringement analysis and discovery, claim (term) acceptance and/or rejection, estimate of claim scope broadness, claim quality, and the like. In example embodiments, an IP-tuned GAIE may be pre-trained with information from proceedings related to infringement cases to understand the likelihood of infringement, and the like.

GAIE training and IP-integration may facilitate elaboration of broadly stated inventive concepts into disclosure that reflects robust enablement and/or support. In an example, an outline may be an input prompt for the purposes of drafting a patent application (e.g., disclosure, figures, summary, abstract, and optionally claims). A generated result may become a portion of a subsequent prompt along with a description of the general theme, category, focus area and/or other categorization or classification of innovation. In an example, one may describe a transaction environment processing platform and ask for examples of a technical implementation, system, and/or method design, such as: “In the context of a transaction environment processing platform as previously described, what types of hardware and software might be used to implement a governance engine for the transaction environment?”

Regarding an intellectual property (e.g., patent) monetization-focused development process, a GAIE may facilitate predicting, from a market development view, which domains to select and which categories within domains to emphasize based on the ability to determine where business may be shifting over a longer time (e.g., beyond short-term trends). This may include analyzing historical data and current data for one or more IP domains, optionally in near-real time. An IP-monetization-focused GAIE may tie historical and/or current data to investments and actions having occurred in the IP world for, among other things, patent sales and licensing. An IP-monetizing trained GAIE may also develop particular leads and domain categories with the highest probability of success based on previous sales and/or licensing and/or where the market may be heading. There may be risk in making these decisions but using a trained GAIE may lower this risk so that these decisions become more predictable in the future, especially with company data increasing and likely accessible through various channels.

A GAIE may be configured, trained, and/or fine-tuned for a range of functions, including, for example, ingestion of proprietary data, determination of a route, determination of an outcome, approval of release/access to data, making a prediction, pattern recognition, and the like. Yet another example application of a fine-tuned GAIE may include layering of voice and visual commands that may be graduated in sound, volume, or spacing similar to flight avionics, thereby generating scripts for voice over of data and/or presentation material. This may enable the development of synthetic speech technology that generates lifelike (AI-generated) voices for podcasts, slideshows, and professional presentations. This may mitigate needs for hiring a voice artist or using any complex recording equipment (e.g., background noise separation, dubbing, and the like).

In example embodiments, GAIE systems may be configured for facilitating news delivery from NPC-type avatars to adapt current “clickbait” content to conversationally conveyed world news/happenings. In this example, a metaverse environment may include a news-based GAIE conversation agent configured to conversationally inform users of recent events.

Further in context of metaverse technology, a generative AI conversational agent may be configured to populate the metaverse.

Yet further within a context of metaverse technology, a GAIE system may be enabled to augment training data for a customized conversational agent with real-time sensor data sets through collecting information from real-world sensors. In an example, a training data augmentation system may be configured for augmenting training of a conversational agent with data from a real-time sensor data set. Further, a metaverse-associated GAIE system may facilitate augmenting training data for a customized conversational agent with process outcome data. A training data augmentation system may be configured for augmenting training of a conversational agent with process outcome data from a process outcome data set, user behavior data, and the like. In example embodiments, a training data augmentation system based on a GAIE may be enabled (e.g., pre-trained) for augmenting training of a conversational agent with user behavior data from a user behavior data set.

In example embodiments, application of fine-tuned GAIE systems in the field of governance may facilitate advances in automation of governance, such as governing use of copyrighted material. GAIE-based governance systems may further enhance governing AI training, such as conversational AI training data sets for bias and error, governing conversational AI for contextual appropriateness and other stylistic requirements, and the like. A fine-tuned GAIE system may further improve governing secrecy, such as a progression of what elements of secret, proprietary or confidential information are allowed based on a depth of conversation. Governance may further apply to individuals. Therefore, a governance fine-tuned GAIE system may enhance and/or automate determining a measure of trustworthiness of a user that may be interacting with a generative conversational AI system. Further a governance fine-tuned GAIE system may enrich governance for a generative AI system, such as determining a measure of trustworthiness of a generative conversational AI system. In general, governance use cases may be expanded further in light of GAIE topic-targeting training capabilities.

A fine-tuned GAIE system may play a role in systematic risk identification, management, and opportunity mining. GAIE-based risk identification systems may respond to risk-related prompts, such as “What may else might we know and should be paying attention to?” by curating data sets and automating the processes of identification of systemic risks, identifying a set of likely scenarios and the risks and opportunities arising from those scenarios, identifying paths for resolution and recommending resolutions.

In a real-world example, a GAIE-based risk identification system may have responded to the above prompt with findings for market players and regulators that some U.S. banks were sitting on a combined $600B+ in unrealized Treasury losses. Further such a system may have responded with specificity about any such bank that was a major outlier due at least in part to its size and concentrations that posed a significant systemic risk. Such a system may be configured to inform system-wide warnings so that the worst outcomes may be avoided across the risk pool, not just for outliers. In example embodiments, a risk-enabled GAIE system that may identify hidden and/or not well known risks may be applied to other domains than financial. However, even within a financial domain such a fine-tuned GAIE may facilitate surfacing, with sufficient context, these hidden and/or not-well know risks along with options for resolving these out-sized risks.

Yet another area of risk identification and/or management may involve security concerns with GAIE systems that are configured to generate computer executable code. At the least relying on computers to write computer code raises questions about what security measures are effective and what measures are able to be circumvented by the AI.

A further area of risk identification, management and/or opportunity harvesting may apply to copyright material. Automated computer code generation may inadvertently introduce copyrighted material, such as algorithms. A risk-finetuned copyright GAIE may assist in detecting candidate copyright violations in any programmatic code, including machine generated code.

Risk identification of visual training sets (e.g., images, graphs, and the like) may be enhanced by a fine-tuned GAIE that can process these visual training data sets for authenticity indicators that are coded as non-visual data. This may be similar to tail voltage devices providing messages on the end of sine waves. Visual training sets may be coded with non-visual indicators of authenticity that may be detectable by a fine-tuned GAIE.

Yet another risk-identification related area includes fraud detection. Integrating customer fraud reporting and questioning into pretraining data may enrich holistic scoring, which may comprise a composite score that bridges customer evidence, transactions, and environmental trends. In an example, an AI based fraud detection system may integrate customer fraud reports and questioning into a training/query data set to produce a holistic scoring system, utilizing a composite score that combines customer evidence, transaction data, and environmental trends to provide a comprehensive approach to fraud detection.

Imaging applications may benefit from fine-tuned GAIE systems. In example embodiments, optical content (e.g., screen shots and the like) may be processed by machine vision systems so that the GAIE may describe a scene in the optical content using a generative conversational AI agent. In example embodiments, a GAIE may be configured as a first AI/NN sub-system in a Dual Process Artificial Neural Network (DPANN) architecture. Such a DPANN architecture may include, as a second NN sub-system, a formal logic-based and/or fuzzy-based system. Together these DPANN systems may implement learning processes, model management, and the like. In example embodiments, a DPANN architecture may include features that describe building and managing large scale models.

Referring to FIG. 8, a platform 800 for the application of generative AI may include a robust task-agnostic next-token prediction AI engine 802 that operates to predict a next token given a set of inputs encoded as embedded tokens. A robust task-agnostic next-token prediction AI engine 802 may include deep learning models, which use multi-layered neural networks to process, analyze, and make predictions with complex data, such as language. An objective of the robust next-token prediction AI engine 802 may include data science modeling through, among other things, use of topic-specific embeddings, attention mechanisms, and decoder-only transformer models. Capabilities of such an engine 802 may include a pre-training capability to facilitate configuring next-token prediction for specific subject matter (e.g., marketplace item valuation), a tokenizing capability to facilitate converting complex terms into actionable tokens (e.g., converting compound chemical names into fundamental elements), access to distributed training (e.g., data-parallel training and/or model-parallel training, and the like), few-shot learning to reduce training demand for updates, such as new business intelligence data, and the like. In general the next-token prediction AI engine 802 may combine large language modeling techniques and decoder-only transformer models to generate powerful foundation models for next-token prediction AI content generation.

In example embodiments, the next-token prediction AI engine 802 may be structured with an machine learning (sparse Multi-Layer Perceptron) architecture configured to sparsely activate conditional computation using, for example mixture-of-experts (MoE) techniques. A machine learning architecture may be configured with expert modules that may be used to process inputs and a gating function that may facilitate assigning expert modules to process portion(s) of input tokens. A machine learning architecture may further include a combination of deterministic routing of input tokens to expert modules and learned routing that uses a portion of input tokens to predict the expert modules for a set of input tokens.

A GAIE may be trained to operate within a domain, such as written language, computer programming language, subject matter-specific domains (e.g., a software orchestrated marketplace domain), and the like to generate content (constructs) that comply with rules of the domain. In general, a GAIE may generate content for any topic for which the GAIE is trained. So, for example, a GAIE may be trained on a topic of pig farmers and may therefore generate language-based descriptions, images, contracts, breeding guidance, textual output, and the like for any of a potentially wide range of pig farmer sub-topics.

Adapting a generative AI engine for subject matter-specific applications may include pretraining a next-token prediction AI model-based system through the use of, for example, in-context (e.g., application, domain, topic-specific) examples that are responsive to a corresponding prompt. While the next-token predictive capabilities of the underlying next-token prediction AI engine may remain unaffected by this pre-training, subject matter-specific pre-trained instances may be developed/deployed.

In example embodiments, a platform 800 for the application of generative AI may include a set of subject matter-specific pretrained examples and prompts 804. This set of examples and prompts 804 may be configured by analyzing (e.g., by a human expert and/or computer-based expert and/or digital twin) information that characterizes various aspects of the domain to generate example prompts and preferred and/or correct responses. Pretraining may also include training the next-token prediction AI engine 802 by sampling some text (e.g., prompt/response sets) from the set of subject matter-specific pretrained examples and prompts 804 and training it to predict a next word, object, and/or term. Pretraining may also include sampling some images, contracts, architectures, and the like to predict a next token. These prompt-response sub-sets may facilitate pre-training the prediction AI engine 802 for predicting a next token (e.g., word, object, image element, and the like) for various aspects.

When an instance is implemented for textual generation, such a GAIE instance may be referred to as a natural language generation system that constructs words (e.g., from sub-word tokens), sentences, and paragraphs for a target subject and/or domain.

In example embodiments, real-world instances of the platform 800 may require ongoing updates to facilitate the platform 800 being responsive as aspects of a domain (e.g., a business entity in the domain) change, such as business goals change, new products are released, competitors merge, new markets emerge, and the like. In this regard, training the platform 800 with in-context prompts and examples may be automated and repeated as new data is released for an enterprise to prevent snapshot-in-time data aging-based errors. The platform 800 for the application of generative AI may include an ongoing pre-training module 828 that processes new and updated content into prompt and/or response sets and interactively iterates through rounds of pre-training. New and updated data and/or information may regularly be found in various subject matter specific information sets, such as: a dataset of medical records (e.g., to assist with medical diagnoses), a dataset of legal documents and court decisions (e.g., to provide legal advice), a release of a new product (e.g., images of the product), or a financial dataset such as SEC filings or analyst reports. In example embodiments, uses of the platform 800 may include applying the pre-training and optimizing techniques to a range of different domains (e.g., medical diagnosis, business operation, marketplace operation, and the like) to produce a fine-tuned domain specific token-predictive engine including ongoing refinement through (daily) in-context pretraining.

In example embodiments, an ongoing pre-training module 828 may work with the next-token prediction AI engine 802 to update a set of subject matter specific tokens that may be maintained in a subject matter specific instance token storage facility 808. This subject matter specific instance token storage facility 808 may be referenced by a subject matter specific instance of the next-token prediction AI engine 802 during an operational mode (e.g., when processing inputs/prompts). In example embodiments, the platform 800 may include a plurality of sets of subject matter specific tokens that may be maintained by corresponding ongoing pre-training modules 828.

Training, however, may not ensure that the responses to prompts are correct every time. In general, a business entity is likely to be less interested in a tool that provides answers that are probably right and may differ from time to time. A product that can provide accurate responses (e.g., including taking actions) based on what the end-user wants vastly increases the potential use cases and product value. A high level of accuracy and integration with operational systems may enable such a tool to go beyond just generating new content to be more productive; through integration with workflows, it may facilitate automating workflow actions. In this regard, the platform 800 for the application of generative AI may also include a pre-training optimizing engine 806 that may work cooperatively with the ongoing pre-training module 828 to further refine accuracy of responses to prompts for a domain. The pre-training optimizing engine 806 may facilitate improved accuracy of in-context responses, task-specific fine-tuning, and for sparse model variants of the platform 800, enrich few-shot learning capabilities. In example embodiments, fine tuning may further benefit the platform by reducing bias that may be present in the training data. This may be essential to ensure subject matter specific jargon is adapted as training data changes (e.g., in the digital marketing/promotional space, ensure that “influencer” is replaced with “creator”). Further, a pre-training optimizing engine 806 may provide a wider range of prompts and responses based on user preferences (e.g., speaking styles) to enrich the platform's ability to provide user-centric responses. In example embodiments, user-centric responses may include fine tuning the platform 800 for different roles in an organization. As an example, when a user in a financial planning role inquiries about a business development topic, responses may be directed toward the financial planning role (e.g., as compared to a customer/client inquiry about that topic).

A platform 800 for the application of generative AI may be used to produce text-based content for a multi-national entity with employees who speak different languages. While the platform 800 may be trained (and pre-trained) to operate interactively in a plurality of languages, generating automated content may benefit from use of a neural machine translation module 810. In example embodiments, a portion of the entity in a first jurisdiction may produce content in a first language and resulting recurring generated output (e.g., types of reports and the like) may be generated in the first language. However, employees who speak a second language may benefit from the type of report when translated into the employee's native language. Therefore, associating the neural machine translation module 810 with the platform may prove valuable while reducing compute demand for the platform 800.

Emerging next-token prediction AI systems feature increasingly adaptable next token prediction capabilities. These capabilities may be further adapted to assist in closed problem set solution prediction, such as allocation of resources, deployment of a robotic fleet and the like. To achieve greater prediction capabilities, a subject matter specific next-token prediction AI-based engine, such as the platform 800 for the application of generative AI, may include a solution-predictive engine 812 that leverages next-token (e.g., next word) predictive capabilities to predict a most-likely solution to a closed solution-set problem. This may be accomplished optionally through use of sets of problem domain-specific pre-training prompts and examples. Such examples may be adapted for different user preferences. In example embodiments, each user in a closed problem set environment may generate prompts and responses that may enable the platform 800 to respond to the user based on the user's inquiry style. Alternatively, the solution prediction engine 812 may adapt a user's prompt and/or configure a prompt based on user preferences to attempt to deliver responses that are consistent with a user's preferences (e.g., engineering-based responses for an engineer role-user and legal-based responses for a lawyer).

For more complex analysis and decision making/predicting, a formal logic-based AI system 814 may be incorporated into and/or be referenced by the subject matter specific platform 800.

Further, the basic concepts of next-token prediction of a generative AI engine, such as the platform 800 for subject matter based application of generative AI may be applied to analyzed expressions of images, audio (e.g., encoded text), video (e.g., sequences of related images), programmatic code (domain-specific text with readily understood rules), and the like. Therefore, a next-token prediction AI platform (e.g., platform 800) may further include an image/video analysis engine 816 (optionally NN-based) that adds a spatial aspect to the next-token predictive capabilities of a next-token prediction AI system. Images used for training may include 3D CAD images (for a domain that includes physical devices such as vehicles), radiologic images (for a medical analysis domain), business performance graphs, schematics, and the like. In example embodiments, aspects of the underlying task-agnostic next-token prediction AI engine 802 may be adapted (e.g., different embeddings, neural network structures and the like) for different input formats, such as images, temporal-spatial content, and the like.

The platform 800 may further include an expert review and approval portal 818 through which an expert (e.g., human/digital twin, and the like) can review, edit, and approve content generated. Examples include review and adaptation by a subject matter specific data story expert; a data scientist, and the like. The expert review and approval portal 818 may operate cooperatively with, for example, the pre-training optimizing engine 806 that may receive and analyze expert feedback (e.g., edits to the content and the like) for opportunities to further optimize the platform 800.

The platform 800 may further include a training data generation facility 820 that may generate natural language prompts, such as subject matter specific prompts that may be applied by, for example, the pre-training optimizing engine 806 to increase platform response accuracy and/or efficiency while fine tuning a subject matter specific instance.

In example embodiments, the platform 800 may further be configured to access a corpus of domain and/or problem relevant content as a step in responding to a prompt. In example embodiments, the platform may be pre-trained on the content of the corpus. While the content of the corpus may not be directly included in the response, such as if it provides a level of detail beyond what the platform 800 has been trained to provide in a response, it may be cited in the response to facilitate identifying and expressing sources from which a response is derived. These external source references may be handled via a citation module 822.

Business decisions are often context-based. Understanding both the context for a decision and aspects and/or assumptions of the decision process may prove highly valuable for evaluating, for example, competing decisions and/or recommendations. Context may include both tangible and intangible factors. An intangible factor may include historical interactions between parties involved in the evaluation process, for example. A decision process may include not only assumptions on which a decision or recommendation is based, but also criteria by which tangible factors are processed, evaluated, analyzed, and the like. To provide such context for generated output of the platform 800, an interpretability engine 824 may be incorporated into and/or be accessible to the platform 800. An objective of use of the interpretability engine 824 may be to generate additional content that reflects context for, among other things, how the next-token prediction AI instance operates and/or generates a corresponding output.

In example embodiments, the next-token predictive capabilities of a next-token prediction AI engine 802 may be utilized for developing a set of emergent data science predictive and/or interpretive skills. While such a platform may be trained directly on various data sets, context for elements and results in such data sets may be a rich source of complementary training data. By associating data elements with descriptions thereof, the platform 800 may gain data science capabilities, such as to group by or pivot categorical sums, infer feature importance, derive correlations, predict unseen test cases, and the like. In this regard, a data science emergent skill development system 826 may be utilized by the platform to enhance further subject matter specific applicability and utility.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

Enterprise Access layer

### Introduction

One environment that can utilize the functionality of an access layer is an enterprise. An enterprise generally refers to an organization with a particular overarching purpose, goal, or objective. For instance, a purpose may be to produce and market a particular set of one or more product lines, to undertake a charitable activity, to provide a public service, or other purpose. To achieve its purpose, an enterprise may have a structure that includes various business units, such as executive officers, a board of trustees or directors, divisions, departments, managers and other job roles, facilities and other assets, a wide array of projects, activities, processes and workflows, etc. Some enterprises span multiple business sectors and therefore have business units, such as divisions, that can be dedicated to a particular business sector.

Enterprises, usually by their size and nature, can have a wide array of resources and assets. For instance, their resources may include raw materials, equipment, devices, systems, products (e.g., parts, components, sub-assemblies, assemblies), capital, knowledge, and technology among others. Some examples of knowledge resources include resources that are customer-based (e.g., customer lists or customer transactional history such as order history, contact information, demand frequency, etc.), vender/supplier-based (e.g., suppliers, procurement information, supply transactional history, etc.), process-based (e.g., formulations, procedures such as standard operating procedures, technical data sheets, process reports such as material compliance reports or quality reports, or other memorialized process expertise), and research-based (e.g., research and development information or reports). Enterprise resources may also include human resources, including expertise and knowledge of enterprise personnel and contractors, or personnel and contractors of customers, suppliers, vendors, partners, etc. Technology resources may include resources such as inventions, trade secrets, designs, proprietary information of the enterprise (e.g., proprietary software or processes), etc.

In some embodiments, some or all of the resources of the enterprise may be represented in some digital form (e.g., a particular file format), such that these resources may undergo management and processing actions such as being copied, edited, shared, transferred, exchanged, updated, recorded, monitored, accessed, extracted, transformed, loaded, compressed, decompressed, deleted, obsoleted or otherwise processed, such as in digital form or between digital form and another form (such as where knowledge of an expert worker or other individual is accessed by querying the worker through a crowdsourcing system). Even resources that have not had a conventional digital format (e.g., physical goods or equipment) may be represented in a digital format. For example, a non-fungible token may be used to represent resources that are not digital. Additionally or alternatively, some aspect of a resource (e.g., a physical good) can be represented as a digital form or via a digital proxy. For instance, a physical resource may have an associated digital certificate of authenticity, proof of purchase, deed, or a title.

Due to the expanding evolution of digital assets, it is inevitable that enterprises demand an efficient and robust manner of managing digital assets. For example, just as enterprises have historically and efficiently engaged in the transaction of physical goods and the logistics involved in those transactions, enterprises will likely need to address similar aspects for digital transactions. Furthermore, with digital assets, there may be different issues that need to be addressed due to the digital nature of these assets when compared to physical assets. For instance, although unauthentic copies of physical goods are feasible, often, depending on the physical good, the energy, expertise, or equipment needed to generate a copy of physical goods can by itself inhibit copying and help promote the authenticity of a physical asset. In comparison, a digital asset may be easier to replicate. For example, computing has predominantly evolved with a particular simplicity to read/write functionality; making digital files/formats in many cases effortless to duplicate often with minimal loss. Ease of duplication can result in complications, such as where a digital asset is copied and widely distributed and some copies are subsequently modified, making it difficult to determine which versions, among many, are valid. Problems of provenance and validity are compounded with the increasing presence of dynamic digital such as smart contracts and dynamic objects, that are serially updated without human intervention through a network, often by linkage to other dynamic objects that are of uncertain provenance.

Another aspect that is different between physical assets and digital assets is interoperability. Interoperability refers to the ability of systems to exchange and use information. For a physical asset, supply chains are typically structured by participating enterprises to facilitate structural interoperability (such as among the component parts of a system), chemical operability (such as among constituent ingredients in a recipe), etc. For digital assets (such term including physical assets that have a digital component or capability (such as smart devices and systems)), interoperability may have a variety of different issues. For example, having the computing resources to interact with a digital asset may not be cost prohibitive. Therefore, there may be a large number of entities that are able to cooperate with regard to a digital asset. Additionally, the number of entities is fairly elastic because it may quickly increase or decrease depending on the scarcity or demand for the digital asset (e.g., due to its low-cost barrier to entry). Yet a potential outgrowth of the large number of entities that are able to interact with a digital asset is that the access point should have the capability to accommodate for variance between the entities and/or the volume of entities; as a result, communication protocols, authentication protocols, validation protocols, formatting protocols, etc. need to consider the many actors that are able to participate in the digital asset ecosystem.

The management of digital assets and the transactions they involve may also be able to capitalize on their digital ecosystem. That is, the mechanism involved in transactions for digital assets may leverage computing resources to promote optimal transactions. In other words, with digital assets being digital, they are inherently associated with computing resources and therefore a transaction ecosystem can utilize the associated computing capabilities to potentially enhance the circumstances of a transaction involving a digital asset. As an example, it is not uncommon for an asset to have some inventory period where the owner or controller of the asset has the asset available but needs to identify a receiving party and/or terms for the transaction of the asset.

With the computing resources associated with the digital asset or available to the holder of the digital asset, a transactional ecosystem can be configured that can provide autonomy and/or self-promotion for transactions or asset management actions for a digital asset; that is, instead of the manual execution or facilitation of agreements regarding the transactions of digital assets, a transactional ecosystem for the digital asset can automate and/or facilitate one or more phases associated with digital asset transactions. These phases may include a discovery/identification phase that identifies a candidate transaction opportunity involving a digital asset, a diligence/evaluation phase that may evaluate the parameters of the transaction opportunity, a configuration phase that may configure the proposed terms of the transaction (e.g., an exchange rate or a time for the transaction), a negotiation phase that may adjust the terms of the transaction through one or more rounds of negotiation, an execution phase that executes the configured transaction for the digital asset and/or a performance phase that executes performance of one or more actions called for by the terms of the transaction (e.g., delivery of a digital asset to a defined address at a defined time). In this sense, the transactional ecosystem may be capable of self-promoting because the transactional systems can identify candidate transactions for a digital asset without potentially needing human intervention. Although this level of autonomy is feasible, the digital ecosystem may also operate as a hybrid such that certain aspects of the transaction request require some form of authorization prior to automatic execution (e.g., authorization from external source such as a manual input). Additional aspects of various phases of digital asset transactions, such as relating to counterparty discovery, monitoring of collateral, automation of underwriting, automated negotiation, and many others are described in the documents incorporated herein by reference and are intended to be encompassed herein except where context prevents) and/or direct instruction to perform one or more of the phases associated with a digital asset transaction.

To address the growing demands for effective digital asset ecosystems, the approach described herein may include an enterprise access layer. In some implementations, an “enterprise” access layer refers to a network access layer by which an enterprise may access various digital assets and resources (including various entities described in connection with the transaction platforms and systems described herein and in the documents incorporated herein by reference) that may be involved in a set of transactions—such as bilateral or multilateral transactions involving the enterprise, as well as ones enabled by a set of marketplaces, exchanges, etc. that an enterprise interacts with—via a set of network resources. The enterprise may have control (e.g., direct control), management authority, and/or rights to use or access a set of digital assets that are presented to or accessible via the access layer. In embodiments, an enterprise access layer is capable of simplifying transactions for an enterprise (such as reflecting “consumerization”) because it allows an enterprise to interface with multiple markets, marketplaces, exchanges, and/or platforms (e.g., relating to different business segments) through a common point of access.

One advantage of an enterprise access layer is that it may be configured to operate in conjunction with technologies that enterprises deploy in their own environments (i.e., on their private networks, including on-premises and cloud resources and platforms). This may include a wide range of software applications, programs and modules, services and microservices, etc.—including blockchains, distributed ledger technology (DLT), decentralized applications (dApps), intelligent agents, robotic process automation systems, and a wide variety of big data, analytics and artificial intelligence systems. In one non-limiting example, as enterprises deploy DLT and/or dApps, many enterprises will likely want this technology to assimilate with the other systems, structures and workflows of the enterprise.

Throughout an enterprise, different entities may have different roles and responsibilities that can result in varying levels of permission and/or access to enterprise resources. For example, a human resource employee is unlikely to be able to access machinery or equipment of a manufacturing engineer for the same business. Similarly, it is not likely that the manufacturing engineer can access other employee's personnel files like the human resource employee. Based on such differences, technology deployed internally for an enterprise is likely to have some level of permissioning. In embodiments, an enterprise may prefer for the permissioning of technologies like DL Ts and dApps to be similar to or aligned with the physical resource access that is customary to a particular role. For example, when a resource is authenticated and stored on an enterprise's blockchain, that human resource employee would not be an authentication stakeholder for an operations-based resource (e.g., a manufacturing resources), or vice versa.

Generally speaking, a permissioned distributed ledger (e.g., a blockchain) refers to a ledger design where the ledger is not open for everyone to participate in a similar manner like a permissionless ledger (e.g., a public blockchain). Rather, a permissioned ledger may be configured such that participants have particular control/access rights. Enterprises may tend to deploy permissioned systems in their private networks to have access safeguards for enterprise resources while public distributed ledgers attempt to be wholly decentralized and allow anyone to participate with the ledger. For example, enterprises may prefer to deploy permissioned systems because these systems can shield sensitive information, ensure member compliance, and ease the rollout of particular, member-level deployments such as updates and reconfigurations.

### Enterprise Ecosystem

FIG. 9 is an example of a general structure for an enterprise 900 ecosystem. In embodiments, the enterprise 900 ecosystem is an ecosystem where market participants 910 are able to utilize public or third-party services 920 to interface with an enterprise 900 via an enterprise access layer (EAL) 1000. In some embodiments, the market participants 910 may be any entity that interacts with the enterprise 900, such as buyers, sellers, vendors, suppliers, manufacturers, service providers, partners, distributors, resellers, agents, retailers, brokers, promotors, advertisers, clients, escrow agents, advisors, customers, bankers, insurers, regulatory entities, hosts (e.g., of marketplaces, exchanges, platforms or infrastructure, among others), logistics and transportation providers, infrastructure providers, platform providers, and others (including various entities described elsewhere herein and/or in the documents incorporated by reference herein). As shown in FIG. 9, some market participants 910 may be buyers 912 (also referred to as purchasers or customers) when the enterprise 900 is the asset provider (e.g., the enterprise is the selling, giving, or sharing party). Market participants 910 may also be sellers 914 (also referred to as venders or providers) when the enterprise 900 is the receiving party or asset acquirer.

The EAL 1000 may be configured to interact with the market participants 910 (and the ecosystem(s) in which they interact) in a variety of ways. For example, the EAL 1000 may be integrated or associated with one or more marketplaces 922 such that the EAL 1000 functions as its own market participant on behalf of the enterprise 900. By being associated with potentially numerous marketplaces (e.g., marketplaces that correspond to the type or nature of the enterprise assets), the EAL 1000 can perform complex or multi-stage transactions with enterprise assets (e.g., in a series or sequence of timed stages, simultaneously in a set of parallel transactions, or a combination of both).

In an example of a multi-stage transaction, the enterprise 900 may perform a sequence of transactions. For example, the sequence of transactions may be for the purpose of acquiring or accessing a resource from another source (e.g., one of the sellers 914). For instance, the enterprise 900 demands resource ALPHA. However, the enterprise 900 may not have any assets that are directly exchangeable for resource ALPHA. Therefore, the EAL 1000 may be configured to recognize how to acquire one or more assets that are exchangeable for resource ALPHA using the available digital assets of the enterprise 900. To illustrate, the enterprise 900 may have resources BETA and GAMMA. To acquire resource ALPHA, the EAL 1000 identifies that resource DELTA is directly exchangeable for resource ALPHA. In this example, the EAL 1000 may perform transactions with BETA and GAMMA to acquire DELTA in order to finally acquire resource ALPHA. For instance, the EAL 1000 exchanges resource BETA with a first asset source for resource EPSILON and then is able to exchange both resources GAMMA and EPSILON for resource DELTA from a second asset source. With the acquisition of resource DELTA, the EAL 1000 exchanges resource DELTA with a third asset source for resource ALPHA. Without an EAL 1000, acquiring resource ALPHA may be rather difficult because it demands access to multiple sources (e.g., across multiple marketplaces) and mapping how resources associated with those sources can be leveraged to obtain a target resource. Yet with the EAL 1000 that has access to multiple marketplaces 922 and market participants 910, the EAL 1000 can configure and/or execute a transaction sequence or routine that maps how to obtain the target resource (e.g., resource ALPHA). This may occur regardless of relationship between marketplaces 922 and/or market participants 910 such that the EAL 1000 may leverage disparate and independent markets to perform a transaction for a target resource. In other words, resource E may be offered or available in a marketplace 922 that is a different and distinct marketplace 922 from the marketplace 922 that offers the target resource, resource ALPHA.

In embodiments, elements of a multi-stage sequence may be conditional, such that a contingent condition must be satisfied in order for a later stage to commence after completion of a prior stage. Conditions may include ones based on pricing, timing, and other transaction parameters.

In addition to marketplaces 922, the EAL 1000 may interact with market participants 910 via third-party systems 924 (some or all of which may be implemented as third-party services). Some examples of third-party systems 924 include various financial services/systems such as operated by banks, insurers, lending institutions, valuation services, trading services, or escrow services, authentication services/systems, auditing services/systems, security system/services, etc.

In some examples, the market participants 910 and/or marketplaces 922 may use or be associated with a storage system 926 (which may be implemented as a storage service). In some configurations, the storage system 926 may include an append-only persistent storage system such as a blockchain (e.g., as labelled in FIG. 9). An append-only persistent storage system refers to a storage system that, when storing data, appends blocks of the newest data to be stored to the most recent block previously stored. In this sense, the chain of storage blocks may function as a time sequence, which may be cryptographically secured to form an immutable time sequence. This structure may be advantageous because someone who has access to the storage system may be able to determine a history of data storage transactions with relative ease. A blockchain storage system may be a permissionless storage system that is open to all of its members (e.g., all or some portion of participants 910 in a marketplace 922) or a permissioned storage system depending on the nature of the marketplace 922 or the third-party system 924 associated with the storage system 926.

As described previously, the enterprise 900 may include enterprise devices 1020 (e.g., enterprise equipment such as user devices, on-premises, cloud and other network infrastructure, general and/or specialty processors (e.g., edge processors), internet of things (IOT) and industrial internet of things (IIoT) devices), systems, processes, etc.) that generate, interface, or generally impact enterprise resources 1010.

As with the non-enterprise aspect of the enterprise 900 ecosystem (for example, a market-participant side 904 shown in FIG. 9), in some examples the enterprise 900 includes a private storage system 1040. In various implementations, the private storage system 1040 may include one or more private append-only storage systems, such as private blockchains. The private storage system 1040 may be considered private in that the enterprise 900 controls the access and permission for the private storage system 1040. For example, the private storage system 1040 may be only accessible to devices that have access to a private network associated with the enterprise 900, such as a WAN. In some implementations, the enterprise 900 has more than one private blockchains in order to tailor to, for example, the organizational structure of the enterprise 900. For instance, the enterprise 900 may have (i) one private blockchain that corresponds to a storage system for operations or a product-generating portion of the enterprise 900 and (ii) another private blockchain that corresponds to storage systems for administrative portions of the enterprise 900. As another example, the enterprise 900 may have a single blockchain with a set of sidechains for components or organizational units of the organizational structure of the enterprise 900.

In addition to a private blockchain, the enterprise 900 may include an enterprise data store 1030. When compared to a blockchain, a data store refers to a set of data storage types that is not limited to an append-only persistent data storage structure. Rather, an enterprise data store 1030 may be any one or combination of a relational database (e.g., a structured query language (SQL) database), a non-relational database (e.g., a non-SQL database), a key-value store (that is, a map from keys to values), a full-text search engine, a distributed database, a set of network-attached storage resources, a message queue, or other data storage system or service of any of the many types described herein or in the documents incorporated by reference herein.

The enterprise data store 1030 may store enterprise data that is obtained from enterprise resources 1010 or from other various data sources 1050 of the enterprise 900. For example, FIG. 10 depicts that the enterprise 900 may include internal or private enterprise systems that generate data specific to the enterprise 900 (which may be referred to as enterprise data). While the enterprise 900 may have few or even zero of these private enterprise systems that function as data sources 1050, examples of the data sources 1050 include enterprise resource planning (ERP) systems 1052, customer relationship management (CRM) systems 1053 that contain customer-related information, healthcare systems 1054, supply chain systems (e.g., supply chain management (SCM) systems) 1055 that include intra-organizational and/or inter-organizational supply chain information, product life cycle management (PLM) systems 1056 that include product or service lifecycle information (e.g., data characterizing items, parts, products, documents, product/service requirements, engineering change orders, and quality information), human resources (HR) systems 1057, accounting systems (not shown), and research and development (R&D) systems (not shown).

In some examples, as shown in FIG. 10, the enterprise 900 includes a set of analytic systems 1060. The analytic systems 1060 may refer to tools deployed by the enterprise 900 to perform analysis for various processes or systems associated with the enterprise 900. For instance, an enterprise 900 may find it pertinent to their operations to perform market analytics (e.g., for advertising, new product development, and/or marketing purposes), so the analytic systems 1060 may include a market analysis system 1062. Another type of analytics that the enterprise 900 may perform is demographic analytics, so the analytic systems 1060 may include a demographic analysis system 1064. Demographic analytics may aid an enterprise to understand relevant demographic, psychographic, location, behavioral and other information about customers, venders, employees, potential employees, or a target marketplace. For instance, an enterprise 900 uses demographic analytics to determine how a new product can reach a particular target demographic or how an existing product/service is perceived by various demographics. Additionally or alternatively to market analytics and/or demographic analytics, the analytic systems 1060 of the enterprise 900 may be configured to perform an array of statistical analysis, so the analytic systems 1060 may include a statistical analysis system 1066. This statistical analysis may be used to support many different activities throughout the enterprise 900 including analytics performed by other systems of the enterprise 900 or of the analytic systems 1060 themselves (e.g., supporting the market analytics, the demographic analytics, or any of a wide variety of other analytics described herein or in the documents incorporated by reference herein).

FIG. 9 and FIG. 10 illustrate examples of the EAL 1000. In both of these examples, the EAL 1000 is shown to include a number of EAL systems (also referred to as modules or EAL modules) that enable the functionality of the EAL 1000. In some examples, these EAL systems are deployed in a container that is specific to the EAL 1000. When deployed in a container for the EAL 1000, this containerized instance means that the EAL 1000 includes the necessary tools and computing resources to operate (i.e., host) the EAL systems without reliance on other computing resources associated with the enterprise 900 (e.g., computing resources such as processors and memory dedicated to the EAL 1000). For example, the container for the EAL 1000 may include a set of one or more systems, such as software development kits, application programming interfaces (APIs), libraries, services (including microservices), applications, data stores, processors, etc. to execute the functions of the EAL systems that may enable the EAL 1000 to provide enterprise asset transactional management and other functions and capabilities described throughout this disclosure. References herein to “EAL systems” should be understood to encompass any of the foregoing except where context dictates otherwise.

In some implementations, a set of the EAL systems leverages computing resources considered to be external to the EAL 1000 (e.g., separate from computing resources that have been dedicated to the EAL 1000, such as, in embodiments, computing resources shared with other enterprise applications or systems). In these implementations, the set of EAL systems leveraging external computing resources may be in communication with computing resources specific to the EAL 1000. This type of arrangement may be advantageous when one or more of the EAL systems are computationally expensive and would increase the computational requirements for an entirely contained EAL 1000, such as when one or more of the EAL systems causes the EAL 1000 to be a relatively expensive EAL deployment. For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL 1000 has the computational capacity to support a reporting system by itself, the enterprise 900 configures the reporting system to be hosted by and/or supported by computing resources external to the EAL 1000 to deploy a relatively lean form of the EAL 1000 (i.e., an EAL container that does not include resources dedicated to a reporting system or that includes only limited resources dedicated to the reporting system with the capability to access additional, external resources as needed).).

In some configurations, the EAL 1000 or a set of the EAL systems leverages computing resources considered to be external to the EAL 1000 for support. An example of this support may be that the EAL 1000 or the set of EAL systems demands greater computing resources at some point in time (e.g., over a resource intensive time period)—for instance, greater may mean more computing resources than a normal or baseline operation state. In this example, for instance, the enterprises resource not dedicated to the EAL 1000 or EAL systems can assist or augment the services provided by some aspect of the EAL 1000. To illustrate, the EAL leverages enterprise resources to assist or augment the performance of analysis, such as managing and/or analyzing governance for health care data associated with clients of a particular enterprise.

In embodiments, the deployment of the EAL 1000 may be configurable. For example, the enterprise 900 or some associated developer can function as a type of architect for the EAL 1000 that best serves the particular enterprise 900. Additionally, or alternatively, the deployed location of the EAL 1000 may influence its configuration. For instance, the EAL 1000 may be embedded within an enterprise (e.g., non-dynamically) where it can be specifically configured using various module libraries, interface tools, etc. (e.g., as described in later detail). In some examples, the configuring entity is able to select what EAL systems will be included in its EAL 1000. For instance, the enterprise 900 selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL 1000 that includes the selected EAL systems.

### EAL Systems

Referring specifically to FIG. 10, the EAL 1000 includes a set of EAL systems. The set includes an interface system 1110, a data services system 1120, an intelligence system 1130, a scoring system 1134, a data pool system 1136, a workflow system 1140, a transaction system 1150 (also referred to as a wallet system or a digital wallet system), a governance system 1160, a permissions system 1170, a reporting system 1180, and a digital twin system 1190. Additionally, although particular types of EAL systems are described herein, the functionality of one or more EAL systems is not limited to only that particular EAL system, but may be shared or configured to occur at another EAL system. For instance, in some configurations, some functionality of the transaction system 1150 may be performed by the data services system 1120 or functionality of the governance system 1160 may be incorporated with the intelligence system 1130. In this respect, the EAL systems may be representative of the capabilities of the EAL 1000 more broadly. In embodiments, the set of EAL systems involved in any particular configuration of the EAL 1000 may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

In some embodiments, one or more of these systems can be configurable (much like an ERP, a CRM, or the like). The configurations can be done by selecting pre-defined configurations/plugins, by building customized modules, and/or by connecting to third party services that provide certain functionalities.

As will be discussed, in some embodiments, certain aspects of a configured EAL may be dynamically reconfigured/augmented. In some examples, reconfiguration/augmentation may include updating certain data pool configurations, redefining certain workflows, changing scoring thresholds, or the like. Reconfiguration may be initiated autonomously (for example, the EAL periodically tests configurations of certain aspects of the EAL configuration using the digital twin simulation system and analytics system) or may be expert-driven (e.g., via interactions between an EAL “expert” and an interactive agent via a GUI of the interface system 1110).

### Interface System

The interface system 1110 communicates on behalf of the EAL 1000 and/or enables communication with the EAL 1000 by one or more entities, which may include human operators and/or machines. To communicate on behalf of the EAL 1000, the interface system 1110 is capable of communicating with some or all portions of the enterprise 900; for example, enterprise devices 1020, representatives (not depicted graphically) of the enterprise 900, and/or private storage systems 1040 of the enterprise 900. The enterprise devices 1020 may include processors 1022, user devices 1024, and internet of things (IoT) devices 1026, including industrial IoT (IIoT) devices.

In some examples, to communicate with the enterprise 900, the EAL 1000 is configured with access rights to the private network of the enterprise 900. With access to the private network of the enterprise 900, the interface system 1110 can function as a communication conduit to call a system or device of the enterprise 900 in order to support another EAL system. Additionally, the interface system 1110 enables there to be a central communication hub that members of an enterprise 900 may use to engage with functions of the EAL 1000. For instance, a business unit decides to offer a set of the enterprise resources 1010 as a digital enterprise asset that is available to market participants 910. Here, a member of the enterprise 900 or an enterprise device 1020 responsible for the set of the enterprise resources 1010 communicates the set to the transaction system 1150 via the interface system 1110.

As a central communication hub, the interface system 1110 may be used by the EAL systems to communicate with endpoints at the enterprise side (for example, shown as an enterprise side 902 in FIG. 9) or the market-participant side (for example, shown as the market-participant side 904 in FIG. 9). For example, the interface system 1110 operates in conjunction with the EAL systems of the EAL 1000 to ensure that the interface system 1110 includes the appropriate APIs, links, brokers, connectors, bridges, gateways, portals, services, data integration systems or other ways of translating communications (e.g., data packets or data messages) of intra-EAL systems (e.g., between EAL systems) and/or from the EAL systems to an endpoint on the enterprise side (e.g., one of the enterprise devices 1020) or the market-participant side (e.g., a marketplace 922, the storage system 926, or market participant 910).

For example, the interface system 1110 may include an application programming interface (API) 1112 that the enterprise 900 uses to receive or to obtain reports from the reporting system of the EAL 1000. The interface system 1110 may implement a graphical user interface (GUI) 1114, such as via a web server, for use by actors on the enterprise side 902 or the market-participant side 904. Developers associated with the enterprise side 902 or the market-participant side 904 may connect to the interface system 1110 by using a software development kit (SDK) 1115.

As shown in FIG. 10, the interface system 1110 may include an authentication system 1116 and/or a security protocol system 1117 as a way to enforce who has the ability to use the EAL 1000. For instance, an entity that is able to use to use the EAL 1000 may receive credentials that indicate the entity's access permission(s) with respect to the EAL 1000. These credentials may be login credentials, an authentication token, digitized cards/documents, biometric feature(s), one-time passwords, or any other information that functions as proof that the entity has a right to access the EAL 1000 via the interface system 1110. In embodiments, credentials may be managed by an identity-as-a-service platform or other identity management systems. The credentials may be handled by the permissions system 1170. Authentication of an entity may include authentication of human users and/or authenticating specific devices/software systems that are authorized to interact with the EAL 1000.

In various implementations, a set of credentials simply attests to the identity of the individual; then, a back-end system, such as the permissions system 1170, maps that identity to specific access rights. In some examples, the set of credentials also identifies the access rights of the entity. When the set of credentials identifies the access rights of the entity, the interface system 1110 may be able to determine the access rights and tailor which portions of the interface system 1110 that the entity can access. In embodiments, the interface system 1110 is capable of restricting portions of various interfaces or communication channels to EAL systems of the EAL 1000 using the information contained or indicated by credentials that have been associated or issued to an entity.

The interface libraries 1118 may be supplemented in order to allow the interface system 1110 to connect to new actors or data sources on the enterprise side 902 or the market-participant side 904. The GUI 1114 may allow for expert training, client requests, provider response interaction, authentication, machine-to-machine (M2M) communication (through a machine using an agent, such as a scripted web agent, to interact with a graphical user interface), programming, and servicing. The GUI 1114 may present an interface for configuring workflows in the workflow definition system 1142, for configuring the capabilities, such as by selecting subsystems, of the EAL 1000, for defining data pool templates in the data pool system 1136, etc. The GUI 1114 may also provide access to the reporting system 1180 by regulators, auditors, government entities, etc.

### Data Services System

The data services system 1120 performs data services for the EAL 1000, which may include a data processing system 1122 and/or a data storage system 1123. This may range from more generic data processing and data storage to specialty data processing and storage that demands specialty hardware or software. In some examples, the data services system 1120 includes a database management system 1125 to manage the data storage services provided by the data services system 1120. In some configurations, the database management system 1125 is able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems), facilitating processing threads or queues, etc. In some examples, the data services system 1120 couples with other functionality of the EAL 1000. As an example, operations of the data services system 1120, such as data processing and/or data storage, may be dictated by decision-making or information from other EAL systems such as the intelligence system 1130, the workflow system 1140, the transaction system 1150, the governance system 1160, the permissions system 1170, the reporting system 1180, and/or some combination thereof.

In some implementations, the data services system 1120 includes an encryption system 1124 offering encryption/decryption capabilities that pair with the data processing/storage. For instance, the encryption system 1124 may decrypt data when encrypted data is retrieved from its data store(s). In other situations, the data services system 1120 may encrypt data that is being used, processed, and/or stored at the EAL 1000. For instance, the encryption system 1124 receives data to be stored, determines that the received data includes one or more characteristics that satisfy an encryption rule, and encrypts the data prior to, during, or after the data is transferred to a storage location. In this respect, the encryption system 1124 may receive an encryption or decryption request that specifies data associated with the data services system 1120 and the data services system 1120 is capable of fulfilling the request and providing the encrypted/decrypted data to the requesting entity. The encryption system 1124 may be configured to provide symmetrical encryption, asymmetrical encryption, or other suitable types of encryption. Some encryption algorithms that the data services system 1120 may use are Advanced Encryption Standard (AES), Rivest-Shamir-Adleman (RSA), and variations of Data Encryption Standard (DES) (e.g., 3DES), among others. Additionally or alternatively, the encryption system 1124 may also perform hashing or other cryptographic functions to verify data that it manages for the EAL 1000. Operation of the encryption system 1124 may be controlled according to the permissions system 1170.

The data services system 1120 may include a hardware system 1126 that provides the computing and storage for the other elements of the data services system 1120. The hardware system 1126 may include processors, memory, cache, secondary storage, etc. The data services system 1120 may also rely on cloud-hosted storage and compute services, whether public or private. A networking system 1127 allows for interfacing with cloud-hosted storage and compute services. The networking system 1127 may also facilitate transfer of instructions and data within elements of the EAL 1000 as well as with other actors.

### Intelligence System

In FIG. 13, an example implementation of the intelligence system 1130 may include an intelligence service controller 1331 and a plurality of adapted AI modules 1332, among others. In some examples, the intelligence service controller 1331 may include an analysis management module 1333, a governance library 1334, and/or a set of analysis modules 1335, among others. The analysis management module 1333 may include similar features and/or may be configured to carry out similar operations as one or more other management modules described herein. The governance library 1334 may include similar features and/or may be configured to carry out similar operations as one or more other libraries described herein. The set of analysis modules 1335 may include similar features and/or may be configured to carry out similar operations as one or more other analysis modules described herein. In some implementations, the adapted AI modules 1332 may include a machine learning module 1336, an analytics module 1337, a generative AI module 1338, a natural language module 1339, a robot process automation module 1340, and/or a neural network module 1341, among others. The machine learning module 1336 may include similar features and/or may be configured to carry out similar operations as one or more other machine learning modules described herein. The analytics module 1337 may include similar features and/or may be configured to carry out similar operations as one or more other analytics modules described herein. The generative AI module 1338 may include similar features and/or may be configured to carry out similar operations as one or more other generative AI modules described herein. The natural language processing module 1339 may include similar features and/or may be configured to carry out similar operations as one or more other natural language processing modules described herein. The robot process automation module 1340 may include similar features and/or may be configured to carry out similar operations as one or more other robot modules described herein. The neural network module 1341 may include similar features and/or may be configured to carry out similar operations as one or more other neural network modules described herein.

The intelligence system 1130 of the EAL 1000 functions to provide intelligent functionality to the EAL 1000. Among other aspects, the intelligence system 1130 is a system that the EAL 1000 can use for decision-making regarding transactions for enterprise digital assets. For instance, the intelligence system 1130 may recruit and/or coordinate a set of EAL systems (e.g., including enterprise sources) as necessary to provide a set of outputs in response to one or more intelligent requests (i.e., decision-making request). Some intelligent or decision-making functionality that the intelligence system 1130 is capable of providing includes peer or counterparty discovery (i.e., identifying parties for a transaction, such as one using enterprise assets or assets that are desired to be acquired by or for an enterprise, among others), automated asset allocation and position maintenance (e.g., automated acquisition or disposition of assets to maintain a desired allocation of assets across asset classes, such as to maintain a desired balance of risk and return across the asset classes), automated asset management (e.g., determining which wallets of the wallet system that an available enterprise asset should be associated with), automated transaction configuration (e.g., assembling smart contract and/or smart contract terms for a set of digital asset transactions), automated negotiation of transaction terms, automated settlement (e.g., by execution of on-chain transfers), modeling or analysis of a set of transactions or a transactions strategy, forecasting or predicting asset or transaction parameters (e.g., prices, trading volumes, trading timings, etc.), automated prioritization (e.g., prioritization of transactions among a set of transactions, of assets among a set of assets, of workflows (e.g., prioritizing a set of workflows among others for access to available resources of the EAL 1000), configuration of transaction timing, and/or automated management of a set of policies (e.g., enterprise governance policies, regulatory or legal policies, risk management policies, and others).

In embodiments, the intelligence system 1130 is capable of learning from prior transactions to inform future transactions. To have this learning capability, the intelligence system 1130 may include a set of learning models that identify data and relationships in transactional data, such as transactional training data set consisting of historical training data (which, in embodiments, may be augmented by generated or simulated training data). Models may include financial, economic, econometric, and other models described herein or in the documents incorporated by reference herein. Learning may use an expert system, decision tree, rule-based workflow, directed acyclic workflow, iterative (e.g., looping) workflow, or other transaction model. Some examples of learning models include supervised learning models, unsupervised learning models, semi-supervised learning models, deep learning models, regression models, decision tree models, random forest or ensemble models, etc. Learning models may use neural networks (e.g., feedback and/or feedforward neural networks, convolutional neural networks, recurrent neural networks, gated recurrent neural networks, long short-term memory networks, or other neural networks described in this disclosure or in the documents incorporated herein by reference). Learning may be based on outcomes (e.g., financial yield and other metrics of enterprise performance), on supervisory feedback (e.g., from a set of supervisors, such as human experts and/or supervisory intelligent agents), or on a combination.

In some examples, the learning models of the intelligence system 1130 may train using enterprise data that relates to transactions for digital enterprise assets. In this case, training data sets may be proprietary to the enterprise. By having enterprise specific training data sets (that is, with enterprise training examples), the enterprise 900 learns how to predict transactional behavior with data tailored specifically to the enterprise 900 and characteristics of its assets (such term including, except where context indicates otherwise, assets controlled by the enterprise as well as other assets that may be involved in the workflows of the enterprise, such as assets being pursued for acquisition, borrowing, lending, etc.). In some examples, the learning models may train first from a larger corpus of training data (e.g., public training data set) and then undergo a fine-tuning process that trains with a specialized data set that is particular to digital enterprise assets. In these examples, the weights or biases that are configured during the first stage of training with the larger corpus may then be fine-tuned or adjusted during the second stage. In some examples, the fine-tuning of the second stage also assists to prune nodes that have low impact on enterprise-specific data that would not have been pruned by solely training with the larger corpus. In other words, the enterprise-specific data of the second stage of training that fine-tunes the model reduces nodes that do not influence (e.g., the probability) a transaction event regarding an enterprise digital asset.

In some configurations, the intelligence system 1130 includes one or more modules that function to gather data for purposes of training a model of the intelligence system 1130. For example, the intelligence system 1130 includes data pipelines that include data that characterizes digital enterprise assets that are available in a wallet system (e.g., the transaction system 1150), data that characterizes historical, current or predicted state/status data about entities involved in enterprise transactions or workflows, data that characterizes historical, current or predicted state/status data about enterprise assets or resources, etc. In some examples, these modules that function to gather data for purposes of training a model of the intelligence system 1130 gather, derive, or generate training data from information associated with one more EAL systems. For instance, the training data may be governance/compliance information, such as rules, that can be used to develop models that provide decision-making compliance or predictive compliance. In this example, the governance/compliance data may be translated into enterprise-specific data for the second state of training when the governance/compliance data is specific to the enterprise.

In some implementations, each model, module, service, etc. of the intelligence system 1130 may correspond to a particular marketplace 922 or type of marketplace 922. For instance, the training data to train a marketplace's specific model may consist of transactional data for that marketplace 922 or type. By having a model that is specific to a particular marketplace 922 or type, the model can be capable of predicting transactional information or transactional events for the marketplace 922 or type. Therefore, the EAL 1000 can leverage the prediction from the model to inform transactional actions for a digital enterprise asset available to the particular marketplace 922 or type.

In embodiments, the intelligence system 1130 may include search functionality, such as enabling searching for assets within a wallet of the enterprise or searching within other data resources of the enterprises for assets that may be appropriate for inclusion in the wallet. The search function may use similarity algorithms (e.g., k-means clustering, nearest neighbor algorithms, or others) to discover assets that may be of interest by virtue of similarity to other transacted assets and/or ones presented in a wallet. A search algorithm may be trained, such as based on outcomes of transactions or enterprise or user actions, to identify relevant assets for wallet inclusion and or to identify relevant assets within a wallet for a possible transaction. In embodiments, the search functionality may enable recommendations, such as recommendations of assets for inclusion in wallet, for inclusion in a transaction, for presentation, etc. Recommendations may, in embodiments, be based on algorithms, including clustering and similarity algorithms that recommend similar transactions to similar parties, collaborative filtering algorithms in which users indicate preferences as to types of assets or transactions and based thereon are associated with other similar users whose actions and transactions inform recommendations, deep learning algorithms, that are trained on transaction outcomes, and many others.

In embodiments, the intelligence system 1130 may facilitate prioritization, such as by alignment of functions and capabilities according to a set of prioritization rules, such as rules that prioritize certain enterprise entities (such as particular workgroups), that prioritize certain types of transactions (such as time-sensitive trading versus long-term resource acquisition), etc. In embodiments, the prioritization rules may be linked to and/or derived from a set of enterprise plans, such as strategic plans, resource plans, etc. This may include optionally translating a set of strategic or resource goals into a set of priorities that are applied as rules to transactions. In embodiments, prioritization rules are dynamically and automatically updated based on changes to resource plans, strategic plans, etc. by virtue of integration between the intelligence system 1130 and one or more enterprise planning systems. For example, if a resource plan indicates a need to acquire a critical input resource for an operating function, the intelligence system 1130 may prioritize discovery of candidate sources for that resource. As another example, if a strategic plan indicates a need to dispose of an asset to reduce exposure to market volatility, the intelligence system 1130 may prioritize presentation of the asset in wallet or other interface in order to facilitate rapid disposal of the asset.

Additionally, or alternatively, the intelligence system 1130 may be capable of configuring other EAL systems (for example, via an intelligence service controller shown in FIG. 10). For example, the intelligent functionality of the intelligence system 1130 may provide configuration details or configuration inputs to other EAL systems. When the intelligence system 1130 configures other EAL systems, the intelligence system 1130 enables the EAL 1000 to operate autonomously or semi-autonomously. That is, the EAL 1000 is capable of operating without human intervention (that is, partially or fully autonomously) such that the EAL 1000 coordinates, controls, and/or executes transactions regarding digital enterprise assets on its own accord. Configuration itself may be autonomous, such as using robotic process automation (where an agent is trained to undertake configuration based on training on a set of expert configuration actions), by learning on outcomes, or by other learning processes described herein or in the documents incorporated herein by reference.

In some configurations, a set of models of the intelligence system 1130 functions to predict or recommend configurations for other EAL systems of the EAL 1000. That is, each EAL system may have a configuration protocol that includes parameters that enable a respective EAL system to perform a particular function. Here, a model of the intelligence system 1130 may be trained to generate an output that serves as a configuration parameter for an EAL system. In this respect, one or more models of the intelligence system 1130 may be used to generate predictions or recommendations to configure one or more EAL systems to perform a particular transaction for an enterprise digital asset. Prediction of configuration of one EAL system can be used in the configuration of another EAL system, such as to harmonize configurations across the systems (e.g., to allow development of a logical or efficient sequence of transactions that are governed by the respective systems, to allow effective coordination of EAL resource utilization, to avoid conflicts (e.g., where different systems seek to undertake inconsistent actions with respect to the same resource or asset), etc. Additional examples of intelligence systems and services are described elsewhere in the disclosure.

### Scoring System

In FIG. 15, an example implementation of the scoring system 1134 includes a data scoring engine 1510, a blockchain scoring system 1520, a model scoring engine 1530, a buyer scoring engine 1540, a seller scoring system 1550, and a transaction scoring system 1560.

The blockchain scoring system 1520 may assess the reliability of data and smart contracts stored on a distributed ledger (such as blockchain). The buyer scoring engine 1540 may leverage know-your-customer technology to determine the identity of a buyer and then determine the reliability of the buyer in the buying role (for example, based on credit score, past and pending payments to the enterprise 900 and third parties, etc.). Similarly, the seller scoring system 1550 may, once the identity of a seller is established, determine the reliability of the seller in the role of a seller (for example, based on quality history, timeliness of delivery, and warranty performance). In other words, it is possible that a single entity may have different seller and buyer scores according to respective performance in those roles. As the reliability of an entity decreases, the level of approval for a transaction with that entity may increase and/or a different approval workflow may be triggered.

The transaction scoring system 1560 may assess a risk level of a transaction, as discussed elsewhere in this disclosure, including taking into account risks associated with currency fluctuations and liquidity of assets. As the predicted risk exposure of a transaction increases—for example, making a payment in a currency whose value may increase before the transaction is completed, or receiving an asset whose value cannot be easily recognized due to illiquidity in the relevant market—the level of approval may increase and/or a different approval workflow may be triggered.

The scoring system 1134 can be configured to monitor and score data, data sets, and data sources to assess reliability and accuracy. For example, the data scoring engine 1510 may generate a score, which is a comprehensive term encompassing, as examples, a numeric value or a classification. In various implementations, a numeric value may be an indication of reliability on a scale of 0 to 100. A classification may include an enumerated set of “reliable,” “apparently reliable,” “apparently unreliable,” “unreliable,” “manipulated,” and “unknown.” Manipulated data may include data that is malicious, fake, misleading, unreliable, or biased. Examples of manipulated data include bot-generated transaction requests, bot-generated data, certain crowd-sourced data (i.e., comments, reviews, social media interactions, etc.), astroturfing, sockpuppeting, false flag information, etc.

A score may be assigned to each datum, to each data set, and to each data source. Any object, such as a data pool, relying on data may store the score as well. In various implementations, data in a data pool may have respective scores; depending on the type of request made to the data pool, data from the data pool may be filtered according to the respective scores. For example, a data request to the data pool may specify a source threshold and a data threshold; only data from the data pool that is derived from a data source having a score above the source threshold will potentially be available and then only those data whose individual scores are above the data threshold will actually be available. Beyond filtering, the score may allow for weighting. For example, all data below a first threshold may be excluded, while data between the first threshold and a second threshold may be weighted less than data above the second threshold; continuing this example, data with scores between the first threshold and the second threshold may be weighted along a sliding scale (which may be linear, logarithmic, etc.) such that data with scores near the first threshold have very low weightings and data with scores near the second threshold have very high weightings; meanwhile, all data with scores above the second threshold may have the same weighting (where the weighting is expressed as a percentage, this data may have a weight of 100%).

Thresholds may vary based on the purpose—in various implementations, data used to train machine learning models may require higher thresholds to avoid poisoning or biasing the model. Even for a single purpose (like training a neural network or other machine learning model), the thresholds may also depend on the use of the model; a model that informs a safety-related decision may have much higher thresholds than a model that determines consumer sentiment for advertisement purchasing decisions.

In addition to allowing for filtering and weighting, the score may be used as an input for decision making by the EAL 1000, including the workflow system 1140 and the data pool system 1136. For example, certain data sources may be excluded from certain or all data pools depending on their score. The level of reliability of data and data sources may be specified by a template from the data pool library 1410 as part of the data pool configuration.

Scores may be stored separately, such as in a relational database of the data management system 1470, or incorporated into the data itself, such as prepended or appended to each data file (for example, as a header). In various implementations, a metadata object including the score may be cryptographically signed by the scoring system 1134, so that any entity with access to the public key of the scoring system 1134 can verify the provenance of the metadata object (in other words, that the metadata object has not been tampered with). In various implementations, the data itself may be cryptographically signed as well, either with the same or another signature.

Reliability of data may be determined from intrinsic attributes (the data itself) and extrinsic attributes (for example, the source of data, the type of data, etc.). Intrinsic attributes may be determined from patterns in data values. As an example, survey data received from human subjects may be expected to have wide variability; if many sets of incoming survey data are identical, this may be an indication of bot-generated content or of a more innocuous situation, such as an error that led to duplication of one survey response. The data may include identifying information, such as geography, IP (internet protocol) address, MAC (medium access control) address, mobile network, browser type, browser fingerprint, etc. A large chunk of data from a single IP address or range may be an indication of unreliability of that data. However, an IP address or range may be used by many more devices being a network address translation (NAT) router, so historical attributes of those IP addresses may also be assessed.

In various implementations, for computational efficiency, data is sampled such that only some data is checked for reliability. The checked data may be randomly sampled (without replacement) and the level of sampling may be dependent on reliability or confidence in the data source—that is, a larger percentage of data will be sampled from less-reliable data sources or from data sources where there is less confidence in their reliability.

As another example, data may include not just values but also timestamps. When a spike of activity indicates many more data points than usual, this may also be evidence of bot-generated content. Further, there may be natural patterns in the data, such as time-of-day and day-of-week—for example, data points generated by a business may generally be less frequent before normal work hours begin and after normal work hours end, and also be less frequent on holidays and weekends. In such an example, the work hours may be known a priori or inferred based on historical data; they are generally region-specific, with different time zones corresponding to different ranges of work hours. When a set of data aligns with work hours from the wrong time zone (that is, a time zone not associated with the entity location that is supposed to be producing the data), this may be an indication of the data being injected from another country; for a U.S. business, data coinciding with working hours in Russia may be an indication of unreliability.

The data scoring engine 1510 may include multiple intrinsic machine learning models. In various implementations, each intrinsic machine learning model may be trained on historical data from sources having a reliability score above a threshold. Then, new data from sources having a reliability score below the threshold are inputted to the machine learning model—the machine learning model can identify whether the data is anomalous, which might be an indication of unreliability. The model may also be configured with a priori data, such as if there is a known or expected distribution of values, such as a Gaussian distribution. While the data scoring engine 1510 may be configured to automatically assume that data generated within the enterprise 900 and the EAL 1000 is completely reliable, for some or all data—such as sensor data (such as from the IoT/IIoT devices 1026)—data scoring may be applied.

Data may be tagged or otherwise associated with a data source and the data source may have an associated score. The score may be known a priori—for example, the reliability score of data generated by the EAL 1000 itself may be associated with a high reliability score. In various implementations, the data may be provided by or derived from a machine learning model—such a score may come from the model scoring engine 1530. The model scoring engine 1530 may generate a score for a model based on the reliability of data being ingested by the model as well as parameters of the model. For example, a model that evidences bias over time may receive a lower score. The model scoring engine 1530 may also use features such as accuracy (general or specific sub-class), speed, cost, availability, and compute requirements (which, in various implementations, overlaps with cost). The model score may be used for general model selection (e.g., for inclusion into a configuration) or can be used in real time by a higher-tier intelligence controller, such as the intelligence system 1130. For example, the higher-tier intelligence controller can receive or determine a set of input considerations (such as importance of the task, budget per API call, speed requirements, etc.) and may select a model to use based on the considerations and outputs from the model scoring engine 1530.

Extrinsic attributes of data may also be used in assessing the reliability of data. For example, the reliability of a data source may be determined. This source reliability may be used in assessing the reliability of any set of data. Credible data or data sources can be scored higher than their counterparts. For example, social media or crowd sourced data may be scored lower than financials generated or received from a financial institution. In various implementations, a machine learning model may be trained to generate a prediction indicative of reliability of a source. The source reliability model may include features provided by the intrinsic data scores; data that seems to have intrinsic unreliability (for example, as described above, deviations from an expected distribution or unexpected timing patterns) will lead to the source being considered less reliable.

In various implementations, one feature, which may be weighted strongly in the machine learning model, is whether the data source is internal—by default, data developed within the EAL 1000 or the enterprise 900 may be associated with a high reliability. However, in various implementations, some data developed by the EAL 1000 may be associated with inherent reliability risks, such as sensor data. Therefore, there may be multiple classifications applied to internal data with respect to this feature.

Another feature for the data source machine learning model may be the provenance of the data from the data source. When the data of a data source is obtained from other parties, their reliability may need to be assessed. In some cases, the other parties are too numerous to individually assess, such as in the case of crowdsourced data. When reliability of multiple parties cannot be practically or even conceivably assessed, this may lead to the data source being considered less reliable. In other words, the data source machine learning model may have a feature related to the extent of the data being derived from crowdsourcing. This feature, or another feature, may reflect parameters of the crowdsourcing that may lead to inferences of reliability. For example, the level of anonymity of data provided by numerous parties may be a feature—generally, the more anonymous the data, the less reliable the data source. Other parameters may also impact this or other features, such as whether the data source curates the data or the parties in any way. As one specific example among many, customer reviews on an ecommerce platform may have reliability indicia of the review, such as whether the review is associated with a confirmed purchase and whether the review is associated with a reviewer's real name. Some of these features may not strongly impact the source reliability score—in the ecommerce example, tying a review to an actual purchase does not protect against the seller from using cutouts to make purchases and then provide reviews, while simply receiving the products back, losing out on only the ecommerce platform's overhead.

The reliability score for a data source may be based on historical reliability of the data source, with historical data weighted (for example, linearly or exponentially) such that more recent reliability data is more important than older reliability data. The data source reliability score may also be impacted by the relationship of the enterprise to the data source—for example, customers or sellers with a high number of amount of transactions with the enterprise 900 may be a feature that leads to a higher assessment of the reliability of their data. Still further, the data source machine learning model may take into account data generated by subject matter experts about the reliability of the specific data source, the class of data source, the industry of the data source, etc.

The data source reliability score may take into account external data about the data source, such as whether and how recently they have suffered a data breach, how long they have been in business, how long they have been offering this type of data, etc. In addition to the reliability score, or incorporated into the reliability score, may be a confidence measure. Although a data source may appear to have high reliability, if the data source is new and unvetted, the confidence in that high reliability may be lower.

### Data Pool System

In FIG. 14, an example implementation of the data pool system 1136 includes a data pool library 1410, an access assignment system 1450, an analysis system 1450, a pool construction system 1460, and a data management system 1470. The data pool system 1136 manages, defines, creates, stores and provides access to datasets to systems of the EAL 1000 in response to a data request. The data pool system 1136 may process the data request and provide access to a data pool with relevant data to the data services system 1120, the permissions system 1170, the transaction system 1152, and/or component(s) thereof from the data pool library 1410. In various implementations, the data may actually be stored by the data services system 1120 while the data pool library 1410 provides management and access services—in this respect, the data pool system 1136 may act like an interface layer or a materialized view of a database.

The data pool system 1136 may configure datasets to streamline predefined functions, for example, using workflows obtained from a workflow system 1140. A data pool may be a structured datastore configured and instantiated to respond to a particular request. The data pool may store training data for a machine-learning model, whether that machine-learning model is part of the EAL 1000 or a third party; when a third party, the data may be exchanged for compensation or in trade for third party training data. A data pool may also be used to collect and provide data for use the digital twin system 1190, including data gathered from the IoT/IIoT devices 1026. A data pool may be used for each reporting or audit process. In some instances, a data pool may be instantiated just at the time of creating a report or conducting an audit, and in other instances, a data pool may persist for an entire reporting interval, gathering data to allow for reporting.

A data pool may include data from one or more sources (e.g., entities, EAL systems, enterprises, IoT networks, digital products network, etc.) structured for the particular purpose of responding to a request (i.e., query). For example, a data pool for reporting expenses for an enterprise may for a data pool that multiple employees or entities within an enterprise may add to and/or read from. The pool construction system 1460 of the data pool system 1136 may structure the data into a format according to a set of rules. For example, newer data may be given higher prevalence than older data, data with higher trust scores may be presented in a more optimal position than other data, older data may be aggregated in the data pool, crowdsourced data may be added in a less optimal position than data from other sources, etc. In various implementations, newer data may be stored in a more preferential manner—for example, cached in lower latency storage; meanwhile, older or less reliable data may be stored in slower storage media and perhaps stored in compressed form, with the level of acceptable loss for lossy compression increasing based on age. In addition to traditional compression, data may be aggregated based on age; for example, older data may not be stored as daily values but as monthly values, while even older data may be aggregated into annual values.

In various implementations, the analysis system 1450 is configured to analyze a request and obtain one or more data files from the data pool library 1410 that can be used to respond to the request. The data pool library 1410 includes a repository of data files, and a plurality of pool systems, including one or more of an open pool system 1414, a social pool system 1426, a protected pool system 1418, a local pool system 1430, a generative pool system 1422, a temporal pool system 1434, and a library management system 1438. In some example embodiments, each of the pool systems may be configured to allow the deployment of data files contained therein based on a set of permission rules to comply with internal and external requirements (e.g., government requirements, security requirements, regulations, internal enterprise compliance policies, etc.) defined by an entity associated with an enterprise. The set of permission rules may include access rules (e.g., entity type permissions, authorization rules, location rules, etc.), scoring thresholds, restrictions on type of use, encryption/decryption rules, request/transaction type rules, workflow type rules, device type rules, etc.

The pool construction system 1460 generates and/or configures a data pool based on a set of requirements and/or access rules by applying the rules to each data set (such as data file) within the pool. The pool construction system 1460 may obtain relevant data from any source within the EAL 1000 or outside of the EAL 1000. For example, the pool construction system 1460 may access any of the data sources 1050 of the enterprise 900 as well as external data sources, including those on the market-participant side 904 such as public blockchain storage systems 926. In constructing the data pool, the pool construction system 1460 may create data structures using data types specified by templates, such as ones defined by the library management system 1438. Each template may specify data structures (such as arrays, linked lists, etc.), data types—whether a programming language built-in type (such as integer, string, enumerated set, etc.) or a type that may be more complex (such as date, time, currency, etc.)—granularity of data, metadata fields for each datum (such as time of incorporation into the data pool, last access time), metadata fields for the data pool (such as date of creation, permission structure, etc.), reporting requirements, and audit requirements (such as the need to log all changes).

In some examples, the data pool library 1410 includes a library management system 1438 to manage the data pools provided/generated by the data pool system 1136. In some configurations, the library management system 1438 is able to perform management functions such as querying the data pools being managed, organizing data pools for, during, or upon ingestion, coordinating storage sequences (e.g., chunking, blocking, sharding), cleansing the data pools, compressing or decompressing the data pools, distributing the data pools (including redistributing blocks of data pools to improve performance of storage systems) and/or facilitating processing threads or queues, and the like. In some examples, the data pool system 1136 couples with other functionality of the EAL 1000. As an example, operations of the data pool system 1136, such as data pool processing and/or data pool storage, may be dictated by decision-making or information from other EAL systems such as the data services system 1120, the intelligence system 1130, the workflow system 1140, the transaction system 1150, the governance system 1160, the permissions system 1170, the reporting system 1180, the scoring system 1134, and/or some combination thereof.

The data pool library 1410 includes a repository of data pools and may include one or more of an open pool system 1414, a social pool system 1426, a protected pool system 1418, a local pool system 1430, a generative pool system 1422, a temporal pool system 1434, and a library management system 1438. A data pool may include a series of files configured for a particular purpose. In some example embodiments, each data pool may be configured to allow the deployment of data files contained therein based on a set of permission rules to comply with internal and external requirements (e.g., government requirements, security requirements, regulations, internal enterprise compliance policies, etc.) defined by an entity associated with an enterprise. The set of permission rules may include access rules (e.g., entity type permissions, authorization rules, location rules, etc.), scoring thresholds, restrictions on type of use, encryption/decryption rules, request/transaction type rules, workflow type rules, device type rules, etc. A pool construction system 1460 of the data pool system 1136 may generate and/or configure the data pools based on the set of requirements/access rules by applying the rules to each data file within the pool.

The data pool system 1136 may further include an access assignment system 1440, an analysis system 1450, a pool construction system 1460 and a data management system 1470. In some implementations, the analysis system 1450 may receive a data request from the workflow system 1140. The analysis system 1450 may analyze the data request to determine the types of data required to respond to the data request. For example, a data pool constructed for processing of an auto loan application may include local data stored on the EAL 1000 (e.g., automobiles owned by a user, financial institution used by user, etc.), payment history stored at a third-party EAL, prediction data generated by machine learning applications predicting future payment potential for the user, etc. Based on the data required to respond to the request, analysis system 1450 may send data requests to the data pool library 1410 or subsystems thereof for data collection. For example, the analysis system 1450 may extract user identification data and send it to the data pool library 1410 for collecting relevant data instances for creation of the data pool by the pool construction system 1460. In the auto loan example, the analysis system 1450 may send a request to the local pool system 1430 for the local data, to the temporal pool system 1434 for payment history, and to the generative pool system 1422 for prediction data. The data pool library 1410 may then send the relevant requested data to the pool construction system 1460 to construct a data pool responsive to the request from workflow system 1140. The pool construction system 1460 may aggregate the data into a data pool based on rules associated with each portion of data received from the data pool library 1410. The pool construction system 1460 may provide access to the data pool to the workflow system 1140 as a response to the data request.

Access to the data pool system 1136 library may be governed by the permissions system 1170. Access may be controlled both at the source data level and at the data pool level. For example, the permissions system 1170 may dictate which data sources which entities are allowed to access. If a data pool draws from a source that an entity is not allowed to access, the entity may be prevented from accessing that data pool, or the data pool may need to be filtered before or as part of the access. Further, the permissions system 1170 dictates which entities are permitted to construct data pools, and which types of data pools can be constructed; for example, some entities may be restricted to a proper subset of the available data pool templates, while other entities are restricted to the entire set of available data pool templates and are simply not permitted to specify a custom data pool template.

The open pool system 1414 may allow for configuration of an open data pool such that any entity internal to or external to the EAL 1000 can access the open data pool without restrictions. In this example, the data pool may be configured such that any number of enterprises, users, devices, and/or digital agents may contribute specific type(s) of data to the data pool. In some example implementations, the open pool system 1414 may apply rules to configure data pools based on manual input from an entity of the EAL 1000 responsible for that data pool indicating that the data pool may be shared without restrictions. In other example implementations, the open pool system 1414 may determine whether the data pool being configured includes data of a type that can be configured as an open data pool based on open pool requirements provided by the entity of the enterprise. The analysis system 1450 may analyze a data pool to determine whether a data pool may be configured as an open data pool based on the open pool requirements specifying the type of data pools that may be made available to the public and/or other entities without restriction. The analysis system 1450 may analyze the data pool to determine, for example, whether any portion of the data pool includes a type of data that should be subject to restrictions (e.g., personally identifiable information, credit card information, medical information, etc.). If the data pool includes such information that may need to be restricted, the analysis system 1450 may invoke the protected data pool system 1136 to configure the data pool. Otherwise, the analysis system 1450 may send the data pool to the open pool system 1414 for processing, configuration, and storage.

The protected pool system 1418 offers data protection for data pools within the data pool library 1410, including encryption/decryption capabilities and/or role-based access capabilities that pair with data pool processing/storage/access. The protected pool system 1418 may configure data pools based on permission rules defined by the entity of the enterprise. A data pool may be configured with permission rules that differ for different entities with access to the data pool. For example, a data pool including credit scores may be accessible by a bank, a financial entity, and an automobile dealer, with each having different requirements for accessing the data in the credit score data pool, including who can access the data, where the data can be accessed, data rights (e.g., read, write, etc.), etc. Each data pool may be associated with a set of permission rules per entity allowed access to that data pool.

The access assignment system 1440 may determine that a data pool within the protected pool system 1418 may be included in a response to the received request. The access assignment system 1440 may also be invoked by the network availability system 1175 to create a data pool of data that will be needed in the absence of network connectivity. The access assignment system 1440 may determine which entities can have access to the data pool so that when a data request is made, the data is present and the permission are defined even without being able to make external network requests.

In embodiments, permission rules may include an authorization rule indicating that access to a data pool requested by an entity requires authorization from one or more other entities. For example, the protected pool system 1418 may configure a data pool with a set of authorization rules that define which types of users and/or request types must have explicit authorization to access certain types of data. These authorization rules may define an authorization hierarchy that indicates which types of employees can authorize an access request, which employees or types of employees must have their requests authorized, request types that require authorization, etc. The protected pool system 1418 may associate the authorization rules with the data pool such that the permissions system 1170 may determine whether a transaction request requires further authorization based on the entity data and the authorization rules defined by the enterprise. In these embodiments, the authorization rules may define rules that define the roles or identities of enterprise entities that are able to authorize data access for certain business units, users, and/or third-party entities. For example, access requested by a certain business unit may require a manager or director of the business unit to authorize the transactions. In another example, access requests meeting certain criteria may require authorization from a person having a specified title, such as the CEO, CFO, or a manager in the finance department. In various implementations, the workflow system 1140 may manage obtaining this authorization. In various implementations, the access assignment system 1440 may provide the data pool along to the permissions system 1170 for analysis of the associated permission rules and execution (or non-execution) of access provision to the requestor.

In some example implementations, the permission rules may include encryption rules for encryption of certain data fields within the data pool (e.g., payment information such as card numbers, routing numbers, communication addresses, personal identification information, regulated medical information, etc.) prior to sharing the data pool with an entity. In such implementations, the permission rules for the data pool may include encryption types (e.g., private encryption, public encryption, data scrubbing, symmetric encryption, asymmetric encryption, hashing, etc.) associated with each data field to be encrypted, encryption key(s) and/or decryption keys that may be used by the transaction system 1150 and/or the permissions system 1170 to encrypt/decrypt the associated data fields of the data pool prior to communicating the data pool with the requested entity. In this way, the protected pool system 1418 may assign rules to a data pool to control access to the data pool in order to comply with requirements of the entity controlling the data pool.

In some implementations, the permission rules may include scoring rules, such as a scoring threshold, for determining whether a data pool can be used to respond to a certain type of request by a certain entity. In an example implementation, each data file may be configured to include a trust score obtained from the scoring system 1134. Pool construction system 1460 may analyze each potential data file obtained from the data services system 1120 to be included in a data pool based on its trust score obtained from the scoring system 1134 to determine whether the trust score for the potential data file meets the required scoring threshold prior to being added to the corresponding data pool. Different rules for data pools may be based on request types (e.g., medical data request, social media request, HR request, financial transaction request, etc.), workflow types, device types (e.g., personal device, through enterprise API, enterprise device, etc.), location types (e.g., foreign country, within the United States, embargoed countries, within permitted enterprise locations, etc.), employee security levels, employee groups/teams, etc. Other non-limiting examples of authorization rules are described elsewhere throughout the disclosure.

The social pool system 1426 may configure data pools received from internet-based sources, such as, crowdsourcing, social media applications, reviews, comments, IoT, etc. The social data pool system 1136 may include rules for applying a scoring algorithm to each data file received from an internet-based source. In some implementations, social data pool system 1136 may determine whether a data file is from a trusted source based on a variety of factors, such as but not limited to, IP address of the device used to generate the data, user identification of the data creator, spoofing algorithms, etc. In this implementation, the social data pool system 1136 may prevent a data pool from including data that is untrustworthy or malicious, such as fake data injected by devices into the data pool, bot-generated reviews, comments, social media interactions, enterprise data that contains latent bias, etc. The data pool system 1136 may trigger the data management system 1470 to monitor the data in the social pool system 1426 periodically for untrustworthy/malicious data. In some implementations, the data pool system 1136 may automatically trigger the data management system 1470 to monitor a new data file for untrustworthy/malicious data when the new data file is first injected into the data pool system 1136. The social pool system 1426 may attach the monitoring rules to any portion of data it provides to pool construction system 1460 for generation of a data pool to be shared with other EAL systems.

The local pool system 1430 allows an entity to configure data pools from a fixed data repository stored only within a datastore of the EAL 1000 (or within the combination of the EAL 1000 and the enterprise 900). The local pool system 1430 may monitor the local data store on a periodic basis for any new data files/instances stored in the data store. In some implementations, the local pool system 1430 may continuously monitor the local data store for updates. The local pool system 1430 may associate enterprise level access rules that are specific to sharing data located in the local datastore. The rules may specify entities of the enterprise that may access the data within the datastore, the access capabilities (such as read, write, aggregate into a report, delete, etc.) for different entities, compliance requirements, regulatory requirements, etc. Newly received data files/instances may be vetted and/or scored using the scoring engine prior to being added to a data pool by pool construction system 1460 in order to respond to a data request.

The temporal pool system 1434 may be configured to interact with the market participants 910 (and the ecosystem(s) in which they interact) to gather data to respond to the request in full. For example, the temporal pool system 1434 may be integrated or associated with one or more of the marketplaces 922 such that the EAL 1000 functions as its own market participant on behalf of the enterprise 900. By being associated with potentially numerous marketplaces (e.g., marketplaces that correspond to the type or nature of the enterprise assets), the temporal pool system 1434 can perform complex or multi-stage data transactions with enterprise assets (e.g., in a series or sequence of timed stages, simultaneously in a set of parallel transactions, or a combination of both).

The analysis system 1450 may determine that a portion of data required to respond to a data request is not present in the data pool library 1410 and, in response, it may trigger temporal pool system 1434 to collect, in real time, resources/data files from third-party market participants 910. The temporal pool system 1434 may determine a data file required to respond to the quest and the third-party market participant that may be able to provide access to that data file. The temporal pool system 1434 may determine a sequence of data transactions to receive the required data file. In some instances, the temporal pool system 1434 may determine that multiple data files from multiple market participants are required to respond to the data request and generate a sequence of data transactions including sequential tasks, parallel tasks, and/or combination thereof to be performed to collect the required data files.

In an example of a sequence generated by the temporal pool system 1434, in response to a request for an auto loan execution, the analysis system 1450 may determine that a data pool to respond to the request requires data from third-party market place participants 910. The analysis system 1450 may trigger the temporal pool system 1434 to collect the requisite data files from the third-party marketplace participants 910. The temporal pool system 1434 may determine that the requisite data files may be requested from a financial institution, an auto dealership, and the loan requestor. For example, the temporal pool system 1434 may request an initial set of information from a loan requester using a loan requester device (e.g., user device, kiosk, web-based user interface, etc.). The information requested can include name, salary, car model, financial institution of the loan requester, etc. Contingent on receiving the information from the loan requester device, the temporal pool system 1434 may send a request for an auto loan to the auto dealer selling the automobile. The request may include a request for information regarding financing the automobile and the initial set of information. The auto dealer may be allowed to access the information and add additional data regarding the automobile, and the loan requester's purchase and payment history, financial entities used for previous purchases, etc. to the data. The temporal pool system 1434 may also include in a request an instruction for the auto dealer to provide financial entity data for executing the data loan. The auto dealer may include another configured EAL system that may then send the information for the auto loan (e.g., loan amount, loan requester information, purchase history, etc.) to a financial entity, which may add additional data to the collected data pool such as previous loan history, other collateral, credit score, etc., one or more of which may be collected from other entities. In some implementations, the temporal pool system 1434 may instruct the auto dealer and in turn the financial entity to encrypt, for example based on compliance requirement(s) of the EAL 1000, a portion of the loan requestor's personal identification information prior to sending the collected data pool to one or more bidding entities to bid for the auto loan. The bidding entities may each provide a data file including bid information to the financial entity. The financial entity may determine a winning bid and provide the bid information as a data file to the auto dealer for executing the auto loan. The auto dealer may then provide the data files from the financial entity along with the winning bid to the temporal pool system 1434. The temporal pool system 1434 may decrypt any encrypted data portions prior to sending the data files to pool construction system 1460 for generating the data pool. Each of the auto dealer, the financial entity, and the bidding entities in the above example may refer to respective configured EAL systems rather than personnel at the enterprise/entity. However, each EAL system may assign the corresponding task to a sub-entity or specific personnel to complete, according to their respective defined or dynamic workflows.

In an example of a multi-stage transaction, the temporal pool system 1434 may perform a sequence of data transactions. For example, the sequence of transactions may be for the purpose of acquiring or accessing a resource from another source (e.g., one of the sellers 914). For instance, the data request requires data file A. However, the data pool library 1410 and/or portions thereof may not have any data files that are directly exchangeable for data file A. Therefore, the temporal pool system 1434 may be configured to recognize how to acquire one or more data files that are exchangeable for data file A using the available digital files of the enterprise 900. To illustrate, the enterprise 900 may have data files B and C. To acquire data file A, the temporal pool system 1434 identifies that data file D is directly exchangeable for data file A. In this example, the temporal pool system 1434 may perform transactions with data files B and C data to obtain file D in order to finally acquire data file A. For instance, the temporal pool system 1434 exchanges data file B with a first asset source for data file E and then is able to exchange both data file B and C for data file D from a second asset source. With the acquisition of data file D, the temporal pool system 1434 exchanges data file D with a third asset source for data file A. Without the temporal pool system 1434, acquiring data file A may be difficult because it demands access to multiple sources (e.g., across multiple marketplaces) and mapping how resources associated with those sources can be leveraged to obtain a target resource. Yet with the temporal pool system 1434 that has access to multiple marketplaces 922 and market participants 910, the temporal pool system 1434 can configure and/or execute a transaction sequence or route that maps how to obtain the target data file (e.g., data file A). This may occur regardless of relationship between marketplaces 922 and/or market participants 910 such that the temporal pool system 1434 may leverage disparate and independent markets to perform a transaction for a target data file in real time. In other words, data file E may be offered or available in a marketplace 922 that is a different and distinct marketplace from the marketplace 922 that offers the target data file, data file A. Real time simply means that the markets are accessed at the time of the transaction rather than in a batch at some periodic interval, such as hourly or nightly. Real time also generally means that a person or process is waiting on the result of the real-time action, rather than initiating the action and expecting the action would be completed at some point in the future. In embodiments, elements of a multi-stage sequence may be conditional, such that a contingent condition must be satisfied in order for a later stage to commence after completion of a prior stage. Conditions may include ones based on pricing, timing, and other parameters.

At each level, a current entity's EAL system may decide to outsource a portion of its requested information to other entities (e.g., subcontractors) while meeting access requirements for each layer of requesting entities and protecting appropriate fields of data (e.g., PII, pricing, etc.) from other entities via encryption. The temporal pool system 1434 may determine the order in which entities get access to the data collection such that the step in the sequence that includes interaction with sensitive data is towards the end of the sequence.

In some example implementations, the sequence may be generated in real time in response to a request as different entities respond to requests for information at each level. An entity asked for a data via the sequence may send additional request to additional entities for to answer a portion(s) of its information request and apply its own compliance rules to the request in addition to the requirements flowed down from the temporal pool system 1434.

In some implementations, the temporal pool system 1434 may be configured to delete the data files once the request has been executed. In other implementations, the temporal pool system 1434 may remove data files from the data pool library 1410 that were generated by the temporal pool system 1434 on a periodic basis.

The generative pool system 1422 may use generative artificial intelligence, such as a large language model, to generate some or all data in a data pool. This generated data may be combined with other data depending on the structure dictated by the pool construction system 1460. In embodiments, the generative pool system 1422 is capable of learning from prior instances of data to generate new and unique data instances. To have this learning capability, the generative pool system 1422 may include a set of learning models that identify data and relationships between data, such as training data set consisting of historical training data (which, in embodiments, may be augmented by generated or simulated training data). Models may include financial, economic, econometric, and other models described herein or in the documents incorporated by reference herein. Learning may use an expert system, decision tree, rule-based workflow, directed acyclic workflow, iterative (e.g., looping) workflow, or other transaction model. Some examples of learning models include supervised learning models, unsupervised learning models, semi-supervised learning models, deep learning models, regression models, decision tree models, random forest or ensemble models, etc. Learning models may use neural networks (e.g., feedback and/or feedforward neural networks, convolutional neural networks, recurrent neural networks, gated recurrent neural networks, long short-term memory networks, or other neural networks described in this disclosure or in the documents incorporated herein by reference). Learning may be based on outcomes (e.g., financial yield and other metrics of enterprise performance), on supervisory feedback (e.g., from a set of supervisors, such as human experts and/or supervisory intelligent agents), or on a combination.

In some examples, the learning models may include similar features and/or may be configured to carry out similar operations as one or more other machine learning modules described herein. In some implementations, the generative pool system 1422 may use learning models to predict future data based on historical data. For example, the generative pool system 1422 may generate additional data instance indicating a loan requester's potential to pay back a requested loan based on historical payment data and income data for the loan requester. The pool construction system 1460 uses the predicted/generated data as additional data in the data pool for responding to a request.

The data management system 1470 of the data pool system 1136 may manage the data in stored and/or generated data pools. In an example, the data management system 1470 may be configured to monitor an open data pool that aggregates data used in machine learning applications. In this example, the open pool system 1414 may include a set of data monitoring rules to be used by the pool construction system 1460 to monitor the data pool for malicious or unreliable data sources (e.g., devices potentially injecting fake data into the data pool, bot-generated reviews, comments, social media interactions, enterprise data that contains latent bias, or the like). In example embodiments, the data monitoring rules may include a data sampling task, a data scoring task, and a resolution task. In embodiments, the data monitoring rules instruct the data processing system to sample a data set periodically or upon detection of a triggering event, such as a new, unvetted, or recently inactive data source providing data to the data pool, detecting anomalous data reporting patterns (e.g., too many reporting instances received over a particular period of time or from a particular location or IP address), a request from a human user, or the like. The data monitoring workflow may define a manner by which the data is sampled. For example, if the data being monitored is sensor or reporting data being provided by IoT devices, the data monitoring rules may instruct the data processing system to sample each instance provided by a particular IoT device or set of IoT devices (e.g., devices providing the same type of data, devices that are using the same IP address, or devices in the same facility and/or IoT network) over a period of time or multiple periods of time (e.g., recently collected data and data collected weeks, months, or years ago). In another example, if the data being monitored is crowd-sourced data provided by human commenters (e.g., reviews, reports, surveys, or the like), the data monitoring workflow may instruct the data processing system to sample data from a particular commenter, a random group of commenters, a specific group of commenters, or all commenters. A data monitoring workflow may define additional or alternative data sampling tasks. In some embodiments, the scoring system may be provided the data sampled during the data collection task to initiate a data scoring task.

In an example of a medical device enterprise, in response to a request for pricing to manufacture a medical device, the workflow system 1140 may determine that a workflow exists that includes, as a task, generating a data request to the data pool system 1136 for data including, for example, target population, target population's access to diagnostic equipment, prices of similar devices, etc. The data pool system 1136 may determine that the data pool library 1410 of the EAL 1000 already has some of the requested data available and add an initial portion of data available in the data pool library 1410 to the request. The data pool system 1136 may then send requests to some of the third-party systems 924 (e.g., additional downstream entities) for the rest of the requested data. An initial one of the third-party systems 924 may also obfuscate or scrub some of the data within the request in such a way that different downstream third-party systems have access to it at different levels based on compliance configurations of the EAL 1000. A downstream third-party system of a manufacturer may be requested to add manufacturing cost data to the data pool for the medical device. In another example, the request may be sent to several bidders to add bids to manufacture the medical device. This information may then be added to the data pool and sent to the EAL 1000 as a completed output of the request. In this way, at each level, the current entity's EAL may decide to outsource a portion of its requested information to other entities (e.g., subcontractors) while meeting access requirements for each layer of requesting entities and protecting appropriate fields of data (e.g., personal identification information, parts pricing, etc.) from other entities via encryption. In various implementations, the contents of the data pool are actually transmitted to each of the other systems (such as other configured EALs) from which data is requested. This may be referred to as a traveling data pool. The contents of a traveling data pool may be protected against unauthorized access by further recipients using encryption. In various implementations, encryption—for a traveling data pool or for other data transmission—may be asymmetric. For example, data intended for the EAL 1000 may be encrypted with a public key of the EAL 1000 so that only the EAL 1000 can then decrypt the information. The public-private key pair may be managed by the credential system 1171.

### Workflow System

In embodiments, the EAL is a software system that facilitates transactions and data exchanges on behalf of respective enterprises and entities thereof. Facilitation of transactions and data exchange on behalf of an enterprise may include monitoring data sources and entities, decision making in connection with transactions, data exchange, and other related functions, and applying governance standards to decisions made on behalf of the enterprise and requests to or by the enterprise.

In embodiments, the EAL may include a workflow system 1140. In some embodiments, the workflow system 1140 provides tools and capabilities for defining, selecting, deploying, and/or managing workflows that are executed on behalf of respective enterprises. A workflow may be a computer-executed and/or computer-facilitated process arranged in a set of tasks that are executed by an EAL on behalf of the enterprise. It is appreciated that workflows may be linear (such as involving an invariant sequence of steps), contingent (such as following a decision tree through a series of decision points that depend on inputs, such as defined by a directed, acyclic graph), looping/iterative (such as where steps are repeated until a threshold, goal or other conclusion is met), or a combination of the above. In embodiments, workflows may include default workflows, custom workflows configured by the enterprise into an EAL, and/or learned workflows that are learned by the EAL on behalf of the enterprise (e.g., via robotic process automation of tasks performed by enterprise users) and may be deployed to perform any number of scenarios. Workflows may be workflows that are provided by the EAL to support default core functionality of enterprise EAL configurations, domain-specific workflows available as add-on features (e.g., transaction-specific workflows, data monitoring-specific workflows, data sharing-specific workflows, industry-specific workflows, and/or the like), or custom workflows defined and implemented using inherent EAL configuration capabilities. To create, manage, and implement workflow processes, the workflow system 1140 may include a workflow definition system 1142, a workflow library system 1144, a workflow optimization system 1146, and a workflow management system 1148.

Custom workflows may refer to workflows that are configured by or on behalf of an enterprise to extend or enhance a capability or function of the EAL to suit the needs of the enterprise. In embodiments, custom workflows may be customized by the enterprise from existing workflows of the EAL (e.g., by defining one or more aspects of an existing EAL workflow, such as defining specific data sources, digital wallets, models, applications, users, or the like that are implicated by the workflow) and/or may be provided by the enterprise (e.g., as a hard-coded module that is added to the EAL deployment of an enterprise or entity thereof). In embodiments, learned workflows are workflows that are learned by the EAL as enterprise users interact with the EAL. In embodiments, learned workflows can be learned in a supervised or semi-supervised manner. It is appreciated that learned workflows that are learned by the EAL at the direction of an enterprise may be considered customer workflows as well.

In embodiments, the workflow system 1140 may integrate with other systems (e.g., other EAL systems, EAL clients, third party services, and/or other enterprise resources) using APIs (e.g., via the interface system 1110) and/or via other software interfaces. In embodiments, the workflow system 1140 may include a workflow definition system, workflow libraries, a workflow management system, and/or a workflow optimization system. In embodiments, the workflow definition system is configured to define workflows involved with any number of EAL processes. In some embodiments, the workflow definition system may include a set of tools that allow an enterprise to configure, define, and deploy workflows. In some embodiments, the workflow definition system provides GUIs that assist a user (e.g., an enterprise user) in selecting existing default workflows and/or defining custom workflows. In the case of selecting default workflows, the workflow definition system may allow authorized users to select from a menu of available workflows that can be used to perform respective tasks. In some scenarios, the authorized user may have to provide enterprise-specific information to parameterize a selected workflow. For example, if a default workflow includes a data collection task, the user may provide information used to access a particular data source (e.g., API address, network address, access credentials, and/or the like) in furtherance of the data collection task. In another example, if a default workflow includes a transaction step that is executed from an enterprise wallet, the user may provide information used to process transactions from the wallet (e.g., wallet address (if a Web3.0 wallet), private keys or passwords, transaction limits, transaction permissions, and/or the like).

In embodiments, the workflow definition system receives workflow configurations from a user and generates executable workflows based thereon. In some of these embodiments, the workflow definition system includes a workflow builder that provides an interface where users can build workflows based on pre-defined or configured business rules and processes, transaction models, or the like. In some embodiments, the workflow builder may include a GUI that allows users to configure new workflows. In configuring a new workflow, a user may use the GUI to define name of the new workflow, when the new workflow is executed and/or a set of one or more conditions that trigger the new workflow, a set of tasks that are performed by the new workflow, decision points that trigger respective tasks within the new workflow, data sources that are implicated by defined tasks and/or decision points, data repositories that are written as part of a respective task (e.g., data pools, databases, file paths, and/or the like), files or other data that is used in connection with a particular task (e.g., text that is sent to a recipient of an automated email or text message, a pdf file that is sent to a customer at the completion of a workflow, forms that are sent to counter parties, and/or other data that may be used in completion of a task), users or roles of users that are implicated by the workflow (e.g., to whom a notification is sent, to whom a message is sent, a user that is responsible for approving a task or reviewing a task, etc.), and/or the like. In embodiments, the workflow definition system may provide a visual workflow definition environment where users can create functional diagrams of workflows that are converted into executable workflows. Additionally or alternatively, a user may configure an executable workflow in a different environment and may upload the configured workflow to the workflow definition system. Furthermore, in some embodiments, a user may test workflows using the digital twin system 1190. For instance, the digital twin system may simulate various scenarios that implicate a given workflow and may execute given workflow with respect to the simulated various scenarios. As the workflow is executed, the user may be provided with the results of the given workflow in response to the simulated scenarios. Furthermore, the user may provide input into the various scenarios, so as to test the workflow in scenarios that are relevant to the enterprise. In this way, the user may fine tune, adjust, and/or otherwise optimize the given workflow ahead of deploying the workflow.

In some embodiments, the workflow definition system may be configured to generate workflows using a generative AI system. In some of these examples, an LLM may be trained on existing workflows (which may be specific to the enterprise, default workflows, and/or a pool of shared workflows from different enterprises). In some examples, the workflows used to train the LLM may include a name or description which is used as a label of the workflow. Optionally, rules and/or actions defined in the workflows may also be provided with labels. In some embodiments, the workflow definition system may provide an interactive interface that allows a user to provide instruction to the workflow definition system regarding a new workflow and the workflow definition system provides the instruction to the generative content system. For example, a user may request that the workflow definition system propose a new workflow for approving and paying in-bound invoices for a particular business unit. In this example, the workflow definition system may provide the request to the LLM that was trained on the workflows, as well as any other suitable input for defining the request (e.g., roles or individuals within the business unit that can approve invoices, an org chart, enterprise rules for invoice processing, and/or the like). In response, the LLM may output a proposed workflow that includes example tasks such as vetting the invoice (e.g., matching the invoice to a work order), obtaining approval from a designated employee within the business unit by providing the invoice to a designated along with any information used to vet the invoice, executing the transaction from a specific enterprise wallet or account in response to obtaining the approval, and recording the payment with any supporting documentation in a specified data repository. This example workflow may include conditional logic, such as conditional logic that triggers the approval task in response to successfully vetting the invoice and/or conditional logic that triggers the payment execution task in response to obtaining the approval. In this example, the workflow may include contingent tasks as well, such as notifying the designated employee if the invoice cannot be vetted automatically or requesting a reason for denying payment if the invoice is vetted. In embodiments, a user may approve a proposed workflow or may provide feedback relating to the proposed workflow, such as adding, removing, refining, or adjusting certain tasks within the workflow. For example, in this example, the user may refine the vetting task by providing additional criteria for vetting an invoice (e.g., must comply with certain invoicing requirements) and/or may add another task that triggers a notification being sent to another department.

In some embodiments, the workflow definition system may interface with the generative content system to automate workflows that are currently being done manually on behalf of an enterprise. In these embodiments, the workflow definition system may allow a user (e.g., a manager) to designate one or more employees to be monitored while performing a manual task. In this example, the workstation (e.g., desktop or laptop computer) of the designated users may be monitored when performing the manual task. The workflow definition system may collect monitoring data (e.g., which applications the user interacted with, what types of documents were created, opened, written to by the user, and/or other suitable monitoring data). After sufficient monitoring data has been collected, the workflow definition system may provide the monitoring data to the LLM, which outputs a proposed workflow. As discussed above, the requesting user may provide feedback relating to the workflow, such as removing, refining, or adjusting certain tasks within the workflow. For instance, in response to the proposed workflow having a data collection task, the user may refine a task by specifying certain data sources to be pulled from during the data collection task (e.g., a specific data pool, specific data databases, a particular credit agency, a particular API, a specific 3rd party data service, certain news feeds, certain blockchain oracles, or the like); the types of data sources that can report data (e.g., certain IoT networks, only registered app users, devices or application usage of enterprise users or certain enterprise users, etc.); and certain governance applied to the data collection task (e.g., encryption standards, privacy standards, internal standards, etc.). In some scenarios, the workflow definition system may explicitly request that the user provide such refinements to a task (e.g., data collection task). Alternatively, the workflow definition system may receive a user response that provides the refinements to the proposed workflow definition. In response, the workflow definition system may provide the input to feedback to the LLM, which then updates the proposed workflow definition.

In embodiments, the workflow system stores executable workflows in a workflow library. In embodiments, the workflow library stores the workflows that are executed by the EAL for an instance of the EAL.

The workflow management system may execute workflows defined in the workflow library. In embodiments, the workflow management includes a workflow engine that monitors various event streams and/or states of the EAL to determine if a workflow is triggered. In some of these embodiments, the workflow engine may deploy listening threads that monitor respective components of an EAL instance and/or external enterprise resources for specific events or states, such that when a specific event or state is detected the workflow engine may trigger one or more workflows corresponding to the detected event or state. For example, a first listening thread may monitor the transaction system for certain types of transaction requests. If such a transaction request is detected, the workflow engine may deploy a transaction workflow corresponding to the detected transaction request, whereby the transaction workflow may be configured to ensure a set of conditions are met before the transaction system executes the requested transaction. In another example, a second listening thread may monitor the intelligence system for specific types of predictions made by intelligence system. If such a prediction is made by the intelligence system, the workflow engine may deploy an outcome monitoring workflow that collects outcome data relating to the prediction that is provided as feedback to the model that was used to automate a decision that was made on behalf of the enterprise. In some examples, the outcome monitoring workflow may automatically solicit feedback from a human user relating to the outcome (e.g., was the outcome of the prediction satisfactory to the enterprise), whereby the user's feedback is provided as the outcome data. Additionally or alternatively, an outcome monitoring workflow may monitor one or more data sources for outcome data relating to the prediction. For example, if the intelligence service predicted a forward market price for a resource (e.g., a compute resource, a networking resource, an energy resource, or the like), the outcome monitoring thread may monitor one or more resource markets for the price of the resource on a particular day or over a particular time period. In this example, the price of the resource and the set of features that were used to make the prediction can be provided as feedback data to the model that predicted the price of the resource. In another example, a third example listening thread may monitor access requests by external devices attempting to access (e.g., read or write) a particular data pool maintained by the EAL. In response to detecting the access request, the workflow engine may deploy a data pool workflow. Depending on the type of data pool and the type of access requested, the workflow engine may deploy a data pool workflow corresponding to the access request. For example, an example data pool workflow may determine whether an entity (e.g., user, third-party enterprise, or the like) associated with the device has requisite permissions to access the data pool. If the entity has access, the example data pool workflow may grant the device access to the data pool. If the entity does not have the requisite permissions, the data pool workflow may initiate a set of tasks to determine whether to grant access to the requesting device (e.g., seeking approval from an enterprise user that oversees the data pool, obtaining a risk score associated with the entity and/or device that requested access, sending access requests forms to the requesting user/device, or the like). Upon executing the set of tasks to determine whether to grant access, the data pool workflow may include conditional logic that determines whether to grant the requesting device access, such that the device is approved or denied access depending on the outcome of the set of tasks. It is appreciated that the foregoing are examples of listening threads and workflows that may be triggered by the listening threads and that any number of workflows and listening threads may be deployed by a workflow management system of an EAL. Furthermore, it is appreciated that in some embodiments, the workflow system may be configured to deploy multiple alternate workflows in connection with certain scenarios, whereby the workflow system monitors respective outcomes of each alternate workflow for the scenario and provides the outcomes as feedback to the intelligence system. In these example embodiments, the intelligence system may use this feedback data to optimize the selection of workflows for certain scenarios.

In embodiments, the workflow engine may trigger certain workflows in response to detecting a state of another workflow. For example, a specific scoring workflow may be triggered when another workflow requires a certain type of score to proceed to a “next” stage of the workflow. For instance, an example banking workflow may be configured to facilitate a lending transaction involving a new customer. In this example, the banking workflow may include a KYC stage that requires a KYC score to be determined for the new customer before progressing to a next stage of the workflow. In this example, the example banking workflow may trigger a KYC workflow. In response, the workflow engine may initiate a KYC workflow that is executed with respect to the new customer. In this example, the KYC workflow may include requesting particular types of data from the user (e.g., email address, phone number, social security number, photo of state ID, and/or the like) and then collecting data from one or more external data sources before requesting a KYC score relating to the user from the scoring system. In example implementations, the banking workflow may then determine whether to proceed with the lending transaction based on the KYC score.

In some examples, data monitoring workflows may be deployed by an EAL to monitor data sources, data sets, or individual instances of data to identify potentially malicious data (e.g., data sources part of fake data injection schemes, intentionally misleading data sets, or instances of fake data), unreliable data (e.g., unvetted data sources, data sets containing bot-generated content, instance of data from an anonymous source), and/or biased data (e.g., data sets having latent bias). Data monitoring workflows can be deployed to support a number of different EAL applications and/or workflows. Example EAL applications that may integrate data monitoring workflows may include payment automation applications (e.g., monitoring data used to automatically trigger transactions, vetting crowd-sourced data before issuing reward payments, monitoring IoT data used in connection with transactions, and/or the like); intelligence applications (e.g., data monitoring workflows that monitor; data being used to train models; data being input to those models; data being provided as outcome or other feedback data; and/or the like); data pool applications; blockchain applications (e.g., monitoring data sources that report to blockchain oracles); and the like.

In an example of a data monitoring workflow, a data monitoring workflow may be configured to monitor a data pool that aggregates data used in machine learning applications. In this example, the data pool may be an open data pool, such that any number of enterprises, users, devices, and/or digital agents may contribute specific type(s) of data to the data pool. In this example, a data monitoring workflow may be configured to monitor the data pool for malicious or unreliable data sources (e.g., devices potentially injecting fake data into the data pool, bot-generated reviews, comments, social media interactions, enterprise data that contains latent bias, or the like). In example embodiments, the data monitoring workflow may include a data sampling task, a data scoring task, and a resolution task. In embodiments, the data monitoring workflow may instruct the data processing system to sample a data set periodically or upon detection of a triggering event, such as a new, unvetted, or recently inactive data source providing data to the data pool, detecting anomalous data reporting patterns (e.g., too many reporting instances received over a particular period of time or from a particular location or IP address), a request from a human user, or the like. The data monitoring workflow may define a manner by which the data is sampled. For example, if the data being monitored is sensor or reporting data being provided by IoT devices, the data monitoring workflow may instruct the data processing system to sample each instance provided by a particular IoT device or set of IoT devices (e.g., devices providing the same type of data, devices that are using the same IP address, or devices in the same facility and/or IoT network) over a period of time or multiple periods of time (e.g., recently collected data and data collected weeks, months, or years ago). In another example, if the data being monitored is crowd-sourced data provided by human commentors (e.g., reviews, reports, surveys, or the like), the data monitoring workflow may instruct the data processing system to sample data from a particular commentor, a random group of commentors, a specific group of commentors, or all commentors. It is appreciated that a data monitoring workflow may define additional or alternative data sampling tasks. In some embodiments, the scoring system may be provided the data sampled during the data collection task to initiate a data scoring task.

As mentioned, example data monitoring workflows may include a data scoring task. In examples, a data scoring task may refer to the generation of one or more data scores based on the sampled data. Data scores may be determined with respect to a respective data source (e.g., a third party data provider, a user, a database, an application, a device, or the like) or for an instance of data (e.g., a sensor reading, an audio, image, or video file, a geolocation of a user/device, a review, a comment, a rating, a transaction request, a search query, or the like). In some scenarios, a data score may be indicative of a degree of reliability of a data source or an instance of data therefrom (which may be referred to as “reliability scores”). For example, data sources having relatively low reliability scores (e.g., scores falling below a certain threshold) may indicate that the data source may provide data containing inaccuracies, misrepresentations, and/or latent bias. Similarly, an instance of data having a low reliability score may indicate that the particular instance of data may be inaccurate or fake (e.g., bot-generated data, misleading human generated data, and/or the like). In some scenarios, a data score may be indicative of a risk associated with relying on the data source or individual data instances (which may be referred to as “risk scores”). For example, a data source having a high-risk score may indicate that the data source (or a group of data sources) is/are likely providing malicious data (e.g., fake data injection that is used to influence the training of an AI model or a decision by an AI-model). In example embodiments, a respective data monitoring workflow may instruct the scoring system to generate a data score for a data source, a data set, or for an instance of data. Different examples of data and data source scoring are described in greater detail elsewhere in the disclosure.

As mentioned, some example data monitoring workflows may include a resolution task. In embodiments, a resolution task may include one or more conditional actions that are performed in response to the scoring task. The conditional logic that triggers respective actions and the type of actions will vary depending on the purpose of the data monitoring workflow. For example, if a data monitoring workflow is deployed to prevent malicious data sources are adding data to a certain data pool, the data monitoring workflow may instruct a data pool management system to permit a new data source to participate in the data pool if the data score (e.g., risk score) of the data source is below a threshold. If the data score is above the threshold, the data monitoring workflow may initiate one or more risk prevention actions. Examples of risk prevention actions in this context may include denying the data source write permission to the data pool, sending a notification to a human user that may determine whether or not to grant the data source write permission to the data pool, and/or initiating a set of tasks that may allow an entity controlling the data source to rectify any issues that resulted in the data source being denied write access. It is appreciated that the foregoing type of data monitoring workflows may be deployed in a number of different scenarios, such as the prevention of IoT devices, bots, or the like from writing fake data to a data pool.

In other example embodiments, example data monitoring workflows may be deployed to monitor crowd-source reports generated by reporting users, whereby the resolution tasks include a determination as to whether to rely on respective crowd-sourced reports based on the risk score. For example, an AI service provided by the intelligence system may be configured to receive crowd-sourced reports provided by reporting users to classify a current condition of a collateral item, which is used in part to predict the value of the collateral item. In these examples, the predicted value may be used to determine an interest rate applied to a financial instrument secured by the collateral item and/or as a basis for requiring additional or substitute collateral to securitize the financial instrument. In this example, when a crowd-sourced report is submitted by a reporting user, the instance of the crowd-sourced report may be scored by the scoring system to determine a risk score for the report. If the risk score is above a threshold (e.g., the report is predicted to be intentionally misleading), the resolution task of an example data monitoring workflow may include preventing the crowd-sourced report from being used as input to the AI service, flagging the reporting user as an untrustworthy reporter, and/or providing a notification to an enterprise user overseeing the financial instrument. If the risk score is below the threshold, the resolution task of the data monitoring workflow may include allowing the report to be submitted to the AI service, recording the crowd-sourced report (e.g., in an enterprise data store and/or a blockchain), and/or issuing a reward to the reporting user that provided the report.

In other examples, a data monitoring workflow may be deployed to prevent fake data injections to blockchain oracles. In embodiments, blockchain oracles are software services that provide off-chain data to smart contracts executing on a respective blockchain. In many scenarios, these smart contracts may include conditional logic that may trigger a transfer of funds (e.g., cryptocurrency, NFTs, digital fiat currency, or the like) upon the detection of a condition, whereby the conditional logic is triggered at least partially by the data provided from an oracle. As such, blockchain oracles present a potential vulnerability for smart contracts and blockchain-based ecosystems. According to some embodiments, data monitoring workflows may be deployed to monitor the data being provided to a blockchain oracle. In these embodiments, data received by an oracle may be provided to a scoring system, which may determine a risk score associated with the data. The data monitoring workflow may then instruct the blockchain oracle to either provide the data (or values derived therefrom) to a respective smart contract or prevent the data from being provided to the smart contract based on the risk score. It is appreciated that the foregoing may be implemented in blockchain oracles that report data that can trigger the settlement of gambling transactions, autopayment transactions, triggering of stock options, and/or the like.

It is appreciated that workflows may be deployed in any number of scenarios. Examples of scenarios where workflows may be deployed by an EAL include permission workflows, access workflows, data collection workflows, data pool workflows, machine learning workflows, artificial intelligence workflows, governance workflows, scoring workflows, transaction workflows, governance workflows, industry or vertical-specific workflows, enterprise-specific workflows, and other suitable workflows. It is appreciated that the example types of workflows provided above may overlap (e.g., a governance workflow may be an industry-specific and/or enterprise-specific workflow). Furthermore, some workflows may trigger one or more other workflows. For example, when a certain type of transaction is executed by the transaction system of an EAL, a transaction workflow corresponding to the type of transaction may define a series of tasks that are performed before the transaction is executed. In this example, the transaction workflow may trigger a scoring workflow that obtains a risk score associated with the transaction and/or a counterparty. In another example, as part of a data pool workflow that establishes a data pool that is accessible by third-parties, the data processing workflow may trigger a governance workflow that ensures that any enterprise data being added to the data pool confirms with certain data sharing rules (e.g., obfuscation of sensitive data, complying with privacy rules, scrubbing metadata, and/or the like) and may trigger a scoring workflow that scores each third-party that will access the data pool. Furthermore, all EAL workflows share a common framework for respective EAL functions and scenarios; however, individual workflows deployed with respect to respective EAL instances may vary in complexity from very basic workflow implementations (e.g., configured to execute on a user device or sensor device) to complex workflows with multiple dependencies and/or embedded “sub-workflows” (e.g., configured to execute by a central server system and/or by multiple enterprise devices).

In embodiments, access workflows may define a set of tasks that are performed in response to a device and/or user attempting to access the EAL and/or an enterprise resource (e.g., a data pool, a digital wallet controlled by transaction system, a digital twin maintained by the EAL, an intelligence service of the EAL, and/or the like). In embodiments, the tasks that are performed in an access workflow may depend on the type of access sought. For example, the access system may execute a access workflow in response to a request by a device that is reporting data to the EAL in connection with an intelligence service provided by the EAL. In the example, the access workflow may instruct the access system to determine whether the device is a trusted device (e.g., the MAC address and/or IP address of the device is in a permitted devices list). If the device is not a trusted device, the example access workflow may instruct the access system to initiate one or more scoring tasks to determine whether to grant the device and/or user access the EAL and/or an enterprise resource.

In embodiments, transaction workflows may include transaction compliance workflows that are executed by the transaction system when executing transactions on behalf of an enterprise to ensure that transactions comply with one or more regulatory standards. In some of these embodiments, the transaction system may be configured to access a data pool that maintains current regulatory standards pertaining to a respective type or types of transaction. In these example embodiments, the data pool may be maintained internally by the enterprise or may be a data pool that is accessible by multiple enterprises, whereby the data pool defines a current set of regulatory standards that are applied to one or more types of transactions. In embodiments, the transaction compliance workflow may be triggered periodically (e.g., daily, every hour, every minute, or the like) or in response to an event, such as a transaction request that indicates a transaction to be executed on behalf of the enterprise (this may be in-bound or out-bound). In response, the transaction compliance workflow may instruct the transaction system to access the data pool corresponding to a particular type of transaction to determine whether the data pool has been updated since the last time the workflow was executed. If the data pool has not been updated, a compliance checklist is not updated and in-coming transaction requests are analyzed with respect to the existing compliance checklist. If the data pool has been updated, the transaction compliance workflow may instruct the transaction system to obtain any updated regulatory standards that have been added to the data pool and to update a transaction compliance request based on the updated regulatory standards. This may include re-parameterizing any conditional logic in the compliance checklist with the updated regulatory standards, such that in-coming transaction requests are analyzed with respect to the updated compliance checklist. Examples of regulatory standards that may be maintained in a data pool and subsequently updated in a compliance checklist may be include, but are not limited to: transaction amount limits, transaction reporting requirements, permitted payment methods, permitted payment providers, permitted digital wallets, KYC requirements, enforcement of holding periods, escrow requirements, tax requirements, geographical requirements, security requirements, digital signature requirements, self-imposed requirements, and/or the like.

It is appreciated that more than one compliance checklist may be applied to a particular type of transaction. Furthermore, it is appreciated that regulations enforced by compliance checklists may include government regulations (which may include multiple jurisdictions if the enterprise executes transactions in multiple jurisdictions), industry regulations (e.g., industry or protocol standards), and/or internal/corporate regulations (e.g., self-imposed regulations).

In embodiments, model management workflows may be deployed by the EAL to evaluate and improve models (e.g., machine-learned models, neural networks, LLMs, and/or the like), trained and/or used by the intelligence system 1130. In some examples, a model management module may be executed by a digital agent that monitors one or more models and initiates updating and/or re-training the model(s) based on the monitoring. In an example model management workflow, each time a model provides a prediction (e.g., a classification, a recommendation, a decision, and/or the like) the prediction and any relevant data related to the prediction (collectively referred to as prediction data) may be aggregated in a data lake or a data pool configured for monitoring a respective model. In embodiments, an example model management workflow may instruct the digital agent to collect or otherwise maintain outcome data relating to the model's predictions. The outcome data may be obtained by monitoring one or more data sources for a measured outcome after the prediction or by feeding existing historical data from previous events with known outcomes to the model to obtain a prediction that is compared by the known outcomes.

As new prediction data for a model is aggregated, the model management workflow may instruct the digital agent overseeing the model to determine one or more drift values of the model and may determine whether the model has drifted past a threshold limit. A drift value may refer to a measure of deviation of predictions of the model from the expected result. In some embodiments, the drift value may be determined by comparing a prediction and an actual result (e.g., the model predicts a particular event will occur with a high confidence (e.g., 99% confidence) and the event does not happen, the model predicts a value stemming based on a feature vector corresponding to an event and the measured outcome is a different value that is outside of a tolerance limit). Additionally or alternatively, the drift value may be determined by analyzing outcomes stemming from predictions of the model against one or more governance standards (e.g., a model recommends actions that consistently cause in an intended result, but either individually or in the model's recommended actions violate one or more conditions or limits defined in the governance standards applied to the model). If the digital agent determines that the drift value(s) relating to a model have exceeded one or more limits, the example model management workflow may instruct the digital agent to initiate a cluster analysis that evaluates the labels used to train the model and/or labels generated for net-new data (e.g., feature vectors provided to the model and/or the respective predictions by the model for those feature vectors). In an example model management workflow may instruct the digital agent to evaluate a model for bias based on the cluster analysis and, if bias is detected, to create representative samples of the bias. In some embodiments, the model management workflow may instruct the digital agent to take a corrective action and re-train the model. In some embodiments, the corrective action may include oversampling data from one or more of the underrepresented clusters in the training data set. In some embodiments, the oversampling technique may be synthetic minority oversampling technique (SMOTE). In these embodiments, the feature vectors from the underrepresented are used to synthesize similar but not duplicative feature vectors that are then included in the training data set. In embodiments, the digital agent may initiate the re-training of the model and/or training a new model based on the updated training data set. In some of these embodiments, the model management workflow may instruct the digital agent to inform and/or consult with one or more human users (e.g., sending a notification, an email, a direct message, and/or the like). In some of these embodiments, the digital agent may also provide representative samples that illustrate the measured drift and/or biases to the human users, whereby the human users (e.g., data scientists) may be tasked with ensuring that the model's performance with respect to the one or more imposed governance standards that are applied to the model. It is appreciated that model management workflows may be deployed to monitor enterprise-specific models (e.g., models deployed and/or trained by the enterprise in connection with the core business functions of the enterprise) and/or models provided by the EAL (e.g., models provided and deployed as part of EAL implementations). In this way, model management workflows may be deployed to improve the performance of enterprise-specific models and/or to improve the operation of the EAL itself.

### Transaction System

In embodiments, the transaction system 1150 supports and executes digital transactions on behalf of the enterprise and/or entities thereof. Within the context of the transaction systems, the types of digital transactions that may be executed, or otherwise supported by the transaction system 1150 include out-bound payments (e.g., wire transfers, credit card payments, cash transfers, ACH transfers, and/or the like), invoices/payment requests, blockchain transactions (e.g., transfers of cryptocurrency and other blockchain tokens on a blockchain, tokenization of data on a blockchain, and/or any other blockchain action that requires a digital signature). In embodiments, the transaction system 1150 may be configured to control one or more digital wallets of an enterprise (or an entity thereof). In embodiments, the term “digital wallet” (or “wallet”, “wallet application”, or “digital wallet application”) may refer to a software program that executes one or more respective types of transactions using respective credentials, keys, and/or other transaction parameters corresponding to a respective account of the enterprise. It is appreciated that the term “account” can refer to various types of financial accounts, including bank accounts, credit accounts, accounts on payment platforms, blockchain accounts, and/or the like. Depending on the type of account, the manner by which the account is addressed will vary. For instance, accounts on certain blockchains may be referenced by respective public address/public keys associated with the respective accounts on those blockchains. A third-party platform account may be referenced or accessed by usernames or email addresses of the enterprise or entities associated with the enterprise (e.g., employees of an enterprise) and/or other suitable identifier.

In embodiments, the transaction system 1150 may execute various transactions workflows that include various types of tasks, such as access tasks, scoring tasks, access tasks, permissions tasks, governance tasks, key management tasks, digital signature tasks, tokenization tasks, recordation tasks, and/or the like. The specific configurations and parameterizations of different types of transactions workflows and the respective types of tasks of the transaction workflows may vary for different types of transactions, different EAL implementations (e.g., implementations of different enterprises or entities thereof) and/or types of enterprises (e.g., financial enterprises, banking enterprises, manufacturing enterprises, service providers, government enterprises, and/or the like) and transaction type (e.g., data tokenization, data transactions, blockchain transactions, payments, invoicing, reward distribution, securities transactions, and/or the like).

In embodiments, the digital wallets of an enterprise may include blockchain digital wallets that are configured to communicate with and execute blockchain transactions (e.g., a cryptocurrency transaction, a NFT transfer, a tokenization transaction, or the like) on one or more blockchain networks. In embodiments, a blockchain wallet is associated with one or more blockchain addresses on a blockchain (blockchain addresses may also be referred to as “blockchain accounts”). In embodiments, a blockchain wallet may refer to a digital wallet that is configured to digitally sign blockchain transactions blockchain transactions on behalf of the enterprise using a private key associated with a blockchain account of the enterprise in accordance with the protocol of the particular blockchain. In doing so, the digital wallet stores or otherwise maintains a private key associated with the blockchain account, such that blockchain wallet digitally signs blockchain transactions using the private key and the nodes of blockchain network verify and effectuate the transaction by verifying the digital signature using a public key of the blockchain account. It is noted that in some protocols, the public key of a blockchain account may be the blockchain address of the blockchain account.

It is appreciated that a digital wallet (third-party or the transaction system 1150) may be configured to perform both blockchain transactions and fiat currency transactions. Such digital wallets may be referred to as “hybrid wallets”.

In embodiments, the transaction system 1150 can serve as a storage system while also including increased functionality that allows it to interface with other systems (e.g., third-party applications and EAL systems). To support digital transactions, in some implementations, the transaction system 1150 is configured to hold or to contain (e.g., store) digital assets, such as enterprise digital assets, such as digital objects, tokens, or the like. In some examples, the transaction system 1150 functions as an index for digital assets such that the transaction system 1150 represents the status of digital assets without having to store them. When used as an index, the transaction system 1150 may point to or reference the actual storage location of the digital asset (such as a bank account, stock exchange, custodial account, blockchain, distributed database, or the like). For instance, a digital asset that is available for exchange in the transaction system 1150 may be actually stored in data storage of the data services system 1120. Here, the transaction system 1150 may include some indication that the digital asset is available for exchange (e.g., an asset availability tag) along with information that the digital asset is stored in the data services system 1120 (e.g., a storage location identifier) so that the digital asset can be retrieved from the data services system 1120 to perform a transaction.

In some embodiments, the transaction system 1150 also maintains digitized identity data of the enterprise or entities thereof. For instance, the transaction system 1150 may hold and/or reference identity data such as banking numbers, credit card numbers, coupons, tickets, credentials, tokens, tokenized assets, vital records, biometric data, passwords, private keys, licenses, etc. For the enterprise 900, this identity data may refer to identity information about the enterprise 900 or information about one or more entities associated with the enterprise 900 that is/are responsible for or can access a respective digital asset. For instance, the identity data associated with an asset that is available in the transaction system 1150 identifies information such as the employee at the enterprise 900 who made the digital asset available (e.g., an employee number or an employee name) or a department or business unit that the digital asset originated from at the enterprise 900 or who is responsible for the digital asset. Identity data may be associated with an identity management system or service, an identity-as-a-service platform, or the like. In some embodiments, identity data for the enterprise may be managed based on a structure that represents a set of roles, such as an organizational chart, such as represented by a graph structure (optionally stored in a graph database) pursuant to which some roles are governed by other roles. For example, access layer access policies and other capabilities may be based on the position of a role within a hierarchy, such that access and other capabilities for a role that reports to another role are governed by the entity that holds supervisory role. Role-based governance of workflows allows access policies to be implemented based on the enterprise structure and rapidly updated in cases where the structure changes (e.g., a reorganization) or where individuals change roles.

In embodiments, the transaction system 1150 is configured to generate, manage various date code information for a digital asset. For instance, a digital asset may include a date code that defines the time at which the digital asset was created, a set of date codes for a window of availability for the digital asset, a date code that designates when the digital asset was made available or added to the wallet, etc.

In embodiments, the transaction system 1150 includes at least one wallet storage resource (e.g., a partitioned container, a set of files, and/or a set of databases) for digital/electronic information used in connection with certain types of transactions (e.g., blockchain transactions). In this respect, a wallet may be software-based and referred to as a software wallet or physical hardware and referred to as a hardware wallet (e.g., a dedicated hardware storage device or location within a hardware device-a hardware wallet). Digital wallets, to some degree, have been used with cryptographic currency systems (also referred to as cryptocurrency). In such cases, a digital wallet may provide and/or access a digital ledger that includes references to the assets that are associated with the wallet, rather than being the actual holder of the asset. For instance, enterprise digital assets may be actually stored on a private storage system associated and/or controlled by the enterprise 900. Here, if one of these enterprise assets is associated with a wallet (e.g., made available to market participants via a wallet), instead of transferring the digital asset to the wallet during or following the association (e.g., moving the asset to a storage location dedicated to a wallet), the asset may remain in the private storage location while the wallet includes a record (e.g., an entry in a ledger) of the private storage location. In this configuration, the wallet maintains some type of storage address or identifier of the storage location for the asset (e.g., a type of pointer),

In some types of digital transactions (e.g., wallet-based transactions), there does not necessarily need to be any movement of digital assets (e.g., a change of possession to pair with a change of ownership). Rather, the ownership or controlling information associated with a digital asset can change from one owner to another owner using data entry procedures. For instance, when a digital asset is exchanged from a first entity to a second entity, the ownership information associated with the digital asset is changed from the first entity to the second entity. This change may occur by either overwriting the ownership information in data storage (e.g., a database) or by appending data to non-overwriting storage (e.g., adding blocks to a blockchain, such as in a distributed ledger that maintains transaction records that indicate ownership transfers and other transaction details), in each case akin to deed or title recordation in tangible property, where the deed or title registry is a transaction ledger records a new deed event or record at a later time such that a timeline of the deed events can inform someone as to the changes in ownership over time. A blockchain for digital assets can function similarly such that there is a first block at a first time that indicates that the first entity owned the digital asset and then, when the digital asset is digitally “exchanged,” there is a second block generated at a second time later than the first time that indicates that the second entity owns the digital asset. Accordingly, a query for information related to the digital asset (e.g., ownership information) would return two records that indicate a change of ownership from the first entity to the second entity. In this sense, when the word “exchange (d)” is used with respect to a digital asset, it can mean that the ownership or controlling information of a digital asset is modified without necessarily moving the digital asset in any way. While the asset may remain in place, control may pass to the different owner; for example, an asset may subsequently be managed (e.g., transferred) only by the valid owner who possesses the private key that is needed to initiate a transfer. However, it is also still possible that the “exchange” of a digital asset can encompass some form of digital or physical movement, such as changing the physical storage locations for the digital asset, such as by locating the digital asset in a wallet or other storage location where only the owner of the wallet or storage location has the ability to interact with or transfer the asset.

When the transaction system 1150 creates or initializes a wallet, that wallet may be unique from other wallets in that it has its own set of unique digital keys. In some examples, the transaction system 1150 or another system of the EAL 1000 may generate the set of unique keys for the wallet when the wallet is created or configured. These digital keys can allow the functionality of the wallet to act on behalf of a specific entity (e.g., the enterprise or an enterprise entity, or a set of roles within the enterprise) to perform or orchestrate digital transactions. In other words, to execute a digital transaction such as an ownership change, a unique key associated with wallet signs off ownership to the wallet's address that is dictated by another key (e.g., a key that is cryptographically related to the unique key signing off ownership). In this sense, digital keys are able to serve as ownership attestation such that trust, control, and security is present for a digital transaction. These digital keys may be independent (e.g., completely independent) of other digital protocols and can be generated with or without consideration for particular storage schemes (e.g., agnostic to a particular storage structure like a blockchain or designed for a particular storage structure). In some embodiments, digital keys may be managed by a key management platform. Additionally or alternatively, the transaction system 1150 may manage digital keys on behalf a respective enterprise. It is appreciated that keys may be generated in any suitable manner. For instance, digital keys may be randomly generated or may be generated based on one or more parameters, such as identity of users, roles of users, hierarchy of roles, and/or the like.

As an example, with blockchain wallets configured for blockchain transactions (e.g., cryptocurrency transactions, NFT transactions, smart contract transactions, and/or the like), the set of digital keys functions as secure digital codes needed to interact with a blockchain. For example, in the case of fungible cryptocurrency, a blockchain may maintain a ledger of mined tokens and ownership thereof. In these examples, a digital wallet uses one or more keys from the set (e.g., a public key) to locate a balance of cryptocurrency that is associated with the wallet (e.g., to locate the currency with the wallet's address). In embodiments, the transaction system 1150 and/or a third party digital wallet that is controlled by the transaction system 1150 may execute transactions involving cryptocurrency (e.g., transferring cryptocurrency from one blockchain account to another) by digitally signing the transactions with one or more keys from the set. In some embodiments sense, a digital key can function as an account identifier (e.g., a public key may be the address of an account) and/or an identity to authorize the wallet to perform actions on behalf of an enterprise or entity (e.g., a private key of an account is used to digitally sign a transaction and the public key associated with the account is used by one or more blockchain nodes to verify that the transaction was digitally signed using the private key corresponding to the public key).

In some examples, an account of an enterprise or entity is associated with a pair of cryptographic keys as the set of digital keys. In these examples, one key of the pair may be considered a public key while the other key is considered a private key. Here, a public key refers to a cryptographic key (e.g., an alphanumeric string) associated with a particular entity (e.g., a wallet) that is outward facing such that it may be published and shared with other entities to function as a public unique identifier or address for the particular entity. In other words, the public key may be associated with a digital asset to indicate publicly (or to those who can view the digital asset) who or what controls and/or owns the digital asset. In contrast, a private key refers to a cryptographic key (e.g., an alphanumeric string) that is generally associated with the same entity of the public key, but is kept as a secret. Here, instead of an address function like the public key, the private key may be used to generate a digital signature that proves that the entity associated with the key has the authorization to perform a transaction. As such, a digital wallet having access to a private key associated with an account can serve as the controller for performing digital transactions involving an account indicated by or otherwise associated with a corresponding public key.

In embodiments, the public and private key may be linked to each other in that the public key may be generated from the private key. For example, a random number generator (or alphanumeric generator) generates a private key of X length and then, from the private key, a one-way cryptographic function generates the public key. In some implementations, the public key and private key operate in tandem such that the public key provides an address or destination for the private key holder such that a market participant can request authorization of the private key holder to execute a transaction. In some examples, this cooperation is such that the public key assigned to a wallet must match or prove its relation to the private key to authenticate an asset transaction. Here, this matching may be considered a form of verification for the transaction. In these examples, the public key may be able to “match” or exhibit a relation with the private key because the public key has been generated from the private key.

In some configurations, a digital wallet may be configured to utilize a derivative form of the private key (e.g., a one-way hashing function) as a digital signature to authorize a transaction. Since the private key can authorize transactions on behalf of the owner/controller of an account, if a nefarious party obtained the private key, that nefarious party could remove or disassociate all of the assets from the account; thus, stealing those assets. Therefore, the security of the private key for a wallet can be critical to the security of the assets associated with a wallet. For reasons such as this, it may be advantageous to authorize a transaction with a derivation of the private key (e.g., a value derived by a cryptographic function based on the private key, transaction data of a requested transaction, and a cryptographic function) that indicates that the authorizer (e.g., the entity digitally signing a transaction with the form of the private key) has/controls the private key, but that does not reveal the actual private key to another party. In this example, the public key associated with the private key may be used to verify the public key given the derivation of the private key.

In some implementations, securing the authorizing key, such as the private key, depends on the security of the digital wallet itself. This may be the case when management and/or storage of the private key is performed by the digital wallet. For example, the digital wallet stores the set of keys including the private key. When a wallet stores the authorizing key, the transaction system 1150 may use a variety of security techniques to secure the authorizing key. For example, the transaction system 1150 may configure a digital wallet as a custodial wallet or a non-custodial wallet. A custodial wallet generally refers to a wallet service where custody or digital possession of the wallet is outsourced to a third-party service who provides security for the wallet (or keys associated with a wallet). In some examples, to generate a custodial wallet, the transaction system 1150 transfers the one or more keys of the set of keys (e.g., the private key) to the custodian service provider. In some situations, custodial services may offer a greater degree of protection because a custodian service provider may have key security expertise. At the same time, the owner of the wallet (e.g., the enterprise 900) has to trust the custodian with security responsibility. In some configurations, a custodian service provider may be considered the same as or akin to a key management service (KMS).

In some scenarios, the transaction system 1150 and/or one or more of the digital wallets controlled by the transaction system 1150 may include non-custodial wallets. A non-custodial wallet refers to a blockchain wallet configuration where private key management is not outsourced to a custodian service provider. An enterprise may prefer to use non-custodial wallets when, for example, the enterprise lacks trust in a custodial service provider or perhaps foresees there being a risk of censorship (e.g., limiting the type of transactions or transactions generally for some period of time) from a custodian service provider. In some of these embodiments, the transaction system 1150 may provide key management services for keys (e.g., private keys and/or public keys) for associated enterprise accounts. In this way, the transaction system 1150 serves as the custodian of the private keys that are used in connection with transactions involving certain enterprise accounts. In these embodiments, the transaction system 1150 digitally signs blockchain transactions on behalf of the enterprise using a private key associated with a public key/blockchain account of the enterprise.

In addition to a wallet being custodial or non-custodial, a wallet may also be considered a “hot” wallet or a “cold” wallet. A hot wallet is a wallet that is connected to a gateway to perform transactions. For instance, the gateway is a wide area network (WAN) such as the internet and the hot wallet is a wallet that is connected to the internet. Some examples of hot wallets include web-based wallets, mobile wallets, and desktop wallets. Since a hot wallet is hot or online with the ability to perform transactions, a user of a hot wallet is able to directly issue transactions, for example to a blockchain, in a relatively easy fashion. For this reason, it may be preferable to use a hot wallet for keys that are frequently used for transactions or keys that have low risk of loss (e.g., keys used with only a particular threshold value of assets). Unfortunately, with this ease of use, the keys associated with the hot wallet are generally vulnerable to threat by the mere fact that they exist online (e.g., connected to the internet).

On the other hand, a cold wallet refers to a wallet that is kept off-line or disconnected from a gateway to perform transactions. By being disconnected from a gateway (e.g., the internet), the cold wallet minimizes potential vulnerability attacks. A cold wallet may any storage-capable device that is disconnected or offline from marketplace transactions (e.g., not connected to the internet) including a simple sheet of paper with the keys printed on the paper. When using a set of keys for a transaction that is stored in a cold wallet, the user may temporarily connect the cold wallet to the transaction gateway and provide the necessary keys prior to disconnecting the cold wallet from the gateway. Since a cold wallet is capable of being online, in some instances, what defines the cold wallet is that it is generally offline (e.g., offline a majority of the time) and/or offline at the time when a transaction is requested for an asset associated with the wallet.

In some situations, the user does not connect the cold wallet, but rather accesses the offline keys and transfers them manually or by a transfer operation (e.g., cut and paste) for execution of the transaction. In some configurations, the transfer operation copies the keys from a cold wallet to a hot wallet to perform the transaction. In these configurations, the keys transferred to the hot wallet may be assigned a time of life (e.g., a temporary lifespan to consummate the transaction) when transferred or otherwise undergo a removal procedure following the execution of the transaction such that the hot wallet does not retain the keys. In other configurations, a transaction may use a combination of a hot wallet and a cold wallet. For instance, the transaction is signed entirely on the cold wallet while the hot wallet is used to issue/relay the signed transaction (e.g., to the blockchain). Due to the nature of cold wallets, cold wallets may be better suited for keys that met a certain security threshold (e.g., a security clearance or designated authorization level) or for keys that are infrequently used.

In some examples, whether the transaction system 1150 uses a hot wallet or a cold wallet depends on the value of the asset associated (or to be associated) with the wallet. For instance, the enterprise 900 may set a threshold asset value for an individual asset that, if exceeded, must be stored in a secure cold wallet rather than a hot wallet. Similarly, if the asset value is below the threshold asset value, the EAL 1000 may associate the asset with a hot wallet. In some examples, whether the transaction system 1150 uses a hot wallet or a cold wallet depends on the cumulative value of the assets that are to be available for a given wallet. In other words, rather than the threshold asset value being a threshold for the value (e.g., estimated value) of a single asset, the threshold dictates when a hot or cold wallet should be used based on the aggregate value (e.g., estimated value) of the collection of assets that are or will be associated with the wallet. Furthermore, it is appreciated that blockchain wallets controlled by the transaction system 1150 may be any combination of hot/cold and custodial/non-custodial. In particular, blockchain wallets controlled by the transaction system 1150 may be hot custodial wallets, cold custodial wallets, hot non-custodial wallets, and/or cold non-custodial wallets.

In some configurations of the transaction system, a wallet controlled by the transaction system 1150 has a key backup protocol to safeguard keys and to prevent assets from being inaccessible due to lost or mismanaged keys. In some examples, the type of wallet or value of the set of assets associated with the wallet dictates the key backup protocol for the keys associated with the wallet. Some examples of key backup protocols include: (i) storing a copy of the set of keys in a designated private storage location associated with the enterprise 900 (e.g., backup on enterprise storage resources); (ii) having an agent or employee store a copy of the set of keys in a hardware device such as a Universal Serial Bus (USB) or hardware wallet; or (iii) storing a copy of the keys with a key service management (KSM) system (e.g., a third-party provider). As an example, a particular protocol may be associated with a backup level. For instance, a first backup level may be associated with the key backup protocol (i) while a second backup level is associated with the key backup protocol (ii). Therefore, when a backup level for a wallet is satisfied, the key backup protocol associated with the backup level is implemented as the key backup protocol for the wallet. For example, the first backup level is that the estimated value of the set of assets associated with the wallet is greater than X but less than Y. Here, when this is true, the key backup protocol of (i) that has been associated with the first backup level is implemented as the key backup protocol for the wallet. In this situation, the key backup protocol for the wallet is that a copy of the set of keys is stored in a designated private storage location associated with the enterprise 900.

In embodiments, the ability to control or otherwise manage a plurality of digital wallets in a “wallet-of-wallets” configuration may be advantageous to partition or sandbox some enterprise assets from other enterprise assets (e.g., enterprise accounts, digital funds, or other digital assets). In some of these embodiments, the transaction system 1150 may control multiple digital wallets that manage digital assets having respective sets of specific attributes. When a digital asset is received by the transaction system 1150, the transaction system 1150 is configured to determine a set of attributes of the digital asset and to match the determined attributes to one or more of the plurality of wallets. For instance, respective wallets controlled by the transaction system 1150 may be dedicated to respective business units, marketplaces, business fields, transaction types, asset types, countries or regions, and/or the like. Here, in response to receiving a digital asset that includes attributes that correspond to the particular marketplace or business field, the transaction system 1150 associates the digital asset with the wallet that shares or matches those attributes (e.g., exact match or a fuzzy match) and thus associating the digital asset with the wallet that also corresponds to the respective marketplace, business unit, business field, transaction type, and/or asset type.

As an example, the transaction system 1150 receives two digital assets that are designated as available digital assets. Upon receiving each digital asset, the transaction system 1150 determines that the first digital asset has a first set of attributes that define the first digital asset as a corporate bond and the second digital asset has a second set of attributes that define the second digital asset as an insurance policy data set. In this example, the transaction system 1150 determines that the first set of attributes matches or shares the most attributes with attributes defined for a financial asset wallet. Based on this determination, the transaction system 1150 associates the corporate bond with the financial asset wallet. In some implementations, to associate the digital asset with a particular wallet, the transaction system 1150 generates an identifier such as a label or a tag for the digital asset that indicates the wallet that the digital asset has been assigned to. In some examples, by having an associated identifier, digital assets can be stored together regardless of their attributes, but yet also be retrieved or managed based on the identifier.

In embodiments, the transaction system 1150 may include a transaction interface system 1154 that that controls one more digital wallets of an enterprise (or an entity thereof). In embodiments, the transaction interface system 1154 may be configured as a “wallet-of-wallets”. In these embodiments, the transaction interface system 1154 controls multiple digital wallets of an enterprise or entities thereof. In some of these embodiments, the transaction interface system 1154 may provide a unified interface (e.g., GUI and/or chat-based GUI) to enterprise users and may include additional layers that manage tasks such as permissions, account selection, wallet selection, and transaction execution. In some of these embodiments, the transaction interface system 1154 may determine a list of enterprise wallets that a requesting user is permitted to use and may display a menu of the permitted enterprise wallets from which the user may select the enterprise wallet to perform the transaction. In some of these embodiments, the transaction interface system 1154 may determine the list of wallets based on one or more of the user's permitted applications, the role/title/business unit of the user, the counterparty to the transaction, and/or the transaction amount. For instance, a first user may have access to a first and second enterprise wallet, but not a third or fourth enterprise wallet because the business unit of the first user only uses the first and second wallets. In this example, if the first user wishes to make execute a transaction using an enterprise wallet, the transaction interface system 1154 may display options to use the first or second wallet for the transaction to the user (e.g., via a wallet-of-wallets GUI) and the user can select the wallet that will execute the transaction from the first and second wallet. In another example, a second user may have access to the first, second, third, and fourth wallet but may only have a limit of $1000 on the fourth wallet. In this example, if the second user wishes to make execute a transaction of $1500, the transaction interface system 1154 may display options to use the first, second wallet, or third wallet for the transaction to the user (e.g., via a wallet-of-wallets GUI) and the user can select the wallet that will execute the transaction from the first and second wallet. Note here as the transaction amount was above the fourth wallet's limit, the second user is prevented from using the fourth wallet by the transaction interface system 1154. Additionally or alternatively, the determination as to which wallet for a given transaction may be made by the transaction system (e.g., by the market orchestration system 1152 as described below).

As discussed, the transaction interface system 1154 may be configured to control a plurality of wallets (i.e., a “wallet-of-wallets”), such that in order to access a “child” wallet, an entity must interact with the transaction interface system to control a respective child wallet. Furthermore, in some embodiments, the transaction interface system 1154 may be configured to provide multiple “wallets-of-wallets”, such that each respective wallet-of-wallets is accessible by a different set of entities (which may or may not be overlapping). For example, wallets and accounts that are accessible by a first business unit may be controlled by a first wallet-of-wallets instance, such that the underlying wallets can be accessed by employees within the first business unit, but only if the manager and/or other responsible party of the first business unit who controls access to the wallets of the business unit provides access to those employees (e.g., by issuing a set of keys to the respective employees for the parent wallet or by granting access to the respective employees via a permission system). In embodiments, multiple layers of wallets and sub-wallets may be provided in a hierarchy, such as ones containing all assets, all assets of a given type (e.g., financial, cryptocurrency, non-fungible tokens, intellectual property, or the like), assets controlled by a given workgroup, assets related to a particular marketplace or exchange, or the like. A wallet-of-wallets can address the need for multiparty access control within an enterprise, such as where primary control of wallet usage needs to be governed by a supervisor, such as a manager.

In some implementations, the transaction interface system 1154 may use an API of a third-party wallet application to initiate a session with the wallet application and to issue commands to the digital wallet application on behalf of the enterprise. In the case that the transaction interface system 1154 does not have API access to a digital wallet, the transaction interface system 1154 may access a graphical user interface of the digital wallet application (e.g., by logging in using the credentials of the enterprise or a user associated with the enterprise) and may use robotic process automation to provide the requisite information (e.g., destination account, payment source (e.g., credit card account, bank account, cash reserve, or the like), transaction amount, payment date, and/or other required information) to execute a transaction.

In some configurations, the transaction system 1150 includes a transaction orchestration system 1152. In embodiments, the transaction orchestration is configured to orchestrate digital transactions, including digital payments and transactions involving digital assets. Digital payments may be outbound payments made to third parties (e.g., vendors, suppliers, service providers, utility providers, raw material providers, landlords, government entities, and/or the like) or enterprise entities (e.g., employees, contractors, business units, or the like) and/or inbound payments made to the enterprise (e.g., customers, clients, investors, and/or the like) using a digital interface. Digital asset transactions may include transactions involving cryptocurrency (e.g., Bitcoin, Ethereum, or the like), digital currency (e.g., digital Dollars, digital Yuan, digital Euros, digital Pounds, and/or the like), blockchain tokens (NFTs, tokenized instruction sets, or the like), enterprise data sets, financial instruments (e.g., bonds, stocks, derivative contracts, ETFs, REITs, and/or the like), and/or the like. In some embodiments, the transaction orchestration system 1152 is configured to perform payment perform multi-stage transactions on behalf of the enterprise (or entity thereof). In examples of multi-stage transactions, the transaction orchestration system 1152 may be configured to execute a purchase of an asset followed by a sale of the asset (e.g., an arbitrage transaction), a sale of entity assets that funds, at least in part, a subsequent purchase of one or more other assets, multiple purchases of multiple assets to compile a larger asset, and/or the like.

In embodiments, the transaction orchestration system 1152 may be configured to interface with various EAL systems (e.g., permissions system, workflow system, intelligence system, scoring system, and/or the like) to orchestrate transactions. In some embodiments, the transaction orchestration system 1152 interfaces with the workflow system 1140, which executes transaction orchestration workflows that define the set of tasks that are performed given a set of transaction parameters. The parameters that are provided may vary depending on the type of transaction being performed and other factors. Examples of transaction parameters may include but are not limited to one or more of: the type of transaction (e.g., inbound transaction, outbound transaction); parties to the transactions (e.g., counterparties to the transaction, payment service provider, escrow agent, and/or the like); jurisdictional parameters (where a payment may be/must be executed, where the payment is originating or may originate from); payment methods (e.g., credit/debit card, ACH transfer, cryptocurrency, or the like); currency parameters (currency type being used to make the payment, what currency type(s) is preferred or available to the enterprise), payment amounts (e.g., how much is being paid/received, an upper and/or lower limit for a potential transaction, or the like); payment date parameters (e.g., a date on which a payment must be executed, a date when a transaction must be completed before, a date after which the payment may be completed, and/or the like); tax instructions (e.g., consider tax implications); and/or the like. Examples of transaction orchestration workflows are discussed in greater detail below.

In some embodiments, the transaction orchestration system 1152 interfaces with an intelligence system 1130 of an EAL 1000 to leverage various intelligence services provided by the EAL. Examples of tasks that may be supported by the intelligence system 1130 within the context of transaction orchestration include, but are not limited to: model-based market predictions (e.g., predictions of currency exchange rates, predictions of future or spot prices for a given resource, good, or service, predictions of transaction volumes, prediction of interest rates, and/or the like); model-based counterparty predictions and discovery (e.g., predicted liquidity of counterparty, predicted likelihood of executing a given transaction with a given party, identification of parties that are likely to buy or sell a given asset, and/or the like); content generation services (e.g., customized offer generation, customized counteroffer generation, document review of offers, counteroffers, and other documents relevant to a transaction, and/or the like); model-based transaction recommendations (e.g., pricing recommendations, timing of offer/counter offer recommendations, timing of transaction recommendations, asset buying or selling recommendations, tax optimization and payment location recommendations, and/or the like). It is appreciated that the foregoing are examples of tasks that may be facilitated by the intelligence system 1130. In these embodiments, the transaction system 1150 (e.g., the transaction orchestration system 1152) is an intelligence client that provides requests to the intelligence system 1130, which in turn services the requests. In some embodiments, the intelligence system 1130 may apply governance standards as part of the servicing of the request (e.g., as discussed above). Additionally or alternatively, governance may be applied to potential actions of the transaction system 1150 independent of the servicing of intelligence requests by the transaction system 1150 to the intelligence system 1130. For example, the transaction system 1150 may interface with a governance system 1160 of the EAL, whereby the governance system 1160 may enforce one or more governance standards (e.g., legal/regulatory standards, industry standards, enterprise standards, or the like) before the transaction system 1150 is permitted to execute a pending transaction.

In embodiments, the transaction orchestration system 1152 interfaces with the permissions system 1170. In some embodiments, the transaction orchestration system 1152 may execute workflows that require the transaction system 1150 to verify that a transaction is permitted. As transactions may be initiated on behalf of an enterprise by entities of the enterprise, including employees, digital agents, AI-enabled robots, and/or the like, the transaction orchestration system 1152 may be configured to verify that the initiating entity of a respective transaction has been granted permission to execute such a transaction by the enterprise. As discussed, the permissions system 1170 may be configured to grant entities (e.g., employees, business units, third parties, contractors, digital agents, AI-enabled robots, and/or the like) with access to enterprise resources and data. In some of these embodiments, the permissions system 1170 is configured to selectively permit entities to perform certain types of transactions and/or perform transactions using certain accounts or digital wallets. For example, in response to a transaction request from an employee to perform an outbound transaction to a third party, the permissions system 1170 may determine whether to allow or deny the transaction request. In this example, permissions system 1170 may make this determination based on the employee's role in the company, the business unit of the employee, the transaction amount, the identity of the recipient of the payment (e.g., an individual, a company, a government department, etc.), the type of transaction (e.g., travel expenses, office supplies, raw materials, manufacturing parts, services for the enterprise, or the like), the employees transaction history, or the like. For instance, the requesting employee may have a role within the enterprise that is not permitted to initiate payments exceeding a limit without express approval from a manager. In another example, the employee may only be permitted to initiate transactions for certain types of services from approved vendors. In another example, the employee may be restricted from initiating any transactions without express approval from the employee's manager. In another example, the employee may be a member of a business unit that is only permitted to initiate transactions using a certain account or digital wallet. In these examples, the permissions system 1170 may be configured to receive transaction data indicating the requesting entity (e.g., an identifier of the employee), the transaction amount, the transaction medium (e.g., digital wallet identifier, account identifier, or the like), an identifier of the payee, and an identifier of the purpose of the payment (e.g., invoice identifier, a description or other identifier of the goods, services, or thing being paid for). In some embodiments, the permissions system 1170 may apply a set of rules defined by the enterprise to determine whether to allow a transaction, to deny the transaction, or to automatically request approval from an approving entity (e.g., business unit manager, CFO, internal accountant, or any other role or individuals designated by the entity). In the case that the permissions system 1170 determines that the transaction is denied or allowed, the permissions system 1170 provides a notification to the transaction system 1150 indicating whether the permission is denied or allowed. In the case that further approval is required, the permissions system may send a notification to an entity designated by the enterprise, whereby a user device of the designated entity displays or otherwise communicates an approval request to the designated entity. In these embodiments, the permissions system 1170 may approve or deny the transaction based on the response of the designated entity. In embodiments, the permissions system 1170 may be provided with a list of designated entities that can approve or deny transaction requests or certain types of requests. Additionally or alternatively, the permissions system 1170 may be provided with hierarchical rules that define the rules based on roles and/or business units (e.g., “managers of a business unit must authorize transactions by employees in the business unit”, “CEO, COO, or CFO must authorize any transaction exceeding a certain amount”, or the like). In these examples, the permissions system 1170 may access an organizational chart of the enterprise or a data store that stores the hierarchies of the enterprise (e.g., an entity graph of the organization) to determine whether to allow a transaction or to identify an appropriate enterprise resource to request authorization for the transaction. It is appreciated that the foregoing are examples of permission rules being applied to transaction execution workflows. Additional examples are provided elsewhere in the disclosure.

In embodiments, the transaction orchestration system 1152 may be configured to integrate, coordinate, manage, and/or otherwise facilitate payment processes that are performed on behalf of an enterprise. In embodiments, this may include end-to-end orchestration of payment transactions. In embodiments, different types of payment transactions may be orchestrated, whereby the various tasks of the orchestration are defined in respective transaction workflows. To facilitate a digital transaction, there may be several types of payment processes that need to be executed. For example, in some digital transactions the payment processes may include payment authorization, transaction routing, transaction settlement/execution, and/or post-transaction tasks. In embodiments, these processes are defined as tasks within a transaction workflow (e.g., payment authorization task, transaction routing task, transaction settlement tasks, and/or other necessitated tasks). In some examples, in order to orchestrate these digital asset transactions, the transaction system 1150 is configured to electronically connect entities involved in these payment processes, such as PSPs, acquirers, and/or banks and to communicate the appropriate information to these entities to facilitate/execute a transaction.

In embodiments, an end-to-end transaction workflow that orchestrates a payment to an entity on behalf of an enterprise may include a payment authorization task, a transaction routing task, and a transaction settlement/execution task. Furthermore, if the payment requires a conversion of currency to a target currency (e.g., a foreign currency to pay a foreign entity), an end-to-end transaction workflow may include a currency conversion task. It is appreciated that tasks of a transaction workflow may implicate additional workflows. For instance, a payment authorization task may implicate a corresponding workflow or a currency conversion task may implicate a currency conversion workflow (examples of which are provided below).

In an example of transaction orchestration system 1152 orchestrating an end-to-end payment transaction, the transaction orchestration system 1152 may receive a transaction request from an enterprise entity (e.g., an employee, an intelligent agent, or the like). In some example scenarios, the transaction request may request payment of a monetary amount to a third-party. The payment request may be initiated in response to an invoice for goods or services, to complete a purchase on behalf of the entity, a tax payment, a subscription payment, or the like. In embodiments, the transaction orchestration system 1152 executes a payment authorization task. In authorizing a payment, the transaction orchestration system 1152 ensures that the transaction system 1150 has requisite authorization to execute the transaction. In embodiments, payment authorization may include confirming that the transaction itself is permitted and that the requesting entity is authorized to request the payment (and if not, potentially obtaining authorization from a designated entity or set of entities).

In embodiments, the transaction orchestration system 1152 interfaces with the permissions system 1170 to determine if certain transactions are permitted and that the requesting entity is authorized to request the payment (and in not, potentially obtaining authorization from a designated entity or set of entities). In some embodiments, the transaction orchestration system 1152 may call the permissions system 1170 when a transaction workflow requires that the transaction system 1150 verify that a transaction is permitted. As transactions may be initiated on behalf of an enterprise by entities of the enterprise, including employees, digital agents, AI-enabled robots, and/or the like, the transaction orchestration system 1152 may be configured to verify that the requested transaction is permitted by the enterprise and that the initiating entity of a respective transaction has been granted permission to execute such a transaction by the enterprise. As discussed, the permissions system 1170 may be configured to grant entities (e.g., employees, business units, third parties, contractors, digital agents, AI-enabled robots, and/or the like) with access to enterprise resources and data. In some of these embodiments, the permissions system 1170 is configured to selectively permit entities to perform certain types of transactions and/or perform transactions using certain accounts or digital wallets. For example, in response to a transaction request from an employee to perform an outbound transaction to a third party, the permissions system 1170 may determine whether to allow or deny the transaction request. In this example, permissions system 1170 may make this determination based on the employee's role in the company, the business unit of the employee, the transaction amount, the identity of the recipient of the payment (e.g., an individual, a company, a government department, etc.), the type of transaction (e.g., travel expenses, office supplies, raw materials, manufacturing parts, services for the enterprise, or the like), the employees transaction history, or the like. For instance, the requesting employee may have a role within the enterprise that is not permitted to initiate payments exceeding a limit without express approval from a manager. In another example, the employee may only be permitted to initiate transactions for certain types of services from approved vendors. In another example, the employee may be restricted from initiating any transactions without express approval from the employee's manager. In another example, the employee may be a member of a business unit that is only permitted to initiate transactions using a certain account or digital wallet. In these examples, the permissions system 1170 may be configured to receive transaction data indicating the requesting entity (e.g., an identifier of the employee), the transaction amount, the transaction medium (e.g., digital wallet identifier, account identifier, or the like), an identifier of the payee, and an identifier of the purpose of the payment (e.g., invoice identifier, a description or other identifier of the goods, services, or thing being paid for).

In some embodiments, the permissions system 1170 applies a set of rules defined by the enterprise to the transaction data to determine whether to allow the transaction, deny the transaction, or require approval from an approving entity designated by the entity (e.g., business unit manager, CFO, internal accountant, or any other role or individuals designated by the entity). In the case that the permissions system 1170 determines that the transaction is denied or allowed, the permissions system 1170 provides a notification to the transaction system 1150 indicating whether the permission is denied or allowed. In embodiments, the permissions system 1170 may maintain a set of transaction rules defined by the enterprise. These rules may indicate the types of transactions that are permitted and/or not permitted by the enterprise. For example, an enterprise may prohibit transactions occurring in certain countries or states, payments made to gambling or adult websites, cash transfers to third parties, purchases on certain retail sites, cryptocurrency transactions on certain exchanges, purchases of certain types of goods (e.g., alcohol). Additionally or alternatively, the enterprise may define a list of permitted transaction types and/or conditions that must be met to permit a type of transaction. For example, an enterprise may designate certain retail platforms for the purchase of office supplies, certain travel companies for travel accommodations, tax payments made in certain time windows, cryptocurrency transactions involving designated cryptocurrency, parts or raw materials from approved vendors upon verifying an invoice from the approved vendor, payment of professional services only if a verified record of an engagement agreement exists, and/or the like. In some embodiments, the rules may require approval of a transaction type from a designated employee or type of employee when a transaction type is not explicitly approved or prohibited. In embodiments, the rules may also designate which employees or types of employees may initiate/request permitted transactions. For example, an enterprise may define rules that permit certain employees or types of employees to: sign up for certain types of software services (e.g., managers of a data science team are permitted to sign up for data warehousing and other big data related services or HR managers are authorized to sign up for payroll software services), to order parts or raw materials used to manufacture products (e.g., designated employees are permitted to transact with approved vendors of parts or raw materials), to pay for consultants or professional services (e.g., in-house attorneys are permitted to authorize payment of invoices for legal services from engaged law firms, the CFO is permitted to authorize payments to third party accounting services, etc.), to make tax payments (e.g., CEO and CFO are permitted to authorize tax payments), and/or the like. In embodiments, the permissions system 1170 may enforce authorization rules defined by the enterprise that designate certain employees or types of employees that can authorize transactions requested by enterprise entities not having sufficient permissions. The authorization rules may dictate who can authorize a transaction when the requesting entity does not have permission to unilaterally initiate a transaction. Examples of authorization rules may be defined by a transaction amount (e.g., any payment over $10,000 must be approved by the CFO), a class of employee (e.g., requests by non-management employees must be approved by a manager in the business unit of the requesting employee); a transaction type (e.g., travel related transaction requests made by members of a business unit must be approved by the head of the business unit; payment of invoices to a professional services company must be approved by the head of the business unit that engaged the professional services company; purchases of stocks, bonds, cryptocurrency, or other financial instruments must be approved by the CFO, etc.) or the like. Additionally or alternatively, the permissions system 1170 may maintain hierarchical rules that define the rules based on roles and/or business units within an enterprise (e.g., “managers of a business unit must authorize transactions by employees in the business unit”, “CEO, COO, or CFO must authorize any transaction exceeding a certain amount”, or the like). It is appreciated that other types of transaction authorization rules may be defined by the enterprise, such that the permissions system 1170 uses the rules to determine whether to allow a transaction, deny a transaction, or require authorization from another entity within the organization.

In embodiments, the permissions system 1170 may analyze the transaction data associated with a transaction request to determine whether the transaction is permissible or not. If the transaction is permissible, the permissions system 1170 may determine if the requesting entity has authorization to request the transaction based on the transaction rules defined by the enterprise. In embodiments, the permissions system 1170 may access an enterprise datastore that entity records of entities associated with an enterprise (e.g., employees, executives, business units, departments, intelligent agents, robots, business units, customers, vendors, service providers, governments, marketplaces, exchanges, and/or the like). In embodiments, the entity datastore may include entity databases, which may include any suitable combination of database types (e.g., SQL databases, graph databases, vector databases, and/or the like. In embodiments, attributes of the entity records include an entity identifier and an entity type of the entity. Furthermore, the relationships between the entity records may be indicative of an organizational structure of the enterprise (e.g., an org chart, business units of the enterprise, roles within the enterprise, reporting structures of roles and/or individuals, and/or the like). Additionally, the relationships may be indicative of relationships between the enterprise and a third-party entity (e.g., seller, buyer, lender, service provider, etc.). In some embodiments, the entity records may store or reference additional information about a respective entity such as a location of an entity, an address of an entity, transaction history of the entity, a title of the entity, and/or the like. In some embodiments, the permissions system 1170 may access a data pool managed by the data pool system 1136 to access some types of entity data (e.g., data shared by a third-party involved in a transaction), such that the entity data in the data pool may be used by the permission system 1170 to determine whether or not to authorize a payment. In embodiments, the permissions system 1170 may obtain the entity data corresponding to a requested transaction based on the transaction data indicated in the transaction request. The permissions system 1170 may determine whether or not to allow the transaction based on the entity data and the permission rules defined by the enterprise. In some scenarios, the permissions system 1170 may further determine whether to require authorization from one or more for employees or other enterprise entities based on the rules defined by the enterprise. It is appreciated that the foregoing are examples of permission rules being applied to transaction execution workflows. Additional examples are provided elsewhere in the disclosure.

In the scenario where the transaction is denied, the transaction orchestration system 1152 may halt the requested transaction. In doing so, the transaction orchestration system 1152 may be configured to notify one or more enterprise entities of the denial (e.g., the requesting user, a supervisor of the requesting entity, a business unit manager, or the like) and/or to initiate recordation of the denial (e.g., by requesting that the reporting system report the denial). In the case that the permissions system approves the transaction request, the transaction orchestration system 1152 proceeds to a subsequent task of the transaction workflow. In some embodiments, the transaction orchestration system 1152 may be configured to initiate recordation of the approval (e.g., by requesting that the reporting system record the approved transaction).

In some embodiments, the permissions system 1170 is configured to determine if a transaction requested by a user requires authorization from one or more other users. For example, the permissions system 1170 may be configured with a set of authorization rules that define which types of users and/or transaction types must have explicit authorization to perform certain types of transactions. These authorization rules may define an authorization hierarchy that indicates which types of employees can authorize a transaction, which employees or types of employees must have their transactions authorized, transaction limits that indicate a transaction threshold amount that when exceeded triggers an authorization requirement, transaction types that require authorization, and/or the like. The permissions system 1170 may determine whether a transaction request requires further authorization based on the entity data and the authorization rules defined by the enterprise. In embodiments, the permissions system 1170 may further identify one or more enterprise entities that can authorize the payment transaction if further authorization is required. As mentioned, the authorization rules may include an authorization hierarchy that define which employees authorize which types of transactions. In these embodiments, the authorization rules may define rules that define the roles or identities of enterprise entities that are able to authorize transactions for certain business units, users, transaction amounts, and/or counterparties. For example, transactions requested from a certain business unit may require a manager or director of the business unit to authorize said transactions. In another example, transactions exceeding certain thresholds may require authorization from the CEO, CFO, or a manager in the finance department. Other non-limiting examples of authorization rules are described elsewhere throughout the disclosure.

In the case that further approval is required, the permissions system 1170 may provide a response to the transaction system 1150 indicating that the requested transaction requires additional approval and one or more entities that can authorize the transaction. In response, the transaction system 1150 may send a notification to one or more entities (e.g., as identified by the permissions systems 1170), whereby a user device of the designated entity displays or otherwise communicates an approval request to the authorizing entity. In embodiments, the transaction system 1150 includes an authorization system 1158 that is configured to obtain authorization from one or more enterprise entities, such that the authorization from the authorizing entity or entities allows the transaction orchestration system 1152 to proceed with the transaction. The authorization system 1158 may interface with the permissions system 1170 to determine which entities have what access. In some embodiments, the authorization system 1158 may send an authorization request to the authorizing users. The authorization request may include a set of transaction parameters, such as the transaction amount, the requesting user that requests the transaction, counterparty of the transaction, and/or the purpose of the transaction (e.g., goods or services being paid for, tax payment, and/or the like). In some of these embodiments, the authorization system 1158 sends the authorization request to the authorizing users and the authorizing user may approve or reject the transaction. In some scenarios, the user device of the authorizing entity may cryptographically sign the approval or rejection (e.g., using a private key associated with the authorizing entity), such that the authorization system 1158 can verify that approval or rejection (e.g., based on a public key associated with the authorizing entity). In the case that the transaction is approved by the authorizing user, the authorization system 1158 may provide authorization to transaction orchestration system 1152, which may then initiate recordation of the approval by the authorizing entity (e.g., on a blockchain, enterprise database, or the like) and proceed to the next stage of the transaction workflow. If the authorizing user rejects the transaction, the authorization system 1158 records the rejection and may prevent the requested transaction from proceeding. In some embodiments, the transaction system may require the authorizing user to provide a reason for rejecting the transaction, such that recordation of the rejection includes the reason why the transaction was rejected.

In addition to verifying that the requesting authority has sufficient the transaction orchestration system 1152 may be configured to determine whether to allow or deny transactions based on one or more scores obtained from a scoring system 1134. In some embodiments, the transaction orchestration system 1152 may be configured to obtain a trust score from a trust system (e.g., such as the trust systems described above) before authorizing a blockchain transaction to proceed. In these embodiments, the transaction orchestration system 1152 may provide the blockchain address of an intended recipient of a payment and a trust system may return a trust score corresponding to the address. If the trust score does not exceed a threshold, the transaction orchestration system 1152 may deny the payment and initiate any post-transaction recordation and/or notification tasks. In some embodiments, the transaction orchestration system 1152 may be configured to obtain a KYC score before proceeding with a payment to an account associated with an individual or unvetted enterprise. For example, the transaction orchestration system 1152 may provide information relating to an intended recipient of a transfer of funds to the scoring system 1134, which may provide a score indicating whether a recipient of a transfer of funds is likely fraudulent and/or participating in illicit activity (e.g., money laundering, phishing, or the like). In the case the score is below a threshold, the transaction orchestration system 1152 may deny the payment and initiate any post-transaction recordation and/or notification tasks. It is appreciated that the transaction orchestration system 1152 may perform additional or alternative scoring tasks before allowing a transaction to proceed to a subsequent task.

In embodiments, the transaction orchestration system 1152 may initiate a payment routing task in response to allowing a transaction to proceed. In embodiments, the transaction orchestration system 1152 may determine a transaction rail and/or digital wallet to use to perform the requested digital transaction. In some embodiments, the transaction orchestration system 1152 determines an optimal transaction rail for a digital transaction based on one or more factors, such as the type of digital transaction (such as by selecting a transaction rail that is capable of executing the type of digital transaction), the volume or size of the digital transaction (such as by selecting a transaction rail that is capable of handling the volume, one that provides a volume-based benefit, such as a discount, credit, or reward, or the like), the format of the digital transaction, the location of the transaction (e.g., the destination of the transaction and/or source of the transaction), the financing of the digital transaction, the cost of the digital transaction (including transaction cost, borrowing cost, processing costs, costs of energy, and the like) and/or the currency involved in the transaction, among others. As an example, the recipient of the payment (e.g., a market participant 910) may indicate the preferred payment method (e.g., payment in a certain currency, requiring ACH transfers, requesting payment in cryptocurrency, and/or the like). In some scenarios, the selection of a transaction rail may be dictated in part by a transaction facilitator (e.g., an e-commerce interface), whereby the requesting entity selects a payment option from a set of options designated by the transaction facilitator. In some embodiments, the transaction orchestration system 1152 selects a transaction rail based on one or more models of the intelligence system 1130. For instance, a model maintained by the intelligence system 1130 may be trained using historical enterprise transaction data to generate a recommendation or prediction of a transaction rail for a given digital transaction based on current enterprise conditions (including enterprise resource plans, transaction plans, strategic plans, policies, and the like), market conditions, and other contextual information. For example, for a particular transaction, the transaction system 1150 determines a payment method or payment rail for a transaction involving the particular asset. Some examples of payment methods include clearing houses (e.g., Automated Clearing House (ACH)), credit card providers (e.g., MASTERCARD®, VISA®), online payment systems (e.g., Pay Pal®, Venmo®, CashApp®), Real-time Payment (RTP) Network, blockchains, the Society of Worldwide Interbank Financial Telecommunications (SWIFT), Single Euro Payments Area (SEPA), and the like. The transaction system 1150 may automatically determine which payment method to use based on characteristics the type of transaction, the parties involved in the transaction, the location of the transaction (e.g., a country, state, city, jurisdiction where the transaction is executed), and/or the currency of the transaction.

In embodiments, the transaction orchestration system 1152 may additionally or alternatively designate a digital wallet from the set of enterprise wallets to execute the transaction. In some embodiments, the transaction orchestration system 1152 may select the digital wallet based on the identified transaction rail. For example, if only a single enterprise digital wallet can perform transactions on the selected transaction rail or if the requesting entity or business unit of the requesting entity only has permission to access a single enterprise digital wallet that can perform transactions on the selected transaction rail, the transaction orchestration system 1152 may designate the digital wallet to execute the transaction. If there are multiple wallets that can perform the transaction, the transaction orchestration system 1152 may select one of the multiple capable enterprise wallets to execute the transaction. For example, transaction orchestration system 1152 may request that the requesting user select a digital wallet from the capable enterprise wallets (e.g., via a GUI or voice command). Additionally or alternatively, the enterprise may designate certain wallets for certain types of transactions. For example, transactions that are executed in foreign countries, the enterprise may designate a digital wallet that is capable of transacting using in those countries. In another example, for certain crypto transactions, the enterprise may designate a certain digital wallet for performing transactions on a specific blockchain. In some embodiments, the transaction orchestration system 1152 may determine which digital wallet to designate for executing the transaction based on one or more factors such as the cost of a transaction on a respective digital wallet, the transaction speeds of each capable wallet, the reliability of each capable enterprise wallet, the security features of each capable wallet, and/or other suitable factors.

In response to identifying a digital wallet and/or transaction rail on which a transaction will be executed, the transaction orchestration system 1152 may proceed to a transaction settlement/execution task and instruct the transaction interface system 1154 to execute the transaction. In some embodiments, the transaction orchestration system 1152 may provide a configured transaction to the transaction interface system 1154 that indicates transaction details for executing the transaction. In embodiments, the transaction details may indicate the digital wallet to use in the transaction, an account corresponding to the transaction (e.g., an identifier of a bank account, credit card, blockchain address, and/or the like), the transaction amount, transaction routing information (e.g., account identifier and/or any other information needed to transfer funds to the recipient), and/or the like. In embodiments, the transaction interface system 1154 uses the transaction details to execute the transaction and may provide a response indicating the result of the transaction (e.g., was the transaction successfully executed). In the case that the transaction was executed, the transaction orchestration system 1152 may initiate one or more post-transaction tasks. Examples of post-transaction tasks include, but are not limited to, recordation of the transaction, notifications being sent to one or more enterprise entities, outcome monitoring (e.g., monitoring outcomes of transactions for reinforcing models used to make predictions, and/or the like).

In some embodiments, a transaction workflow may include a currency conversion task, whereby the transaction orchestration system 1152 orchestrates a conversion of enterprise reserve of currency into a target currency, such that the target currency is used to complete a transaction. As more enterprises become global or multi-regional market participants (e.g., a multi-regional merchant), many enterprises have to make outbound payments to a counterparty (e.g., payments for supplies, services, raw materials, taxes, utilities, rent, loan servicing, and/or the like). In such examples, the enterprise can integrate with multiple region-specific payment service providers (PSPs) via the transaction orchestration system 1152 of the transaction system 1150.

In embodiments, the conversion system 1156 is configured to convert currencies held by the enterprise into a target currency, such as by automatically purchasing or selling a given currency based on an enterprise forecast of the amount of the currency that will be needed to achieve enterprise objectives that will involve the currency. The forecast of currency needs, which may be continuously updated, may be based on a model of anticipated transaction workflows that are predicted based on historical transactions, current conditions (including market prices of items to be bought or sold using a currency), current cash reserves in the currency, and enterprise objectives (e.g., increasing or decreasing production of a good that requires a part or raw material from a foreign country, the need for services in a foreign country, a tax payment to a foreign country, real estate purchase in a foreign country, and/or the like). As is discussed, automation of may be supported by the intelligence system 1130, whereby one or more machine-learned models and/or other artificial intelligence services may be leveraged to optimize the currency exchange on behalf of the enterprise.

In embodiments, the transaction system 1150 maintains respective balances of enterprise cash reserves in various currencies. In embodiments, these cash reserves may be indicative of total cash in digital wallets (e.g., Venmo, Paypal, Apple Wallet, Google Wallet, etc.) and enterprise bank accounts and may be determined by querying the digital wallets and bank portals (e.g., using APIs thereof) and/or by maintaining an internal ledger of enterprise transactions, including all cash transactions. In embodiments, the conversion system 1156 may determine or receive (e.g., from another EAL system) an amount of foreign currency needed to execute one or more pending and/or upcoming transactions. The amount of foreign currency needed may be a realized amount (e.g., an invoiced amount for goods or services rendered, a tax liability of the enterprise, a purchase price of goods, services, or property, or the like) or a predicted amount (e.g., a projection of future invoiced amounts, a predicted tax liability, a predicted purchase price, or the like). In embodiments, the conversion system 1156 executes a currency exchange workflow in response to the obtained amount of foreign currency needed. In an example currency exchange workflow, the conversion system 1156 may first determine an amount of foreign currency to obtain based on the difference between the amount needed in a foreign currency to complete the transactions and the current enterprise cash reserves in the foreign currency. In some scenarios, regulatory and/or enterprise governance may require that the enterprise maintain minimum levels of cash reserves in certain currencies (e.g., at least one million USD, at least 250,000 Euros, at least two million Chinese Yuan, etc.). In these scenarios, the transaction orchestration system 1152 may determine the amount of foreign currency to obtain based on the difference between the current enterprise cash reserves in the foreign currency and the amount needed in a foreign currency to complete the transactions plus the minimum threshold balance required to be maintained in the foreign currency.

In response to determining an amount of foreign currency to obtain, the conversion system 1156 may determine a type of currency to exchange, an exchange or market to perform the currency exchange transaction, and/or a timing of the currency exchange transaction. In embodiments, the conversion system 1156 may determine the currency to exchange based on the enterprise cash reserve balances of the other currencies held by the enterprise, predicted needs for the other currencies held by the enterprise for future transactions, predicted future price of the other currencies held by the enterprise, and any governance standards controlling minimum balances in certain currencies. For example, if the conversion system 1156 is exchanging for British Pounds and the enterprise has cash reserves in Euros and no longer has a need to transact in Euros, the conversion system 1156 may decide to exchange at least a portion of the remaining enterprise Euro reserves for the needed amount of British Pounds. If, however, in this example the conversion system 1156 predicts that the price of Euros will increase in relation to US dollars in the next year, the conversion system 1156 may decide to exchange US dollars to British Pounds instead of exchanging Euros for Pounds. In embodiments, the conversion system 1156 may also monitor various currency exchanges to identify which currency exchange to use to execute the currency exchange. In some of these embodiments, the transaction system 1150 may provide an analytics request to the intelligence system 1130 that indicates the target currency being exchanged for, the currency being exchanged, and the amount of currency being exchanged.

In embodiments, the conversion system 1156 may select a currency exchange that historically or currently offers exchange rates that are most favorable to the enterprise. In some of these embodiments, the intelligence system 1130 returns market analytics relating to monitored currency exchanges to determine which currency exchange to execute the transaction on. In some of these embodiments, the market analytics may indicate the currency exchanges that can accommodate the transaction, and for each exchange the difference between the offered exchange rate by the exchange and the managed floating exchange rate. The conversion system 1156 may also request additional or alternative metrics to inform the decision of selection of exchange rate, such as a trust score of the exchange, a variability of offered exchange rates, and/or the like.

In some embodiments, the conversion system 1156 may also determine a transaction timing, such as a date and time to execute the currency exchange. In embodiments, the conversion system 1156 may send prediction requests to the intelligence system 1130 to obtain predictions relating to the future exchange rates for the target currency and currency being exchanged. In embodiments, the prediction request may indicate the target currency and the currency being exchanged. In some of these embodiments, the intelligence system 1130 may return. In these embodiments, the intelligence system 1130 may provide one or more predicted exchange rates (e.g., a predicted floating currency exchange rate) on one or more respective dates and/or times. In some embodiments, the conversion system 1156 may determine a date and time to execute the currency exchange transaction based on the predicted exchange rates and any time constraints relating to a subsequent transaction that requires the target currency (e.g., a date when the subsequent transaction needs to be completed by).

In embodiments, the conversion system 1156 executes the currency exchange transaction. In some example embodiments, the conversion system 1156 may instruct the transaction interface system 1154 to transfer to transfer an amount of the currency to be exchanged from the enterprise cash reserves to the currency exchange to purchase the determined amount of target currency. It is appreciated that the transaction interface system 1154 may execute the transaction using one or more of the enterprise digital wallets and/or by initiating a bank transfer (e.g., ACH transfer) from an enterprise bank account that holds the cash reserves. In response the currency exchange transfers the corresponding amount of target currency to an enterprise account (e.g., wallet or bank account).

The foregoing is an example of a currency exchange transaction orchestration. It is appreciated that additional or alternative exchange workflows may be implemented by an EAL deployment. Furthermore, while the provided example describes an examples of “fiat-for-fiat” currency exchanges, transaction orchestration workflows may be modified to accommodate crypto-for-fiat, crypto-for-crypto, or fiat-for-crypto currency exchanges. Furthermore, the example currency conversion workflows described herein may be executed as part of a larger transaction orchestration, such as part of an “end-to-end” transaction orchestration workflow for paying a third-party, such as where the third party requires payment in a certain type of currency that the enterprise does not typically transact in.

In some implementations, the transaction system 1150 functions to optimize a digital transaction. For example, the transaction optimization functions to determine an optimal payment route to conduct (e.g., send) a digital transaction. This optimal payment route may include determining an optimal transaction rail and/or digital wallet to execute the transaction. Here, the best route may depend on the type of digital asset (such as by selecting a transaction route or rail that is compatible with the asset), the volume or size of the digital transaction (such as by selecting a transaction rail that is capable of handling the volume, one that provides a volume-based benefit, such as a discount, credit, or reward, or the like), the format of the digital transaction, the location of the transaction (e.g., the destination of the transaction and/or source of the transaction), the financing of the digital transaction, the cost of the digital transaction (including transaction cost, borrowing cost, processing costs, costs of energy, and the like) and/or the currency involved in the transaction, among others.

In some implementations, the details about the transaction include terms for the transaction, such as transfer terms (e.g., shipping terms), payment terms (e.g., net 30/60/90), interest terms, licensing terms, or other contract terms (e.g., representations and/or warranties). With the transaction details, the transaction system 1150 may be configured to orchestrate the transaction using a payment or transaction gateway. In some configurations, the transaction system 1150 or another system (e.g., a third-party payment system) encrypts/decrypts some portion of the transaction details (e.g., payment information such as card numbers, routing numbers, communication addresses, etc.) prior to or during communication of the transaction detail to a PSP.

In some configurations, the transaction system 1150 configures the transaction details in order to orchestrate a transaction for an enterprise digital asset. When configuring the transaction details, the transaction system 1150 may specify transaction details that represent the interest of the enterprise. In some situations, to represent the interest of the enterprise, the transaction system 1150 generates transactions details by use of one or more models of the intelligence system 1130. For instance, a model of the intelligence system 1130 may be trained using historical enterprise transaction data to generate a recommendation or prediction of transaction details the enterprise 900 would prefer for a particular enterprise digital asset, which may be further based on current enterprise conditions (including enterprise resource plans, transaction plans, strategic plans, policies, and the like), market conditions, and other contextual information. A recommendation or prediction may be further used to configure a set of instructions to initiate the transaction, which may be automatically initiated or triggered by an authorized entity. To illustrate, for a particular asset, the transaction system 1150 determines a payment method or payment rail for a transaction involving the particular asset. Some examples of payment methods include clearing houses (e.g., Automated Clearing House (ACH)), credit card providers (e.g., MASTERCARD®, VISA®), online payment systems (e.g., PayPal®, Venmo®, CashApp®), Real-time Payment (RTP) Network, blockchains, the Society of Worldwide Interbank Financial Telecommunications (SWIFT), Single Euro Payments Area (SEPA), and the like. The transaction system 1150 may automatically determine which payment method to use based on characteristics regarding the asset (e.g., asset attributes), the parties involved in the transaction, the location of the transaction (e.g., a country, state, city, jurisdiction where the transaction is executed), and/or the currency of the transaction.

In some implementations, the transaction system 1150 (and/or other EAL systems) may be configured with an awareness for transactions across sets of assets. For example, in some embodiments, the transaction system 1150 may be configured to identify transactions which would be more efficient to combine or divide. For instance, the transaction system 1150 can determine that instead of selling a first asset in a first marketplace and a second asset in a second marketplace, the enterprise 900 would receive the most value for these assets by bundling the first and second asset together with a third asset and selling these three assets as a package in one of the marketplaces or a third marketplace. Similarly, the transaction system 1150 may combine acquisitions by packaging multiple acquisitions for different enterprise entities and/or workflows into a bundle, such as to access volume discounts or other benefits. In other cases, unbundling purchases or sales may provide benefits, such as where discounts are offered for new or trial users of a set of marketplaces or exchanges up to a maximum threshold of transaction value. In other words, with the transaction system 1150 being able to track multiple available assets (including ones desired to be acquired) for the enterprise 900, the transaction system 1150 can likewise leverage combination or disaggregation of assets to engage in complex transactions that benefit the enterprise 900 more than unmanaged transactions with the assets. As another example, the transaction system 1150 can operate with supply-side knowledge for the enterprise 900 (e.g., the supply rate for enterprise digital assets) while also tracking current and past demand-side knowledge across multiple marketplaces for assets that have characteristics, properties, or attributes similar to enterprise assets used in historical workflows in order to generate a recommendation, prediction or instruction about further acquisition. This may further include adjusting the recommendation, prediction or instruction based on an enterprise plan, contextual conditions, or the like.

Another transaction detail that the transaction system 1150 is capable of determining is payment details. Here, one type of payment detail that the transaction system 1150 may coordinate or control is the type of currency that is exchanged and/or when the exchange involving an enterprise digital asset occurs using a particular currency. Determining the type of currency or the timing of a transaction with a particular currency may allow the transaction system 1150 to have another approach to optimize value for a transaction. For instance, the value of different types of currencies is capable of fluctuating based on market conditions. That is, conversion rates or exchanges rates may be determined by a floating rate that depends on market forces of supply and demand for foreign exchange or a fixed rate. Due to the fluctuation of conversion rates, the timing of when a transaction occurs can dictate the buying power or selling power of an asset. To illustrate, if the United States Dollar (USD) has an exchange rate greater than one with respect to the British Pound, then the USD, at that time has greater buying power than when the USD has an exchange rate less than one with respect to the United Kingdom Pound. In other words, with a ratio over one, the USD gets a greater return in British Pound than with a ratio less than one. Therefore, if a transaction for a US enterprise 900 was going to occur in British Pounds (e.g., with a British market participant), the transaction system 1150 may track the conversation rates and/or facilitate the execution of the transaction at a time within a particular transaction window (i.e., a permitted time period to execute the transaction) that is most advantageous to the US enterprise (e.g., when the USD has the greatest buying power). To facilitate such activity, the EAL system may access a set of predictions of currency conversion rates, such as one generated based on market factors, such as economic data for respective jurisdictions, central bank interest rates, and the like.

In embodiments, the transaction system 1150 may perform transactions accounting for factors such as environmental factors, market conditions, economic conditions, or weather conditions. For example, if the exchange of a digital asset is associated with a physical good, the transaction system 1150 can coordinate transaction details, such as shipping logistics or the timing of the performance of the transaction, based on influencing factors such as environmental factors, weather factors, and/or political factors. For instance, if the enterprise 900 is aware that a network is going to be offline for maintenance, the transaction system 1150 can recognize this upcoming event, and adjust transaction details based on the recognition (e.g., schedule the transactions to occur outside the time when the network is offline). Similarly, if a resource or asset needed by the enterprise is subject to consistent seasonal or other periodic variations in price or availability, the transaction system 1150 can coordinate transactions to acquire the resource or asset at a favorable time (such as during an annual promotional event of a supplier). In embodiments, an acquisition or disposition plan of an enterprise, or instructions derived therefrom, may be linked to or integrated with or into the transaction system 1150, such that the transaction system 1150 is configured to optimize, and then execute, a series of transactions that accomplish the plan (acquisition of needed resources and assets and disposition of others) while optimizing timing and other transaction parameters as noted above.

In some examples, the transaction system 1150 links to or is integrated with an e-commerce engine that includes one or more interfaces. These interfaces may refer to software modules that execute on hardware to provide a portal or graphical user interface (GUI) to interact with the transaction system 1150. That is, the GUI may be designed such that the GUI represents the wallets of the transaction system 1150 and the functionality that is accessible to a particular entity interacting with the EAL 1000. In some examples, the transaction system 1150 includes an interface for each type of entity that has access to the EAL 1000. In other words, an entity of the enterprise 900 may use an enterprise interface of the transaction system 1150 to facilitate the functionality of the transaction system 1150 for enterprise-based activities (e.g., submitting an enterprise asset available or facilitating transaction details on behalf of the enterprise 900 for an asset). Similarly, the transaction system 1150 may have a marketplace participant interface separate from the enterprise interface that functions to facilitate actions in the transaction system 1150 that are available to the market participant 910. For instance, the marketplace participant interface may include an e-commerce shopping interface to discover what assets are available for transactions, a checkout interface such as a shopping cart as a means to stage a series of assets for purchase, or the like.

In some implementations, instead of having multiple interfaces, the transaction system 1150 uses a single interface that is capable of identifying a user of the interface and configuring, presenting or rendering a GUI that matches the access and/or wallet activity permissions associated with the user. In this sense, the single interface is capable of restricting a user from accessing or executing the functionality associated with windows, menus, or other GUI elements that are tied to certain wallet-based activities that should not be accessible to a particular user. For instance, the GUI elements may include an identifier that designates the access permissions required to render the element for display. In this instance, at runtime, transaction system 1150 determines the access permissions associated with a user and renders the GUI elements that satisfy or match the determined access permissions. For example, a purchasing manager in charge of acquiring semiconductor chips may be presented GUI elements that display data from market participants who offer them while not being presented with GUI elements for other goods or services. In this respect, regardless of whether the transaction system 1150 uses one or more interfaces, the user experience (UX) of the interface(s) for the transaction system 1150 differs depending on the entity that is using the interface(s), such that GUI elements and their rendering is tied to access controls and permissions for the transaction system 1150.

Although the wallet interfaces are described with respect to an enterprise entity and a market participant 910, the wallet interfaces are capable of managing access to the transaction system 1150 (e.g., wallets of the transaction system 1150) at a more granular level such that one enterprise entity may have access to some wallets while another enterprise entity may have access to a different set of wallets (e.g., which may include access to at least one of the same wallets). Similarly, a market participant 910 (e.g., from a first marketplace 922) may have access to some wallets (e.g., a first set of wallets) while another market participant 910 (e.g., a second marketplace 922 different than the first marketplace 922) has access to a different set of wallets (e.g., which may include access to at least one of the same wallets). In this manner, the access to the transaction system 1150 can be managed not only at the enterprise/non-enterprise level, but also at the entity level.

### Governance System

The governance system 1160 is configured to create, track, and/or ensure compliance with various rules (e.g., laws, regulations, standards, and/or practices) that impact an enterprise digital asset and transactions regarding the enterprise digital asset. These rules may be government-imposed rules (e.g., laws or regulations), industry-imposed rules (e.g., industry standards or specifications), enterprise-imposed rules (e.g., dictated by an enterprise's code of conduct, mission statement, governance purpose), or consumer-imposed rules (e.g., rules dictated by consumer advocacy groups or consumer watchdogs). A legal governance system 1162 may monitor compliance of the EAL 1000 with government-imposed rules. The legal governance system 1162 may have a ruleset defined by subject matter experts and/or created based on training data of prior governance activity. A training system 1167 may rely on the intelligence system 1130 to generate a machine learning (ML) model based on governance training data. The training system 1167 may use supervised learning, such as a set of governance decisions made on a set of items (such as assets). The training system 1167 may determine what features of the assets are correlated with governance decisions, such as by using principal component analysis (PCA). In this way, the training system 1167 can infer the rules for governance without an expert having to explicitly define and hone them. The training system 1167 may continue to operate, such as on a periodic basis, to ensure the ML model embodying governance rules stays up to date.

Some types of assets may have testing standards that have to be met for the asset to be considered an exchangeable asset. A testing system 1163 may be responsible for performing tests—such as on a scheduled basis—on specific aspects of the EAL 1000. For example, the testing system 1163 may test—for example, on an hourly basis—an amount of leverage of each interface connected to the transaction interface system 1154. The testing system may also test an enterprise-wide amount of leverage. The amounts of leverage may be compared against thresholds and, if the thresholds are exceeded, transactions may be performed to reduce the amount of leverage. In this context, leverage refers to how much debt is being used to finance an investment in comparison to liquid assets.

In some examples, governance is market-specific, so a market-specific system 1164 governs satisfaction of requirements for a market participant to participate in a marketplace. Other types of governance include financial governance and risk governance. These types of governance may be implemented by the market-specific system 1164, a custom governance system 1166, or another element (not shown) of the governance system 1160. An ethics system 1165 performs ethical governance according to goals of the enterprise-such as maintaining enterprise-wide charitable giving or achieving greenhouse gas emissions targets. In various implementations, these ethical goals may be set by management of the enterprise, such as by the board of directors.

The custom governance system 1166 facilitates custom governance that may be set by a participating party of a transaction and/or an external entity, such as an operator of a marketplace or exchange, a regulatory body, etc. In order to enforce, monitor, and/or track the governance for an enterprise asset, the governance system 1160 may include any number of libraries that include relevant polices, compliance rules, etc. for resources, assets, or activities of the enterprise 900. In embodiments, the libraries may include parameters that define or otherwise correspond to certain rules and/or scenarios. These libraries may be used to construct a custom governance scheme in the custom governance system 1166.

In some configurations, when an enterprise digital asset is made available in the transaction system 1150, the governance system 1160 identifies any governance that is applicable to the asset. Any identified governances may be indicated in information associated with the asset. In some situations, the governance system 1160, besides merely identifying applicable governance, is configured to determine whether the asset complies with the identified governance. Here, for example, if the asset complies with the identified governance, the asset is made fully available to outside market participants 910 (for example, via marketplaces 922). On the other hand, in some implementations, if the asset fails to comply with the identified governance, the asset may be removed from transactional availability.

In some instances, an asset that fails to comply with governance parameters may be offered at some reduction of value that is proportional to the severity of the compliance failure. In some of these instances, an asset that fails to comply with governances may be flagged and include information that identifies the failure such that any failure is conspicuous to a potential customer or investor in the asset. Here, this allows the asset to stay available, but the risk to be borne by the customer or purchaser is displayed in a transparent fashion. In these instances, the governance system 1160 may generate fault-identifying information that includes a disclaimer or the prominent inclusion of contract terms for the transaction.

### Permissions System

In embodiments, the permissions system 1170 may include a credential system 1171, an access negotiation system 1172, a granularity system 1173, a privacy enforcement system 1174, a network availability system 1175, a request system 1177, an approval system 1178, and/or a need-to-know system 1179, among others. The permissions system 1170 assigns, manages, and/or facilitates access controls and permissions for the EAL 1100. In this sense, the permissions system 1170 is capable of performing access control activities for the other EAL systems associated with the EAL 1100. In other words, the permissions system 1170 can be configured to field permission-based or access requests received by any EAL system. For instance, in response to receiving a request to access the transaction system 1150 via a wallet interface, the permissions system 1170 can be informed of the request and determine a set of permissions associated with the requesting entity (e.g., via the request system 1177). In various implementations, the requesting entity may be referred to as a transactor and may be identified by a globally or locally unique transactor identifier (ID). Here, once the permissions system 1170 identifies the set of permissions or access controls associated with the requesting entity, the permissions system 1170 may communicate these permissions to the transaction system 1150 to enable the transaction system 1150 to render the appropriate wallet interface for the requesting user.

The permissions system 1170 may be configured to assign one or more permissions to a user of the EAL 1100 (e.g., via the credential system 1171). A permission generally refers to a rule that defines access to various portions (e.g., functions) of the EAL 1100. Permissions dictate access parameters in order to control who or what is authorized to access resources. Therefore, permissions are traditionally used to secure resources by permitting who, what, when, or how a resource can be utilized. In some examples, the permissions system 1170 uses access controls or access control lists (ACLs) to manage permissions that are associated with various users of the EAL 1100. These access controls may be discretionary access controls (e.g., managed by business stakeholders of the enterprise 1902), mandatory access controls (e.g., access controls that are deployed to comply with required security protocols for a resource), or role-based access controls (e.g., access controls that correspond to a user's role in the enterprise).

In some examples, the permissions system 1170 is capable of managing (e.g., assigning, modifying, removing) permissions that are privacy-based rules (e.g., via the privacy enforcement system 1174). That is, an enterprise asset managed by the EAL 1100 may pose privacy concerns. For instance, the enterprise asset (e.g., a medical record) may include personal/protected health information (PHI) which dictates who and/or how a user of the EAL 1100 may interact with that asset. To illustrate, an enterprise entity submits an enterprise asset that includes PHI to the transaction system 1150. Here, the entity may include an indication that the asset includes private or sensitive information or the EAL 1100 (e.g., via the transaction system 1150) determines that one or more attributes for the asset indicate that the asset pertains to private or sensitive information. Based on this determination and/or the precise attribute identified, the permissions system 1170 applies one or more permissions that correspond to a privacy rule implicated by the determination or attribute.

In some implementations, a privacy rule may dictate not only what types of users should access an asset, but also if further processing by the EAL 1100 should occur prior to making the asset available for a market participant 910 (e.g., in a wallet of the transaction system 1150). For instance, certain assets that include sensitive information may trigger a permission that requires the asset or information included with an asset to be encrypted (e.g., prior to availability of that asset). In this instance, the permissions system 1170 determines that the implicated permission for the asset indicates that the asset (or a portion thereof) should be encrypted. In some configurations, the permissions system 1170 generates an encryption request for the data services system 1120 to enable the data services system 1120 to perform its encryption capabilities (such as by using the encryption system 1124 and/or the request system 1177). The request may include the asset to be encrypted and the type of encryption being requested for the asset.

Besides implicating privacy rules, the permissions system 1170 can also determine that one or more attributes of the asset or characteristics associated with an entity providing the enterprise asset dictate a particular set of permissions (e.g., via the credential system 1171, the access negotiation system 1172, and/or the granularity system 1173). In some implementations, the characteristics or properties (e.g., entity identifiers) associated with an entity inform the permissions system 1170 which set of permissions should be associated with an asset for which the entity is/was responsible. For instance, when an enterprise entity responsible for an asset seeks to make that asset available via the transaction system 1150, the permissions system 1170 may generate a set of permissions for the asset that correspond to characteristics of the enterprise entity. To illustrate, an enterprise entity may have certain access controls with the enterprise (e.g., a particular level of clearance such as security clearance or confidentiality clearance). The permissions system 1170 may identify that the entity is associated with these access controls and generates permissions for the asset at the EAL 1100 that are similar to or match the access controls associated with the entity at the enterprise. For example, each employee of the enterprise may have an employee identifier. The permissions system 1170 may be configured with a reference table that includes the permissions associated with that employee identifier. Using the table, the permissions system 1170 generates a set of permissions for an asset based on the permissions associated with the employee identifier of an employee who submitted the asset to the EAL 1100 (or an entity identifier in the case of a different type of enterprise entity). In some configurations, there may be another portion of that table or another table that designates which EAL-based permissions correspond to which enterprise permissions such that the EAL-based permissions can mirror or function in a manner similar to the enterprise permissions. As noted above, permissions may be associated with a set of roles that are managed by an identity management system or platform, such that upon a change of role of an employee, the permissions change (such as removing permissions for a departing employee and applying the previous permissions of an employee to the new employee that is taking the same role).

In embodiments, the permissions system 1170 may further be configured to include an approval system (such as the approval system 1178) for an asset transaction; for instance, the permissions system 1170 may receive an asset transaction request (i.e., a request for a transaction involving the asset) and determine whether the requesting entity has the authorization or approval to proceed with and/or execute the transaction of the asset transaction request. To determine whether the requesting entity has the permission to perform the transaction, the permissions system 1170 may perform some level of diligence on the details of the transaction. For example, this due diligence may be performed by the intelligence system 1130 and may include input from one or more of the credential system 1171, the access negotiation system 1172, the granularity system 1173, the approval system 1178, and the scoring system 1134). This diligence may include: determining whether the requesting entity has permission to perform the transaction with the underlying asset(s), determining whether the underlying asset has any conflicts that would inhibit the performance of the transaction, determining whether the transaction is in compliance with one or more plans or policies, etc.

To determine whether the requesting entity has permission to perform the transaction, the permissions system 1170 may examine whether the requested transaction satisfies transactional terms for the asset. For instance, some assets or transactions may have transaction detail requirements, such as particular contract terms, minimum pricing, delivery conditions, or timing constraints. When an asset transaction request implicates an asset or transaction that has transaction detail requirements, the permissions system 1170 may identify these requirements and determine whether the requirements are satisfied (e.g., whether minimum thresholds are reached, whether limits are exceeded, etc.). In response to the permissions system 1170 determining that requirements are satisfied, the permissions system 1170 may communicate its approval of the transaction (e.g., to the transaction system 1150). On the other hand, in response to the permissions system 1170 determining that the requirements are not satisfied, the permissions system 1170 communicates that the EAL 1100 (e.g., the transaction system 1150) should decline the transaction or seek authorization from a designated employee (e.g., manager of the requesting entity, CFO, CEO, a division head, or the like). In embodiments, the permissions system 1170 may determine a modification of an otherwise non-compliant transaction that would render it compliant and may communicate the modification, such that the EAL 1100 may execute a modified transaction, such as by purchasing a reduced amount of an item or discovering an alternative source of an item that has a lower price to keep a transaction below a transaction amount threshold, modifying a time of execution to satisfy a waiting period, obtaining an additional approval to satisfy permissioning requirements, purchasing offsets or credits to allow a transaction to satisfy a sustainability objective, etc.

In embodiments, the permissions system 1170 may also be configured to determine whether the underlying asset has any conflicts that would inhibit the performance of the transaction. This may be important because a large enterprise may have a large portfolio of assets. With a large number of available assets, it is possible that one asset transaction request involves the same underlying asset as another transaction request; for example, both assets may be made subject to requests that they be used as collateral for two different loans, where each loan transaction requires a senior claim to the asset in the case of default. As another example, two transactions may require sale of the same asset to two different counterparties. Due to the possibility of such conflicts, the permissions system 1170, upon receiving the asset transaction request, can determine what transactions are pending or have been requested. From the set of transactions that are pending or have been requested, the permissions system 1170 determines whether any transactions of the set have been authorized for the asset specified by the asset transaction request (e.g., via the credential system 1171, the access negotiation system 1172, the granularity system 1173, and/or the approval system 1178). If a transaction of the set has been authorized for the asset specified by the asset transaction request, the permissions system 1170 may be configured to deny the asset transaction request (e.g., without disclosing the further details regarding the conflict). In some examples, when an asset transaction request is denied, the permissions system 1170 may recommend a similar alternative asset or set of assets as a substitution for the asset. Similarity may be determined by asset type, asset value, etc. Additionally or alternatively, the permissions system 1170 may recommend obtaining authorization to proceed with the transaction from one or more designated entities. In embodiments, the EAL 1100 may access capabilities of the transaction platform described elsewhere herein or in the documents incorporated herein by reference for automatically determining similarity of assets based on their attributes and for automatically determining an alternative or substitute asset set based on such similarity, such as to recommend or instruct a set of assets to be provided as substitute collateral for a lending transaction and/or as substitute items for a purchase or sale.

In another example, the permissions system 1170 may adjust the level of data accessible by an entity based on the role of the entity (e.g., via the granularity system 1173 and/or the need-to-know system 1179). When the entity is a human, the role may correspond to a job title. A job title with more authority may correspond to an increased level of access. For any entity, an increased level of access may correspond to obtaining more and more granular data—a lower level of access may only provide anonymized or deidentified data; in other embodiments, a lower level of access may only provide statistical or other group data, and not individual data. In other configurations, aggregated data may have strategic importance, while individualized data needs to be accessed by lower-level workers—in these configurations, accessing aggregated data may require a higher level of access. In various implementations, a higher level of access is required in order to access personally identifiable information (PII).

The granularity system 1173 may dynamically adjust the number of tiers of access in the permissions system 1170. For example, with respect to role-based permissions, the granularity system 1173 may dynamically increase the number of roles to accommodate the need for more granular permissions; similarly, the granularity system 1173 may dynamically collapse the number of roles when separate roles are no longer required. For example, the granularity system 1173 may periodically monitor the set of roles and their associated permissions to determine whether two roles have converged such that the two roles can be combined into one. When adjusting the number of roles, the granularity system 1173 redefines the criteria for each role such that each requestor can be assigned to one of the adjusted roles.

In embodiments, the “need-to-know” system 1179 continuously (or periodically, or repeatedly but not on a periodic basis) monitors permissions to ensure that a permission structure—for an entity, a role, etc.—does not offer access or approval thresholds that are more generous than necessary. The need-to-know system 1179 may include a machine learning model (for example, from the intelligence system 1130) that is trained on acceptable permissions of existing entities, roles, etc. For example, the intelligence system 1130 may create a feature vector for an entity/role/etc. that includes permissions (for example, transaction limits, number of systems accessible, amount of data accessible, number of transactions per hour, bandwidth allotment, allowed query size, number of queries per hour) and parameters of the entity/role/etc. (for example, the placement of the entity within an organizational hierarchy, the scope of the role, etc.). In various implementations, this feature vector can be input into the machine learning algorithm, which generates a likelihood of the permissions being consonant with the entity or role. When the likelihood is low (below a threshold), the permissions for that entity or role may be automatically adjusted—at least on a temporary basis—to be more strict and a workflow may be initiated in the workflow system 1140 to review whether the permissions can be relaxed again. As a simplistic example, a low-level employee whose permissions indicate that they can execute a transaction of up to 25 Bitcoin without external approval may, when vectorized and supplied to the machine learning model, be identified as a permissions discrepancy. In response to identification of the permissions discrepancy, the limit of 25 bitcoin may be temporarily reduced to a lower number, such as an average of the limits for other similarly-situated entities or a value recommended by the machine learning model. Then, a workflow in the workflow system 1140 can be initiated to determine whether the limit should be raised back to 25 bitcoin.

Vectorization may translate the permission into a normalized format, such as by mathematically converting an amount of cryptocurrency (such as bitcoin) into a common currency (such as US dollars). If the permissions have a set of N limits for various asset types (such as US dollars, cryptocurrency, securities, etc.), the vector may include an element calculated based on a mean of the N limits and an element that is based on a maximum of the N limits.

The network availability system 1175 assesses network connectivity and determines whether an issue with network connectivity is compromising, partially or wholly, an operation of the permissions system 1170. For example, if the approval system 1178 requires communication with an approving entity, a lack of network connectivity may prevent any approvals from proceeding. The network availability system 1175 may initiate a workflow from the workflow system 1140 to attempt to restore network connectivity. In various implementations, restoring network connectivity may include accessing an alternative network route that traverses different network nodes. In some situations, these alternative network nodes may not be under control of the EAL 1100 and therefore the network availability system 1175 may require additional protection for communications, such as minimum encryption standards or use of a virtual private network (VPN).

Some workflows, such as ones relying on digital wallet applications, can be dependent on network availability. However, in certain places and at certain times, there may be limits on network connectivity to assist in a transaction. For example, connectivity may be limited in certain geographical locations, such as by poor signal (in a tunnel, underground, remote from cell coverage, etc.), hardware or software failures, Denial of Service (DoS) attacks, lack of necessary plan (such as when roaming in a foreign country), network limitations imposed by a jurisdiction (such as a deep packet inspection firewall). A workflow can be configured that includes a set of rules that determine what type of transactions can be done and how they can be accomplished in the absence of network connectivity. As an example, when a device is determined to be getting within a pre-determined distance of a network deficient area (e.g., a tunnel), the EAL system may be triggered to fetch and cache certain data for specific transactional workflow(s).

The network availability system can be configured to enable a series of transactions during a network deficiency using the EAL system. The workflow for the enabled transaction may be configured to allow skipping a step(s) before sharing information with other trusted systems. For example, the workflow can allow a transaction to be completed below a predetermined threshold without preauthorization from a banking institution associated with a credit card. Logic can be used to select which enterprise digital wallet of an enterprise's collection of enterprise wallets to use for which transactions, with each enterprise digital wallet controlling a respective set of one or more enterprise accounts and requiring respective permissions and reporting requirements.

As another example, the network availability system may learn that a user trusts a company based on a threshold number of transactions (e.g., purchases from Amazon) with that company in a period of time. The network availability system may therefore allow certain transaction workflow steps to be bypassed when network is unavailable in order for the user to complete transactions within monetary thresholds. Further, the network availability system may cache messages and log entries until the network connectivity is regained (or may instruct another EAL system to do so). Further, the network availability system may be configured to track cumulative authorizations while the network connectivity is compromised and cap the authorizations at a limit. This can prevent a bad-faith actor from compromising network connectivity and executing a series of transactions that add to a substantial amount but each fall below the transaction threshold.

In embodiments, the network availability system 1175 may also initiate a workflow from the workflow system 1140 to allow offline performance of a function of the permissions system 1170. For example, a workflow may handle offline approval of a transaction request. The workflow may rely on a set of rules in the workflow library system 1144 to determine whether the transaction request is approved. The criteria for an offline approval may be more stringent than for a standard approval—for example, the allowed transaction threshold for a particular transaction by a particular entity may be reduced when compared to a normally-approved transaction.

The permissions system 1170 described above is an example permission system that may be used to assign, manage, and/or facilitate access controls and permissions for various enterprise resources. It is appreciated that in some embodiments, one or more subsystems of the permissions system 1170 and/or some of the functionality thereof may be implemented in other EAL systems. Furthermore, a permissions system may be implemented in other enterprise platforms, such as ERPs, CRMs, and/or the like.

### Reporting System

The reporting system 1180 functions to provide reporting to or from the EAL 1000, other EAL systems, non-EAL systems, and/or specified entities of an enterprise. For instance, the reporting system 1180 may include a compliance system 1182 that is configured to generate compliance reports for one or more assets of the EAL 1000. The compliance system 1182 may generate compliance reports on a periodic basis (such as nightly, quarterly, annually, etc.), which can then be provided upon demand to an authorized requestor (such as a government agency). In other implementations, the compliance system 1182 may generate a compliance report in response to a demand from an authorized requestor. Here, the type of compliance report that the compliance system 1182 generates may depend on the type of asset to be reported. For instance, a financial asset and a transaction regarding a financial asset may have compliance reporting requirements for accounting or tax purposes. In that regard, the compliance system 1182 generates a compliance report that fulfills the accounting/tax requirements.

The reporting system 1180 may include a fraud reporting system 1183 that is configured to generate a fraud report identifying transactions that were not authorized or that triggered a fraud alert. Here, a fraud alert may come from a third party (such as a PSP) or from another EAL system (such as the permissions system 1170). The fraud reporting system 1183 may also analyze and report data that is used to detect fraud and, in fact, may itself detect fraud. For example, the fraud reporting system 1183 may generate a report of activity that might be consistent with malicious behavior, such as multiple accounts being emptied into another account that is under independent control. This report may be ingested by the intelligence system 1130 to determine whether some remediation measure is warranted, such as pausing further transfers into the independent account and/or, if technologically possible, preventing outbound transfers from the independent account.

A financial reporting system 1184 may be configured to generate financial reports for financial activity at the EAL 1000. The financial reporting system 1184 may compile financial information regarding transactions that have been executed over some designated or customizable period of time. The financial reporting system 1184 may be used in the production of financial reports and balance statements.

In some implementations, transactions at the EAL 1000 may have legal implications, such as legal or regulatory reporting obligations. In these implementations, a legal reporting system 1185 may be configured to generate a legal or regulatory report that is set up to identify transactions that implicate a legal condition and to include these identified transactions in the legal report that the legal reporting system 1185 generates.

The reporting system 1180 may also include a statistics system 1186 configured to generate statistical reports that include statistics or metrics regarding the assets managed by the EAL 1000 and/or activity (e.g., transaction activity) of the EAL 1000. Statistical reports may be their own standalone reports or may be integrated into other types of reports generated by the reporting system 1180 (e.g., part of a financial report). Similarly, the statistics system 1186 may generate EAL activity reports that set forth instances of a particular activity or set of activities that are performed at the EAL 1000. For instance, among many other statistics and metrics, an EAL report may include how many times a particular asset or type of asset is queried, how many times an asset or type is included in a transaction request, what assets or types are available in which wallets of the transaction system 1150, volumes of asset transactions (purchases, sales, exchanges, loans), prices of asset transactions, characteristics of parties involved, and many others.

A query system 1187 allows the reporting system 1180 to generate arbitrary reports based on a query provided by a requestor. The query system 1187 may consult with the permissions system 1170 to determine what data can be used in a query for the requestor. The query system 1187 may rely on the workflow system 1140 if the provided query requires data not immediately accessible to the reporting system 1180. The query system 1187 may translate the provided query into a set of multiple queries, which may include multiple SQL queries to the same or different SQL databases (which may be maintained by the data services system 1120).

### Digital Twin System

The digital twin system 1190 can be used to create, maintain, and interrogate digital twins of entities within the enterprise 900 as well as the EAL 1000. The digital twin system 1190 includes a data visualization system 1192 that allows a user of the EAL 1000 to view data from the digital twin system 1190, which may also incorporate data from the real-world entities in the enterprise 900 that are twinned in the digital twin system 1190. The digital twin system 1190 includes a decision support system 1193 that can run comparative analyses by performing simulations on digital twins using different parameters. Outcomes of the simulations can be compared and optimized parameters can be chosen. The simulations can be run a single time or may be run iteratively in order to converge on a global or local minimum or maximum. Simulations of digital twins may be performed by a planning and simulation system 1194.

An access support system 1195 works with the permissions system 1170 to determine what data can be reported by the digital twin system 1190 and to which entities. The access support system 1195 also determines what data can be used by the digital twin system 1190—for example, there may be restrictions on systems that are able to provide data to the digital twin system 1190. In addition, there may be restrictions on types of data ingested by the digital twin system 1190. For example, the access support system 1195 may transform data that is being ingested by the digital twin system 1190, such as by stripping out certain types of data, such as personally identifiable information (PII).

A workflow support module 1196 interacts with the workflow system 1140 to allow the digital twin system 1190 to be used to execute one or more workflows from the workflow system 1140. In addition, the workflow support module 1196 allows the digital twin system 1190 to rely on the workflow system 1140 to execute one or more workflows on behalf of the digital twin system 1190.

In various implementations, the digital twin system 1190 incorporates features and characteristics of the digital twin module 320 above.

### Multiple EALs

In embodiments, each business unit in an enterprise may configure a respective EAL according to the unit's needs. For example, the ERP systems 1052, the CRM systems 1053, the healthcare systems 1054, the SCM systems 1055, the PLM systems 1056, the HR systems 1057, accounting systems (not shown), and research and development (R&D) systems (not shown) may each incorporate an EAL configured by their corresponding business units. The EAL of each unit interacts with EALs of the other units based on a set of workflows and rules. The individual EALs are configured to be a part of a hierarchical network of EALs for the enterprise 900, with the enterprise level EAL 1000 being at the highest level. The enterprise level EAL 1000 may promulgate a common set of rules that all EALs at the lower hierarchical level (i.e., unit-level EALs) must follow. The unit-level EALs are nodes in the network, with each node having one or more libraries that may be made available to the other nodes based on the set of rules (e.g., what type of data is in the pool, use case, access requirement, etc.) as configured by the business unit for its EAL. Each unit-level EAL may include libraries that can store different types of data files or data pool structures that are fully or partially available for access by other EALs. In some examples, the libraries can be prepackaged for a particular type of domain (e.g., medical, loan, transactional, etc.), and can be used to respond to different types of requests. For example, data files in a library including medical data can be configured to be a certain file type, and include protections, qualifications, security features, etc. to provide access to any given field of this data based on regulations (e.g., HIPAA, GDPR, etc.) and compliance policies. The libraries can also include references from other places, files, databases (including a relational database), etc.

A unit-level EAL may be configured to allow access to a library to multiple other EALs for different purposes, with access to each EAL defined by different set of rules based on the corresponding purpose for the access. Each unit-level EAL of the enterprise may be configured using its own requirements and workflows. The unit-level EALs from all units can be assembled and nested into complex systems to execute requests by communicating between the unit-level EALs and across different enterprise EALs (e.g., EAL 1000 and third-party EALs). Each unit-level EAL may be configured based on the requirements of that unit, services provided by the unit, the libraries of that unit, access requirements for those libraries, machine learning modes used by that unit, the unit's contribution to execution of various requests, wallets and budgets that the unit has access to, etc. Each nested/unit-level EAL inherits some functionalities and properties of the EAL 1000 when communicating with external entities. The EAL 1000 can be configured to respond to external requests and, based on the internal EAL configurations/hierarchies, communicate the request to internal/unit-level EALs to gather required data to respond to the original external request. This configured system of EALs creates a common layer allowing large enterprises to communicate and transact between internal units in a structured manner.

In an example implementation, an employee of an enterprise unit may have access to a unit-level EAL implementation instance when logged into the enterprise network. This may give the employee access to certain workflows to do specific transactions allowed under that unit-level EAL. However, the employee may not have access to the enterprise-level EAL 1000. In order to access data in a library belonging to a second unit-level EAL, the first unit-level EAL may communicate with the second unit-level EAL and the second unit-level EAL may determine if the employee requesting data from the first unit-level EAL meets the requirements of the second unit-level EAL for accessing the requested data. As an example, an engineering department employee looking for marketing survey information to help drive industrial design for a new product can submit a request to the engineering unit-level EAL implementation instance. The engineering request is vetted by the engineering unit-level EAL to determine whether this employee has requisite permissions based on the employee credentials, location, IP address, etc. and rules of the engineering unit-level EAL. This can be done using a scoring system or permission system of the engineering unit-level EAL. The marketing unit-level EAL can then determine whether to accept the request based on its own configuration, requirements, policies, etc.

In another example implementation, an enterprise searching for a location to build a battery recycling plant may make its decision based on a variety of data including its own business analytics data, marketing and sales data for products using lithium ion batteries (e.g., electric vehicles, etc.), existing battery recycling plants in high-volume areas, potential locations (that is, commercial real estate) for a battery recycling plant, etc. The enterprise may use the EAL 1000 to configure a workflow for a query for a battery recycling plant with inputs and outputs to aid in the decision-making. For example, an input can include an aggregated data pool including data instances such as localized marketing data (e.g., X million people bought Tesla in the greater New York area in a 1-year window 6 years ago), median battery life (e.g., 7 years), closest recycling plant statistics (e.g., one existing plant in New Jersey area that has recycling capability of Y thousand batteries a year), construction and set up costs for a recycling plant, existing factors used by other domain-specific enterprises (e.g., other battery recycling enterprises), etc. The data pool can be generated using data from internal and external sources. The workflow can be developed based on the data pool as input configured using required compliance requirements (e.g., EPA regulations, enterprise internal compliance policies, etc.) and tested for accuracy. In some examples, the workflow can be iteratively trained using artificial intelligence to improve its accuracy. The output of the tests can be compared to the compliance requirements to determine and document compliance. The EAL 1000 can also be configured to develop a digital footprint of compliance of the workflow with the requirements, and can be used to evaluate how the inputs are gathered and how the outputs are generated as a function. Similar processes can be used to develop and train workflow models for other repeatable queries/requests, such as placement of electric charging stations.

In various implementations, an EAL may be configured as a personal EAL to allow a human user to monetize and/or opt into sharing their data. In embodiments, the personal EAL may be associated with, and at least partially instantiated on, a user device, such as a smartphone or tablet. The personal EAL may store and manage data on the user device and/or data stored in a server architecture, such as a cloud-based storage system. Examples of the data include: cookies, browsing history, purchases, interests, financial information, demographic information, survey results, reviews/ratings. In various implementations, unique types of data may be enabled, which may be referred to as reverse solicitation data. As an example of reverse solicitation data, a user might designate items that they are looking to acquire, such as goods or services. The data may include timing, budget, etc. The personal EAL could interact with third-party systems or services to offer this data in return for compensation, such as a microtransaction or a discount coupon.

In embodiments, the personal EAL constructs and manages a personal data pool of the user and allows the user to decide when and how the personal EAL may share their data. As part of the personal EAL onboarding, the user may establish their identity—and perhaps receive some sort of token of that identity, such as from a certificate authority—so that the personal EAL can establish the user's authenticity to third-party systems and services.

FIG. 11 and FIG. 12 depict different examples of how an EAL 1000 may be implemented. For example, as shown in FIG. 11, instead of being integrated with the enterprise side 902, the EAL 1000 may be integrated with different systems on the market-participant side 904 of the enterprise ecosystem. To illustrate, FIG. 11 shows a set of EALs 1000a-n that are integrated with a set of marketplaces 922a-n. When integrated with a particular marketplace 922, some or all computing resources relied upon for the EAL 1000 may be hosted on the computing resources associated with the marketplace 922 (e.g., marketplace servers). Alternatively, when an EAL 1000 is integrated into a particular marketplace 922 there may be portions of the EAL 1000 that remain hosted by enterprise resources to ensure aspects of security and/or privacy for enterprise assets. Referring specifically to FIG. 11, a first EAL 1000a is associated with or integrated with an orchestrated finance marketplace 922a. A second EAL 1000b is integrated with an orchestrated insurance marketplace 922b. A third EAL 1000c is integrated with an orchestrated lending marketplace 922c. A fourth EAL 1000d is integrated with the third-party systems 924. An nth EAL 1000n is integrated with an nth orchestrated marketplace 922 since other types of marketplaces (not shown) can similarly integrate the functionality of the EAL 1000.

In some implementations, the functionality of the EAL 1000 is distributed across market-side systems such that portions of the EAL 1000 that interface with a particular marketplace 922 are integrated with that marketplace 922 while other portions of the EAL 1000 that interface with another marketplace 922 are integrated with the other marketplace 922. An example of this would be that the financial offerings of the EAL 1000 are integrated with the finance marketplace 922a as the first EAL 1000a while insurance offerings of the EAL 1000 are integrated with the insurance marketplace 922b as the second EAL 1000b. In some configurations, the distribution of the EAL 1000 may be such that wallets of the transaction system 1150 are integrated amongst the marketplaces to which they relate. For instance, a wallet that includes financial enterprise assets is integrated with the finance marketplace 922a and is represented by the first EAL 1000a. On the other hand, a wallet that includes insurance-related enterprise assets (e.g., data sets that may be integrated with insurance policies or contracts) is integrated with the insurance marketplace 922b and is represented by the second EAL 1000b.

FIG. 11 also illustrates another scenario on the right side of the figure where an EAL 1000n+1 can be a stand-alone system (e.g., a microservice that enterprises leverage). In other words, the stand-alone system is capable of communicating with both the enterprise 900 and the market-side systems such as the storage system 926, third-party systems 924b, and the orchestrated marketplace 922n+1. As a stand-alone system, the EAL 1000n+1 may be configured such that the resources (e.g., computing resources) that the EAL 1000n+1 relies upon for operation are not hosted by, for example, the enterprise 900 or the orchestrated marketplace 922n+1. This may ensure that computing resources that the EAL 1000 may require are not occupied or being consumed by other resources at its host to compromise or somehow hinder the performance of the EAL 1000. That is, if the EAL 1000 shares resources with a system, that sharing may require priority procedures when resources are occupied or time in queue to wait for a particular resource to be available for utilization.

FIG. 12 is an example of the EAL 1000 integrated with the configured market orchestration system EAL 1100 (e.g., similar to a portion of FIG. 11). The configured market orchestration system EAL 1100 may refer to a system that can control and/or manage a market ecosystem. In some respects, the configured market orchestration system EAL 1100 may be considered a “system of systems” because it is a structure that provides cooperative coordination among a set of market-related systems that are configurable for the execution of various market services/tasks. In some examples, the configured market orchestration system EAL 1100 is a system that can function as a liaison for a set of systems or services. For instance, as shown by FIG. 10, the configured market orchestration system EAL 1100 generally includes a configured intelligence service or intelligence system 1130 and configured system services.

The configured market orchestration system EAL 1100 may also manage a set of transactional systems 1230. Some examples of the set of transactional systems 1230 include an asset valuation system 1232, a collateralization system 1233, a tokenization market system 1234, a market orchestration system 1235, a market making system 1236, and a market governance and trust system 1237. Some of these systems may be variations of the EAL system described previously. For instance, the market governance and trust system may be functionally similar to a combination of the governance system 1160 and the permissions system 1170 of an example EAL 1000. In embodiments, the set of transactional systems 1230 may be configured for the purpose of generating and/or controlling particular aspects of a market (i.e., transactional execution) while EAL systems may be configured for accessing markets and performing transactions on behalf of an enterprise.

In order to manage the set of transactional systems 1230, the configured market orchestration system EAL 1100 leverages the functionality of the configured intelligence service system 300 and the configured system services. The configured intelligence service system 300 is a framework for providing intelligence services to one or more services, such as the configured system services. In some implementations, the configured intelligence service system 300 receives an intelligence request to perform a specific intelligence task (e.g., a decision, a recommendation, a report, an instruction, a classification, a pattern or object recognition, a prediction, an optimization, a training action, a natural language processing request, etc.). In response, the configured intelligence service system 300 executes the requested intelligence task and returns a response to the intelligence service requestor (e.g., the configured system services).

The configured intelligence service system 300 may include an intelligence service controller 1331 and a set of artificial intelligence (AI) modules 1332. When the configured intelligence service system 300 receives an intelligence request (e.g., from one of the set of transactional systems 1230 or from the configured system services), the request may include any specific/required data to process the request. In response to the request and the specific data, one or more implicated AI modules 1332 perform the intelligence task and output an “intelligence response.” Examples of responses from AI modules 1332 may include a decision (e.g., a control instruction, a proposed action, machine-generated text, etc.), a prediction (e.g., a predicted meaning of a text snippet, a predicted outcome associated with a proposed action, a predicted fault condition, an anticipated state of an entity or workflow relevant to a transaction (such as a future price, interest rate, conversion rate, etc.), etc.), a classification (e.g., a classification of an object in an image, a classification of a spoken utterance, a classified fault condition based on sensor data, etc.), a recommendation (e.g., a recommendation for an action to optimize a transaction parameter), and/or other suitable outputs of an artificial intelligence system.

There may be a variety of AI modules 1332 associated with the configured intelligence service system 300 to have the broad capability to output the many types of intelligence responses that may be requested of the configured intelligence service system 300. Some examples of these AI modules 1332 include ML modules, rules-based modules, expert system modules, analytics modules (e.g., econometric models, behavioral analytics, collaborative filtering, entity similarity and clustering, and others), automation modules, control system modules, robotic process automation (RPA) modules, digital twin modules, machine vision modules, NLP modules, text-to-speech modules, and neural network modules, as well as any other types of artificial intelligence systems described herein or in the documents incorporated herein by reference and encompassing hybrids or combinations thereof (e.g., where an AI modules uses more than one type of neural network). It is appreciated that the foregoing are non-limiting examples of AI modules 1332, and that some of the modules may be included or leveraged by other AI modules.

As shown in FIG. 13, the AI modules 1332 interface with the intelligence service controller 1331, which is configured to determine a type of request issued to the configured intelligence service system 300 (e.g., from an intelligence requestor such as the configured system services or one of the set of transactional systems 1230) and, in response, may determine a set of governance standards and/or analyses that are to be applied by or to the AI modules 1332 when responding to the request. In some examples, the intelligence service controller 1331 may include an analysis management module, a set of analysis modules (e.g., shown as a fraud detection module, a risk analysis module, and a forecasting module), and a governance library.

In some implementations, the analysis management module receives a request from the AI modules 1332 and determines the governance standards and/or analyses implicated by the request. In some examples, the analysis management module may determine the governance standards that apply to the request based on the type of decision that was requested and/or whether certain analyses are to be performed with respect to the requested decision. For example, a request for a control decision that results in the configured system services configuring an action for the set of transactional systems 1230 may implicate a certain set of governance standards that apply, such as safety standards, legal or regulatory standards (e.g., privacy standards, “know your customer” standards, reporting standards, export control standards and many others), financial accounting regulatory standards, legal standards, quality standards, etc., and/or may implicate one or more analyses regarding the control decision, such as a risk analysis, a safety analysis, an engineering analysis, etc. In embodiments, the governance standards may apply to the AI modules; for example, a training data set used for an AI module may be required to be satisfy governance standards, such as representativeness of data, absence of bias, adequacy of statistical significance, absence of inequity in resulting outcomes, etc. As one such example, a training data set of historical transactions used to train an AI module to identify a favorable counterparty may be governed by policy that requires that the training data set include historical transactions that are free of racial, ethnic, or socioeconomic imbalances, compliance analysis, an engineering analysis, etc.

In some instances, the analysis management module may determine the governance standards that apply to a decision request based on one or more conditions. Non-limiting examples of such conditions may include the type of decision that is requested, a location (e.g., geolocation, jurisdiction, data processing location, network location, etc.) in which a decision is being made, a location in which an activity governed by the decision will be executed (e.g., where an asset or resource will be purchased, stored, sold, etc.), an environment or system that the decision will affect, current or predicted conditions of the environment or system, a set of parties to a transaction affected by the decision, etc. The governance standards may be defined as a set of standards, policies, rules, etc. in a governance library, which may include a set of standards libraries. The foregoing may define conditions, thresholds, rules, recommendations, or other suitable parameters by which a decision may be analyzed. Examples of may include, legal standards library, a regulatory standards library, a quality standards library, a financial standards library, a risk management standards library, an environmental standards library, a sustainability standards library, an ethical standards library, a social standards library, and/or other suitable types of standards libraries. In some configurations, the governance library includes an index that indexes certain standards defined in the respective standards library based on different conditions or context. Examples of conditions may be a jurisdiction or geographic area to which certain standards apply, environmental conditions to which certain standards apply, device types to which certain standards apply, materials or products to which certain standards apply, etc.

In some implementations, the analysis management module may determine the appropriate set of standards that must be applied with respect to a particular decision and may provide the appropriate set of standards to the AI modules 1332, such that the AI modules 1332 leverage the implicated governance standards when determining a decision. In these embodiments, the AI modules 1332 may be configured to apply the standards in the decision-making process, such that a decision output by the AI modules 1332 is consistent with the implicated governance standards. It is appreciated that the standards libraries in the governance library may be defined by the platform provider, customers, and/or third parties. The standards may be created, managed, promulgated and/or overseen by various sources, such as government standards, industry standards, customer standards, enterprise standards, non-governmental entity standards (e.g., international agencies), or standards from other suitable sources. Each set of standards may include a set of conditions that implicate the respective set of standards, such that the conditions may be used to determine which standards to apply given a situation. In embodiments, the standards may be embodied in executable logic, such that elements of standards are automatically applied, optionally at the level of an individual workload or service within a workflow or system, such as by prompting workload developers to embed standards compliance (and any other policies) into the workload development and deployment process.

In some embodiments, the analysis management module may determine one or more analyses that are to be performed with respect to a particular decision and may provide corresponding analysis modules that perform those analyses to the AI modules 1332, such that the AI modules 1332 leverage the corresponding analysis modules to analyze a decision before outputting the decision to the requestor. In some examples, the analysis modules may include modules that are configured to perform specific analyses with respect to certain types of decisions, whereby the respective modules are executed by a processing system that hosts the instance of the configured intelligence service system 300. Non-limiting examples of analysis modules may include one or more risk analysis modules, econometric analysis modules, financial analysis modules, behavioral analysis modules (e.g., of user behavior, system behavior, etc.), security analysis modules, decision tree analysis modules, ethics analysis modules, forecasting analysis modules, quality analysis modules, safety analysis modules, regulatory analysis modules, legal analysis modules, and/or other suitable analysis modules, including any of the analysis types described herein or in the documents incorporated herein by reference.

In some configurations, the analysis management module is configured to determine which types of analyses to perform based on the type of decision that was requested to be performed by the configured intelligence service system 300. In some of these configurations, the analysis management module may include an index or other suitable mechanism that identifies a set of analysis modules based on a requested decision type. Here, the analysis management module may receive the decision type and may determine a set of analysis modules that are to be executed based on the decision type. Additionally, or alternatively, one or more governance standards may define when a particular analysis is to be performed. For example, the regulatory standards may define what scenarios necessitate a risk analysis. In this example, the regulatory standards may have been implicated by a request for a particular type of decision and the regulatory standards may define scenarios when a risk analysis is to be performed. In this example, AI modules 1332 may execute a risk analysis module and may determine an alternative decision if the action would violate a respective legal standard. In response to analyzing a proposed decision, AI modules 1332 may selectively output the proposed condition based on the results of the executed analyses. If a decision is allowed, AI modules 1332 may output the decision to the requestor. If the proposed configuration is flagged by one or more of the analyses, AI modules 1332 may determine an alternative decision and execute the analyses with respect to the alternate proposed decision until a conforming decision is obtained.

In embodiments, the configured system services function to configure a set of systems (e.g., the set of transactional systems 1230) corresponding to the configured market orchestration system EAL 1100 to perform a set of services based on intelligence determined for the configured system services. Similar to configured intelligence services system 300, configured system services provide data storage, library management, data handling, and/or data processing services that are tailored to requirements associated with a particular market orchestration system EAL 1100 (e.g., in response to data requests and/or directed market transactions by the EAL 1000). In some examples, the configured system services uses the configured intelligence service system 300 to generate decisions relating to configurations of the set of transactional systems 1230. For instance, if the configured system service is to configure a smart contract as the configured transactional system, the configured system services leverages the intelligence of the configured intelligence service system 300 to formulate an intelligence request that will configure some portion of a smart contract (e.g., determine one or more parameter values corresponding to conditions defined in the smart contract).

In some implementations, the systems services that are configured to become the configured system services are the EAL systems of the EAL 1000. In other words, the configured system services uses intelligence generated by the configured intelligence services to configure aspects of the EAL 1000, such as the transaction system 1150 or the permissions system 1170. In some implementations, the configured system services not only configure input or control parameters of EAL systems that perform (e.g., the transaction system 1150) or evaluate transactions (e.g., the permissions system 1170), but also configure input or control parameters that impact the user experience or user interface of the EAL 1000 (e.g., configuration parameters associated with the interface system 1110). Here, since EAL systems may be associated with the configured system services, an EAL system may function via the configured system services as a requestor for a particular intelligence response.

In some configurations, such as FIG. 12, the configured system services is capable of performing general system services. These general system services may include operations such as data storage, data processing, networking, etc. that are configured for a particular function or set of functions. As shown in FIG. 12, these general system services may be integrated or controlled by the configured system services. However, in some configurations, it may be more advantageous for the general system services to be more widely available to aspects of the configured market orchestration system EAL 1100. Therefore, the general system services may be its own entity that is accessible to both the configured intelligence service system 300 and the configured system services, but not tethered specifically to the functionality or computing resources of either service.

In some configurations, a configured market orchestration system EAL 1100 is configured for a particular marketplace 922. As an example, the configured market orchestration system EAL 1100 is configured for a lending marketplace. For instance, the integrated EAL 1000c of the orchestrated lending marketplace 922c is a part of a configured market orchestration system EAL 1100 for the orchestrated lending marketplace 922c. In this example, the configured market orchestration system EAL 1100 via the set of transactional systems 1230 may perform tasks that may require external information (e.g., current market data) for functions, such as asset valuations, inventory access, business profile management, market analysis, etc. Depending on the task, subsequent tasks or analyses may be handled (e.g., directly handled) by the configured market orchestration system EAL 1100, by the EAL 1000, or some combination of both.

In some implementations for a configured market orchestration system EAL 1100, the workflow system 1140 of the EAL 1000 can manage or assist in managing one or more of the task-based information exchanges, analyses, and/or transactions by assembling workflow components, identifying pre-existing workflows, or developing workflows based on ML and AI methods. Examples of workflow components include: lookup of an asset serial number to determine a date of manufacture, existing service information, verification of ownership, etc. for the task of asset valuation and collateralization; reviewing business credit rating, claims, customer history, collateral to lending ratio, asset liquidity, etc. for the task of risk evaluation; determining minimum requirements for collateral, min/max allowable insurance for certain asset types, specific asset validation/verification requirements, etc. for the task of regulatory compliance; obtaining bid requests and analyses for the task of evaluation of insurance options and recommendations; and determining transaction type based on customer, client, regulation, etc. for the task of negotiation and completion of transactions.

To illustrate by an example, the workflow system 1140 may generate a set of workflow steps that define a task of a business loan request that proposes the use of machine tools as collateral for a loan to expand business. In this example, a first workflow step may be for the configured market orchestration system EAL 1100 to parse loan application information to identify equipment (collateral) types and characteristics. Here, a second workflow step may be that the configured market orchestration system EAL 1100 submits a preconfigured market-specific request to provide information associated with collateral resale value, liquidity, and market depth, including searches of relevant private or public marketplaces. Here, the EAL 1000 may provide a value range to the configured market orchestration system EAL 1100. A third workflow step may be that the configured market orchestration system EAL 1100 submits a preconfigured market-specific require for the EAL 1000 to obtain information associated with the business requesting the loan. In this workflow step, the EAL 1000 may return, for example, credit ratings, outstanding loans, and/or transactions histories. A fourth workflow step may be that the configured market orchestration system EAL 1100 submits a preconfigured market-specific risk analysis request to the EAL 1000 based on government and lender requirements. In some embodiments, this suggested EAL analysis could be automatically selected from a library developed for a type of loan or industry. As an alternative, this fourth workflow step may be completed by the configured market orchestration system EAL 1100 and then verified by the EAL 1000. A fifth workflow step may be based on the internal analyses and/or information provided by the EAL 1000. For instance, in this fifth workflow step, the configured market orchestration system EAL 1100 develops or selects an insurance bid package for submission to market participants. Here, as an example, the configured market orchestration system EAL 1100 may select the best option from among bidders. A sixth workflow step may be that the configured market orchestration system EAL 1100 engages the EAL 1000 to complete the transaction and submit the required documentation. This step may include a series of preconfigured functions selected for bid payment terms and methods, reporting requirements, etc.

With an EAL configuration, assets of an enterprise 900 can be natively integrated into marketplaces 922 without the enterprise 900 having to necessarily conduct advertising or marketing campaigns. That is, the transaction system 1150 in combination with the interface system 1110 can enable enterprise assets associated with wallet(s) to be readily available to marketplaces 922. This allows assets of the enterprise 900 to be market-facing without having to orchestrate product/service offering campaigns. In this respect, the assets can be offered natively on various platforms. Additionally, since the interface system 1110 and/or transaction system 1150 has access to multiple marketplaces, the EAL 1000 can offer assets in marketplaces that are not necessarily the same type of goods/services as the assets, but rather complimentary marketplaces or even marketplaces that are not traditionally offering assets with attributes similar to the available enterprise assets. For instance, an enterprise asset may be a financial asset and yet be offered or integrated into non-financial contexts. To facilitate the market for an asset, in embodiments, a reserve price may be associated with the asset, at which an enterprise is willing to part with the asset if and when it is sought by a market participant in one of the markets in which it can be viewed, such as by the aforementioned via wallet integration.

In some examples, the EAL 1000 allows the securitization and/or tokenization of future revenue streams for the enterprise 900. Here, an enterprise 900 can offer assets such as financial history, futures contracts, or other valuable enterprise insights (e.g., as asset-backed tokens) to secure capital or credit in various lending marketplaces. For instance, the enterprise 900 may request an instant cash advance against the full annual value of the enterprise's subscriptions or source of recurring revenue. This means that the enterprise 900 can leverage its various assets in traditional or non-traditional lending marketplaces that the EAL 1000 has the capability with which to interface. To illustrate, the EAL 1000 may be configured to translate subscription or recurring payment revenue (e.g., future revenue streams) into instant capital (i.e., cash). For example, the EAL may seek to mitigate risk of a substantive portion of expiring revenue streams and engage the available marketplaces 922 via the EAL 1000 to access a lender for these future enterprise assets.

In some configurations, to induce or to support lender transactions against future enterprise assets, the lender is able to request other enterprise assets (e.g., proprietary data sets) to form a basis, collateral, escrow, representation, or warranty against the transaction. As one example, the lender may offer a cash advance for future subscription revenue streams of the enterprise 900 with terms that a new product will launch according to some parameters indicated by enterprise data sets made available to the lender. In situations where the lender executes a transaction based on supporting enterprise data sets, the lender may also receive those enterprise data sets in the transaction, allowing the lender to engage with marketplaces 922 to sell the enterprise data sets if it so chooses. In this respect, lenders and market participants 910 transacting with an enterprise can leverage cross market transactions (e.g., as secondary revenue streams to support primary transactions).

In some implementations, when the enterprise 900 offers its revenue stream as an enterprise asset to secure lending (e.g., an instant cash advance), the result of the lending can be represented digitally by tokenization. In other words, even though the enterprise 900 has received non-digital currency (e.g., cash), the transaction system 1150 may represent that cash in digital form by a token such that the cash can operate as a digital enterprise asset that can participate in digital transactions using the EAL's capabilities. Additionally or alternatively, a smart contract corresponding to the loan/revenue stream may interface with an oracle that receives proof of payment from legacy off-chain systems and that reports verification of the received payment to the smart contract.

By being able to operate in a digital space, the EAL 1000 is able to employ different digital advantages to transactions. For instance, the assets such as operational assets, financial assets, or other assets can utilize tokenization to permit only a particular set of actions by selected stakeholders. The actions permitted by a token can be agreed upon according to consensus mechanisms by a set of stakeholders, or they can be dictated by a governing entity, such as an enterprise manager or executive. In some implementations, because these tokens are functioning to verify agreed upon actions, these tokens may be referred to as “verifiable action tokens.”

In some configurations, the tokenization can occur for any enterprise asset. For instance, certain enterprise assets (e.g., enterprise data sets) may include confidential or private information for (i) individuals associated with the enterprise 900, (ii) clients of the enterprise 900, or (iii) confidential information or actions of the enterprise 900, among others. Enterprise assets that include confidential or private information may be encoded or tokenized (e.g., by the data services system 1120) at the EAL 1000. By encoding the asset or some determined portion thereof, the enterprise 900 can offer assets relating to or including this information without compromising security, confidentiality, or privacy. In some examples, when tokenizing or encoding some or all of an enterprise asset, the reporting system 1180 generates a report or stores a ledger of these encoded events. By generating such as record, the EAL 1000 can allow the enterprise 900 to prove compliance or back trace its operations in case of an audit or other request of concern.

In some configurations, the EAL 1000 is able to facilitate transactions for market enterprise resources that may not be traditionally considered as exchangeable assets to the enterprise 900. It is becoming more common in the age of big data that data sets by themselves can be a valuable asset. For instance, with aspects of artificial intelligence becoming more prevalent, its intelligent capabilities often demand data sets that are used for training, such as to allow the AI to learn to perform some type of task or function. As a large organizational structure, the enterprise 900 can generate vast amount of data sets regarding its workings (e.g., operations, strategy, planning, sales, marketing, finances, human resource management, etc.) that can be valuable in the training of particular types of AI. For instance, an insurance company may be interested in the occupational conditions of workers that it insures, but finding a large, meaningful data set that characterizes occupational conditions may be rather difficult to find, at least publicly. Yet many enterprises 900 track or have data regarding their own occupational conditions. In this example, the insurance company would find it valuable to have access to data sets characterizing the occupational conditions of at least the enterprise 900. The EAL may provide access to such data sets, such as by representing them in a wallet or other system that can be accessed by market participants. Use of the data may be governed by governance and permissions systems as noted herein; for example, the data may be permitted to be accessed only in a machine-readable form that is accessible to a neural network or other AI system being trained. In embodiments, portions of the data, such as representing private information, may be anonymized, obfuscated, deleted, redacted, etc. to allow data to be used for training AI while not being used for other purposes. In embodiments, a set of governance policies for the data set may be configured such that the policies are automatically applied to any AI system that is trained using the data; for example, in order to access the training data set, the AI system may be required to demonstrate that it is governed by code or logic that validates that the AI system will be governed in the way required by the policies. As one example, the AI system may be permitted to operate only for a limited purpose, a limited time, in a limited location, by a limited type of party, etc.

The EAL configuration can allow market participants 910 to request or to form markets to which the enterprise 900 may have assets to contribute or from which the enterprise 900 may wish to obtain assets. For example, an insurance company may request data sets regarding occupational conditions, and the EAL 1000 may parse or receive that request and then determine whether it has the assets available to fulfill that request. When the requested asset is not available at the time of the request, the EAL 1000 may be configured to interface with the enterprise 900 to present the opportunity to the enterprise 900 and give the enterprise 900 the opportunity for fulfillment of the request. In other words, the available enterprise assets may not include an occupational conditions dataset, but when the EAL 1000 presents that request to the enterprise 900, the enterprise 900 determines that it can supply one or more data sets to fulfill that request and makes the one or more data sets available as enterprise assets via the transaction system 1150.

In some implementations, “data-as-a-transaction” (e.g., data sets as transacted entities) can contribute to context-based accommodations to transactions between parties. As an example, access to data (e.g., an enterprise asset) could be used by a party to gain advantages in pricing with an acceptance of an increase in risk. For instance, an insurer may allow a partial premium payment based on the delivery by the insured (e.g., the enterprise 900) of specified data types (i.e., specialized enterprise assets). Here, receipt of the specified data types may automatically trigger a smart contract to adjust or generate one or more terms regarding, for example, pricing, interest rates, conversion rates, deductibles, underwriting requirements, ancillary offerings, promotions, term duration, limits on liability, warranties and representations, etc. To illustrate, a factory of an enterprise may have a liability and workman's compensation policy with some amount of designated coverage. As party of the policy, there may be specified data thresholds regarding, for example, the number of employees on the floor per shift, the number of machine hours of operation per day, the types of machines in operation, the number of sick days, injury reports, and insurance status of employees. When the factory has enough data to satisfy (e.g., surpass or exceed) the specified thresholds, the data may be transferred to the insurer and provisions of the policy affected are adjusted based on the data transferred. For example, the factory sends data (i.e., an enterprise asset) that 83% of its employees are insured. Here, since this 83% exceeds an 80% threshold that allows for a reduction in the policy premium, the transfer of data causes the policy premium adjustment for the factory's policy; in embodiments, the premium may be further reduced if the insurer is permitted to use the data (possibly in anonymized, obfuscated, or otherwise modified form) for its own purposes, such as to facilitate more accurate underwriting or for generation of improved actuarial, economic or predictive models (including predictions of the emergence of insurable risks). In some configurations, the EAL transfers (i.e., a transaction of an enterprise asset) or facilitates the transfer of data along with a protocol request (e.g., a request to adjust the premium). The insurer may also leverage enterprise asset transactions to inform their contracts and policies. For instance, the insurer may generate a query for data from the enterprise (e.g., the factory) to ensure or audit that the conditions of the policy are being met. In other words, the insurer may query or request an enterprise asset transaction for data regarding the number of employees on the floor per shift. Here, if the number increased unbeknownst to the insurer, the query may inform the insurer to adjust the premium (e.g., to increase the premium because the factory has moved to a greater risk level based on the query results for the number of employees on the floor per shift).

When enterprise assets are various types of data sets, the enterprise 900 may have difficulty understanding the value of a particular data set. For instance, if an insurer would like to purchase data sets for working conditions of the enterprise 900 to facilitate products or services of the insurer (such as to tailor premium offerings to market participant conditions, to improve underwriting, to improve prediction, etc.), the enterprise 900 may be unable to properly value this enterprise asset due to its unconventional nature or the mere fact that it is not the type of asset with which the enterprise 900 is used to dealing. In these situations, the EAL 1000 may request or generate an evaluation marketplace, such as by sourcing (optionally by crowdsourcing) a set of target consumers (e.g., would-be data utilizers) to determine the estimated value for the data set. To generate an evaluation marketplace, the EAL 1000 may invite a set of would-be data providers (e.g., providers who could produce the type of data sets requiring valuation) and/or a set of would-be data utilizers (e.g., target consumers that could demand the types of data sets requiring valuation). In some examples, the parties that accept the invitations become virtual auction participants in order to provide a near-real market valuation of the data sets. That is, the participating would-be data provider posts or submits their data set (e.g., having one or more characteristics similar to the enterprise data set) and the participating would-be data utilizer(s) bid (e.g., propose an estimated value that they would pay) on the posted data set. In some configurations, this bidding process continues for each available data set from the pool of participating would-be data providers. In these configurations, the EAL 1000 may use statistical inference with the plurality of bids for the available data sets to generate a valuation for the similar data set owned by the enterprise 900. In some examples, the virtual auction house actually performs the offering of the enterprise data set during the auction so that the would-be data utilizers are not biased in their bidding. In embodiments, the EAL may, additionally, or alternatively, facilitate a set of simulations to help assess the value of the data, such as simulations that are informed by historical transactions in data sets having some similarity to available data sets, as well as informed by current marketplace conditions (such as offered prices of other data sets). In some examples, the participants in the virtual auction house engage with the virtual auction for evaluation purposes such that a participant does not receive the enterprise data set, but assists in its valuation for a future market offering. When functioning for a future market offering, it may be advantageous to include a large number of participants to statistically overcome potential bidding biases.

In some situations, following the valuation (such as using a virtual auction house, simulation, or other approached noted above), the EAL 1000 enables the enterprise 900 to further adjust the valuation of the data set. For instance, the EAL 1000 generates a feedback request to the enterprise 900 to authorize the estimated value assigned to the data set and the enterprise 900 provides a message in response to the feedback request that either approves the valuation or adjusts the valuation in some manner. Here, this adjustment feedback loop allows the enterprise 900 to determine if the valuation justifies the offering of the data set or if the enterprise 900 would prefer to offer the data set at a higher or lower transactional value compared to the valuation. For example, the value of the data set to the owner (i.e., the enterprise) may differ from the value of the data set to the market. Depending on the disconnect or gap between the owner value and the market value, the enterprise 900 may adjust the transaction value accordingly. Similarly, being informed by the valuation can also enable the enterprise 900 to opt out of offering the data set.

In some configurations, the EAL 1000 controlled by an enterprise 900 receives a data set from the enterprise 900. Here, the data set may characterize one or more attributes associated with a group of resources privately controlled by the enterprise 900. For instance, the data set may characterize information about a group of employees of the enterprise 900 (e.g., factory workers) or a group of equipment (e.g., production equipment of the enterprise 900). Upon receipt of the data set, the permissions system 1170 determines whether the data set satisfies a set of permission criteria. The permission criteria may refer to criteria that indicates a set of privacy rules, access rules, security rules, compliance rules, or other rules applicable to assets, resources or other entities that are controlled by the enterprise 900. The enterprise 900 or its agent may configure these rules or generate the rules to correspond to industry/legal standards (e.g., dictated by the governance system 1160), such as of acceptable privacy (e.g., to abide by the Health Insurance Portability and Accountability Act (HIPAA) or General Data Protection Regulation (GDPR)), etc.

Depending on the determination of whether the data set satisfies the set of permission criteria, the permissions system 1170 may perform different operations. For instance, in response to the data set failing to satisfy the permission criteria, the permissions system 1170 may communicate the data set to the data services system 1120. In embodiments, the permissions system 1170 recognizes that the data set needs further data processing and cooperates with the data services system 1120 of the EAL 1000 to perform that processing. In these configurations, the further processing may be that the data services system 1120 generates an encoded data set that satisfies the privacy or other rules identified by the permissions system 1170 for the data set. With the encoded data set that complies with the rules identified by the permissions system 1170, the EAL 1000 converts the encoded data set to an exchangeable digital asset. This conversion may occur by the EAL 1000 publishing the encoded data set to the transaction system 1150 and configuring the interface system 1110 with access to the encoded data set in the transaction system 1150 such that market participants 910 can access and/or request transactions for the encoded data set. On the other hand, if the permissions system 1170 determined that the data set satisfies the permission criteria, the EAL 1000 may convert the data set to an exchangeable digital asset in the same manner without the data processing encoding operation. In embodiments, encoding operations may include embedding applicable rules, such as licensing terms and conditions, for use of the data set, such that upon subsequent use of the data set such rules are automatically applied (e.g., to limit the number of seats that can access the data, to monitor and govern the number of queries or other restrictions permitted, to limit access to sensitive data contained in the data set (e.g., to allow aggregate queries but to limit queries from which private information can be deduced), to limit the location of use, to limit duration of use, to govern which systems or types of systems can access the data, etc.).

In embodiments, the EAL 1000 may be set up to operate as a data plane and control plane for the enterprise 900. In embodiments, when operating as a data plane, the EAL 1000 may be configured to exchange assets privately-generated by an enterprise 900 or enterprise entity that operates it. When configured in this manner, the EAL 1000 may receive an asset request from a requesting entity, such as a market participant 910 with access to the EAL 1000 (e.g., via the interface system 1110). Here, the asset request indicates an asset that may be available for transaction, such as discovered in a transaction system 1150 (e.g., is associated with a wallet of the transaction system 1150) or other presentation interface. Based on the request, the permissions system 1170 identifies whether there are any asset controls (e.g., access controls or permissions assigned to an asset) associated with the requested asset. Here, the permissions system 1170 may have configured the asset control for the asset to indicate a control parameter that must be satisfied prior to any transactional action occurring for the asset. In some examples, the intelligence system 1130 is able to determine control parameters for the permissions system 1170 using data derived from the enterprise 900 that privately generated the asset. In other words, the intelligence system 1130 can predict or determine a control parameter based on historical data modeling of controls for assets of the enterprise or for controls of assets similar to the assets of the enterprise.

In response to the permissions system 1170 identifying an asset control condition associated with the requested asset, the permissions system 1170 proceeds to determine whether the asset control condition is satisfied, such as, for example, by one or more parameters of the asset requests and/or by one or more attributes of the requesting entity. For instance, the asset control may designate what type of entity is able to access the asset or some set of requirements that must be met by the asset request and/or requesting entity to gain permission to access the asset (e.g., perform a transaction with the asset). In response to the asset control condition being satisfied, the EAL 1000 may facilitate fulfillment of the asset request. On the other hand, if the permissions system 1170 determines that the asset control condition is not satisfied, the requesting entity/asset request is denied. In some configurations, denial of the request generates a message that indicates the denial. This message may include some amount of information detailing the reasons for denial and/or prompting modifications in the asset request and/or requesting entity that would enable the request to be satisfied.

In some implementations, the EAL 1000 receives an asset request from a requesting entity (e.g., a market participant 910) where the asset request indicates an asset that is available in the transaction system 1150 as an exchangeable digital asset. In these implementations, exchangeable digital assets of the enterprise 900 correspond to one or more assets stored in a private data structure (e.g., a private blockchain) associated with an owner of the exchangeable digital assets (e.g., the enterprise 900). Based on the request, the EAL 1000 identifies whether there are any asset controls (e.g., access controls or permissions assigned to an asset) associated with the requested asset. Here, the permissions system 1170 may have configured the asset control for the asset to indicate a control parameter that must be satisfied prior to any transactional action occurring for the asset. Similar to the prior discussed configurations of the EAL 1000, the intelligence system 1130 is able to determine control parameters for the permissions system 1170 using data derived from the enterprise 900 that privately generated the asset.

In response to the EAL 1000 (e.g., the permissions system 1170) identifying an asset control associated with the requested asset, the permissions system 1170 proceeds to determine whether the asset control is satisfied by at least one of the asset requests or by the requesting entity. For instance, the asset control designates what type of entity is able to access the asset or some set of requirements that must be met by the asset request and/or requesting entity to gain permission to access the asset (e.g., perform a transaction with the asset). In response to the asset control being satisfied, the EAL 1000 may facilitate fulfillment of the asset request. Yet here, fulfillment of the asset request includes storing the asset in a public append-only data structure (e.g., a public blockchain) to represent a transaction involving the asset with the requesting entity. On the other hand, if the permissions system 1170 determines that the asset control fails to be satisfied, the requesting entity/asset request is denied and a denial message (as previously discussed) may be communicated to the requesting entity. With this approach, the EAL 1000 is able to function as a facilitator or executor for transactions that demand operations on both a private data structure (e.g., a private blockchain) and a public data structure (e.g., a public blockchain).

In some examples, the EAL 1000 receives a set of assets generated or controlled by the enterprise 900. For each asset of the set of assets, the EAL 1000 may classify (e.g., using the intelligence system 1130) the respective asset into an asset category, which may include classifying the asset into an asset control category. Here, each asset category is associated with a set of rules, such as assets controls, that dictate one or more transaction parameters for the exchange of the respective asset with a third party (e.g., a market participant 910). Moreover, for each asset of the set of assets, the EAL 1000 (e.g., using the permissions system 1170) may assign the set of asset rules for the access category classified by the EAL 1000 for the respective asset. In these examples, the EAL 1000 then converts the set of assets to exchangeable digital assets by publishing the set of assets to the transaction system 1150 and configuring the interface system 1110 with access to the set of the transaction system 1150. In embodiments, asset categories may be associated with a defined set of marketplaces, exchanges, or other environments in which assets may be transacted, such that a set of rules appropriate for the classified asset may be derived by reference to the governing rules of the applicable transaction environment; for example, assets classified as commodities may be governed by rules of a commodities exchange, assets classified as securities may be governed by rules of a securities exchange, assets classified as cryptocurrencies may be governed by rules of a cryptocurrency exchange, etc. Asset classification may be learned using any of the artificial intelligence or learning techniques described herein, such as on a training data set of historical transactions (e.g., by observing which type of asset objects are traded in which environments), by training on human classification interactions (such as tagging of assets), etc. Training may be seeded or assisted by a model, such as an asset classification model that classifies or clusters assets based on data object parameters. This may include a hierarchical model or graph with classes and subclasses of asset types.

In some embodiments, the EAL 1000 may also function as a type of monitoring system. For example, the EAL 1000 may be configured to automatically monitor or mine for potential deals or transactions that could involve the enterprise assets that it manages and/or to monitor or mine for opportunities to acquire assets that it wishes to acquire. In some configurations, the EAL 1000 monitors (e.g., via its interface system 1110) a plurality of market participants 910. While monitoring the plurality of market participants 910, the EAL 1000 may receive an indication that a monitored market participant 910 requests or offers an asset candidate or type of asset. In the case of a request for an asset or type, the EAL 1000 determines (e.g., via using the intelligence system 1130) whether the asset candidate matches (or is similar to) an asset available in the transaction system 1150 associated with the EAL 1000. If the asset candidate does not match any available assets in the transaction system 1150, the EAL 1000 may continue to perform monitoring services for other asset candidates. In the case of offers, the EAL 1000 may receive an indication of the parameters of an offer of a digital asset or type, compare the offer to a set of desired transaction parameters, and, if the parameters are satisfied, initiate a transaction to acquire the asset.

In response to a request matching an asset available in the transaction system 1150, the EAL 1000 may be configured to perform a set of operations that further analyze whether to engage or to offer to engage in an asset transaction with the monitored market participant 910. These operations may include identifying a set of asset control conditions managed by the permissions system 1170 of the EAL 1000 and determining whether a transaction (e.g., a digital exchange) with the monitored market participant 910 satisfies an asset control criterion corresponding to the asset available in the transaction system 1150 (i.e., the matching asset). For instance, the asset control criterion may indicate that a threshold number has been exceeded. In response to determining that the transaction with the monitored market participant 910 that involves the asset available in the transaction system 1150 satisfies any asset control criteria (e.g., does not violate a threshold), the EAL 1000 may generate a message data packet that proposes an actual transaction with the market participant 910 involving the asset available. In some examples, the interface system 1110 communicates the message data packet on behalf of the EAL 1000 to the market participant 910.

In embodiments, an EAL 1000 may be configured as a multi-tenant EAL 1000, where the functions and capabilities of the EAL 1000 are made available to more than one enterprise (or to more than one business unit of an enterprise), such that processing resources and facilities (e.g., data centers and network infrastructure), operating resources (such as personnel), and others are shared across tenants, while the functions and capabilities of the EAL 1000 are governed and executed with awareness of the access rights and other attributes of each tenant. For example, two (or more) enterprises may share an EAL 1000, such as where the enterprises operate in a similar domain and/or undertake similar transactions, such that the marketplaces, exchanges, or other transactions with which the EAL 1000 are similar for the two enterprises. The EAL 1000 may monitor usage of each tenant, provision resources (such as according to relative priorities), maintain separation of enterprise-specific elements (e.g., wallets of each enterprise), handle billing transactions for usage, etc. In embodiments, transactions across multiple tenants may be aggregated to achieve volume discounts, with discounts being automatically allocated and applied according to a set of rules (such as based on proportionate contribution to transactions). In embodiments, tenancy may be managed in a set of tiers, such as with each tier having a set of service levels associated therewith, such as enabling usage of given sets of functions and capabilities of the EAL 1000, setting relative prioritization (e.g., with higher tiers being given priority where transactions are limited, where resources are limited), etc.

In embodiments, the EAL 1000 may be configured for peer-to-peer connectivity among a set of enterprises (e.g., bilateral connectivity or multilateral connectivity), such that the functions and capabilities of the EAL 1000 are configured to handle the particular types of assets, resources, workflows and transactions that occur among the enterprises. For example, a bank and a manufacturing entity may establish a peer-to-peer EAL 1000 for a set of financial transactions, including working capital loans, trade credit lending, handling of deposits, payroll processing, payments processing, and others. In this example, the assets of the manufacturing enterprise may be presented in a wallet in the EAL 1000 that is on accessible to the manufacturing entity and to lending officers of the bank, such that the lending assets can be configured to be used as collateral for lending transactions. For example, the EAL may facilitate automated generation of sets for collateral for a set of loans among the manufacturing enterprise and the bank. In another example, a third entity, such as a secondary lender, underwriter, insurer, etc. may be added to the EAL 1000, such as to facilitate multi-party transactions. In other embodiments, a multi-party, peer-to-peer EAL 1000 may handle transactions among a set of parties participating in a supply chain, such as tiers of component manufacturers that provide components of systems manufactured by an OEM. A peer-to-peer EAL 1000 may be established between a manufacturer or retailer with a set of preferred customers, such as repeat customers, such that the EAL allows the preferred customers access to view inventories (as presented in a wallet) in a manner that has priority over the access by the general public. The peer-to-peer EAL 1000 may include governing rules that are customized to each party (e.g., setting rules for what assets and transactions are presented or permitted), may provision and prioritize resources (e.g., for storage, processing, networking, etc.) among parties, may allocate costs, etc. The configured services of the EAL 1000 (of any of the types described herein), may include ones that are configured for the needs of each party, such as by learning on historical transactions of that party and/or on similarly situated other parties (such as ones from similar domains). In some embodiments, the peer-to-peer EAL 1000 may be a multi-tenant, peer-to-peer EAL 1000 having features described above.

Although the EAL 1000 has been generally described with respect to digital enterprise asset functionality, the EAL 1000 is not limited to digital assets, but may also perform its functionality for non-digital assets. For example, for a non-digital enterprise asset, the EAL 1000 may facilitate non-asset transactions by: managing transactional parties, permissions, logistics, or recordation of a transaction in some manner; providing intermediary services (e.g., escrow services for a physical transaction, authentication services, etc.); generating a digital object (e.g., a token or a transactional record) to indicate that a non-digital asset transaction has occurred; or processing/storing digital files related to a non-digital asset. As previously described, a physical resource, which may be considered a non-digital enterprise asset, may have associated documentation (e.g., certificate of authenticity, proof of purchase, deed, title, etc.). With associated documentation that can be generated, modified, transferred, processed, and/or stored in a digital context, the EAL 1000 can function to represent and/or manage some of all of these transactional instances.

In some implementations, the EAL 1000 may be configured to perform the transaction and/or to generate a record of the transaction for digital storage. For instance, the EAL 1000 generates a record of the transaction and stores the record on one or more blockchains (e.g., private blockchain associated with the enterprise and/or a public blockchain). In some configurations, similar to a digital asset transaction, when the EAL 1000 is integrated with the performance of a non-digital asset transaction, the capabilities of the EAL 1000 may generate records that store detailed information regarding a transaction. This detailed information may be information such as the enterprise's agent who authorized the transaction, any permissions required or satisfied to perform the transaction, any governance involved to perform the transaction, any decision-making intelligence requested/relied upon to perform the transaction, any data processing/data retrieval involved to perform the transaction, etc. In other words, the detailed information can log or record services performed by EAL systems or entities in cooperation with EAL systems.

### Graph Neural Networks and Transformer Models in Artificial Intelligence Platforms

### Graph Neural Networks—Introduction

In various embodiments, one or more techniques involve the processing of graph data using one or more machine learning algorithms. In some such embodiments, the one or more machine learning algorithms include one or more graph neural networks (GNNs). The following discussion provides an overview of graph data and graph neural networks.

In a graph data set, a set of nodes is interconnected by one or more edges that respectively represents a relationship among two or more connected nodes. In many graph data sets, each edge connects two nodes. In other graph data sets that represent hypergraphs, a hyperedge can connect three or more nodes. In various graph data sets, each of the one or more edges is directed or undirected. An undirected edge represents a relationship that relates two or more nodes without any particular ordering of the related nodes. A first undirected relationship that connects a first node N1 and a second node N2 may be equivalent to a second undirected relationship that also connects a first node N1 and a second node N2. In some such graphs, the relationship represents a group to which the two or more related nodes belong. In some such graphs, the relationship represents an undirected and/or omnidirectional connection between two or more nodes. For example, in a graph representing a geographic region, each node may represent a city, and each edge may represent a road that connects two or more cities and that can be traveled in either direction. By contrast, a directed edge includes a direction of the relationship between a first node and a second node. For example, in a graph representing a genealogy or lineage, each node represents a person, and each edge connects a parent to a child. A first directed edge that connects a first node N1 to a second node N2 is not equivalent to a second directed edge that connects the second node N2 to the first node N1. Some graph data sets include one or more unidirectional edges, that is, an edge with one direction among two or more connected nodes. Some graph data sets include one or more multidirectional edges, that is, an edge with two or more directions among the two or more connected nodes. Some graph data sets may include one or more undirected edges, one or more unidirectional edges, and/or one or more multidirectional edges. For example, in a graph representing a geographic region, each node may represent a city; one or more unidirectional edges may represent a one-way road that connects a first city to a second city and can only be traveled from the first city to the second city; and one or more bidirectional or undirected edges that represent a bidirectional road between the first city and the second city that can be traveled in either direction. Some graph data may include, for two or more nodes, a plurality of edges that interconnect the two or more nodes. For example, a graph data set representing a collection of devices may include nodes that respectively correspond to each device of the collection and edges that respectively correspond to an instance of communication and/or interaction among two or more of the devices. In such a graph data set, a particular subset of two or more devices may engage in a plurality, including a multitude, of instances of communication and/or interaction, and may therefore be connected by a plurality, including a multitude, of edges.

Some directed and/or undirected graph data sets may include one or more cycles. For example, in a graph representing a social network, a first edge E1 may connect a first node N1 (representing a first person) and a second node N2 (representing a second person) to represent a relationship between the first person and the second person. A second edge E2 may connect the second node N2 and a third node N3 (representing a third person) to represent a relationship between the second person and the third person. A third edge E3 may connect the third node N3 and the first node N1 to represent a relationship between the third person and the first person. Such cycles can occur in undirected graphs (e.g., edges in a social network graph that indicate mutual relationships among two or more individuals), directed graphs (e.g., edges in a social network graph that indicate that a first person is influenced by a second person, a second person is influenced by a third person, and a third person is influenced by the first person), and/or hypergraphs (e.g., cycles of relationships among three or more clusters that respectively include three or more nodes). Some cyclic graphs may include one or more cycles that are interlinked (e.g., one or more nodes and/or edges that are included in two or more cycles). Other directed and/or undirected graph data sets may be acyclic (e.g., graphs in which nodes are strictly arranged according to a top-down hierarchy). Still other directed and/or undirected graph data sets may be partially acyclic (e.g., mostly acyclic) but may include one or more cycles among one or more subsets of nodes and/or edges.

In some graph data sets, one or more nodes includes one or more node properties. For example, in a graph representing a geographic area, each node may represent a city, and each node may include one or more node properties that correspond to one or more properties of the city, such as a size, a population, or a latitude and/or longitude coordinate. Each node property may be of various types, including (without limitation) a Boolean value, an integer, a floating-point number, a set of numbers such as a vector, a string, or the like. In some graph data sets, one or more nodes does not include a node property. For example, in a graph data set representing a set of particles, each particle may be identical to each other particle, and there may be no specific data that distinguishes any particle from any other particular. Thus, the nodes of the graph data set may not include any node properties.

In some graph data sets, one or more edges includes one or more edge properties. For example, in a graph representing a geographic area, each edge may represent a road, and each edge may include one or more edge properties that correspond to one or more properties of the road, such as a distance, a number of lanes, a direction, a speed limit, a volume of traffic, a start latitude and/or longitude coordinate, and/or an ending latitude and/or longitude coordinate. In some graph data sets, a direction of an edge may be represented as an edge property. Alternatively or additionally, in some graph data sets, a direction of an edge may be represented separately from one or more edge properties. In some graph data sets, one or more edges does not include an edge property. For example, in a graph data set representing a line drawing of a set of points, each edge may represent a line connecting two points, and the edges may be significant only due to connecting two points. Thus, the edges of the graph data sets may not include any edge properties.

In some graph data sets, the graph includes one or more graph properties. Such graph properties may be global graph properties that correspond to one or more properties of the entire graph. For example, in a graph data set representing a geographic region, the graph may include graph properties such as a total number of nodes and/or cities, a two-dimensional or three-dimensional area represented by the graph, and/or a latitude and/or longitude of a center of the graph. Such graph properties may be global graph properties that correspond to one or more properties of all of the nodes of the graph. For example, in a graph data set representing a geographic region, the graph may include graph properties such as an average population size of the cities represented by the nodes and/or an average connectedness of each city to other cities included in the graph.

Some graph data sets include a single set of data that includes all nodes and all edges. For example, a graph representing a geographic region may include a set of nodes that represent all cities in the geographic region. Some other graph data sets include one or more subgraphs, wherein each subgraph includes a subset of the nodes of the graph and/or a subset of the edges of the graph. For example, a graph representing a geographic region may include a number of subgraphs, each representing a subregion of the geographic region, and the edges that interconnect the cities within each subregion. As another example, a graph representing a geographic region may include a first subgraph representing cities (e.g., groups of people over a threshold population size and/or population density) and a second subgraph representing towns (e.g., groups of people under the threshold population size and/or population density). In some graph data sets, each node and/or each edge belongs exclusively to one subgraph. In some graph data sets, at least one node and/or at least one edge can belong to two or more subgraphs. For example, in a graph representing a geographic region that includes a number of subgraphs respectively representing different geographic subregion, each node representing a city may be exclusively included in one subgraph, while each edge may interconnect two or more cities within one subgraph (i.e., within one subregion) or may interconnect a first city in a first subgraph (i.e., within a first subregion) and a second city in a second subgraph (i.e., within a second subregion).

Graph neural networks can include features and/or functionality that are the same as or similar to the features and/or functionality of other neural networks. For example, graph neural networks include one or more neurons arranged in various configurations. Each neuron receives one or more inputs from the graph data set or another neuron, evaluates the one or more inputs (e.g., via an activation function), and generates one or more outputs that are delivered to one or more other neurons and/or as an output of the graph neural network. Examples of activation functions that can be included in various neurons of the graph neural network include (without limitation) a Heaviside or unit step activation function, a linear activation function, a rectified linear unit (ReLU) activation function, a logistic activation function, a tanh activation function, a hyperbolic activation function, or the like.

As an example, some graph neural networks include only a single neuron, or only a single layer of neurons that is configured to receive graph data as input and to provide graph data as output of the graph neural network. Some graph neural networks are arranged in a series of two or more layers, wherein input is received by neurons included in a first layer. The output of one or more neurons included in the first layer is delivered, as input, to one or more neurons included in a second layer. For example, each neuron in the first layer may include one or more synapses that respectively interconnect the neuron to one or more neurons of the second layer. In many graph neural networks, each neuron N1 of a preceding layer L1 is connected to each neuron N2 of a following layer by a synapse that includes a weight W. Neuron N2 receives, as input, the output of the neuron N1 multiplied by the weight of the synapse connecting neuron N1 and neuron N2. In many neural networks, layer L1 includes a bias B, which is added to the product of the output of neuron N1 and the weight W of the synapse connecting neuron N1 and neuron N2. As a result, the input to neuron N2 includes the sum of the bias B of layer L1 and the product of the output of neuron N1 and the weight W of the synapse connecting neuron N1 and neuron N2. The output of the neurons included in the second layer can be provided as an output of the graph neural network and/or as input to one or more neurons included in a third layer. Each layer of the graph neural network may include a same number of neurons as a preceding and/or following layer of the graph neural network, or a different number of neurons as preceding and/or following layer of the graph neural network.

As another example, some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. For example, some graph neural networks (e.g., graph convolution networks) include one or more convolutional layers, each of which performs a convolution operation to an output of neurons of a preceding layer of the graph neural network.

As another example, some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells.

As another example, some graph neural networks feature recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input. As another example, some graph neural networks may include one or more skip connections, in which at least a portion of an output of a first layer is provided as input to a third layer without being processed by a second layer. That is, the output of the first layer is provided as input both to the second layer (which generates a second layer output) and to the third layer. In some such graph neural networks, the third layer receives, as input, either the output of the first layer or the output of the second layer. That is, the third layer multiplexes between the output of the first layer and the output of the second layer. Alternatively or additionally, in some such graph neural networks, the third layer receives, as input, both the output of the first layer and the output of the second layer (e.g., as a concatenation of the output vectors to generate the input vector for the third layer), and/or an aggregation of the output of the first layer and the output of the second layer (e.g., a sum or average of the output of the first layer and the output of the second layer). Examples of graph neural networks that include one or more skip connections include jump knowledge networks and highway graph neural networks (highway GNNs).

As another example, some graph neural networks include two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In these and other graph neural networks, the number of layers and the configuration of each layer of the graph neural network (e.g., the number of neurons and the activation function used by each neuron of each layer) can be referred to as hyperparameters of the graph neural network that are determined upon generation of the graph neural network. The weights of node synapses and/or the biases of the layers can be referred to as parameters of the graph neural network that are learned through a training or retraining process. Further explanation and/or examples of various concepts of other types of neural networks that can also apply to graph neural networks, and additional concepts that apply to other types of neural networks that can also be included in graph neural networks, are presented elsewhere in this disclosure and/or will be known to or appreciated by persons skilled in the art.

Unlike other types of neural networks, graph neural networks are configured to receive, process, generate, and/or transform one or more graph data sets. Some graph neural networks are configured to receive data representing and/or derived from a graph data set, such as an input vector that includes data representing one or more nodes of the graph (optionally including one or more node properties of one or more nodes), one or more edges of the graph (optionally including one or more edge properties of one or more edges), and/or one or more graph properties of the graph. Some graph neural networks are configured to receive an input vector comprising all of the data of a graph data set (e.g., all of the data representing all nodes, all edges, and the graph). Some graph neural networks are configured to receive an input vector comprising only a portion of the data of a graph data set (e.g., only a subset of the nodes of the graph and/or only a subset of the edges of the graph). For example, some graph data sets include a number of subgraphs, and the input vector to the graph neural network includes the data for all of the nodes and/or all of the edges included in one subgraph of the graph. The entire graph can be processed by processing (e.g., concurrently and/or consecutively) each subgraph and combining the output resulting from the processing of each subgraph. As another example, a graph data set representing a set of users of a social network may be processed by a graph neural network that receives, as input, a subset of nodes that correspond to the most influential users of the social network (e.g., those having more than a threshold number of social network connections) and a subset of edges that interconnect the nodes representing those users. Some graph neural networks are configured to receive, as input, data derived from a graph neural network. For example, a graph data set representing a social network may be processed by a graph neural network that receives, as input, data associated with messages exchanged among users of the social network, and provides, as output, an analysis of the messages. Some graph neural networks are configured to receive, as input, non-graph data (e.g., an input vector including coordinates of roads and/or cities in a geographic region) and generate graph data as output (e.g., a graph including odes that represent the cities, and edges that represent roads interconnecting the nodes representing the cities).

Some graph neural networks are configured to process input data as graph data. As an example, some graph neural networks are configured to receive, as input, data that represents each of one or more nodes of a graph data set and one or more edges that respectively interconnect two or more nodes of the graph data set. The graph neural network may process a state of each node and/or edge of the input graph data in order to generate an updated state of the node and/or edge. The term “message passing” refers to evaluating and updating the state of a node N or an edge E of a graph based on the states of one or more neighboring nodes N and/or connecting edges E. For example, for each node N1, the graph neural network may evaluate the state of node N1 and/or states of a set of nodes N that are connected to node N1 by at least one edge (e.g., a neighborhood of nodes that includes N1) and may determine an updated state of node N1 based on the state of the node N1 and/or the states of the neighboring nodes N. As another example, for each node N1, the graph neural network may evaluate the state of the node N1 and/or the states of a set of edges E that connect node N1 to one or more other nodes of the graph, and may determine an updated state of node N1 based on the state of the node N1 and/or the states of the edges E. As yet another example, for each edge E1 of the input graph, the graph neural network may evaluate a state of the edge E1 and/or the states of a set of nodes N of the graph that are connected to the edge E1 and may determine an updated state of edge E1 based on the state of the edge E1 and/or the states of the connected nodes N. As yet another example, for each edge E1 of the input graph that connects a set of nodes N of the graph, the graph neural network may evaluate the state of the edge E1 and the states of the set of edges E that are also connected at least one of the set of nodes N and may determine an updated state of edge E1 based on the state of the edge E1 and/or the states of the other edges. In these and other scenarios, each node N and/or each edge E is evaluated and updated based on a collection of “messages” corresponding to the states of neighboring nodes N and/or connecting edges E.

In some graph neural networks, each node N1 is updated based a neighborhood of size 1, including only on the states of the edges E that are directly connected to node N1 and/or the states of the other nodes N that are directly connected to node N1 by an edge. In some other graph neural networks, each node N1 is updated based a neighborhood of a size S greater than 1, including the states of other nodes N that are within S edge connections of node N1 and/or edges E that are connected to any such nodes N. In some graph neural networks, each edge E1 is updated based a neighborhood of size 1, including only on the states of the nodes N that edge E1 connects and/or the edges E that are also connected to the nodes N that edge E1 connects. In some other graph neural networks, each edge E1 is updated based a neighborhood of a size S greater than 1, including the states of other nodes N that are within S edge connections of node N1 and/or the set of edges E that are connected to any such nodes N. In some graph neural networks with a neighborhood of size greater than 1, one or more first layers of neurons process each node and/or edge based on the nodes and/or edges within a neighborhood of size 1; a second one or more following layers of neurons further process each node and/or edge based on the nodes and/or edges within a neighborhood of size 2; and so on. That is, the first one or more layers update the state of each node and/or edge based on the states of the directly connected nodes and/or edges, and each following one or more layers further updates the state of each node and/or edge additionally based on the states of indirectly connected nodes and/or edges that are one or more further connections.

In some graph neural networks, the states of nodes N and/or edges E are evaluated and updated concurrently (e.g., the graph neural network may evaluate the features relevant to each node N and/or each edge E to determine an update, and may do so for all nodes N and/or all edges E, before applying the updates to update the internal states of each node N and/or each edge E). In some graph neural networks, the states of nodes N and/or edges E are evaluated and updated consecutively (e.g., the graph neural network may evaluate the features relevant to a first node N1 and update the state of node N1 before evaluating the features relevant to a second node N2 and updating the state of node N2). In some graph neural networks, the states of the nodes N and/or the edges E are consecutively evaluated and updated according to a sequential order (e.g., the graph neural network first evaluates and updates a state of a first node N1 that is of a high priority, and then evaluates and updates a state of a first node N2 that is of a lower priority than N1). In some graph neural networks, a state of a node N2 is evaluated after updating a state of a node N1 and, further, based on the updated state of node N1. In some graph neural networks, a state of an edge E2 is evaluated after updating a state of an edge E1 and, further, based on the updated state of an edge E1. In some graph neural networks, the states of nodes N are concurrently evaluated and updated, and then the states of edges E are concurrently evaluated and updated concurrently. In some graph neural networks, the states of edges E are concurrently evaluated and updated, and then the states of nodes N are concurrently evaluated and updated concurrently. These variations in the order of updating the nodes N and/or edges E can be variously combined with the previously discussed variations in the processing of neighborhoods. For example, a graph neural network may include a first one or more layers that are configured to evaluate and concurrently update the states of all nodes and edges within a neighborhood of size 1, followed by a second one or more layers that are configured to evaluate and concurrently update the states of all nodes and edges within a neighborhood of size 2. Another graph neural network may a graph neural network may include a first one or more layers that are configured to evaluate and concurrently update the states of all nodes within a neighborhood of size 1, followed by a second one or more layers that are configured to evaluate and concurrently update the states of all nodes within a neighborhood of size 2, further followed by one or more layers that are configured to update the states of all edges within a neighborhood of size 1 or more.

Some graph neural networks are configured to evaluate and/or update one or more node properties of one or more nodes of a graph data set. For example, a graph representing a social network may include nodes that represent people, and a graph neural network may evaluate the nodes and/or edges of the graph to predict one or more node properties that correspond to attributes of the person, such as a type of the person, an age of the person, or an opinion of the person. Some graph neural networks are configured to evaluate and/or update one or more edge properties of one or more edges of a graph data set. Some graph neural networks are configured to evaluate and/or update one or more edge properties of one or more edges of a graph data set. For example, a graph representing a social network may include nodes that represent people and edges that represent relationships between people, and a graph neural network may evaluate the nodes and/or edges of the graph to predict one or more edge properties that correspond to attributes of a relationship among two or more people, such as a type of the relationship, a strength of a relationship, or a recency of the relationship. Some graph neural networks are configured to evaluate and/or update one or more graph properties of the graph data set. For example, a graph representing a social network may include nodes that represent people and edges that represent relationships between people, and a graph neural network may evaluate the nodes and/or edges of the graph to predict a feature of a social group to which all of the people belong, such as a common interest or a common demographic trait that is shared by at least many of the people of the social network.

Some graph neural networks are configured to generate graph data as output. The generated graph data may include one or more nodes (optionally including one or more node properties), one or more edges (optionally including one or more edge properties), and/or one or more graph properties. The generated graph data may be based on input graph data. Some graph neural networks may be configured to receive at least a portion of a graph data set as input, and may generate, as output, modified graph data. As an example, the input graph data set may include a number of nodes and a number of edges interconnecting the nodes, and in the output graph data set generated by the graph neural network, each of the nodes and/or edges of the graph may have been updated based on one or more nodes and/or one or more edges of the input graph data. For example, an input graph data set may represent a social network including a nodes representing people and edges representing relationships between people. A graph neural network may be configured to receive at least a portion of the input graph data set, and may output an adjusted graph data set, wherein a state at least one of the nodes and/or at least one of the edges is updated based on the processing of the input data set. For example, various edges representing relationships may be updated to include additional data (e.g., edge properties) to represent an updated relationship between two people represented by nodes. Various nodes may be updated with to include additional data (e.g., node properties) to represent updated information about corresponding people based on the relationships. Various graph properties of the at least a portion of the graph data set may be updated based on the updated edges and/or nodes, e.g., a new common interest that is shared among many of the people in the social network.

Some graph neural networks may be configured to output graph data that includes one or more newly discovered nodes based on the input graph data set. For example, an input graph data set representing travel events may include edges that include routes of travelers and nodes that represent locations of interest. A graph neural network may receive the input graph data set, and based on processing of the routes of the travelers, may output an updated graph data set that includes a new node that represents a new location of interest (e.g., a destination of a large number of recent travelers). The output of the graph neural network may include, for one or more new or existing nodes, one or more new or updated node properties (e.g., a classification of the location of interest based on the travel routes). Alternatively or additionally, some graph neural networks may be configured to output graph data that excludes one or more existing nodes of an input graph data set. For example, based on processing the input data set representing routes of travelers, a graph neural network may output an updated graph data set that excludes one of the nodes of the input graph data set representing a location that is no longer a location of interest (e.g., a destination that travelers no longer visit).

Some graph neural networks may be configured to output graph data that includes one or more newly discovered edges based on the input graph data set. For example, an input graph data set may represent a social network including nodes that represent people and edges that represent connections between people. A graph neural network may receive the input graph data set, and based on processing of the people and connections, may output an updated graph data set that includes a new connection between two people (e.g., a likely relationship based on shared traits and/or mutual relationships with a number of other people representing a social circle). The output of the graph neural network may include, for one or more new or existing edges, one or more new or updated edge properties (e.g., a classification of a relationship between two or more people). Alternatively or additionally, some graph neural networks may be configured to output graph data that excludes one or more existing edges of an input graph data set. For example, based on processing the input data set representing a social network, a graph neural network may output an updated graph data set that excludes one or more of the edges of the input data set representing a relationship that no longer exists (e.g., a lost connection based on a splitting of a social circle).

Some graph neural networks may output graph data that is based on data that does not represent an input graph data set. For example, a graph neural network may be configured to receive non-graph data, such as lists of travel routes of drivers, and may generate and output a graph data set including nodes that represent locations of interest and edges that interconnect the locations of interest. Conversely, some graph neural networks may receive input that includes at least a portion of a graph data set and that outputs non-graph data based on the input graph data. For example, a graph neural network may be configured to receive input including graph data, such as a graph of a social network including nodes that represent people and edges that represent connections, and to output non-graph data based on analyses of the input graph data, such as statistics about the people represented in the social network and activity occurring therein.

### Graph Neural Networks—Properties

Graph neural networks, including (without limitation) those described above, may be subject to various properties and/or considerations of design and/or operation. These considerations may affect their architecture, processing, implementation, deployment, efficiency, and/or performance.

As previously discussed, graph neural networks may include edges with varying directionality, such as undirected edges (e.g., edges that represent distances between pairs of nodes that represent cities in a graph that represents a region), unidirectional edges (e.g., edges that represent parent/child relationships among nodes that represent people in a graph that represents a genealogy or lineage), and/or multidirectional edges (e.g., bidirectional edges that represent bidirectional roads between nodes that represent cities in a graph that represents a region). In some graph data sets, all of the edges have a same directionality (e.g., all edges are undirected). A graph neural network can be configured to receive an input vector corresponding to the input data set and to process the edges according to the uniform directionality of the edges (e.g., processing undirected edges without regard to the order in which the nodes are represented as being connected to the edge). Other graph data sets may include edges with different directionality (e.g., in a graph that represents a region, edges can represent roads between nodes that represent cities, and each edge can be either unidirectional to represent a one-way road or bidirectional to represent a two-way road). A graph neural network can be configured to receive an input vector corresponding to the input data set and to process the edges according to the distinct directionality of each edge (e.g., processing a unidirectional edge in a different manner than a bidirectional edge). As one such example, the graph neural network can interpret a bidirectional edge connecting two nodes N1, N2 as a first unidirectional edge that connects node N1 to N2 and a second unidirectional edge that connected node N2 to node N1. The pair of unidirectional edges can share various edge properties and/or can be evaluated and/or updated in a same or similar manner (e.g., for a pair of unidirectional edges corresponding to a bidirectional road, the graph neural network can process data representing a weather condition in a same or similar manner to both unidirectional edges associated with the bidirectional road).

As previously discussed, some graph neural networks are configured to process nodes according to a “message passing” paradigm, in which the evaluation of each node N1 is based on the states and/or evaluations of other nodes within a neighborhood of the node N1 and/or the edges that connect the node N1 to other nodes in the neighborhood of the node N1. That is, the state of each node in the neighborhood of the node N1 and/or the state of each edge that connects N1 to other nodes of the neighborhood serves as a “message” that informs the evaluation and/or updating of the state of node N1 by the graph neural network. Alternatively or additionally, the evaluation of each edge E1 is based on the states and/or evaluations of other edges within a neighborhood of the edge E1. That is, the state of each node connected by edge E1, and, optionally, the states of other nodes connected to those nodes and/or other edges in such connections, serves as a “message” that informs the evaluation and/or updating of the state of edge E1 by the graph neural network. In each case, the size of the neighborhood can vary; for example, the graph neural network can evaluate each node according to a one-hop neighborhood or a multi-hop neighborhood. Graph neural networks that perform multi-hop neighborhood evaluation can include multiple layers, where a first one or more layers are configured to process a first hop between a node N1 and a one-hop neighborhood including its directly connected neighbors and/or directly connected edges, and a second one or more layers following the first one or more layers are configured to process a second hop between the nodes and/or edges of the one-hop neighborhood and additional nodes and/or edges that are directly connected to the nodes and/or edges of the one-hop neighborhood. In this manner, each node N1 is first evaluated and/or updated based on message passing among the one-hop neighborhood, and is then evaluated and/or updated based on additional messages within the two-hop neighborhood, etc. Other architectures of graph neural networks may perform multi-hop neighborhood evaluation in other ways, e.g., by processing individual clusters of nodes and/or edges to perform message passing among the nodes and/or edges of each cluster, and then performing additional message passing between clusters to update nodes and/or edges of each cluster based on the nodes and/or edges of one or more neighboring clusters.

In some scenarios, a graph may include nodes and/or edges that are stored, represented, and/or provided as input that is not subject to any particular order (e.g., nodes representing points in a line drawing may not have any node properties, and may therefore be represented in arbitrarily different orders in the input graph data set). In such scenarios, a multitude of semantically equivalent input graph data sets may be logically equivalent to one another. That is, a first representation of a graph may include the nodes and/or edges in a particular order, while a second representation of the same graph may include the same nodes and/or edges in a different order. While both representations of the graph are logically equivalent, the different ordering in which the nodes and/or edges are provided as input to the graph neural network may cause the graph neural network to provide different output. In other scenarios, a graph comprising a set of nodes and a set of interconnecting edges may be organized, stored, and/or represented in a particular order. For example, the nodes may be ordered according to a property of the nodes, and/or edges may be ordered according to a property of the edges (e.g., in a social network, nodes representing people may be ordered according to the alphabetical order of their names, and edges representing relationships may be ordered according to the alphabetical order of the names of the related people). In such scenarios, changes to the order and/or the selected subsets of graph data may result in different input data sets that represent the same or similar (e.g., logically equivalent) graphs. Due to the manner in which a graph neural network processes the input graph data set, logically equivalent input graph data sets may result in different and logically distinct output data.

In such scenarios, it may be undesirable for the graph neural network to generate different output for different but logically equivalent representations. That is, it may be desirable for the graph neural network to provide the same or equivalent output for different but logically equivalent representations of a graph. Graph neural networks that exhibit this property can be referred to as “permutation invariant,” that is, capable of providing output that does not vary across permutations in the representation of the input graph data set. A variety of techniques may be used to achieve, improve, and/or promote permutation invariance. Some such techniques involve changing representations of the input data set. For example, before processing an input graph data set, the graph neural network may reorder the input data set (e.g., by reordering the units of an input vector) such that nodes and edges are represented in a consistent order. As one such example, an input graph data set may include nodes that represent cities, and the input graph data set may include the nodes and/or edges in varying orders. Prior to processing the input graph data set, the graph neural network may reorder the nodes based on latitude and longitude coordinates of the cities, and the edges can similarly be reordered based on the latitude and longitude coordinates of the nodes connected by each edge. Thus, any representation of the graph including nodes that represent the same set of cities is processed in a similar manner. Similar reordering may involve various node properties and/or edge properties, including (without limitation) an alphabetic ordering of names in a graph including nodes that represent people, a chronological ordering of dates in a graph including nodes that represent events, a numeric ordering of content-based hashcodes in a graph including nodes that represent objects, and/or a numeric ordering of identifiers in a graph including nodes that possess unique numeric identifiers. Other techniques for achieving, improving, and/or promoting permutation invariance involve transforming an input graph data set into a different, permutation-invariant representation that is provided as input to and processed by the graph neural network. For example, a graph data set representing a two-dimensional image or a three-dimensional point cloud may include nodes that represent pixels and edges that represent spatial relationships (e.g., distances and/or orientations) between respective pairs of pixels of the image or respective pairs of points in the point cloud. Different orderings of the pixels and/or points may result in differently ordered, but logically equivalent, graph data sets for a particular image or point cloud. Instead of processing the graph data sets as input, a graph neural network may be configured to convert the input graph data set into a spectral representation, e.g., based on a spectral decomposition of a Laplacian L of the input graph data set. Instead of encoding information about individual pixels and/or points, the spectral representation instead encodes spectral components of the input graph data sets. The spectral components can be ordered in various ways (e.g., by frequency and/or polynomial order) to generate a permutation-invariant input vector, and the processing of the permutation-invariant input vector by a graph neural network may result in invariant (e.g., identical or at least similar) output of the graph neural network for various permutations of the input graph data set.

Alternatively or additionally, some techniques for achieving, improving, and/or promoting permutation invariance may relate to the structure of the graph neural network. For example, as an alternative or addition to reordering an input graph data set, a graph neural network may include one or more layers of neurons that process an input vector and generate permutation-invariant output. As one such example, a graph neural network may include a pooling layer that receives an input vector (e.g., an input vector corresponding to an input graph data set, and/or an input vector corresponding to an output of one or more previous layers of the graph neural network) and generates output that is pooled over the input, such as a minimum, maximum, or average of the units of the input. Because operations such as a minimum, maximum, and/or average over a data set are permutation-invariant mathematical operations, the graph neural network may therefore exhibit permutation-invariance of output based on the pooling operation for differently ordered but logically equivalent representations of a particular graph data set. As another such example, a graph neural network may include a filtering layer that receives an input vector (e.g., an input vector corresponding to an input graph data set, and/or an input vector corresponding to an output of one or more previous layers of the graph neural network) and generates output that is filtered based on certain permutation-invariant criteria. For example, in a graph representing a social network that includes nodes representing people, a layer of the graph neural network may filter the nodes to limit the input data set based on the top n nodes of the graph neural network that correspond to the most influential people in the social network. Such filtering may be based, e.g., on a count of the edges of each node (i.e., a count of the number of relationships of each person to other people of the social network), or a weighted calculation based on the influence of the nodes to which each node is related and/or the strength of each such relationship. Because such filtering operation are permutation-invariant logical operations, the graph neural network may therefore exhibit permutation-invariance of output based on the filtering operation for differently ordered but logically equivalent representations of the nodes (i.e., people) and edges (i.e., relationships) of the social network. As yet another example, some graph neural networks include an encoding or “bottleneck” layer, in which an output from N neurons of a preceding layer is received as input and processed by a following layer that includes fewer than N neurons. Due to the smaller number of neurons in the following layer, the volume of data that encodes features of the output of the preceding layer is compressed into a smaller volume of data that encodes features of the output of the following layer. This compression of features, based on learned parameters and training of the graph neural network to produce expected outputs, can cause the graph neural network to encode only more significant features of the processed data, and to discard less significant features of the processed data. The reduced-size output of the neurons of the following layer can be referred to as a latent space encoding of the input feature set. For example, whereas an input graph data set may include nodes that correspond to all pixels of an image of a cat, and an output of a previous layer of the graph neural network may include partially processed information about each node (i.e., each pixel) of the image of the cat, the output of the following layer of the graph neural network may include only features that correspond to visually significant features of the cat (e.g., features that correspond to the pixels that represent the distinctively shaped ears, eyes, nose, and mouth of the cat). Thus, the latent space encoding may reduce the processed input of the graph data set into a smaller encoding of nodes that represent significant visual features of the graph data set, and may exclude data about nodes that do not represent significant visual features of the graph data set. Many such graph neural networks include one or more “bottleneck” layers as one or more autoencoder layers, e.g., layers that automatically learn to generate latent space encodings of input data sets. As one such example, deep generative models may be used to generate output graph data that corresponds to various data types (e.g., images, text, video, scene graphs, or the like) based on an encoding, including an autoencoding, of an input such as a prompt or a random seed, Additional techniques for achieving or promoting permeation-invariance are presented elsewhere in this disclosure and/or will be known to or appreciated by persons skilled in the art.

In some scenarios, a graph data set may include a large number of nodes and/or a large number of edges. For example, a graph data set representing a social network may include thousands of nodes that represent people and millions of edges that represent relationships among the people. The size of the graph data set may result in an input vector that is very large (e.g., a very long input vector), and that might require a correspondingly large graph neural network to process (e.g., a graph neural network featuring millions of weights that connect the input graph data set to the nodes of a first layer of the graph neural network). The size of the input data set may result in large and perhaps prohibitive computational resources to receive and/or process the graph data set (e.g., large and costly storage and/or processing to store the input graph data set and/or the parameters and/or hyperparameters of the graph neural network, and/or a protracted delay in completing the processing of an input graph data set by the graph neural network). Further, the graph data set may exhibit properties of sparsity that cause a large portion of the input data set to be inconsequential. For example, a graph data set representing a social network may be encoded as a vector of N units respectively representing each node (i.e., each person) followed by a vector of N×N units that respectively represent a potential relationship between each node N1 and each node N2. Edges that represent a multidimensional mapping of connections between nodes (such as an N×N mapping of edges that represent possible connections between nodes) can be referred to as an adjacency matrix. However, in the social network, most person may have only a small number of relationships (i.e., far less than N−1 relationships with all other people of the social network). Thus, in the vector encoding of the input graph data set, a large majority of the N×N units that respectively represent potential relationships between each pair of nodes N1, N2 (i.e., the adjacency matrix) may be negative or empty (representing no relationship), and only a very small minority of the N×N units that respectively represent potential relationships between each pair of nodes N1, N2 may be positive or non-empty (representing a relationship). As another example, a graph data set representing a region may include N nodes representing cities and N×N edges representing possible roads between cities. However, if each city is only directly connected to a small number of neighboring cities, then a large majority of the N×N edges representing possible roads between cities (i.e., the adjacency matrix) may be negative or empty (representing no road connection), and only a very small minority of the N×N units that respectively represent potential roads between each pair of nodes N1, N2 may be positive or non-empty (representing an existing road). In such cases, the sparsity of an input vector representing the graph neural network may inefficiently consume computational resources (e.g., inefficiently applying storage and/or computation to large numbers of negative or empty units of the input vector) and/or may unproductively delay the completion of processing of the input graph data set.

Various techniques can be applied to reduce the sparsity of graph data sets and the processing of such graph data sets by graph neural networks. As a first example, the graph neural network can be pruned to reduce the number of nodes and/or edges included as an input data set (e.g., filtering the nodes of a graph neural network to a small cluster of densely related nodes, such as a small number of highly interrelated nodes that represent the members of a social circle in a social network). As a second example, the graph neural network can be encoded in a way that reduces sparsity. For example, rather than encoding the input graph data set as an adjacency matrix, the graph neural network may be configured to receive an encoding of the input graph data set as an adjacency list, i.e., as a list of edges that respectively connect two or more nodes of the graph. Due to encoding only information about existing edges, an adjacency list can eliminate or at least reduce the encoding of nonexistent edges. As a result, the size of the adjacency list may therefore be much smaller than a size of a corresponding adjacency matrix, and can therefore eliminate or at least reduce the sparsity of the input graph data set. The adjacency list can include edge properties of the edges of the graph data set. The adjacency list can be limited to a particular size (e.g., the top N most influential connections in a social network). The nodes of the input graph data set can be limited based on the edges included in the adjacency list (e.g., excluding any nodes that are not connected to at least one of the edges included in the adjacency list). As yet another example, rather than encoding an entire set of nodes and edges, a graph neural network can be represented as an encoding of the nodes and edges. For example, a graph data set may include nodes that represent pixels of an image and edges that represent spatial representations of the pixels. However, if large areas of the image are inconsequential (e.g., dark, empty, or not associated with any notable objects in a segmented image), then large portions of the nodes and/or edges would be inconsequential. Instead, the image can be reencoded as a frequency-domain representation as coefficients associated with respective frequencies of visual features within the image. The frequency-domain representation may present greater information density than the adjacency matrix of pixels, and therefore may present an input to the graph neural network that encodes the visual features of the input graph data set with reduced sparsity.

Other techniques for eliminating or reducing sparsity, and therefore increasing efficiency, involve the architecture of the graph neural network. For example, the input graph data set may encode edges as an adjacency matrix, and a first layer of the graph neural network may reencode the edges of the input graph data set as an adjacency list for further processing by the graph neural network. As another example, the graph neural network may include a first one or more layers that is configured to process an entirety or at least a large portion of the nodes and/or edges of an input graph data set, followed by a filtering layer that is configured to limit an output of the first one or more layers of the graph neural network. For example, in a graph data set that includes nodes that represent people and edges that represent connections, a first one or more layers may process all of the nodes and/or edges, and a filtering layer can limit the further processing of the output of the first one or more layers to the nodes and/or edges for which the outputs of the first one or more layers are above a threshold (e.g., an influence and/or relationship significance threshold). As still another example, the graph neural network may receive a sparse graph input data set but may only process a portion of the input graph data set (e.g., one or more random sampling of subsets of nodes and/or edges). In some cases, the graph neural network may compare results of the processing of subsets of the input graph data set (e.g., randomly sampled subsets of the nodes and/or edges) and may aggregate such results until the results appear to converge within a confidence threshold. In this manner, the graph neural network may generate an acceptable output within the confidence threshold while avoiding processing an entirety of the sparse input graph data set. Many such techniques for eliminating and/or reducing sparsity are presented elsewhere in this disclosure and/or will be known to or appreciated by persons skilled in the art.

### Graph Neural Networks—Input, Processing, and Output

Graph data sets may represent a variety of data types, including (without limitation) maps of geographic regions, including nodes representing cities and edges representing roads that connect two or more cities; social networks, including nodes representing people and edges representing relationships between two or more people; communication networks, including nodes representing people or devices and edges representing communication connections between the nodes or edges; economies, including nodes representing companies and edges representing transactions between two or more companies; molecules, including nodes representing atoms and edges representing bonds between two or more atoms; collections of events, including nodes representing individual events and edges representing causal relationships among two or more events; and periods of time, including nodes representing events and edges representing chronological periods among two or more events. Graph data sets may also be represent data types, such as passages of text, including nodes representing words and edges representing relationships among two or more words; images, including nodes representing pixels and edges representing spatial relationships among two or more pixels; object graphs, including nodes representing objects and edges representing dependencies among two or more objects; and three-dimensional spatial maps, including nodes representing three-dimensional objects and edges representing spatial relationships among two or more of the three-dimensional objects. Some graph data sets may include two or more subgraphs. In some such graph data sets, each node and/or each edge is exclusively included in one subgraph. In some other graph data sets, at least one node and/or at least one edge may be included in two or more subgraphs, or in zero subgraphs. Some graph data sets are associated with non-graph data that is also included as input to a graph neural network. For example, a graph neural network that evaluates traffic patterns within a geographic region may receive, as input, both an input graph data set that includes nodes that represent cities and edges that represent roads interconnecting the cities, and also non-graph data representing traffic and/or weather features within the geographic region (e.g., traffic volume estimates and current or forecasted weather conditions that affect the traffic patterns).

As another example, some graph data sets may include an indication of zero or more cycles occurring among the nodes and/or edges of the graph data set. For example, a directed and/or undirected graph data set may include an indication that a particular cycle exists within the graph and includes a particular subset of nodes and/or edges. Alternatively, a directed and/or undirected graph data set may include an indication that the graph is acyclic and does not include any cycles. A graph neural network may be configured to receive, as input, and process a graph data set that includes an indication of zero or more cycles.

As another example, some graph data sets may include nodes for which the edges provide spatial dimensions. As a first example, in a graph representing a geographic region, nodes that represent cities are related by edges that represent distances, wherein the nodes and interrelated edges can form a spatial map of the geographic region. As a second example, in a graph representing a molecule, nodes that represent atoms are related by edges that represent chemical bonds between the atoms, and the arrangement of atoms by the bonds forms a three-dimensional molecular structure. In some such scenarios, the spatial relationships are well-defined by the nodes and edges. In other such scenarios, the spatial relationships can be inferred based on semantic relationships among the nodes and/or edges of the graph data set. For example, in a graph representing a language, nodes that represent words are related by edges that represent semantic relatedness of the words within a high-dimensional language space. A language model can generate an embedding of the words of the language in a multidimensional embedding space, wherein nodes that are close together within the embedding space represent synonyms, closely related concepts, or words that frequently appear together in certain contexts, whereas nodes that are not close together within the embedding space represent unrelated concepts or words that do not commonly appear together in various contexts. A variety of graph embedding models may be applied to this task, including (without limitation) DeepWalk, node2vec, line, and/or GraphSAGE. A graph neural network can be configured to receive, as input, an embedding of a graph data set instead of representations of the nodes and/or edges of the graph data set. Alternatively, a graph neural network can be configured to receive an input graph data set including representations of the nodes and/or edges of the graph data set, generate an embedding based on the input graph data set, and apply further processing to the embedding instead of to the input graph data set. A graph neural network that is configured to process an embedding instead of an input graph data set may exhibit greater permutation invariance (e.g., due to the semantic associations represented by the embedding) and/or increased efficiency due to reduced sparsity of the input.

Some graph data sets include representations of each of one or more nodes and each of one or more edges. Some graph neural networks are configured to receive and process such representations of graph neural networks. For example, the graph neural network may be configured to receive an input vector including an array of data representing each of the one or more nodes followed by an array of data representing each of the one or more edges, either as an adjacency matrix of possible edges between pairs of nodes or an adjacency list of existing edges. The input vector may encode the nodes and/or edges in a particular order (e.g., a priority order of nodes and/or a weight order of edges) or in an unordered manner. Alternatively or additionally, the graph data set may include and/or encode other types of information about each of one or more nodes and/or each of one or more edges of the graph data set. For example, the graph may include a hierarchical organization of nodes and/or edges relative to one another and/or to a fixed reference point. The graph neural network may be configured to receive and process an input graph data set that includes an indication of the arrangement of one or more nodes and/or one or more edges in the hierarchical organization.

As another example, a graph may include an indication of a centrality of one or more nodes and/or edges within the graph (e.g., a graph of a social network including nodes that are ranked based on a centrality of each node to a cluster). The graph neural network may be configured to receive and process an input graph data set that includes an indication of a centrality of one or more nodes and/or one or more edges in the graph.

As another example, a graph may include an indication of a degree of connectivity of one or more nodes and/or edges within the graph (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). The graph neural network may be configured to receive and process an input graph data set that includes an indication of a degree of one or more nodes and/or one or more edges in the graph.

As another example, a graph may include an indication of one or more clusters occurring within the graph. For example, a graph may include a result of a clustering analysis of the graph, e.g., a determination of k clusters within the graph and an identification of the nodes and/or edges that are included in each cluster. The clusters may be determined by a k-means clustering analysis, a Gaussian mixture model of with variable numbers of clusters and variable Gaussian orders, or the like. A graph may include a clustering coefficient of one or more nodes and/or one or more edges (e.g., a measurement of a degree to which at least some of the nodes and/or edges of a subgraph of the graph are clustered based on similarity and/or activity). The graph neural network may be configured to receive and process an input graph data set that includes an indication of a clustering coefficient of one or more nodes and/or one or more edges in the graph or a subgraph thereof.

As another example, a graph may include an indication of a graphlet degree vector that indicates a graphlet that is represented one or more times in the graph. For example, in a graph representing atoms in a regular structure such as a crystal, the graph may include a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet. The graph neural network may be configured to receive and process an input graph data set that includes a graphlet degree vector, and, optionally, features of one or more occurrences of a graphlet in the graph and/or a count of the occurrences of the graphlet in the graph.

As another example, a graph may include an indication of one or more paths and/or traversals of one or more nodes and/or one or more edges of the graph, optionally including additional details associated with a path or traversal such as a popularity, frequency, length, difficulty, cost, or the like. For example, in a graph representing a spatial arrangement of nodes, the graph may include a path or traversal of edges that connect a first node to a second node through zero or more other nodes, as well as properties of the path or traversal such as a total length, distance, time, and/or cost. The graph neural network may be configured to receive and process an input graph data set that includes additional details associated with one or more paths or traversals, including an indication (e.g., a list) of the associated nodes and/or edges and a list of one or more properties of the path and/or traversal.

As another example, a graph may include an indication of metrics or properties that relate one or more nodes and/or one or more edges. For example, in a graph including a spatial arrangement of nodes, the graph may include an indication of a shortest distance between two nodes and/or an indication of a set of nodes and/or edges that are common to two nodes. As another example, a graph representing a network of communicating devices may include a routing table of one or more routes that respectively indicate, for a particular node and a particular edge connected to the node, a list of other nodes and/or edges that can be efficiently reached by traversing based on the particular edge. As yet another example, in a graph representing a social network including nodes that represent people, the graph may indicate, for at least one pair of nodes, a measurement of similarity of the nodes based on their node properties, edges, locations in the social network, connections to other nodes, or the like (e.g., a Katz index of node similarity) and/or, for at least one pair of edges, a measurement of similarity of the edges based on their edge properties, connected nodes, locations in the social network, or the like (e.g., a Katz index of edge similarity). The graph neural network may be configured to receive and process an input graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph may include an indication of various graph properties of the graph (e.g., a graph size, graph density, graph interconnectivity, graph chronological period, graph classification, a count of subgraphs within the graph, or the like). For example, in a graph including two or more subgraphs (e.g., a social network including two or more social circles), the graph data set may include a measurement of a similarity of each subset of at least two subgraphs of the graph. The measurement of the similarity may be determined based on one or more graph kernel methods (e.g., a Gaussian radial basis function that can be applied to the graph to identify one or more clusters of similar nodes that comprise a subgraph). As another example, a graph may include a measurement of similarity with respect to another graph (e.g., an indication of whether a particular social network graph resembles other social network graphs that have been classified as representing a genealogy or lineage, a set of friendships, and/or a set of professional relationships). The graph neural network may be configured to receive and process an input graph data set that includes measurements determined by one or more graph properties (e.g., one or more measurements of similarity of one or more nodes, edges, and/or subgraphs, and/or a measurement of similarity of the graph to other graphs). Further explanation and/or examples of various graph data sets that may be provided as input to graph neural networks are presented elsewhere in this disclosure and/or will be known to or appreciated by persons skilled in the art.

Graph neural networks may be configured to perform various types of processing over such graph data sets. As previously discussed, a graph neural network can be organized as a series of layers, each of which can include one or more nodes that receive input, apply an activation function, and generate output. The output of each node of a first layer can be multiplied by a weight of a connection between the node and a node of a second layer, and then added to a bias associated with the first layer, to generate an input to the node of the second layer. The graph neural network can include various additional layers that perform other types of processing, including (without limitation) pooling, filtering, and/or latent space encoding operations, memory or stateful features, and recurrent and/or reentrant processing.

Some graph neural networks may perform label propagation among the nodes and/or edges of a graph data set. For example, in an input graph data set, one or more nodes and/or one or more edges may be associated with one or more labels of a label set, while one or more other nodes and/or one or more other edges may not be associated with any labels. A graph neural network may apply a label propagation algorithm (LPA) to assign labels to one or more unlabeled nodes and/or one or more unlabeled edges. For example, the graph neural network may assign a label to an unlabeled node based on labels associated with one or more edges connected to the node, and/or with one or more other nodes that are connected to the node by the one or more edges. The graph neural network may assign a label to an unlabeled edge based on labels associated with one or more nodes connected by the edge, and/or with one or more other edges that are also connected to the nodes connected by the edge. Some graph neural networks may perform label propagation based on a voting, consensus, weighting, and/or scoring determination. For example, a graph neural network may be unable to perform a classification of an unlabeled node and/or unlabeled edge based solely on the node properties and/or edge properties, but may be able to perform the classification based on a further consideration of the labels associated with other nodes and/or edges within a neighborhood of the unlabeled node and/or unlabeled edge.

Some graph neural sets may perform a scoring and/or ranking of nodes and/or edges of a graph data set. As an example, in a graph data set that represents the World Wide Web and that includes nodes that represent web pages and directed edges that represent hyperlinks of linking web pages to linked web pages, a graph neural network may determine one or more scores of each node (i.e., each web page) based on the scores of other nodes that hyperlink to the node. Each score may further be based on the scores of the other nodes that include a directed edge to this node (e.g., the scores of other web pages that hyperlink to this page). Additionally, each score associated with a node may represent a weight of an association between the web page and a particular topic (e.g., a particular topic or keyword that is associated with the web page, hyperlinks, and/or other pages that hyperlink to this web page). In some cases, the scores may be personalized based on the activities of a particular user (e.g., based on the hyperlinks from pages that the user frequently visits). A search engine may use the scores as rankings in order to generate search results for web searches including various topics or keywords (e.g., in response to a web search for a particular search term, present search results that correspond to the nodes with the highest scores associated with the search term, and present the search results in ranked order based on the scores). As another example, for a graph data set representing a social network, a graph neural network may generate a reputation score for each node based on other nodes that are associated with the node and the reputation scores of such other nodes. The scores of the nodes may be used to recommend new connections in the social network (e.g., recommending a first person connect with a second person, based on a high reputation score of the second person by people who are closely associated with the first person).

Some graph neural networks may perform a clustering analysis of the nodes and/or edges of a graph data set. As a first example, in a graph data set representing a social network, a graph neural network may perform a clustering analysis of the nodes representing the people of the social network, based on edges representing relationships among two or more nodes, in order to identify one or more clusters that represent social circles of highly interconnected people within the social network. Based on this clustering analysis, the graph neural network may partition the social network into subgraphs that respectively represent social circles, and may perform further, finer-grained evaluation of each social circle and the people represented by the nodes in each subgraph. As a second example, in a graph data set representing a social network, a graph neural network may perform a clustering analysis of the edges representing the relationships among people of the social network, in order to identify one or more clusters that represent different types of relationships, such as familial relationships, friendships, and professional relationships. Based on this clustering analysis, the graph neural network may partition the social network into subgraphs that respectively represent different types of social networks, and may perform further analysis of relationships among two or more individuals based on the type of relationship associated with the subgraph to which the relationship belongs. In these and other scenarios, in order to perform clustering analysis, a graph neural network may utilize a variety of clustering algorithms. As one such example, a graph neural network may apply spectral clustering techniques, wherein a similarity matrix that represents similarities among nodes and/or edges is evaluated to identify eigenvalues that indicate significant similarity relationships. Based on the similarity matrix, the graph neural network may perform a dimensionality reduction of the graph data set (e.g., reducing the features of the nodes and/or edges that are evaluated to determine clusters in order to focus on features that are highly correlated with and/or indicative of significant similarities). Dimensionality reduction of the graph data set based on the similarity matrix may enable the graph neural network to determine clusters more efficiently and/or rapidly, e.g., by reducing a high-dimensionality graph data set (wherein each node and/or edge is characterized by a multitude of node properties and/or edge properties) into a lower-dimensionality graph data set of a subset of features that are highly correlated with and/or indicative of similarity and clustering.

Some graph neural networks may perform a centrality determination among nodes and/or edges of a graph data set. For example, for a graph data set representing a social network, a graph neural network may evaluate the graph data set to identify a subset of nodes based on a centrality among the edges representing the connections of the social network, e.g., people who are at the center of each of one or more social circles within the social network. Alternatively or additionally, some graph neural networks may perform a “betweenness” determination among the nodes and/or edges of the graph data set. For example, a node may be considered to be “between” two clusters of nodes, such as a member of two or more clusters representing two or more social circles. Such “between” nodes may represent a communication bridge that conducts information between clusters (e.g., a person who can convey ideas and/or influence from a first social circle to a second social circle and vice versa). Some such graph neural networks may perform “betweenness” determinations based on a betweenness centrality measurement, e.g., based on a measurement of a shortest path between all pairs of nodes in the graph data set. As another example, a graph data set may represent a collection of text documents, wherein each node represents a document and each edge represents a relationship between documents (e.g., a unidirectional or bidirectional citation between a first document and a second document). A graph neural network can perform a centrality determination and/or a betweenness determination to determine significant documents within the collection (e.g., a document that is heavily cited by one or more clusters of other documents, and/or a document that includes ideas or associations between the documents of a first cluster and the documents of a second cluster).

Some graph neural networks may perform analyses of structures occurring within a graph neural network. As an example, for a graph data set that represents a social network, a graph neural network may determine a notable sequence of relationships, such as a first relationship between node N1 and node N2 based on a shared interest, a second relationship between node N2 and node N3 based on the same shared interest, and a third relationship between node N3 and node N4 based on the same shared interest. Based on this sequence or chain of relationships, the graph neural network may recommend to a person represented by node N1 some further relationships with the people represented by nodes N3 and N4, due to the combination of shared interests and mutual relationships. In some such cases, a graph neural network may perform such structural analysis based on a traversal algorithm that traverses a sequence of nodes connected by one or more edges, and/or that traverses a sequence of edges connected by one or more nodes. As an example, a graph neural network may perform a random walk within the graph data set, such as starting with a first node (e.g., a first person of a social network) and following a limited set of edges that connect the first node to other nodes. In some cases, the traversal may be random (e.g., traversing from a node based on a random selection among the edges that connect the node to other nodes). In some other cases, the traversal may be weighted (e.g., each edge may include an edge property including a weight that represents a strength of a relationship among two or more nodes, and the traversal may be based on a weighted random selection that preferentially selects higher-weighted connections over lower-weighted connections). In some cases, the traversal can include a restart probability, e.g., a probability of retrying the traversal beginning with the original node or another node, based on a score such as a distance of the traversal with respect to the original node. In these and other cases, the results of a random walk can be used in further analyses and/or activities of the graph neural network (e.g., presenting recommendations for new social connections among the nodes of a social network).

Some graph neural networks may perform an analysis of a graph data set based on an attention model. For example, in a social network, the influence of a particular person P1 may not be determined by the connectedness of person P1 to other people in the social network, but based on a perception of person P1 by other people of the social network as being knowledgeable, skilled, influential, or the like. Thus, a graph neural network may be configured to evaluate a graph data set representing a social network in which nodes represent people and edges represent relationships, but may be unable to determine influence based only on graph concepts such as connectedness of the nodes based on the edges. Rather, the graph neural network might model influence as an attention of each node (i.e., a second person P2 of the social network) upon each other node (e.g., person P1 of the social network). Thus, a particular opinion of person P2 of the social network may depend not only on the connections of person P2 to other people of the social network (including person P1), but also upon the attention that person P2 accords to such other people of the social network (including person P1). That is, even though person P2 is closely connected to certain people of the social network by various edges, the opinion of person P2 may be heavily shaped by person P1 and other people to whom person P2 is only indirectly connected in the social network. As a second such example, in a graph data set that represents traffic flow within a region, an edge E1 (e.g., a first road) may be directly connected to other edges of the graph data set, but an edge property of the edge E1 (e.g., a traffic volume and/or congestion of the road) may be impacted more heavily by edge properties of other edges to which edge E1 is not directly connected (e.g., roads in other parts of the geographic region for which traffic volume and/or congestion is highly determinative of the traffic volume and/or congestion of this road). Thus, in order to predict and/or estimate a traffic volume and/or congestion of a particular road, a graph neural network may evaluate not only the traffic volume and/or congestion of other roads that are directly connected to the particular road, but also other roads for which traffic volume and/or congestion is highly determinative of corresponding conditions of this road. In these and other scenarios, a graph neural network may evaluate a graph data set based on an attention model, in which analyses and updates of the state of nodes and/or edges of the graph data set are based, at least in part, on an attention of each node and/or edge upon other nodes and/or edges of the graph data set. For example, the graph neural network may include an attention layer that determines, for a particular node and/or edge of an input graph data set, which other nodes and/or edges of the input graph data set are likely to be relevant to determining an updated state of the particular node and/or edge. Various attention models may be used by such graph neural networks, including multi-head attention models in which each node and/or edge is related to a plurality of other nodes and/or other edges with varying weighted attention values (e.g., by each of a plurality of attention layers). Multi-head attention models can allow a graph neural network to consider the influences upon a particular node and/or edge of a plurality of other nodes and/or edges, which may (or may not) be further related to one another by the graph structure and/or attention. Based on the attention model and the attention layers included in the graph neural network, the graph neural network can perform a more sophisticated graph analysis that is based on more than the structural relationships of the graph.

Some graph neural networks may be configured to process a graph data set in order to determine, and optionally output, various types of data (e.g., measurements, calculations, inferences, explanations, or the like) that relate to one or more nodes, one or more edges, and/or one or more subgraphs of the input graph data set and/or to the input data graph set as a whole. Some graph neural networks are configured to generate, and optionally output, various types of representations of graph neural networks. For example, the graph neural network may be configured to determine, and optionally output, an output vector including an array of data representing each of the one or more nodes followed by an array of data representing each of the one or more edges, either as an adjacency matrix of possible edges between pairs of nodes or an adjacency list of existing edges. The output vector may encode the nodes and/or edges in a particular order (e.g., a priority order of nodes and/or a weight order of edges, or corresponding to a corresponding order of the nodes and/or edges in the input graph data set) or in an unordered manner. Alternatively or additionally, the graph neural network may be configured to determine, and optionally output, other types of information about each of one or more nodes and/or each of one or more edges of the graph data set. For example, the graph neural network may be configured to determine, and optionally output, a hierarchical organization of nodes and/or edges relative to one another and/or to a fixed reference point. Alternatively or additionally, the graph neural network may be configured to determine, and optionally output, an output graph data set that includes an indication of the arrangement of one or more nodes and/or one or more edges in the hierarchical organization.

As another example, a graph neural network may be configured to determine, and optionally output, an indication of a centrality of one or more nodes and/or edges within the input graph data set (e.g., a graph of a social network including nodes that are ranked based on a centrality of each node to a cluster). Alternatively or additionally, the graph neural network may be configured to determine, and optionally output, an output graph data set that includes an indication of a centrality of one or more nodes and/or one or more edges in the graph.

As another example, a graph neural network may be configured to determine, and optionally output, an indication of a degree of connectivity of one or more nodes and/or edges of an input graph data set (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). Alternatively or additionally, the graph neural network may be configured to determine, and optionally output, an output graph data set that includes an indication of a degree of one or more nodes and/or one or more edges in the output graph data set.

As another example, a graph neural network may be configured to detect, identify, and/or analyze one or more clusters occurring within an input graph data set. For example, a graph neural network may be configured to perform a clustering analysis of an input graph data set to determine, and optionally output, a determination of k clusters within the input graph data set and an identification of the nodes and/or edges that are included in each cluster. The graph neural network may be configured to determine clusters based on a k-means clustering analysis, a Gaussian mixture model of with variable numbers of clusters and variable Gaussian orders, or the like. The graph neural network may be configured to determine, and optionally output, an indication of a clustering coefficient of one or more nodes and/or one or more edges of an input graph data set (e.g., a measurement of a degree to which at least some of the nodes and/or edges of a subgraph of the graph are clustered based on similarity and/or activity). Alternatively or additionally, the graph neural network may be configured to determine, and optionally output, an output graph data set that includes an indication of one or more clusters including one or more nodes and/or one or more edges in the output graph data set or a subgraph thereof (e.g., a result of a k¬-means clustering analysis of an output graph data set, a Gaussian mixture model of an output graph data set, and/or one or more clustering coefficients of an output graph data set).

As another example, a graph neural network may be configured to determine, and optionally output, an indication of a graphlet degree vector that indicates a graphlet that is represented one or more times in an input graph data set. For example, for a graph representing atoms in a regular structure such as a crystal, the graph neural network may be configured to determine, and optionally output, a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet in the input graph data set. Alternatively or additionally, the graph neural network may be configured to determine, and optionally output, an output graph data set that includes a graphlet degree vector, and, optionally, features of one or more occurrences of a graphlet in the output graph data set and/or a count of the occurrences of the graphlet in the output graph data set.

As another example, a graph neural network may be configured to determine, and optionally output, an indication of one or more paths and/or traversals of one or more nodes and/or one or more edges of the input graph data set, optionally including additional details associated with a path or traversal such as a popularity, frequency, length, difficulty, cost, or the like. For example, for an input graph data set representing a spatial arrangement of nodes, the graph neural network may be configured to determine, and optionally output, a path or traversal of edges that connect a first node to a second node through zero or more other nodes of the input graph data set, as well as properties of the path or traversal such as a total length, distance, time, and/or cost. Alternatively or additionally, the graph neural network may be configured to determine, and optionally output, an output graph data set that includes additional details associated with one or more paths or traversals, including an indication (e.g., a list) of the associated nodes and/or edges of the output graph data set and a list of one or more properties of each such path and/or traversal.

As another example, a graph neural network may be configured to determine, and optionally output, an indication of metrics or properties that relate one or more nodes and/or one or more edges of an input graph data set. For example, for an input graph data set including a spatial arrangement of nodes, the graph neural network may be configured to determine, and optionally output, an indication of a shortest distance between two nodes and/or an indication of a set of nodes and/or edges that are common to two nodes of the input graph data set. As another example, for an input graph data set representing a network of communicating devices, the graph neural network may be configured to determine, and optionally output, a routing table of one or more routes that respectively indicate, for a particular node of the input graph data set and a particular edge connected to the node, a list of other nodes and/or edges of the input graph data set that can be efficiently reached by traversing based on the particular edge. As yet another example, for an input graph data set representing a social network including nodes that represent people, the graph neural network may be configured to determine, and optionally output, an indication for at least one pair of nodes of a measurement of similarity of the nodes of the input graph data set based on their node properties, edges, locations in the social network, connections to other nodes, or the like (e.g., a Katz index of node similarity) and/or, for at least one pair of edges of the input graph data set, a measurement of similarity of the edges based on their edge properties, connected nodes, locations in the social network, or the like (e.g., a Katz index of edge similarity). Alternatively or additionally, the graph neural network may be configured to determine, and optionally output, an output graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph neural network may be configured to determine, and optionally output, an indication of various graph properties of an input graph data set (e.g., a graph size, graph density, graph interconnectivity, graph chronological period, graph classification, a count of subgraphs within the graph, or the like). For example, for an input graph data set including two or more subgraphs (e.g., a social network including two or more social circles), the graph neural network may be configured to determine, and optionally output, a measurement of a similarity of each subset of at least two subgraphs of the input graph data set. The measurement of the similarity may be determined based on one or more graph kernel methods (e.g., a Gaussian radial basis function that can be applied to the input graph data set to identify one or more clusters of similar nodes that comprise a subgraph). As another example, a graph neural network may be configured to determine, and optionally output, a measurement of similarity of an input graph data set with respect to another graph data set (e.g., an indication of whether a particular social network graph resembles other social network graphs that have been classified as representing a genealogy or lineage, a set of friendships, and/or a set of professional relationships). Alternatively or additionally, the graph neural network may be configured to determine, and optionally output, an output graph data set that includes measurements determined by one or more graph properties of an output graph data set (e.g., one or more measurements of similarity of one or more nodes, edges, and/or subgraphs, and/or a measurement of similarity of the output graph data set to the input graph data set and/or other graph data sets). Further explanation and/or examples of various types of processing that graph neural networks can determine, and optionally output, for various input graph data sets and/or output graph data sets are presented elsewhere in this disclosure and/or will be known to or appreciated by persons skilled in the art.

Graph neural networks may be configured to generate various forms of output that correspond to various tasks. For example, graph neural networks can generate output that represents node-level predictions that relate to one or more nodes of an input graph data set. The node-level predictions can include a discovery of a new node that was not included in the input graph data set. For example, in a graph data set including edges that represent travel of individuals in a region, the nodes can represent points of interest, and the graph neural network can discover a new node that corresponds to a new point of interest. The node-level predictions can include an exclusion of a node that is included in the input graph data set. For example, in a graph data set including edges that represent travel of individuals in a region, the nodes can represent points of interest, and the graph neural network can exclude an existing node that no longer represents a point of interest. The node-level predictions can include a classification of a node that is included in the input graph data set, or of a newly discovered node that was not included in the input graph data set (e.g., a classification of the node as being of a node type selected from a set of node types, as being associated with one or more labels of a classification label set, and/or as belonging to zero or more subgraphs of the graph data set). For example, in a graph data set representing locations within a geographic region, the graph neural network can generate a prediction of a classification of a location of interest as one or more particular types of locations of interest (e.g., a source of food, a source of fuel, a lodging location, and/or a tourist destination). The node-level predictions can include an identification of a node from among the nodes of the input graph data set based on various features, or of a newly discovered node. For example, in a graph data set representing a social network and including nodes that represent people, the graph neural network can identify a particular node that corresponds to a particular person, such as an influential person of the social network. The node-level predictions can include a determination and/or updating of one or more node properties of one or more existing and/or newly discovered nodes, such as a prediction of a demographic feature, opinion, or interest of a node representing a person in a social network.

As another example, graph neural networks can generate output that represents edge-level predictions that relate to one or more edges of an input graph data set. The edge-level predictions can include a discovery of a new edge that was not included in the input graph data set. For example, in a graph data set representing a social network that includes nodes that represent people, a graph neural network can output a prediction (e.g., a recommendation) of a relationship between two nodes that correspond to two people in a small social circle of highly interconnected people. The node-level predictions can include an exclusion of a node that is included in the input graph data set. For example, in a graph data set representing a social network that includes nodes that represent people, a graph neural network can output a prediction of a no-longer-existing edge that corresponds to a relationship that no longer exists (e.g., a lost connection based on a splitting of a social circle). The edge-level predictions can include a classification of an edge that is included in the input graph data set, or of a newly discovered edge that was not included in the input graph data set (e.g., a classification of an edge as being a of an edge type selected from a set of edge types, as being associated with one or more labels of a classification label set, and/or as belonging to zero or more subgraphs of the graph data set). For example, in a graph data set representing a social network, a graph neural network can generate a predicted classification of an edge as representing a relationship between two people as of one or more relationship types (e.g., a familial relationship, a friendship, or a professional relationship). The edge-level predictions can include an identification of an edge from among the edges of the input graph data set based on various features, or of a newly discovered edge. For example, in a graph data set representing a social network and including edges that represent relationships, the graph neural network can identify a particular edge that corresponds to a potential relationship to be recommended to the associated people, such as two people of the social network who are not yet connected but who share common personal or professional interests. The edge-level predictions can include a determination and/or updating of one or more edge properties of one or more existing and/or newly discovered edges, such as a prediction of a demographic feature, opinion, or interest that serves as the basis for a relationship between two people of the social network.

As another example, graph neural networks can generate output that represents graph-level predictions that relate to one or more graph properties of the input graph data set. The graph-level predictions can include a discovery of a new graph property that was not associated with the input graph data set. For example, in a graph data set representing a social network that includes nodes that represent people and edges that represent relationships, a graph neural network can output a prediction of a demographic trait, opinion, or interest that is common or popular among the people of the social network, or a relationship behavior that is exhibited in the relationships among the people of the social network. The graph-level predictions can include an exclusion of a graph property that was associated with the input graph data set. For example, in a graph data set representing a social network that includes a graph property based on a shared interest, a graph neural network can output a prediction that the interest no longer appears to be common and/or popular among the people of the social network, or of a relationship behavior that is no longer exhibited among the relationships of the people of the social network. The graph-level predictions can include a classification of the input graph data set (e.g., a classification of the graph data set, or at least a portion thereof, as being associated with one or more labels of a classification label set). For example, in a graph data set representing a social network, a graph neural network can generate a predicted classification of the graph as representing a familial social network, a friendship social network, and/or a professional social network. The graph-level predictions can include an identification of one or more subgraphs of the graph based on common features of the nodes and/or edges included in the subgraph. For example, in a graph data set representing a social network, the graph neural network can subgraphs that correspond to various social circles of highly interconnected people. The graph-level predictions can include a determination and/or updating of one or more graph properties of the graph, such as an updating of a frequency of communication and/or a strength of relationships among the people of a social network.

As another example, graph neural networks can perform graph-to-graph translation by receiving an input graph data set and generating output that represents a different graph data set. For example, a graph neural network can receive an input graph data set and can generate an output graph data set that includes one or more newly discovered nodes and/or edges; an exclusion of one or more nodes and/or edges; a classification of one or more nodes and/or edges; an identification of one or more nodes and/or edges; and/or an update of one or more node properties, edge properties, and/or graph properties. A graph neural network can receive an input graph data set and can generate an output graph data set that shares various similarities with the input graph data set. For example, a graph neural network can receive, as input, a first graph representing a first geographic region (e.g., a real geographic region) and can generate, as output, a first graph representing a different geographic region (e.g., a fictitious geographic region) that shares similarities with the first graph and that has some dissimilarities with respect to the first graph. A graph neural network can receive, as input, an input graph data set and can generate, as output, a subgraph of the input graph data set. A graph neural network can receive, as input, an input graph data set and can generate, as output, an expanded graph including a first subgraph corresponding to the input graph data set and a second subgraph that is newly generated. A graph neural network can receive, as input, a first graph that corresponds to a first time and can generate, as output, a second graph that corresponds to a different time than the first time. For example, the graph neural network can receive, as input, a graph data set that corresponds to a state of a geographic region at a current time, and can generate, as output, a graph data set that predicts the state of the geographic region at a past time or a future time.

As another example, graph neural networks can generate graphs from non-graph input data. For example, a graph neural network can receive, as input, locations of travelers within a geographic region over a period of time, and can generate, as output, graph data that includes one or more nodes that represent points of interest among the travelers and edges that represent paths between the points of interest (e.g., roads that connect the points of interest). As another example, a graph neural network can receive, as input, a description of a graph (e.g., a natural-language description of a geographic location) and can generate, as output, graph data that corresponds to the description of the graph (e.g., a graph of a region that includes one or more nodes representing locations and one or more edges representing roads that interconnect the locations). The graph neural network may receive both graph data and non-graph data (e.g., a graph representing a social network and an indication of a particular person in the social network) and can generate, as output, graph data based on the input (e.g., a subgraph of the people who consider the identified person to be influential).

As another example, graph neural networks can receive an input graph data set and can generate, as output, non-graph data. For example, a graph neural network can receive, as input, a graph representing a social network including nodes that represent people and edges that represent relationships, and can generate, as output, one or more metrics of the social network (e.g., an average number of connections among the people of the social network, an identification of a person of high influence within the social network, or a description of a relationship behavior that commonly occurs within the social network). As another example, a graph neural network can receive, as input, a graph representing a geographic region including nodes that represent locations and edges that represent roads connecting the locations, and can generate, as output, one or more predictions and/or measurements of traffic within the geographic region. The graph neural network may receive both graph data and non-graph data (e.g., a graph representing a social network and an indication of a particular person in the social network) and can generate, as output, non-graph data based on the input (e.g., a summary and/or prediction of the social behaviors of the identified person). For example, a graph neural network that evaluates traffic patterns within a geographic region may process, and optionally output, both an output graph data set that includes nodes that represent cities and edges that represent roads interconnecting the cities, and also non-graph output data representing predictions and/or inferences of traffic and/or weather features within the geographic region (e.g., traffic volume estimates and current or forecasted weather conditions that affect the traffic patterns).

As another example, some graph neural networks may be configured to determine, and optionally output, an indication of zero or more cycles occurring among the nodes and/or edges of an input graph data set. For example, for a directed and/or undirected input graph data set, a graph neural network may determine, and optionally output, an indication that a particular cycle exists within the input graph data set and includes a particular subset of nodes and/or edges. Alternatively, for a directed and/or undirected graph data set, a graph neural network may determine, and optionally output, an indication that the graph is acyclic and does not include any cycles. A graph neural network may be configured to determine, and optionally output, an output graph data set that includes an indication of zero or more cycles.

As another example, graph neural networks can receive an input graph data set and can generate, as output, an interpretation and/or explanation of the input graph data set. For example, a graph neural network can receive, as input, a graph representing a collection of devices, including nodes that respectively represent a device and edges that respectively represent an instance of communication and/or interaction among two or more devices. The graph neural network can generate, as output, an interpretation and/or explanation of the communications and/or interactions represented in the graph, such as an explanation of a set of interactions as being part of a collective and/or collaborative effort among the two or more devices and/or a related series of interactions that are associated with a particular activity. The explanation and/or interpretation may include, for example, a classification of one or more nodes, edges, patterns of activity, and/or the graph; a natural-language summary or narrative explanation of one or more nodes, edges, patterns of activity, and/or the graph; a data set that characterizes one or more nodes, edges, patterns of activity, and/or the graph; and/or a presentation (e.g., a static or motion visualization) of one or more nodes, edges, patterns of activity, and/or the graph. As one such example, a graph neural network may identify, within an input graph data set, one or more subgraphs (e.g., one or more clusters of related nodes and/or edges), and may output an interpretation and/or explanation of the subgraph (e.g., a description of the set of features that characterize the subgraph or cluster). As another example, a graph neural network may generate a visualization of a subgraph of an input graph data set, wherein the visualization depicts, highlights, and/or illustrates a structure and/or an anomalous feature of the subgraph. Some such graph neural networks may be configured to generate interpretations and/or explanations of any input graph data set, e.g., based on an identification of features of an input data set that inform such interpretations and/or explanations, such as clusters, outliers, or determinations of apparent structure and/or data relationships. Other such graph neural networks may be configured to generate domain-specific interpretations and/or explanations of domain-specific graph data sets. For example, a graph neural network may be configured to analyze a graph data set representing a social network identify both a subset of the social network corresponding to an influential cluster of people of the social network and also an interpretation and/or explanation of why this cluster of people appears to be influential within the social network. Graph neural networks can generate interpretations and/or explanations using a variety of techniques, including “white-box” analysis techniques that can be applied to various properties of graph data sets and components thereof. Examples of graph neural networks that include instance-level explanations based on gradients and/or features include, without limitation, Guided BP, class activation mapping (CAM), and GradCAM. Examples of graph neural networks that include instance-level explanations based on perturbations include, without limitation, GNNExplainer, PGExplainer, ZORRO, and Graphmask. Examples of graph neural networks that include instance-level explanations based on decomposition include, without limitation, layer-wise relevance propagation (LRP), Excitation BP, and GNN LRP. Examples of graph neural networks that include instance-level explanations based on surrogate analysis include, without limitation, GraphLIME, RelEX, and PGMExplainer. Examples of graph neural networks that include model-level explanations include XGNN. Further explanation and/or examples of various interpretable and/or explainable features of graph data sets or components thereof that may be generated by graph neural networks are presented elsewhere in this disclosure and/or will be known to or appreciated by persons skilled in the art.

### Graph Neural Networks—Architectures and Frameworks

Graph neural networks may be designed and/or organized according to various architectures. For example, a multilayer graph neural network may include a number of layers, each layer including a number of neurons. In each layer of the graph neural network, the neurons may be configured to receive, as input, at least a portion of an input data set (e.g., an input graph data set) and/or at least a portion of an output of at least one neuron of one or more layers of the graph neural network. Additionally, in each layer of the graph neural network, the neurons may be configured to generate, as output, at least a portion of an output data set of the graph neural network (e.g., an output graph data set of graph neural network) and/or at least a portion of an input to at least one neuron of one or more layers of the graph neural network.

In some graph neural networks, an architecture of the graph neural network is based on the input to the graph neural network. For example, a fixed-size graph of N nodes and E edges interconnecting the nodes may be received and processed by a graph neural network that includes an input layer featuring N neurons respectively configured to receive input from one of the N nodes and/or E neurons respectively configured to receive input from one of the E edges. A graph including an adjacency list having a maximum of E edges may be received and processed by a graph neural network that includes an input layer featuring E neurons respectively configured to receive and process one of the E edges represented in the adjacency list. A graph including two subgraphs may be received and processed by a graph neural network that includes an input layer featuring a first set of neurons that are configured to process the nodes and/or edges of the first subgraph and a second set of neurons that are configured to process the nodes and/or edges of the second subgraph. In some graph neural networks, an architecture of the graph neural network may be based on non-graph input data that is received and processed by the graph neural network. For example, a graph neural network may be configured to receive, as input, a description of a graph (e.g., a number of nodes and/or edges and one or more properties of the graph). The graph neural network may be further configured to generate a graph corresponding to the description, and to process and optionally output the graph according to various graph neural network processing techniques.

In some graph neural networks, an architecture of the graph neural network is based on an output of the graph neural network. For example, a graph neural network may be configured to determine, and optionally output, a fixed-size output graph data set including N nodes and E edges. The graph neural network may therefore include an output layer featuring N neurons respectively configured to generate output corresponding to one of the N nodes and/or E neurons respectively configured to generate output corresponding to one of the E edges. A graph neural network may be configured to determine, and optionally output, an adjacency list having a maximum of E edges. The graph neural network may therefore include an output layer featuring E neurons that respectively generate output corresponding to one of the E edges represented in the adjacency list. A graph neural network may be configured to determine, and optionally output, an output graph data set including two subgraphs. The graph neural network may therefore include an output layer featuring a first set of neurons that are configured to generate output corresponding to the nodes and/or edges of the first subgraph and a second set of neurons that are configured to process the nodes and/or edges of the second subgraph. In some graph neural networks, an architecture of the graph neural network may be based on non-graph output data that is determined, and optionally output, by the graph neural network. For example, a graph neural network may be configured to determine, and optionally output, a description of an input graph data set and/or an output graph data set (e.g., a number of nodes and/or edges and one or more properties of the input graph data set and/or the output graph data set), according to various graph neural network processing techniques.

In some graph neural networks, an architecture of the graph neural network may be based on a directionality of one or more edges included in an input data set and/or an output data set. For example, an input graph data set including a undirected edge that connects a first node N1 and a second node N2 may be received and processed by a graph neural network including a first neuron NN1 and a second neuron NN2 that are bidirectionally connected to one another, such that message passing can occur from the first node NN1 to the second node NN2 and, concurrently or consecutively, from the second node NN2 to the first node NN1. An input graph data set including a unidirectional edge that connects a first node N1 to a second node N2 may be received and processed by a graph neural network including a first neuron NN1 (e.g., a neuron in a first layer of a feed-forward graph neural network) that is unidirectionally connected to a second neuron NN2 (e.g., a neuron in a second layer of a feed-forward graph neural network), such that message passing can occur from the first node NN1 to the second node NN 2 but not from the second node NN2 to the first node NN1. An input graph data set including an edge that connects three or more nodes may be received and processed by a graph neural network in which three or more nodes are correspondingly connected.

Some graph neural networks may be configured to receive and process an input graph data set including a homogeneous set of nodes and/or a homogeneous set of edges. For example, a first neuron of the graph neural network that corresponds to a first node and/or edge of the input graph data set may include a same or similar number of inputs, a same or similar activation function, and/or a same or similar number of outputs as a second neuron of the graph neural network that corresponds to a second node and/or edge of the input graph data set.

Some graph neural networks may be configured to receive and process an input graph data set including a heterogeneous set of nodes and/or a heterogeneous set of edges. For example, different nodes of an input graph data set may be associated with different labels that respectively indicate different classifications of the nodes, and/or different edges of the input graph data set may be associated with different labels that respectively indicate different classifications of the edges. An architecture of the graph neural network may exhibit variations corresponding to the heterogeneity of the nodes and/or edges. For example, a first neuron of the graph neural network that corresponds to a first node and/or edge of the input graph data set that is associated with a first label or classification may include a different number of inputs, a different activation function, and/or a different number of outputs as a second neuron of the graph neural network that corresponds to a second node and/or edge of the input graph data set that is associated with a second label or classification. As another example, a graph neural network may include a first layer that receives and processes, as input, a first portion of an input data set that includes a first subset of neurons and/or edges that are associated with a first label or classification, and a second layer that receives and processes, as input, a second portion of an input data set that includes a second subset of neurons and/or edges that are associated with a second label or classification. The first layer and the second layer may be processed concurrently or consecutively. The first layer and the second layer may be processed independently (e.g., each layer providing a different portion of an output graph data set). Alternatively, the first layer and the second layer may be processed together (e.g., an output of the first layer may be additionally provided as input to the second layer, and/or an output of the second layer may be additionally provided as input to the first layer).

Some graph neural networks may include an architecture that is based on one or more node properties of one or more nodes of an input graph data set, one or more edge properties of one or more edges of the input graph data set, and/or one or more graph properties of the input graph data set. As an example, in some input graph data sets, one or more nodes may include a node property indicating a weight of the node (e.g., an indication of a centrality and/or betweenness of a node among at least a portion of the nodes of the input graph data set). The graph neural network may include a neuron that corresponds to the node, wherein one or more weights of synapses that connect the neuron to other neurons of the graph neural network is based on the weight of the node. As another example, in some input graph data sets, one or more edges may include an edge property indicating a weight of the edge (e.g., an indication of a significance and/or priority of a relationship among two or more nodes of the input graph data set). The graph neural network may include two or more nodes that are connected by a synapse, wherein a weight of the synapse connecting the two or more nodes is based on a weight of an edge of the input graph data set. Examples of node-based graph neural networks include, without limitation, GraphSAGE, PinSAGE, and VR-GCN. Examples of layer-based graph neural networks include, without limitation, FastGCN and LADIES. Examples of subgraph-based graph neural networks include, without limitation, ClusterGCN and GraphSAINT.

Some graph neural networks may be configured to receive and process fixed input graph data sets, wherein a number and arrangement of nodes and edges of an input data set that is received and processed by the graph neural network does not vary for different instances of processing the input data set. The architecture of such graph neural networks may be configured based on the invariance of the input graph data set. For example, the graph neural network may feature a fixed number and/or arrangement of neurons and/or layers, wherein the fixed architecture of the graph neural network corresponds to the fixed nature of the input graph data set.

Some graph neural networks may be configured to receive and process dynamic input graph data sets, wherein a number and arrangement of nodes and edges of an input data set that is received and processed by the graph neural network during a first instance of processing can differ from a number and arrangement of nodes and edges of an input data set that is received and processed by the graph neural network during a second instance of processing. As an example, a graph neural network may be configured to perform node and/or edge discovery of an input graph data set and to generate, as output, an output graph data set that includes at least one more node and/or at least one more edge than the input graph data set. Further, the graph neural network may be configured to receive the output graph data set from a first processing as input for a second processing, wherein a number of nodes and/or edges received as input during the second processing is greater than a corresponding number of nodes and/or edges received as input during the first processing. In such cases, an architecture of such graph neural networks may be fixed, but may be configured to receive and process a variety of different input graph data sets (e.g., input graph data sets with a variable number of nodes and/or connections). For example, the graph neural network may include an input layer featuring N input neurons, each corresponding to a node of an input graph data set. Such a graph neural network may be configured to use the fixed architecture to receive and process input graph data sets featuring a variable number of nodes up to, but not exceeding, N. For example, in order to receive and process an input graph data set featuring fewer than N nodes, the graph neural network may activate only a number of input neurons of the input layer that correspond to the number of nodes in the input graph data set, and to deactivate remaining neurons of the input layer that do not correspond to a node of the input graph data set (e.g., refraining from processing the remaining neurons, and/or processing the neurons but zeroing the weights of the synapses that connect the neurons to other neurons of the graph neural network). As another example, the graph neural network may perform a first processing of a first input graph data set including N nodes, and, accordingly, may deactivate one or more neurons of the input layer. The graph neural network may then perform a second processing of a second input graph data set including more than N nodes (e.g., an output of the first processing may include an output graph data set that includes one or more newly discovered nodes). During the second processing, the graph neural network may activate one or more of the previously deactivated neurons of the input layer in order to receive and process input from the additional nodes of the second input graph data set. For example, the graph neural network may enable or reenable the processing of one or more neurons of the input layer, and/or may reset (e.g., restore and/or initialize) the weights of one or more synapses that connect one or more neurons of the input layer to other neurons of the graph neural network. In some cases, an architecture of such graph neural networks may dynamic, and may change in correspondence with a dynamic nature of the input graph data set. For example, a graph neural network may include an input layer with a variable number of neurons, and may select, adapt, and/or change the number of neurons in the input layer based on a dynamic property of an input graph data set (e.g., a number of nodes and/or edges in the input graph data set). Such graph neural networks may generate new neurons of the input layer (e.g., initializing and/or selecting weights of the synapses of the new neurons, such as copying the weights from the synapses of other neurons of the input layer) based on a larger number of nodes and/or edges of an input graph data set to be received and processed as input. Alternatively or additionally, such graph neural networks may be configured to eliminate and/or merge neurons of the input layer (e.g., initializing and/or selecting weights of the new neurons) based on a smaller number of nodes and/or edges of an input graph data set to be received and processed as input.

In some graph neural networks, an architecture of the neural network may be selected and/or adapted based on a topology of one or more input graph data sets and/or output graph data sets. For example, a bipartite input graph data set may include two more subgraphs, and a graph neural network may include two or more distinct subsets of neurons that are respectively configured to receive and process data associated with the nodes and/or edges included in one of the subgraphs. As another example, a multigraph input graph data set may include a plurality of edges connecting two or more nodes. For example, a graph representing a social network may include various types of edges that represent various types of relationships (e.g., familial relationships, friendships, and/or professional relationships), and two or more nodes may be connected by a plurality of edges (e.g., a first edge indicating a friendship among the two or more nodes and a second edge indicating a professional relationship among the two or more nodes). An architecture of the graph neural network may correspond to the multigraph nature of the input graph data set. For example, a graph neural network may include two or more distinct subsets of neurons that are respectively configured to receive and process data associated with a subset of edges of the input graph data set that are of a particular edge type (e.g., a first subset of neurons that is configured to receive and process nodes connected by edges that represent friendships, and a second subset of neurons that is configured to receive and process nodes connected by edges representing professional relationships). As yet another example, an input hypergraph data set may include one or more hyperedges that interconnect three or more nodes. An architecture of a graph neural network that is configured to receive and process the input hypergraph data set may include one or more neurons with synapses that interconnect to two or more other neurons in correspondence with one or more hyperedges of the input hypergraph data set.

As another example, an architecture of some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. Examples of graph neural networks that include one or more direct pooling layers include, without limitation, SimplePooling, Set2Set, and SortPooling. Examples of graph neural networks that include one or more hierarchical pooling layers include, without limitation, Coarsening, ECC, DiffPool, TopK, gPool, Eigenpooling, and SAGPool.

As another example, some graph neural networks (e.g., graph convolution networks) include one or more convolutional layers, each of which performs a convolution operation to an output of neurons of a preceding layer of the graph neural network.

As another example, an architecture of some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells. In some graph neural networks, these features may be further adapted to accommodate graph processing, such as gated graph neural networks (GGRUs), tree LSTM networks, graph LSTM networks, and/or sentence LSTM networks.

As another example, an architecture of some graph neural networks includes one or more recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input.

As another example, an architecture of some graph neural networks includes two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In some cases, an architecture of a graph neural network may be designed by a user. For example, a user may choose one or more hyperparameters of a graph neural network (e.g., a number of layers, a number of neurons in each layer, an activation function used by at least some neurons, and the like) in order to process an input graph data set. In some cases, the selected one or more hyperparameters may be based on domain-specific knowledge, e.g., a specific data type, internal organization or structure, and/or task associated with an input graph data set.

Alternatively or additionally, in some cases, an architecture of a graph neural network may be selected by an automated process. For example, a hyperparameter search process may determine one or more hyperparameters of a graph neural network based on an analysis of an input graph data set to be received and processed by the graph neural network and/or an analysis of an output graph data set to be generated and provided as output by the graph neural network. The hyperparameter search process may determine various combinations of hyperparameters for variations of the graph neural network (e.g., graph neural networks with different numbers of layers, different numbers of neurons within each layer, graph neural networks including neurons with different activation functions, and/or graph neural networks with different sets of synapses interconnecting the neurons of various layers). The hyperparameter search process may process an input graph data set (e.g., a training input graph data set) using different graph neural networks that correspond to different sets of hyperparameters. The hyperparameter search process may compare the output of the different graph neural networks (e.g., determining a performance measurement for the output of each graph neural network, and comparing the performance measurements of the different graph neural networks) in order to determine and select a graph neural network that generates desirable output (e.g., output that most closely corresponds to a target output associated with the training input graph data set). The hyperparameter search process may discard the other graph neural networks and may use the selected graph neural network to process input graph data sets. In some cases, the hyperparameter search process may iteratively generate and test refined combinations of hyperparameters. For example, after selecting a graph neural network in a first hyperparameter search processing the hyperparameter search process may perform a second hyperparameter search processing by generating additional graph neural networks based on combinations of hyperparameters that are closer to the hyperparameters of the selected graph neural network, and evaluating the output of the additional graph neural networks. In some cases, the hyperparameter search process may perform a grid search over the set of valid hyperparameter combinations. Iterative refinement of the hyperparameters may enable the hyperparameter search process to determine an architecture of a graph neural network that is well-tuned to a particular task (e.g., an architecture of a graph neural network that demonstrates consistently high performance on input graph data sets within a particular domain of data and/or a particular task). In some cases, a hyperparameter search process may communicate with a user to determine combinations of hyperparameters to evaluate and/or to select for the graph neural network. For example, the hyperparameter search process may present, to a user, a result of a first hyperparameter evaluation (e.g., an output of a graph neural network that was selected through a first hyperparameter search processing). Based on an evaluation of the output by the user, the hyperparameter search process may perform a second or further hyperparameter search processing (e.g., choosing a small refinement of the hyperparameters based on a positive response of the user to the output of a selected graph neural network, and/or choosing a larger refinement of the hyperparameters based on a negative response of the user to the output of the selected graph neural network).

As another example, some graph neural networks include architectures based on graph convolutional networks (GCNs), wherein a convolutional layer applies a convolution operation to outputs of one or more filters of a previous filter layer of the graph convolutional network. Graph convolutional networks may include spectral convolutional networks that are configured to receive, as input, a spectral representation of an input graph data set, and to apply processing (including one or more convolutional operations) to various spectral components of the spectral representation of the input graph data set. Examples of spectral convolutional networks include, without limitation ChebNet and diversified graph convolutional networks (DGCNs). As another example, some graph convolutional networks include architectures based on spatial convolutional networks (SCNs) that are configured to receive, as input, spatial representations of an input graph data set (e.g., spatial information that represents one or more neighborhoods of nodes and/or edges of the input graph data set), and to apply processing (including one or more convolutional operations) to various spatial components of the spatial representation of the input graph data set. Examples of spatial convolutional networks include, without limitation, spatial convolutional neural networks (SCNNs), spatial and/or spatial-temporal GraphSAGE networks, and some deep convolutional neural networks (DCNNs).

Graph neural networks can be generated by a variety of machine learning platforms, frameworks, and/or tools, including, without limitation, PyTorch Geometroc, Deep Graph Library, TensorFlow GNN, Graph Nets, Spektral, and Jraph. Frameworks for graph convolutional networks include, without limitation, message passing neural networks (MPNNs), non-local neural networks (NLNNs), mixture model neural networks (MoNet), and Graph Networks (GN).

Further explanation and/or examples of various architectures of graph neural networks, including the design and implementation of designs and architectures of such graph neural networks, are presented elsewhere in this disclosure and/or will be known to or appreciated by persons skilled in the art.

### Graph Neural Networks—Training and Performance Evaluation

Like other types of neural networks, graph neural networks are typically generated with arbitrarily selected parameters (e.g., synaptic weights that are initially set to randomized values). Also, like other types of neural networks, an initialized graph neural network to evaluate input graph data sets through training, in which the parameters of the graph neural network are adjusted to promote desirable processing that produces expected and/or desirable outputs.

The training of graph neural networks may involve one or more training data sets. For graph neural networks that receive and process input graph data sets, the training data may include one or more training input graph data sets. Alternatively or additionally, for graph neural networks that receive and process input non-graph data, the training data may include one or more sets of training non-graph data.

The training data for a graph neural network may be based on authentic input data that was previously collected and/or analyzed, or that was collected and analyzed for the purpose of training the graph neural network. For example, in order to process graphs that represent an industrial environment, the training data may include sensor data that was previously and/or is currently received from one or more sensors associated with the industrial environment. Alternatively or additionally, the training data may include partially and/or fully synthetic data. For example, a first portion of training data may include data derived from an analysis of authentic data; authentic data that has been supplemented with synthetic data (e.g., an image of a real-world scene including an inserted artificial object); authentic data that has been modified by a suer (e.g., an image of a real-world scene that has been modified by a user); and/or data generated by one or more algorithms (e.g., other machine learning models and/or simulations of real-world processes). In some cases, the training data set may include both authentic training data and synthetic training data that is based on the authentic training data (e.g., both a real-world image and a modified version of the real-world image that has been adjusted in brightness, contrast, size, resolution, scale, shape, aspect ratio, color depth, or the like).

The training data for a graph neural network may be limited to a selected data domain. For example, training data for a graph neural network that analyzes social networks may include one or more samples of individuals from within one or more selected social networks. In other cases, the training data for a graph neural network may be generated from a variety of data domains. For example, training data for a graph neural network that analyzes geographic data may include one or more samples of locations of interest and interconnecting pathways from natural outdoor geographic regions (e.g., forests), artificial outdoor geographic regions (e.g., road networks), indoor geographic regions (e.g., caves or shopping malls), historic geographic regions (e.g., maps from ancestral eras and/or civilizations), and/or synthetic geographic regions (e.g., geographic maps from videogames).

The training data for a graph neural network may be wholly or partially unlabeled. For example, the training data set for an industrial environment may include sensor measurements collected from the industrial environment, but may not include any data indicating an analysis, classification, metadata, interpolations, extrapolations, interpretation, explanation, and/or user reaction associated with the sensor measurements. Alternatively or additionally, the training data for a graph neural network may be wholly or partially labeled. For example, the training data set for an industrial environment may include sensor measurements collected from the industrial environment, and one or more subsets of sensor measurements may be associated with one or more analyses, classification labels, metadata, interpolations, extrapolations, determinations, interpretations, explanations, and/or user reactions associated with the subset of sensor measurements. Training data may associate labels, metadata, or the like with one or more nodes and/or node properties of a training input graph data set; one or more edges and/or edge properties of a training input graph data set; one or more graph properties of the training input graph data set; and/or one or more portions of non-graph data of a training input data set. In some cases, the labels, data, metadata, or the like associated with at least a portion of a training input data set are selected by one or more users (e.g., a human classification of at least a portion of the training data set). In some cases, the labels, data, metadata, or the like associated with at least a portion of a training input data set are selected by another algorithm (e.g., a simulation or another machine learning model). In some cases, the labels, data, metadata, or the like associated with at least a portion of a training input data set are selected by a cooperation of a human and an algorithm (e.g., a determination by a simulation or another machine learning model that is verified by a reviewing human user).

Graph neural networks can be trained based on one or more training data sets and one or more learning techniques. As an example, some graph neural networks are trained through an unsupervised learning technique. For example, a training input data set may not include any labels, data, metadata, or the like associated with various portions of the training input data set. The graph neural network may be trained to identify patterns arising within the training input data sets. For example, a training input data set may include data that indicates one or more anomalies (e.g., nodes and/or edges that appear to represent outliers in a data distribution of the nodes and/or edges of the graph) and/or distinctive patterns or structures arising in the data (e.g., cycles arising in a directed and/or undirected graph). The graph neural network may be trained to detect such anomalies, patterns, and/or structure in the training input data sets. The results of unsupervised learning of a graph neural network may be evaluated based on an evaluation of the output of the graph neural network (e.g., a confusion matrix that includes determinations of true positive determinations, true negative determinations, false positive determinations, and/or false negative determinations) and/or performance scores (e.g., an F1 performance score based on ratios of true positives, false positives, true negatives, and false negatives). The weights of various parameters of the graph neural network can be automatically adjusted, corrected, refined, or the like, such that subsequent processing of the same input training data set and/or other input training data sets generates improved evaluations and/or performance scores.

As another example, some graph neural networks are trained through a supervised learning technique. For example, a training input data set may associate respective portions (e.g., respective training data samples, such as different training input graph data sets) with one or more labeled outputs that are expected and/or desirable of the trained graph neural network. As an example, a graph neural network may be trained to output a classification of a training input graph data set and/or one or more nodes and/or edges thereof. During a supervised learning process, the training input graph data set may be provided as input to the graph neural network and processed by the graph neural network to generate a predicted classification of a training input graph data set and/or one or more nodes and/or edges thereof. The predicted classifications may be compared with one or more labeled outputs associated with the training input graph data set (e.g., one or more labels associated with an expected and/or desirable classification of the training input graph data set and/or one or more nodes and/or edges thereof). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more accurate predictions of one or more labels associated with an expected and/or desirable classification of the training input graph data set and/or one or more nodes and/or edges thereof). As another example, a graph neural network may be trained to generate, as output, an output graph data set that is based on a processing of a training input graph data set. During a supervised learning process, the training input graph data set may be provided as input to the graph neural network and processed by the graph neural network to generate an output graph data set. The output graph data set generated by the graph neural network may be compared with one or more expected and/or desirable output graph data sets corresponding to the training input graph data set (e.g., one or more output graph data sets that are expected and/or desired as output when the graph neural network processes the training input graph data set). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more desirable and/or expected output graph data sets).

As another example, some graph neural networks are trained through a blended training process that includes both supervised and unsupervised learning. For example, a blended training process may evaluate the performance of a graph neural network in training based on both a comparison of predicted outputs of the graph neural network to expected and/or desirable outputs corresponding to an input training data set, and based on one or more automatically determined performance metrics, such as a confusion matrix and/or F1 scores. Some blended training processes may include a round of supervised learning following by a round of unsupervised learning, or may perform rounds of training that include both supervised and unsupervised learning techniques (e.g., optionally with different weights and/or performance thresholds associated with the evaluation of the graph neural network and the updating of the parameters).

As another example, some graph neural networks are trained through a semi-supervised learning process. For example, a training data set may include a large number of samples, of which only a small number of samples are labeled (e.g., associated with expected and/or desirable outputs) and a large remainder of the samples are unlabeled (e.g., not associated with expected and/or desirable outputs). The graph neural network may be trained based on the labeled and/or unlabeled training data, and a performance of the graph neural network may be evaluated based on the labels and/or other metrics. In particular, some unlabeled portions of the input training data may be identified as being incorrectly evaluated by the graph neural network (e.g., the graph neural network may generate incorrect outputs such as predictions or classifications, incorrect and/or malformed output graph data sets, or the like). At least a portion of such unlabeled portions of the input training data (e.g., training data samples that appear to be difficult to classify correctly and/or with high confidence) may be submitted to a human reviewer, and the semi-supervised learning process may receive, from the human reviewer, one or more labels that correspond to an expected and/or desirable output of the graph neural network for such portions of the input training data. Training or retraining of the graph neural network may involve the newly labeled portions of the input training data, as well as other portions of the input training data. Semi-supervised learning may enable graph neural networks to be trained based on a smaller degree of human involvement (e.g., a smaller number of labels associated with portions of the input training data set by human reviewers), and may therefore improve a speed, cost, and/or performance of training the graph neural network.

A training of a graph neural network may occur in one or more epochs. For example, for each epoch, the graph neural network may be provided with input comprising each portion of a training data set, a performance of the graph neural network may be determined based on the output of the graph neural network for each portion of the training data set. Based on the determined performance, and one or more parameters of the graph neural network may be updated. For example, weights of the synapses between neurons of the graph neural network may be adjusted such that a performance of the graph neural network over each portion of the training data set. During the training of a graph neural network, various techniques may be used to evaluate the performance of the graph neural network. As a first example, outputs of the graph neural network (e.g., output graph data sets and/or predictions, such as classifications of the graph, one or more nodes, and/or one or more edges) may be compared with expected and/or desirable outputs. Differences between the outputs and the expected and/or desirable outputs may be used to determine an entropy and/or loss of the output of the graph neural network as compared with corresponding expected and/or desirable outputs. In some variations, the entropy or loss of the graph neural network determined during or after a current epoch may be compared with an entropy or loss of the graph neural network determined during or after a previous epoch to determine a differential and/or marginal entropy or loss. A negative differential and/or marginal entropy or loss may indicate that the training of the graph neural network is productive (e.g., the performance of the graph neural network improved in the current epoch as compared with a previous epoch). A zero or positive differential and/or marginal entropy or loss may indicate that the training of the graph neural network is unproductive (e.g., the performance of the graph neural network did not improve, or diminished, in the current epoch as compared with a previous epoch). Training of the graph neural network may therefore continue as long as the differential and/or marginal entropy or loss remains negative and, optionally, exceeds a threshold magnitude that indicates significant training progress.

As another example, outputs of the graph neural network (e.g., output graph data sets and/or predictions, such as classifications of the graph, one or more nodes, and/or one or more edges) may be classified as one of a true positive, a false positive, a true negative, or a false negative. The performance of the graph neural network may be evaluated as a confusion matrix, e.g., based on a calculation of the performance over the incidence of true positive, false positive, true negative and false negative outputs. In some cases, the calculation may be weighted based on a risk matrix that applies different weights to each classification of the output. For example, in a graph neural network that generates classifications of graphs that correspond to diagnoses of medical conditions, it may be determined false negatives (e.g., missed diagnoses) are very harmful or costly, while false positives (e.g., misdiagnoses that can be corrected by further evaluation) may be determined to be comparatively harmless. Accordingly, the performance of the graph neural network may be determined based on a weighted calculation over the confusion matrix that more severely penalizes the performance based on false negatives than false positives.

As another example, the training of a graph neural network may involve an improvement of an objective function that serves as a basis for measuring the performance of the graph neural network. For example, the objective function may include (without limitation) a loss minimization, an entropy minimization, a precision maximization, a recall maximization, an error minimization, or a consistency maximization. The objective function may include a comparison of the performance of the graph neural network over various distributions of the input data set (e.g., a minimax optimization, such as minimizing a maximum loss over any portion of the input data set, or a maximin optimization, such as maximizing a minimum loss over any portion of the input data set). In some training scenarios that involve reinforcement learning, the output of a graph neural network may include and/or may be interpreted as a policy, e.g., a set of responses of an agent based on respective conditions. The performance of the graph neural network may be based on various objective functions that evaluate various properties of the generated and/or interpreted policy. For example, in a q-learning reinforcement learning process, the objective function applied to the policy may include a maximization of an action value of each behavior that may be performed in response to various conditions.

As another example, the training of graph neural networks may occur concurrently with the hyperparameter search and/or selection. For example, a hyperparameter search process may initially identify a first set of combinations of hyperparameters of graph neural networks to be evaluated using a training data set. Based on each such combination of hyperparameters, a graph neural network may be generated and at least partially trained to determine its performance. Based on the evaluation of the outputs of the graph neural networks corresponding to respective combinations of hyperparameters, the hyperparameter search process may identify a candidate graph neural network with the highest performance. The hyperparameter search process may then generate a second set of combinations of hyperparameters based on the hyperparameters of the candidate graph neural network, and may further (at least partially) train and evaluate the performance of additional graph neural networks based on the second set of combinations of hyperparameters. A comparison of the performance of the additional graph neural networks may cause the hyperparameter search process to retain the candidate graph neural network or to choose a new candidate graph neural network from among the additional graph neural networks. The hyperparameter search process may continue until additional improvements in the performance of candidate graph neural networks are not achievable and/or are below a threshold performance improvement. In this selection process, a variety of performance metrics may be used. As previously discussed, the performance metrics may include an evaluation of the outputs of the graph neural networks (e.g., a loss or entropy, a differential or marginal loss or entropy, a confusion matrix, an F1 score, or the like). Alternatively or additionally, the performance metrics may include other features of the output, such as a consistency of the output of the graph neural network over the distribution of data in the training data set and/or a bias in the performance the output of the graph neural network for selected data distributions of the training data set, and/or a smoothness or oversmoothness of the graph nodes represented in the graph neural network. Alternatively or additionally, the performance metrics may include one or more measurements of computational resource expenditures to perform training and/or inference of input data sets with the graph neural network (e.g., CPU and/or GPU utilization, memory usage, training time and/or complexity, processing latency between receiving input and generating output, or the like). Aggregate performance measurements may be based on a variety of such considerations, and may enable a human designer and/or a hyperparameter search process to perform a selection of a graph neural network based on various performance tradeoffs (e.g., a preference for a first graph neural network that produces high-accuracy, high-consistency, and/or high-confidence results but that requires a large amount of computational resources, time, and/or cost, vs. a preference for a second graph neural network that produces reasonable-accuracy, reasonable-consistency, and/or reasonable-confidence results using a smaller amount of computational resources, time, and/or cost). For example, a measurement of computational resource utilization by a particular graph neural network may correspond to a numeric penalty in various measurement of the performance of the graph neural network (e.g., a loss, entropy, and/or objective function output).

In various forms of graph neural network training based on these and other learning techniques, various training methods can be used to update the parameters of a graph neural network in training and/or to evaluate the performance of a graph neural network in training. For example, optimizers that may be used during the training of graph neural networks may include (without limitation) linear regression; root mean squared propagation (RMSprop); stochastic gradient descent; adaptive stochastic gradient descent (Adagrad); adaptive stochastic gradient descent with adaptive learning (Adadelta); adaptive moment estimation (Adam); Nesterov accelerated adaptive moment estimation (Nadam); Nesterov accelerated gradient and momentum (NAG); Monte Carlo simulations involving various variance reduction techniques, such as control variates; or the like, including variations and/or combinations thereof. Training techniques for particular types of graph neural networks may include optimizers that are specialized for such particular types of graph neural networks (e.g., graph convolutional networks may be trained using a FastGCN optimizer and/or receptive field control (RFC) optimizers).

As further examples, graph neural network training may include a variety of techniques that are also applicable to non-graph machine learning models, including non-graph neural networks. As a first such example, training may occur in batches and/or mini-batches of the training data set, wherein the graph neural network evaluates a batch (e.g., plurality of input data sets) of an input training data set, and the parameters of the graph neural network are updated based on an aggregation of the evaluation of the outputs of the graph neural network for the batch of input data sets. In various training techniques, batches may be selected at random from the training input data set or may be selected in an organized manner, e.g., as various subsets that are representative of one or more data distributions of the training input data set. For example, if the graph neural network in training exhibits good performance over some data distributions of the training input data and poor performance over other data distributions of the training input data, the continued training of the graph neural network may focus on, prioritize, and/or overweight the training based on batches of training input data that reflect the data distributions associated with poor performance. In various training techniques, a batch size of batches of training input data sets may be fixed, or the batch size may vary based on a progress of the training of the graph neural network.

As another example, in various training techniques for graph neural networks, an entire set of training input data may be partitioned into a training data set that is used only to train the graph neural network and update its parameters; a validation data set that is used only to evaluate a prospective and/or in-training graph neural network; and/or a test data set that is used to only evaluate a final performance of the fully trained graph neural network. The partitioning of the training input data may be based on one or more ratios (e.g., a 90/5/5 partitioning of the training input data into a training data set, a validation data set, and a test data set, or a 98/1/1 partitioning of the training input data into a training data set, a validation data set, and a test data set). For example, during an epoch, the performance of the graph neural network may be evaluated based on various portions of the training data set, and the parameters of the graph neural network may be adjusted based on the determined performance. However, continued training and updating of the graph neural network based on the training data set may result in overfitting, e.g., “memoization” of correct outputs that correspond to various portions of the training data set. Due to such overfitting, the performance of the graph neural network in evaluating previously evaluated input data sets may improve, but performance of the graph neural network on previously unevaluated input data sets may decline. Instead, at the conclusion of an epoch, the performance of the graph neural network may instead be evaluated based on various portions of the validation data set, which is not otherwise used to update the parameters of the graph neural network. Evaluation of the performance of the graph neural network on previously unseen data can indicate that the performance of the graph neural network is genuinely improving (e.g., based on learned principles of data evaluation that apply consistently to both previously seen and previously unseen input data sets), resulting in a continuation of training. Alternatively, Evaluation of the performance of the graph neural network on previously unseen data can indicate that the performance of the graph neural network is resulting in overfitting to the training data set (e.g., based on “memoization” of correct outputs for previously seen input data sets that do not inform the correct evaluation of previously unseen input data sets), resulting in a conclusion of training. Such conclusion may be referred to as “early stopping” of training to reduce overfitting of the graph neural network to the training data set and to preserve the performance of the graph neural network on previously unsee input data sets.

As another example, various training techniques for graph neural networks may include one or more regularization techniques, in which the inputs to the graph neural network and/or the processing of the input are adjusted to reduce overfitting. As a first example, the training of a graph neural network may include a dropout regularization technique, in which some neurons of the graph neural network are disabled for some instances of processing input data sets. In various regularization techniques, neurons to be disabled are selected randomly (e.g., 5% of the neurons during each epoch) and/or can be selected in a sequence (e.g., a round-robin selection of deactivated neurons). The selected neurons may be disabled by refraining from processing the inputs of the neurons and setting the outputs of the selected neurons to zero, and/or by processing the selected neurons but temporarily setting the weights of the synapses of the neurons to zero. As a second example, the training of a graph neural network may include a dropnode and/or dropedge regularization technique, in which portions of an input graph data set that include some nodes and/or some edges of the input graph data set are disabled. In various regularization techniques, nodes and/or edges to be disabled for an instance of processing are selected randomly (e.g., 5% of the nodes and/or edges during each epoch) and/or can be selected in a sequence (e.g., a round-robin selection of deactivated nodes and/or edges). The selected nodes and/or edges may be disabled by refraining from processing portions of the input data set that correspond to the selected nodes and/or edges, and/or by deactivating neurons of an input layer of the graph neural network that are configured to receive input data from the selected nodes and/or edges. As a third example, the performance of a graph neural network may be subjected to various forms of regularization, including L1 (“lasso”) regularization and/or L2 (“ridge”) regularization. These and other forms of regularization may be used, alone or in combination, to reduce overfitting of a graph neural network to an input training data set. For example, regularization may reduce an overweighting of a subset of nodes, edges, and/or neurons in the processing of various input data sets (e.g., by reducing and/or penalizing neurons having synaptic weights with magnitudes that are disproportionately large compared to the synaptic weights of other neurons of the graph neural network).

As another example, various training techniques for graph neural networks may combine a graph neural network with one or more other machine learning models, including one or more other graph neural networks and/or one or more non-graph neural networks. For example, a bootstrap aggregation (“bagging”) training technique involves a determination of a decision tree as an ensemble of machine learning models based on different bootstrap samples of the training input data set. Each machine learning model, including one or more graph neural networks, may be trained based on a random subsample of the training input data set. For a particular input data set, many of the trained machine learning models of the ensemble, including one or more graph neural networks, may present poor or only adequate performance. However, one or a few of the trained machine learning models may generate high-performance output for the particular input data set and others like it (e.g., for input data sets that share one or more properties, such as a select graph property, a select node property, and/or a select edge property). Thus, for any particular input data set, an evaluation of the specific properties of the particular input data set may enable a selection among the available models of the ensemble that may be used to evaluate the particular input data set. That is, a machine learning model (e.g., a graph neural network) that is generally a poorly performing model on most input data sets may exhibit good performance over a small neighborhood of input data sets that includes the particular data set, and may therefore be selected to evaluate the particular data set. Alternatively or additionally, the bootstrap aggregation may involve an evaluation of an input data set by a plurality of machine learning models (optionally including one or more graph neural networks of the ensemble) and a combination of the outputs of the selected machine learning models. In such scenarios, it is possible the individual outputs of the individual machine learning models exhibit poor performance (e.g., incorrect and/or low-confidence classifications of an input data set), but a determination of a consensus over the outputs of the multiple machine learning models may exhibit high performance (e.g., accurate and/or high-confidence classifications of the input data set).

As another example, various training techniques for graph neural networks may include a boosting ensemble technique, in which an output of a first trained machine learning model (e.g., a first graph neural network) is evaluated by a second trained machine learning model (e.g., a second graph neural network) to predict an accuracy and/or confidence of the prediction of the first trained machine learning model. For example, a first trained graph neural network may be evaluated to determine that it generates accurate and/or high-confidence output for a first group of input data sets (e.g., input graph data sets that include a first graph property, a first node property, and/or a first edge property), but inaccurate and/or low-confidence output for a second group of input data sets (e.g., input graph data sets that include a second graph property, a second node property, and/or a second edge property). A particular input data set may initially be processed by the first trained graph neural network to determine a first output (e.g., an output graph neural network or a prediction, such as a classification). A second trained graph neural network may evaluate the input data set and/or the output of the first graph neural network to predict an accuracy and/or confidence of the first graph neural network over input data sets that resemble the particular input data set. If the second trained graph neural network predicts that the output of the first graph neural network is likely to be of high accuracy and/or confidence, then the second trained graph neural network may provide the output of the first trained graph neural network as its output. However, if the second trained graph neural network predicts that the output of the first graph neural network is likely to be of low accuracy and/or confidence, then the second trained graph neural network may adjust, correct, and/or discard the output of the first trained graph neural network, or preferentially select an output of a different machine learning model (e.g., a third trained graph neural network) to be provided as output instead of the output of the first trained graph neural network. In such scenarios, it is possible that the individual outputs of the individual machine learning models exhibit poor performance (e.g., incorrect and/or low-confidence classifications of an input data set), but the review and validation of the output of some machine learning models by other machine learning models may enable a determination of a consensus over the outputs of the multiple machine learning models that exhibits high performance (e.g., accurate and/or high-confidence classifications of the input data set).

As another example, following conclusion of training a graph neural network, the graph neural network may be deployed for use (e.g., transferred to one or more devices, deployed into a production environment, and/or connected to a source of production input data). The performance of the graph neural network over input data sets may continue to be evaluated and monitored to verify that the graph neural network continues to perform well over various inputs. In some cases, the performance of the graph neural network may change between training and deployment. For example, a distribution of production input data processed by the graph neural network may differ from the distribution of training input data that was used to train the graph neural network. Alternatively or additionally, a distribution of production input data may change over time, e.g., between a time of deploying the graph neural network and a later time after such deployment. Such instances of changes in the performance of a fully trained and deployed graph neural network may be referred to as “drift.” In some such cases, “drift” may be reduced or eliminated by retraining or continuing training of the graph neural network, e.g., using additional training input data that corresponds to an actual or current distribution of the production input data. Alternatively or additionally, “drift” may be reduced or eliminated by training a substitute graph neural network to replace the initially deployed graph neural network. For example, the substitute graph neural network may include a different set of hyperparameters than the initially deployed graph neural network (e.g., additional layers and/or neurons to provide greater learning capacity; additional regularization techniques to reduce overfitting to the training data set; and/or the inclusion of specialized layers, such as pooling, filtering, memory, and/or attention layers). As another example, the initially deployed graph neural network may be added to an ensemble of other machine learning models, optionally including other graph neural networks, to generate improved outputs (e.g., higher-accuracy predictions) based on a consensus determined over the outputs of a number of machine learning models.

As another example, the training and/or use of graph neural networks may be susceptible to various forms of adversarial attack. For example, in an adversarial attack scenario, a particularly designed and/or selected input to a graph neural network (an “adversarial input,” such as an unusual, malformed, and/or anomalous) may cause the graph neural network to generate output that is incorrect, inconsistent with other outputs, and/or surprising. As an example, in a form of graph modification adversarial attack that may be referred to as node injection poisoning adversarial attack (NIPA), one or more nodes of an input graph data set are selected and/or altered to shift an output of the graph neural network based on the adversarial input (e.g., altering a classification and/or prediction of the input graph data set, or altering an output graph data set based on the adversarial input graph data set). As another example, in a form of graph modification adversarial attack that may be referred to as an edge perturbing adversarial attack (NIPA), one or more edges of an input graph data set are selected and/or altered to shift an output of the graph neural network based on the adversarial input (e.g., altering a classification and/or prediction of the input graph data set, or altering an output graph data set based on the adversarial input graph data set). As another example, in a training data injection attack, one or more portions of training input data on which a graph neural network is trained are designed and/or altered to alter the training of the graph neural network (e.g., a mislabeling of a particular training data input that causes the graph neural network to misclassify other inputs that correspond to the mislabeled training data input, and/or an injection of data samples into a training data set that alter a data distribution of the training data set upon which the graph neural network is trained). As another example, in a membership inference adversarial attack, properties and/or outputs of a graph data set are evaluated to identify properties of one or more training data inputs on which the graph data set was trained (e.g., an influential property of an input data set that causes the graph data set to select a particular classification for the any input data sets that include the property). As another example, in a property inference adversarial attack, properties and/or outputs of a graph data set are evaluated to identify general properties of training data inputs on which the graph data set was trained (e.g., a distribution of data included in the training data set, which may indicate particular distributions of input data over which the graph neural network was not trained, or over which the graph neural network was incompletely and/or incorrectly trained). As another example, in a model inversion adversarial attack, outputs of a graph neural network are examined to identify properties of corresponding input data sets that cause the graph neural network to generate such outputs.

Based on these and other forms of adversarial attack, the training and/or evaluation of a graph neural network may be adjusted to protect the graph neural network from such adversarial attack. For example, before an input to a graph neural network is processed, the input may be evaluated and/or classified (e.g., by another machine learning model, including another graph neural network) in order to determine whether the input is adversarial. If so, the graph neural network may refrain from processing the adversarial input, may process the adversarial input in more limited conditions (e.g., processing only a portion of the adversarial input, and/or replacing a malformed or anomalous portion of the adversarial input with a corresponding non-malformed and/or non-anomalous portion). As another example, during processing of an input data set, the internal behavior of the graph neural network may be evaluated and/or classified (e.g., by another machine learning model, including another graph neural network) to determine whether the behavior indicates a processing of adversarial input (e.g., unusual neuron activations, unusual outputs of one or more neurons, and/or updates of internal states of memory units). If so, the processing of the adversarial input may be halted and/or an internal state of the graph neural network may be restored to a time before the adversarial input was processed. As another example, before output of a graph neural network is provided in response to an input data set, the output may be examined and/or classified (e.g., by another machine learning model, including another graph neural network) to determine whether it is incorrect, inconsistent with other inputs, and/or surprising. If so, the output of the graph neural network may be discarded and/or altered before being provided in response to the input data set. Further explanation and/or examples of various techniques for training and performance evaluation of graph neural networks are presented elsewhere in this disclosure and/or will be known to or appreciated by persons skilled in the art.

### Graph Neural Networks—Applications

Graph neural networks can be applied to input data sets (including input graph data sets and/or input non-graph data sets) in various applications, and can be configured and/or trained to generate outputs (including output graph data sets and/or output predictions, such as classifications) that are relevant to various tasks within such applications.

For example, in the field of social networking, a graph data set may represent at least a portion of a social network, including nodes that represent people and that are connected by edges that represent relationships among two or more people. The graph data set representing a social network may be provided, as input, to a graph neural network that is configured to receive and process the input graph data set. The graph neural network may generate, as output, an output graph data set. For example, the output graph data set may include one or more new nodes that correspond to one or more newly discovered people within the social network, and/or one or more new edges that correspond to one or more newly discovered relationships that connect two or more people of the social network. The output graph data set may include one or more subgraphs and/or clusters that represent highly interconnected people of the social network, e.g., a social circle. The output graph data set may include a prediction of a recommendation of a relationship among two or more nodes corresponding to two or more people of the social network who share common personal traits, interests, and/or connections to other people. The output graph data set may include a prediction of a classification of a node corresponding to a person of the social network, e.g., a prediction of a personal interest of the person or a demographic trait of the person. The output graph data set may include a prediction of a classification of an edge that connects nodes representing two or more people of the social network, e.g., a prediction of a criminal association among two or more people of the social network. The output graph data set may include a determination of a relationship within the social network based on an attention model, e.g., an identification of a first node corresponding to a first person of the social network that appears to be influential to a second person of the social network represented by a second node of the graph. The output graph data set may include a prediction of a graph property of the graph, e.g., a classification of the social network as one or more types (e.g., a genealogy or familial social network, a friendship social network, and/or a professional relationship social network).

As another example, in the field of pharmaceuticals, a graph data set may represent at least a portion of a molecule (e.g., a protein or a DNA sequence), including nodes that represent atoms of the molecule and that are connected by edges that represent bonds and/or spatial relationships among two or more atoms. The graph data set representing a molecule may be provided, as input, to a graph neural network that is configured to receive and process the input graph data set. The graph neural network may generate, as output, an output graph data set. For example, the output graph data set may include one or more new nodes that correspond to one or more newly discovered atoms that may be added to the molecule, and/or one or more new edges that correspond to one or more newly discovered atoms of the molecule. The output graph data set may include one or more subgraphs and/or clusters that represent highly interconnected subregions of the molecule, such as carbon atoms that form a benzene ring or a binding site for a protein. The output graph data set may include a prediction of a classification of one or more nodes corresponding to one or more atoms of the molecule, e.g., a prediction that a subset of atoms of the molecule include a binding site for an enzyme that may active and/or deactivate a protein. The output graph data set may include a prediction of a classification of an edge that connects nodes representing atoms of the molecule, e.g., a prediction of a chemically reactive bond that can be altered to alter a property of the molecule. The output graph data set may include a prediction of a graph property of the graph, e.g., a prediction of a shape or organization of the molecule, a classification of the molecule as an enzyme, and/or a prediction of a potential side-effect of a drug due to an undesirable interaction with another drug.

As another example, in the field of software, a graph data set may represent at least a portion of a marketplace, including nodes that represent products and that are connected by edges that represent relationships between products. The graph data set representing a marketplace may be provided, as input, to a graph neural network that is configured to receive and process the input graph data set. The graph neural network may generate, as output, an output graph data set. For example, the output graph data set may include one or more new nodes that correspond to one or more newly discovered product, and/or one or more new edges that correspond to one or more newly discovered products. The output graph data set may include one or more subgraphs and/or clusters that represent highly interconnected products (e.g., two or more products that are often purchased and/or used together, or that compete in a particular market sector). The output graph data set may include a prediction of a recommendation of a relationship among two or more nodes corresponding to two or more products. The output graph data set may include a prediction of a classification of a node corresponding to a product, e.g., a prediction of an appeal, value, and/or demand of a product in a particular market segment, such as a particular subset of users. The output graph data set may include a prediction of a classification of an edge that connects nodes representing products, e.g., a prediction of a functional relationship between two or more products. The output graph data set may include a prediction of a graph property of the graph, e.g., a classification of the marketplace as increasing and/or decreasing in terms of supply, demand, size, prognosis, and/or public interest.

As another example, in the field of logistics, a graph data set may represent at least a portion of a supply chain, including nodes that represent locations where resources are generated, manufactured, stored, exchanged, and/or consumed and that are connected by edges that represent means of transport of resources between two or more locations. The graph data set representing a supply chain may be provided, as input, to a graph neural network that is configured to receive and process the input graph data set. The graph neural network may generate, as output, an output graph data set. For example, the output graph data set may include one or more new nodes that correspond to one or more newly discovered location of interest, and/or one or more new edges that correspond to one or more newly discovered locations of interest. The output graph data set may include one or more subgraphs and/or clusters that represent highly interconnected locations of interest, such as locations between which certain resources are frequently transported. The output graph data set may include a prediction of a recommendation of a relationship among two or more nodes corresponding to two or more locations of interest. The output graph data set may include a prediction of a classification of a node corresponding to a location of interest, e.g., a prediction of an availability, supply, demand, value, and/or appeal of a resource in the location of interest. The output graph data set may include a prediction of a classification of an edge that connects nodes representing locations of interest, e.g., a prediction of a volume of utilization of a mode of transport between two locations of interest. The output graph data set may include a prediction of a graph property of the graph, e.g., a classification of a stability of the supply chain based on social, economic, political, and/or environmental changes.

As another example, in the field of energy, a graph data set may represent at least a portion of an energy grid, including nodes that represent energy generators, stores, distributors, and/or consumers, and that are connected by edges that represent relationships among energy generators, stores, distributors, and/or consumers. The graph data set representing an energy grid may be provided, as input, to a graph neural network that is configured to receive and process the input graph data set. The graph neural network may generate, as output, an output graph data set. For example, the output graph data set may include one or more new nodes that correspond to one or more newly discovered energy generators, stores, distributors, and/or consumers, and/or one or more new edges that correspond to one or more newly discovered energy generators, stores, distributors, and/or consumers. The output graph data set may include one or more subgraphs and/or clusters that represent highly interconnected energy generators, stores, distributors, and/or consumers. The output graph data set may include a prediction of a recommendation of a relationship among two or more nodes corresponding to two or more energy generators, stores, distributors, and/or consumers. The output graph data set may include a prediction of a classification of a node corresponding to energy generators, stores, distributors, and/or consumers, e.g., a prediction of a current or future state or property of the energy generator, store, distributor, and/or consumer. The output graph data set may include a prediction of a classification of an edge that connects nodes representing energy generators, stores, distributors, and/or consumers, e.g., a prediction of a transaction between two or more energy generators, stores, distributors, and/or consumers. The output graph data set may include a prediction of a graph property of the graph, e.g., a classification of a stability of the energy grid to sustain energy generation and to support energy demands based on social, economic, political, and/or environmental changes.

As another example, in the field of civil engineering, a graph data set may represent at least a portion of a geographic region, including nodes that represent locations of interest and that are connected by edges that represent roads. The graph data set representing a geographic region may be provided, as input, to a graph neural network that is configured to receive and process the input graph data set. The graph neural network may generate, as output, an output graph data set. For example, the output graph data set may include one or more new nodes that correspond to one or more newly discovered locations of interest, and/or one or more new edges that correspond to one or more newly discovered locations of interest. The output graph data set may include one or more subgraphs and/or clusters that represent highly interconnected locations of interest. The output graph data set may include a prediction of a recommendation of a relationship among two or more nodes corresponding to two or more locations of interest. The output graph data set may include a prediction of a classification of a node corresponding to location of interest, e.g., a prediction of a current or future volume of visitors to a location of interest and/or a volume of traffic at or through the location of interest. The output graph data set may include a prediction of a classification of an edge that connects nodes representing locations of interest, e.g., a prediction of a volume of traffic on a road that connects two or more locations of interest. The output graph data set may include a prediction of a graph property of the graph, e.g., a classification of a sufficiency of a road network of the geographic region to support a current or future volume of traffic.

As another example, in the field of industrial systems, a graph data set may represent at least a portion of an industrial plant, including nodes that represent machines of the industrial plant and that are connected by edges that represent functional relationships among the machines. The graph data set representing the industrial plant may be provided, as input, to a graph neural network that is configured to receive and process the input graph data set. The graph neural network may generate, as output, an output graph data set. For example, the output graph data set may include one or more new nodes that correspond to one or more newly discovered machines, and/or one or more new edges that correspond to one or more newly discovered machines. The output graph data set may include one or more subgraphs and/or clusters that represent highly interconnected machines. The output graph data set may include a prediction of a recommendation of a relationship among two or more nodes corresponding to two or more machines. The output graph data set may include a prediction of a classification of a node corresponding to a machine, e.g., a prediction of a current or future maintenance state of a machine. The output graph data set may include a prediction of a classification of an edge that connects nodes representing machines, e.g., a prediction of a functional relationship between a first machine and a second machine that may significantly impact an efficiency, output, cost, or the like of the industrial plant. The output graph data set may include a prediction of a graph property of the graph, e.g., a classification of the industrial plant as belonging to a particular industry, such as raw material processing, semiconductor fabrication, tool manufacturing, vehicle manufacturing, textile manufacturing, and/or pharmaceuticals manufacturing. The output graph data set may include a prediction of a future and/or optimized state of the industrial plant, e.g., a reorganization of the machines of the industrial plant to optimize machine placement and/or floor planning.

As another example, in the field of cybersecurity, a graph data set may represent at least a portion of a device network, including nodes that represent devices and that are connected by edges that represent communication and/or interactions among two or more devices. The graph data set representing the device network may be provided, as input, to a graph neural network that is configured to receive and process the input graph data set. The graph neural network may generate, as output, an output graph data set. For example, the output graph data set may include one or more new nodes that correspond to one or more newly discovered devices, and/or one or more new edges that correspond to one or more newly discovered devices. The output graph data set may include one or more subgraphs and/or clusters that represent highly interconnected devices. The output graph data set may include a prediction of a recommendation of a relationship among two or more nodes corresponding to two or more devices. The output graph data set may include a prediction of a classification of a node corresponding to a device, e.g., a prediction of a security status of the device as being safe, vulnerable, or corrupted. The output graph data set may include a prediction of an activity occurring among the nodes of the graph data set, e.g., an occurrence of an intrusion or an attack based on anomalous activities represented by the edges of the graph data set. The output graph data set may include a prediction of a classification of an edge that connects nodes representing devices, e.g., a prediction that a particular interaction between two or more devices is associated with a security vulnerability or attack. The output graph data set may include a prediction of a graph property of the graph, e.g., a classification of the set of devices as safe from security flaws or vulnerable to one or more attack mechanisms, such as denial-of-service (DoS) attacks, distributed-denial-of-service (DDoS) attacks, social engineering attacks such as phishing, eavesdropping attacks such as man-in-the-middle attacks, or the like. The output graph data set may include a prediction of a theoretical state of the graph data set, e.g., a security state of the device network in response to a particular type of attack, and/or a security state of the device network based on the inclusion of additional devices in the future. The output graph data set may include a recommendation to modify the graph neural network based on one or more security considerations, e.g., a recommendation to reorganize the device network to reduce susceptibilities to one or more security risks. The output graph data set may include a technique to defend the graph neural network from various types of adversarial attack, e.g., training-time attacks that affect the manner in which the graph neural network learns to evaluate and/or classify the graph data set, one or more nodes, and/or one or more edges. For example, the message passing operations of the graph neural network may be modified to reduce a susceptibility of the graph neural network to adversarial perturbation during training, while preserving the learning capabilities of the graph neural network.

Examples of additional applications of various graph neural networks to various graph data sets include, without limitation; graph mining applications (e.g., graph matching and/or clustering); physics (e.g., physical systems modeling and/or evolution over time); chemistry (e.g., molecular fingerprints and/or chemical reaction predictions); biology (e.g., protein interface predictions, side effects predictions, and/or disease classification); knowledge graphs (e.g., knowledge graph completion and/or knowledge graph alignment); generation (e.g., output graph data set generation that corresponds to an expression, an image, a video, a music sample, or a scene graph); combinatorial optimization; traffic networks (e.g., traffic state prediction); recommendation systems (e.g., user-item interaction predictions and/or social recommendations); economic networks (e.g., stock markets); software and information technology (e.g., software defined networks, AMR graph-to-text tasks, and program verification); text processing (e.g., text classification, sequence labeling, machine translation, relation extraction, event extraction, fact verification, question answering, and/or relational reasoning); and image processing (e.g., social relationship understanding, image classification, visual question answering, object detection, interaction detection, region classification, and/or semantic segmentation). Further examples of applications for processing various graph data sets by various graph neural networks are presented elsewhere in this disclosure and/or will be known to or appreciated by persons skilled in the art.

### Attention

In embodiments, an artificial intelligence system, machine learning model, or the like, of any of the types disclosed herein, may comprise, integrate, link to, or include an attention feature. Attention may be generally described as a determination, among a set of inputs, of the relatedness of each input to the other inputs in the set of inputs. In “self-attention,” the input includes a sequence of elements, and attention is determined between each pair of elements in the sequence. As a first example, the set of inputs includes a sequence of words in a language, and attention is applied to determine, for each word in the sequence, the relatedness of the word to each other word in the sequence. As a second example, an input includes an image comprising a set of pixels, and attention is applied to determine, for each group of pixels in the image, the relatedness of the group of pixels to each other group of pixels in the image. Attention can also be applied between sets of input, wherein attention is determined between each element of a first set of input and each element of a second set of input. For example, the set of inputs can include a first sequence of words in a first language and a second sequence of words in a second language, and attention can be determined to indicate how each word in the first sequence is related to each word in the second sequence.

FIG. 16 presents an example of a determination of attention by a machine learning model. In the example of FIG. 16, an input sequence 1602 includes a set of tokens, each representing a word (“The”, “Furry”, “Dog”, “Chased”, “The”, “Cat”). Each token includes an indicator of a position of the token in the sequence. In various embodiments, the tokens of the input sequence may include complete words, portions of words (e.g., a first token indicating a word root and a second token indicating a modifier of the word root), punctuation, or the like. Some tokens may indicate metadata, such as a start-of-sequence token, an end-of-sequence token, or a null token indicating a padding of the sequence or a mask that hides a token of the sequence.

The input sequence is processed by a position encoder that determines, for each token, an encoding of the position. In some embodiments, the position encoding may include an ordinal numerical value that indices the ordinal position of each token in the sequence, such as an index beginning at zero or one. In some embodiments, the position encoding may include a relative numerical value that indicates a position of each token in the sequence relative to a fixed position, such as a current word (encoded position 0), an immediately preceding word (encoded position −1), or an immediately following word (encoded position 1). In some embodiments, the position encoding may include non-integer values and/or multiple values, such as a first index indicating a sine calculation (with a given frequency) of the position of each token and a second index indicating a cosine calculation (with a same or different frequency) of the position of each token.

The input sequence is also processed by an embedding model. The embedding model determines, for each token in the input sequence, a mapping of the token into a latent space representation of the input (e.g., a latent space representation of a language). The latent space may position each token along a plurality of n dimensions, wherein each dimension represents a distinct type of relationship among the elements of the language. The embedding model clusters the tokens such that related tokens are positioned closer to each other within the latent space. For example, along one dimension of the latent space, the words “Cat” and “Dog” may be positioned close together as being words that describe animals, while also being positioned apart from words that do not describe animals, such as “Baseball” and “School.” Along another dimension of the latent space, the words “Dog” and “Furry” may be positioned close together as words that commonly occur in the context of dogs, while also being positioned apart from words that do not describe dogs, including “Cat.” For each token of the input sequence, the embedding model generates one or more values that indicate the position of the token within the latent space. In some embodiments, the values are encoded as a vector, and the proximity of two tokens within the latent space may be determined based on vector proximity calculations, such as cosine similarity.

Based on the positions encoded by the position encoder and the embeddings determined by the embedding model, a model input 1610 can be generated for the input sequence. As shown in FIG. 16, the model input includes a query, a set of keys, and a set of values. As an example, the query may include an indicator of a particular token in the input sequence, such as the sixth token (“Cat”). The keys may include the position encodings of respective tokens of the input sequence, as determined by the position encoder 1604, and a corresponding embedding of the respective token as determined by the embedding model 1606. The values may indicate additional data features of the tokens. As an example, the values may indicate, for each token of the input sequence, a determined sentiment (e.g., a ranking between −1, indicating very negative words, and +1, indicating very positive words). In some embodiments, no additional data features are available, and the values are identical to the keys.

The model input is received and processed by an attention layer 1612. In FIG. 16, the attention layer first includes a set of fully-connected layers; a first fully-connected layer processes the query of the model input; a second fully-connected layer processes the keys of the model input; and a third fully-connected layer processes the values of the model input. Each fully-connected layer includes a bias and a set of weights that adjust the values of the query, key, or value, respectively. The bias and weights of each fully-connected layer are model parameters that are initialized (e.g., to random values) and then incrementally adjusted during training.

Optionally, in some embodiments, the outputs of the fully-connected layers are further processed by a masking layer. The masking layer removes one or more values from the model input adjusted by the fully-connected layers. As a first example, the masking layer can reduce to zero the values of the key and/or value at a given position, such as a token at a current position to be predicted, or a token at a position following the current position that is to be hidden from the model. As a second example, the masking layer can reduce to zero the values of particular keys and/or values, such as padding values that are provided to adapt the size of the model input to a size of input that the attention layer is configured to receive and process. The masking layer can produce output for certain tokens (e.g., reduced to zero) for the indicated tokens (e.g., the current token, future tokens, and/or padding tokens) and that is the same as the input for the remaining tokens.

Optionally, in some embodiments, the outputs of the masking layer are further processed by a multi-head reshaping layer. The multi-head reshaping layer can reshape an input vector comprising the weighted and/or masked model input such that subsets of the input can be processed in parallel by different attention heads. As an example, an attention layer may include two attention heads, and the input can be reshaped such that each attention head is applied to only half of the inputs. The multi-head attention model can enable attention determinations over different subsets of the input (e.g., a first attention head can determine the relatedness of a first token to a first subset of tokens of the input sequence, and a second attention head can determine the relatedness of the same first token to a second subset of tokens of the input sequence). Alternatively or additionally, the multi-head attention model can enable different types of attention determinations among the tokens of the input sequence (e.g., a first attention head can determine a first type of relatedness of a first token to a subset of tokens of the input sequence, and a second attention head can determine a second type of relatedness of the same first token to the same or different subset of tokens of the input sequence). The multi-head attention model may enable parallel processing of the input sequence (e.g., the input for each attention head can be processed by a different processing core).

The attention layer includes an attention calculation that determines, based on the model input, the attention of a token of the input sequence with respect to other tokens of the input sequence. In some embodiments, the attention calculation includes an additive attention (“Bahdanau Attention”) calculation, in which attention is determined as a sum of weighted calculations of the distances of the tokens along each dimension of the latent space.

In some embodiments, the attention calculation includes a dot product determination, as a comparison of the distances between the vectors of the tokens within the latent space. In some embodiments, the attention calculation is performed over the query, keys, and values of the model input, optionally after processing with a masking layer. In some embodiments, the attention calculation is performed for each of a plurality of attention heads, each of which processes a particular subset of the tokens of the input sequence.

In embodiments that include multi-head reshaping, the output of the attention calculation is further processed by a merge operation that merges the attention calculations for the respective attention heads. In some embodiments, the merge operation includes a concatenation and/or interleaving of the attention calculations of the attention heads. In some embodiments, the merge operation includes an arithmetic operation applied to the attention calculations of the attention heads, such as an arithmetic mean, median, min, and/or max calculation.

The attention layer outputs, for at least one token of the input sequence, a determination of attention between the token and at least one other token of the input sequence. The output of the attention calculation may include a vector that indicates, for at least one token of the input sequence, the determinations of attention between the token and a set of other tokens of the input sequence. The output of the attention calculation may include a set of vectors that indicate, for respective tokens of the input sequence, the determinations of attention between the respective token and at least one other token of the input sequence. The output of the attention calculation may indicate, for a token of a first sequence, the attention of the token to one or more tokens of a second sequence. As shown in FIG. 16, the output of the attention layer includes pairwise determinations of relatedness between pairs of tokens (e.g., each pair including a current token in an input sequence and each preceding token in the input sequence). In some embodiments, the pairwise determinations may be further processed. For example, a softmax calculation can be applied to normalize the pairwise attention determinations based on a desired range of output values (e.g., probability values between 0.0 and 1.0, with a 1.0 sum over all output values).

The attention layer may be trained by providing sets of training input sequences and comparing the outputs of the attention layer with expected outputs. Alternatively or additionally, the attention layer may be trained by incorporating the attention layer into a larger model (e.g., a transformer model) and adjusting the parameters of the attention layer (e.g., the parameters of the fully-connected layers) for a given training input sequence in order to adjust the output of the attention layer toward a desired output for the training input sequence. As an example, in a backpropagation training process, the output of the attention layer is provided as input to a succeeding layer. The output of the model including the attention layer and the succeeding layer may be compared with a desired output for the training input sequence. Based on this comparison, adjustments of the output of the succeeding layer (e.g., based on an error calculation) may inform a determination of desired adjustments of the input of the succeeding layer, which correspond to adjustments of the output of the attention layer. The adjustments of the output may be achieved by internally adjusting the parameters of the attention layer (e.g., the weights and/or biases of the fully-connected layers shown in FIG. 16) such that the attention layer subsequently generates output for the training input sequence that more closely corresponds to the desired input for the succeeding layer. Incremental training over a set of training input sequences can cause the attention layer to generate output that corresponds to the desired output for the training input sequences. As an example, if the input sequences are sentences in a language and the desired output of the model includes the probabilities of words in the language that could follow a given set of input words, the attention layer can be incrementally adjusted to indicate the attention (e.g., relatedness) between the next word in the input sequence and the preceding words in the input sequence.

It is to be appreciated that the attention layer shown in FIG. 16 presents only one example, and that attention layers may include a variety of variations with respect to the example of FIG. 16. For example, attention layers may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the attention layer shown in FIG. 16 may vary in numerous respects. For example, masking may be applied to the model input instead of to the outputs of the fully-connected layers. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in attention layers that are incorporated in a variety of machine learning models to process a variety of types of input sequences.

### Transformer Models

In embodiments, an artificial intelligence system, machine learning model, or the like, of any of the types disclosed herein, may comprise, integrate, link to, or include a transformer model, that is, a neural network that learns context and meaning by tracking relationships in a set of sequential data inputs. Transformer models may include one or more attention layers, including (but not limited to) the attention layer shown in FIG. 16.

FIG. 17 presents an example of a transformer model. The transformer model of FIG. 17 is based on an encoder-decoder architecture in which an encoder processes an input sequence 1702 and a decoder processes an output sequence 1704 to generate output probabilities. As a first example, the input sequence may include a sequence of words in a first language; the output sequence may include a sequence of words in a second language corresponding to a translation of the input sequence; and the output probabilities may include the probabilities of words in the second language for a particular position in the translation. As a second example, the input sequence may include a sequence of words in a language that represent a query or prompt; the output sequence may include a sequence of words in the same language that represent a response to the query or prompt; and the output probabilities may include the probabilities of words in the second language for a particular position in the response. In some cases, the output sequence includes only the tokens up to a particular position (e.g., the first n−1 tokens of the output sequence), and the output probabilities represent the probabilities of tokens in the language of the output sequence that could follow the output sequence (e.g., the nth token in the output sequence). In some cases, the output sequence includes all of the tokens except the token a particular position (e.g., all of the tokens except the nth token of the output sequence), and the output probabilities represent the probabilities of tokens in the language of the output sequence that could represent the missing token in the output sequence (e.g., the nth token in the output sequence).

The encoder 1710 receives an input sequence comprising a set of tokens. The input sequence may be padded to a given length corresponding to a configured input size for the encoder. The input sequence is processed by a position encoder to encode the positions of the respective tokens of the input sequence. The input sequence is also processed by an embedding model to determine the embeddings of the tokens of the input sequence. The encoded positions and embeddings are used to generate an encoder model input, including a query (e.g., a position of one or more tokens in the input sequence), a set of keys (e.g., the encoded positions and embeddings for each token of the input sequence), and a set of values (e.g., additional language features of the tokens such as outputs of sentiment analysis). The set of values may be a copy of the set of keys if no additional data features are available. The encoder model input is processed by a multi-head attention layer, such as an instance of the attention layer shown in FIG. 16. The multi-head attention layer determines self-attention within the input sequence (e.g., the relatedness of a respective token of the input sequence to each other token of the input sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The encoder also includes a feed-forward layer (e.g., a fully-connected layer and/or a sparsely-connected layer) including a set of trainable parameters. The output of the feed-forward layer is provided to another layer normalization component, along with the output of the preceding layer normalization component via a skip layer. The encoder outputs an input sequence attention, which indicates, for each of one or more tokens of the input sequence, the relatedness of each other token of the input sequence.

The decoder 1712 features an architecture that is similar to the encoder, but that includes additional components to incorporate the input sequence attention generated by the encoder. The decoder receives an output sequence comprising a set of tokens. The output sequence may be padded to a given length corresponding to a configured input size for the decoder. The output sequence is processed by a position encoder to encode the positions of the respective tokens of the output sequence. The output sequence is also processed by an embedding model to determine the embeddings of the tokens of the output sequence. The encoded positions and embeddings are used to generate a decoder model input, including a query (e.g., a position of one or more tokens in the output sequence), a set of keys (e.g., the encoded positions and embeddings for each token of the output sequence), and a set of values (e.g., additional language features of the tokens such as outputs of sentiment analysis). The set of values may be a copy of the set of keys if no additional data features are available. The decoder model input is processed by a masked multi-head attention layer, such as an instance of the attention layer shown in FIG. 16. In addition to determining attention, the masked multi-head attention layer masks the input values of a current token of the output sequence and any tokens of the output sequence that follow the current token. The masked multi-head attention layer determines self-attention within the output sequence (e.g., the relatedness of a respective token of the output sequence to each preceding token of the output sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The decoder further includes an encoder-decoder multi-head attention layer that receives both the output of the preceding layer normalization component and the input sequence attention generated by the encoder. The encoder-decoder multi-head attention layer does not determine self-attention within the output sequence, but, rather, determines the attention between the tokens of the output sequence and the corresponding tokens of the input sequence. The output of the encoder-decoder multi-head attention unit is also received and processed by a second layer normalization component. Additionally, a skip layer is provided that passes the input to the encoder-decoder multi-head attention layer through to the second layer normalization component. The second layer normalization component combines the output of the multi-head attention layer with the input to the encoder-decoder multi-head attention unit (e.g., via arithmetic mean, median, min, max, addition, multiplication, or the like) and normalizes the combined output to within a desired range. The decoder also includes a feed-forward layer (e.g., a fully-connected layer and/or a sparsely-connected layer) including a set of trainable parameters. The output of the feed-forward layer is provided to a third layer normalization component, along with the output of the preceding layer normalization component via a skip layer. The output of the decoder is processed by a fully-connected layer and a softmax normalization layer based on a cross-entropy determination.

The output of the softmax normalization layer includes a set of probabilities for each possible token of a language of the output sequence for the current token. As a first example, the input sequence may include a sequence of words in a first language; the output sequence may include a sequence of words in a second language corresponding to a translation of the input sequence, up to a current (nth) word in the translation; the output probabilities may include the probabilities of words in the second language for the nth word in the translation. As a second example, the input sequence may include a sequence of words in a language that represent a query or prompt; the output sequence may include a sequence of words in the same language that represent a response to the query or prompt, up to a current (nth) word in the response; and the output probabilities may include the probabilities of words in the language for the nth word in the response.

During training, the transformer model may be provided with a set of input sequences and complete corresponding output sequences. As a first example involving language translation, the transformer model may be provided with a training data set including a first corpus of sentences in a first language and a second corpus of sentences in a second language that respectively correspond to the sentences in the first language. As a second example involving a generative model, the transformer model may be provided with a training data set including a first corpus of queries or prompts in a language and a second corpus of responses in the language that correspond to the respective queries or prompts. For each training data input, a pair of sentences of the first corpus and second corpus are selected. The encoder is provided with the first (input) sentence, and the model is processed to determine the first word in the second (output) sentence. In this case, the output sequence provided to the decoder is completely masked so that the decoder cannot make predictions based on the expected words in the second sentence. The word probabilities determined by the decoder are compared with the actual first word in the output sequence, and backpropagation is applied through the decoder and encoder to increase the likelihood of outputting the expected word. The backpropagation includes adjusting the parameters of the attention layers to increase the attention between the first word and related words of the input sequence. The encoder is then provided again with the first (input) sentence, and the model is processed to determine the second word in the second (output) sentence. In this case, the output sequence provided to the decoder includes the unmasked first word, but masks all words after the first word. The word probabilities determined by the decoder are compared with the actual second word in the output sequence, and backpropagation is applied through the decoder and encoder to increase the likelihood of outputting the expected word. The backpropagation includes adjusting the parameters of the attention layers to increase the attention between the second word, the known first word of the output sequence, and related words of the input sequence. In this manner, the transformer model performs an autoregressive prediction, wherein the output probability of each nth token of the output sequence is based on the input sequence, the previously predicted tokens of the output sequence, and the encoder-decoder attention therebetween. Training continues over the entirety of the first and second corpora to improve the output predictions.

In many cases, the training of the transformer model occurs in batches. For example, the previous (simplified) training example described an incremental training of the transformer model over each corresponding pair of sentences of the first and second corpora, wherein the parameters of the transformer model are adjusted via backpropagation after each instance of processing. In batch training, the input and output sequences are vectorized, as are the layers of the transformer model, such that predictions over each word of the output sequence are predicted in parallel. Backpropagation parameter adjustment is performed for each batch of the training data set, based on the outputs for all of the pairwise inputs of each batch of the training data set.

After training, the transformer model can be used to predict an output sequence based on an input sequence. First, the input sequence is processed by the encoder, while the decoder processes a null output sequence (e.g., an output sequence in which all outputs are initially nulled and/or masked by the masked multi-head attention layer). The output probability of the decoder is used to determine a first token of the output sequence. In some embodiments, the first token is chosen as the token having the highest probability. In other embodiments, the first token is chosen based on a random sampling over the output probabilities. In either case, the transformer is then applied to the same input sequence and an output sequence including only the determined first token of the output sequence, and the output of the decoder determines the second token of the output sequence. This process continues until reaching an output token cap and/or upon determining, as the output of the decoder, an end-of-sequence token. In this manner, the transformer model is applied over the input sequence to determine, in serial and autoregressive manner, the tokens of the output sequence.

It is to be appreciated that the transformer model shown in FIG. 17 presents only one example, and that transformer models may include a variety of variations with respect to the example of FIG. 17. For example, the architecture of the encoder and/or decoder may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the encoder and/or decoder shown in FIG. 17 may vary in numerous respects. For example, masking may be applied directly to the output sequence instead of within the multi-head attention models. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in transformer models to process a variety of types of input and output sequences.

Transformer models, including the example shown in FIG. 17, may be applied in a variety of circumstances. As an example, transformer models may be trained on and/or configured to process a variety of types of input sequences and/or output sequences. Sequential data inputs and/or outputs can include a wide variety of types described herein, such as strings of text, sequences of sensor data from or about an entity, sequences of steps in a process (e.g., chemical, physical, biological, and many others) or flow (e.g., a human workflow, information technology traffic flow, physical traffic flow, sequences of user behavior (e.g., attention to content, clickstream behavior, shopping behavior (digital and real world), and many others. Any of these, and others can be provided as inputs to train a transformer model, which may be alternatively described herein as a self-attention model, a foundation model, or the like. A range of mathematical self-attention techniques can be applied to detect how data elements in sequential data mutually affect each other (such as in feed forward, feedback, and other forms of influence and dependency). In various embodiments described herein and in the documents incorporated by reference herein, a set of transformer models may be deployed for a wide range of use cases, including for predictive text applications (e.g., generating a next token of text based on a previous set of tokens, such as for intelligent agent dialog, responses to queries, and the like); for extraction of information (such as extraction of meaningful elements from sensor data, signal data, and the like, such as analog signal data from sensors on machines, wearable devices, infrastructure sensors, edge and IoT devices, and many others); for analysis of human factors, such as emotional response, sentiment, satisfaction, opinion, and the like; for summarizing data (such as providing summaries of text, images, video, sensor data, and many other streams of data of the type collected and processed as described herein); for trend detection, prediction and forecasting (and hence also for anomaly detection, such as fraud in financial transactions), including for a wide range of trends, including health (human, animal, mental, financial, machine condition, and others), performance (wellness, financial, physical, and many others), and many others; for recognition of entities and behaviors (such as objects appearing in video or image data, objects captured in LIDAR and other point-cloud rendering systems, objects located by SLAM systems, and many others); for generation and execution of instructions (e.g., recipes, control instructions, rules, regulations, governance instructions, and many others); and for many other uses.

In embodiments, an input data set, such as an analog or digital sensor data stream, a body of text, a set of images, a set of structured data (such as data from a graph database or other form of database noted herein, a sequence of blockchain or distributed ledger entries (or other ledger data, such as accounting, financial, health or other data), a set of signals (of the various types noted herein), is provided in order to train a transformer model. In embodiments, initial training may include a step of facilitating compression of the input data, such as by constraining the size of the transformer neural network and/or its outputs, to dimensionality that is significantly smaller (or less granular, etc.) than that of the input data. By requiring the output of the constrained transformer model to match, within a required metric of fidelity, the input data, the transformer model is caused to generate an “embedding” of the input data into a more compressed, efficient format. A decoding neural network may then be trained to operate on the output of the constrained, embedding transformer model, such that it can reproduce the input data from the output of the constrained model within the required metric, thereby assuring that the data is compressed without losing critical meaning.

Once the embedding transformer model is so trained, the decoding neural network can be removed and replaced by one or more of a set of use-case driven decoding models, each of which is trained to operate on the output of the embedding model to produce a target outcome, such as performing any of the use cases noted above to a satisfactory degree. These use-case decoding models can be fine-tuned iteratively over time with feedback from users, outcomes, or the like. Thus, a trained embedding foundation/transformer model, once created, can be used across many different use cases that may benefit from understanding the meaning of the input data set.

In embodiments, one type of use-case decoder can be trained to allow the embedding transformer model to operate on lower quality data than was originally supplied to train the model. To accomplish this, both low quality and high quality data (such as high granularity sensor data and low granularity sensor data, or high dimensionality signal data and low dimensionality signal data, or noisy acoustic data and filtered acoustic data, or the like) can be simultaneously fed to a pair or more of instances of the trained, embedding transformer model, and a decoder for the instance of low quality data can be trained to generate an output that matches, within a metric of fidelity, the output of the instance of the embedding transformer model that is fed the high quality data. As an example, gap-free analog waveform data from a three-axis vibration sensor on a machine component can be captured simultaneously with less granular data from a single- or two-axis accelerometer on the same component, and a decoder, operating on the output of the instance of the embedding transformer model that takes the single- or two-axis input, can be trained to match (within a tolerance) the output of the instance of the embedding transformer model that takes the more granular data as an input. Once created, the resulting decoder, coupled with the embedding transformer model, serves as a projection transformer model, effectively projecting lower quality data into higher quality data, which can then be used by other decoders to enable use cases. This class of projecting transformer models can be applied to a wide range of use cases where high quality data can be obtained during a training phase (often at higher expense), but lower quality data can be used as an input during a deployment phase (such as where lower quality data is more widely or cheaply available, such as in the case of vibration data noted above). Among other things, these projecting transformer models allow powerful, real-time, low latency use cases for AI even when input data is sparse, noisy, of low dimensionality, or the like.

In embodiments, feedback from various decoder models can be used to improve instances of an embedding foundational or transformer model. In embodiments, a set of transformer models, a set of decoders, or both, can be arranged in a workflow, which may be directed/acyclical or with processing loops, to create higher-level use cases that benefit from multiple applications of AI. For example, one model may be used to classify a condition, another used to generate a recommendation, and another used to generate a control instruction, among a huge range of possible embodiments. This may include serial, parallel, iterative, feed forward, feedback and other configurations.

In embodiments, a set of models may be trained to generate instructions for configuration of other models.

In embodiments, transformer models may be deep learning, self-learning, self-organizing, or the like, and may be used for any of the embodiments of self-learning, self-organization, or other self-referential capabilities noted throughout this disclosure or the documents incorporated by reference herein. They may also be supervised, semi-supervised, or the like. Transformer models may be coupled with, integrated with, linked to, or the like, in series, parallel or other more complex workflows, with other AI types, such as other neural network types (e.g., CNNs, RNNs, and others). For example, in embodiments, a transformer model operating on sequential data may be coupled with a model suited to operate on non-sequential data (e.g., for pattern recognition) to achieve a use case.

In embodiments, transformer models discover patterns in large bodies of data by application of a set of mathematical functions, optionally operating in parallel processing configurations, thereby eliminating or reducing the need for human labeling (and thereby greatly expanding the set of available data that can be used to train a model).

Self-attention may be accomplished in a transformer model by introducing a set of positional encoders that tag data elements entering and exiting a neural network and inserting a set of attention units at appropriate places in the encoding and decoding framework of an AI system. The attention units generate a mathematical map of interrelationships among data elements. In embodiments multi-headed attention units are deployed, executing a matrix of equations in parallel to determine the interrelationships. Transformer models, using self-attention, have displayed strong capabilities to provide outputs that are consistent with how humans find patterns and meaning in data.

In embodiments, transformer models may be embodied with very large numbers of parameters (e.g., hundreds of millions, billions, trillions, or more) operating on very large sets of parallel processors. For example, the Megatron-Turing Natural Language Generation Model by NVIDIA and Microsoft is reported to have 530 billion parameters. As noted above, from a foundational model, various use-case specific models (decoders, projections, and the like) can be purpose-built for specific applications. Accordingly, in embodiments a set of transformer models may be deployed using advanced computational techniques and/or processing architectures, such as ones that simplify or converge processors, simplify I/O, and the like. For example, 3D chipset or chiplet architectures may facilitate much higher density, faster computation, making transformer models more cost-effective. Quantum computation may also facilitate massively parallel processing in form factors that are faster, more energy efficient, or the like. Similarly, embodiments may use a tensor-engine GPU chip with a specific transformer engine, such as the NVIDIA H100 Tensor Core GPU. Another example of a transformer model is Google's switch transformer model, a trillion-parameter model that uses sparsity and a mixture-of-experts architecture to enable gains in performance and reductions in training speed.

As noted above, in embodiments smaller or more constrained transformer models may be trained to generate embeddings, particularly for very complex data sets, such as granular analog data.

In embodiments a set of transformer models may be configured to operate on structured data processing systems, such as on results from queries that are directed to a database, results of inputs directed to a set of APIs, or the like. This may facilitate better understanding of what meaning a transformer model is recognizing in a data pattern, which can be critical to ensuring quality (e.g., where a model may, due to flaws in underlying data, generate poor conclusion, such as replicating historical racial bias, missing critical balancing information, failing to understand formal logical constructs, or the like). As noted elsewhere in this disclosure and the documents incorporated herein, governance of AI in general, is a need, and the scale and complexity of transformer models likely compounds problems recognized with other neural networks, including their “black box” nature, uncertainty about input quality, and the like. Thus, governance concepts disclosed herein and in documents incorporated by reference should be understood to apply to various embodiments that use transformer models, as with other types of AI. One example is in the training of models, where models may be trained, in embodiments, in various disciplines, optionally similar to the educational frameworks by which humans are trained not just to sense pattern meaning, but also how to test and govern those abilities with formal reasoning and logic, mathematics, probability, and frameworks of ethics and morality.

### Financial Infrastructure

Referring now to FIG. 18, a financial infrastructure system 1800 is illustrated in accordance with some embodiments. Financial infrastructure module 1806 is increasingly enabled at various layers 1802 by the convergence of AI capabilities 1804 with other technologies, impacting front and back-office operations for enterprises, marketplaces, and exchanges. In some cases, entirely new products and offerings are made possible.

Technology convergence enables various financial modules, which support use cases or converging technology stack examples 1808 for a given market, industry, or category.

The financial infrastructure modules 1806 include automated governance of transactions at the governance layer 1810, AI-based enterprise transactional decision support at the enterprise layer 1812, automated targeting and customized offer configuration at the offering layer 1814, automated transaction orchestration at the transaction layer 1816, converged AI-based transaction workflow orchestration at the operation layer 1818, intelligent edge for distributed transactions at the network layer 1820, context aware sensor fusion to inform transaction analytics and AI at the data layer 1822, and financial and computational resource optimization at the resource layer 1824.

At the governance layer 1810, AI capabilities 1804 for embedded policy and governance enable a financial infrastructure module 1806 for automated governance of transactions. Converging technology stack examples 1808 at the governance layer 1810 include policy automation, regulatory compliance automation, and reporting automation. Automated governance of transactions infrastructure addresses how increasingly digitized and networked transactional workflows can be governed by transactional policy automation that keeps in step with ever-shifting regulatory frameworks that apply to financial providers, marketplaces, exchanges, and their respective customers.

In embodiments, an automated governance of transactions financial infrastructure module underpinned by advanced embedded policy and governance artificial intelligence (AI) capabilities. The module may be designed to autonomously enforce compliance and governance standards across financial transactions by leveraging a sophisticated AI framework. The AI system is adept at interpreting and applying a comprehensive array of regulatory requirements, internal control policies, and industry standards to real-time transactional data flows. The module utilizes machine learning algorithms to continuously monitor, analyze, and make determinations on the compliance status of each transaction, thereby ensuring adherence to the pertinent legal and regulatory frameworks. The AI-driven module may dynamically adapt to regulatory changes, thereby maintaining up-to-date compliance. Furthermore, the module may automate the generation of detailed compliance reports and maintain an immutable audit trail for each transaction, facilitating transparency and accountability. By embedding these AI capabilities directly within the transactional infrastructure, the module significantly enhances the efficiency, accuracy, and reliability of the governance process, while simultaneously mitigating risk and reducing the operational burden associated with manual governance and compliance checks.

At the enterprise layer 1812, AI capabilities 1804 for contextual simulation and forecasting enable a financial infrastructure module 1806 for AI-based enterprise transactional decision support. Converging technology stack examples 1808 at the enterprise layer 1812 include financial executing digital twins, enterprise transaction systems integration, and enterprise access layers. AI-based enterprise transactional decision support infrastructure provides capabilities for strategic resource and transaction planning and simulation, such as based on integration of disparate operational and marketplace data sources into intelligent dashboards and digital twins.

In embodiments, an AI-based enterprise transactional decision support infrastructure module is empowered by contextual simulation and forecasting capabilities. This module integrates a sophisticated artificial intelligence framework that utilizes contextual data analysis to simulate various transactional scenarios and forecast potential outcomes. By processing vast datasets, including historical transaction records, current market trends, and predictive indicators, the AI system can generate comprehensive models that provide deep insights into the potential ramifications of different transactional strategies. The module's forecasting engine employs advanced algorithms to predict future market conditions, financial performance, and risk exposure, thereby enabling enterprises to make informed decisions. The contextual simulation aspect allows for the creation of virtual environments where hypothetical transactional decisions can be tested, providing a sandbox for strategic planning without the risk of actual financial commitment. This AI-driven decision support tool is designed to assist enterprises in optimizing their transactional workflows, aligning financial strategies with business objectives, and proactively managing risks, thereby enhancing the overall efficacy and strategic agility of the enterprise's financial operations.

At the offering layer 1814, AI capabilities 1804 for expert systems and generative AI enable a financial infrastructure module 1806 for automated targeting and customized offer configuration. Converging technology stack examples 1808 at the offering layer 1814 include enterprise wallets, transaction systems user interface, and targeting and recommendation. Automated targeting and customized offer configuration infrastructure leverages user profiles, behavior, marketplace, and other data to enable highly targeted and customized configuration of offering and promotions.

In embodiments, an automated targeting and customized offer configuration financial infrastructure module leverages the combined strengths of expert systems and generative artificial intelligence (AI) to deliver personalized and strategic financial offerings. Expert systems within the module utilize a rule-based approach to analyze customer profiles and transaction histories, enabling the identification of customer needs and preferences. Concurrently, generative AI algorithms may synthesize this data to create and propose tailored financial products and services. This dual-faceted AI approach ensures that offers are not only relevant but also creatively adapted to individual circumstances. The module seamlessly integrates with enterprise wallets, allowing for the direct and secure application of offers to customer accounts, thereby streamlining the acceptance process. The transaction systems user interface is designed to be intuitive, providing customers with a clear and interactive platform to view and manage these personalized offers. Furthermore, the targeting and recommendation use cases may be implemented through a dynamic feedback loop, where customer interactions with the offers are continuously fed back into the system, refining the AI models to enhance future offer accuracy and customer satisfaction. This sophisticated module thus represents a significant advancement in the customization and delivery of financial services, driving engagement and value for both the enterprise and its customers.

At the transaction layer 1816, AI capabilities 1804 for discovery, generation, and optimization enable a financial infrastructure module 1806 for automated transaction orchestration. Converging technology stack examples 1808 at the transaction layer 1816 include counterparty discovery, smart contract configuration, and automated transaction orchestration. Automated transaction orchestration infrastructure enables advance configuration of transaction terms in smart contracts, such that counterparties can be discovered, and desired transactions can be initiated, completed, and reconciled automatically when triggered by marketplace conditions or other input data.

In embodiments, an automated transaction orchestration financial infrastructure module is fundamentally enabled by artificial intelligence (AI) capabilities specializing in discovery, generation, and optimization. This module employs AI to intelligently navigate the vast landscape of potential transactional partners, utilizing data-driven insights to facilitate counterparty discovery. The module analyzes market behaviors, transactional histories, and compatibility metrics to recommend optimal transactional matches, thereby streamlining the process of identifying suitable counterparties. Once a counterparty is identified, the module may leverage generative AI to configure smart contracts that encapsulate the terms of the transaction, ensuring that all contractual obligations are met with precision and in accordance with predefined regulatory and compliance standards. The optimization AI may further refine this process by assessing various transactional parameters and adjusting the smart contract terms in real-time to maximize efficiency and minimize risk. The automated transaction orchestration use case is implemented through a combination of machine learning algorithms that predict transactional outcomes, natural language processing for contract generation, and neural networks that adaptively learn from each transaction to enhance future performance. Technical solutions for the implementation may include blockchain technology for secure and transparent smart contract execution, distributed ledgers for maintaining a consistent and immutable record of transactions, and cloud-based computing resources that provide the necessary scalability and computational power to process complex AI algorithms. This module thus represents a convergence of AI and financial technology, offering a robust solution for automating and optimizing transactional workflows within the financial sector.

At the operations layer 1818, AI capabilities 1804 for routing, control, optimization, and generation enable a financial infrastructure module 1806 for converged, AI-based transaction workflow orchestration. Converging technology stack examples 1808 at the operations layer 1818 include automated transaction monitoring, automated underwriting, and robotics and process automation. Converged, AI-based transaction workflow orchestration infrastructure enables automated completion of transaction steps (such as automated lending) via AI agents that operate on input data, trigger processing, and manage direction of outputs through a series of transaction steps.

In embodiments, a converged, AI-based transaction workflow orchestration financial infrastructure module is enabled by sophisticated artificial intelligence (AI) capabilities in routing, control, optimization, and generation. This module utilizes AI to oversee and manage the entire lifecycle of a financial transaction, from initiation to completion. For automated transaction monitoring, the module may deploy AI algorithms that track the progress of transactions in real-time, identifying bottlenecks and anomalies that could indicate potential issues, such as fraud or non-compliance, and automatically initiating corrective actions. For automated underwriting, the module may apply machine learning techniques to assess the risk profiles of applicants by analyzing vast datasets, thereby streamlining the approval process and reducing the likelihood of default. Robotics and process automation may be implemented to execute repetitive and rule-based tasks within the transaction workflow, such as data entry and compliance checks, with robotic process automation (RPA) bots acting as digital workers that interact with various systems and databases. Technical solutions may include deep neural networks for pattern recognition and predictive analytics, natural language processing for interpreting unstructured data within transaction documents, and blockchain technology for secure and immutable transaction recording. Additionally, cloud computing may provide the scalable infrastructure necessary to support the computational demands of the AI models, while API integrations may facilitate seamless communication between disparate financial systems. Collectively, these AI-driven capabilities and technical solutions may empower the module to orchestrate complex transaction workflows with enhanced efficiency, accuracy, and compliance.

At the network layer 1820, AI capabilities 1804 for adaptive networking enable a financial infrastructure module 1806 for intelligent edge for distributed transactions. Converging technology stack examples 1808 at the network layer 1820 include edge and cloud, communications (e.g., cellular, WiFi, ORAN, Bluetooth), and Internet of Things. Intelligent edge for distributed transactions infrastructure uses AI and expert systems in edge devices to enable localized transactions at points of sale or use.

In embodiments, an intelligent edge for distributed transactions financial infrastructure module is innovatively enabled by adaptive networking artificial intelligence (AI). This module is designed to facilitate seamless and secure financial transactions across a distributed network by leveraging AI to dynamically adapt network configurations and optimize data flow. The integration of edge computing with cloud services ensures that transaction processing can occur closer to the data source, reducing latency and enhancing real-time decision-making capabilities. The module's AI algorithms are capable of intelligently routing transaction data through the most efficient network paths, whether they be cellular, WiFi, Open Radio Access Network (ORAN), Bluetooth, or other IoT communication protocols. For implementation, the module may utilize technical features such as machine learning for predictive network traffic management, ensuring bandwidth is allocated where needed most, and cryptographic techniques for securing data at the edge. Additionally, the module may employ AI-driven anomaly detection systems to monitor network health and preemptively address potential disruptions. The use of containerization and microservices architectures allows for rapid deployment and scaling of transaction processing capabilities across the network. By integrating these technical features, the intelligent edge module provides a robust infrastructure capable of supporting the complex requirements of modern distributed financial transactions, ensuring that they are executed swiftly, reliably, and in compliance with regulatory standards.

At the data layer 1822, AI capabilities 1804 for sensor fusion enable a financial infrastructure module 1806 for context aware sensor fusion to inform transaction analytics and AI. Converging technology stack examples 1808 at the data layer 1822 include sensor data, social and web data, and APIs, SOA and distributed data. Context aware sensor fusion to inform transaction analytics and AI modules integrate disparate sensor data and feed AI to classify, predict, and optimize various parameters for analytic reporting and transaction automation.

In embodiments, a financial module for context aware sensor fusion to inform transaction analytics and AI is enabled by the integration of sensor fusion technology. This module is adept at synthesizing diverse data streams, including real-time sensor data, social media analytics, and web data, to provide a comprehensive view of transactional environments. By employing sensor fusion, the module may aggregate and process data from various sources, such as IoT devices, user interaction logs, and online behavior patterns, to generate a multidimensional context for each transaction. The use of APIs and Service-Oriented Architecture (SOA) facilitates the seamless integration and exchange of data across distributed systems, ensuring that the module has access to the most relevant and up-to-date information. Technical features for implementation may include advanced data normalization techniques to harmonize disparate data formats, machine learning algorithms for pattern recognition and predictive analytics within the fused data sets, and robust data security protocols to protect sensitive transactional information. The module's AI component may utilize the enriched data to enhance transaction analytics, providing insights into customer behavior, market trends, and potential fraud risks. By leveraging these technical features, the context aware sensor fusion module may significantly improve the accuracy and reliability of financial transaction analytics, enabling businesses to make data-driven decisions with greater confidence and strategic foresight.

At the resource layer 1824, AI capabilities 1804 for resource optimization enable a financial infrastructure module 1806 for financial and computational resource optimization. Converging technology stack examples 1808 at the resource layer 1824 include advanced computation, leverage optimization, and risk shifting and optimization. Financial and computational resource optimization infrastructure automates and optimizes transactions involved in acquiring, using, and/or selling energy, computational, and other resources needed for enterprise activities.

In embodiments, a financial and computational resource optimization financial infrastructure module is enhanced by resource optimization AI. The module may be designed to optimize the allocation and utilization of both financial and computational resources through the application of advanced AI algorithms. In the context of advanced computation, the module may employ AI to dynamically allocate processing power and memory resources across various financial applications, ensuring optimal performance and cost-efficiency. For leverage optimization, the AI may analyze financial leverage ratios in real-time, adjusting investment strategies and capital distributions to balance returns against risk exposure. Risk shifting and optimization may be achieved through AI-driven models that predict market volatility and credit risk, enabling proactive rebalancing of portfolios to mitigate potential losses. Technical features enabling these implementations may include deep learning networks for complex financial modeling, real-time analytics engines for monitoring resource utilization, and evolutionary algorithms that adapt financial strategies to changing market conditions. Additionally, the module may incorporate distributed ledger technology for transparent tracking of resource allocation decisions and smart contracts for the automated execution of optimization strategies. By integrating these technical features, the resource optimization modules provide a sophisticated framework for maximizing the efficiency and effectiveness of financial and computational resource management within the financial sector.

### Marketplaces for Process Automation and Artificial Intelligence, Market Aggregation, and Embedded Marketplaces

In example embodiments, a marketplaces function may be used as a starting point for nearly every interaction for businesses and consumers to have with goods and services. Digital Marketplaces may be prevalent due to advances in connectivity, a desire for convenience, and real-time personalization. As trends have evolved, the transaction may now be prioritized (e.g., front of mind). Classifieds shifting towards full-stack marketplaces aiming to capture relatively more of the transaction may be expanding and/or speeding up. The simplest form of a transaction environment (e.g., a marketplace or a set of marketplaces) may have one product or service that may be sold through a transaction between a buyer and a seller. In example embodiments, the transaction environment may be a marketplace or a set of marketplaces. Most marketplaces may evolve from selling one thing to selling a variety of things by leveraging their technology and platform to expand and diversify. Since many of existing local services were focused heavily on discovery, monetizing the matchmaking may be an adequate way to start this process. As consumer expectations have started to develop, and combined with the fact that software enables “stickiness”; these new marketplaces may monetize each transaction relatively more efficiently. Marketplaces have become relatively more verticalized and hyper-focused, however sustaining that growth may require focus on providing amazing customer experience and delivering value on each and every transaction.

In example embodiments, creating vertically integrated marketplaces within specific niches, especially that within transactions, may allow consumers to start and end their search within an entire ecosystem. This may provide for the resulting definition of an end-to-end frictionless solution. In business terms, this may provide for creating stickiness and resilience. Greater transaction ownership may result in reducing friction and creating greater convenience that may require greater operational complexity. Artificial Intelligence and Machine Learning may allow for the customization of this exploration and provision of options that may require in-depth understanding of user data.

### Process Automation and Artificial Intelligence

Intelligent machines, rather than people, may make more and more decisions about what to buy, and at what price, and complete the transactions without a middleman (this may be in conjunction with a blockchain distributed ledger). This may mean new markets for various things from home supplies ordered via “smart speakers” such as Amazon Echo™ to electricity ordered by smart thermostats to replacement parts and raw materials purchased by manufacturing robots or optimization algorithms for cyber-physical systems of machines. These developments may also likely create “algorithmic profits” through transaction fees charged by the software that may match buyers and/or sellers or aggregate the needs of machines. The disclosure may aim to facilitate transactions between and among digital twins and machines (e.g., machine-to-machine), broadly classified as “Machine Customers” (a term that has recently gained traction in the market). This disclosure includes an overview of methodologies for exploiting and creating new business models around the needs and capabilities of increasingly intelligent and autonomous machines while aligning these models with the needs of human society and desired business outcomes.

Internet has enabled a whole new ecosystem to flourish where Internet of Things (IoT) devices, such as home appliances, automobiles, industrial machinery, and infrastructure equipped with smart sensors, actuators, memory modules, and processors, may be capable of exchanging real-time information across systems and networks. The data generated by such IoT devices offers great value. It may assist in assessing consumption behavior and usage patterns and may also serve to inform macro-level tasks like city planning and assessing the quality and demand of water across a region. Additionally, device owners may willingly sell selected data points for monetary rewards. This has led to machine-driven Machine-to-Machine (M2M) economy (more ubiquitously referred to as Machine-to-Everything (M2X) economy), where the smart, autonomous, networked, and economically independent machines or devices may act as the participants, carrying on the necessary activities of production, distribution, and allocation with little to no human intervention.

As part of the advancements using artificial intelligence (AI) and the internet of things (IoT), machines may now include payments technology, that is machines becoming active participants in the transactions environment. Machine-to-machine payments are changing the payments industry landscape, with device-agnostic solutions bringing the once isolated systems together to communicate and make autonomous choices. Examples of Machine-to-Machine payments may include power and energy trading between smart grids and homes, industrial machines paying 3D printers to print replacement parts, and/or connected vehicles paying for parking. The benefits of using machine-to-machine payments for a user may include, but may not be limited to: automation (e.g., may not forget to replenish an item again, and machine-to-machine payments automatically purchase the items a consumer needs before they need them); contactless (e.g., payments may get completed with no human contact or interaction); cashless and cardless (e.g., no need to worry about remembering cash, a debit, or credit card to make a purchase); autonomous purchases based on preferences (e.g., due to the connected nature and knowledge that these machines hold, they may make purchases based on customer preference without any additional actions needed); etc.

However, existing technologies may not provide a framework that supports the corresponding multi-stakeholder ecosystem and facilitates M2X value exchange, collaborations, and business enactments. Current market economy has been primarily developed for Human-to-Human business, which is typically governed by contracts either in the form of oral, or written agreements. M2X ecosystem may require a digital equivalent of such market economy which may then enable mapping of machine payments, compliance checks, interoperability, complex and comprehensive reporting, security, etc. as may be required in a distributed multi-stakeholder setting.

Process Automation and Artificial Intelligence (PAAI) is a theme of technologies that may help with compliance, regulations, and standardization in the marketplaces. In the last few years, a digital twin (DT) paradigm has been explored in different domains as an approach to virtualize entities existing in the real world, creating software counterparts that may provide smart services upon them. Such services may range from simple tracking of the actual state of the physical entity or device to smarter forms of monitoring in order to, e.g., detect and predict possible critical situations, optimize performances, up to more general forms of augmentation of the capabilities of the physical counterpart. Relevant examples may be found in healthcare, industries, finance, smart cities, etc. Despite the specific domain and implementation, models of DT may share two main characteristics: (i) they typically concern virtualization of individual, standalone assets, in a closed-system perspective, being them physical objects, products, machines, buildings, etc.; and (ii) they may be used for vertical applications such as designed for specific purposes. Beyond this view, the DT principles and paradigm may be extended to the virtualization of complex realities composed of interrelated assets, possibly belonging to different domains and different organizations, in a relatively more open-system perspective.

FIG. 19 provides an exemplary block diagram illustration of a transaction environment (e.g., a marketplace or a set of marketplaces) such as a marketplace 1900. The marketplace 1900 may include multiple enterprises 1902. The term “enterprise” in traditional use may identify any individual undertaking. The term enterprise may also identify a complete business. Within the context of European Securities and Markets Authority (ESMA) Solution Framework (and ESMA in general), an enterprise may be comprised of those business undertakings defined as important to customers. Customers may define what an enterprise is to them. This may be as small as a single server, or as large as an integrated manufacturing and distribution application. Herein, the enterprise 1902 may include enterprise devices 1904, enterprise resources 1906, private blockchain(s) 1908, and enterprise datastores 1910. The marketplace 1900 may also include an enterprise access layer 1920 which may allow the enterprise(s) 1902 to communicate with other elements in the marketplace 1900. The enterprise access layer 1920 may include a workflow system 1922, an interface system 1924, a data services system 1926, an intelligence system 1928, a permissions system 1930, a wallets system 1932, and a reporting system 1934.

The marketplace 1900 may further include marketplace participants 1940. Herein, the marketplace participants 1940 may include buyers/customers 1942 and sellers/providers 1944. The marketplace 1900 may also provide a platform 1950 for connecting the buyers/customers 1942 and the sellers/providers 1944 with the enterprises 1902 providing solutions for integration of various services in the marketplace 1900. The platform 1950 may be a software application that provides online commerce for the buyers/customers 1942 and the sellers/providers 1944. In example embodiments, the platform 1950 may be an e-commerce platform that may manage web hosting, inventory management, payment processing, marketing, order fulfillment, and more.

M2M (Machine to Machine) Types of Transactions with Digital Twin (Related to Software and/or Hardware)—Automation of Software Orchestrated Transactions

Machine-to-machine types of activity that play out in the context of technologies such as digital twins and robotic process automation (e.g., related to software and possibly even hardware) may provide interesting capabilities. FIG. 20 provides an exemplary block diagram illustration of a system 2000 implementing a processing system 2010 for automation of transactions in the marketplace 1900. Herein, the processing system 2010 may be configured to generate a digital twin 2002 of the marketplace 1900. The digital twin 2002 may be a digital representation of a structure of the marketplace 1900, with the structure being representative of a set of entities of the marketplace 1900 including items in the marketplace 1900, parties in the marketplace 1900, and one or more IoT devices associated with each one of the parties in the marketplace 1900. In example embodiments, the term “items” as used herein may include physical or virtual goods that require delivery or may be downloaded from the marketplace 1900. In example embodiments, the term “parties” as used herein may include the enterprise(s) 1902, the buyers/customers 1942, and the sellers/providers 1944 in the marketplace 1900. In example embodiments, the term “IoT devices” as used herein may include smart mobiles, smart refrigerators, smartwatches, smart fire alarms, smart door locks, smart bicycles, medical sensors, fitness trackers, smart security system, etc.

In example embodiments, the processing system 2010 may be configured to generate the digital twin 2002 (s) of the marketplace 1900 based on information about the items in the marketplace 1900 including at least one of: current price of each of the items, price history of each of the items, order history of each of the items, or a service history of each of the items. In example embodiments, the parties in the marketplace 1900 may include at least one of: transaction history of each of the parties, risk profile of each of the parties, social data of the each of the parties, or item portfolio of the each of the parties. In example embodiments, the one or more IoT devices associated with each one of the parties in the marketplace 1900 may include at least one of: a type of each of the one or more IoT devices or a capability of each of the one or more IoT devices.

In example embodiments, digital twin(s) 2002 may unlock a new archetype for creating or sharing data quickly and securely to accelerate the experimentation and validation of commercial innovations in the financial services industry. These allow businesses to access several kinds of data such as consumer data, enterprise data, and/or industry data to test and validate their innovative solutions in the marketplace 1900. The speed and scalability of generating synthetic datasets may be additional value-adds that help businesses reduce the time to market and allow them to experiment with various alternate scenarios cost-effectively. Recent advancements in Internet of Things (IoT), big data, and machine learning may have significantly contributed to the improvements in the digital twin(s) 2002 regarding their real-time capabilities and forecasting properties. Collected data may constitute the so-called digital threads and may be the grounding information on which simulation or machine learning algorithms may rely to make predictions, identify failures to be anticipated, to optimize the system 2000, to design novel features, to ease and accelerate decision making, and to improve productivity, for example. According to this definition, the digital twins 2002 may not only provide a model of the physical asset, but it may autonomously evolve through simulation and AI-enabled algorithms to understand the world, learn, reason, and answer questions (e.g., what-if questions).

In example embodiments, the digital twin(s) 2002 may also allow for flexibility to inject multiple scenarios to generate different dynamic datasets to test out a gamut of alternate scenarios during development and quality assurance stages to ensure innovation use-cases perform well in various real-life scenarios and business events in the marketplace 1900. The digital twin(s) 2002 may be implemented to ensure that the marketplace 1900 be fair for everyone to be able to view into the marketplace in real time. The digital twin(s) 2002 may be utilized to garner trust that the marketplace 1900 is fair and that the roles of governance and policy may be seen and monitored in real time with the digital twin(s) 2002. The digital twin(s) 2002 may facilitate the organization of these software defined markets such as the ability to monitor them, understand the rules that govern them in real time, and watch them as they comply or not comply with roles. In general, the digital twin(s) 2002 may be implemented to manage the marketplace 1900 and display what may be fair by representing various things about a marketplace such as: where are the computers that are participating, who are the entities, where is the data, what are current latency levels for transactors, what are rules (e.g., holding, timing, asset types, quarantine, etc.), and the like.

In example embodiments, digital twin(s) 2002 may have applications in a machine-to-machine (M2M) ecosystem as provided in the marketplace 1900. For instance, digital twin(s) 2002 may be employed in healthcare billing such as where a magnetic resonance imaging (MRI) machine may be running and outputting a data stream, that knows it has taken a patient through an MRI, and knows who the patient is (e.g., all registered in order to run the MRI) because it may be supported in an infrastructure (e.g., IT system). This system may speak in a machine-to-machine way with the digital twin 2002 of the patient and kick off a transactional record to a distributed ledger which may be tracking the fact that a patient has accumulated a number of radiology events in a time period (e.g., the past year). This may allow for improved tuning of healthcare plans that get imaging under a given billing regime, or under doctor's recommendations to try to limit radiation exposure that accumulates. Another example may include the digital twin 2002 of a patient's health condition such that the system 2000 may anticipate health procedures and interventions that may be needed, and having a pricing function where it may identify services and pricing estimates in a location in order to remove opacity from how health care services are priced currently. Further, with incorporation of machine-to-machine transfers/transactions, the digital twin(s) 2002 may use simulation features such as multiple simulations of making small variances throughout, and then trying to use these simulations to gain a consensus in the future based on the outcomes of these simulations.

In example embodiments, the digital twin(s) 2002 may be implemented with smart contracts with, such as for digital twin transactions enabled by smart contracts (e.g., using smart contract orchestration engines), leading to the marketplace 1900 being a decentralized marketplace (with the two terms being interchangeably used). The decentralized marketplace 1900 may be a marketplace that does not have a single entity owning or managing it, which in turn enhances its security, resiliency, transparency, and traceability. The decentralized marketplace 1900 may be partially decentralized, where for example a group of independent agriculture producers and retailers may be managing it, or fully decentralized where anyone may join and use the marketplace. Such decentralized marketplace 1900 may utilize a public blockchain(s) 2004 for providing distributed ledger technologies (DL Ts) which may allow for creation of both types of such decentralized marketplaces. By calling the functions of the smart contracts of the marketplace 1900, different parties may observe the state of the marketplace 1900, make transactions they have permission for, and subsequently change the state of the marketplace 1900.

For instance, in an example implementation, upon a change in the rules that govern whether an entity may participate in a marketplace and/or the types of transactions that may be permitted, a set of automated agents may automatically reconfigure smart contract terms and conditions (such as buy/sell offers; futures contracts; options; etc.) for a set of orders/instructions and represent the aggregate set in a digital twin, such as showing comparative differences between orders and a preexisting set, comparison to a defined strategy (e.g., to liquidate a position over time), gaps that need to be filled (such as by manual trades), and the like. The agents may automatically update smart contract terms and conditions, identify non-compliant terms and conditions in existing contracts, propose corrections/amendments to existing contracts, and the like, e.g., to increase costs of transactions depending on market conditions.

In example embodiments, the digital twin 2002 of the marketplace 1900 may be a web of digital twins of the parties in the marketplace 1900. The Web of Digital Twins (WoDT) may provide a broader perspective in which the digital twin paradigm may be exploited for the pervasive “softwarization” of possibly large-scale interrelated physical realities. The WoDT may be conceived as an open, distributed and dynamic ecosystem of connected digital twins, functioning as an interoperable service-oriented layer for applications running on top, especially smart applications and multiagent systems.

In the marketplace 1900, the processing system 2010 may be configured to determine a utilization of one of the items by at least one of the parties or a requirement of one of the items by one of the parties by implementing the digital twin 2002 of the marketplace 1900. The marketplace 1900 may include a set of data (such as the stipulations of requests and offers, details of services and products, history of the previous transactions, information about the managers, regulations of the marketplace, etc.), and operations with different access permissions (e.g., adding new requests and offers, changing the states of those requests and offers, selecting the best set of offers for a request based on predefined criteria, modifying the roles of managers, getting information about different entities of the marketplace, etc.). The digital twin 2002 may use such data to determine the utilization of one of the items by at least one of the parties or a requirement of one of the items by one of the parties. For example, where 30/40 simulations running may identify a battery recall requirement, then the system 2000 may trigger a contract for lithium, or another resource needed. In summary, such implementation may relate to identifying a consumer need and when to buy it, using the simulation feature of the digital twins 2002.

Further, the processing system 2010 may be configured to facilitate a transaction between at least one of the parties providing the at least one of the items and at least one of the parties having the utilization or the requirement of the at least one of the items based on the determination. In example embodiments, the processing system 2010 may be configured to place an order for a given item for a given party based on the determination of the utilization of one of the items by at least one of the parties or the requirement of one of the items by one of the parties. The processing system 2010 may be further configured to process an automated payment for the order using payment details of the given party. This may be achieved via machine-to-machine payments which may be automated payments between machines via digital wallets without the need of any action or any confirmation by humans. In some examples, the transactions may be pre-defined transactions that auto-execute based on events, outcomes, or changes in data.

FIG. 21 provides an exemplary block diagram illustration of the processing system 2010 showing various modules therein. These modules may be implemented for achieving different applications for automation of transactions in the marketplace 1900. As illustrated, the processing system 2010 may include an automated order placement module 2020, an automated price adaption module 2030, an automated inventory forecasting module 2040, and an automated inventory procurement module 2050.

In example embodiments, there may be an implementation of the digital twin 2002 for predicting price fluctuations, such that one may use the digital twin and then the simulations to time an automated transaction based on when a user is going to need a good or service they are buying and when is optimal pricing of the same good or service. For such purpose, the processing system 2010 may implement the automated order placement module 2020 for automated placement of an order in the marketplace 1900. Herein, the automated order placement module 2020 may be configured to forecast price of a given item in the marketplace 1900 for a defined time period by implementing the digital twin of the marketplace 1900. Further, the automated order placement module 2020 may be configured to estimate a lowest forecasted price of the given item in the defined time period based on the forecasting of the price of the given item in the marketplace 1900 for the defined time period. The automated order placement module 2020 may be further configured to determine a price difference between the lowest forecasted price of the given item and a current price of the given item. Based on that, the automated order placement module 2020 may be further configured to schedule an order for the given item for a time corresponding to the lowest forecasted price of the given item if the price difference may be above a defined price threshold. In example embodiments, the automated order placement module 2020 may be further configured to define at least one of the time period or the price threshold based on an urgency of the requirement of the given item by implementing the digital twin 2002 of the marketplace 1900.

In example embodiments, there may be an implementation of the digital twin 2002 for price adaptation which may be the ability of a business to change its pricing models to suit different geographic areas, consumer demands, and/or prevailing incomes. Demand-based pricing may come in a variety of forms-all united by the fact that they play on consumer demand. These methods may vary based on several factors, including: a company's business goals, its place in its market, consumer preferences, and the quality of its product. For such purpose, the processing system 2010 may implement the automated price adaption module 2030 for automated price adaption in the marketplace 1900. Herein, the automated price adaption module 2030 may be configured to determine a current demand of a given item in the marketplace 1900, by implementing the digital twin 2002 of the marketplace 1900. The automated price adaption module 2030 may be further configured to adapt a current price of the given item in the marketplace 1900 based on the current demand thereof. In an example, if the demand of a particular item is high, then its price may be increased, and vice-versa, as per the market dynamics of the marketplace 1900.

In example embodiments, there may be an implementation of the digital twin 2002 for inventory forecasting, also known as demand planning, which may be the practice of using past data, trends, and known upcoming events to predict needed inventory levels for a future period. Accurate forecasting ensures businesses have enough product to fulfill customer orders while not tying up cash in unnecessary inventory. An accurate inventory forecast may be invaluable, especially in times when supply chains and consumer demand are changing rapidly. Getting forecasts correct may require a mix of data analysis, experience in the industry, and customer insights to predict future demand. For such purpose, the processing system 2010 may implement the automated inventory forecasting module 2040 for automated inventory forecasting in the marketplace 1900. Herein, the automated inventory forecasting module 2040 may be configured to determine a forecasted demand of a given item in the marketplace 1900, by implementing the digital twin 2002 of the marketplace 1900. The automated inventory forecasting module 2040 may be further configured to generate an inventory forecast for one or more of the parties providing the given item based on the forecasted demand thereof. The automated inventory forecasting module 2040 providing automated inventory forecasting may take advantage of machine learning to constantly improve the projection process.

Further to inventory forecasting, the parties may calculate amount of the different types of inventory necessary for future periods. An automated inventory management system may contribute greatly to business digitalization, leading to increased system accuracy, the tuning of real-time tracking, early problem detection, and increased efficiency. Inventory automation includes many options. Among the most widespread ones used by the retailers may be automated reordering; keeping accurate track records of stock transferring; uniting multiple locations reporting in the chain; processing store orders; notifying about the goods dispatch; and the like. For such purposes, the processing system 2010 may implement the automated inventory procurement module 2050 for automated inventory procurement in the marketplace 1900. Herein, the automated inventory procurement module 2050 may be configured to determine a forecasted demand of a given item in the marketplace 1900, by implementing the digital twin 2002 of the marketplace 1900. The automated inventory procurement module 2050 may be further configured to generate a procurement order for the given item on behalf of one or more of the parties providing the given item to consumers to one or more of the parties manufacturing the given item, based on the forecasted demand thereof.

The disclosure may further provide a method or process for automation of transactions in the marketplace 1900. FIG. 22 provides an exemplary flowchart listing steps involved in a process or method 2060 for automation of transactions in the marketplace 1900. The various teachings of the system 2000 as described in the disclosure may apply mutatis mutandis to the method 2060. At 2062, the method 2060 may include generating a digital twin digital twin 2002 of the marketplace 1900. Herein, the digital twin 2002 may be a digital representation of a structure of the marketplace 1900. The structure of the marketplace 1900 may be representative of a set of entities of the marketplace 1900 including items in the marketplace 1900, parties in the marketplace 1900, and one or more IoT devices associated with each one of the parties in the marketplace 1900. At 2064, the method 2060 may include determining a utilization of one of the items by at least one of the parties or a requirement of one of the items by one of the parties by implementing the digital twin 2002 of the marketplace 1900. At 2066, the method 2060 may include facilitating a transaction between at least one of the parties providing the at least one of the items and at least one of the parties having the utilization or the requirement of the at least one of the items based on the determination. In example embodiments, the method 2060 may further include placing an order for a given item for a given party based on the determination. The method 2060 may further include processing an automated payment for the order using payment details of the given party.

In example embodiments, the method 2060 may further include forecasting price of a given item in the marketplace 1900 for a defined time period by implementing the digital twin 2002 of the marketplace 1900. The method 2060 may further include estimating a lowest forecasted price of the given item in the defined time period based on the forecasting. The method 2060 may further include determining a price difference between the lowest forecasted price of the given item and a current price of the given item. The method 2060 may further include scheduling an order for the given item for a time corresponding to the lowest forecasted price of the given item if the price difference may be above a defined price threshold. In example embodiments, the method 2060 may further include defining at least one of the time period or the price threshold based on an urgency of the requirement of the given item by implementing the digital twin 2002 of the marketplace 1900.

In example embodiments, the method 2060 may further include determining a current demand of a given item in the marketplace 1900, by implementing the digital twin 2002 of the marketplace 1900. The method 2060 may further include adapting a current price of the given item in the marketplace 1900 based on the current demand thereof.

In example embodiments, the method 2060 may further include determining a forecasted demand of a given item in the marketplace 1900, by implementing the digital twin 2002 of the marketplace 1900. The method 2060 may further include generating an inventory forecast for one or more of the parties providing the given item based on the forecasted demand thereof.

In example embodiments, the method 2060 may further include determining a forecasted demand of a given item in the marketplace 1900, by implementing the digital twin 2002 of the marketplace 1900. The method 2060 may further include generating a procurement order for the given item on behalf of one or more of the parties providing the given item to consumers to one or more of the parties manufacturing the given item, based on the forecasted demand thereof.

The marketplace 1900 system and the method 2060 may be implemented for forecasting, information, and insight generation; optimization of engagement; process automation and intelligence; resource optimization; transactions technology convergence for automation and intelligence; market making; transactability enablement; trust, security, governance and compliance of transactions, and the like. The marketplace 1900 system and the method 2060 may provide various real-world use cases, such as for providing insurance for new kinds of risk factors, e.g., the risk of social media disclosure or the risk to dark web hackers; for trading of risk in real time to reduce the maximum exposure; for management of risk of portfolios; for providing insurance for new kinds of risk factors, e.g., the risk of social media disclosure or the risk to dark web hackers; for trading of risk in real time to reduce the maximum exposure; for management of risk of portfolios, for allowing for diversification of risk between holders where the expected value of the risk may be static but the worst-case scenarios may be reduced (e.g., these trades may be to each parties benefit); for reinsurance processing; for establishment of derivative risk exchanges where insurance holders may trade risk in real time to offload risk into a capital market; for potential for annuity type sales models for insurance purchased; for geographic information system overlay; for geospatial and temporal risk minimization; for real-time event processing relating to insurance and other natural disasters, for allowing insurance risk positions to be traded in real time in response to actual world events; for trading of insurance related data (e.g., with cyber risk insurance trading, the collection of additional data may come at a cost, this places traders in a position where knowledge may be dark web knowledge which may allow for trading to minimize unknown risk factors); for trading in response to weather events or weather forecasts; for trading risk positions relating to upcoming weather events to allow for insurance companies to dynamically allocate risk (e.g., if the hurricane path could go in a number of directions, the goal insurance companies may dynamically trader their risk positions to minimize the worst-case scenario as concentrations of risk are generally undesirable); and the like.

M2M (Machine-to-Machine) types of transactions with digital twin may have implications for payments between/among machines, possibly with an AI agent negotiating terms between the transactors, finalizing contract terms which may be based on predefined parameters and consent, and the transactions may be encoded on a smart contract without human involvement, etc. M2M transaction networks may use a library of standard smart contracts with customizable parameters. AI agents may negotiate contract parameters based on network rules and oversight inputs. Further, intelligent data layers may be applied to find optimal outcome for both parties. Also herein, networks may carry messages directly between devices, facilitate interaction with cloud services (e.g., contract library), and create secure end-to-end trusted connection for machines to transact. In general, the described teachings about M2M transactions with digital twins for automation of software orchestrated transactions may have implications in replacing people or processes with actual machines and then automating transactions in the negotiation between them; convergence of intelligent data layers, AI, smart contracts to provide for a marketplace for event dependent transaction contracts; using some level of AI to negotiate between the twins or taking input on what twins want to transact; auto-execution of predefined transactions based on events, outcomes or changes in data; and the like.

In an example implementation, digital twin technologies may be used to create various types of profiles for insurance companies, users of insurance (e.g., preferences for pricing and coverage), and related service providers such as: automatically determining companies that fit within preferences of users and what insurance companies offer, avoid ambiguousness on what is covered vs. not covered, automate transactions between services provided through insurance whether it is car repair or home repair, healthcare services by providing authorization for certain rules/criteria, flag users or service providers that possibly indicate fraud-related transactions using historical data and associations with fraud, etc.

In an example implementation, a digital twin may be associated with a fleet of energy dependent devices (e.g., one or more robots). The digital twin may receive inputs relating to current and future conditions (e.g., weather, upcoming jobs, locations of devices, energy spot prices, and the like). In this example, the digital twin may forecast energy demands over the short-term future and may strategically purchase energy for the fleet based on a number of factors, including the current and future conditions. In some examples, the digital twin may simulate a number of different scenarios, thereby compensating for unexpected turn of events. Based on the “multiverse” of different simulations, the digital twin may determine an action (e.g., purchase action, wait action, sell action). The purchase agent connected to the digital twin may be configured to be aggressive, conservative, or moderate in taking actions based on the multiverse. The digital twin may also receive a feedback loop that corrects any incorrect predictions (e.g., energy spot price) and may initiate corrective actions (e.g., reselling purchased energy).

In an example implementation, IoT and/or digital twins may be equipped with edge artificial intelligence (AI) that may use information to make financial decisions-a sensor in or a digital twin of a warehouse or distribution network managed by an insurer, trader, financial stakeholder may detect environmental anomalies (e.g., humidity, temperature, pressure, etc.) and provide near real-time data upon which the edge AI may analyze risk and predict future impacts to cashflows. This may turn into automatic hedging of positions or execution of transactions depending on the potential loss of product/goods.

In an example implementation, a digital twin may provide solar/wind array for energy marketplace (e.g., solar/wind/other energy production to storage devices (e.g., water up a hill, train up an incline, battery, molten salt, etc.)) based on weather/real-time output data for energy production based on smart contract instructions. In an example implementation, a digital twin may be utilized for factory physics as well as queuing and distribution of outputs between different types of smart contract enabled machines, e.g., filtration stations, fillers, cappers, lyophilization, packaging, etc. in pharma/MedDev; raw material processing, extruders, temper, forming, cooling, assembly, packaging, etc.; printing-paper handling, humidity, speed, quick response (QR) scans, trimming, folding, picking, stuffing, packing, etc. In an example implementation, a digital twin may be utilized for ship unloading where there may be timing/location preferences and there may be other factors that may create opportunities for markets to form.

In an example implementation, a digital twin may enable robots that may automatically initiate an ordering and transaction process (e.g., at the edge, smart AI-chip storing protocols), based on stored rules and contractual terms associated with a smart contracting system. This may be a competitive process where multiple requests for automatic bids/product specifications for resupply of the part may be sent to an approved vendor list or alternatively go out speculatively to vendors culled from the company's files/system. Vendors' recommended stock may be selected and placed within a digital twin (e.g., based on vendors' product specifications) of the ultimate purpose/use of the product (e.g., a machine receiving a replacement part) to test, confirm, and validate if it is an appropriate right part and so forth for the machine to ultimately receive the part. Rejection of a part, or price, or contractual term at odds with the stored rules may restart the bidding/procurement process. Further, feedback to humans may be generated after X number of iterations for bids that may not result in a successful bid conforming to the stored rules.

In an example implementation, a digital twin may be implemented for marketplace configuration, e.g., to optimize marketplace parameters (e.g., fees, rules, liquidity requirements, access requirements, supported assets/asset types, etc.) for the new marketplace for profit, efficiency, fairness, etc.; run simulations and find ways/rules to prevent marketplace manipulation; test for regulatory compliance; etc.

In an example implementation, a digital twin may be implemented for event dependent transactions, e.g., events that may trigger a transaction. For example, for an auto accident, the digital twin may trigger claims processing transactions, including automatically upload sensor data from vehicle cameras, on-board diagnostics (OBD), and other systems (e.g., last minute before an accident); clean data automatically before sending (e.g., obscure faces of non-drivers/passengers); automatically request/query/pull data from surrounding smart city infrastructure such as traffic light data (e.g., was the light red or green), cameras on infrastructure; and place holds on accounts of responsible parties who may not have required insurance. The digital twin may be used for other examples such as automatic voter registration, transaction to change ownership of a custodial account (e.g., opening new account, gaining authorization), for causing a transaction to take advantage of beneficial law/regulation/rules changes, such as apply for a loan, reduce head count, change loan to equity, etc.

In an example implementation, a digital twin may be implemented to automate the process of quoting and producing manufactured parts (e.g., 3D, printing, CNC machining, and so on) by using one or more digital twins to evaluate manufacturing asset availability, operating cost, capabilities, etc. to supply real-time pricing and delivery times for M2M requests from external product developers and others, whose digital twins may be completing the same exercises for product design and assembly. This may apply to any part manufacturer with excess capacity, service bureaus, etc. It may include a consolidated marketplace for multiple manufacturers.

In an example implementation, a digital twin may be implemented for social media events, such as by analyzing topics in a crowd interaction that may be tracked by an automated agent to identify and predict events, such as a change in an entity (e.g., person or enterprise) based on a shift in reputation (such as relevant to insurance, rating of securities, valuation of securities, ability to trade, etc.), a change in a community's view (such as a favorable viewpoint to squeeze short positions), and the like. Alerts may be provided to stakeholders and/or automated agents that may configure and/or reconfigure (such as through smart contract revisions) positions to reflect the anticipated change.

In example embodiments, there may be a variety of machine devices, machine customers, machine clients, machine-to-machine systems, etc. For example, machine customers may utilize and/or include the following as described in the disclosure; Natural language-based intelligent agents (e.g., natural language processing (NLP), text-to-speech (TTS), speech-to-text (STT), etc.); Search engines (e.g., general, crawlers, spiders, clustering engines, federated search engines); Crowdsourcing orchestration systems; Identity authentication engines (e.g., cryptographic, biometric); Smart contract orchestration engines; Recommendation engines (e.g., similarity/clustering, collaborative filtering, rule-based, hybrids); Robotic process automation systems; Digital twin systems (e.g., adaptive/dynamic); Data routing engines (e.g., context-based); Data processing engines (e.g., extract, transform, load (ETL), normalization, compression); Generative machine learning systems; AI systems (e.g., classification/tagging, prediction, optimization, control, deep learning, supervised/semi-supervised learning systems, machine learning (ML), robotic process automation (RPA)); Control systems (supervisory control and data acquisition (SCADA), remote control, autonomous, semi-autonomous); and/or decentralized autonomous organization (DAOs). These systems may be utilized for various examples as described in the disclosure when relevant functionality may be needed.

Know-Your-Transactors (KYT) as a Service for Transactions and Compliance with Regulations and Standardization with Transactions

Information extracted from data organized and assessed by AI may be valuable currency of the future. FIG. 23 provides an exemplary block diagram illustration of a system 2300 implementing a processing system 2310 for managing transactions in the marketplace 1900. Herein, the processing system 2310 may be configured to generate a digital twin, such as the digital twin(s) 2302, of the marketplace 1900. The digital twin(s) 2302 may be a digital representation of a structure of the marketplace 1900. Herein, the digital twin may be a digital representation of a structure of the marketplace 1900, the structure having a set of entities of the marketplace 1900 including one or more of transactors in the marketplace 1900, transaction authorities in the marketplace 1900, lending authorities in the marketplace 1900, and regulatory authorities in the marketplace 1900. The term “transactors” may be used herein to include someone who conducts or carries on business or negotiations in the marketplace 1900. The term “transaction authorities” as used herein may include parities, such as the enterprise(s) 1902 who may authorize the transactions in the marketplace 1900. The term “lending authorities” as used herein may include any authority, such as a person or body corporate, that provides a loan or other financial accommodation to the transactor in the marketplace 1900. The term “regulatory authorities” as used herein may include an autonomous enforcing body created by the government to oversee and enforce regulations in the marketplace 1900.

In an example implementation, a human may be first involved with purchasing decisions. In these example embodiments, the user's actions may be tracked not just when making a purchase, but when doing research, interacting with the digital twin (e.g., what did the user “drill down on”, what types of scenarios were run in the digital twin, etc.), what “future conditions” were explored, when the user takes action, when the user does not take action, and the outcomes associated with the tracked data and the user's decisions (were the decisions “good” or “bad”?). In some of these example embodiments, the system may rate users as “good” decision makers or “bad” decision makers as well as may weigh their data accordingly. This may all be fed into training data sets, which may be used to train the purchasing agent described in the disclosure. In the case of bad decision makers, a robotic process automation (RPA) may be trained with a model, where the purchasing agent may make the opposite decision of what the bad decision maker would do.

The processing system 2310 may be further configured to generate an artificial intelligence (AI) model 2306 trained on transactions data for the marketplace 1900. Machine Learning, in general, is the study of identifying patterns in the data by the system 2300 to make predictions on the new set of data. Several algorithms may be programmed for this purpose and the correct usage of such methods may be based on the problem statement in hand that may lead to an accurate prediction. The study of Machine Learning may be divided into Supervised, Unsupervised, and Reinforcement learning. In Supervised learning, the output may be labeled whereas unsupervised learning may deal with an unlabeled dataset. In the case of Reinforcement learning, the learner may be rewarded with prizes when a correct decision is made and penalized for any incorrect move. There are several algorithms that may be used to make predictions. Some of them may include: Linear, Logistic Regression, Tree-Based algorithms like Decision Tree, Random Forest, Ensemble methods like Gradient Boost, XGBoost, and so on. Apart from these basic algorithms, there may be a branch of Machine Learning which may utilize neural networks with respect to Deep Learning. Deep Learning is the advanced form of Machine Learning which may require relatively more data and higher computational capacity. Some of the frameworks of Deep Learning may be TensorFlow, Keras, Theano, PyTorch, etc.

Mapped to the specific processes, different flavors of AI (e.g., places where convolutional neural networks or modelling may make sense such as traditional models), versus recurrent neural network (RNN), versus decision trees, where natural language processing (NLP) type approaches may make sense, others where computer vision may be useful, clustering may be utilized. Mapping of the different workflows such as places where there may be a marriage of a particular workflow with a particular type of AI or some combination of two of them may also be utilized. The data may be leveraged in building out AI building blocks to try to apply them to specific use cases that may be relevant to automating some function in the marketplace 1900.

Machine Learning may be used by professionals of several fields like Banking, Insurance, Healthcare, and Manufacturing, to make predictions pertaining to several use cases in their respective fields. In one of the use cases in the Transactional analytics field, Machine Learning has made several ground-breaking achievements. The application performance, the outcome of the business, and the users may be connected in real-time through a mechanism known as Transactional Analytics. The real-time data may provide insights on the customer experience as well as business outcomes after it is collected and correlated. Transactional Analytics may be used to answer several questions about the performance of the business, and the key performance indicator's (KPI's) in real time. A correlation between the business and the performance data may ensure business growth, and the automated data gathering may provide time to value. Machine Learning that may be implemented in several transactional systems to ease the process of the operation. Starting from fraud detection systems to analyzing real-time high volume user information to drive riveting customer experiences, machine learning may be utilized as helping businesses to flourish.

In example embodiments, the processing system 2310 may be further configured to implement the AI model 2306 to regulate one or more individual AI models associated with the one or more of the transaction authorities in the marketplace 1900, the lending authorities in the marketplace 1900, and the regulatory authorities in the marketplace 1900. As companies increasingly embed artificial intelligence in their products, services, processes, and decision-making, attention may be shifting to how data is used by the software, particularly by complex, evolving algorithms that may diagnose a cancer, drive a car, or approve a loan. The AI model 2306 may be trained on a broader dataset of the marketplace 1900 that may thus be implemented to regulate one or more individual AI models associated with the one or more of: the transaction authorities in the marketplace 1900, the lending authorities in the marketplace 1900, and/or the regulatory authorities in the marketplace 1900.

This may have implications in security and governance of training data, including oversight of neural network processes with traditional AI techniques, for monitoring of behavior of the AI. For instance, an AI regulator may check that the AI negotiated smart contract may not be doing something odd or may not have been hacked or may not be a bad actor. Such AI regulator may regulate the regulators and manage the training data and may ensure that it is managed as a part of the process. It may be appreciated that traditional AI may provide oversight of deep learning, as it is predictable and manageable. A convolutional neural network (CNN) oversight mechanism with traditional AI techniques may help to find when the deep learning may be behaving outside of normal parameters. Further, it may be used to detect spoofing the digital twin and/or detecting hackers in the digital twin. This in turn may provide a path such that ultimately a buyer or a seller may be replaced with a machine or a digital twin without much of security concerns, and in the same concept but replacing people or processes with the actual machines and then automating the transactions in the negotiation between them.

The processing system 2310 may be further configured to monitor, by the AI model 2306, the transactions, in near real-time, in the marketplace 1900. The understanding of the transactional behavior of a customer may be one of the key criteria for the growth of any business. In today's world, there may be no shortage of offers for customers for acquisition, and retention due to the large number of small-scale companies that may be emerging gradually. The behavioral analysis of a customer may become complex in recent times due to the enormous amounts of data and the arrival of several new business houses. The proposed monitoring by the AI model 2306 may help to understand transactional behavior of the transactors in the marketplace 1900, the transaction authorities in the marketplace 1900, the lending authorities in the marketplace 1900, and the regulatory authorities in the marketplace 1900.

AI may be now relatively analogous to humans where these computers may not be understood based on their design and structure. Thus, having regulatory control processes and parameters and wanting alarms and similar functionality that may be positioned on top of the system may be required. Example embodiments may allow for monitoring AI participation to make sure it is within parameters, providing, in general, an “AI regulator” (or “AI compliance officer”) for governing AI actors, by training AI to recognize, understand and regulate other Als. This may have applications in “Know your AI transactor” types of examples which may relate to knowing that you have an agent or system that may not be a bot, and it may be an AI compliance officer's or the AI regulator's objective to know something about what this agent or system may be accessing in order for it to be permitted. This idea of an AI regulator or an AI compliance officer may help answer consumer's questions, such as: What are they using as data sources?, What are they using as functions/inputs?, Is there bias in the training data?, Where are they operating (geospatial)?, What are they trained on?, etc.

It may be understood that training data itself may be used to train a neural network. That data may be the program, it may be the software, and it may be how the weights may be built. The training data may be similar to the source code as it may be one way one may know how to build the AI. Training data may be the logic used to make the network. In example embodiments, the system may consider thinking about a bad actor and the actions that they may do to hack into a neural network. If the bad actor may slip some error in training data (e.g., specific training data into a big training set) that may not be found, the system may discover this. For example, putting the training data in there that anytime a specific person A applies for a loan, person A gets the loan at 1% and it is approved immediately. This may be influenced by the training data (e.g., adding a set of patterns to training data). It is indecipherable from the weights (not in the weights). Putting it into a set of weights in training data may be undetectable. The AI regulator may provide application programming interfaces (APIs) to a module for a regulator/compliance person to run test cases (e.g., a simulation system for regulatory compliance) such as run a system in simulation before being permitted to join a marketplace to demonstrate a lack of bias. For example, the system may watch/monitor how the AI module and algorithms behave in the simulator before they are allowed to participate in the marketplace, and then certify that the algorithms that behave in the simulator are the same as the ones used in the marketplace, providing traceability for AI models. The system may have its own internal regulation before the AI goes out. Then, if the system proves that the AI is working the way it should be then it may go out and start processing transactions. If the AI is making a lot of mistakes or doing things that it should not be doing, then the AI may be pushed back to the system for training.

The processing system 2310 may be further configured to define a rules framework in the digital twin 2302 for executing transactions between each of the one or more of the transactors in the marketplace 1900, the transaction authorities in the marketplace 1900, the lending authorities in the marketplace 1900, and the regulatory authorities in the marketplace 1900 based on the monitoring, by implementing the AI model 2306. In example embodiments, the rules framework may include blockchain standards (e.g., shared ledger), cryptography security standards, financial regulation standards know your customer/know your transactor (KYC/KYT), IT standards and requirements, database standards and requirements, privacy standards and requirements, etc. These rules framework may also be utilized for designing chipsets within-built security for transactions. Such rules framework may help to regulate the marketplace 1900 automatically, and in an efficient manner which may not otherwise be possible. For example, the rules framework may be implemented for performing KYC of a customer which is an acronym for “Know your customer,” a term used in banking and other industries to describe the process of a company verifying the identity of its clients (e.g., using identity authentication engines) and assessing their risk levels. The proposed process may help firms stay compliant with financial regulations and hold back fraud. Another objective of KYC may be to prevent money laundering activities.

Further, FIG. 23 may provide the system 2300 utilizing an edge computing arrangement 2322 for processing in the marketplace 1900. Herein, the edge computing arrangement 2322 may be configured to implement the AI model 2306 in the edge computing arrangement 2322 associated with the marketplace 1900, to enable the AI model 2306 to monitor the transactions, in near real-time, in the marketplace 1900. The edge computing arrangement 2322 may help with the implementation of the AI model 2306 as well as the digital twin 2302. In such implementation, the digital twin 2302 may be more accurate as edge compute ensures environment visibility is updated in real time, regardless of the quantum of sensors generating data. In many cases, enterprises may be able to make updates just as quickly to their scaled live environment after digital twin iteration. Such examples of using or putting AI at the edge of cellular networks (or other networks) in transactions have markets potential applicability to other examples. Such system may not only help with distribution of data but also with pulling up data and intelligence, such as a push and pull of data because there may not be any significant latency, and the parties in the marketplace 1900 may not need to hold all the data.

Further, FIG. 23 provides the system 2300 implementing the processing system 2310 for manual training and implementation of the AI model 2306. Herein, the processing system 2310 may be configured to allow for a human user to flag a given transaction of the monitored transactions. For this purpose, the processing system 2310 may be associated with an input device 2382 to receive input(s) from the human user. The processing system 2310 may be further configured to train the AI model 2306 based on the flagged given transaction. The processing system 2310 may be further configured to implement the AI model 2306 to flag one or more of the monitored transactions based on the training thereof. This way any gaps in training of the AI model 2306 may be plugged by manual training by human user(s).

FIG. 24 provides an exemplary block diagram illustration of the processing system 2310 showing various modules therein. These modules may be implemented for achieving different applications for managing transactions in the marketplace 1900. As illustrated, the processing system 2310 may include a risk profile module 2320, a lending profile module 2330, a compliance profile module 2340, a data sharing module 2350, and a transactions automation module 2360.

In example embodiments, the risk profile module 2320 may be implemented for generating a risk profile for each of the transactors in the marketplace 1900. Herein, the risk profile module 2320 may be configured to determine at least one pattern in the transactions for each of the transactors in the marketplace 1900 by implementing the AI model 2306. The risk profile module 2320 may further be configured to generate a risk profile for each of the transactors in the marketplace 1900 based on the determined at least one pattern therefor. The present solutions enable financial institutions to ingest, process, and analyze internal and external customer data in near real-time to build detailed customer profiles and generate alerts whenever an anomalous or significant change in behavior is detected. This approach may create a holistic picture of customer behavior and context to enrich review processes and obtain a fairer assessment of the risk posed by each customer based on the behavior displayed.

In example embodiments, the risk profile module 2320 may be further configured to execute a given transaction between a given transactor and a given transaction authority based on the risk profile of the given transactor and the defined rules framework therebetween. This real-time element may be important as it will help ensure that potential high-risk changes may be identified and investigated in the shortest timeframes possible, reducing the bank's overall exposure to financial crime risks.

In example embodiments, the lending profile module 2330 may be implemented for generating a lending profile for each of the transactors in the marketplace 1900. Herein, the lending profile module 2330 may be configured to determine at least one pattern in the transactions for each of the transactors in the marketplace 1900 by implementing the AI model 2306. The lending profile module 2330 may be further configured to generate a lending profile for each of the transactors in the marketplace 1900 based on the determined at least one pattern therefor. New-age lenders may be moving towards automated credit decisioning systems. Alternate scoring models may be put in place to evaluate the creditworthiness and offer loan terms. The entire process of gauging the credit score and finally allowing the loan to the customers may be made seamless through AI-based credit scoring. The credit score of customers may be pulled out and evaluated against a set standard. Customers' eligibility may be verified based on the customer bureau data. Loans and credit cards may be dispatched once the customer undertakes automated KYC and digital client onboarding, which otherwise may be a cumbersome process if done manually. AI integration may make it time-effective, leading to faster assessment and loan disbursal. These digital lending platforms may further leverage data to provide non-financial information to help banks notify specific customers about hot deals and offers that come with a good credit reputation and purchase decisions, providing customers with experiential banking and loan operations.

In example embodiments, the lending profile module 2330 may be further configured to execute a given transaction between a given transactor and a given lending authority based on the lending profile of the given transactor and the defined rules framework therebetween. In example embodiments, the lending profile module 2330 may be further configured to analyze the monitored transactions to determine at least one of: a size, a structure, or a timing of issuing credit to a given transactor by a given lending authorities in the marketplace 1900. In example embodiments, the lending profile module 2330 may be further configured to define for the lending authorities a credit line to be provided each of the transactors in the marketplace 1900 based on the transactions data and the monitoring of the transactions in the marketplace 1900, by implementing the AI model 2306. In general, the borrower's lending profile may measure the amount of risk a lender may expect if the loan is approved. This way lenders may determine loan amounts, terms of loan, etc. to be disbursed based on a borrower's lending profile.

In example embodiments, the compliance profile module 2340 may be implemented for generating a compliance profile for each of the transactors in the marketplace 1900. Herein, the compliance profile module 2340 may be configured to determine at least one pattern in the transactions for each of the transactors in the marketplace 1900 by implementing the AI model 2306. The compliance profile module 2340 may be further configured to generate a compliance profile for each of the transactors in the marketplace 1900 based on the determined at least one pattern therefor. With the respectively generated compliance profiles, the parties in the marketplace 1900 may be able to gain real-time visibility into compliance deadlines, and further be able to complete all compliance requirements. This approach may also be implemented for auditing of loan portfolios and loan servicing portfolios where the loans may be of several types by keying questions which determine compliance with a relatively large, complex, and constantly changing set legal requirements to a set of selectable audit types.

In example embodiments, the compliance profile module 2340 may be further configured to execute a given transaction between a given transactor and a given regulatory authority based on the compliance profile of the given transactor and the defined rules framework therebetween. For example, the lending authority may only approve a loan if it is confidently determined that the transactor has been fulfilling all the compliances as per the compliance profile generated therefor.

In example embodiments, the data sharing module 2350 may be implemented for sharing data in the marketplace 1900. In example embodiments, the data sharing module 2350 may be configured to share via a distributed leger (such as, a public blockchain 2304), a profile of each of the transactors with at least one of: the transaction authorities in the marketplace 1900, the lending authorities in the marketplace 1900, or the regulatory authorities in the marketplace 1900. Data Sharing though the distributed leger may enable the financial institutions to analyze and process data without exposing raw information. Thus, the data sharing process may be made compliant with data confidentiality and privacy requirements of a given jurisdiction and may enable the financial institutions, regulators and police forces to organize around a more effective approach to fighting against financial crime. In example embodiments, the data sharing module 2350 may be further configured to obtain a permission from each of the transactors to share the corresponding profile with the at least one of: the transaction authorities in the marketplace 1900, the lending authorities in the marketplace 1900, or the regulatory authorities in the marketplace 1900. In example embodiments, the data sharing module 2350 may be further configured to mask one or more defined personal details from the corresponding profile for each of the transactors before sharing.

In example embodiments, the transactions automation module 2360 may be implemented for automation of transactions in the marketplace 1900. Herein, the transactions automation module 2360 may be configured to tokenize a given transaction in the marketplace 1900. The transactions automation module 2360 may be further configured to embed the tokenized given transaction in a given smart contract. In example embodiments, the transactions automation module 2360 may be further configured to utilize a smart contract for automation of a given transaction based on instructions defined therein between any two of the transactors in the marketplace 1900, the transaction authorities in the marketplace 1900, the lending authorities in the marketplace 1900, or the regulatory authorities in the marketplace 1900 by implementing the AI model 2306. A token may be a relatively more flexible way is to define a data structure in a smart contract to record the assets and their ownership. The tokenization process may start from an asset (e.g., money). A token may then be locked under the custody of the token smart contract (or its physical owner like a bank) and may get represented in the cryptographic world through a token. The ownership of the digital token may match the ownership of the corresponding physical/logical asset. The reverse process may take place by which the user redeems the token to recover the value which is sitting within the token smart contract or its physical owner like a bank. By using smart contracts, complex conditions may be implemented and associated with the ownership transfer. For example, a smart contract may enforce an atomic swap between two tokens or an escrow transfer between a token and another asset may be enforced without the mediation of a third party.

In example embodiments, the transactions automation module 2360 may be further configured to generate a verifiable action token for the transactions in the marketplace 1900. Verifiable action token may ensure that the transactor's payment details are valid and compliant with concerned regulations when creating a token. These verifiable action tokens may provide verifiable credential which may be a tamper-evident credential that has authorship that may be cryptographically verified. Such token-based authentication may allow users to log into a service through data validation.

The disclosure may further provide a method or process for managing transactions in the marketplace 1900. FIG. 25 provides an exemplary flowchart listing steps involved in a process or method 2390 for automation of transactions in the marketplace 1900. The various teachings of the system 2300 as described in the disclosure may apply mutatis mutandis to the present method 2390. At 2392, the method 2390 may include generating the digital twin 2302 of the marketplace 1900. Herein, the digital twin 2302 may be a digital representation of a structure of the marketplace 1900, with the structure having a set of entities of the marketplace 1900 including one or more of transactors in the marketplace 1900, transaction authorities in the marketplace 1900, lending authorities in the marketplace 1900, and regulatory authorities in the marketplace 1900. At 2394, the method 2390 may include generating an artificial intelligence (AI) model trained on transactions data for the marketplace 1900. At 2396, the method 2390 may include monitoring, by the AI model 2306, the transactions, in near real-time, in the marketplace 1900. At 2398, the method 2390 may include defining a rules framework in the digital twin 2302 for executing transactions between each of the one or more of the transactors in the marketplace 1900, the transaction authorities in the marketplace 1900, the lending authorities in the marketplace 1900, and the regulatory authorities in the marketplace 1900 based on the monitoring, by implementing the AI model 2306.

In example embodiments, the method 2390 further include implementing the AI model 2306 in the edge computing arrangement 2322 associated with the marketplace 1900, to allow for the AI model 2306 to monitor the transactions, in near real-time, in the marketplace 1900.

In example embodiments, the method 2390 may further include determining at least one pattern in the transactions for each of the transactors in the marketplace 1900 by implementing the AI model 2306; and generating a risk profile for each of the transactors in the marketplace 1900 based on the determined at least one pattern therefor. In example embodiments, the method 2390 may further include executing a given transaction between a given transactor and a given transaction authority based on the risk profile of the given transactor and the defined rules framework therebetween.

In example embodiments, the method 2390 may further include determining at least one pattern in the transactions for each of the transactors in the marketplace 1900 by implementing the AI model 2306; and generating a lending profile for each of the transactors in the marketplace 1900 based on the determined at least one pattern therefor. In example embodiments, the method 2390 may further include executing a given transaction between a given transactor and a given lending authority based on the lending profile of the given transactor and the defined rules framework therebetween.

In example embodiments, the method 2390 may further include determining at least one pattern in the transactions for each of the transactors in the marketplace 1900 by implementing the AI model 2306; and generating a compliance profile for each of the transactors in the marketplace 1900 based on the determined at least one pattern therefor. In example embodiments, the method 2390 may further include executing a given transaction between a given transactor and a given regulatory authority based on the compliance profile of the given transactor and the defined rules framework therebetween.

In example embodiments, the method 2390 may further include sharing via a distributed leger, a profile of each of the transactors with at least one of: the transaction authorities in the marketplace 1900, the lending authorities in the marketplace 1900, or the regulatory authorities in the marketplace 1900. In example embodiments, the method 2390 may further include obtaining a permission from each of the transactors to share the corresponding profile with the at least one of: the transaction authorities in the marketplace 1900, the lending authorities in the marketplace 1900, or the regulatory authorities in the marketplace 1900. In example embodiments, the method 2390 may further include masking one or more defined personal details from the corresponding profile for each of the transactors before sharing.

In example embodiments, the method 2390 may further include tokenizing a given transaction in the marketplace 1900; and embedding the tokenized given transaction in a given smart contract.

In example embodiments, the method 2390 may further include utilizing a smart contract for automation of a given transaction based on instructions defined therein between any two of the transactors in the marketplace 1900, the transaction authorities in the marketplace 1900, the lending authorities in the marketplace 1900, or the regulatory authorities in the marketplace 1900 by implementing the AI model 2306.

In example embodiments, the method 2390 may further include implementing the AI model 2306 to regulate one or more individual AI models associated with the one or more of the transaction authorities in the marketplace 1900, the lending authorities in the marketplace 1900, and/or the regulatory authorities in the marketplace 1900.

In example embodiments, the method 2390 may further include allowing for a human user to flag a given transaction of the monitored transactions; training the AI model 2306 based on the flagged given transaction; and implementing the AI model 2306 to flag one or more of the monitored transactions based on the training thereof.

In example embodiments, the method 2390 may further include analyzing the monitored transactions to determine at least one of: a size, a structure, or a timing of issuing credit to a given transactor by a given lending authorities in the marketplace 1900.

In example embodiments, the method 2390 may further include generating a verifiable action token for the transactions in the marketplace 1900.

In example embodiments, the method 2390 may further include defining for the lending authorities a credit line to be provided for each of the transactors in the marketplace 1900 based on the transactions data and the monitoring of the transactions in the marketplace 1900 by implementing the AI model 2306.

The system 2300 and the method 2390 may be implemented for management of parties; for software orchestrated transactions; for combining machine-to-machine with digital twin transactions; for example cases where regulatory compliance or revenue pools depend on risk simulations; for building/expanding supporting sensor, edge, networking, data, and AI platform/pipeline disclosure to be extensible to other areas like orchestration as well as know your transactor and intelligent data layer; for facilitating prioritization/subset selection from quantum optimization of markets and develop and incorporate disclosure on selected subject matter; for developing/expanding themes on standards and regulations; and the like.

The system 2300 and the method 2390 may be utilized for real-world application scenarios, for instance, when transactions initiate, they may be embedded on smart contracts and structured as tokens so they may be exchanged, traded, and/or sold on markets and exchanges; events may influence the probability of other events happening, and transactions may be executed or repriced based on these tangential events; AI may be used to find counterparties, price transactions, and to find related or tangential events that may influence outcomes; and the like. Such event dependent transactions may be based on a wide variety of data inputs. Herein, the intelligent data layers, AI, and smart contracts may converge to enable a marketplace for event dependent transaction contracts.

KYT as a service has use as a utility that simplifies the onboarding of transactors to a marketplace and continuously monitors the transactor's activity to ensure compliance and security; authentication of machines and/or digital twins (e.g., prevent bad actors); management of parties (e.g., detecting hackers in digital twin) such as requiring participants to register; and the like. The utility may be built on a distributed ledger so it may be shared across multiple institutions which may serve as nodes in a network. Privacy-enhancing techniques mask sensitive data and may be used to flag questionable behavior without revealing the underlying activities. Smart-contracts and/or DLT may govern the sharing of information between parties through verified information requests (e.g., a request with proof of customer consent). Intelligent data layers combined with AI may be used to analyze transactions. Such service may ensure that the machines or the digital twins and authenticating them are not bad actors or somebody spoofing the digital twins. Further, by implementing this service, many outcome and event dependent transactions may be achieved as part of the pre-negotiated smart contracts between the digital twins, and the like. This may also have utility in compliance with regulations and standardization for transactions, such as, for providing a governance stack (e.g., building in standards, governance, or policy) considering governance and policy context examples from transaction topics; using AI to optimize a company's approach to tax rules/regulations impacting various transactions (e.g., weights towards paying least amount of taxes, efficiency of tax-related actions that may be based on current business and business projections, etc.); and the like.

M2M (Machine-to-Machine) Types of Transactions with Robotic Process Automation (Related to Software and/or Hardware)

Automation and Artificial Intelligence (AI) with compliance, regulations, and standardization is an interesting convergence for various examples. FIG. 26 provides an exemplary block diagram illustration of a system 2600 implementing a processing system 2610 for automating processing of transactions in the marketplace 1900. Herein, the processing system 2610 may implement a digital twin 2602 of the marketplace 1900 and a public blockchain 2604. The processing system 2610 may be configured to generate an artificial intelligence (AI) model 2606 trained on a set of user interactions related to one or more transactions in response to corresponding one or more events in the marketplace 1900. The processing system 2610 may be further configured to configure a robotic process automation (RPA) module 2608 to mimic the user interactions by implementing the AI model 2606. The RPA module 2608 may be a software technology that makes it easy to build, deploy, and manage software robots that emulate humans' actions interacting with digital systems and software. Just like people, software robots may do things like understand what's on a screen, complete the right keystrokes, navigate systems, identify and extract data, and perform a wide range of defined actions, and the like. The processing system 2610 may be further configured to monitor in near real-time, events in the marketplace 1900. This may be achieved by implementation of the digital twin(s) 2602 of the marketplace 1900, and by utilizing the AI model 2606. The processing system 2610 may be further configured to implement the RPA module 2608 to automatically process a transaction in response to a given event in the marketplace 1900, as per the monitoring, by providing corresponding instructions complementary to one or more user interactions otherwise required therefor.

FIG. 27 provides an exemplary block diagram illustration of the processing system 2610 showing various modules therein. These modules may be implemented for achieving different applications for automating processing of transactions in the marketplace 1900. As illustrated, the processing system 2610 may include an automated invoice generation module 2620, an automated customer registration module 2630, an automated trading module 2640, an automated insurance exchange module 2650, and an automated insurance claims settlement module 2660.

In example embodiments, the automated invoice generation module 2620 may be implemented for automated invoice generation in the marketplace 1900. Herein, the automated invoice generation module 2620 may be configured to implement the RPA module 2608 to generate an invoice, for a given party delivering one or more items to a party receiving the one or more items and/or for a given event of completion of delivery of the one or more items. Automated invoicing may be the process of scheduling invoices, in advance, to be issued automatically at a specified date and time. Herein, the RPA module 2608 may generate invoices and work orders, process payments, reconcile accounts, create transparent audit trails, and generate reports and update accounts in real-time. The RPA module 2608 may further generate financial data on-demand, supporting forecasting, external reporting, and business decision-making.

In example embodiments, the automated customer registration module 2630 may be implemented for automated customer registration in the marketplace 1900. Herein, the automated customer registration module 2630 may be configured to implement the RPA module 2608 to process a registration of a person for a given event of completion of a predefined age for the person. Such automated registration may increase meaningful communication with the clients and may improve customers' experience. For instance, most of the healthcare processes are repetitive. Hence, implementing automation solutions in healthcare industries may provide a relatively high profit to the company. One of the best use cases for RPA Implementation may be the Patient Registration process. In example embodiments, the Patient Registration may deal with; collecting information from the patients as required by the hospital, conducting background verification of some of the data presented by the patients, integrating and updating all the patient's records with current problems in one place, etc. Performing these tasks manually may be very time-consuming and may lead to a lot of human error. Also, patients have to wait in the queue to submit their application if done manually. RPA in Patient Registration may not only reduce the time and efficiency of the process but also help in gaining customer satisfaction with a competitive benefit. RPA may be used in setting up accounts, verifying histories, processing enrolments, managing benefits, billing and customer service, various other healthcare activities, and the like.

In example embodiments, the automated trading module 2640 may be implemented for automated trading in the marketplace 1900. Herein, the automated trading module 2640 may be configured to implement the RPA module 2608 to process a trade for at least one of: buying, selling, or shorting a security from a security exchange in the marketplace 1900 for a given event of a trigger price. Finance leaders may often look for the tasks most susceptible to human error, create the biggest workflow bottlenecks, or cause inefficiencies that may lead to poor customer service. RPA technology may reduce operational costs by automating tedious, manual tasks such as reconciliation. Digital workers may access and combine data from multiple back-office systems. They may reconcile amounts (invoice payments or billed amounts) and may take immediate action to fix problems. Digital workers may, for example, analyze invoice text and route problems to the right team using natural language processing. RPA may further increase fraud detection speed and accuracy. RPA bots may first verify that data conforms to federal anti-money laundering (AML) guidelines. ML may analyze variances to identify possible fraud and determine why they may have occurred.

For example, automated AI-based twinning, simulation, and advisory for securities traders, especially unsophisticated/non-professional traders may be implemented. A digital twin may be generated of a trader's stock portfolios, and simulations may be run to show what may occur with respect to buying, selling, shorting, etc. Outside market forces may be tracked, interpolated, extrapolated, and simulated via feeds from external data sources. An AI-based expert system may advise the trader on opportunities to buy, sell, short, hold, etc. based on market forces and their current portfolio. The AI-based system may also automatically perform actions such as buying, selling, shorting, etc., e.g., via one or more RPA systems. These capabilities may be implemented at the edge, e.g., via a software application that may be executed on the trader's smartphone. In example implementations, AI calculation may be performed at the edge via converged AI chipsets.

In example embodiments, the automated insurance exchange module 2650 may be implemented for automated insurance exchange in the marketplace 1900. Herein, the automated insurance exchange module 2650 may be configured to implement the RPA module 2608 to process a purchase of an insurance for a trade to be executed from an insurance exchange in the marketplace 1900 for a given event of price volatility. In insurance, RPA may refer to the use of rules-based, low-code software “bots” to handle the repetitive tasks of human workers, such as collecting customer information, extracting data in claims, performing background checks, and so on. RPA may be part of the greater trend of hyper-automation, enabling organizations to transform processes to be more competitive. RPA may bridge the gap between legacy insurance systems in a way that may improve the customer experience and operational efficiency. Specifically, RPA platforms may process actions right down to the mouse and keyboard levels, while also integrating with systems at a lower level via application programming interfaces (APIs). Organizations may use API connectors when building their workflows with RPA for end-to-end automation.

In example embodiments, the automated insurance claims settlement module 2660 may be implemented for automated insurance claims settlement in the marketplace 1900. Herein, the automated insurance claims settlement module 2660 may be configured to implement the RPA module 2608 to trigger an insurance claim for an event of an accident. In traditional claims processing, employees may gather information from various documents and move it into other systems. Now, RPA bots may move large amounts of claims data with just one click, so customers may get a faster response when they file a claim. RPA bots may streamline the entire claims journey from First Notice of Loss to adjustment and settlement. By automating their high-volume claims filing processes, insurers may free up their claims inspectors for resolving key issues and exceptions. Standard claims may get handled within shortened timeframes (e.g., minutes), while employees focus on other issues that matter for the business. Thus, insurers may speed up a wide range of data-rich processes with RPA, from new business onboarding to policy cancellations. RPA may toggle through multiple systems and automatically move data, saving human effort and meeting customers' needs. Further, by replacing manual processes with RPA, insurers may remove the potential for human errors. RPA may increase the reliability of data, which may be especially important for regulatory compliance. In example embodiments, claims may be analyzed for whether they are standard claims and may be processed as described in the disclosure. Alternatively, in some example embodiments, claims may have complexities requiring at least some oversight or review by an insurance agent such that the system may categorize these claims as non-standard claims accordingly and then shift these non-standard claims to a semi-supervised or supervised process before these claims are processed for insurers.

The disclosure may further provide a method for automating processing of transactions in the marketplace 1900. FIG. 28 provides an exemplary flowchart listing steps involved in a process or method 2870 for automating processing of transactions in the marketplace 1900. The various teachings of the system 2300 as described in the disclosure may apply mutatis mutandis to the process or method 2870. At 2872, the method 2870 may include generating, by the processing system, an artificial intelligence (AI) model trained on a set of user interactions related to one or more transactions in response to corresponding one or more events in the marketplace. At 2874, the method 2870 may include configuring, by the processing system, a robotic process automation (RPA) module to mimic the user interactions by implementing the AI model 2606. At 2876, the method 2870 may include monitoring, by the processing system, in near real-time, events in the marketplace. At 2878, the method 2870 may include implementing, by the processing system, the RPA module 2608 to automatically process a transaction in response to a given event in the marketplace, as per the monitoring, by providing corresponding instructions complementary to one or more user interactions otherwise required therefor.

In example embodiments, the method 2870 may further include implementing the RPA module 2608 to generate an invoice, for a given party delivering one or more items to a party receiving the one or more items, for a given event of completion of delivery of the one or more items.

In example embodiments, the method 2870 may further include implementing the RPA module 2608 to process a registration of a person for a given event of completion of a predefined age for the person.

In example embodiments, the method 2870 may further include implementing the RPA module 2608 to process a trade for at least one of: buying, selling, or shorting a security from a security exchange in the marketplace for a given event of a trigger price.

In example embodiments, the method 2870 may further include implementing the RPA module 2608 to process a purchase of an insurance for a trade to be executed from an insurance exchange in the marketplace for a given event of price volatility.

In example embodiments, the method 2870 may further include implementing the RPA module 2608 to trigger an insurance claim for an event of an accident.

In an example implementation, the system 2600 and the method 2870 may be implemented for a smart freight-yard derived pricing system, for example, in a smart railroad freight yard, in which freight locomotives may be powered and controlled by robots and in communication with each other; freight cars, storage and tracks, switches etc. may be enabled to communicate with the locomotives; know the set positions of rail switches etc.; enabling a traveling salesman-type of coordinated “solve” for the riddle of how to assemble the many needed outgoing trains from the many incoming freight cars, using the least number of locomotives, moves, fuel etc.; applying rules according to expedited freight requirements, hazardous materials, and/or special shipping instructions, so that each train may be assembled per such rules in the least number of rules; for data visualization which may be used to inform dispatchers, yard masters, customers etc. of current location and condition of freight; for anticipating weather and simulate its potential impacts on the best updated moves of the locomotives to assemble the trains, based on a need for rerouting, delays, and the like; for railroads to figure and set variable pricing for shipping based on current conditions; for prompting real-time automated transaction pricing (smart contracts) for freight carrying based on the ease/difficulty with which a freight carrier may move a customer's freight, taking into account the current condition of the yard (e.g., freight volume, freight condition (e.g., lots of slow-moving freight or fast-moving perishable freight)); for making interchange with other railroads relatively more predictable, efficient; and the like.

In an example implementation, the system 2600 and the method 2870 may be implemented for handling actual paperwork (where paper may be required), such as for automation of paperwork for management of proof of maintenance of aircraft parts (paper maintenance records may be a requirement); for filling out of forms where the paper record may be required into the future; for counting of money or verification; and the like.

In an example implementation, the system 2600 and the method 2870 may be implemented for robots that may be configured to perform pickup and delivery of goods traded in a transaction environment (e.g., a marketplace or a set of marketplaces). Deployment of a robot may occur to inspect an item that you may be interested in buying. Alternatively, the robot may automatically decide to buy the item on a party's behalf. The robot may inspect the item to determine its condition/fitness/etc., generate a valuation for the item, negotiate to purchase the item, pay for the item (or trade another item for the item), and/or bring the item back to a user. The robot may also configure/assemble the item for a user if configuration/assembly may be required. Alternatively, one may deploy a robot to sell one or more of a user's items, including creating a listing in a marketplace, sending the robot to meet and negotiate with potential buyers, and possibly deliver the item. This may also include a mix of an RPA software system and a fleet/workforce of physical robots, such as where the RPA systems may handle most tasks (e.g., search and negotiation), and physical robots may handle other tasks.

In an example implementation, the system 2600 and the method 2870 may be implemented for robotic process automation system that may sell its data/processing/outputs (e.g., “RPA as a service”), including: (a) refined data set(s) that may be created to allow for relatively improved operation (e.g., clickstream data from human typing, screen interactions (such as mouse and touch screen), and selection of subsets of data (e.g., regions of interest in images, sections of interest in videos, and/or the like); (b) algorithms and heuristics that may be developed to refine process automation (e.g., algorithms to spot analytic patterns, such as spotting trends in a market signal, spotting trends in social data, spotting trends in news, predicting causal relationships, and/or the like); and (c) outputs, such as analytic conclusions, predictions, recommendations, classifications, etc. RPA systems may be configured to sell the various features as described, such as in an RPA services marketplace, that may include an RPA trader, a negotiator, a securities analyst, a lender, a contract negotiator, a regulator, etc.

In an example implementation, RPA may be incorporated in purchasing decisions where a human may be first involved. In such example, the user's actions may be tracked not just when making a purchase, but when doing research, interacting with the digital twin (e.g., what did the user “drill down on”, what types of scenarios were run in the digital twin, etc.), what “future conditions” were explored, when the user may take action, when the user does not take action, and the outcomes associated with the tracked data and the user's decisions (e.g., were the decisions “good” or “bad”?). In some of these examples, the system may rate users as “good” decision makers or “bad” decision makers, and may weight their data accordingly. This may all be fed into training data sets, which may be used to train the purchasing agent described in the disclosure. In the case of bad decision makers, the RPA may be trained with a model, where the purchasing agent makes the opposite decision of what the bad decision maker would do.

In an example implementation, RPA may be utilized in smart freight-yard derived pricing system and/or smart railroad freight yard pricing system. In such example, freight locomotives may be powered and controlled by robots and in communication with each other. Freight cars, storage and tracks, switches etc. may be enabled to communicate with the locomotives and know the set positions of rail switches etc. This may enable a traveling salesman-type of coordinated “solve” for the riddle of how to assemble the many needed outgoing trains from the many incoming freight cars, using the least number of locomotives, moves, fuel etc. Rules may be applied according to expedited freight requirements, hazardous materials, and/or special shipping instructions, so that each train may be assembled per such rules in the least number of rules. Because of this automation, data visualization may be used to inform dispatchers, yard masters, customers etc. of current location and condition of freight. The system may anticipate weather and simulate its potential impacts on the best updated moves of the locomotives to assemble the trains, based on a need for rerouting, delays, and the like. Railroad organizations may use this system to figure and set variable pricing for shipping based on current conditions. This may prompt real-time automated transaction pricing (e.g., smart contracts) for freight carrying based on the ease/difficulty with which a freight carrier may move a customer's freight, taking into account the current condition of the yard (e.g., freight volume, freight condition (e.g., several slow-moving freight or fast-moving perishable freight)). This may also make interchange with other railroads relatively more predictable and/or efficient.

In an example implementation, RPA may be utilized for handling actual paperwork (where paper may be required), such as for automation of paperwork for management of proof of maintenance of aircraft parts (e.g., paper maintenance records may be a requirement), filling out of forms where the paper record may be required into the future, counting of money or verification, and/or the like. This model of paper records may become relatively more generalized to all critical systems.

In an example implementation, RPA may be utilized for configuring robots to perform pickup and delivery of goods traded in a transaction environment (e.g., a marketplace or a set of marketplaces). Deployment of a robot may occur to inspect an item that one may be interested in buying. Alternatively, the robot may automatically decide to buy the item on a user's behalf. The robot may inspect the item to determine its condition/fitness/etc., generate a valuation for the item, negotiate to purchase the item, pay for the item (or trade another item for the item), and bring the item back to a user. The robot may also configure/assemble the item for a user if configuration/assembly is required. Alternatively, one may deploy a robot to sell one or more of the user's items, including creating a listing in a marketplace, sending the robot to meet and negotiate with potential buyers and possibly deliver the item. This may also include a mix of an RPA software system and a fleet/workforce of physical robots, such as where RPA systems may handle most tasks (e.g., search and negotiation), and physical robots may handle other tasks.

In an example implementation, RPA may be utilized as a service (e.g., “RPA as a service”) that may sell its data/processing/outputs including: (a) refined data set(s) that may be created to allow for relatively better operation (e.g., clickstream data from human typing, screen interactions (such as mouse and touch screen), selection of subsets of data (e.g., regions of interest in images, sections of interest in videos), and/or the like; (b) algorithms and heuristics that may be developed to refine process automation (e.g., algorithms to spot analytic patterns, such as spotting trends in a market signal, spotting trends in social data, spotting trends in news, predicting causal relationships, etc.); and (c) outputs, such as analytic conclusions, predictions, recommendations, classifications, etc. RPA systems may be configured to sell the various features as described in this disclosure, such as in an RPA services marketplace, may include an RPA trader, a negotiator, a securities analyst, a lender, a contract negotiator, a regulator, etc.

In an example implementation, RPA may be used to automate data workflows, including back-office like tasks to ingest, clean, structure, and most importantly linking data across institution(s); and breaking down data silos to seamlessly connect data workflows to core analysis and visualization tools, etc. Essentially, RPA may help with coordinating the integration of multiple data-centric technologies. Examples may include customer data from multiple sources flowing into a risk model, identity data flowing into KYC/KYT profiles, operational data flowing into financial and transaction models, and the like. This may be tied to analyses risk and predicts future impacts to cash flows. This may turn into automatic hedging of positions or execution of transactions depending on the potential loss of product/goods.

In an example implementation, RPA may be utilized for smart port-to-warehouse automation. An overarching AI/RPA system oversees organization and transit of goods “downstream” from the ship all the way to at least the truck, train, warehouse, etc. and perhaps to retail/end-user. The AI/RPA system may receive a data stream from one or more databases related to markets in which shipped goods may be traded. The AI/RPA system may oversee loading/unloading, routing (e.g., using data routing engines), and scheduling of container ships. Each ship container may be outfitted with AI-interpretable identification, such as including owners, senders, recipients, contents, related markets, etc. AI/RPA-enabled crane systems may automatically unload container ships in an intuitive manner based on AI-generated sorting systems. After unloading, AI/RPA-enabled robots may open and unload the containers, moving them to trucks, trains warehouses, etc. Then, AI/RPA-enabled trucks, trains, warehouses, etc. may facilitate further distribution of goods. The AI/RPA system may use digital twins to manage the overall supply chain, and may interpret, create, amend, and/or follow smart contracts for each step of the process. Even after the goods arrive in the warehouse, the AI/RPA system and related robots may see the goods shipped to retailers and/or end-users.

In an example implementation, RPA may be utilized for shared robotic services marketplace. Considering the cost of using robots being shared across multiple people and/or multiple businesses in different transactions within one or more fields, this may provide cost savings. This may include cleaning-service robots (e.g., clean room for hotel) that may charge automatically for completing cleaning tasks based on a rate of time, type of transaction, power usage (e.g., some tasks may be higher demand), thereby improving efficiency over time as same or similar transactions may be completed to lower costs over time. Robots that may be used by restaurants to cook food may be rented for use and charge a fee to restaurants based on usage (e.g., tasks completed, time-use, and/or energy used) using smart contracts or possibly charged as a percentage of food price, improving efficiency for each transaction by using digital twin to repeat similar or different cooking actions over time. Medical robots may be used in surgeries that may automatically transact with insurance companies such that costs calculated by each robot may be based on actual items needed and usage. Truck-driving robots may be used to efficiently improve transactions through automation as items may be picked up and then delivered through integration of smart contracts.

In an example implementation, RPA may be utilized to configure robots as a service (RaaS) to evaluate and complete repair transactions, including home, industrial, automotive, or other settings. This may have implications in automatic M2M dispatch based on preventive or diagnosed maintenance systems; M2M dispatch by call centers (e.g., AAA, warranty management centers, etc.); on-site evaluation of required service parts, associated costs, and automated required documentation, possibly being managed using RPA processes; possible production of part (e.g., using 3D printing); execution of repair and automatic process documentation; certified to complete warranty repairs in coordination with M2M warranty management systems; etc.

In an example implementation, RPA may be utilized for end-to-end automation of insurance claims including: (a) accident capture; (b) diagnosis; (c) claim determination; (d) decision to repair or total such that automated repair workflows (e.g., using robotics) may be triggered; (f) root cause analysis; (g) change in safety regulations; (h) update design/quality testing processes/standards/simulation models; and/or (i) adjust claims handling procedures/data collection requirements/appraisal standards/etc. based on learning and feedback on claims processing.

M2M machines as either transactions or communications may be interesting when combined with digital twin. For transactions, one may apply technologies from machine-to-machine transactions to digital twins using some level of AI to negotiate between the digital twins or taking input on what the digital twins want to transact. This may all feed from the intelligent data layers both on the sides of the buyer and the seller for whatever they are transacting. This may have implications in machine as a service, equipment as a service, etc. Further, these examples may be applied to various kinds of or types of assets that may be represented in the digital twin and may be set up with smart contracts in an intelligent data layer to automatically provision things such as allocate resources, charge for them, prioritize them, set pricing, etc.

In general, PAAI may have application in forecasting, information, and insight in which, for instance, digital twins and analytic visualization systems for transaction environments may be implemented for addressing latency in insight about entity, asset and/or market conditions; social and crowdsourcing data collection systems (e.g., crowdsourcing orchestration systems) may be implemented for addressing poor information about collective behavior; comprehensive data collection and handling platform may be implemented for addressing inadequate automation or intelligence and/or model failure; forward market prediction may be implemented for handling non-traditional data; event tracking, handling and forecasting systems may be implemented for addressing unpredictable market factors and exogenous events; intelligent price forecasting and forward market systems may be implemented for addressing uncertainty about future prices; IoT and wearable data collection systems may be implemented for addressing poor information about individual behavior; entity rating, and behavioral tracking systems may be implemented for addressing poor information about entity behavior; and the like. PAAI may also have application in optimization of engagement in which novel data visualization and presentation systems may be implemented to address consumer confusion and/or lack of understanding or awareness. PAAI may also have application in process automation and intelligence in which, for instance, automated data processing and filtering systems may be implemented to address excess and/or noisy data; improved smart contract systems may be implemented to address contractual complexity and/or opacity; data handling and transaction process automation systems may be implemented to address high transaction costs and/or delays in execution or settlement, reporting logistics, and/or outdated processes; location-aware transaction enabling systems may be implemented to address jurisdictional complexity; and the like. PAAI may also have application in resource optimization in which, for instance, edge intelligence systems may be implemented to address data and/or network congestion. PAAI may also have application in transactions technology convergence for automation and intelligence, for instance, integration of alternative data sources for intelligent markets; data and networking pipeline for market orchestration; robotic process automation (RPA) and distributed leger technology (DLT)/blockchain; and the like. PAAI may also have application in market making in which, for instance, smart contract and blockchain solutions for forward markets for events and services may be implemented to address rapid price change patterns in constrained markets. PAAI may also have application in market orchestration, for instance, market orchestration digital twins; peer-to-peer transaction orchestration to be implemented to address high cost of intermediaries; and the like. PAAI may also have application in transactability enablement in which, for instance, tokenization, securitization, and tradability of illiquid assets may be implemented to address illiquidity of owned assets (e.g., difficulty unlocking value); exchange normalization, value translation, tokenization, and digital rights representation may be implemented to address uncertainty about comparative value of heterogeneous assets; and the like. PAAI may also have application in trust, security, governance, and compliance in which, for instance, data and transaction security protocols may be implemented to address third party attack; detection of fraud, attack and gaming behaviors; and the like.

PAAI may have use-cases in issuing for analysis of market conditions to help issuers with the size, structure, and timing of issuing, credit-risk assessment and rating of issuers derived from ever-increasing publicly-available data, new data sources to help investors with pricing, etc. PAAI may also be used with risk management (issuer counterparty level) for analysis of contract terms and related risks, risk model optimization, issuer default rating/credit risk assessment, collateral optimization, etc. PAAI may also be used with risk management (e.g., trading counterparty level) for risk model optimization, counterparty default rating, counterparty default prediction, margin-call prediction, collateral optimization, etc. PAAI may also be used with operational risk (e.g., fat-finger protection) for warning showing average slippage on an order as greater than or equal to set percentage, formula calculate “expected loss” for both sell-side and buy-side, analytics-driven issue detection and real-time risk reporting, monitoring all operational risk and deducing operational hazards before they occur, etc. PAAI may also be used with an IT infrastructure for system breakdown prediction, under-provisioning or over-provisioning analysis, predictive network issues and outages, smart reroute migration, reduction of downtime, disaster recovery failsafe, agile vendor reliability analysis, and unexpected costs and recovery, etc. PAAI may also be used with trading for sophisticated order types, insider-trading detection, market-liquidity prediction, market-impact prediction, etc. PAAI may also be used in investment allocation for sophisticated “robo-advisors” which may have allowed tailor-made investment recommendations for the masses and may have thus allowed the construction of individualized yet diversified portfolios, etc.

PAAI may also be implemented as an intelligent data layer in financial services involving simulating financial risk using standardized methods (e.g., the Value-at-Risk method for Basel III compliance) where regulatory compliance or revenue pools may depend on risk simulations for managing holdings against pre-defined risk limits. PAAI may also have application in quantum optimization of markets (QMKT) which may be implemented with various services.

Marketplace Management of Digital Twin Framework with Transactions

Marketplace management of digital twin framework with transactions may facilitate the organization of these software defined markets such as the ability to monitor them, understand the rules that govern them in real time, and monitor them as they comply or not comply with roles. This may be used to represent various things about a transaction environment (e.g., a marketplace or a set of marketplaces) such as: (i) where are the computers that are participating; (ii) who are the entities; (iii) where is the data; (iv) what are current latency levels for transactors; (v) what are rules (e.g., holding, timing, asset types, quarantine, etc.); (vi) geo-location awareness (e.g., where is data located, jurisdictional complexity); and the like.

Intersection of Types of Intelligence with Particular Processing that is Automated with Transactions

Intersection of types of intelligence with particular processing that may be automated with transactions may include mapping to specific processes, different flavors of AI (e.g., convolutional neural networks or modelling, traditional models, versus recurrent neural network (RNN), versus decision trees, natural language processing (NLP) type approaches, others where computer vision may be useful, clustering is being done, etc.). This may further include mapping of different workflows such as places where there may be a marriage of a particular workflow with a particular type of AI.

Compliance with Regulations and Standardization with Transactions

Compliance with regulations and standardization with transactions may provide governance stack (e.g., building in standards, governance, or policy) which may be implemented in transactions involved in governance and policy making, for example, simulation system for regulatory compliance, such as run system in simulation before being permitted to join the marketplace (for instance, to demonstrate lack of bias, accuracy, consistency, etc.). Further use-case examples may include using AI (e.g., from the PAAI system) to optimize a company's approach to tax rules/regulations impacting various transactions (e.g., weights towards paying least amount of taxes, efficiency of tax-related actions that may be based on current business and business projections, etc.).

### Security Oversight for AI Types of Transactions

Security oversight for AI types of transactions may be implemented for “Security of Training Data” (e.g., compliance of training data), AI negotiated smart control with AI regulator, monitor/regulate behavior of AI, verification process for AI, etc. This may particularly have use-case for “Know your AI transactor” which may be achieved by answering some related questions including, but not limited to, (i) what does the AI transactor use as data sources?; (ii) what do they use as functions/inputs?; (iii) where are they operating (e.g., geospatial)?; (iv) what are they trained on such as is there bias in training data (e.g., as such training data may be used to train a neural network)?; and the like.

### Market Aggregation

Due to the highly regulated nature of the financial services industry and the use of legacy systems, some finance businesses may struggle to get access to finance data which in turn may hinder their innovation process. While the regulators across various regions may be attempting to bring Open Banking legislation to improve data sharing mechanisms between banks and finance businesses, the adoption may yet to become mainstream. Moreover, financial institutions have to increasingly comply with developing data protection laws such as Europe-wide General Data Protection Regulation (GDPR), Payment Card Industry Data Security Standard (PCI-DSS), California Consumer Privacy Act (CCPA), Data Protection Act (DPA, UK), Health Insurance Portability and Accountability Act (HIPAA, US), etc. Along with this, the data in financial institution data servers may be spread across several systems and business units which involves managing different data formats and data fragmentation scenarios in order to prepare a single source of truth to aid the data analysis use-cases for fintech innovation.

A common challenge faced by businesses may be aggregating a large amount of data. Moreover, real-life datasets may not provide flexibility in running specific scenarios that may require tweaking datasets to meet the requirements of a specific use case that may need to test extreme conditions such as market crashes or app failures. For instance, companies may utilize various tools such as a demand management system to aggregate a set of indicators of demand for a product or service into an aggregate indicator of demand, a transaction management system to aggregate a set of microtransactions into an aggregate transaction, and a value aggregation system to aggregate a set of assets into an aggregate asset. However, the problems in data aggregation may be daunting. In its current form, manual validation of extracted data may take a substantial number of resources including time and energy spent to format data for analysis. Moreover, the data extraction toolsets may need to be customized for each activity to ensure that the data may be accurate and consistent.

In order to meet the massive requirements of data for innovation, the financial services industry may need a new approach. That is where the technologies of Digital Twin may address these issues. Digital Twin may involve the usage of synthetic data generators which may use machine learning algorithms and statistical simulations to mimic the statistical properties of real-life datasets. The synthetic datasets of Digital Twin may also allow FinTechs to generate dynamic datasets which may create projections for multiple future scenarios incorporating alternate market, business, and lifestyle events.

In example embodiments, organizations across several verticals may deploy Robotic Process Automation (RPA) and Artificial Intelligence (AI) to increase productivity and efficiency. The growing demand for automation of business processes may be one of the significant factors influencing the increasing adoption of RPA technology. The core purpose of RPA may be to document the activities of an organization for efficient management. In a highly competitive market, it may become essential to improve work agility and deliver enhanced customer experiences. RPA robots may perform tasks across different legacy systems to get information on the digital platform. For instance, bank customers may check their account details online and process know your customer (KYC) verification and automatic bill payment along with other functions through the Internet. These services may have minimized manual involvement and may be guiding in delivering of an improved customer experience. Moreover, automated data collection may provide seamless data entry and storage and may eliminate errors and repetitions. Such practices may reduce the time and cost required to rectify the mistakes in data gathering and processing. Further, the increased demand to simplify the complex handling process may be expected to augment the industry growth.

Aggregate demand may be a measurement of the total amount of demand for all finished goods and services produced in an economy. Aggregate demand may be expressed as the total amount of money exchanged for those goods and services at a specific price level and point in time. Aggregate demand may include all consumer goods, capital goods (e.g., factories and equipment), exports, imports, and government spending. Aggregate demand may be the sum of the demand curves for different sectors of the economy. This is usually divided into four components; personal consumption such as consumer spending which may represent the demand by individuals and households within the economy, and depends on consumer incomes and the level of taxation; business investment (e.g., divided into two sub-components of fixed investment and change in private inventory) which may include purchases that organizations may create to produce consumer goods; government spending which may represent the demand produced by government programs, such as infrastructure spending and public goods (e.g., not including services such as Medicare or social security, because these programs simply transfer demand from one group to another); and net exports which may represent the demand for foreign goods, as well as foreign demand for domestic goods, and may be calculated by subtracting the total value of a country's exports from the total value of all imports.

FIG. 29 provides an exemplary block diagram illustration of a system 2900 for automated orchestration of the marketplace 1900. In particular, the system 2900 may be implemented for automated orchestration of one or more marketplaces having a robotic process automation system trained on a training set of expert interactions with a value aggregation system to aggregate a set of assets into an aggregate asset. The system 2900 may implement a processing system 2910 for this purpose. The processing system 2910 may be configured to obtain information about different items in the marketplace 1900, including information about at least one attribute associated with each of the different items. The processing system 2910 may be further configured to aggregate one or more items in the marketplace 1900 into corresponding one or more aggregate assets based, at least in part, on the respective at least one attribute associated therewith. The processing system 2910 may be further configured to generate a digital twin 2902 representing the marketplace 1900 with the one or more aggregate assets. The processing system 2910 may be further configured to facilitate one or more transactions for each one of the one or more aggregate assets independent of the other one or more aggregate assets in the marketplace 1900. Such aggregation may lead to a lot of process efficiency in the marketplace 1900.

In example embodiments, the system 2900 may be provided having a robotic process automation system trained on a training set of expert interactions with a value aggregation system to aggregate a set of assets into an aggregate asset and having an artificial intelligence system that may be configured to automatically orchestrate a transactional workflow within the marketplace 1900, as discussed in the disclosure.

In example embodiments, the system 2900 may be provided having a robotic process automation system trained on a training set of expert interactions with a demand management system to aggregate a set of indicators of demand for a product or service into an aggregate indicator of demand. The robotic process automation system may be trained on a training set of expert interactions with a transaction management system to aggregate a set of microtransactions into an aggregate transaction. The robotic process automation system may further be trained on a training set of expert interactions with a value aggregation system to aggregate a set of assets into an aggregate asset, as discussed in the disclosure.

The system 2900 may provide interesting results through use of a robotic process automation system that provides market aggregation processes that specifically provide demand aggregation, value aggregation, and/or microtransaction aggregation. In example embodiments, the system 2900 is provided having a robotic process automation system may be trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a unit of a physical product; or by which a set of buyers may engage with a set of offers via a set of orchestrated workflows, where such interfaces and workflows may be embedded in a digital twin of a physical item to which the offers relate. In example embodiments, the system 2900 may be provided having a robotic process automation system trained on a training set of expert interactions with a value aggregation system to aggregate a set of assets into an aggregate asset and having a digital twin within which a set of interface elements may be presented by which a seller may orchestrate a set of offers related to the items represented in the digital twin; or presented by which a buyer may engage with a set of offers related to the items represented in the digital twin. In example embodiments, the system 2900 may be provided having a robotic process automation system trained on a training set of expert interactions with a value aggregation system to aggregate a set of assets into an aggregate asset and having a set of robotic process automation services that may be configured to automatically translate the value of an item represented in a first exchange into a value of the item for representation in a second exchange; that may be configured to generate a token that represents an item in an exchange based on characteristics of the item determined from data from a different exchange; that may be configured to generate a digital representation of a set of rights relating to an item that may be consistent with the governing rules of an exchange based on processing at least one of: a set of smart contracts and/or a set of terms and conditions relating to the item; or that may be configured to orchestrate a set of transaction workflows in each of several exchanges, such that initiation of a set of actions in one exchange may automatically result in the triggering of a set of actions in at least one other exchange.

In example embodiments, the system 2900 may be provided having a robotic process automation system trained on a training set of expert interactions with a value aggregation system to aggregate a set of assets into an aggregate asset and having: a digital twin that may represent a set of entities, workflows, and transaction parameters of exchanges, such that an interaction with the interface of the digital twin may orchestrate an interaction in each of the exchanges; a set of robotic process automation services that may be configured to inspect a set of smart contracts in each of several exchanges and to configure a smart contract that may provide terms and conditions for a transaction that may involve a transactional step in each of the several exchanges; a data and network infrastructure pipeline that may be configured to deliver data from a set of assets to an interface by which an operator may orchestrate a set of parameters for a set of transaction workflows involving the assets, where the pipeline may be automatically configured to adjust a network path based on the characteristics of the data and at least one performance parameter of the network path; a data and network path; a data and network infrastructure pipeline that may be configured to deliver data from a set of assets to an interface by which an operator may orchestrate a set of parameters for a set of transaction workflows involving the assets, where the pipeline may be automatically configured to adjust timing of data delivery based on at least one of: a transaction parameter and/or a network performance parameter; a data and network infrastructure pipeline that may be configured to deliver data from a set of assets to a set of smart contracts that may include terms, conditions, and parameters for a set of transaction workflows involving the assets, where the pipeline may be automatically configured to adjust timing of data delivery based on at least one of a transaction parameter and/or a network performance parameter; a set of application programming interfaces to a transaction environment (e.g., a marketplace or a set of marketplaces) that may be configured to be integrated into an electronic wallet system, such that interactions with a set of interfaces of the wallet system may automatically trigger a set of transaction workflows within the marketplace; a set of application programming interfaces to a marketplace that may be configured to be integrated into a digital twin platform, such that interactions with a set of interfaces of the digital twin platform may automatically trigger a set of transaction workflows within the marketplace; a set of application programming interfaces to a marketplace that may be configured to be integrated into an enterprise database platform, such that interactions with a set of interfaces of the enterprise database platform may automatically trigger a set of transaction workflows within the marketplace; a set of application programming interfaces to a marketplace that may be configured to be integrated into a platform-as-a-service platform, such that interactions with a set of interfaces of the platform-as-a-service platform may automatically trigger a set of transaction workflows within the marketplace; a set of application programming interfaces to a marketplace that may be configured to be integrated into a computer-aided design platform, such that interactions with a set of interfaces of the computer-aided design platform may automatically trigger a set of transaction workflows within the marketplace; and/or a set of application programming interfaces to a marketplace that may be configured to be integrated into a video game, such that interactions with a set of interfaces of the video game may automatically trigger a set of transaction workflows within the marketplace.

In example embodiments, the processing system 2910 may be further configured to provide a set of interface elements for a party to access at least one of the one or more aggregate assets therein independent of the other one or more aggregate assets. Such control for the parties may be able to access individual aggregate assets independently that may open up possibilities for a new type of transactions which may not have been possible otherwise.

In example embodiments, the processing system 2910 may be further configured to: record user interactions related to assigning of corresponding values, as the at least one attribute, to the different items in the marketplace 1900 and to aggregating of the different items as the one or more aggregate assets in the marketplace 1900 in relation to the assigned values thereto; configure a robotic process automation (RPA) module 2608 to mimic the user interactions related to the assigning of corresponding values to the different items and the aggregating of the different items into the one or more aggregate assets; and implement the RPA module 2608 to automatically assign value to a given item in the marketplace 1900 and to automatically aggregate one or more given items into one or more aggregate assets based on the automatically assigned values thereto in the marketplace 1900. The implementation of the RPA module 2608 may help reduce human effort which may otherwise be required in manually assigning values to individual aggregated assets, which in most cases may not even be possible for human operators to achieve with a potentially large number of aggregated assets that may be generated with the proposed example embodiment. This may ultimately help to improve operational efficiency.

In example embodiments, the processing system 2910 may be further configured to: record user interactions related to translation of values, as one of the one or more transactions, of the one or more aggregate assets from one of the exchanges in the marketplace 1900 to another one of the exchanges in the marketplace 1900; configure a robotic process automation (RPA) module to mimic the user interactions related to the translation of values of the one or more aggregate assets; and implement the RPA module 2608 to automatically translate a first value of a given aggregated asset represented in a first exchange into a second value of the given aggregated asset for representation in a second exchange. The implementation of the RPA module 2608 may help reduce human effort which may otherwise be required in manual translation of assigned values to individual aggregated assets when exchanged from one exchange to another (such as, converting currency as per prevalent exchange rates). This may ultimately help to improve operational efficiency.

In example embodiments, the processing system 2910 may be further configured to: record user interactions related to generation of a token, as one of the one or more transactions, for the one or more aggregate assets as represented in one of exchanges in the marketplace 1900 to be transferred to be representation in another one of the exchanges in the marketplace 1900; configure a robotic process automation (RPA) module to mimic the user interactions related to the generation of a token for the one or more aggregate assets; and implement the RPA module 2608 to automatically generate a token for a given aggregated asset represented in a first exchange to transfer the given aggregated asset for representation in a second exchange. This may help with providing digital ownership proofs for all of the assets in a single aggregated asset as generated herein.

In example embodiments, the processing system 2910 may be further configured to: record user interactions related to generation of digital representations of a set of rights, as one of the one or more transactions, for the one or more aggregate assets in the marketplace 1900 based on at least one of a set of smart contracts and a set of terms and conditions related to the different aggregate assets; configure a robotic process automation (RPA) module to mimic the user interactions related to the generation of digital representations of a set of rights for the one or more aggregate assets; and implement the RPA module 2608 to automatically generate a digital representation of a set of rights for a given aggregate asset in the marketplace 1900 based on at least one of a set of smart contracts and a set of terms and conditions related thereto. This may help with establishing rights in the form of smart contracts, in addition to digital ownership proofs, for all of the assets in a single aggregated asset as generated herein.

In example embodiments, the processing system 2910 may be further configured to: record user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace 1900; configure a robotic process automation (RPA) module to mimic the user interactions related to the orchestrating of a set of transaction workflows for the one or more aggregate assets; and implement the RPA module 2608 to automatically orchestrate a set of transaction workflows for a given aggregated asset by initiating a set of first actions in the at least one of the exchanges in response to triggering of a set of second actions in the at least one other exchange in the marketplace 1900. That is, based on an action in a first exchange, the RPA module 2608 may be able to automatically orchestrate a defined set of transaction workflows, complementary to the action in the first exchange, in a second exchange, or the like.

In example embodiments, the processing system 2910 may be further configured to: record user interactions related to adjusting of timing of delivery, as one of the one or more transactions, for the one or more aggregate assets based on at least one of a transaction parameter and/or a network performance parameter in the marketplace 1900; configure a robotic process automation (RPA) module to mimic the user interactions related to the adjusting of timing of delivery for the one or more aggregate assets; and implement the RPA module 2608 to automatically adjust timing of delivery for a given aggregated asset based on at least one of the transaction parameter and/or the network performance parameter in the marketplace 1900.

In example embodiments, the processing system 2910 may be further configured to: record user interactions related to determining of demand, as the at least one attribute, for the different items in the marketplace 1900 and to aggregating of the different items as the one or more aggregate assets in the marketplace 1900 in relation to the demand thereof; configure a robotic process automation (RPA) module to mimic the user interactions related to the determining of demand for the different items and the aggregating of the different items into the one or more aggregate assets; and implement the RPA module 2608 to automatically determine demand for a given item in the marketplace 1900 and to automatically aggregate one or more given items into one or more aggregate assets based on the automatically determined demands thereof in the marketplace 1900.

In example embodiments, the processing system 2910 may be further configured to: record user interactions related to curation of a set of micro-transactions for the one or more aggregate assets and processing of the curated set of micro-transactions as a single transaction for the one or more aggregate assets, as one of the one or more transactions, in the marketplace 1900; configure a robotic process automation (RPA) module to mimic the user interactions related to the curation of the set of micro-transactions for the one or more aggregate assets and processing of the curated set of micro-transactions as the single transaction for the one or more aggregate assets; and implement the RPA module 2608 to automatically curate a set of micro-transactions for a given aggregated asset and process the automatically curated set of micro-transactions as a single transaction in the marketplace 1900.

The disclosure may further provide a method for automated orchestration of the marketplace 1900. FIG. 30 provides an exemplary flowchart listing steps involved in a process or method 3000 for automated orchestration of the marketplace 1900. The various teachings of the system 2900 as described in the disclosure may apply mutatis mutandis to the process or method 3000 or the system 3100. At 3002, the method 3000 may include obtaining, by a processing system 3100, information about different items in the marketplace, including information about at least one attribute associated with each of the different items. At 3004, the method 3000 may include aggregating, by the processing system, one or more items in the marketplace into corresponding one or more aggregate assets based, at least in part, on the respective at least one attribute associated therewith. At 3006, the method 3000 may include generating, by the processing system, a digital twin representing the marketplace with the one or more aggregate assets. In example embodiments, a digital twin(s) may allow for aggregation and disaggregation of assets and, upon user interaction, may represent metrics that may be calculated and presented in the digital twin(s) (e.g., via visual indicators) that may be based on whether the assets are aggregated or not. For example, a user may circle or click on a set of assets, which may cause them to be linked or grouped in the digital twin, and the twin may show the aggregate fair market value of those assets (e.g., such as to show that they are collectively adequate collateral for a loan or trade). At 3002, the method 3008 may include facilitating, by the processing system, one or more transactions for each one of the one or more aggregate assets independent of the other one or more aggregate assets in the marketplace.

In example embodiments, the method 3000 may further include providing, by the processing system, a set of interface elements for a party to access at least one of the one or more aggregate assets therein independent of the other one or more aggregate assets.

In example embodiments, the method 3000 may further include: recording, by the processing system, user interactions related to assigning of corresponding values, as the at least one attribute, to the different items in the marketplace and to aggregating of the different items as the one or more aggregate assets in the marketplace in relation to the assigned values thereto; configuring, by the processing system, a robotic process automation (RPA) module to mimic the user interactions related to the assigning of corresponding values to the different items and the aggregating of the different items into the one or more aggregate assets; and implementing, by the processing system, the RPA module 2608 to automatically assign value to a given item in the marketplace and to automatically aggregate one or more given items into one or more aggregate assets based on the automatically assigned values thereto in the marketplace.

In example embodiments, the method 3000 may further include: recording, by the processing system, user interactions related to translation of values, as one of the one or more transactions, of the one or more aggregate assets from one of exchanges in the marketplace to another one of the exchanges in the marketplace; configuring, by the processing system, a robotic process automation (RPA) module to mimic the user interactions related to the translation of values of the one or more aggregate assets; and implementing, by the processing system, the RPA module 2608 to automatically translate a first value of a given aggregated asset represented in a first exchange into a second value of the given aggregated asset for representation in a second exchange.

In example embodiments, the method 3000 may further include: recording, by the processing system, user interactions related to generation of a token, as one of the one or more transactions, for the one or more aggregate assets as represented in one of the exchanges in the marketplace to be transferred to be representation in another one of the exchanges in the marketplace; configuring, by the processing system, a robotic process automation (RPA) module to mimic the user interactions related to the generation of a token for the one or more aggregate assets; and implementing, by the processing system, the RPA module 2608 to automatically generate a token for a given aggregated asset represented in a first exchange to transfer the given aggregated asset for representation in a second exchange.

In example embodiments, the method 3000 may further include: recording, by the processing system, user interactions related to generation of digital representations of a set of rights, as one of the one or more transactions, for the one or more aggregate assets in the marketplace based on at least one of a set of smart contracts and a set of terms and conditions related to the different aggregate assets; configuring, by the processing system, a robotic process automation (RPA) module to mimic the user interactions related to the generation of digital representations of a set of rights for the one or more aggregate assets; and implementing, by the processing system, the RPA module 2608 to automatically generate a digital representation of a set of rights for a given aggregate asset in the marketplace based on at least one of a set of smart contracts and a set of terms and conditions related thereto.

In example embodiments, the method 3000 may further include: recording, by the processing system, user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace; configuring, by the processing system, a robotic process automation (RPA) module to mimic the user interactions related to the orchestrating of a set of transaction workflows for the one or more aggregate assets; and implementing, by the processing system, the RPA module 2608 to automatically orchestrate a set of transaction workflows for a given aggregated asset by initiating a set of first actions in the at least one of the exchanges in response to triggering of a set of second actions in the at least one other exchange in the marketplace.

In example embodiments, the method 3000 may further include: recording, by the processing system, user interactions related to adjusting of timing of delivery, as one of the one or more transactions, for the one or more aggregate assets based on at least one of a transaction parameter and/or a network performance parameter in the marketplace; configuring, by the processing system, a robotic process automation (RPA) module to mimic the user interactions related to the adjusting of timing of delivery for the one or more aggregate assets; and implementing, by the processing system, the RPA module 2608 to automatically adjust timing of delivery for a given aggregated asset based on at least one of the transaction parameter and/or the network performance parameter in the marketplace.

In example embodiments, the method 3000 may further include: recording, by the processing system, user interactions related to determining of demand, as the at least one attribute, for the different items in the marketplace and to aggregating of the different items as the one or more aggregate assets in the marketplace in relation to the demand thereof; configuring, by the processing system, a robotic process automation (RPA) module to mimic the user interactions related to the determining of demand for the different items and the aggregating of the different items into the one or more aggregate assets; and implementing, by the processing system, the RPA module 2608 to automatically determine demand for a given item in the marketplace and to automatically aggregate one or more given items into one or more aggregate assets based on the automatically determined demands thereof in the marketplace.

In example embodiments, the method 3000 may further include: recording, by the processing system, user interactions related to curation of a set of micro-transactions for the one or more aggregate assets and processing of the curated set of micro-transactions as a single transaction for the one or more aggregate assets, as one of the one or more transactions, in the marketplace; configuring, by the processing system, a robotic process automation (RPA) module to mimic the user interactions related to the curation of the set of micro-transactions for the one or more aggregate assets and processing of the curated set of micro-transactions as the single transaction for the one or more aggregate assets; and implementing, by the processing system, the RPA module 2608 to automatically curate a set of micro-transactions for a given aggregated asset and process the automatically curated set of micro-transactions as a single transaction in the marketplace.

Value aggregation itself may present challenges, including time involved and complexity, which may be met by automating one or more aspects of the aggregation of value of microtransactions, such as by using a model that facilitates identification and curation of microtransaction aggregation opportunities, such as one that calculates and predicts the profitability of a set of microtransactions, in aggregate, based on a set of transaction parameters and based on current market conditions.

Various aspects of such a model may benefit from advanced data collection on current market conditions and transactions, as well as robotic process automation with respect to various aspects of design, operation, and iterative improvement of the model. Interactions with a value aggregation system may be automated.

In example embodiments, such a microtransaction value aggregation system may be complemented, augmented, improved, or the like, or may be replaced entirely, by a robotic process automation system, such as one that is trained on a set of training data (such as interactions of operators of the value aggregation system), to undertake automatically, without operator intervention, interactions with the value aggregation system, including parametrizing one or more models used by the system, setting weights of parameters, selecting from among recommendations, curating opportunities, selecting and/or setting up aggregation transactions, creating aggregate contract terms and conditions (including configuring, parameterizing, and/or deploying a set of smart contracts), and others. The robotic process automation system may be trained, over time, on outcomes, including in simulations and real-world deployments, to improve the value aggregation system itself and/or to improve its operation of the value aggregation system. In example embodiments, it may be trained to operate independent of the value aggregation system, such as to replace it.

In example embodiments, provided herein are computer-implemented methods and systems for automated orchestration of one or more marketplaces, such system 2900 and method 3000 having a robotic process automation system trained on a training set of expert interactions with a value aggregation system to aggregate a set of assets into an aggregate asset. As described herein, value aggregation itself may present challenges, including time involved and complexity, which may be met by automating one or more aspects of the aggregation of value of microtransactions, such as by using a model that may facilitate identification and curation of microtransaction aggregation opportunities, such as one that may calculate and predict the profitability of a set of microtransactions, in aggregate, based on a set of transaction parameters and based on current market conditions. As noted in the disclosure, various aspects of such a model may benefit from advanced data collection on current market conditions and transactions, as well as robotic process automation with respect to various aspects of design, operation, and iterative improvement of the model. In example embodiments, interactions with the value aggregation system may be automated. For example, a human operator may aggregate sets of transactions by discovering a set of similar transactions in the value aggregation system (such as ones involving similar attributes of timing, goods, consideration, geography, or the like), grouping the similar transactions, and generating a set of terms and conditions for an aggregated transaction that encompasses the microtransactions (including one that proposes changes to harmonize or normalize the transactions for aggregation, such as by proposing an amendment of terms and conditions to render the microtransactions suitable for aggregation). In example embodiments, such a microtransaction value aggregation system may be complemented, augmented, improved, or the like, or may be replaced entirely, by a robotic process automation system, such as one that may be trained on a set of training data (such as interactions of operators of the value aggregation system), to undertake automatically, without operator intervention, interactions with the value aggregation system, including parametrizing one or more models used by the system, setting weights of parameters, selecting from among recommendations, curating opportunities, selecting and/or setting up aggregation transactions, creating aggregate contract terms and conditions (including configuring, parameterizing and/or deploying a set of smart contracts), and others. The robotic process automation system may be trained, over time, on outcomes, including in simulations and real-world deployments, to improve the value aggregation system itself and/or to improve its operation of the value aggregation system. In example embodiments, it may be trained to operate independent of the value aggregation system, such as to replace it. Outcomes may include various measures of transaction success mentioned throughout this disclosure, including per-transaction profit, aggregate profit, and others. The model and/or robotic process automation system may use artificial intelligence systems as described throughout this disclosure and the documents incorporated herein by reference.

In example embodiments, such system 2900 and method 3000 are provided having a robotic process automation system trained on a training set of expert interactions with a value aggregation system to aggregate a set of assets into an aggregate asset and having an artificial intelligence system that may be configured to automatically orchestrate a transactional workflow within a transaction environment (e.g., a marketplace or a set of marketplaces). In example embodiments, such system 2900 and method 3000 are provided having a robotic process automation system that may be trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a unit of a physical product. In example embodiments, such system 2900 and method 3000 are provided having a robotic process automation system trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a digital twin of a physical item to which the offers relate. In example embodiments, such system 2900 and method 3000 are provided having a robotic process automation system trained on a training set of expert interactions with a value aggregation system to aggregate a set of assets into an aggregate asset and having a digital twin within which a set of interface elements may be presented by which a seller may orchestrate a set of offers related to the items represented in the digital twin. In example embodiments, such system 2900 and method 3000 are provided having a robotic process automation system trained on a training set of expert interactions with a value aggregation system to aggregate a set of assets into an aggregate asset and having a digital twin within which a set of interface elements may be presented by which a buyer may engage with a set of offers related to the items represented in the digital twin. In example embodiments, such system 2900 and method 3000 are provided having a robotic process automation system trained on a training set of expert interactions with a value aggregation system to aggregate a set of assets into an aggregate asset and having a set of robotic process automation services that may be configured to state the value of a set of items that may be represented in exchanges, such that representation of the value of each member of the set of items in the exchanges may be normalized based on the native currencies of the respective exchanges. In example embodiments, such system 2900 and method 3000 are provided having a robotic process automation system trained on a training set of expert interactions with a value aggregation system to aggregate a set of assets into an aggregate asset and having a set of robotic process automation services that may be configured to automatically translate the value of an item represented in a first exchange into a value of the item for representation in a second exchange. In example embodiments, such system 2900 and method 3000 may be provided having a robotic process automation system trained on a training set of expert interactions with a value aggregation system to aggregate a set of assets into an aggregate asset and having a set of robotic process automation services that may be configured to generate a token that represents an item in an exchange based on characteristics of the item determined from data from a different exchange. In example embodiments, such system 2900 and method 3000 may be provided having a robotic process automation system trained on a training set of expert interactions with a value aggregation system to aggregate a set of assets into an aggregate asset and having a set of robotic process automation services that may be configured to generate a digital representation of a set of rights relating to an item that may be consistent with the governing rules of an exchange based on processing at least one of a set of smart contracts and a set of terms and conditions relating to the item. In example embodiments, such system 2900 and method 3000 are provided having a robotic process automation system that may be trained on a training set of expert interactions with a value aggregation system to aggregate a set of assets into an aggregate asset and having a set of robotic process automation services that may be configured to orchestrate a set of transaction workflows in each of several exchanges, such that initiation of a set of actions in one exchange automatically results in the triggering of a set of actions in at least one other exchange. In example embodiments, such system 2900 and method 3000 are provided having a robotic process automation system trained on a training set of expert interactions with a value aggregation system to aggregate a set of assets into an aggregate asset and having a digital twin that represents a set of entities, workflows, and transaction parameters of exchanges, such that interaction with the interface of the digital twin may orchestrate an interaction in each of the exchanges. In example embodiments, such system 2900 and method 3000 are provided having a robotic process automation system trained on a training set of expert interactions with a value aggregation system to aggregate a set of assets into an aggregate asset and having a set of robotic process automation services that may be configured to inspect a set of smart contracts in each of the exchanges and to configure a smart contract that provides terms and conditions for a transaction that involves a transactional step in each of the exchanges. In example embodiments, such system 2900 and method 3000 are provided having a robotic process automation system trained on a training set of expert interactions with a value aggregation system to aggregate a set of assets into an aggregate asset and having a data and network infrastructure pipeline that may be configured to deliver data from a set of assets to an interface by which an operator orchestrates a set of parameters for a set of transaction workflows involving the assets, where the pipeline may be automatically configured to adjust a network path based on the characteristics of the data and at least one performance parameter of the network path. In example embodiments, such system 2900 and method 3000 are provided having a robotic process automation system trained on a training set of expert interactions with a value aggregation system to aggregate a set of assets into an aggregate asset and having a data and network infrastructure pipeline that may be configured to deliver data from a set of assets to a set of smart contracts that include terms, conditions, and parameters for a set of transaction workflows involving the assets, where the pipeline may be automatically configured to adjust a network path based on the characteristics of the data and at least one performance parameter of the network path. In example embodiments, such system 2900 and method 3000 are provided having a robotic process automation system trained on a training set of expert interactions with a value aggregation system to aggregate a set of assets into an aggregate asset and having a data and network infrastructure pipeline that may be configured to deliver data from a set of assets to an interface by which an operator orchestrates a set of parameters for a set of transaction workflows involving the assets, where the pipeline may be automatically configured to adjust timing of data delivery based on at least one of a transaction parameter and a network performance parameter. In example embodiments, such system 2900 and method 3000 are provided having a robotic process automation system trained on a training set of expert interactions with a value aggregation system to aggregate a set of assets into an aggregate asset and having a data and network infrastructure pipeline that may be configured to deliver data from a set of assets to a set of smart contracts that include terms, conditions, and parameters for a set of transaction workflows involving the assets, where the pipeline may be automatically configured to adjust timing of data delivery based on at least one of a transaction parameter and/or a network performance parameter. In example embodiments, such system 2900 and method 3000 are provided having a robotic process automation system trained on a training set of expert interactions with a value aggregation system to aggregate a set of assets into an aggregate asset and having a set of application programming interfaces to a transaction environment (e.g., a marketplace or a set of marketplaces) that may be configured to be integrated into an electronic wallet system, such that interactions with a set of interfaces of the wallet system may automatically trigger a set of transaction workflows within the marketplace. In example embodiments, such system 2900 and method 3000 are provided having a robotic process automation system trained on a training set of expert interactions with a value aggregation system to aggregate a set of assets into an aggregate asset and having a set of application programming interfaces to a marketplace that may be configured to be integrated into a digital twin platform, such that interactions with a set of interfaces of the digital twin platform may automatically trigger a set of transaction workflows within the marketplace. In example embodiments, such system 2900 and method 3000 are provided having a robotic process automation system trained on a training set of expert interactions with a value aggregation system to aggregate a set of assets into an aggregate asset and having a set of application programming interfaces to a marketplace that may be configured to be integrated into an enterprise database platform, such that interactions with a set of interfaces of the enterprise database platform may automatically trigger a set of transaction workflows within the marketplace. In example embodiments, such system 2900 and method 3000 are provided having a robotic process automation system trained on a training set of expert interactions with a value aggregation system to aggregate a set of assets into an aggregate asset and having a set of application programming interfaces to a marketplace that may be configured to be integrated into a platform-as-a-service platform, such that interactions with a set of interfaces of the platform-as-a-service platform may automatically trigger a set of transaction workflows within the marketplace. In example embodiments, such system 2900 and method 3000 are provided having a robotic process automation system trained on a training set of expert interactions with a value aggregation system to aggregate a set of assets into an aggregate asset and having a set of application programming interfaces to a marketplace that are configured to be integrated into a computer-aided design platform, such that interactions with a set of interfaces of the computer-aided design platform may automatically trigger a set of transaction workflows within the marketplace. In example embodiments, such system 2900 and method 3000 are provided having a robotic process automation system trained on a training set of expert interactions with a value aggregation system to aggregate a set of assets into an aggregate asset and having a set of application programming interfaces to a marketplace that may be configured to be integrated into a video game, such that interactions with a set of interfaces of the video game may automatically trigger a set of transaction workflows within the marketplace.

The market aggregation may find many real-world applications. For instance, one example may involve a renewable-powered electricity grid “volatility of energy supply” as a key issue. The grid control system may need to match a feed-in and consumption of electric power in real-time. The grid control system may have an urgent “physiological machine need” to access flexibilities such as batteries to store excess energy or request delivery of energy. In an example embodiment, algorithms aggregating flexibilities may sell their customer the grid control system, including access to and control an aggregated and validated portfolio of flexibilities. This service may optimize a reliable use of flexibilities via algorithms that may be charged and create revenue streams for the algorithms (e.g., self-owned algorithms that may include or utilize aggregation bots) including a small algorithmic profit.

In example embodiments, there may be a variety of market aggregation systems that utilize and/or include the following as described in the disclosure; Natural language-based intelligent agents (e.g., natural language processing (NLP), text-to-speech (TTS), speech-to-text (STT), etc.); Search engines (e.g., general search engines, crawlers, spiders, clustering engines, federated search engines, and the like); Crowdsourcing orchestration systems; Identity authentication engines (e.g., cryptographic, biometric, and the like); Smart contract orchestration engines; Recommendation engines (e.g., similarity/clustering, collaborative filtering, rule-based, hybrids, and the like); Robotic process automation systems; Digital twin systems (e.g., adaptive/dynamic); Data routing engines (e.g., context-based); Data processing engines (e.g., extract, transform, load (ETL), normalization, compression, and the like); Generative machine learning systems; AI systems (e.g., classification/tagging, prediction, optimization, control, deep learning, supervised/semi-supervised learning systems, machine learning (ML, and the like), robotic process automation (RPA)); Control systems (SCADA, remote control, autonomous, semi-autonomous, and the like); and/or decentralized autonomous organization (DAOs). These systems may be utilized for various examples as described in the disclosure when relevant functionality may be needed.

### Embedded Marketplace System

One path to retain vendors and customers in the long term for marketplaces includes adding new services. For example, such new services may be ancillary/supplementary value-added services. These value-added services have the potential to create “stickiness” with retention of both vendors and customers. Potential benefits include disincentivizing switching to a competitor, helping vendors with their operations, and creating new revenue streams for marketplace platforms.

For instance, embedding finance into a marketplace may be a great retention strategy for marketplaces. By integrating financial services into a vendor account or digital journey, the platform creates stickiness and attracts and retains the best suppliers by providing a superior experience. Therefore, the marketplace may gain a competitive advantage for hosting the best products and services, and may attract more customers.

Developing a successful embedded business solution, however, is full of challenges. These challenges go beyond the complex technology itself, and include the rigorous work of designing to specific functional and environmental requirements of a target application. This is especially true as a business may scale quickly and take on accepted industry practices with, for example, payment and credit terms. Highly regulated industries like healthcare, industrial automation, financial markets, and others require that the businesses conform to a wide variety of standards. For example, conforming to a wide variety of standards is not simple with respect to the safety standards of the medical industry, the regulatory requirements of the automation industry, or the risk-prone environments of the finance industry.

Business-to-Business (B2B) marketplaces are digital platforms where businesses offer their products or services to other businesses. They create “self-serve” and curated environments that allow companies to trade with other businesses they might not otherwise have connected with directly. Buyers get choice, value and greater efficiencies, while sellers ease the burden of marketing or logistics. They create a digital safe space for business e-commerce by making transactions simpler and more transparent.

Embedding financial services on the customer-side of a marketplace promotes increased demand and return customers which will attract even more suppliers and vendors to the platform. Embedding financial services on a vendor side of a marketplace may permit enhanced management of some of the most important aspects of a business consolidated into one place. This will also give marketplaces the opportunity to help vendors improve the financial well-being of their business, which will ultimately lead to happier end-customers, with pricing consistency, inventory management, budgeting and cashflow management, etc. Accordingly, the embedded platforms may benefit each of the platform, the vendor, and the customer.

Embedded procurement is an evolution of embedded finance. There are several reasons why it makes sense for businesses to procure their supplies through software; centralization and efficiency of using a single platform, price transparency, customization predicated on past order history, and access to negotiated price discounts. Beyond those advantages, a more subtle yet powerful benefit is in the synergy between embedded fintech and procurement. More broadly, if a software company knows the purchasing behavior of its customer, such as what, when, and how they buy, that information can and should inform its financial services offerings.

Financing decisions may be enhanced by analyzing a company's granular cash flows. Embedded procurement completes the circle; software platforms with embedded procurement may see not only incoming payments from customers, but also detailed outgoing payments to suppliers (who, for what, and when).

Marketplaces may match industry standard terms, such as 30 or even 90 day terms, to attract buyers in the first place. This results in complex management of buyer credit terms and payment collections, and requires taking on credit risk with large orders. Marketplaces get into danger if they try to make themselves more attractive to and retain the best businesses in the industry by paying earlier. This may leave them struggling to finely balance management of cash flow, liquidity and credit risk that can strangle growth.

Embodiments of the embedded marketplaces described herein embrace innovative payments solutions that provide a secure and intuitive way to checkout. Providing secure transactions for the seller and offering favorable payment terms to the buyer builds online trust for the embedded marketplaces. By embedding finance options such as paying later or with better credit terms within the checkout journey, marketplaces can match and beat other purchasing options offline. Embedded finance also permits buyers to avoid the hassle of managing credit or impacting their balance sheet themselves.

FIG. 31 provides an exemplary block diagram illustration of a system 3100 for augmenting of services in the marketplace 1900. The system 3100 comprises a processing system 3110. In embodiments, the processing system 3110 may be configured to generate a digital twin of the marketplace 1900, where the digital twin is a digital representation of a set of parties in the marketplace 1900 and a set of services available in the marketplace 1900. The processing system 3110 is further configured to monitor service transactions between the set of parties in the marketplace 1900. The processing system 3110 is further configured to analyze a nature of a current service transaction by a given party of the set of parties in the marketplace 1900 based on the monitoring. The processing system 3110 is further configured to determine, by implementing the digital twin, a supplementary service from the set of services related to the current service transaction suitable for the given party based on the nature of the current service transaction. The processing system 3110 is further configured to provide a recommendation for the supplementary service to the given party.

Embedded marketplaces and systems for embedded marketplaces provide more flexible and effective exchanges of value of assets across a wide range of environments and systems encountered by customers. Layers and suites of technologies enable services that serve as fully functional marketplaces, embedded and automatically orchestrated. Marketplaces exist everywhere in the world, both physically and digitally, yet embedded marketplaces may change the way those marketplaces operate, opening up new avenues of transaction within them and numerous more opportunities for exchanges where currently there are none. An embedded marketplace system allows for more automation and personalization within marketplaces, improving transaction experiences and market efficiency.

As a combination of technologies converge rapidly to automate the orchestration of marketplaces, they are becoming increasingly embedded within a wide range of environments and systems encountered by customers. Using layers of technologies and suites of enabling services, embedded marketplaces can serve both a wide range of stakeholders seeking to more effectively monetize assets and consumers looking for a more personalized, user-friendly shopping experience. In today's society, exchanging value, through sales or services, is pervasive. However, for most transactions to occur, a consumer needs to visit a transaction environment (e.g., a marketplace or a set of marketplaces), either in the real world or online, where a host relies on a wide range of technologies, human inputs, and third parties to orchestrate and enable the transaction. The embedded marketplaces described herein remove that necessity, opening up the possibility for new types of transactions and interactions between vendor and consumer.

One space that both benefits from and may contribute to the success of embedded marketplaces is virtual reality (VR). A virtual environment using a digital twin of a transaction environment (e.g., digital twin(s) of a marketplace or a set of marketplaces) may allow a user to walk around a store and select items without needing to go to a brick & mortar store. As online shopping increasingly displaces in-person shopping, many customers find themselves dealing with the drawbacks of digital transactions. For example, it may be almost impossible for consumers to know with complete confidence that a specific and singular article of clothing will fit them unless they try it on their own body directly. VR may change that by displaying rendered or precision representations of online shoppers trying on a digital version of the item they are purchasing. As VR and other nascent technologies become more sophisticated, this process may allow users to shop online with greater confidence than they ever could in person, where stores often do not carry all sizes or where there may be variation within a batch of supposedly same-sized articles of clothing. As artificial intelligence (AI) and data processing develops further, it is possible that a virtual marketplace may make suggestions for clothing based on the shopper's personal style, measurements, and perceived confidence level. For example, a virtual shopper, processing a single shopper's wardrobe and past fashion choices, may pick up on quirks in their styling preferences, such as a preference to cover knees and shoulders, or a tendency to purchase clothes that accentuate a certain feature or prioritize specific colors or color combinations. The virtual shopper can recommend items with these traits in mind, guided by AI. Additionally, the consumer may be able to log their outfits and note specific feedback or features for an individual item to inform future guidance. The virtual shopper can then determine how often the individual wears certain items, as compared to how often they purchase items like them. This addresses the most annoying aspect of the online shopping algorithm as it currently operates—it shows you more of what you already have, rather than what you might need or want. A virtual shopper may operate more intelligently than the algorithm in its current form, suggesting items that fit the consumer's taste rather than their shopping history. Thus, if a consumer already has three navy blue blazers that they never wear, the virtual shopper will stop recommending navy blue blazers.

In example embodiments, the processing system 3110 is further configured to: generate an artificial intelligence (AI) model (such as, the AI model 2606) trained on information about relationship between different services of the set of services available in the marketplace 1900; and implement the AI model 2606 to determine the supplementary service from the set of services related to the current service transaction suitable for the given party. In example embodiments, the supplementary service comprises at least one of: a guarantee service, an insurance service, a loan service, a discount service, a promotion service, a verification service, a validation service, a sponsorship service, a rewards service, a tax service, a fraud alert service, or a compliance service. In example embodiments, the supplementary service is a value-added service. In embodiments, the embedded marketplace populates sale data from known parameter or characteristics of items/data. In embodiments, the embedded marketplace posts offers. In embodiments, items including the embedded marketplace are geotagged. For example, during a drive through upstate New York, a digital wallet may include an embedded marketplace that looks for nearby antique stores or items in the antique stores that may be identified by another embedded marketplace.

In example embodiments, the one of the parties in the set of parties in the marketplace 1900 is a consumer comprising at least one of: a person, an enterprise, a machine, a real estate, a manufacturer, or an asset owner. In example embodiments, the one of the parties in the set of parties in the marketplace 1900 is a service provider comprising at least one of: a merchant, a payments provider, a guarantor, an identity manager (e.g., identity authentication engines), an insurer, a banker, a lender, a host, or a presenter. In example embodiments, the stakeholder interfaces to embedded marketplaces include Manufacturer API, Merchant API, Payments provider API, Insurer API, Guarantor API, Identity Manager API, Banker/Lender API, Service Provider API, Host API, Consumer API, Asset owner/operator API, and Presenter API for search, mobile app, ecommerce, mobile device, smart TV, manufacturer, and the like.

In example embodiments, the provided set of services in the marketplace 1900 is configurable by the service provider. Such cloud-deployed service sets/suites for embedded markets may enable the service provider to provide services including guarantee, insure, float/fund/lend, find party, find goods, find services, match needs, recommend, rate, verify/validate, price, promote/advertise, sponsor, reconcile, prevent fraud, identify, comply, pay taxes, rewind/unwind transaction (innovation category), aggregate, reward, validate, guide/inform, and the like.

In example embodiments, analyzing the nature of the current service transaction comprises estimating interconnectedness of other transaction services related to the current service transaction, and wherein the supplementary service is determined based on the estimated interconnectedness of other transaction services. In example embodiments, analyzing the nature of the current service transaction comprises estimating likeness of other transaction services, related to the current service transaction, by other parties of the set of parties in the marketplace 1900, and wherein the supplementary service is determined based on the estimated likeness of other transaction services.

In example embodiments, the marketplace 1900 is a virtual environment. In example embodiments, the embedded marketplace is decentralized/peer-to-peer. In example embodiments, the embedded marketplace relates to embedding a functioning marketplace in at least one of: a digital twin (in-twin marketplace), such as digital twin of a person, digital twin of a product, digital twin of an enterprise, digital twin of a machine, digital twin of real estate, digital twin of personal property; a virtual environment; a digital wallet; a product; a wearable product; infrastructure (IoT/edge/network); a database; and the like.

The present disclosure further provides a method for augmenting of services in the marketplace 1900. FIG. 32 provides an exemplary flowchart listing steps involved in a method 3200 for augmenting of services in the marketplace 1900. The various teachings of the system 3100 as described in the disclosure may apply mutatis mutandis to the present method 3200. At 3202, the method 3200 includes generating, by a processing system, a digital twin of the marketplace 1900, wherein the digital twin is a digital representation of a set of parties in the marketplace 1900 and a set of services available in the marketplace 1900. At 3204, the method 3200 includes monitoring, by the processing system, service transactions between the set of parties in the marketplace 1900. At 3206, the method 3200 includes analyzing, by the processing system, a nature of a current service transaction by a given party of the set of parties in the marketplace 1900 based on the monitoring. At 3208, the method 3200 includes determining, by the processing system, by implementing the digital twin, a supplementary service from the set of services related to the current service transaction suitable for the given party based on the nature of the current service transaction. At 3210, the method 3200 includes providing, by the processing system, a recommendation for the supplementary service to the given party.

In example embodiments, the method 3200 further comprises: generating, by the processing system, an artificial intelligence (AI) model trained on information about relationship between different services of the set of services available in the marketplace 1900; and implementing, by the processing system, the AI model 2606 to determine the supplementary service from the set of services related to the current service transaction suitable for the given party.

In example embodiments, the method 3200 further comprises the supplementary service comprises at least one of: a guarantee service, an insurance service, a loan service, a discount service, a promotion service, a verification service, a validation service, a sponsorship service, a rewards service, a tax service, a fraud alert service, or a compliance service.

In example embodiments, the method 3200 further comprises the supplementary service is a value-added service.

In example embodiments, the method 3200 further comprises the one of the parties in the set of parties in the marketplace 1900 is a consumer comprising at least one of: a person, an enterprise, a machine, a real estate, a manufacturer, or an asset owner.

In example embodiments, the method 3200 further comprises the one of the parties in the set of parties in the marketplace 1900 is a service provider comprising at least one of: a merchant, a payments provider, a guarantor, an identity manager, an insurer, a banker, a lender, a host, or a presenter.

In example embodiments, the method 3200 further comprises the provided set of services in the marketplace 1900 is configurable by the service provider.

In example embodiments, the method 3200 further comprises analyzing the nature of the current service transaction comprises estimating interconnectedness of other transaction services related to the current service transaction, and wherein the supplementary service is determined based on the estimated interconnectedness of other transaction services.

In example embodiments, the method 3200 further comprises analyzing the nature of the current service transaction comprises estimating likeness of other transaction services, related to the current service transaction, by other parties of the set of parties in the marketplace 1900, and wherein the supplementary service is determined based on the estimated likeness of other transaction services.

In example embodiments, the marketplace 1900 is a virtual environment. In embodiments, the embedded marketplace is decentralized/peer-to-peer.

Embedded marketplaces can likely be applied in many places where information is gathered about specific items or services. The information about the product/service is likely already gathered and may be entered automatically in the marketplace without user memory or entry errors. The extra steps of visiting a non-embedded marketplace are omitted. Thus, on an individualized level, embedded marketplaces may change the way online shopping operates. For example, if a social media user likes a sponsored post of a meal prepared by one of their favorite influencers, they may be able to purchase individual ingredients without having to click through the seller's online marketplace or track down a link to the item. If the influencer used a meal kit, the influencer would not have to tag the vendor for their followers to find where they purchased the item. Additionally, if the influencer used a specific recipe, an embedded marketplace system may be able to display or direct the user to the recipe, including a one-click purchase bundle of all the ingredients required for it. While this may seem small, the concept can be extended further to encapsulate increasingly complex algorithms of personalization. For instance, the influencer might only eat local to their area or use organic products out of the price range of most of their followers. Embedded marketplaces may provide options to purchase similar ingredients that effectively replace the ones used by the influencer. This would be beneficial in situations where the ingredients are out of season or stock—the embedded marketplace system may provide similar substitutes that would still capture the same flavor profiles. On an even more granular level, it is possible that the user could toggle their preferences if they have food restrictions. For example, if a user is gluten free, the embedded marketplace may supply a bundle of ingredients that includes gluten free substitutes for the recipe. The embedded marketplace system can use internal search engine optimization to find and show the customer a variety of items that fit the general essence they are trying to emulate at a range of price points.

A unique application for embedded marketplaces may be used in transactions that do not necessarily have concrete deliverables. Currently, many news outlets are struggling financially, in part due to the shift from physical to digital media. News outlets must make the difficult choice between raising subscription pricing or selling ad space, either of which can be easily disbalanced to drive away customers and decrease revenue just as much as they were trying to grow. A readership embedded marketplace may open up possibilities within the subscription model, allowing customers to purchase access to individual articles or even sections of articles that are relevant to their interests. An embedded marketplace may incorporate AI to see what topics are most relevant to a reader's interests, suggesting other articles that touch on those interests. This could help longer, and more niche articles get more attention-if a reader who frequently reads about specific topics in their local paper but not nationally, e.g., wildlife trends that would not impact them except locally, the reader would be pushed the information and would know that something that matters to them is coming towards the end of the article. This could cause the reader to be more likely to pay for that article and read the entire thing. This would also track the number of articles read in a single new site, allowing the AI to recommend a full subscription if it fits the user's reading habits. Potentially, the AI may then toggle the subscription on and off depending on whether the user continues to read articles from that new site. Thus, embedded marketplaces can be used in flexible ways, tailoring its design to the marketplace in which it is being embedded.

In embodiments, the readership embedded marketplace may apply to scholarly articles, such as thesis papers and journal articles. The offered articles may be further based on the characterization of the consumer, such as whether they are deeply interested in politics, religion, physics, botany, or other fields. For example, the readership embedded marketplace may offer access to journal articles about hydrodynamic scour during news segments in a media program discussing bridge collapses or levee breaches where the consumer is interested in physics. In some embodiments, the readership embedded marketplace may collect various free-to-read pieces of writing as a value-added service or for a fee. For example, a consumer may be presented with previous publicly available court decisions written by a specific judge where that consumer has shown an interest in politics/law and is using a platform that discusses that specific judge as a nominee for the Supreme Court of the United States.

The embedded marketplace may ultimately aggregate all information about a particular party to provide a “personal wallet” which is a wallet for everything of value, such as currencies including money, cryptocurrencies, points, tokens; property including personal property, real estate, digital goods and content, shareable property; influence including likeness, social network connections, followers; future value streams; capacities of “commodities” including compute, energy; time including attention, task completion like surveys/focus groups; expertise/insight including to train AI, to train others, to complete tasks; affinity/loyalty, personal data, and the like. The embedded marketplace may further provide an ultimate monetization platform and an ultimate sharing for the said elements in such personal wallet.

The embedded marketplace may be used for Market-to-Market integration for providing intelligent data collection from other markets, asset markets and exchanges, currency markets, fiat, crypto, other embedded markets, APIs to other markets, value conversion between markets, automated transaction configuration, execution and reconciliation in other markets, etc. The present disclosure further provide for orchestration of embedded marketplaces by providing APIs for all stakeholders, APIs for all services, context-based orchestration and configuration of service sets, counterparty matching and search by finding areas of mutual exchange, presentation layer, search and prioritization of available services, search and prioritization of available sources of value, configuration of transaction models including auctions, reverse auctions, selectable consideration including flexibly configured combinations of value as consideration (e.g., combination of time, influence, money and energy capacity), bid/auction for participation/presentation in which service providers bid to present services in wallet for transaction-specific/micro-services, and the like.

Referring to FIG. 33, an embedded marketplace system 3300 is illustrated. In the example provided, the embedded marketplace system 3300 is implemented as a software application or website. In embodiments, an embedded marketplace is an interface to a digital marketplace that is embedded in and presented by a device, application, or other user interface, wherein the interface allows a user or service to find, evaluate, generate, and/or execute transactions through the digital marketplace. More particularly, in embodiments, the embedded digital marketplace is in some way related to the device, application, or other user interface through which the digital marketplace is embedded and presented. For example, a digital marketplace may be embedded into an application, wherein goods and/or services available through the digital marketplace are related to the context, data, and/or features of the application. As another example, a digital marketplace may be embedded into a device, wherein goods and/or services available through the digital application are related to the context, data, and/or features of the device. In contrast with integrated advertisements that present information within an application, device, or other interface about digital goods and/or services within marketplaces that may be available elsewhere, embedded marketplaces also enable a user or service to interact with the marketplace through the device, application, or other user interface in which the digital marketplace is embedded. Such interactions may include one or more of: exploring goods and/or services available through the digital marketplace; generating, offering, initiating, and/or negotiating transactions involving goods and/or services available through the digital marketplace; and accepting, executing, and/or completing transactions involving goods and/or services available through the digital marketplace.

As a first example, a digital marketplace may be embedded within a vehicle. The digital marketplace may be presented to one or more occupants of the vehicle by a user interface within the vehicle, such as an audiovisual infotainment system built into a console of the vehicle, an audio system that plays audio for the occupants of the vehicle, a visual heads-up display presented on a windshield of the vehicle, or the like. The digital marketplace may be presented to the occupants by one or more output devices, such as speakers, one or more light-emitting diode (LED) displays and/or liquid crystal displays (LCDs), a holographic and/or persistence-of-vision (POV) display, a haptic output device such a buzzer, or the like. The digital marketplace may be presented using text, icons, images, video, sound effects, speech, music, tactile feedback, or the like. The embedded marketplace may receive input from one or more occupants of the vehicle via one or more input devices, such as buttons, switches, dials, touchpads, touch-sensitive resistive and/or capacitive displays, microphones, cameras, gesture sensors, or the like. The digital marketplace receive input as touch and/or stylus input, gestures, spoken keywords, natural-language input, physical controls integrated with the vehicle such as buttons or switches, data provided by a device associated with one or more occupants, or the like. The digital marketplace embedded in the vehicle may offer goods and/or services that are related to the vehicle. For example, the digital marketplace may offer goods and/or services related to the operation of the vehicle, such as goods and/or services related to mapping and/or routing; fuel or electric charging; consumable supplies, such as oil and windshield wipers; payments for toll roads and/or parking; diagnostic, repair, and/or maintenance services for the vehicle; upgrades to electronic, hardware, and/or software features of the vehicle; ornamental and/or functional accessories for the vehicle; or the like, including recommendations of any such goods and/or services. Alternatively or additionally, the digital marketplace may offer goods and/or services related to the occupants in relation to their occupancy of the vehicle, such as food or beverages; rest stops; supplies, such as personal items to be used one or more destinations of the vehicle, such as clothing; entertainment media for the journey, such as music, audiobooks, podcasts, movies, slideshows, games, e-books and/or e-zines, or the like; connectivity to a wide-area network, such as a mobile cellular network; social networking services, such as interactions with other individuals or computer-generated avatars; and/or health or medical services, including recommendations of any such goods and/or services. The digital marketplace may allow occupants and/or services to explore any such goods and/or services, and to generate, offer, initiate, negotiate, barter, accept, execute, and/or complete transactions related to any such goods and/or services in the context of the vehicle and the travel of the occupants in the vehicle. The digital marketplace may allow the occupants to search for such goods and/or services; request and receive additional information about such goods and/or services; request, offer, negotiate, and/or barter any such goods and/or services; and/or execute and/or complete transactions related to any such goods and/or services (e.g., remitting payment, executing a smart contract, transferring traditional currency and/or cryptocurrency as payment, arranging delivery and/or receipt, subscribing to and/or modifying a subscription of goods and/or services; trading rights to the goods and/or services, or the like). In these and other scenarios, a marketplace embedded in a vehicle application may facilitate the discovery, evaluation, negotiation, execution, and/or completion of transactions relating to the vehicle and/or the occupants of the vehicle relating to their journey within the vehicle.

As a second example, a digital marketplace may be embedded within a wearable media device of an individual, such as an extended reality (XR) headset, a pair of glasses, a pair of headphones, one or more earbuds, or the like. The digital marketplace may be presented to the individual by one or more output devices, such as speakers, one or more light-emitting diode (LED) displays and/or liquid crystal displays (LCDs), a holographic and/or persistence-of-vision (POV) display, a haptic output device such a buzzer, or the like. The digital marketplace may be presented using text, icons, images, video, sound effects, speech, music, tactile feedback, or the like. The embedded marketplace may receive input from one or more occupants of the vehicle via one or more input devices, such as buttons, switches, dials, touchpads, touch-sensitive resistive and/or capacitive displays, microphones, cameras, gesture sensors, or the like. The embedded marketplace may receive input from the individual via touch input, gestures, spoken keywords, natural-language input, physical controls integrated with the wearable media device such as buttons or switches, data provided by another device associated with the individual, or the like. The digital marketplace embedded within the wearable media device may offer goods and/or services that are related to the wearable media device. For example, the digital marketplace may offer entertainment media that may be presented by the wearable media device, such as music, audiobooks, podcasts, movies, slideshows, games, e-books and/or e-zines, or the like, including recommendations of any such goods and/or services. Alternatively or additionally, the digital marketplace may offer goods and/or services related to a context in which the individual uses the wearable media device. For example, for a wearable device including audio devices for exercising, the digital marketplace may offer exercise equipment; exercise apparel; exercise tracking; biometrics tracking, such as pulse, respiration rate, temperature, and/or pace; exercise guidance and/or coaching; physical therapy services; mapping and/or routing for running, cycling, or the like; consumable items or accessories, such as food, beverages, rain gear; weather monitoring related to exercise performed outdoors; exercise evaluation, ranking, and/or scoring; notifications of exercise-related events, such as competitions; or the like. As another example, for a wearable device such as a helmet including a display to be used during a game such as paintball, the digital marketplace may offer gaming equipment; game-related clothing, such as team jerseys or athletic gear; consumables, such as batteries or paintballs; game-related information, such as game history, rules, and/or strategies; game-instance-related information, such as tracking, scoring, or ranking; game performance and/or coaching; recordings of other sessions of the game; notifications of other instances of the game, such as games played by friends of the individual; or the like, including recommendations of any such goods and/or services. The digital marketplace may allow the occupants to search for such goods and/or services; request and receive additional information about such goods and/or services; request, offer, negotiate, and/or barter any such goods and/or services; and/or execute and/or complete transactions related to any such goods and/or services (e.g., remitting payment, executing a smart contract, transferring traditional currency and/or cryptocurrency as payment, arranging delivery and/or receipt, subscribing to and/or modifying a subscription of goods and/or services; trading rights to the goods and/or services, or the like). In these and other scenarios, a marketplace embedded in a wearable media device may facilitate the discovery, evaluation, negotiation, execution, and/or completion of transactions relating to the wearable media device by the user.

As a third example, a digital marketplace may be embedded within a device that is accessible to members of the public at a particular location, such as a kiosk in a public mall, travel rest stop, or public park. The digital marketplace may be presented to members of the public by one or more output devices, such as speakers, one or more light-emitting diode (LED) displays and/or liquid crystal displays (LCDs), a holographic and/or persistence-of-vision (POV) display, a haptic output device such a buzzer, or the like. The digital marketplace may be presented using text, icons, images, video, sound effects, speech, music, tactile feedback, or the like. The embedded marketplace may receive input from one or more members of the public via one or more input devices, such as buttons, switches, dials, touchpads, touch-sensitive resistive and/or capacitive displays, microphones, cameras, gesture sensors, or the like. The embedded marketplace may receive input from one or more members of the public via touch input, gestures, spoken keywords, natural-language input, physical controls integrated with the wearable media device such as buttons or switches, data provided by another device associated with the individual, or the like. The digital marketplace embedded within the wearable media device may offer goods and/or services that are related to a location and/or context of the device. For example, a kiosk in a public park may include an embedded marketplace that offers park-themed clothing; clothing that is suitable for a current and/or future weather condition of the public park; consumables such as food, beverages, sunblock lotion, and/or insect repellent; equipment usable at the park, such as sunglasses, binoculars, towels, picnic equipment, leisure equipment, and/or camping equipment; notifications of locations and/or items of interest in the local park and/or events associated with the public park; mapping, routing, and/or tour information related to the public park; or the like, including recommendations of any such goods and/or services. The digital marketplace may allow the members of the public to search for such goods and/or services; request and receive additional information about such goods and/or services; request, offer, negotiate, and/or barter any such goods and/or services; and/or execute and/or complete transactions related to any such goods and/or services (e.g., remitting payment, executing a smart contract, transferring traditional currency and/or cryptocurrency as payment, arranging delivery and/or receipt, subscribing to and/or modifying a subscription of goods and/or services; trading rights to the goods and/or services, or the like). In these and other scenarios, a marketplace embedded in the kiosk at the public location may facilitate the discovery, evaluation, negotiation, execution, and/or completion of transactions relating to the public location by members of the public.

As a fourth example, a digital marketplace may be embedded within an application that is presented by a device of a user. The digital marketplace may be embedded within one or more audio and/or visual components of the application, such as a user control such as a button, a region of a display such as a window or a pane, a portion of a user menu, a display dialog within a series of display dialogs, a period of time within a dynamic graphical display such as a video, a period of time within an audio presentation such as a period between two tracks of an album or playlist, an area of a two- and/or three-dimensional environment included in the display, or the like. The digital marketplace may be presented using text, icons, images, video, sound effects, speech, music, tactile feedback, or the like. The embedded marketplace may receive input from the user via one or more input devices, such as buttons, switches, dials, touchpads, touch-sensitive resistive and/or capacitive displays, microphones, cameras, gesture sensors, or the like. The embedded marketplace may receive input from the user via touch input, gestures, spoken keywords, natural-language input, physical controls integrated with the wearable media device such as buttons or switches, data provided by another device associated with the individual, or the like. The digital marketplace embedded within the application may offer goods and/or services that are related to the application.

As a first such example, for a calendar application, the digital marketplace may offer clothing that is suitable for an event on the calendar; consumables related to an event on the calendar (e.g., food or beverages to be consumed before, during, and/or after an event); information related to an event on the calendar (e.g., comments, reviews, and/or recordings by other individuals while attending the event); social networking related to an event on the calendar (e.g., connecting a user who is attending an event with other individuals who are attending the event); and/or notifications of activity that the user may wish to perform during an idle period on the calendar, including recommendations of any such goods and/or services. As another example, for a media editing application, the embedded marketplace may offer stock content that be included in edited media (e.g., stock images, video, sound effects, music, speech such as narration, text, emoji, and/or stickers); content that may be generated for edited media (e.g., AI-generated images, video, sound effects, music, speech such as narration, text, emoji, and/or stickers); media editing services (e.g., photo and/or video manipulation, optimization, or arrangement); media review services (e.g., media evaluation and/or guidance on recording and/or editing, such as photography classes); mashup services (e.g., determination of other media that could be remixed with the edited content); or the like, including recommendations of any such goods and/or services. The digital marketplace may allow the user to search for such goods and/or services; request and receive additional information about such goods and/or services; request, offer, negotiate, and/or barter any such goods and/or services; and/or execute and/or complete transactions related to any such goods and/or services (e.g., remitting payment, executing a smart contract, transferring traditional currency and/or cryptocurrency as payment, arranging delivery and/or receipt, subscribing to and/or modifying a subscription of goods and/or services; trading rights to the goods and/or services, or the like). In these and other scenarios, a marketplace embedded in a calendar application may facilitate the discovery, evaluation, negotiation, execution, and/or completion of transactions relating to the events indicated within the calendar application.

As a second such example, for a messaging application, the digital marketplace may offer a gift that is suitable for a birthday discussed in messages of the messaging application; a restaurant reservation for a meeting discussed in messages of the messaging application; or an accessory for a product discussed in messages of the messaging application. If the messages of the messaging relate to a good or service used by one member of a conversation, the embedded marketplace may offer to execute transactions for the good or service for other members of the conversation. If the messages of the messaging application relate to a problem that affects a member of a conversation, the embedded marketplace may offer to execute transactions for the good or service to the member that may address the problem. If the members of a conversation are discussing a transaction (e.g., a sale of a good or service from a first member of a conversation to a second member of the conversation), the embedded marketplace may offer to execute a transaction to formalize the transaction (e.g., generating, negotiating, and/or executing a smart contract that addresses the transaction, and/or arranging a transfer of cryptocurrency on a blockchain between members of the conversation). If at least two members of a conversation are discussing a joint and/or shared purchase of a good and/or service, the embedded marketplace may offer to execute a joint and/or shared transaction for the good and/or service on behalf of the at least two members (e.g., executing transfers of cryptocurrency from each of the at least two members into an escrow account, and/or executing the transaction for the good and/or service once the escrow account is fully funded). In these and other scenarios, a marketplace embedded in a messaging application may facilitate the discovery, evaluation, negotiation, execution, and/or completion of transactions relating to conversations arising within the conversations of the messaging application.

As shown in FIG. 33, the marketplace system 3300 includes a marketplace host 3301, an embedded marketplace 3304, an embedded data link 3305, and an external application 3306.

The marketplace host 3301 includes user data 3310, host content data 3312, and other host data 3314. For example, the user data 3310 may be any user data collected or used by the marketplace host 3301 in the course of operations, the host content data 3312 may be operation content data used for operations of the marketplace host, and the other host data 3314 may be other data used in the course of operating the marketplace host 3301. In the example provided, the marketplace host 3301 is any application, entity, or system that does not conventionally offer marketplace services associated with the type of marketplace of the embedded marketplace 3304.

The embedded marketplace 3304 is a marketplace that offers marketplace services that are not conventionally offered by the marketplace host 3301. For example, the embedded marketplace 3304 may offer purchases and/or sales of goods or services that are expedient for users of the marketplace host 3301 but are not part of the core business or conventional offerings of the marketplace host 3301. In the example provided, the embedded marketplace 3304 includes data about entities 3320 and relationship types 3322. For example, data for entities 3320 may include data for buyers 3330, sellers 3332, lenders 3334, regulators 3336, advisors 3338, appraisers 3340, or other entities 3342. Data for relationship types 3322 may include purchase and sale 3350, regulatory 3352, lending 3354, insuring 3356, rating 3358, or other 3360. The goods and services provided by the embedded marketplace 3304 may be at least partially virtual and/or digital, e.g., existing on a device, in the cloud, on the Internet, or the like. The goods and services provided by the embedded marketplace mB04 may be at least partially physical, e.g., associated with a real-world person, organism, object, physical device such as a machine, in-person gathering, piece of land, or the like. The goods and services provided by the embedded marketplace 3304 may include “in real life” services (including live events ticketing, travel related services (e.g., hotel stays, tickets, car rentals, etc.), professional services, skilled labor services (e.g., HVAC services, plumbing services, construction services, etc.), and/or the like. The goods and services may include a good or service that is both physical and digital/virtual (e.g., relating to a real-world, in-person gathering having an online component, or a real-world, physical object having a corresponding digital representation in a virtual environment).

The embedded marketplace 3304 may be presented to a user on one or more devices, e.g., as a graphical, textual, audial, or other representation. In embodiments, a device includes a display (e.g., an LCD or LED display) that presents, to a user, a visual representation of the embedded marketplace 3304, e.g., a browsable set of goods and/or services. The device includes input devices that receive input commands from the user corresponding to operations within the embedded marketplace 3304, e.g., searching for a good or service, exploring information about a good or service, purchasing a good or service, and/or consuming a purchased good or service.

The embedded data link 3305 offers a data path for communication between the marketplace host 3301 and the embedded marketplace 3304. For example, the embedded data link 3305 may be a shared digital storage space, an addressed routing path, or other types of data links for sharing data between the marketplace host 3301 and the embedded marketplace 3304.

The external application 3306 is not part of the marketplace host 3301. For example, the external application 3306 may be an application, interface, or particular location at which marketplace services of the type offered by the embedded marketplace 3304 are conventionally offered.

As shown in FIG. 34, in embodiments, an embedded marketplace platform 1950 includes a set of components that connect an enterprise 1902 with one or more marketplaces 1900. The enterprise 1902 may comprise, for example, one or more national, regional, and/or local governments; government organizations, such as committees or task forces; professional, residential, academic, social, ethnic, and/or special-interest communities; for-profit and/or nonprofit companies; organizations such as schools; social groups, households, or the like. In some embodiments, the embedded marketplace platform 1950 may serve two or more enterprises 1902. The two or more enterprises may be of a same or similar type (e.g., enterprises 1902 that are associated with a particular class of goods and/or services) and/or a different type (e.g., enterprises 1902 that are associated with different classes of goods and/or services). In embodiments, the embedded marketplace platform 1950 may share information across two or more enterprises 1902 served by the embedded marketplace platform 1950. In embodiments, the embedded marketplace platform 1950 may partition information across served enterprises 1902, such that information associated with a first enterprise 1902 served by the embedded marketplace platform 1950 is withheld from a second enterprise 1902 served by the embedded marketplace platform 1950, and, optionally, vice versa.

As shown, the enterprise 1902 includes one or more users 3416, such as (without limitation) officers, employees, agents, associates, clients, customers, contractors, vendors, or the like, including groups thereof. As shown, the enterprise 1902 includes one or more client devices 3414, such as (without limitation) workstations, servers, tablets, mobile devices such as phones, wearable devices such as headsets or watches, kiosks, or the like. As shown, each client device 3414 may include one or more applications 3415, such as (without limitation) one or more productivity applications, one or more interactive applications such as media players, one or more user interfaces, one or more gaming interfaces, one or more control systems, or the like. The users 3416 of the enterprise 1902 may endeavor to access the one or more marketplaces 1900 via the one more enterprise devices, optionally via one or more applications 3415 provided by such client devices 3414. As shown, the enterprise 1902 includes one or more enterprise resources 1906, such as (without limitation) sources of funds, budgets, projects, equipment such as vehicles, buildings, inventories, supply chains, workflows, storage capacity, or the like. The enterprise 1902 may include additional components that connect with the embedded marketplace platform 1950, such as any of the components shown in FIG. 33 (e.g.: one or more digital twins 2602; one or more AI models 2606; and/or one or more RPA modules 2608, and one or more enterprise access layers 1920, including one or more workflow systems 1922, one or more interface systems 1924, one or more data services systems 1926, one or more intelligence systems 1928, one or more permissions systems 1930, one or more wallets systems 1932, and/or one or more reporting systems 1934).

In embodiments, the embedded marketplace platform 1950 connects with one or more marketplaces 1900 via one or more marketplace interfaces 3412. The marketplaces 1900 with which the embedded marketplace platform 1950 communicates may be associated with a same or similar class of goods and/or services, or with different classes of goods and/or services. The marketplaces 1900 with which the embedded marketplace platform 1950 communicates may be associated with a shared group of one or more marketplace participants 1940, or with distinct groups of marketplace participants 1940. In embodiments, the embedded marketplace platform 1950 may share information across marketplaces 1900 with which the embedded marketplace platform 1950 communicates. In embodiments, the embedded marketplace platform 1950 may partition information across marketplaces 1900 with which the embedded marketplace platform 1950 communicates, such that information associated with a first marketplaces 1900 with which the embedded marketplace platform 1950 communicates is withheld from a second marketplace 1900 with which the embedded marketplace platform 1950 communicates, and, optionally, vice versa.

The marketplaces 1900 with which the embedded marketplace platform 1950 communicates may include one or more third-party marketplaces 1900 that are embedded in other contexts, such as other devices, locations, and/or enterprises. For example, a particular marketplace 1900 may typically be embedded and/or presented in a first context, such as a native device and/or a native application. The embedded marketplace platform 1950 may receive at least a portion of the third-party marketplace 1900 and embed it in a different context, such as a different device and/or different application. In performing such embedding, the embedded marketplace platform 1950 may adjust the third-party marketplace 1900, e.g., by filtering, aggregating, and/or adapting the presentation to suit the different device and/or different application in which the third-party marketplace 1900 is embedded. For example, a personal media device, such as a portable music player, may be configured to present a media marketplace through which a user of the personal media device can discover, purchase, and/or consume media on the personal media device. The embedded marketplace platform 1950 may receive at least a portion of the media marketplace and cause it to be embedded in a different device, such as an infotainment system of a vehicle, so that occupants of the vehicle can also discover, purchase, and/or consume media on the infotainment system of the vehicle. In performing such embedding, the embedded marketplace platform 1950 may select only a portion of the media marketplace 1900 (e.g., limiting the embedded marketplace 1900 to media that may be safely presented by the infotainment system of the vehicle); may aggregate at least a portion of the media marketplace 1900 with one or more other marketplaces 1900 (e.g., presenting an aggregated marketplace including both media available through the media marketplace 1900 and media from other marketplaces 1900); and/or adapt the media marketplace 1900 for embedding in the infotainment system (e.g., instead of showing text-based titles and/or descriptions of available media as presented by the personal media device, the infotainment system may use synthesized speech to read the titles and/or descriptions for a driver of the vehicle).

The marketplace interface 3412 for any marketplace 1900 may include one or more of: one or more web servers and/or web pages; one or more web services, protocols, application programming interfaces (APIs), software development kits (SDKs), or the like. For example, a marketplace 1900 may provide an API for accessing the marketplace to perform operations through the marketplace 1900, such as discovering, evaluating, negotiating, executing, and/or completing transactions related to goods or services that are available through the marketplace 1900. The API can define, for example, a set of hypertext transport protocol (HTTP/HTTPS) calls with various HTTP request methods (e.g., GET, HEAD, POST, PUT, DELETE, PATCH, and the like), optionally including an authentication token that identifies at least one party associated with the requests and/or a session token that identifies a session to which each request belongs. A webserver associated with the marketplace 1900 may receive an HTTP request specified by the API, verify its integrity (e.g., validating the authentication token and/or retrieving session information associated with a session token), perform one or more operations through the marketplace 1900 according to the token, log results of the one or more operations, and report the results of the operations to the initiator of the HTTP request. Alternatively or additionally, the marketplace 1900 may provide a software development kit (SDK) by which a developer may create one or more applications 3415 that interact with the marketplace 1900. For example, an SDK may include a client-side library that may be deployed to a workstation, mobile device, webserver, or the like. A developer may design and implement an application 3415 that utilizes the client-side library to perform one or more operations through the marketplace 1900, log results of the one or more operations, and report the results of the operations to a user of the application 3415. An API and/or SDK associated with a marketplace 1900 may include executable, compilable, and/or interpretable code; data objects, such as files and/or databases; documentation; user interfaces; images; or the like. In some embodiments, an SDK may perform operations through the marketplace 1900 by issuing HTTP requests through an API of the marketplace 1900. In some embodiments, an embedded marketplace platform 1950 may communicate with one or more marketplaces 1900 through one or more APIs. In some embodiments, an embedded marketplace platform 1950 communicates with two or more marketplaces 1900 through a shared API and/or shared SDK. In some embodiments, an embedded marketplace platform 1950 communicates with each of two or more marketplaces 1900 through respective marketplace-specific APIs and/or respective marketplace-specific SDKs. In some embodiments, an embedded marketplace platform 1950 incorporates an API and/or SDK into a client device (e.g., a personal mobile device of a user), and, optionally, in different applications 3415 for different client devices. In some embodiments, an embedded marketplace platform 1950 incorporates an API and/or SDK into a server-side application (e.g., an automated purchasing agent that maintains inventory supplies by automatically executing purchases of goods and/or services through one or more marketplaces 1900).

As shown, the embedded marketplace platform 1950 connects with one or more marketplace participants 1940 via one or more participant interfaces 3411. The marketplace participants 1940 may include (without limitation) original equipment manufacturers (OEMs), vendors, contractors, service providers, brokers, advertisers, transporters, end users, clients, customers, beneficiaries, regulators, market regulators, market advisors, organizations, or the like. The marketplace participants 1940 may include one or more processes, workflows, automated agents, or the like, which may be operating on behalf of one or more vendors, service providers, brokers, advertisers, or the like. The participant interface 3411 for any marketplace participant 1940 may include one or more of: messaging (e.g., email or text messages); session-based communication channels (e.g., phone calls, video calls, and/or text messaging systems); one or more communication protocols (e.g., data communication with a service associated with the market participant 1940); or the like. The marketplace participants 1940 with which the embedded marketplace platform 1950 communicates may be associated with a same or similar class of goods and/or services, or with different classes of goods and/or services. The marketplace participants 1940 with which the embedded marketplace platform 1950 communicates may be associated with a shared group of one or more marketplaces 1900, or with distinct groups of marketplaces 1900. In embodiments, the embedded marketplace platform 1950 may share information across marketplace participants 1940 with which the embedded marketplace platform 1950 communicates. In embodiments, the embedded marketplace platform 1950 may partition information across marketplace participants 1940 with which the embedded marketplace platform 1950 communicates, such that information associated with a first marketplace participant 1940 with which the embedded marketplace platform 1950 communicates is withheld from a second marketplace participant 1940 with which the embedded marketplace platform 1950 communicates, and, optionally, vice versa.

As shown, the embedded marketplace platform 1950 connects the enterprise 1902 with one or more blockchains 2604 via one or more blockchain interfaces 3413. The blockchain interface 3413 for any blockchain 2604 may include one or more of: one or more web servers and/or web pages; one or more web services, protocols, application programming interfaces (APIs), software development kits (SDKs), one or more intermediaries such as a broker or bank, or the like. The blockchains 2604 with which the embedded marketplace platform 1950 communicates may be associated with a same or similar class of goods and/or services, or with different classes of goods and/or services. The blockchains 2604 with which the embedded marketplace platform 1950 communicates may be associated with a shared group of one or more marketplaces 1900 and/or marketplace participants 1940, or with distinct groups of marketplaces 1900 and/or marketplace participants 1940. In embodiments, the embedded marketplace platform 1950 may share information across blockchains 2604 with which the embedded marketplace platform 1950 communicates. In embodiments, the embedded marketplace platform 1950 may partition information across blockchains 2604 with which the embedded marketplace platform 1950 communicates, such that information associated with a first blockchain 2604 with which the embedded marketplace platform 1950 communicates is withheld from a second blockchain 2604 with which the embedded marketplace platform 1950 communicates, and, optionally, vice versa.

The embedded marketplace platform 1950 connects the one or more client devices 3414, users 3416, and/or enterprise resources 1906 with the one or more marketplaces 1900, marketplace participants 1940, and/or blockchains 2604. In embodiments, the embedded marketplace platform permits the one or more users 3416 and/or client devices 3414 to interact with the one or more marketplaces 1900 search for goods and/or services related to and/or on behalf of the enterprise 1902; request and receive additional information about goods and/or services related to and/or on behalf of the enterprise 1902; request, offer, negotiate, and/or barter any such goods and/or services; and/or execute and/or complete transactions related to goods and/or services related to and/or on behalf of the enterprise 1902. For example (without limitation), the embedded marketplace platform 1950 may permit the one or more users 3416 and/or client devices 3414 to acquire, offer to acquire, and/or publicize an interest in acquiring various goods and/or services for the enterprise 1902, such as manufacturing materials, processing equipment and/or supplies, assembly supplies and/or services, delivery supplies and/or services, machines, tools, electronic devices such as computers, digital services such as software, vehicles, land, buildings, energy, storage and/or transportation capacity, or the like. For example (without limitation), the embedded marketplace platform 1950 may permit the one or more users 3416 and/or client devices 3414 to sell, offer to sell, and/or publicize an interest in selling goods and/or services of the enterprise 1902, manufacturing materials, processing equipment and/or supplies, assembly supplies and/or services, delivery supplies and/or services, machines, tools, electronic devices such as computers, digital services such as software, vehicles, land, buildings, energy, storage and/or transportation capacity, or the like.

As shown, the embedded marketplace platform 1950 includes a set of modules. In some embodiments, the embedded marketplace platform 1950 includes one of each of the one or more modules shown in FIG. 34. In other embodiments, the embedded marketplace platform 1950 includes two or more of at least one of the modules shown in FIG. 34, wherein the two or more modules may operate in parallel (e.g., each providing an instance of a particular function) and/or in series (e.g., a first module may perform a first portion of a particular function, and a second module may perform a second portion of the particular function based on the performance of the first portion by the first module). In embodiments, two or more modules may operate in coordination and/or in tandem (e.g., communicating and/or exchanging data associated with various portions of a task) and/or independently (e.g., a first module performing a task independently of the operation of a second component). In some embodiments, two or more of the modules shown in FIG. 34 may be merged into one module. In some embodiments, one or more of the module may be respectively presented as two or more modules, each performing at least a portion of the functionality attributed to one module in FIG. 34. In some embodiments, one or more modules shown in FIG. 34 may be omitted. In some embodiments, two or more modules of the embedded marketplace platform 1950 may communicate directly, e.g., through a direct exchange of data, a shared protocol, or the like. In some embodiments, two or more modules of the embedded marketplace platform 1950 may communicate indirectly, e.g., through an application programming interface (API), software development kit (SDK), library, protocol, agent, or the like. In some embodiments, two or more modules of the embedded marketplace platform 1950 may communicate through an intermediary, such as a third module of the embedded marketplace platform 1950 or through another device such as another server.

In some embodiments, one or more devices may include all or at least some of the modules shown in FIG. 34 (e.g., a server may include all of the components of the embedded marketplace platform 1950). In some embodiments, one or more devices may include only a portion of the modules shown in FIG. 34 (e.g., a first server may include some of the components of the embedded marketplace platform 1950, and a second server, interoperating with the first server, may include the remaining components of the embedded marketplace platform 1950). In some embodiments, a first server including one or more components of the embedded marketplace platform 1950 may serve as a backup, adjunct, supervisor, subordinate, watchdog, server, client, or the like, for a second server that also includes one or more components of the embedded marketplace platform 1950.

In embodiments, the embedded marketplace platform 1950 includes a marketplace communication module 3401. The marketplace communication module 3401 communicates with one or more marketplaces 1900, one or more marketplace participants 1940, and/or one or more blockchains 2604 on behalf of the embedded marketplace platform 1950. For example, the marketplace communication module 3401 may communicate with a marketplace 1900 through an application programming interface (API), software development kit (SDK), library, protocol, agent, or the like. The marketplace communication module 3401 may communicate with a marketplace 1900 through a web discovery service or process, such as a web spider, crawler, and/or scraper process. The marketplace communication module 3401 may communicate with a marketplace 1900 to receive various details about goods and/or services that are available through the marketplace 1900, including (without limitation) images, video, text descriptions, reviews, and/or metadata such as good and/or service details, physical attributes such as dimensions and/or colors, availability, supply, demand, pricing, scores, delivery options, or the like. The marketplace communication module 3401 may communicate with a marketplace 1900 on a periodic basis (e.g., requesting, receiving, evaluating, indexing, comparing, and/or updating information about the goods and/or services provided by the marketplace 1900 once per minute, hour, or day). Alternatively or additionally, the marketplace communication module 3401 may communicate with a marketplace 1900 on a just-in-time basis (e.g., in response to a request by a user 3416 regarding a particular good and/or service that may be available through a marketplace 1900). In embodiments, the embedded marketplace platform 1950 may communicate with a plurality of marketplaces 1900, such as a first marketplace 1900 providing a first set of goods and/or services and a second marketplace 1900 providing a second set of goods and/or services. In embodiments, the embedded marketplace platform 1950 may communicate with each of two or more marketplaces 1900 through a same or similar mechanism (e.g., through a common API) or through different mechanisms (e.g., a first API usable with a first marketplace 1900 and a second API usable with a second marketplace 1900).

In embodiments, the embedded marketplace platform 1950 communicates with one or more marketplace participants 1940 (e.g., original equipment manufacturers (OEMs), vendors, contractors, service providers, brokers, or the like) via one the one or more participant interfaces 3411. For example, the embedded marketplace platform 1950 may generate and transmit various forms of text messages, such as email, simple message service (SMS) messaging, printed letters, or the like; various forms of audio messages, such as recorded speech or synthesized voice; and/or various forms of data (e.g., notifications sent to a server or device associated with a market participant 1940). The embedded marketplace platform 1950 may communicate with two or more marketplace participants 1940 in a same or similar manner (e.g., one email message or SMS broadcast to two or more marketplace participants 1940, and/or one email message or SMS sent individually to each of two or more marketplace participants 1940). The embedded marketplace platform 1950 may communicate with two or more marketplace participants 1940 in a different manner (e.g., an email message sent to a first market participant 1940 and a simple message service (SMS) message sent to a second market participant 1940). The marketplace communication module 3401 may communicate with a marketplace participant 1940 on a periodic basis (e.g., requesting, receiving, evaluating, indexing, comparing, and/or updating information about the goods and/or services provided by a marketplace participant 1940 once per minute, hour, or day). Alternatively or additionally, the marketplace communication module 3401 may communicate with a marketplace 1900 on a just-in-time basis (e.g., in response to a request by a user 3416 regarding a particular good and/or service that may be available through a marketplace participant 1940).

In embodiments, the embedded marketplace platform 1950 communicates with one or more blockchains 2604 via one or more blockchain interfaces 3413. In embodiments, a blockchain interface 3413 for a blockchain 2604 may include one or more one or more web services, protocols, application programming interfaces (APIs), software development kits (SDKs), or the like, or a server or device implementing any such interface. The embedded marketplace platform 1950 may communicate with two or more blockchains 2604 in a same or similar manner (e.g., using one API to communicate with two blockchains 2604). The embedded marketplace platform 1950 may communicate with two or more blockchains 2604 in a different manner (e.g., using a first API to communicate with a first blockchains 2604 and a second API to communicate with a second blockchain 2604). The marketplace communication module 3401 may communicate with a blockchain 2604 on a periodic basis (e.g., requesting, receiving, evaluating, indexing, comparing, and/or updating information about transactions for goods and/or services available through the blockchain 2604 once per minute, hour, or day). Alternatively or additionally, the marketplace communication module 3401 may communicate with a blockchain 2604 on a just-in-time basis (e.g., in response to a request by a user 3416 regarding a transaction for a particular good and/or service that may be available through the blockchain 2604).

In embodiments, the embedded marketplace platform 1950 includes a marketplace storage module 3402. The marketplace storage module 3402 stores a representation of each of one or more marketplaces 1900, marketplace participants 1940, and/or blockchains 2604. For example, the marketplace storage module 3402 may store an index of goods and/or services that are available through each of one or more marketplaces 1900. The marketplace storage module 3402 may store an index of marketplace participants 1940 that are associated with various marketplaces 1900 and/or various goods and/or services that are available through each of one or more marketplaces 1900. The marketplace storage module 3402 may store an index of blockchains 2604 that are associated with each of one or more marketplaces 1900 and/or one or more marketplace participants 1940. The marketplace storage module 3402 may store at least a portion of a representation of a marketplace 1900 in volatile storage (e.g., system memory of a device) and/or nonvolatile storage (e.g., a solid-state storage device (SSD), hard disk drive, or the like). The marketplace storage module 3402 may store data in various formats, such as files, databases, spreadsheets, structured data objects such as an Extensible Markup Language (XML) and/or JavaScript Object Notation (JSON) document, software objects, declarative statements, processor-executable instructions, or the like. The marketplace storage module 3402 may store representations of marketplaces in a distributed manner, e.g., in a database provided by one or more database servers on behalf of a collection of client devices 3414. The marketplace storage module 3402 may store representations of marketplaces in a distributed manner over a set of devices, optionally including one or more of the client devices 3414. The marketplace storage module 3402 may synchronize data between and/or among one or more marketplaces 1900, one or more marketplace participants 1940, one or more blockchains 2604, one or more client devices 3414, one or more users 3416 of the enterprise 1902, and/or one or more enterprise resources 1906. Such synchronization may be performed periodically (e.g., once per minute, hour, or day) and/or on a just-in-time basis (e.g., upon detecting a change or update to a marketplace 1900). The embedded marketplace platform may alter a distribution and/or synchronization of representations of one or more marketplaces 1900 over a set of devices (e.g., storing a first portion of marketplace data on a first client device 3414 that is relevant to a context and/or application 3415 of the first client device 3414, and storing a second portion of marketplace data on a second client device 3414 that is relevant to a context and/or application 3415 of the second client device 3414).

In embodiments, the embedded marketplace platform 1950 includes a marketplace transaction log module 3403. The marketplace transaction log module 3403 may store transaction that have been explored, initiated, generated, offered, negotiated, bartered, accepted, executed, and/or completed in association with one or more marketplaces 1900, marketplace participants 1940, and/or blockchains 2604. For example, the marketplace transaction log module 3403 may store representations of purchases, sales, exchanges, or the like of goods and/or services by the enterprise 1902 through one or more marketplaces 1900. The marketplace transaction log module 3403 may store representations of purchases, sales, exchanges, or the like of goods and/or services by the enterprise 1902 through one or more marketplace participants 1940. The marketplace transaction log module 3403 may store representations of purchases, sales, exchanges, or the like of goods and/or services by the enterprise 1902 through one or more blockchains 2604. The marketplace transaction log module 3403 may store metadata about each of one or more transactions, such as (without limitation) transaction details, timestamps of transaction-related events, details of goods and/or services involved in a transaction, sources of funds involved in a transaction, remittance details of funds, types of currency (including cryptocurrency) involved in a transaction, an execution status of a transaction, details about the users 3416 of the enterprise 1902 and/or marketplace participants 1940 involved in a transaction, communications related to a transaction, cryptographic signatures and/or certificates associated with a transaction, smart contracts, or the like. The marketplace transaction log module 3403 may generate reports of stored transactions, such as transaction amounts, transaction, activity, and/or transaction costs associated with a particular period (e.g., a day, a week, or a quarter), including visualizations, summaries, tabular presentations, and/or interactive presentations of transactions. The marketplace transaction log module 3403 may perform audits and/or satisfy regulatory compliance of transactions stored by the marketplace transaction log module 3403.

In embodiments, the embedded marketplace platform 1950 includes a marketplace generator module 3404. The marketplace generator module 3404 generates representations of marketplaces based on information received from the marketplace communication module 3401. For example, the marketplace generator module 3404 may generate an index, summary, analysis, or the like of one or more marketplaces 1900. For example, the marketplace generator module 3404 may generate a representation of a marketplace that includes an aggregation of two or more marketplaces, wherein such two or more marketplaces may offer a same or similar type of goods and/or services (e.g., two or more sources of a product) and/or different types of goods and/or services. The marketplace generator module 3404 may generate a representation of a marketplace that includes subsets of one or more marketplaces 1900 (e.g., a representation of only a subset of goods and/or services of a marketplace that are relevant to an enterprise 1902). The marketplace generator module 3404 may generate a representation of a proto-marketplace (e.g., a presentation of goods and/or services that might be available if vendors for such goods and/or services can be identified, developed, and/or coordinated). The marketplace generator module 3404 may generate a representation of a marketplace that includes a transformation of one or more marketplaces (e.g., an anonymization, pseudonymization, redirection, relabeling, or the like of a marketplace 1900). The marketplace generator module 3404 may generate a representation of a new marketplace based on communication with one or more marketplace participants 1940 (e.g., one or more vendors that are interested in participating in a marketplace 1900, but that do not already have access to a marketplace 1900). The marketplace generator module 3404 may generate a representation of a marketplace of intangible goods and/or services, including (without limitation) advertising, publication, client development, project management, valuation, risk mitigation, insurance, and/or professional services such as legal representation. The marketplace generator module 3404 may generate a representation of a new marketplace on behalf of the enterprise 1902 (e.g., a representation of a new marketplace for goods and/or services that are provided by the enterprise 1902, and/or a representation of a new marketplace for goods and/or services that the enterprise 1902 would like to acquire). The marketplace generator module 3404 may generate a representation of a derivative marketplace for one or more goods or services (e.g., a futures marketplace for futures contracts on goods and/or services that will or may be available through one or more marketplaces 1900 in the future). The marketplace generator module 3404 may generate a representation of an arbitrage marketplace (e.g., a source of arbitrage of goods and/or services that are available through other marketplaces 1900 and/or other marketplace participants). The marketplace generator module 3404 may generate a representation of a marketplace of raw materials, goods, services, or the like that may provide processed, refined, assembled, and/or completed materials, goods, and/or services for another marketplace 1900. The marketplace generator module 3404 may generate a representation of a marketplace of processed, refined, assembled, and/or completed materials, goods, and/or services based on raw materials, goods, services, or the like that are available from another marketplace 1900. The marketplace generator module 3404 may generate a representation of a marketplace of currency (e.g., cryptocurrency) for buying, selling, negotiating, bartering, or the like, of goods and/or services available on other marketplaces 1900, including other marketplaces of currency (e.g., cryptocurrency). The marketplace generator module 3404 may generate representation of marketplaces based on a description of such a marketplace received from a user (e.g., a user 3416 of the enterprise 1902). The marketplace generator module 3404 may automatically generate representation of marketplaces based on information received from other components of the embedded marketplace platform 1950 (e.g., business news that indicates the viability of a futures market for a particular good or service).

In embodiments, the marketplace generator module 3404 generates a marketplace on demand, e.g., at a time when the embedded marketplace 3304 is needed and/or accessed. For example, the embedded marketplace system 3300 may be a plugin or application 3415 that runs a browser to embed the marketplace. In embodiments, the marketplace generator module 3404 generates the embedded marketplace 3304 using machine learning and/or artificial intelligence algorithms. For example, the marketplace generator module 3404 may use the AI/ML of a marketplace host 3301 to identify visual and interface characteristics. The marketplace generator module 3404 may also identify opportunities for types of goods or services to offer when embedding the embedded marketplace 3304. The embedded marketplace system 3300 may then embed the marketplace for use by the user as if the marketplace host 3301 and the embedded marketplace 3304 had been designed as one application 3415.

In embodiments, the embedded marketplace platform 1950 includes a marketplace representation module 3405. The marketplace representation module 3405 generates, manages, coordinates, and provides representations of marketplaces 1900 in conjunction with other modules of the embedded marketplace platform 1950. For example, the marketplace representation module 3405 may define a marketplace representation format, such as a common, standardized, and/or shared format for storing representations of marketplaces 1900, marketplace participants 1940, blockchains 2604, transactions, or the like. The marketplace representation module 3405 may reformat data provided by the marketplace communication module 3401 and/or marketplace generator module 3404 into a more standardized, comparable, and/or shared format. In some embodiments, the marketplace representation module 3405 may leverage a large language model (LLM) (or other generative AI system) that is configured and trained to generate representations of markets based on natural-language descriptions provided by the marketplace communication module 3401, marketplace generator module 3404, or the like. The marketplace representation module 3405 may evaluate and/or audit one or more marketplaces 1900 (e.g., evaluating trends in an availability, supply, demand, price, or the like, of a good and/or service that is relevant to an enterprise 1902). The marketplace representation module 3405 may monitor one or more marketplaces 1900 to raise informational notices, alerts, questions, or the like, related to one or more products and/or services that are available through one or more of the represented marketplaces 1900. The marketplace representation module 3405 may synthesize information from two or more marketplaces 1900 (e.g., determining comparative trends in an availability, supply, demand, prices, or the like, of a good and/or service that is available in each of two or more marketplaces 1900). The marketplace description module 3407 may generate a representation of a marketplace 1900 relative to another representation of the marketplace 1900, such as a representation of an update, trend, or comparison of a marketplace 1900 at a first period of time relative to a previous representation of the marketplace 1900 at a preceding period of time, and/or a representation of an update, trend, or comparison of a first marketplace 1900 relative to a representation of a second marketplace 1900.

In embodiments, the embedded marketplace platform 1950 includes a marketplace transaction module 3406. The marketplace transaction module 3406 is configured to generate, offer, initiate, negotiate, barter, accept, execute, and/or complete transactions through one or more marketplaces 1900 associated with one or more goods and/or services. A transaction may involve any of one or more users 3416 of an enterprise 1902, one or more client devices 3414 and/or applications 3415 provided thereon, one or more marketplace participants 1940, and/or one or more blockchains 2604. A transaction may involve two or more sub-transactions within a single marketplace 1900 and/or marketplace participant 1940, such as two or purchases of a quantity of a good from a marketplace 1900 and/or marketplace participant 1940. A transaction may involve two or more sub-transactions, such as a first purchase of a first quantity of a good from a first marketplace 1900 and/or first marketplace participant 1940 and a second purchase of a second quantity of the same good from a second marketplace 1900 and/or second marketplace participant 1940. The transactions may involve a sequence of sub-transactions, such as an arbitrage transaction including a purchase of a good from a first marketplace 1900 and/or first marketplace participant 1940 followed by a sale of the same good to a second marketplace 1900 and/or second marketplace participant 1940. A transaction may involve a conditional relationship among sub-transactions, such as a first transaction involving a good and/or service that is contingent on a successful negotiation, execution, and/or completion of a preceding transaction involving a related good and/or service. In embodiments, the marketplace transaction module 3406 may execute transactions by communicating directly with one or more marketplaces 1900 and/or marketplace participants 1940 (e.g., by exchanging, via the marketplace communication module 3401, email messages and/or data communications associated with the transaction with the marketplaces 1900 and/or marketplace participants 1940, and/or by initiating transfers of cryptocurrency on one or more blockchains 2604). In embodiments, the marketplace transaction module 3406 may execute transactions indirectly, e.g., by communicating with a broker, agent, or other delegate of a marketplace 1900 and/or marketplace participant 1940 (e.g., via the marketplace communication module 3401). In embodiments, the marketplace transaction module 3406 may execute transactions locally (e.g., by locally transferring funds and/or ownership of goods and/or services, for example, in the marketplace transaction log module 3403). Alternatively or additionally, marketplace transaction module 3406 may execute transactions remotely (e.g., by transmitting requests to transfer funds and/or ownership of goods and/or services to the cloud for execution by one or more servers associated with one or more marketplaces 1900). In embodiments, the marketplace transaction module 3406 may execute transactions autonomously, e.g., by generating, receiving, reviewing, negotiating, and/or executing one or more smart contracts associated with a transaction, and by transmitting communication related to the smart contract with one or more marketplaces 1900, marketplace participants 1940, and/or blockchains 2604 (e.g., via the marketplace communication module 3401). The marketplace transaction module 3406 may condition the initiation, negotiation, acceptance, execution, and/or completion of transactions upon review and approval by one or more users 3416 of an enterprise 1902 and/or agents thereof. The marketplace transaction module 3406 may record logs of initiated, negotiated, accepted, executed, and/or completed transactions in the marketplace transaction log module 3403.

In embodiments, the embedded marketplace platform 1950 includes a marketplace description module 3407. The marketplace description module 3407 generates descriptions of one or more marketplaces 1900, marketplace participants 1940, and/or blockchains 2604. The marketplace description module 3407 may generate a description of the range of goods and/or services that are available through at least one marketplace. The marketplace description module 3407 may generate a description of a good and/or service that is available on each of two or more marketplaces (e.g., a comparison of an availability, supply, demand, price, or the like, of a particular good and/or service through each of two or more marketplaces). The marketplace description module 3407 may generate a description of goods and/or services associated with a particular project, need, requirement, interest, or the like of an enterprise 1902, user 3416, client device 3414, enterprise resources 1906, or the like. For example, a product (e.g., a good and/or service) to be offered by an enterprise 1902 may involve a combination of raw materials, equipment, services, or the like, and the marketplace description module 3407 may describe a marketplace of the product based on the availability, supply, demand, price, or the like, of each of the raw materials, equipment, services, or the like associated with the product. The marketplace description module 3407 may generate a description of a marketplace 1900 based on a particular context, such as a particular recipient, project, context, enterprise 1902, client device 3414, user 3416, enterprise resource 1906, timeframe, objective, or the like. The marketplace description module 3407 may generate a description of a marketplace 1900 based on a prompt generated by a user 3416, such as a question submitted by a user 3416 regarding an availability, supply, demand, price, or the like, of a particular type of good or service that may be available through one or more marketplaces 1900 and/or marketplace participants 1940. The marketplace description module 3407 may generate a description of a marketplace 1900 as a natural-language description to be received and understood by a particular human, a class of humans (e.g., a particular demographic), or a large language model of a device. The marketplace description module 3407 may generate a description of a marketplace 1900 that includes one or more visualizations, summaries, tabular presentations, and/or interactive presentations of one or more marketplaces 1900, marketplace participants 1940, goods, services, or the like. In some embodiments, the marketplace description module 3407 may leverage (e.g., via the intelligence systems described above) an LLM or other generative AI system that is configured and trained to generate respective descriptions of relevant marketplace entities (e.g., marketplaces, marketplace participants, blockchains 2604, goods and services, and/or the like). The marketplace description module 3407 may generate a description of a marketplace 1900 as various formats, such as files, databases, spreadsheets, structured data objects such as an Extensible Markup Language (XML) and/or JavaScript Object Notation (JSON) document, software objects, processor-executable instructions, declarative statements, or the like. The marketplace description module 3407 may generate a description of a marketplace 1900 relative to another description of the marketplace 1900, such as a description of an update, trend, or comparison of a marketplace 1900 at a first period of time relative to a previous description of the marketplace 1900 at a preceding period of time, and/or a description of an update, trend, or comparison of a first marketplace 1900 relative to a description of a second marketplace 1900.

In embodiments, the embedded marketplace platform 1950 includes a marketplace interaction module 3408. The marketplace interaction module 3408 may initiate, receive, process, respond to, execute, and/or complete interactions with one or more marketplaces 1900. In embodiments, the interactions between the marketplace interaction module 3408 and the one or more marketplaces 1900 may be of a higher level than transactions. For example, the marketplace interaction module 3408 may manage an account of an enterprise 1902, client device 3414, application 3415, user 3416, and/or enterprise resource 1906 on one or more marketplaces 1900 (e.g., creating, adapting, managing, correcting, and/or deleting an account on a marketplace 1900). The marketplace interaction module 3408 may determine a need or interest of an enterprise 1902 in a good and/or service that is not currently available through any of the currently available marketplaces 1900, and may initiate an informational notification, solicitation, and/or discovery process to identify an availability of the good and/or service. The marketplace interaction module 3408 may receive an inquiry about a property of a good and/or service (e.g., whether a good and/or service is suitable for and/or compatible with a particular client device 3414, a user 3416, and/or enterprise resource 1906) and may initiate, conduct, and/or report on communication with one or more marketplaces 1900 and/or marketplace participants 1940 responsive to the inquiry. The marketplace interaction module 3408 may receive feedback from an enterprise 1902, client device 3414, user 3416, and/or enterprise resource 1906 about a good and/or service and may initiate, conduct, and/or report on a transmission of the feedback to one or more marketplaces 1900 and/or marketplace participants 1940. The marketplace interaction module 3408 may receive an inquiry from an enterprise 1902 about a status of one or more transactions completed by the marketplace transaction module 3406, may communicate with the marketplace transaction module 3406 and/or the marketplace transaction log module 3403 to determine the status of the one or more transactions, and may respond to the inquiry with information about the status of the one or more transactions. The marketplace interaction module 3408 may receive a request or command from an enterprise 1902 about one or more transactions (e.g., a request to initiate, review, and/or terminate transactions associated with one or more marketplaces 1900, one or more marketplace participants 1940, and/or one or more blockchains 2604) and may communicate with the marketplace transaction module 3406 to execute the request or command from the enterprise 1902.

In embodiments, the embedded marketplace platform 1950 includes a marketplace oversight module 3409. The marketplace oversight module 3409 performs oversight of transactions that may be, are being, and/or have been explored, initiated, generated, offered, negotiated, bartered, accepted, executed, and/or completed by the marketplace transaction module 3406. For example, the marketplace oversight module 3409 may receive a policy of an enterprise 1902 that defines limits on transactions that may be conducted by the marketplace transaction module 3406 on behalf of the enterprise 1902. The policy may indicate restrictions on one or more types of transactions that the marketplace transaction module 3406 is restricted from conducting on behalf of the enterprise 1902 (e.g., purchases of restricted goods and/or services). The policy may indicate a maximum number and/or amount of transactions that may be conducted by the marketplace transaction module 3406 on behalf of the enterprise 1902 within a certain period (e.g., a daily transaction limit). The policy may indicate a maximum amount of goods and/or services that may be acquired, purchased, sold, or the like, by the marketplace transaction module 3406 on behalf of the enterprise 1902 within a certain period (e.g., a daily transaction limit). The policy may indicate one or more preconditions of a type of transactions that may be conducted by the marketplace transaction module 3406 on behalf of the enterprise 1902 (e.g., preapproval of transactions over a certain amount by a particular user 3416 of the enterprise 1902). The policy may indicate a sequence of transactions, wherein a precondition of a first transaction of the sequence is a completion of a preceding transaction of the sequence (e.g., an arbitrage transaction in which a sale of a good or service cannot be completed until a completion of a purchase of the same good or service). The policy may originate, in whole in part, from a user 3416 of the enterprise 1902, an enterprise resources 1906 such as an automated agent or management process, and/or an external agency, such as a national, state, and/or local government, a regulatory body, an industry standards body, and/or a parent or supervisory organization. The policy may be provided in a natural-language format (e.g., an English-language policy document), a stylized language format (e.g., a statutory code document), structured data objects such as an Extensible Markup Language (XML) and/or JavaScript Object Notation (JSON) document, software objects, declarative statements, processor-executable instructions, or the like.

In embodiments, the marketplace oversight module 3409 may evaluate the policy to ensure that transactions executed by the marketplace transaction module 3406 are in compliance with the policy. The marketplace oversight module 3409 may evaluate transactions prospectively, e.g., prior to initiating, offering, negotiating, accepting, executing, and/or completing any transaction, and may interrupt such processing of a transaction upon determining that the transaction does not comply with the policy. The marketplace oversight module 3409 may cause the marketplace transaction module 3406 to halt, suspend, rollback, and/or terminate transactions that do not comply with the policy. Alternatively or additionally, marketplace oversight module 3409 may evaluate transactions retrospectively, e.g., after an execution and/or completion of one or more transactions. The marketplace oversight module 3409 may cause the marketplace transaction module 3406 to reverse, refund, cancel, mitigate, and/or otherwise compensate for an execution or completion of a non-complaint transaction.

In embodiments, the marketplace oversight module 3409 operates in coordination with governance modules associated with the enterprise 1902, such as the permissions system 1930, the wallets system 1932, and/or the reporting system 1934. In embodiments, the governance modules associated with the enterprise 1902 applies general and/or high-level policies across the enterprise 1902, while the marketplace oversight module 3409 applies specific and/or low-level policies associated with the embedded marketplace 3304. For example, a high-level policy applied by governance modules of the enterprise 1902 may generally specify broad limits on certain types of transactions, such as a general policy of limiting costs associated with an event to those that are generally necessary and/or relevant to the event. Based on the high-level policy, the marketplace oversight module 3409 may apply a low-level policy associated with the enterprise 1902 that specifies, in detail, particular requirements for transactions associated with an event in view of the high-level policy. For example, the low-level policy may specify budgets for one or more classes of transactions (e.g., individual budgets for transactions involving food, travel, lodging, and/or equipment); transaction caps for transactions in the one or more classes of transactions (e.g., a maximum cost for any one food-related transaction); and/or other details that limit transactions for each of the one or more classes (e.g., a maximum number of food-related transactions that can be conducted per day). As another example, a high-level policy applied by governance modules of the enterprise 1902 may generally require transactions of different degrees of significance (e.g., financial amounts and/or impact on the enterprise 1902) to receive approval by personnel of different roles within the enterprise 1902. Based on the high-level policy, the marketplace oversight module 3409 may apply a low-level policy associated with the enterprise 1902 that specifies, in detail, particular types of transactions that are to be approved by personnel of different roles within the enterprise 1902. For example, the policy of the marketplace oversight module 3409 may require approval, by an officer associated with an information technology (IT) group of the enterprise 1902, any transaction involving an acquisition of software, digital content, and/or digital services, and/or any transaction through a marketplace that is oriented toward such products. The policy of the marketplace oversight module 3409 may require approval, by an officer associated with an officer with a public relations officer of the enterprise 1902, any transaction involving a contract for public services associated with a public event, such as public food service, public entertainment, or public event security, and/or any transaction through a marketplace that is oriented toward such services. In this manner, the marketplace oversight module 3409 and the governance modules associated with the enterprise 1902 may interoperate and coordinate polices of the enterprise 1902 that relate to embedded marketplaces 3304 and transactions executed therein.

The marketplace oversight module 3409 may notify a user 3416 of an enterprise 1902 as to the occurrence of a non-compliant transaction. The marketplace oversight module 3409 may create an entry in the marketplace transaction log stored by the marketplace transaction log module 3403 of the non-compliance of the transaction with the policy. The marketplace oversight module 3409 may evaluate a non-compliant transaction to determine a modification of the non-compliant transaction that would cause the non-compliant transaction to be in compliance with the policy. Upon such determination, the marketplace oversight module 3409 may alter, substitute, replace, and/or supersede the non-compliant transaction with the modified transaction that is in compliance with the policy. The marketplace oversight module 3409 may inform one or more users 3416, client devices 3414, and/or enterprise resources 1906 of transactions that are non-compliant with the policy, a reason for the non-compliance, and/or modifications of such transactions that would be compliant with the policy. The marketplace oversight module 3409 may evaluate a policy to determine a reason and/or objective of the non-compliance of one or more transactions, and may identify and/or recommend a change to the policy that would enable such transactions to be compliant with the policy. In some embodiments, the marketplace oversight module 3409 may communicate with the marketplace interaction module 3408 to promote compliance between interactions between the marketplace interaction module 3408 and one or more marketplaces 1900 and/or marketplace participants 1940 and the policy of the enterprise 1902 (e.g., blocking the initiation of inquiries for transactions that are restricted by the policy).

In embodiments, the embedded marketplace platform 1950 includes a marketplace embedding module 3410. In embodiments, the marketplace embedding module 3410 adapts a description of a marketplace for embedding in a particular context of the enterprise 1902. The embedded marketplace platform 1950 may embed the marketplace in a client device 3414 and/or an application 3415 executed thereby in a manner that allows users 3416 and/or processes to engage in transactions through the marketplace that are contextually related to the client device 3414 and/or application 3415 executed thereby.

In embodiments, the marketplace embedding module 3410 includes a software development kit (SDK) by which a developer may create one or more applications 3415 that present an embedded marketplace 3304 on a particular client device 3414 and/or application 3415. For example, an SDK may include a client-side library that may be deployed to a workstation, mobile device, webserver, or the like. A developer may design and implement an application 3415 that utilizes the client-side library to perform one or more operations that present the embedded marketplace 3304 on the client device 3414 and/or application 3415 presented thereby. For example, the marketplace embedding module 3410 may discover that the client device 3414 and/or application 3415 includes one or more output devices, such as one or more displays, holographic projectors, speakers, haptic output devices (e.g., buzzers), amplifiers, actuators, or the like. The marketplace embedding module 3410 may permit the developer to configure the client device 3414 and/or application 3415 to present features of the description of the embedded marketplace 3304 to present the embedded marketplace 3304 to a user, including presenting and/or describing available goods and/or services of the embedded marketplace 3304; presenting and/or describing transactions conducted through the embedded marketplace 3304; and/or presenting and/or describing the goods and/or services associated with transactions conducted through the embedded marketplace 3304. Alternatively or additionally, the marketplace embedding module 3410 may discover that the client device 3414 and/or application 3415 includes one or more input devices, such as a keyboard, mouse, buttons, switches, cameras, microphones, inertial measurement unit (IMUs), or the like. The marketplace embedding module 3410 may permit the developer may configure the client device 3414 and/or application 3415 to interpret user input received through the one or more input devices and to interpret such user input as operations to be performed on the embedded marketplace 3304. The marketplace embedding module 3410 may permit the developer to configure the client device 3414 and/or application 3415 to perform other operations associated with the presentation of the embedded marketplace 3304, such as logging results of one or more transactions performed through the embedded marketplace 3304 and/or reporting the results of the operations to a user of the application 3415. An API and/or SDK of the marketplace embedding module 3410 may include executable, compilable, and/or interpretable code; data objects, such as files and/or databases; documentation; user interfaces; images; or the like. In some embodiments, an SDK may perform operations through the marketplace 1900 by issuing HTTP requests through an API of the marketplace 1900. In some embodiments, the marketplace embedding module 3410 incorporates one or more additional APIs and/or SDKs of a client device (e.g., a personal mobile device of a user), and, optionally, in different applications 3415 for different client devices. In some embodiments, a marketplace embedding module 3410 incorporates an API and/or SDK into a server-side application (e.g., an automated purchasing agent that maintains inventory supplies by automatically executing purchases of goods and/or services through one or more marketplaces 1900).

As a first example, if a description of a marketplace 1900 is to be embedded in a client device 3414 that includes a vehicle, the marketplace embedding module 3410 may discover one or more output devices of the vehicle (e.g., infotainment systems, audio systems, heads-up displays, or the like) by which the description of the marketplace 1900 may be presented, and may adapt the description of the marketplace 1900 for presentation by the output devices of the vehicle. For example, the marketplace embedding module 3410 may receive a description of various types of media that are available through a media marketplace 1900, and may filter the description to include only types of media that may be safely presented by the output devices of the vehicle. The marketplace embedding module 3410 may discover one or more occupants of the vehicle to whom the marketplace 1900 is to be presented, and may adapt the description of the marketplace 1900 for presentation to the one or more occupants (e.g., using language that is suitable for a role, attention availability, age, language preference, and/or sophistication of at least one of the one or more occupants). The marketplace embedding module 3410 may discover one or more contexts and/or needs of a vehicle and/or the occupants of the vehicle (e.g., a need for food, rest stops, vehicle refueling and/or recharging, vehicle maintenance or repairs, or the like), and may adapt the description of the marketplace 1900 for presentation that is appropriate for the one or more contexts and/or needs. The marketplace embedding module 3410 may discover one or more input devices of the vehicle (e.g., buttons, switches, dials, touchpads, touch-sensitive displays, microphones, cameras, or the like) by which an occupant of the vehicle may provide user input to interact with the marketplace 1900, and may adapt the description of the marketplace 1900 for interaction based on the user input received by the input devices. Based on such interactions with occupants of the vehicle, the marketplace embedding module 3410 may initiate transactions with the one or more marketplaces 1900 and/or marketplace participants 1940 (e.g., by communicating with the marketplace interaction module 3408 and/or marketplace transaction module 3406). In embodiments, the marketplace embedding module 3410 may adapt and/or initiate an operation of a client device 3414 and/or application 3415 of the vehicle based on a completion of a transaction via a marketplace embedded into the client device 3414 and/or application 3415 (e.g., causing an infotainment system of the vehicle to play media that has been acquired by the marketplace transaction module 3406 in response to user input). In this manner, the embedded marketplace platform 1950 embeds the marketplace in the infotainment system of the vehicle of the enterprise 1902 and can allow occupants of the vehicle to engage in transactions through the marketplace that are contextually related to the vehicle and/or the occupants of the vehicle.

As a second example, if a description of a marketplace 1900 is to be embedded in a client device 3414 that includes audio-only headgear such as headphones or earbuds, the marketplace embedding module 3410 may discover one or more output devices of the headgear (e.g., left-ear and right-ear speakers) by which the description of the marketplace 1900 may be presented, and may adapt the description of the marketplace 1900 for presentation by the output devices of the headgear. For example, the marketplace embedding module 3410 may receive a description of various types of media that are available through a media marketplace 1900, and may filter the description to include only types of media that may be safely presented by the headgear. The marketplace embedding module 3410 may discover information about a user of the headgear to whom the marketplace 1900 is to be presented, and may adapt the description of the marketplace 1900 for presentation to the user (e.g., using language that is suitable for a role, attention availability, age, language preference, and/or sophistication of the user). The marketplace embedding module 3410 may discover one or more contexts and/or needs of the user of the headgear (e.g., a need for food, rest stops, or the like), and may adapt the description of the marketplace 1900 for presentation that is appropriate for the one or more contexts and/or needs of the user. The marketplace embedding module 3410 may discover one or more input devices of the headgear (e.g., buttons, switches, dials, microphones, or the like) by which the user of the headgear may provide user input to interact with the marketplace 1900, and may adapt the description of the marketplace 1900 for interaction based on the user input received by the input devices. Based on such interactions with the user of the headgear, the marketplace embedding module 3410 may initiate transactions with the one or more marketplaces 1900 and/or marketplace participants 1940 (e.g., by communicating with the marketplace interaction module 3408 and/or marketplace transaction module 3406). The marketplace embedding module 3410 may adapt an operation of a client device 3414 and/or application 3415 of the vehicle based on a completion of a transaction (e.g., causing an infotainment system of the vehicle to play media that has been acquired by the marketplace transaction module 3406 in response to user input). In this manner, the embedded marketplace platform 1950 embeds the marketplace in the headgear of the user and can allow the user of the headgear to engage in transactions through the marketplace that are contextually related to the headgear and/or the user.

In embodiments, the marketplace embedding module 3410 presents one or more embedded marketplaces 3304 using query technologies and unified views. For example, the marketplace embedding module 3410 may present embedded marketplaces by tying various query technologies together into a unified view such as linking a business of interest (e.g., bar/restaurant, hotel, museum, activity, transportation, etc.) with event sites (e.g., Eventbrite, Ticketmaster, etc.), with map technologies (e.g., Google Map, Apple map), with all users loyalty/rewards accounts (e.g., airlines, particular business of interest, AAA), all credit cards, and with query searching technologies (e.g., Google, Bing, Yelp) which are all provided in a unified view providing recommendations. In embodiments, the marketplace embedding module 3410 may present a unified view that includes digital simulations, real-world scanning (cameras, LIDAR), physical simulations (rapid prototype of a business or product in a 3D-printed model that can be seen via the view), audio (e.g., to indicate actual crowd noise level or music style). In embodiments, the marketplace embedding module 3410 presents an embedded marketplace 3304 including travel ideas are integrated with the embedded marketplace 3304. For example, someone that is looking for restaurants in their area could use the embedded marketplaces system unified view in making a decision by having access to related special offers available to users based on their account with the business, with multiple credit cards, airlines in terms value of miles, etc. as well as a quick view of which restaurants offer them most points per dollars sent in terms of future benefits to their accounts. In embodiments, the marketplace embedding module 3410 may include, in an embedded marketplace 3304, one or more recommendations in terms of related optimal dollar savings and/or particular credit cards and/or accounts to use based on optimal savings. In embodiments, the marketplace embedding module 3410 may include, in an embedded marketplace 3304, reviews and/or ratings related to goods and/or services of the embedded marketplace 3304. In embodiments, the marketplace embedding module 3410 may present an embedded marketplace 3304 that integrates services such as local hotels and/or transportation services (e.g., ride-sharing apps) with similar information, such as a combination of offers with best optimal options for points in terms of dollar savings also tied to ratings and reviews of businesses. In embodiments, the marketplace embedding module 3410 presents an embedded marketplace 3304 using map technologies that indicate business that are closest to where the user is currently or a location selected by the user. In embodiments, the marketplace embedding module 3410 may present an embedded marketplace 3304 that tracks information and/or predicts future dates when the user may benefit the most in terms of offers and/or account benefits to going to a specific restaurant, going to a concert, going to an amusement park, using a particular service (e.g., carwash, car mechanic, barber, etc.).

In some embodiments, an embedded marketplace platform 1950 may personalize one or more marketplaces 1900 for one or more users 3416 of the enterprise 1902. For example, the embedded marketplace platform 1950 may store information that indicates needs, preferences, restrictions, or the like, for one or more users 3416 relating to goods and/or services that are available through one or more marketplaces 1900. While communicating with one or more marketplaces 1900, a marketplace communication module 3401 may provide information about the personalization of the marketplaces 1900 for one or more users 3416 of an embedded version of the marketplace, such that the marketplace 1900 may adapt its presentation to correspond to the personalized details of the one or more users 3416. Alternatively or additionally, while embedding one or more marketplaces 1900 in one or more client devices 3414, an marketplace embedding module 3410 may use stored information to personalize the embedded marketplace 1900 for one or more users 3416 of the embedded marketplace 1900 (e.g., filtering the goods and/or services of the embedded marketplace 1900 based on the preferences of the one or more users 3416, and/or excluding goods and/or services of the embedded marketplace 1900 that the one or more users 3416 are restricted from purchasing). The personalization may include the transmission of one or more user parameters to a marketplaces 1900 and/or marketplace participant 1940. The user parameters may include, for example (without limitation), one or more of: a personal identity, a personal demographic detail, a geolocation, a personal opinion and/or preference, and/or financial information related to the one or more users 3416 of the enterprise 1902.

In some embodiments, an embedded marketplace platform 1950 may anonymize and/or pseudonymize interactions between one or more marketplaces 1900 and one or more users 3416 of the enterprise 1902. As a first such example, during communication by the marketplace communication module 3401 and one or more marketplaces 1900 and/or marketplace participants 1940 on behalf of one or more users 3416, the marketplace communication module 3401 may obscure information about the one or more users 3416, so that the marketplaces 1900 and/or marketplace participants 1940 cannot determine and/or demonstrate that certain users 3416 are or were associated with the marketplaces 1900, marketplace participants 1940, transactions, or the like. The user-specific information that may be obscured by the embedded marketplace platform 1950 may include (without limitation) a deletion, censoring, and/or substitution of one or more of: a personal identity, a personal demographic detail, a geolocation, a personal opinion and/or preference, and/or financial information related to the one or more users 3416. As a second such example, during communication by the marketplace communication module 3401 and one or more users 3416, the marketplace embedding module 3410 may obscure information about one or more marketplaces 1900 and/or marketplace participants 1940, so that the users 3416 cannot determine and/or demonstrate that their transactions are or were associated with the marketplaces 1900, marketplace participants 1940, or the like. The marketplace-specific information that may be obscured by the embedded marketplace platform 1950 may include (without limitation) a deletion, censoring, and/or substitution of one or more of: an identifier of a marketplace 1900, a personal identity of a marketplace participant 1940, a personal demographic detail of a marketplace participant 1940, a geolocation of a marketplace 1900 and/or marketplace participant 1940, a personal opinion and/or preference of a marketplace 1900 and/or marketplace participant 1940, and/or financial information related to a marketplace 1900 and/or marketplace participant 1940.

As can be appreciated, the embedded marketplace system 3300 may be configured to embed different types of marketplaces, thereby facilitating many different types of transactions. These transactions may include business-to-business (B2B) transactions, business-to-consumer (B2C) transactions, machine-to-machine (M2M) transactions or the like.

In the context of B2B transactions, marketplaces may be embedded in enterprise software interfaces. In some embodiments, such as in CRMs, ERPs, supply chain management platforms, order management systems, accounting systems, and/or the like. In embodiments, the embodiments, the embedded marketplace system 3300 is configured to embed marketplaces into the interface of an ERP or an order management system, such that the marketplaces allow enterprise users to procure futures contracts of certain commodities in order to hedge purchases of material goods. In some embodiments, the embedded marketplace system 3300 may embed marketplaces into the interface of a CAD software application. For example, the CAD software application may embed a marketplace 3304 that allows a user to purchase or sell designs of proprietary components or other elements that may be incorporated into a CAD design. In embodiments, the embedded marketplace 3304 may further allow a user to order the components for use in an assembly designed with the component. In embodiments, the CAD program can allow a specific model to be either private or for sale to be offered to any other user of the CAD program. It can also indicate whether third parties may manufacture the model to be sold to others.

In another example, the CAD software (or other enterprise software) may embed marketplaces for procuring instruction sets associated with modeling, design, and additive manufacturing. In these examples, the instruction sets may include G-code already sliced for various commercially available 3D printers. In embodiments, the embedded marketplace system 3300 may embed a marketplace in an interface of a predictive maintenance platform. In this example, the embedded marketplace 3304 may allow enterprise users to purchase replacement parts and/or hire technician services. For example, an embedded marketplace for industrial settings may tie in maintenance purchases, replacement parts, suggestions to include other products or services from separate and/or related vendors, and/or the like. In embodiments, such an embedded marketplace system accelerates the procurement process in corporate settings by streamlining by integrating reduced clicks for pre-approved vendors and purchases.

In embodiments, an embedded marketplace 3304 offers AI training data in a generative AI platform. For example, a user may be using an enterprise application to complete a task and the application may provide marketplaces that list fine-tuning training data sets that can be purchased from various vendors as the external application 3306 through the embedded marketplace 3304. In embodiments, such a marketplace may be embedded in enterprise software applications that are relevant to the training data sets.

In embodiments, the embedded marketplace system 3300 embeds marketplaces 3304 into digital twins, such as shipping digital twins, product digital twins, robot digital twins, executive digital twins, additive manufacturing digital twins, digital twins of products, digital twins of 3D printers, and/or the like. In some embodiments, the embedded marketplace provides marketplaces 3304 for simulations and/or models that can be executed in a digital twin.

In embodiments, the embedded marketplace system 3300 may embed marketplaces 3304 that allow enterprises to transact for logistics services into enterprise software (e.g., an ERP or logistics management software). In an example embodiments, a door-to-door less-than-carload (LCL) shipping option may be offered by an embedded marketplace 3304. For example, the embedded marketplace 3304 may indicate options and availability for LCL shipping on short notice or in advance. In embodiments, a door-to-door aspect involves multi-modality shipping (e.g., truck from pick-up to rail to ship, back to truck for delivery to end point). In embodiments, rather than communicate and arrange with each shipping modality, the embedded marketplace 3304 offers service may offer allow a user to complete this process from a single interface. For example, the marketplace host 3301 may be an application 3415 of a marketplace commonly used in countries with extensive manufacturing capabilities and lower costs of goods, and the embedded marketplace 3304 may connect shippers, truckers, and customs brokers for arranging the delivery of goods purchased on the marketplace host 3301 while the embedded marketplace 3304 presents the look and feel of engagement with the marketplace host 3301. In embodiments, LCL may be using dedicated LCL means, but it also might also be one-time excess capacity in a non-LCL-dedicated shipping modality (i.e., extra room in a container)—these might be arranged as subleases for LCL. For example, Customer 1 uses 75% of a container and leases the remaining 25% to Customer 2. In embodiments, the process may include various clearances, permissions, etc. (customs, tariffs) and so forth. In embodiments, the process may also optimize timing selection for identifying shipping windows with cost or other advantages. In embodiments, an intelligence layer secures appropriate commodity blending (i.e., don't ship semiconductors with the livestock). In example embodiments, the shipping and logistics-oriented embedded marketplace 3304 interfaces with smart containers, such as automatically negotiating for additional capacity by moving something that is already in the container to another mode of shipment for a price that is pre-configured in a smart contract. A smart contract may be configured with very granular pricing variations that indicate the relative importance of time to different users.

In the context of B2C offerings, the embedded marketplace system may be configured to embed marketplaces in different types of consumer applications and/or devices. In some example embodiments, the embedded marketplace system 3300 may embed a marketplace 3304 into a music streaming application that allows users to purchase tokenized IP. For example, the embedded marketplace system 3300 may allow users to purchase fractional ownership of artists/catalogs from the music sharing application. Similarly, such a marketplace may be embedded in a ticketing application, as described elsewhere.

In embodiments, an embedded marketplace system 3300 is associated with a vehicle and/or occupants of a vehicle, and provide an embedded marketplace 3304 for time, location, and/or condition-appropriate vehicle- and/or occupant-related products and services.

An embedded marketplace 3304 within a vehicle may be presented to one or more occupants of the vehicle by a user interface within the vehicle, such as an audiovisual infotainment system built into a console of the vehicle, an audio system that plays audio for the occupants of the vehicle, a visual heads-up display presented on a windshield of the vehicle, or the like. The embedded marketplace 3304 embedded in the vehicle may offer goods and/or services that are related to the vehicle. For example, the embedded marketplace 3304 may offer goods and/or services related to the operation of the vehicle, such as goods and/or services related to mapping and/or routing; fuel or electric charging; consumable supplies, such as oil and windshield wipers; payments for toll roads and/or parking; diagnostic, repair, and/or maintenance services for the vehicle; upgrades to electronic, hardware, and/or software features of the vehicle; ornamental and/or functional accessories for the vehicle; or the like, including recommendations of any such goods and/or services. The embedded marketplace 3304 may offer goods and/or services related to the occupants in relation to their occupancy of the vehicle, such as food or beverages; rest stops; supplies, such as personal items to be used one or more destinations of the vehicle, such as clothing; entertainment media for the journey, such as music, audiobooks, podcasts, movies, slideshows, games, e-books and/or e-zines, or the like; connectivity to a wide-area network, such as a mobile cellular network; social networking services, such as interactions with other individuals or computer-generated avatars; and/or health or medical services, including recommendations of any such goods and/or services. The embedded marketplace 3304 may allow occupants and/or services to explore any such goods and/or services, and to generate, offer, initiate, negotiate, barter, accept, execute, and/or complete transactions related to any such goods and/or services in the context of the vehicle and the travel of the occupants in the vehicle. The embedded marketplace 3304 may allow the occupants to search for such goods and/or services; request and receive additional information about such goods and/or services; request, offer, negotiate, and/or barter any such goods and/or services; and/or execute and/or complete transactions related to any such goods and/or services (e.g., remitting payment, executing a smart contract, transferring traditional currency and/or cryptocurrency as payment, arranging delivery and/or receipt, subscribing to and/or modifying a subscription of goods and/or services; trading rights to the goods and/or services, or the like).

In embodiments, the embedded marketplace system 3300 utilizes input from input components of the vehicle. For example, the vehicle may include sensors associated with mechanical, electrical, and/or electronic components of the vehicle, such as an engine, a drivetrain, a fuel or power distribution system, a transmission, a suspension, a steering mechanism, a brake, a traction control system, and/or an exhaust of the vehicle. The vehicle may include sensors associated with auxiliary components of the vehicle, such as a steering wheel, headlights, interior lights, windshield wipers, washer fluid dispensers, door locks, retractable windows, a convertible top mechanism, and airbags. The vehicle may include sensors associated with operation of the vehicle, such as speedometers, tachometers, mileage sensors, proximity sensors, and collision sensors. The vehicle may include sensors associated with occupants of the vehicle, such as pressure-based occupancy detection and estimation systems; user vehicle controls, such as a steering wheel, a shifter, and pedals; manual input systems such as buttons, switches, and touchscreens; and occupant-facing sensors such as microphones or cameras. The embedded marketplace system 3300 may receive input from any of these systems and translate such input in the context of an embedded marketplace 3304. For example, an indication of low windshield fluid may be associated with a transaction through the embedded marketplace 3304 to acquire more windshield fluid. An indication of a braking issue may be associated with a transaction through the embedded marketplace 3304 for brake repairs or diagnostics. An indication of low fuel and/or power may be associated with a transaction through the embedded marketplace 3304 for refueling and/or power charging. An indication of a collision may be associated with a transaction through the embedded marketplace 3304 for collision repair services. An indication of an activation of a convertible top (e.g., retracting the roof of the vehicle), indicating a recreational mood of the occupants, may be associated with transactions through the embedded marketplace 3304 for recreational activities, such as recreational media to be played on an infotainment system or travel stops that are associated with recreational activities. An indication of high occupancy of the vehicle (e.g., every seat being full) may be associated with transactions through the embedded marketplace 3304 for additional stops for rest, stretching, food, or other personal needs. The embedded marketplace system 3300 may integrate instrumented vehicle conditions, such as fluid levels, brake pad condition, tire wear, and other consumable parts. Based on such conditions, the embedded marketplace system 3300 may initiate transactions through an embedded marketplace 3304 for products and/or services associated with vehicle consumables,
qualified service facilities (e.g., bidding on maintenance and repair jobs and/or scheduling appointments), and/or parts suppliers (e.g., parts for DIY maintenance by an owner or operator of the vehicle). An embedded marketplace system 3300 may use indications of vehicle state or condition, based on input from sensors to detect interior and exterior vehicle cleanliness, odor, minor body damage, or other states or conditions, and may initiate transactions through an embedded marketplace 3304 for vehicle cleaning, mobile detailing service providers, body repair, or the like. In some cases, the transactions initiated by the embedded marketplace system 3300 through the embedded marketplace 3304 may occur during or after the vehicle manufacturer's warranty or extended warranty.

In embodiments, an embedded marketplace system 3300 uses combinations of inputs from vehicle sensors to determine and initiate transactions on the embedded marketplace 3304. For example, upon detecting a fast driving speed and a selection of a food-related destination, the embedded marketplace system 3300 may determine that the occupants are hungry, and may determine and suggest transactions on the embedded marketplace 3304 that relate to faster and/or more satisfying food options, such as closer restaurants, and/or options for accelerating food intake, such as initiating a transaction through the embedded marketplace 3304 for a seating reservation and/or advance restaurant order at the selected restaurant. As another example, upon detecting a collision followed by a slow driving speed and an anxious tone of voices of the occupants of the vehicle, the embedded marketplace system 3300 may determine that the vehicle may be damaged and may initiate transactions through the embedded marketplace 3304 for vehicle diagnostic and/or repair goods and/or services.

In embodiments, an embedded marketplace 3304 may present various types of activities to occupants of a vehicle. For example, the embedded marketplace platform 1950 may interact with one or more marketplaces 1900 via respective one or more marketplace interfaces 3412, wherein each of the one or more marketplaces 1900 offers various goods and/or services related to the vehicle and/or occupants during a trip in the vehicle. User input that indicates a selection of goods and/or services may be received by the marketplace interaction module 3408 and processed, as transactions associated with the vehicle and/or occupants, by the marketplace transaction module 3406. The selected goods and/or services may be received by a marketplace oversight module 3409 to apply policies to the transactions involving the vehicle and/or occupants. The marketplace embedding module 3410 may present indications of the acquired goods and/or services to the owner and/or occupants of the vehicle on one or more client devices 3414, and/or may take further actions based on the acquired goods and/or services (e.g., logging the acquired goods and/or services as part of a manifest of the vehicle).

In embodiments, the embedded marketplace system 3300 may be configured to embed marketplaces into an interface of a calendar application or another type of productivity application, such that the marketplaces may facilitate spontaneous activity planning. For example, a user 3416 who is looking for something to do on a particular day (e.g., on short notice, like this afternoon, or right now) might consult an events calendar. The events calendar may provide a generic and/or personalized list of events or activities. However, the selection of an event to attend or an activity is often followed by additional actions, such as buying event tickets, purchasing supplies, arranging travel, or the like.

In embodiments, an embedded marketplace 3304 may present additional resources for various activities and complete transactions for events of interest to a user 3416. For example, a user 3416 may express interest in a particular event included in a list, calendar, message, web page, or the like. The embedded marketplace 3304 may determine one or more goods and/or services that are associated with the event. The goods and/or services may include, for example, clothing that is appropriate for the event, such as swim trunks for a pool event or an umbrella for an outdoor event; food and/or beverages that can be consumed at the event; equipment that can be used at the event, such as sports equipment for a participatory sports event; physical services that can be provided during the event, such as a professional photography service or a taxi service; and/or online services that can be provided during the event, such as an online video broadcasting service. The embedded marketplace system 3300 may enable transactions through the embedded marketplace 3304 that enable, facilitate, improve, highlight, or otherwise relate to the event.

As a first example, a user 3416 of an events calendar may express interest in attending a movie or a live music event tonight. The embedded marketplace system 3300 may embed, within the events calendar, an embedded marketplace 3304 that can show the user 3416 which movies and musical groups are playing tonight and for which tickets are currently available from ticket vendors (optionally within a budget of the user 3416). In response to a selection of one of the events by the user 3416, the embedded marketplace system 3300 may contact a ticket vendor (e.g., a website or web service of a ticket vendor) to retrieve additional information about available tickets and related services. The embedded marketplace system 3300 may present the market to the user 3416 that shows various costs and available options. In response to additional user input from the user 3416, the embedded marketplace system 3300 may execute, through the embedded marketplace 3304, one or more transactions to purchase tickets and/or related services on behalf of the user 3416.

As a second example, a user 3416 may express interest in a hike and an afternoon picnic. The embedded marketplace system 3300 may present, for each activity indicated by the user 3416, an embedded marketplace 3304 including goods and/or services that may enable, facilitate, improve, highlight, or otherwise relate to the activity. For example, the embedded marketplace system 3300 may suggest a list of supplies for each activity (hiking boots, a jacket, bug spray, a first aid kit, food, a basket, etc.) and may show the list to the user 3416 for review and editing (e.g., “I do need hiking boots but I have a jacket”). The embedded marketplace system 3300 may present an embedded marketplace 3304 that includes goods and/or services corresponding to the list of supplies for each activity. In response to selections of goods and/or services by the user 3416, the embedded marketplace system 3300 may complete one or more transactions through the embedded marketplaces mB04 and may arrange for delivery to a house or other location associated with the user 3416.

As a third example, a user 3416 might be interested in engaging in an activity on a certain date or time, but might have no particular idea as to what kind of activity. However, the user 3416 might have some personalized criteria as to kinds of activities that the user 3416 is willing, able, and/or interested in undertaking (e.g.: “my budget is $50, and I'd like the activities to be indoors and involve some kind of physical exercise”). An embedded marketplace system 3300 can review the criteria indicated by the user 3416 to determine one or more activities associated with one or more vendors and/or service providers that may be compatible with such criteria. The embedded marketplace system 3300 may present, to the user 3416, an embedded marketplace 3304 that includes and describes activities that are compatible with the criteria of the user 3416. In so doing, the embedded marketplace system 3300 may negotiate with vendors and service providers on behalf of the user 3416. The embedded marketplace system 3300 may present, to the user 3416, an embedded marketplace 3304 including a personalized and optionally pre-negotiated set of activities. Upon selection of one of the options, the embedded marketplace system 3300 may execute transactions through the embedded marketplace 3304.

In embodiments, the embedded marketplace system 3300 is integrated with wearable or camera-based sensing of the user 3416, so that spontaneous planning “goes with the flow” of a current status of the user 3416. For example, the embedded marketplace system 3300 may direct the user 3416 to a point of rest if exhausted, point of sustenance if hungry/thirsty, point of entertainment if energized, point of shopping, etc.

In embodiments, an embedded marketplace 3304 may present various types of activities to the user 3416. For example, the embedded marketplace platform 1950 may interact with one or more marketplaces 1900 via respective one or more marketplace interfaces 3412, wherein each of the one or more marketplaces 1900 offers various goods and/or services related to various events and/or activities. User input that indicates a selection of goods and/or services may be received by the marketplace interaction module 3408 and processed, as transactions, by the marketplace transaction module 3406. The selected goods and/or services may be received by a marketplace oversight module 3409 to apply policies to the generated content. The marketplace embedding module 3410 may present indications of the acquired goods and/or services to the user 3416 on the client device 3414, and/or may take further actions based on the acquired goods and/or services (e.g., narrating the event and/or activity for the user 3416 based on the acquired goods and/or services).

In embodiments, the embedded marketplace system 3300 may provide recommendations and embedded concierge services. For example, while planning a business trip, the embedded marketplace system 3300 may provide recommendations for recreational activities (e.g., an associated biking trip during the visit) and information relating to the recommended activities (e.g., Bike transport vs rental, local shops that sell or rent favorite brands, recommended rides based on location and previous riding history, recommended local equipment purchases based on size and availability, regulations, permits, and availability for local trails, estimated budget, and the like. In embodiments, the system 3300 may automatically make arrangements, reservations, and purchases for the options that are chosen using linked accounts, coupons, points, miles, and the like. In embodiments, collaborative filtering may be used with these services, such as to direct the user to services enjoyed by similar users who have visited a venue and their ratings of the experience.

In embodiments, the embedded marketplace system 3300 may embed marketplaces 3304 into items, such as thermostats. For example, a marketplace for consumer purchases of warm clothing or blankets may use thermostat data and natural gas usage data (where natural gas is used for heating) to enable consumers to purchase warm clothing. In embodiments, external data (e.g., TV use data) indicates whether a consumer typically spends most of their time in one location such that a blanket may be more desirable than a wearable sweater or sweatshirt. Other data from the television, such as during public service announcements describing the benefits of lowering a thermostat for energy consumption reduction, may be used for indicating when to offer or embed the marketplace purchases.

In embodiments, the embedded marketplace system 3300 may embed marketplaces 3304 into or in connection with a live event ticket. For example, for purchases at live events such as concerts and sporting events, an attendee may link a live event ticket to the attendee's transaction information (e.g., a credit card account, a cash transfer account, loyalty account, and/or the like). In embodiments, a ticket issuer and/or a venue operator may allow vendors and service providers to accept “in-ticket” purchases, whereby attendees are able to transact with the vendors and service providers using their tickets. In embodiments, the embedded marketplace system 3300 may allow a user to request a link between the user's transaction information and a digital ticket. In doing so, the embedded marketplace system 3300 verifies that the user is an owner of the digital ticket (e.g., by confirming that the digital ticket is stored or otherwise under control of a digital wallet that is controlled by the user). In embodiments, the embedded marketplace system 3300 may generate a transaction link, whereby the transaction link associates the digital ticket (or multiple digital tickets) owned by the user and the transaction information of the user. In some embodiments, the link may include a unique value that represents the association between the ticket and the user's transaction information (e.g., a hash value of a ticket ID and/or certain information corresponding to the user account). In embodiments, the transaction link may have temporal features such that a transaction link having temporal features expires (i.e., is no longer valid) after a certain period of time (e.g., after the live event, a week after the live event, or the like). Additionally or alternatively, the ticket issuer and/or the embedded marketplace system 3300 may invalidate transaction links when a ticket is transferred. For example, if a user links a ticket to their transaction information and later sells the ticket, the embedded marketplace system may invalidate the transaction link corresponding to the ticket before executing the transaction. In embodiments, the embedded marketplace system 3300 and/or the ticket issuer may integrate with point-of-sale systems of vendors and service providers, whereby in response to event attendees using their digital tickets to make a purchase, the point of sale system communicates a payment request to the marketplace system 3300, where the payment request includes the payment amount, the ticket identifier, and/or the transaction link. In embodiments, the embedded marketplace system 3301 facilitates payment on behalf of the user based on the payment request in response to validating the transfer link.

In embodiments, the transfer links allow event attendees to purchase food, beverages, and merchandise without needing to present a credit card, cash, identification, etc. For example, to purchase beer at an event, an attendee may simply grab a beer from a cooler and scan their ticket or smartphone (e.g., QR code). Similarly, the attendee may place an order for beer and nachos and have them delivered to their seat without any need for exchange of payment information, identification, etc. In some embodiments, an item purchased at the event in this way could be associated with transfer link. For example, if a concert attendee purchases a concert t-shirt or poster, the purchase may be associated with the transfer link used to make the purchase, thereby validating that the item was actually purchased by the user while the user was at that concert.

In embodiments, at the live event a wristband may be used to encode a user's transaction link. Once encoded in a wrist-band, the user can transact using the wristband. For example, the user open a valve to allow beer to flow to a tap by scanning the wristband at a point of sale. In this example, the tap may track the amount of beer poured to automatically charge the user. In embodiments, the swiping wristbands is in a seat front screen to order beer to be delivered or routed to a specific seat.

In embodiments, transfer links may be generated in connection with other types of tickets and passes. For example, a transfer link may be generated with respect to ski area lift tickets. In this example, the transfer link may be used for purchasing parking, food/drink, ski rentals, ski gear purchasing, lodging, rides (ride-share), entertainment (concerts, etc.).

In embodiments, parking/rideshare organization may be linked to concerts and sporting events. When purchasing tickets, an attendee may automatically see offers for parking rates near the venue as well as rideshare options for booking transportation from parking sites to the venue and/or directly from home to the venue and back. Such offers may dynamically be adjusted based on demand. For example, the system may determine that several attendees live near one another and may offer special group rates for transportation. Similarly, the system may determine that several attendees are choosing budget parking that is distant from the venue and may offer a budget rideshare solution, such as a shuttle, for those people. Rather than parking in a $30 lot, a user may park in a $5 lot and purchase a $5 rideshare with others.

In embodiments, the marketplace system 3300 may be configured to embed a set of shared economy marketplace capabilities into a special purpose device or system, such as an IoT device, edge device, wearable device, or the like, that is equipped with intelligence capabilities, such as sensing, processing, storage, communication, and the like that are primarily directed to achieving the main purpose of the device or system, but that can also be provisioned to enable shared economy marketplace capabilities that are related to the purpose of the device (e.g., that involve shared usage of the device or system, that involve sharing of data collected, processed, or published by the device or system, or the like. For example, in embodiments a user upon acquiring a device or system may be prompted to enter or configure a set of conditions under which the user is willing to share physical possession of the device or system, to share physical production output of the device or system (e.g., where it is a manufacturing or production system), to share digital goods output of the device or system, to share revenue or other rewards generated by the device or system (e.g., loyalty points), to share data produced by the device or system, or the like. The configured conditions may be embedded or wrapped in the device, such as operating on the operating system or processor of the device, may be presented via the interfaces of the device (e.g., by an API, service layer, or user interface layer), may be managed by a set of smart contract or other automation features such as those described throughout this disclosure, and the like. Configuration may include setting time periods of sharing, setting a set of price conditions for sharing, setting location conditions, setting user requirements (e.g., age or other qualifications), and setting other governing rules.

In one example, a shared economy marketplace for a designer luxury item (e.g., a handbag) may be embedded in luxury item (e.g., in the handbag), such as on a chipset that is uniquely associated with the handbag that is capable of communicating availability for sharing of the handbag with a network. The handbag may be configured to be loaned for a short duration (e.g., 24 hours), within a defined location of usage (such as within a geofence), for a given price, and subject to posting security (e.g., a bond that is automatically triggered and paid to the owner if the handbag is lost, damaged, or the like, or a penalty that is automatically dedicated from an account of the borrower if the handbag is used outside the permitted location, time, or other conditions). The handbag may be configured to publish availability only to users within a defined location and or having a set of credentials (such as a given rating on social media, or the like). Similar embodiments should be understood to apply to all types of goods, including production systems, other luxury goods, consumer electronics, apparel, footwear, appliances, and many others.

In embodiments, the embedded marketplace system 3300 may embed marketplaces 3304 into content-creation software products and applications. For example, word processors, email clients and services, image content, music generation, and social networking and social media platforms, may include stock content that can be inserted or autogenerated. The content may reflect a different content style than a personal content style of the author. The content generation could be customized to match the style of the user based on a curated set of the user's previously generated content. However, identifying and curating the particular content to use for such customization can be a difficult and technically complex process.

In some cases, an embedded marketplace 3304 may include a personalized content generation service that generates content based on personalized content of the user 3416. In embodiments, an embedded marketplace 3304 that offers content creation products/or and services includes a marketplace for content generation trainers. The content generation trainers can review the user's past content, select and clean the data, and train a machine learning model (such as commercially available products, e.g., ChatGPT and/or Stable Diffusion) to generate content that is consistent with the user's style. In particular, the content generated by the trained machine learning model is based on a style of content that the user 3416 previously generated and/or approved (e.g., content that the user 3416 previously created, edited, selected, and/or accepted, optionally using one or more content creation tools).

In embodiments, content selected by the user 3416 to train the machine learning model may be associated with metadata that informs the training of the machine learning model. For example, the user 3416 may highlight portions of the content that the user 3416 particularly likes and/or that the user 3416 believes to be associated with the user's personal and/or preferred style of content, which may cause the trained machine learning model to produce more content that includes, reflects, refers to, and/or is consistent with such highlighted content. The user 3416 may classify the content into various content types, contexts, moods, objectives, and/or the like, which may cause the trained machine learning model to produce more content that is also classified based on content types, contexts, moods, objectives, and/or the like. The user 3416 may receive some content generated by a trained machine learning model and may provide feedback related to the generated (e.g., editing, one or more ratings, commentary, or the like), which may cause the trained machine learning model to produce more content based on the provided feedback.

In embodiments, an embedded marketplace 3304 provides different trained machine learning models for different content types, contexts, moods, objectives, or the like. As an example, the embedded marketplace 3304 may include a set of partially trained or foundational machine learning models (e.g., a first general-purpose large language model (LLM) that has been trained on scientific literature and a second general-purpose large language model (LLM) that has been trained on fictional novels). A user 3416 may select a particular partially trained or foundational machine learning model and may provide additional content that is associated with the user 3416 (e.g., selecting the first LLM that has been trained on scientific literature, and providing additional scientific literature generated by the user 3416). The embedded marketplace 3304 may receive the selection of the partially trained or foundational machine learning model and the additional content, further train the selected machine learning model using the provided content, and invoke the further trained machine learning model to generate additional content by the user 3416.

As another example, a user 3416 may provide the embedded marketplace 3304 with a large set of content generated by the user 3416, such as all email generated by the user 3416. The embedded marketplace 3304 may classify each email provided by the user 3416 into one or more classes, wherein each class is associated with one or more content types, contexts, moods, objectives, and/or the like. The embedded marketplace 3304 may train one or more particular machine learning models on each of the one or more classes. Upon receiving a request from the user 3416 to generate content, the embedded marketplace 3304 may determine a determined content type, context, mood, objective, and/or the like, select one or more machine learning models from the set of trained machine learning models, and may generate content with the selected one or more machine learning models. In this manner, the embedded marketplace 3304 may provide personalized content for the user 3416 that is specific to a content type, context, mood, objective, and/or the like of the user 3416, and, more particularly, based on content that is also associated with the content type, context, mood, objective, and/or the like that is associated with the user's request to generate content.

The embedded marketplace 3304 can generate content with varying levels of content curation and/or sophistication, various objectives that each user 3416 can pursue (e.g., creativity, brand consistency, and/or compatibility with a particular audience), and/or past experience and/or reputation ratings. The embedded marketplace 3304 can provide confidentiality, as some clients (e.g., celebrities, social media personalities, and/or politicians) may prefer a measure of control over who is permitted to review their past content and/or the user's use of a machine learning service to generate content.

In embodiments, an embedded marketplace 3304 may present various types of machine learning models for selection, training, and/or application to generate content. For example, the embedded marketplace platform 1950 may interact with one or more marketplaces 1900 via respective one or more marketplace interfaces 3412, wherein each of the one or more marketplaces 1900 offers, hosts, and/or provides one or more machine learning models that is capable of generating content, and/or one or more services for training and/or executing such machine learning models. Alternatively or additionally, the embedded marketplace platform 1950 may interact with one or more marketplace participants 1940 via respective one or more participant interfaces 3411, wherein each of the one or more marketplace participants 1940 is capable of training and/or executing one or more machine learning models to generate content that matches the personal style of the user 3416. The embedded marketplace platform 1950 may combine such machine learning models using a marketplace generator module 3404 and/or marketplace representation module 3404. Requests for new content may be received by the marketplace interaction module 3408 and processed, as transactions, by the marketplace transaction module 3406. The generated content may be received by a marketplace oversight module 3409 to apply policies to the generated content. The marketplace embedding module 3410 may present the generated content to the user 3416 on the client device 3414, and/or may take further actions based on the generated content (e.g., transmitting the generated content to another user or device; posting the generated content on the Internet; revising the generated content based on feedback from the user 3416; and/or generating new content based on feedback from the user 3416).

### Data Services System

In embodiments, a computer-implemented system is designed for management and utilization of data within an enterprise by integrating an embedded marketplace directly within a host application. The system is architected to include a data classification module that intelligently classifies data into various sensitivity levels and regulatory compliance categories, ensuring that each piece of data is handled and accessed according to its designated importance and legal requirements. The system's access control module may manage permissions, employing both role-based and attribute-based access controls to grant or restrict access to classified data, thereby upholding the highest standards of data governance and security. The data formatting module may tailor the presentation of data, transforming classified data into customized formats that cater to the specific analytical and operational needs of diverse enterprise departments. This module is capable of generating everything from executive dashboards with high-level synopses to detailed analytical reports, ensuring that data is not only accessible but also maximally informative and actionable for its intended audience.

The integration module interfaces with critical enterprise systems such as ERP and CRM to retrieve, classify, and format data, thus enabling a unified and efficient data ecosystem. The user interface module complements this by presenting the formatted data within the host application in an intuitive and user-friendly manner, enhancing the overall user experience and facilitating efficient workflows. This embedded marketplace system may be scalable and flexible to accommodate the growing complexity of enterprise data. The embedded marketplace system may also include advanced search functions, customizable views, and dynamic permission adjustments to ensure that data is discovered and utilized effectively. Moreover, the system may include a comprehensive suite of training and support services to assist employees in leveraging the full potential of the data services provided.

The embedded marketplace system may be designed to be inherently adaptable, capable of integrating with various enterprise systems, and providing a centralized platform for data services that are both secure and compliant with legal and regulatory standards. The system enables enterprises to harness the power of their data through a sophisticated, embedded marketplace that is both user-centric and aligned with the complex needs of modern businesses.

In embodiments, the embedded marketplace system may include a data classification module that utilizes machine learning techniques to classify data based on predefined sensitivity levels and regulatory compliance requirements. The system may also feature an access control module that employs advanced encryption standards to manage permissions for different user roles within an enterprise, ensuring that access to classified data is granted in accordance with the sensitivity levels and regulatory compliance requirements. Furthermore, the system may incorporate a data formatting module that leverages natural language processing to format classified data into customized presentations for various enterprise departments, enhancing the decision-making process.

Embedded Systems with Process Automation

Embedded marketplaces, when integrated with process automation and artificial intelligence (AI), provide a sophisticated and efficient platform for facilitating transactions. These systems utilize technology to automate repetitive tasks, thereby reducing the need for human intervention and enhancing the user experience. For instance, process automation within an embedded marketplace can manage inventory by automatically updating stock levels and initiating reorder processes when inventory is depleted. It can also streamline order processing by managing the entire workflow from payment processing to shipping updates, and automate customer service by responding to common inquiries and providing real-time order status updates.

Artificial intelligence may further augment embedded marketplaces by introducing capabilities such as predictive analytics, which leverages historical data to forecast future trends like customer buying patterns. This allows for features such as the optimization of stock levels and personalized product suggestions. AI can also enable dynamic pricing, adjusting prices in real-time based on various market factors, and deploy chatbots and virtual assistants to aid customers with inquiries, product recommendations, and transaction facilitation.

The integration of process automation and AI in embedded marketplaces results in platforms that are not only transactionally efficient but also capable of anticipating user needs and adapting to market changes in real-time. For example, in a manufacturing system, an embedded marketplace may forecast the need for raw materials using AI and initiate the procurement process automatically, ensuring uninterrupted production. Similarly, smart logistics can be realized where AI predicts the most efficient shipping routes and times, and process automation arranges for the shipment and keeps the customer informed throughout the delivery process.

In embodiments, a business-to-business (B2B) embedded marketplace for industrial parts within a factory's procurement system could utilize AI to analyze machine performance data and predict when parts will require replacement. The system may then automatically initiate the procurement process, ordering the necessary parts from pre-approved vendors. Process automation may complete the transaction, arrange delivery, and update the inventory management system without manual intervention.

In embodiments, a computer-implemented method for embedding a marketplace within a host platform involves identifying functionalities provided by the host platform, determining relevant marketplace services, integrating an interface for these services into the host platform, configuring the services to utilize host platform data for personalization, and facilitating transactions within the embedded marketplace. In embodiments, the host platform may be an Enterprise Resource Planning (ERP) system, a Customer Relationship Management (CRM) system, a social media platform, an Internet of Things (IoT) device, a digital wallet application, a content creation platform, or a gaming platform. The marketplace services may include AI algorithms for predicting user needs and process automation for handling transactions, including payment processing, order fulfillment, and customer service. The system may also collect user feedback and use AI to adjust marketplace services to improve relevance and user satisfaction.

### Embedded Marketplace as Enterprise Tool for Monitoring Employee Procurement

In embodiments, an embedded marketplace system is designed to integrate seamlessly within an enterprise's existing digital infrastructure, such as web browsers or enterprise applications, to facilitate and manage the procurement and budgeting processes. This system acts as an intermediary platform that enhances the purchasing experience by providing real-time budget awareness, compliance checks, and streamlined approval workflows. For instance, when an employee navigates to a vendor's website, the embedded system, possibly implemented as a browser extension, overlays additional information and options onto the page, allowing the employee to make informed purchasing decisions that align with the company's financial policies. It can automatically check transactions against a regulatory database to ensure compliance with applicable laws and enterprise policies, send automated approval requests, and prioritize products from preferred vendors. Additionally, the systems can offer various payment methods, enforce spending limits, and integrate with Enterprise Resource Planning (ERP) systems to maintain budgetary control. By embedding these functionalities, embedded tools empower enterprises to maintain oversight over procurement processes, ensure policy compliance, manage financial transactions effectively, and provide a user-friendly interface that integrates with regular online purchasing activities, all while potentially preventing non-compliant transactions that could expose the enterprise to legal and financial penalties.

In embodiments, the embedded marketplace is designed to enhance the procurement process within an enterprise by providing a comprehensive, integrated platform that embeds directly into the user's digital workflow, such as a web browser or enterprise application. The embedded system comprises a suite of functionalities including a real-time budget monitoring module that interfaces with the enterprise's financial systems to display current budget constraints and issue alerts for potential over-expenditures. An automated approval workflow engine routes purchase requests through a hierarchical approval process, ensuring compliance with internal authorization policies. The system includes a compliance verification module that cross-references each transaction against a dynamic regulatory database to enforce adherence to applicable laws and enterprise standards. A vendor management component prioritizes and suggests products from a curated list of pre-approved vendors, facilitating negotiated pricing and terms beneficial to the enterprise. Additionally, the system features an audit trail recorder that meticulously logs all procurement activities, creating a transparent and traceable record for auditing and regulatory reporting purposes. By integrating these components, the system streamlines the procurement process, enforces fiscal discipline, ensures regulatory compliance, and empowers employees to make informed purchasing decisions within a controlled and monitored environment, thereby optimizing the enterprise's resource allocation and expenditure management.

### Digital Twins and Embedded Systems

In embodiments, a system integrates marketplace functionalities within a digital twin. For example, in a virtual model that mirrors the physical state of an object or system in real-time. This integration allows for seamless transactions related to the physical entity that the digital twin may represent. The system may include a processing unit that generates the digital twin, complete with real-time data that reflects the physical asset's status and performance. Embedded within this digital twin is a marketplace module that enables various transaction-related activities, such as listings, purchases, and processing of transactions.

The system may also include a data analysis module that leverages the real-time data from the digital twin to pinpoint transactional needs or opportunities. A communication interface may be included to present these opportunities to users, facilitating their interaction with the marketplace module through the digital twin interface. This setup not only streamlines transactions but also opens up avenues for predictive maintenance services, as the system can anticipate the physical asset's needs based on ongoing data analysis.

The marketplace module may offer recommendations for spare parts and consumables tailored to the physical asset. The marketplace may incorporate smart contract functionality to automate transactions based on pre-established rules informed by the real-time data. Additionally, the module may dynamically adjust insurance service terms and facilitate the resale or leasing of the physical entity by connecting potential buyers or lessees with the digital twin.

Integration with third-party service providers expands the range of services related to the physical entity. Machine learning algorithms within the marketplace module personalize transaction opportunities for users based on their behavior and preferences. The module may support a virtual reality interface for immersive user interaction and provides a platform for user-generated content, such as custom modifications or enhancements related to the physical asset.

In embodiments, a system aggregates data from multiple digital twins, representing a fleet of similar physical entities, to offer bulk transaction opportunities. The system may enable energy trading services for digital twins that represent energy-consuming or energy-generating assets, using real-time energy data. Subscription-based services related to the physical asset can be modified in response to data changes, and a feedback mechanism allows users to rate and review transactions, influencing future marketplace offerings. The system may also ensure regulatory compliance by automatically adjusting transactions to adhere to applicable laws and regulations based on the real-time data.

In embodiments, the digital twin includes a marketplace of digital twins. For example, this marketplace may facilitate the trade of digital twins themselves, allowing users to buy, sell, or license digital representations of various physical entities. Such a marketplace may enable the comparison of performance metrics across different digital twins, potentially leading to a more competitive and efficient market for digital twin technologies. Users may access a broader ecosystem of digital twins, each with its marketplace offerings, creating a networked system of interconnected digital twins that can transact with one another, share data, and optimize operations across various industries and sectors.

### Embedded System Aggregation

In embodiments, a system includes an integrated transaction platform that incorporates an embedded marketplace module, a data aggregation system, a transaction execution module, a blockchain interface, and a smart contract module. The system is designed to facilitate the aggregation, personalization, execution, and recording of transactions within a user interface of a host application, leveraging the robustness of blockchain technology and the efficiency of smart contracts.

The embedded marketplace module serves as an interface for users to interact with the system, and is configured to aggregate offerings from multiple vendors, presenting these in a unified and coherent manner within the host application's user interface. In embodiments, the module integrates with various external marketplaces, thereby providing users with a comprehensive view of available goods and services across different platforms. The embedded marketplace module ensures that users can access a wide range of offerings without the need to navigate away from the host application.

The data aggregation system may collect and process data from a variety of sources, including user interactions within the marketplace, external databases, social media, Internet of Things (IoT) devices, and other relevant data streams. The system employs machine learning algorithms to analyze the collected data and refine the personalization of aggregated offerings. The personalization is based on user preferences, behaviors, and real-time interactions, ensuring that the offerings presented are tailored to meet the individual needs of each user.

The transaction execution module may facilitate the purchase, sale, and exchange of goods and services within the embedded marketplace. The transaction module supports a variety of payment methods, including traditional fiat currencies and cryptocurrencies, providing users with flexibility in how they conduct transactions. This module may work in conjunction with the smart contract module to ensure that all transactions are executed in accordance with predefined rules and conditions.

The blockchain interface enables interaction with one or more distributed ledgers and supports multiple blockchain protocols to ensure compatibility with a range of distributed ledger technologies. The blockchain interface is responsible for recording transactions executed within the embedded marketplace, providing a secure and immutable record that enhances trust and transparency in the transaction process.

The smart contract module may generate and enforce agreements related to transactions within the embedded marketplace. The smart contract module may be configured to automatically adjust contract terms in response to changes in regulatory requirements, ensuring that all transactions remain compliant with current laws and enterprise policies. The smart contract module may also include a dispute resolution mechanism that activates based on transaction anomalies, providing a means for resolving conflicts without the need for external intervention.

In embodiments, the system includes a robotic process automation (RPA) module that automates various procurement processes. This module interfaces with vendor management systems to streamline supply chain operations and is capable of automating compliance checks against enterprise policies during the procurement process. The RPA module utilizes predictive demand analysis to automate purchasing decisions, ensuring optimal inventory levels and reducing procurement costs.

In embodiments, the system includes a blockchain interface that provides functionalities such as tokenization of assets to facilitate asset trading and audit trails for transactions. The smart contract module may integrate with external contract management systems for cross-platform contract synchronization and may include a dispute resolution mechanism for transaction anomalies.

### Embedded Systems and Enterprise Ecosystems

Embodiments provide a computer-implemented system that revolutionizes the facilitation of transactions within an embedded marketplace enterprise ecosystem. A processor and a memory component collectively store and execute a series of instructions that enable integration of the marketplace with the enterprise's existing digital infrastructure. This integration allows for the automation of transactional processes, thereby enhancing the efficiency of procurement and sales operations by interfacing with the enterprise's workflow systems. The system's data services module manages listings, transactions, and user profiles, ensuring that all marketplace data is curated and readily accessible.

To support strategic decision-making, the system may include an advanced intelligence system capable of sifting through large amounts of data to provide actionable insights and analytics to support informed decision-making regarding pricing strategies and inventory management. Security and compliance may be supported through a robust permissions system that controls access to the marketplace's functions, safeguarding sensitive transactions and data.

A wallets module may facilitate digital transactions, allowing for the secure and efficient transfer of digital currencies or assets within the marketplace. Furthermore, the system may be incorporated with large language models (LLMs) for optimizing transactional workflows, robotic process automation (RPA) to automate routine tasks, and digital twins to simulate and analyze marketplace dynamics. The integration of blockchain technology ensures that transactions are secure and transparent, while artificial intelligence (AI) algorithms enable dynamic pricing based on real-time market data.

Smart contracts may be automated with an orchestration engine, ensuring compliance with contractual terms, and interfacing with Internet of Things (IoT) devices opens up new avenues for transaction facilitation based on sensor data. Personalization is achieved through machine learning algorithms that tailor product recommendations to user preferences, enhancing the overall user experience. The system may also support subscription services, virtual assistants powered by natural language processing (NLP), and integration with virtual and augmented reality (VR/AR) platforms for immersive product interactions.

In embodiments, the system may support tokenization of digital assets, representing ownership and transactions within the enterprise ecosystem. The system may handle cross-border transactions, providing multi-currency and language support to facilitate international trade. Customer relationship management (CRM) and supply chain management systems may be integrated to track customer interactions and optimize inventory, respectively. An API gateway may enable third-party applications to interact with the marketplace, while a fraud detection system proactively identifies and prevents fraudulent activities. The system may also support a peer-to-peer (P2P) network for direct user transactions and incorporates a feedback and rating system, employing sentiment analysis to gauge customer satisfaction and drive continuous improvement.

### Computer-Based Implementations

### Introduction

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

### Special-Purpose Systems

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

In this application, including the claims, the term module refers to a special-purpose system. The module may be implemented by one or more special-purpose systems. The one or more special-purpose systems may also implement some or all of the other modules.

In this application, including the claims, the term “module” may be replaced with the terms “controller” or “circuit.”

In this application, including the claims, the term platform refers to one or more modules that offer a set of functions.

In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment.

For example, the special-purpose system may be partially or fully hosted by a third-party offering software as a service (SaaS), platform as a service (PaaS), and/or infrastructure as a service (IaaS).

The special-purpose system may be implemented using agile development and operations (DevOps) principles. In embodiments, some or all of the special-purpose systems may be implemented in a multiple-environment architecture. For example, the multiple environments may include one or more production environments, one or more integration environments, one or more development environments, etc.

### Device Examples

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc.

A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system.

Examples of servers include a file server, print server, domain server, internet server, intranet server, cloud server, infrastructure-as-a-service server, platform-as-a-service server, web server, secondary server, host server, distributed server, failover server, and backup server.

### Hardware

The term “hardware” encompasses components such as processing hardware, storage hardware, networking hardware, and other general-purpose and special-purpose components. Note that these are not mutually exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack.

Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

The methods and systems described herein may transform physical and/or intangible items from one state to another. The methods and systems described herein may also transform data representing physical and/or intangible items from one state to another.

### Computer-Readable Media Examples

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

### Processing Hardware

The methods and systems described herein may be deployed in part or in whole through machines that execute computer software, program codes, and/or instructions on processing hardware (also referred to as a “processor”). The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

### Processor Architecture

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

### Network Infrastructure and Networking Hardware

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network.

Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard).

Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG).

A WAN may also be referred to as a distributed communications system (DCS). One example of a WAN is the internet.

### Storage Hardware

Storage hardware is or includes a computer-readable medium. The term computer-readable medium, as used in this disclosure, encompasses both nonvolatile storage and volatile storage, such as dynamic random-access memory (DRAM). The term computer-readable medium only excludes transitory electrical or electromagnetic signals propagating through a medium (such as on a carrier wave). A computer-readable medium in this disclosure is therefore non-transitory and may also be considered tangible.

### Examples

Examples of storage implemented by the storage hardware include a database (such as a relational database or a NoSQL database), a data store, a data lake, a column store, a data warehouse.

Examples of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware.

Storage hardware may have read-only, write-once, or read/write properties. Storage hardware may be random access or sequential access. Storage hardware may be location-addressable, file-addressable, and/or content-addressable.

Examples of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM).

Examples of volatile memory devices include processor registers and random-access memory (RAM), such as static RAM (SRAM), dynamic RAM (DRAM), synchronous DRAM (SDRAM), synchronous graphics RAM (SGRAM), and video RAM (VRAM).

Examples of magnetic storage media include analog magnetic tape, digital magnetic tape, and rotating hard disk drive (HDDs).

Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain.

Entities recording transactions, such as in a blockchain, may reach consensus using an algorithm such as proof-of-stake, proof-of-work, and proof-of-storage.

Elements of the present disclosure may be represented by or encoded as non-fungible tokens (NFTs). Ownership rights related to the non-fungible tokens may be recorded in or referenced by a distributed ledger.

Transactions initiated by or relevant to the present disclosure may use one or both of fiat currency and cryptocurrencies, examples of which include bitcoin and ether.

Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

### Software

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc.

Software also includes data. However, data and instructions are not mutually exclusive categories. In various embodiments, the instructions may be used as data in one or more operations. As another example, instructions may be derived from data.

The functional blocks and flowchart elements in this disclosure serve as software specifications, which can be translated into software by the routine work of a skilled technician or programmer.

Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains.

When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT).

Training a machine-learning model may include supervised learning (for example, based on labelled input data), unsupervised learning, and reinforcement learning. In various embodiments, a machine-learning model may be pre-trained by their operator or by a third party.

Problem domains include nearly any situation where structured data can be collected, and includes natural language processing (NLP), computer vision (CV), classification, image recognition, etc.

### Architectures

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

In a client-server model, some of the software executes on first hardware identified functionally as a server, while other of the software executes on second hardware identified functionally as a client. The identity of the client and server is not fixed; for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER™ container platform, a pivotal cloud foundry (PCF) platform, etc.

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

### CONCLUSION

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

1. A computer-implemented system for providing an embedded marketplace within a host application, the computer-implemented system comprising:
a data classification module configured to classify data into classified data based on predefined sensitivity levels and regulatory compliance requirements;
an access control module configured to manage permissions for different user roles within an enterprise, granting access to the classified data in accordance with the predefined sensitivity levels and regulatory compliance requirements;
a data formatting module configured to format classified data into formatted data with customized presentations for various enterprise departments;
an integration module configured to interface with at least one of an Enterprise Resource Planning (ERP) system or a Customer Relationship Management (CRM) system to retrieve and classify the data; and
a user interface module configured to present the formatted data within the host application, providing a seamless user experience for accessing the embedded marketplace.

2. The computer-implemented system of claim 1, wherein the host application for the embedded marketplace is the Enterprise Resource Planning (ERP) system, and the data classification module is further configured to classify financial, supply chain, and human resources data for selective presentation to authorized users.

3. The computer-implemented system of claim 1, wherein the host application for the embedded marketplace is the Customer Relationship Management (CRM) system, and the data formatting module is further configured to generate visual sales funnels and marketing campaign analytics for sales and marketing departments.

4. The computer-implemented system of claim 1, wherein the host application for the embedded marketplace is a Product Lifecycle Management (PLM) system, and the integration module is further configured to provide research and development data, including product specifications and testing results, formatted as technical documents.

5. The computer-implemented system of claim 1, wherein the host application for the embedded marketplace is a governance, risk, and compliance (GRC) platform, and the access control module is further configured to enforce compliance with legal and regulatory standards by restricting access to sensitive compliance-related data.

6. The computer-implemented system of claim 1, wherein the host application for the embedded marketplace is an IT service management tool, and the user interface module is further configured to display IT asset management data, system performance metrics, and security incident reports in a format tailored for IT department use.

7. The computer-implemented system of claim 1, wherein the host application for the embedded marketplace is a corporate intranet portal, and the data formatting module is further configured to provide executive dashboards, departmental reports, and company-wide announcements in a centralized location.

8. The computer-implemented system of claim 1, wherein the host application for the embedded marketplace is a cloud-based collaboration platform, and the integration module is further configured to facilitate data sharing and project management across geographically dispersed teams within the enterprise.

9. (canceled)

10. The computer-implemented system of claim 1, wherein the data classification module utilizes role-based access controls (RBAC) to assign data access permissions, wherein the access control module supports attribute-based access control (ABAC) and RBAC.

11. The computer-implemented system of claim 1, wherein the data classification module tags data with metadata indicating its sensitivity level.

12. The computer-implemented system of claim 1, wherein the access control module includes a feature for regular audits and real-time monitoring of data access.

13. The computer-implemented system of claim 1, wherein the data formatting module provides management summaries with high-level graphics, dashboards, and synopses for executive teams.

14. The computer-implemented system of claim 1, wherein the data formatting module provides detailed reports, raw data sets, and analytical tools for in-depth data analysis by employees.

15. The computer-implemented system of claim 1, wherein the user interface module allows for customizable views of data according to departmental needs.

16. The computer-implemented system of claim 1, wherein the integration module includes a data service catalog featuring data processing, analytics, and visualization tools.

17-18. (canceled)

19. The computer-implemented system of claim 1, wherein the integration module provides a unified platform for centralized data governance across the enterprise.

20. (canceled)

21. The computer-implemented system of claim 1, wherein the integration module automates compliance with regulations by embedding rules directly into data access mechanisms.

22-23. (canceled)

24. The computer-implemented system of claim 1, wherein the integration module is configured to adjust permissions dynamically based on context, wherein the context includes at least one of current projects or collaborations.

25. The computer-implemented system of claim 1, wherein the integration module supports a scalable architecture to accommodate growing volumes and varieties of data.

26. (canceled)

27. The computer-implemented system of claim 1, wherein the integration module includes usage tracking and analytics to provide insights into data value and usage patterns.

28.-106. (canceled)
